(19) United States
(12) Patent Application Publication
(10) Pub. No.: US 2006/0182418 A1
(43) Pub. Date: Aug. 17, 2006

(54) Information storage medium, information recording method, and information playback method

(76) Inventors: Yoichiro Yamagata, Yokohama-shi (JP); Kazuhiko Taira, Yokohama-shi (JP); Hideki Mimura, Yokohama-shi (JP); Yasufumi Tsumagari, Yokohama-shi (JP); Yasuhiro Ishibashi, Ome-shi (JP); Takero Kobayashi, Akishima-shi (JP); Toshimitsu Kaneko, Kawasaki-shi (JP); Toru Kanbayashi, Chigasaki-shi (JP); Haruhiko Toyama, Kawasaki-shi (JP); Seiichi Nakamura, Inagi-shi (JP); Eita Shuto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/344,575

(22) Filed: Feb. 1, 2006

(30) Foreign Application Priority Data
Feb. 1, 2005 (JP) 2005-025622
Feb. 10, 2005 (JP) 2005-035161

(51) Int. Cl. H04N 5/91; H04N 7/52

(52) U.S. Cl. 386/95

(57) ABSTRACT

According to one embodiment, video objects to be played back by a method different from an existing playback sequence with respect to contents recorded on a read-only information storage medium are implemented. The medium is configured to store startup information including one or more pieces of playlist information to be played back first when the medium stores an advanced content, and information used to determine which one of the pieces of playlist information is to be adopted.

### CROSS-REFERENCE TO RELATED APPLICATIONS

This application is based upon and claims the benefit of priority from prior Japanese Patent Applications No. 2005-25622, filed Feb. 1, 2005; and No. 2005-35161, filed Feb. 10, 2005, the entire contents of both of which are incorporated herein by reference.

### BACKGROUND

1. Field

One embodiment of the invention relates to an information storage medium such as, for example, an optical disc, a method of recording information on the information storage medium, and a method of playing back the information storage medium.

2. Description of the Related Art

In recent years, DVD-Video discs having high image quality and advanced functions, and video players that play back such discs have prevailed. An environment that can personally implement a home theater and allows users to freely enjoy movies, animations, and the like with high image quality and high sound quality at home has become available. As described, for example, in Jpn. Pat. Appln. KOKAI Publication No. 10-50036, a playback apparatus which can superimpose various menus by changing, e.g., text colors and the like for playback video pictures from a disc has been proposed.

Along with the improvement of the image compression technique, a demand has arisen for realization of higher image quality from both the users and contents providers. In addition to realization of higher image quality, the contents providers have need of an environment that can provide more attractive contents to users by upgrading and expanding the contents (e.g., more colorful menus, improvement of interactiveness, and the like) in contents such as menu screens, bonus video pictures, and the like as well as a title itself. Furthermore, some users may require to freely enjoy contents by playing back still picture data sensed by the user, subtitle text data acquired via Internet connection, and the like by freely designating their playback positions, playback regions, or playback times.

It is better to provide an environment, for example, that can provide more attractive contents to users by upgrading and expanding the contents (e.g., more colorful menus, improvement of interactiveness, and the like) in contents such as menu screens, bonus video pictures, and the like in addition to realization of higher image quality of a title itself.

To produce contents with more colorful menus and high interactiveness, for example, a technique different from the conventional contents production is to be provided. Hence, much time has to be spent to master such technique. For this reason, a contents providing environment that allows the conventional production technique to produce and can realize high image quality of a title itself (although functions are little more than the conventional technique) may be required at the same time.

In a conventional DVD-Video disc (ROM-based disc), for example, video objects (called VOBs or EVOBs) and/or their playback order are determined based on program chain (PGC in short) information which is set by the contents provider, is determined in advance, and is recorded on a disc. However, video objects to be played back and their playback order are determined in advance upon preparing that disc, and cannot be changed after the disc is prepared. Thus, when the contents provider wants to change the video objects to be played back or their playback order, for example, he or she may be required to record PGC information changed by re-generating new management information of a DVD-Video disc on a new disc. The user has to re-purchase a DVD-Video disc that records the changed PGC information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an example of the data structure of recording information on disc-shaped information storage medium (optical disc, etc.) 1 according to an embodiment of the invention;

FIG. 2 is a view for explaining an example of a file system used to manage content recorded on the disc-shaped information storage medium according to an embodiment of the invention;

FIG. 3 shows an example of the data structure of HD video manager information (HDVMGI) recorded on an HD video manager (HDVMG) recording area;

FIG. 4 shows an example of the data structure of an HD video manager information management table (HDVMGI_MAT) included in the HD video manager information (HDVMGI) and the recording content of category information (HDVMG_CAT) stored in the management table;

FIG. 5 shows an example of the data structure of a title search pointer table (TT_SRPT) recorded in the HD video manager information (HDVMGI);

FIG. 6 shows an example of the data structure of an HD video manager menu PGCI unit table (HDVMGM_PGCI_UT) recorded in the HD video manager information (HDVMGI);

FIG. 7 shows an example of the data structure of each HD video manager menu language unit (HDVMGM_LU#n);

FIG. 8 shows an example of the recording content of an HDVMGM_PGC category (HDVMGM_PGC_CAT);

FIG. 9 shows an example of the data structure of a parental management information table (PTL_MAIT) recorded in the HD video manager information (HDVMGI);

FIG. 10 shows an example of the data structure of each parental management information (PTL_MAI#n);

FIG. 11 shows an example of the data structure of an HD video title set attribute information table (HDVTS_ATRT) recorded in the HD video manager information (HDVMGI);

FIG. 12 shows an example of the data structure of a text data manager (TXTDT_MG) recorded in the HD video manager information (HDVMGI);

FIG. 13 shows an example of the data structure of each text data language unit (TXTDT_LU#n);

FIG. 14 shows an example of the data structure of text data (TXTDT);

FIG. 15 shows an example of the data structure of an HD video manager menu cell address table (HDMVGM_C_ADT) recorded in the HD video manager information (HDVMGI);

FIG. 16 shows an example of the data structure of an HD video manager menu video object unit address map (HDVMGM_VOBU_ADMAP) recorded in the HD video manager information (HDVMGI);

FIG. 17 shows an example of the data structure of an HD menu audio object set information table (HDMENU_AOBSIT) recorded in the HD video manager information (HDVMGI);

FIG. 18 shows an example of the data structure of a menu video object area (HDVMGM_VOBS) recorded in the HD video manager (HDVMG) area;

FIG. 19 shows an example of the data structure of a menu audio object area (HDMENU_AOBS) recorded in the HD video manager (HDVMG) area;

FIG. 20 shows an example of the data structure of HD video title set information (HDVTSI) recorded on each HD video title set (HDVTS#n) recording area;

FIG. 21 shows an example of the data structure of an HD video title set information management table (HDVTSI_MAT) recorded in the HD video title set information (HDVTSI);

FIG. 22 shows an example of the data structure of an HD video title set part-of-title search pointer table (HDVTS_PTT_SRPT) recorded in the HD video title set information (HDVTSI);

FIG. 23 shows an example of the data structure of an HD video title set program chain information table (HDVTS_PGCIT) recorded in the HD video title set information (HDVTSI);

FIG. 24 shows an example of the recording content of an HDVTS_PGC category (HDVTS_PGC_CAT);

FIG. 25 shows an example of the data structure of an HD video title set menu PGCI unit table (HDVTSM_PGCI_UT) recorded in the HD video title set information (HDVTSI);

FIG. 26 shows an example of the data structure of each HD video title set menu language unit (HDVTSM_LU#n);

FIG. 27 shows an example of the recording content of an HDVTSM_PGC category (HDVTSM_PGC_CAT);

FIG. 28 shows an example of the data structure of an HD video title set time map table (HDVTS_TMAPT) recorded in the HD video title set information (HDVTSI);

FIG. 29 shows an example of the data structure of an HD video title set menu cell address table (HDVTSM_C_ADT) recorded in HD video title set information (HDVTSI);

FIG. 30 shows an example of the data structure of an HD video title set menu video object unit address map (HDVTSM_VOBU_ADMAP) recorded in HD video title set information (HDVTSI);

FIG. 31 shows an example of the data structure of an HD video title set cell address table (HDVTS_C_ADT) recorded in HD video title set information (HDVTSI);

FIG. 32 shows an example of the data structure of an HD video title set video object unit address map (HDVTS_VOBU_ADMAP) recorded in HD video title set information (HDVTSI);

FIG. 33 shows an example of the data structure of program chain general information (PGC_GI) included in program chain information (PGCI: e.g., corresponding to one of HDVTS_PGCI in FIG. 23), and the recording content of a PGC graphics unit stream control table (PGC_GUST_CTLT) and resume/audio object category (RSM&AOB_CAT) stored in the PGCI;

FIG. 34 shows an example of the data structure of a program chain command table (PGC_CMDT) included in the program chain information (PGCI);

FIG. 35 shows an example of the content of program chain command table information (PGC_CMDTI) and each resume command (RSM_CMD) included in the program chain command table (PGC_CMDT);

FIG. 36 shows an example of the data structure of a program chain program map (PGC_PGMAP) and that of a cell position information table (C_POSIT) included in the program chain information (PGCI);

FIG. 37 shows an example of the data structure of a cell playback information table (C_PBIT) included in the program chain information (PGCI);

FIG. 38 is an exemplary block diagram showing an example of the internal structure of a playback apparatus for the disc-shaped information storage medium (optical disc, etc.) according to an embodiment of the invention;

FIG. 39 is an exemplary block diagram for explaining an example of the arrangement of each decoder in the apparatus shown in FIG. 38;

FIG. 40 is an exemplary view for explaining a concept of imaginary video access unit IVAU;

FIG. 41 is an exemplary view for explaining a practical example of system parameters used in an embodiment of the invention;

FIG. 42 shows an example of a list of commands used in an embodiment of the invention;

FIG. 43 shows practical examples in respective fields of the commands used in an embodiment of the invention;

FIG. 44 shows an example of allocation of graphics units GU in video objects;

FIG. 45 shows an example of the data structure in each graphics unit;

FIG. 46 shows an example of header information content and general information content in each graphics unit;

FIG. 47 is an exemplary view for explaining image examples of mask data and graphics data in each graphics unit;

FIG. 48 is an exemplary view showing an example of video composition including mask patterns;

FIG. 49 is an exemplary view for explaining an example of button position information in graphics unit GU;

FIG. 50 is an exemplary view for explaining an example of the recording content of an advanced content recording area of the information content recorded on disc-shaped information storage medium (optical disc, etc.) 1 according to another embodiment of the invention;

FIG. 51 is an exemplary view for explaining an example of the recording content of an advanced HD video title set (AHDVTS) recording area of the information content recorded on disc-shaped information storage medium (optical disc, etc.) 1 according to still another embodiment of the invention;

FIG. 52 shows an example of the data structure of advanced HD video title set information (AHDVTSI) recorded on the advanced HD video title set recording area;

FIG. 53 shows an example of the data structure of an advanced HD video title set information management table (AHDVTSI_MAT) recorded in the advanced HD video title set information (AHDVTSI), and the recording content of category information (AHDVTS_CAT) stored in the management table;

FIG. 54 shows an example of the data structure of an advanced HD video title set part-of-title search pointer table (AHDVTS_PTT_SRPT) recorded in the advanced HD video title set information (AHDVTSI);

FIG. 55 shows an example of the data structure of an advanced HD video title set program chain information table (AHDVTS_PGCIT) recorded in the advanced HD video title set information (AHDVTSI);

FIG. 56 shows an example of the data structure of program chain general information (PGC_GI) included in program chain information (PGCI: e.g., corresponding to AHDVTS_PGCI in FIG. 55);

FIG. 57 shows an example of the data structure of an advanced HD video title set cell address table (AHDVTS_C_ADT) recorded in the advanced HD video title set information (AHDVTSI);

FIG. 58 shows an example of the data structure of a time map information table (TMAPIT) recorded in the advanced HD video title set information (AHDVTSI);

FIG. 59 shows an example of the data structure of each time map information (TMAPI) included in the time map information table (TMAPIT), and the recording content of time map generation information (TMAP_GI) stored in the time map information;

FIG. 60 shows an example of the data structure of a time entry table (TM_ENT) included in the time map information (TMAPI) and the recording content of the number of time entries (TM_EN_Ns) and a time entry (TM_EN) stored in the time entry table;

FIG. 61 shows an example of the recording content of a video object unit entry (VOBU_ENT), those of an interleaved unit address entry (ILVU_ADR_ENT), and those of an entry video object number (ENT_VOBN), which are included in the time map information (TMAPI);

FIG. 62 is a flowchart for explaining an example of the playback sequence of an advanced VTS (AHDVTS in FIGS. 51, 74, 79, and the like) according to the content of information (application type) included in the management information (e.g., AHDVTS_CAT in FIG. 53);

FIG. 63 is an exemplary view for explaining the configuration of a navigation pack (NV_PCK) allocated at the head of each data unit (EVOBU) used in an expanded video object (a video object in an HDVTS) according to an embodiment of the invention;

FIG. 64 shows an example of the data structure of playback control information (PCI) in the navigation pack (NV_PCK) used in the expanded video object;

FIG. 65 shows an example of the data structure of data search information (DSI) in the navigation pack (NV_PCK) used in the expanded video object;

FIG. 66 is an exemplary view for explaining an example of the configuration of an advanced VTS (AHDVTS);

FIG. 67 is an exemplary view for explaining elements which form a time map according to an embodiment of the invention;

FIG. 68 is an exemplary view for explaining practical elements which form the time map;

FIG. 69 shows an example of a case wherein a plurality of objects (e.g., VOB#2 and VOB#3) are to be played back using ILVU data of an interleaved block;

FIG. 70 is an exemplary view for explaining a time map of an ILVU interval in the example of FIG. 69;

FIG. 71 is an exemplary view for explaining a time map in the interleaved block;

FIG. 72 is an exemplary block diagram showing an example of the internal structure of a playback apparatus according to still another embodiment of the invention;

FIG. 73 is an exemplary view for explaining a part (HDVMG_CAT) of the recording content of an HD video manager (HDVMG) recording area of the information content recorded on disc-shaped information storage medium (content type 1 disc) 1 according to still another embodiment of the invention;

FIG. 74 is an exemplary view for explaining the data structure (AHDVMGI is allocated in the HDVMG unlike in the example of FIG. 1) of an HD video manager (HDVMG) recording area of the information content recorded on disc-shaped information storage medium (content type 2 disc example 1) 1 according to still another embodiment of the invention;

FIG. 75 shows an example of the data structure of advanced HD video manager information (AHDVMGI) recorded on the HD video manager (HDVMG) shown in FIG. 74;

FIG. 76 shows an example of the data structure of an advanced HD video manager information management table (AHDVMGI_MAT) included in the advanced HD video manager information (AHDVMGI), and the recording content of category information (HDVMG_CAT) stored in the management table;

FIG. 77 shows an example of the data structure of an advanced title search pointer table (ADTT_SRPT) included in the advanced HD video manager information (AHDVMGI);

FIG. 78 is an exemplary view for explaining a playback model (example 1) of a disc that records an advanced VTS (AHDVTS);

FIG. 79 is an exemplary view for explaining the data structure of video data recording area 20 and advanced content recording area 21 of the information content recorded on disc-shaped information storage medium (content type 2 disc example 2) 1 according to still another embodiment of the invention;

FIG. 80 shows an example of the data structure of advanced HD video manager information (AHDVMGI) that can be recorded in an HD video manager (HDVMG) shown in FIG. 79;

FIG. 81 shows an example of the data structure of an advanced HD video manager information management table (AHDVMGI_MAT) included in the advanced video manager information (AHDVMGI) in FIG. 80, and the recording content (the content different from FIG. 76) of category information (HDVMG_CAT) stored in the management table;

FIG. 82 shows an example of the data structure (the content different from FIG. 77) of an advanced title search pointer table (ADTT_SRPT) included in the advanced video manager information (AHDVMGI) in FIG. 80;

FIG. 83 is an exemplary view for explaining the relationship between the advanced VTS playback state and standard VTS playback state;

FIG. 84 is an exemplary view for explaining a playback control module shift command on the DVD-Video playback engine side;

FIG. 85 is a flowchart for explaining an example of switching algorithm of a user command process;

FIG. 86 is an exemplary view for explaining a domain transition model in a content type 2 disc (FIG. 79, etc.) which records the advanced VTS and standard VTS together;

FIG. 87 is an exemplary view for explaining a playback model (example 2) that records the advanced VTS (AHDVTS) and standard VTS (HDVTS) together;

FIG. 88 is an exemplary view for explaining a unique reference model of objects in a disc that records the advanced VTS (AHDVTS) and standard VTS (HDVTS) together;

FIG. 89 is an exemplary view for explaining a shared reference model of objects in a disc that records the advanced VTS (AHDVTS) and standard VTS (HDVTS) together;

FIG. 90 is an exemplary view for explaining a practical example of loading information included in advanced content;

FIG. 91 is an exemplary block diagram for explaining the arrangement of a buffer manager in an interactive engine of the apparatus shown in FIG. 72;

FIG. 92 is a flowchart for explaining an example of apparatus operation when the interactive engine of the apparatus shown in FIG. 72 is activated.

FIG. 93 is an exemplary view for explaining an example of the configuration of an advanced VTS having multiple PGCS;

FIG. 94 is an exemplary view for explaining an example of the configuration of an advanced VTS having one PGC;

FIG. 95 is an exemplary view for explaining a description example (an example using the chapter/PTT numbers) of a playback sequence in a playback sequence information file (e.g., file PBSEQ001.XML in FIG. 2);

FIG. 96 is an exemplary view for explaining another description example (an example using the cell numbers) of a playback sequence in a playback sequence information file (e.g., a PBSEQ001.XML file or the like);

FIG. 97 is an exemplary view for explaining still another description example (an example using the PGC number and chapter/PTT numbers) of a playback sequence in a playback sequence information file (e.g., file PBSEQ001.XML or the like);

FIG. 98 is an exemplary view for explaining yet another description example (an example using the PGC number and cell numbers) of a playback sequence in a playback sequence information file (e.g., file PBSEQ001.XML or the like);

FIG. 99 is a flowchart for explaining an example of processing for initializing the playback sequence of an advanced VTS by a DVD playback engine using a playback sequence information file (e.g., file PBSEQ001.XML in FIG. 2) (so as to initialize to use a playback sequence based on the description of the playback sequence information file in place of that based on existing PGC information);

FIG. 100 is an exemplary block diagram for explaining an example of the internal structure of a playback apparatus according to still another embodiment of the invention;

FIG. 101 is an exemplary view showing another example of the data structure of an advanced HD video title set program chain information table (AHDVTS_PGCIT) recorded in advanced HD video title set information (AHDVTSI);

FIG. 102 is an exemplary view showing an example of the plane configuration upon super in posing output frames of respective modules in a video mixer shown in FIG. 100;

FIG. 103 is an exemplary view for explaining an example of time map information (TMAPI) including no time entry in a case wherein one TMAPI is stored in one TMAP file;

FIG. 104 is an exemplary view for explaining an example of time map information (TMAPI) including no time entry in a case wherein one or more pieces (in this example, two pieces) of TMAPI are stored in one TMAP file;

FIG. 105 is an exemplary view for explaining the configuration of time map information for EVOBs which are allocated in an interleaved block and form angles;

FIG. 106 is an exemplary view showing an example of the data structure of a time map information table (TMAPIT) including no time entry;

FIG. 107 is an exemplary view showing an example of the data structure of time map information (TMAPI) including no time entry;

FIG. 108 is an exemplary view showing an example of the data structure of control packs (standard GCI_PCK and advanced GCI_PCK) including general control information (GCI);

FIG. 109 is an exemplary view showing an example of the data structure of general control information (GCI);

FIG. 110 is an exemplary view for explaining another example of the data structure of advanced HD video title set information (advanced VTSI) recorded in the advanced HD video title set recording area;

FIG. 111 is an exemplary view showing an example of the data structure of an advanced HD video title set attribute information table (AHDVTS_ATRIT) stored in the advanced VTSI in FIG. 110;

FIG. 112 is an exemplary view showing an example of the data structure of an advanced HD video title set EVOB information table (AHDVTS_EVOBIT) stored in the advanced VTSI in FIG. 110;

FIG. 113 is an exemplary view showing an example of a case (case 1) in which one program stream obtained by multiplexing a primary object (movie object) and secondary object (advanced object) is recorded on a disc, and another advanced object (secondary object) exists as another independent program stream on an external communication line (Web);

FIG. 114 is an exemplary diagram for explaining a decoding model of case 1;

FIG. 115 is an exemplary view showing an example of a case (case 2-1) in which a program stream of a primary object and that of a secondary object (two program streams multiplexed for respective packs) are recorded on a disc, and another advanced object (secondary object) exists as another independent program stream on an external communication line (Web);

FIG. 116 is an exemplary diagram for explaining a decoding model of case 2-1;

FIG. 117 is an exemplary view showing an example of a case (case 2-2) in which a program stream of a primary object and that of a secondary object (two program streams multiplexed for respective access units) are recorded on a disc, and another advanced object (secondary object) exists as another independent program stream on an external communication line (Web);

FIG. 118 is an exemplary diagram for explaining a decoding model of case 2-2;

FIG. 119 is an exemplary view for explaining an example of stream IDs used to identify the content of a primary object and that of a secondary object (a case in which private stream 1 is used to identify objects);

FIG. 120 is an exemplary view showing an example of the configuration of substream IDs for private stream 1 in the stream IDs shown in FIG. 119;

FIG. 121 is an exemplary view showing an example of the configuration of substream IDs for private stream 2 in the stream IDs shown in FIG. 119;

FIG. 122 is an exemplary view for explaining another example of stream IDs used to identify the content of a primary object and that of a secondary object (a case in which new private stream 3 is set to identify objects);

FIG. 123 is an exemplary view showing an example of the configuration of substream IDs for private stream 1 in the stream IDs shown in FIG. 122;

FIG. 124 is an exemplary view showing an example of the configuration of substream IDs for private stream 2 in the stream IDs shown in FIG. 122;

FIG. 125 is an exemplary view showing an example of the configuration of substream IDs for private stream 3 in the stream IDs shown in FIG. 122;

FIG. 126 is a flowchart for explaining an example of the processing sequence when a primary object and/or a secondary object are/is to be played back from a disc and/or an external communication line (Web);

FIG. 127 is an exemplary view for explaining playback routes of a primary object and secondary object from a disc;

FIG. 128 is an exemplary view for explaining playback routes of a primary object from a disc and a secondary object from an external communication line (Web);

FIG. 129 is an exemplary view showing an example of the data structure of a time map information table including a type flag (TMAP_TYPE_FL) of time maps;

FIG. 130 is an exemplary view for explaining Markup description example 1;

FIG. 131 is an exemplary view for explaining Markup description example 2;

FIG. 132 is an exemplary view for explaining Markup description example 3;

FIG. 133 is an exemplary view showing another example of a case (case 1a) in which one program stream obtained by multiplexing a primary object (movie object) and secondary object (advanced object) is recorded on a disc, and another advanced object (secondary object) exists as another independent program stream on an external communication line (Web);

FIG. 134 is an exemplary view showing still another example of a case (case 1b) in which one program stream obtained by multiplexing a primary object (movie object) and secondary object (advanced object) is recorded on a disc, and another advanced object (secondary object) exists as another independent program stream on an external communication line (Web);

FIG. 135 is an exemplary diagram for explaining a decoding model of case 1a;

FIG. 136 is an exemplary view for explaining an example of the operation of a smoothing buffer in the decoding model of case 1a;

FIG. 137 is an exemplary view showing an example of an outline of an advanced content on a disc;

FIG. 138 is an exemplary block diagram exemplifying an outline of the playback system model of an advanced content;

FIG. 139 is an exemplary block diagram for explaining an example of a data flow in the playback system model of the advanced content;

FIG. 140 is an exemplary block diagram for explaining another example of a data flow in the playback system model of the advanced content;

FIG. 141 is an exemplary block diagram for explaining still another example of a data flow in the playback system model of the advanced content;

FIG. 142 is an exemplary block diagram for explaining yet another example of a data flow in the playback system model of the advanced content;

FIG. 143 is an exemplary block diagram for explaining an example of a blending model of picture outputs in the playback system model of the advanced content;

FIG. 144 is an exemplary view showing a practical example of the blending model of picture outputs;

FIG. 145 is an exemplary diagram for explaining an example of a mixing model of audio outputs in the playback system model of the advanced content;

FIG. 146 is an exemplary diagram for explaining an example of user interface processing in the playback system model of the advanced content;

FIG. 147 is a flowchart for explaining an example of the flow of startup processing after disc insertion;

FIG. 148 is an exemplary view for explaining a configuration example of an advanced content;

FIG. 149 is an exemplary view for explaining a configuration example of video title set information (VTSI);

FIG. 150 is an exemplary view for explaining a configuration example of a video title set information management table (VTSI_MAT);

FIG. 151 is an exemplary view for explaining a configuration example of a video title set category (VTS_CAT);

FIG. 152 is an exemplary view for explaining a configuration example of a video title set enhanced video object attribute table (VTS_EVOB_ATRT);

FIG. 153 is an exemplary view for explaining a configuration example of video title set enhanced video object attribute table information (VTS_EVOB_ATRTI);

FIG. 154 is an exemplary view for explaining a configuration example of a video title set enhanced video object attribute search pointer (VTS_EVOB_ATR_SRP);

FIG. 155 is an exemplary view for explaining a configuration example of a video title set enhanced video object attribute (VTS_EVOB_ATR);

FIG. 156 is an exemplary view for explaining a configuration example of an enhanced video object attribute (EVOB_ATR);

FIG. 157 is an exemplary view for explaining a configuration example of a main video attribute of an enhanced video object (EVOB_VM_ATR);

FIG. 158 is an exemplary view for explaining a practical example of parameters in the main video attribute of an enhanced video object (EVOB_VM_ATR);

FIG. 159 is an exemplary view for explaining a configuration example of a sub video attribute of an enhanced video object (EVOB_VS_ATR);

FIG. 160 is an exemplary view for explaining a configuration example of the number of main audio streams in an enhanced video object (EVOB_AMST_Ns);

FIG. 161 is an exemplary view for explaining a configuration example of a main audio stream attribute table of an enhanced video object (EVOB_AMST_ATRT);

FIG. 162 is an exemplary view for explaining a configuration example of each main audio stream attribute of an enhanced video object (EVOB_AMST_ATR);

FIG. 163 is an exemplary view for explaining a practical example of parameters in the main audio stream attribute of an enhanced video object (EVOB_AMST_ATR);

FIG. 164 is an exemplary view for explaining a configuration example of a multichannel main audio stream attribute table of an enhanced video object (EVOB_MU_AMST_ATRT);

FIG. 165 is an exemplary view for explaining a configuration example of each multichannel main audio stream attribute of an enhanced video object (EVOB_MU_AMST_ATR);

FIG. 166 is an exemplary view for explaining a configuration example of the number of sub audio streams in an enhanced video object (EVOB_ASST_Ns);

FIG. 167 is an exemplary view for explaining a configuration example of a sub audio stream attribute table of an enhanced video object (EVOB_ASST_ATRT);

FIG. 168 is an exemplary view for explaining a configuration example of each sub audio stream attribute of an enhanced video object (EVOB_ASST_ATR);

FIG. 169 is an exemplary view for explaining a configuration example of the number of Sub-picture streams in an enhanced video object (EVOB_SPST_Ns);

FIG. 170 is an exemplary view for explaining a configuration example of a Sub-picture stream attribute table of an enhanced video object (EVOB_SPST_ATRT);

FIG. 171 is an exemplary view for explaining a configuration example of each Sub-picture stream attribute of an enhanced video object (EVOB_SPST_ATR);

FIG. 172 is an exemplary view for explaining a practical example of parameters in a main audio stream attribute of an enhanced video object (EVOB_AMST_ATR);

FIG. 173 is an exemplary view for explaining a configuration example of a palette (EVOB_SDSP_PLT) that describes luminance/color difference signals (256 sets) shared by all SD Sub-picture streams in each enhanced video object;

FIG. 174 is an exemplary view for explaining a configuration example of a palette (EVOB_HDSP_PLT) that describes luminance/color difference signals (256 sets) shared by all HD Sub-picture streams in each enhanced video object;

FIG. 175 is a view for explaining a configuration example of a video title set enhanced video object information table (VTS_EVOBIT);

FIG. 176 is an exemplary view for explaining a configuration example of video title set enhanced video object information table information (VTS_EVOBITI);

FIG. 177 is an exemplary view for explaining a configuration example of a video title set enhanced video object information search pointer (VTS_EVOBI_SRP);

FIG. 178 is an exemplary view for explaining a configuration example of video title set enhanced video object information (VTS_EVOBI);

FIG. 179 is an exemplary view for explaining an example of the contents of an EVOBS_ID in the video title set enhanced video object information (VTS_EVOBI);

FIG. 180 is an exemplary view for explaining an example of parameters in the video title set enhanced video object information (VTS_EVOBI);

FIG. 181 is an exemplary view for explaining a configuration example of a time map (TMAP) for a primary video set;

FIG. 182 is an exemplary view for explaining a configuration example of time map general information (TMAP_GI);

FIG. 183 is an exemplary view for explaining a configuration example of a time map type (TMAP_TY);

FIG. 184 is an exemplary view for explaining a configuration example of a time map information search pointer (TMAPI_SRP);

FIG. 185 is an exemplary view showing an example of a TMAP for an interleaved block;

FIG. 186 is an exemplary view for explaining a configuration example of time map information (TMAPI) which starts from entry information (EVOBU_ENT#1 to EVOBU_ENT#i) of one or more enhanced video object units;

FIG. 187 is an exemplary view for explaining a configuration example of enhanced video object unit entry information (EVOBU_ENTI);

FIG. 188 is an exemplary view for explaining a configuration example of interleaved unit information (ILVUI) which exists when time map information is for an interleaved block;

FIG. 189 is an exemplary view for explaining a configuration example of interleaved unit entry information (ILVU_ENTI);

FIG. 190 is an exemplary view for explaining a list of pack types in an enhanced video object;

FIG. 191 is an exemplary view for explaining a restriction example of transfer rates on streams of an enhanced video object;

FIG. 192 is an exemplary view for explaining a configuration example of a primary enhanced video object (P-EVOB);

FIG. 193 is an exemplary view for explaining a restriction example of elements on a primary enhanced video object stream;

FIG. 194 is an exemplary view for explaining a configuration example of a stream id and stream id extension;

FIG. 195 is an exemplary view for explaining a configuration example of a substream id for private stream 1;

FIG. 196 is an exemplary view for explaining a configuration example of a substream id for private stream 2;

FIG. 197 is an exemplary view for explaining a configuration example of a navigation pack (NV_PCK) aligned at the head of an enhanced video object unit (EVOBU);

FIG. 198 is an exemplary view for explaining a configuration example of a system header of the navigation pack;

FIG. 199 is an exemplary view for explaining a configuration example of a buffer size boundary (P-STD_buf_size_bound) for MPEG-2/MPEG-4 AVC/SMPTE VC-1 video elementary streams;

FIG. 200 is an exemplary view for explaining a configuration example of a general control information (GCI) packet;

FIG. 201 is an exemplary view for explaining a configuration example of a data search information (DSI) packet;

FIG. 202 is an exemplary view for explaining a configuration example of a video packet for MPEG-2 or MPEG-4 AVC;

FIG. 203 is an exemplary view for explaining a configuration example of a video packet for SMPTE VC-1;

FIG. 204 is an exemplary view for explaining a configuration example of an audio packet for DD+;

FIG. 205 is an exemplary view for explaining a configuration example of an audio packet for DTS-HD;

FIG. 206 is an exemplary view for explaining a configuration example of an advanced pack (ADV_PCK) and the first pack of a video object unit/time unit (VOBU/TU);

FIG. 207 is an exemplary view for explaining a configuration example of an advanced packet;

FIG. 208 is an exemplary view for explaining a restriction example of MPEG-2 video for a main video stream;

FIG. 209 is an exemplary view for explaining a restriction example of MPEG-2 video for a sub video stream;

FIG. 210 is an exemplary view for explaining a restriction example of MPEG-4 AVC video for a main video stream;

FIG. 211 is an exemplary view for explaining a restriction example of MPEG-4 AVC video for a sub video stream;

FIG. 212 is an exemplary view for explaining a restriction example of SMPTE VC-1 video for a main video stream;

FIG. 213 is an exemplary view for explaining a restriction example of SMPTE VC-1 video for a sub video stream;

FIG. 214 is an exemplary view for explaining a configuration example of a time map (TMAP) for a secondary video set;

FIG. 215 is an exemplary view for explaining a configuration example of a TMAPI_SRP;

FIG. 216 is an exemplary view for explaining a configuration example of an EVOB_ATR;

FIG. 217 is an exemplary view for explaining elements in the EVOB_ATR;

FIG. 218 is an exemplary view for explaining a list of pack types in a secondary enhanced video object;

FIG. 219 is an exemplary view for explaining a configuration example of a secondary enhanced video object (S-EVOB);

FIG. 220 is an exemplary view for explaining a configuration example of a stream id and stream id extension, that of a substream id for private stream 1, and that of a substream id for private stream 2;

FIG. 221 is an exemplary view for explaining a restriction example of JPEG data;

FIG. 222 is an exemplary view for explaining a restriction example of PNG data;

FIG. 223 is an exemplary view for explaining a configuration example of PNG chunks;

FIG. 224 is an exemplary view for explaining a configuration example of critical PNG chunks;

FIG. 225 is an exemplary view for explaining a configuration example of ancillary PNG chunks;

FIG. 226 is an exemplary block diagram for explaining an example of the arrangement of an MNG decoder;

FIG. 227 is an exemplary view for explaining a configuration example of MNG chunks;

FIG. 228 is an exemplary view for explaining a configuration example of critical MNG control chunks;

FIG. 229 is an exemplary view for explaining a configuration example of critical MNG image defining chunks;

FIG. 230 is an exemplary view for explaining a configuration example of critical MNG image displaying chunks;

FIG. 231 is an exemplary view for explaining a configuration example of JNG chunks;

FIG. 232 is an exemplary view for explaining a configuration example of critical JNG chunks;

FIG. 233 is an exemplary view for explaining a configuration example of ancillary JNG chunks;

FIG. 234 is an exemplary view for explaining a configuration example of a font system model;

FIG. 235 is an exemplary view for explaining the relationship between pieces of information associated with a playlist;

FIG. 236 is an exemplary view for explaining a configuration example of the playlist;

FIG. 237 is an exemplary view for explaining an example of the allocation of a presentation object on the timeline;

FIG. 238 is an exemplary view for explaining an example when trick play (chapter jump or the like) of a presentation object is made on the timeline;

FIG. 239 is an exemplary view for explaining a configuration example of the playlist when an object includes angle information;

FIG. 240 is an exemplary view for explaining a configuration example of the playlist when an object includes multi-story data;

FIG. 241 is an exemplary view for explaining a description example (when an object includes angle information) of object mapping information in the playlist;

FIG. 242 is an exemplary view for explaining a description example (when an object includes multi-story data) of object mapping information in the playlist;

FIG. 243 is an exemplary view for explaining a description example (when an object includes angle information) of a playback sequence in the playlist;

FIG. 244 is an exemplary view for explaining a description example (when an object includes multi-story data) of a playback sequence in the playlist;

FIG. 245 is an exemplary view for explaining a description example of configuration information in the playlist;

FIG. 246 is an exemplary view for explaining examples (four examples in this case) of an advanced object type;

FIG. 247 is an exemplary view for explaining an example of a playlist in case of a synchronized advanced object;

FIG. 248 is an exemplary view for explaining a description example of a playlist in case of a synchronized advanced object;

FIG. 249 is an exemplary view for explaining an example of a playlist in case of a non-synchronized advanced object;

FIG. 250 is an exemplary view for explaining a description example of a playlist in case of a non-synchronized advanced object;

FIG. 251 is an exemplary view for explaining a playlist for various playback processes of an advanced object;

FIG. 252 is an exemplary view for explaining an example of a playlist upon playing back an object including bonus contents;

FIG. 253 is an exemplary view for explaining points to remember (multiplexing rules) when an application to be used in the next enhanced video object to be played back is multiplexed on the current enhanced video object whose playback is in progress so as to attain seamless playback;

FIG. 254 is an exemplary view for explaining an example of the physical allocation and playback sequence of enhanced video objects when an application used in the next enhanced video object to be played back is multiplexed on the current enhanced video object whose playback is in progress;

FIG. 255 is an exemplary view for explaining an example when processing for interrupting (or repeating) the progress of the timeline is executed in a playlist (still setting);

FIG. 256 is an exemplary view for explaining a description example of object mapping information in a playlist upon executing the processing for interrupting (or repeating) the progress of the timeline (still setting);

FIG. 257 is an exemplary view for explaining a description example of playlists independently prepared for respective titles;

FIG. 258 is an exemplary view for explaining a description example of playlists independently prepared for respective titles;

FIG. 259 is an exemplary view for explaining the relationship between pieces of information when a playlist is provided;

FIG. 260 is an exemplary view for explaining playlist categorization upon startup;

FIG. 261 is an exemplary view for explaining description example 1 (only one piece of playlist information) of a startup file;

FIG. 262 is an exemplary view for explaining description example 2 (a plurality of pieces of playlist information) of a startup file;

FIG. 263 is an exemplary view for explaining the relationship between pieces of information when no playlist is provided;

FIG. 264 is an exemplary view for explaining another example of object mapping information (when presentation objects are allocated using time periods defined on the timeline) in a playlist;

FIG. 265 is an exemplary view for explaining a description example of a playlist (when object mapping information and a playback sequence are described for each title);

FIG. 266 is an exemplary view for explaining a description example of object mapping information (when angles are implemented by individual TMAP files);

FIG. 267 is an exemplary view for explaining a description example of object mapping information (when audio and subtitle streams multiplexed on a primary video set are recombined or when non-multiplexed additional audio and subtitle streams are allowed to be selected);

FIG. 268 is an exemplary view for explaining another description example of object mapping information;

FIG. 269 is an exemplary flowchart for explaining an example of a sequence when a predetermined one of one or more playlists is selected, and playback is made based on the selected playlist;

FIG. 270 is an exemplary view showing an example of the timeline and the relationship between the starting position and start/end time of a P-EVOB; and

FIG. 271 is an exemplary view showing another example of a secondary enhanced video object (S-EVOB) (another example of FIG. 219).

### DETAILED DESCRIPTION

Various embodiments according to the invention will be described hereinafter with reference to the accompanying drawings. In general, an embodiment of the invention can provide an environment, with respect to content recorded on a read-only information storage medium such as a DVD-video disc, to implement video objects to be played back by a method different from an existing playback sequence and/or control of its playback order.

An information storage medium according to one embodiment of the invention may comprise a file information area and a data area including a video data recording area and an advanced content recording area. The file information area may store file information corresponding to or relating to recording contents of the data area. The video data recording area may comprise a management area and an object area. The management area may record management information (e.g., HDVMG). The object area may record objects (e.g., HDVTS, AHDVTS) to be managed by the management information. The advanced content recording area may include information (e.g., 21A to 21E) different from recording contents (e.g., 30 to 50) of the video data recording area.

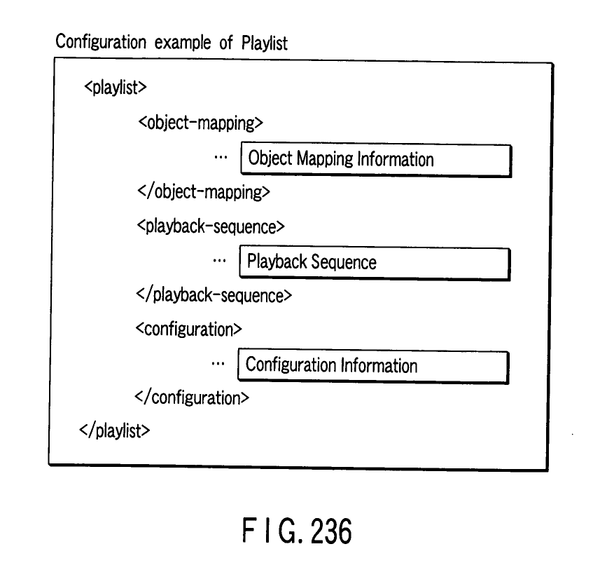

Here the data area (e.g., 211A, 215A) may be configured to store playlist information (e.g., Object Mapping Information, Playback Sequence, and Configuration Information in FIG. 236, etc.) which is played back first (or prior to playback of advanced content) when the information storage medium stores an advanced content.

Or, the data area (e.g., 211A, 215A) may be configured to store one or more pieces of playlist information (e.g., FIG. 236) which are played back first, and startup information (e.g., FIG. 262) including information used to determine which one of the one or more pieces of playlist information is to be adopted, when the information storage medium stores an advanced content (e.g., use of a playlist of the latest version can be determined by “_{—}5” in <playlist href=VIDEO_TS/Playlist_{—}5.xml>).

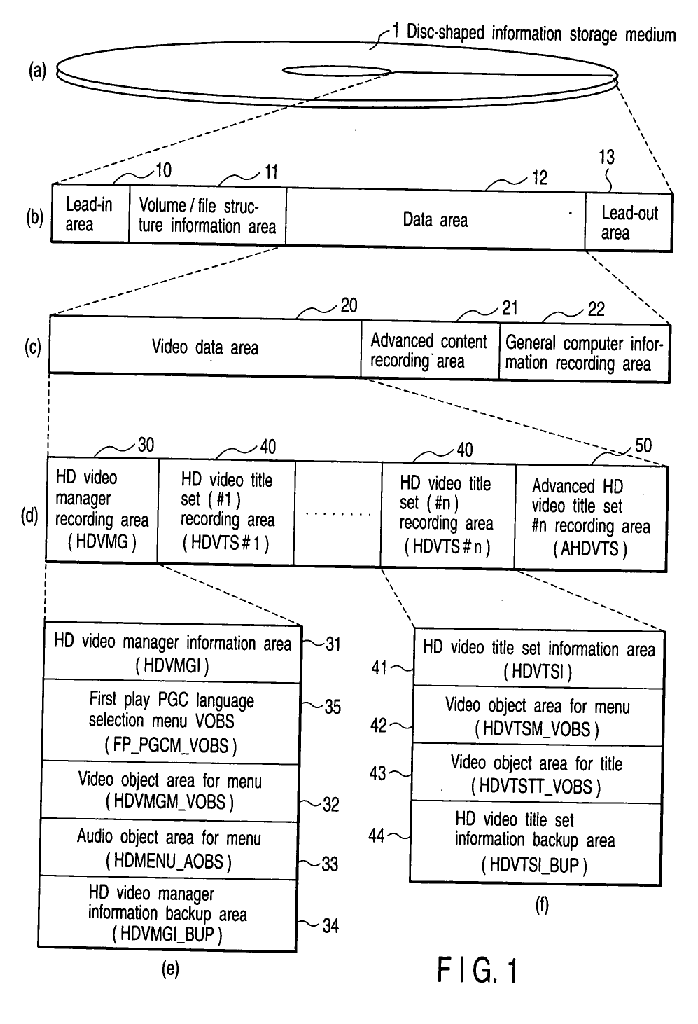

FIG. 1 is a view for explaining the information content recorded on a disc-shaped information storage medium according to the embodiment of the invention. Information storage medium 1 shown in FIG. 1(a) can be configured by a high-density optical disk (a high-density or high-definition digital versatile disc: HD_DVD for short) which uses, e.g., a red laser of a wavelength of 650 nm or a blue laser of a wavelength of 405 nm (or less).

Information storage medium 1 includes lead-in area 10, data area 12, and lead-out area 13 from the inner periphery side, as shown in FIG. 1(b). This information storage medium 1 adopts the ISO 9660 and UDF bridge structures as a file system, and has ISO 9660 and UDF volume/file structure information area 11 on the lead-in side of data area 12.

Data area 12 allows mixed allocations of video data recording area 20 used to record DVD-Video content (also called standard content or SD content), another video data recording area (advanced content recording area used to record advanced content) 21, and general computer information recording area 22, as shown in FIG. 1(c).

Video data recording area 20 includes HD video manager (High Definition-compatible Video Manager [HDVMG]) recording area 30 that records management information associated with the entire HD_DVD-Video content recorded in video data recording area 20, HD video title set (High Definition-compatible Video Title Set [HDVTS], also called standard VTS) recording area 40 which are arranged for respective titles, and record management information and video information (video objects) for respective titles together, and advanced HD video title set (advanced VTS) recording area [AHDVTS] 50, as shown in FIG. 1(d).

HD video manager (HDVMG) recording area 30 includes HD video manager information (High Definition-compatible Video Manager Information [HDVMGI]) area 31 that indicates management information associated with overall video data recording area 20, HD video manager information backup (HDVMGI_BUP) area 34 that records the same information as in HD video manager information area 31 as its backup, and menu video object (HDVMGM_VOBS) area 32 that records a top menu screen indicating whole video data recording area 20, as shown in FIG. 1(e).

In the embodiment of the invention, HD video manager recording area 30 newly includes menu audio object (HDMENU_AOBS) area 33 that records audio information to be output in parallel upon menu display. An area of first play PGC language select menu VOBS (FP_PGCM_VOBS) 35 which is executed upon first access immediately after disc (information storage medium) 1 is loaded into a disc drive is configured to record a screen that can set a menu description language code and the like.

One HD video title set (HDVTS) recording area 40 that records management information and video information (video objects) together for each title includes HD video title set information (HDVTSI) area 41 which records management information for all content in HD video title set recording area 40, HD video title set information backup (HDVTSI_BUP) area 44 which records the same information as in HD video title set information area 41 as its backup data, menu video object (HDVTSM_VOBS) area 42 which records information of menu screens for each video title set, and title video object (HDVTSTT_VOBS) area 43 which records video object data (title video information) in this video title set.

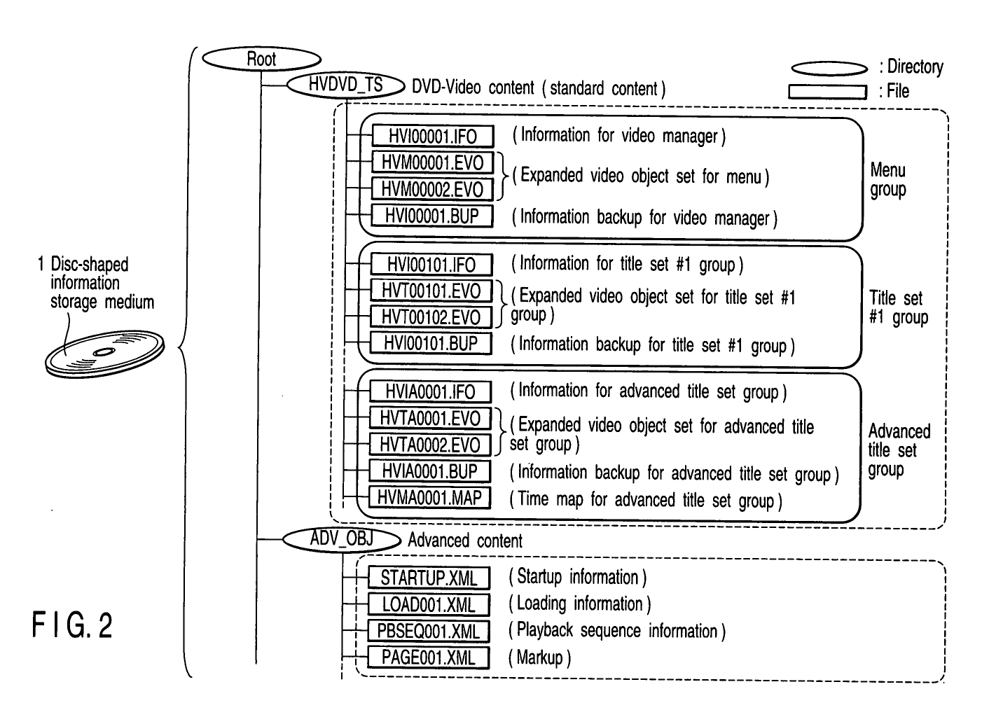

FIG. 2 is a view for explaining an example of a file system which manages content recorded on the disc-shaped information storage medium according to the embodiment of the invention. The areas (30, 40) shown in FIG. 1 form independent files in the file system having the ISO 9660 and UDF bridge structures. Conventional (standard SD) DVD-Video content are allocated together under a directory named “VIDEO_TS”. On the other hand, files according to the embodiment of the invention have a configuration in which an HVDVD_TS directory for storing information files that handle High-Definition video data, and an ADV_OBJ directory for storing information files that handle advanced object data are allocated under a Root directory, as shown in, e.g., FIG. 2.

The HVDVD_TS directory broadly includes a group of files which belong to a menu group used for a menu, and groups of files which belong to title set groups used for titles. As the group of files that belong to the menu group, an information file (HVI00001.IFO) for a video manager having information used to manage the entire disk, its backup file (HVI00001.BUP), and playback data files (HVM00001.EVO to HVM00003.EVO) of expanded video object sets for a menu used as background frames of a menu are stored.

As the group of files that belong to a title set #n group (e.g., title set #1 group), an information file (HVIxxx01.IFO: xxx=001 to 999) for a video title set having information used to manage title set #n, its backup file (HVIxxx01.BUP: xxx=001 to 999), playback data files (HVTxxxyy.EVO: xxx=001 to 999, yy=01 to 99) of expanded video object sets for title set #n used as a title are stored.

Furthermore, as the group of files that belong to an advanced title set group, an information file (HVIA0001.IFO) for a video title set having information used to manage an advanced title set, its backup file (HVIA0001.BUP), playback data files (HVTAxxyy.EVO: xx=01 to 99, yy=01 to 99) of video object sets for advanced title sets used as titles, time map information files (HVMAxxxx.MAP: xxxx=0001 to 9999) for advanced title sets, their backup files (HVMAxxxx.BUP: xxxx=0001 to 9999, not shown), and the like are stored.

The ADV_OBJ directory stores a startup information file (STARTUP.XML), loading information file (LOAD001.XML), playback sequence information file (PBSEQ001.XML), markup language file (PAGE001.XML), moving picture data, animation data, still picture data file, audio data file, font data file, and the like. Note that the content of the startup information file include startup information of data such as moving picture data, animation data, still picture data, audio data, font data, a markup language used to control playback of these data, and the like. The loading information file records loading information (that can be described using a markup language/script language/stylesheet, and the like), which describes information associated with files to be loaded onto a buffer in a playback apparatus, and the like.

The playback sequence information file (PBSEQ001.XML) records playback sequence information (that can be also described using a markup language or the like), which defines a section to be played back of the playback data files of expansion video object sets for advanced title sets in the advanced title set group, and the like.

Note that the markup language is a language that describes text attributes along commands which are defined in advance, and can give the font type, size, color, and the like to a character string as attributes. In other words, the markup language is a description language which describes structures (headings, hyperlinks, and the like) and modification information (character size, the state of composition, and the like) of sentences in these sentences by partially bounding special character strings called tags.

Since a document written using the markup language becomes a text file, the user can normally read it using a text editor, and can edit that file, of course. As typical markup languages, Standard Generalized Markup Language (SGML), Hypertext Markup Language (HTML) evolved from SGML, TeX, and the like are known.

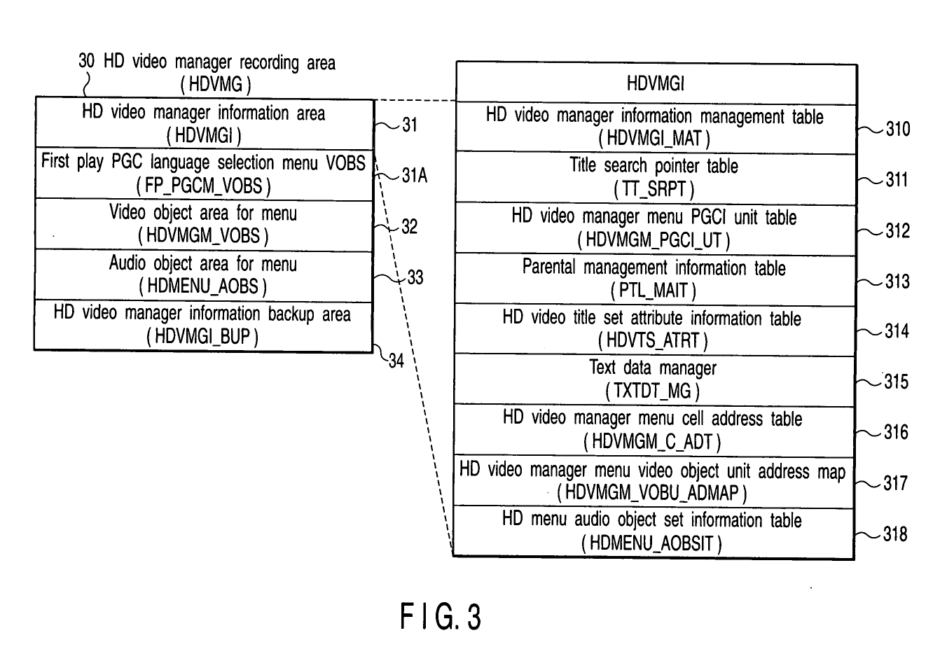

FIG. 3 shows an example of the detailed data structure in HD video manager information (HDVMGI) area 31 shown in FIG. 1(e). At the head of this area 31, HD video manager information management table (HDVMGI_MAT) 310, which records management information common to the entire HD_DVD-Video content recorded in video data recording area 20 together, is allocated. After this table, title search pointer table (TT_SRPT) 311 that records information helpful to search (to detect the start positions of) titles present in the HD_DVD-Video content, HD video manager menu program chain information unit table (HDVMGM_PGCI_UT) 312 that records management information of a menu screen, which is separately allocated for each menu description language code used to display a menu, parental management information table (PTL_MAIT) 313 that records information for managing pictures fit or unfit for children to see as parental information, HD video title set attribute information table (HDVTS_ATRT) 314 that records attributes of title sets together, text data manager (TXTDT_MG) 315 that records text information to be displayed for the user together, HD video manager menu cell address table (HDVMGM_C_ADT) 316 that records information helpful to search for the start address of a cell that forms the menu screen, HD video manager menu video object unit address map (HDVMGM_VOBU_ADMAP) 317 that records address information of VOBU which indicates a minimum unit of video objects that form the menu screen, and HD menu audio object set information table (HDMENU_AOBSIT) 318 are stored in turn. HD menu audio object set information table (HDMENU_AOBSIT) 318 in HD video manager information (HDVMGI) area 31 records management data for objects in menu audio object (HDMENU_AOBS) area 33.

Note that the data structure from HD video manager information management table (HDVMGI_MAT) 310 to HD video manager menu video object unit address map (HDVMGM_VOBU_ADMAP) 317 matches that of the conventional DVD-Video management information.

In the embodiment of the invention, the field of HD menu audio object set information table (HDMENU_AOBSIT) 318 to be newly added is separately allocated after those which match the conventional DVD-Video management information. With this allocation, a description of a conventional control program using the conventional DVD-Video management information can be utilized upon practicing the invention (the description of the control program using management information with the same data structure as in the conventional DVD-Video can be commonly used in the prior art and the invention). In this manner, generation of a control program for an information playback apparatus according to the embodiment of the invention can be simplified.

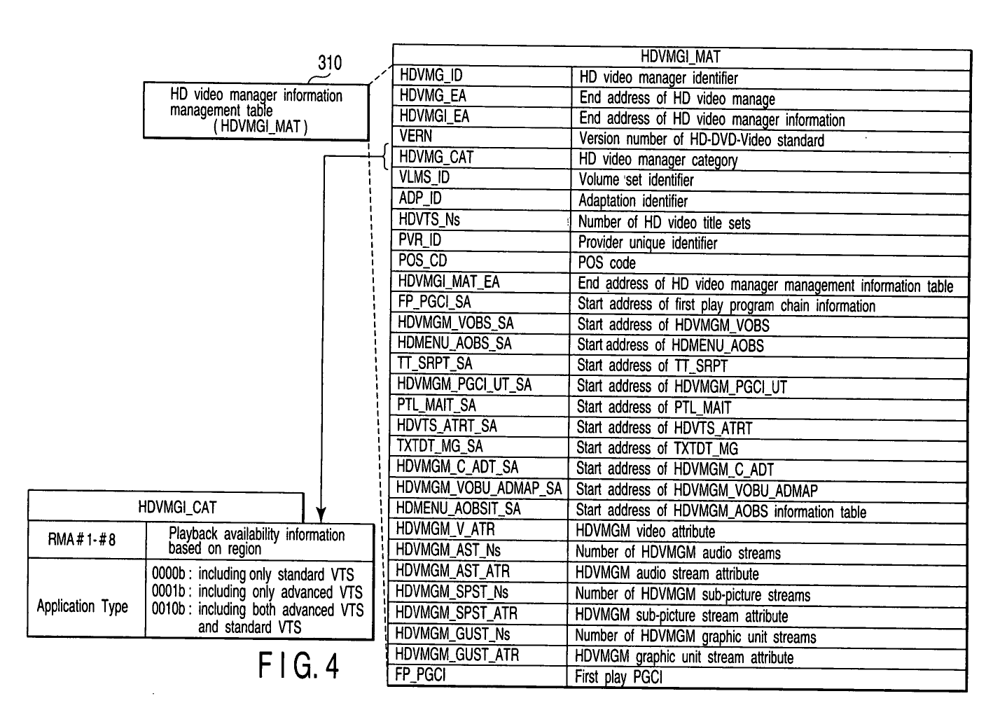

FIG. 4 shows an example of the detailed data structure in HD video manager information management table (HDVMGI_MAT) 310 in FIG. 3. In this management table 310, information of first play PGCI (FP_PGCI) that records language select menu management information for the user, the start address information (HDMENU_AOBS_SA) of an HDMENU_AOBS, the start address information (HDMENU_AOBSIT_SA) of an HDVMGM_AOBS information table, information of the number (HDVMGM_GUST_Ns) of HDVMGM graphics unit streams, HDVMGM graphics unit stream attribute information (HDVMGM_GUST_ATR), and the like are allocated.

In addition, HD video manager information management table (HDVMGI_MAT) 310 records various kinds of information: an HD video manager identifier (HDVMG_ID), the end address (HDVMG_EA) of the HD video manager, the end address (HDVMGI_EA) of the HD video manager information, the version number (VERN) of the HD_DVD-Video standard, an HD video manager category (HDVMG_CAT), a volume set identifier (VLMS_ID), an adaptation identifier (ADP_ID), the number (HDVTS_Ns) of HD video title sets, a provider unique identifier (PVR_ID), a POS code (POS_CD), the end address (HDVMGI_MAT_EA) of the HD video manager information management table, the start address (FP_PGCI_SA) of first play program chain information, the start address (HDVMGM_VOBS_SA) of an HDVMGM_VOBS, the start address (TT_SRPT_SA) of the TT_SRPT, the start address (HDVMGM_PGCI_UT_SA) of the HDVMGM_PGCI_UT, the start address (PTL_MAIT_SA) of the PTL_MAIT, the start address (HDVTS_ATRT_SA) of the HDVTS_ATRT, the start address (TXTDT_MG_SA) of the TXTDT_MG, the start address (HDVMGM_C_ADT_SA) of the HDVMGM_C_ADT, the start address (HDVMGM_VOBU_ADMAP_SA) of the HDVMGM_VOBU ADMAP, an HDVMGM video attribute (HDVMGM_V_ATR), the number (HDVMGM_AST_Ns) of HDVMGM audio streams, an HDVMGM audio stream attribute (HDVMGM_AST_ATR), the number (HDVMGM_SPST_Ns) of HDVMGM sub-picture streams, and an HDVMGM sub-picture stream attribute (HDVMGM_SPST_ATR).

In FIG. 4, the HD video manager category (HDVMG_CAT) includes RMA#1, RMA#2, RMA#3, RMA#4, RMA#5, RMA#6, RMA#7, and RMA#8 which are determined by dividing the world countries into predetermined regions, and indicate playback availability information in respective regions, and application type indicating the VMG category. Note that application type assumes the following values:

Application type=0000b: including only standard VTS

=0001b: including only advanced VTS

=0010b: including both advanced VTS and standard VTS

That is, when application type is “0000b”, it indicates that this information storage medium is the one (content type 1 disc) including only standard VTS; when application type is “0001b”, it indicates that this information storage medium is the one (content type 2 disc) including only advanced VTS; and when application type is “0010b”, it indicates that this information storage medium is the one (content type 2 disc) including both standard VTS and advanced VTS (to be described in detail later).

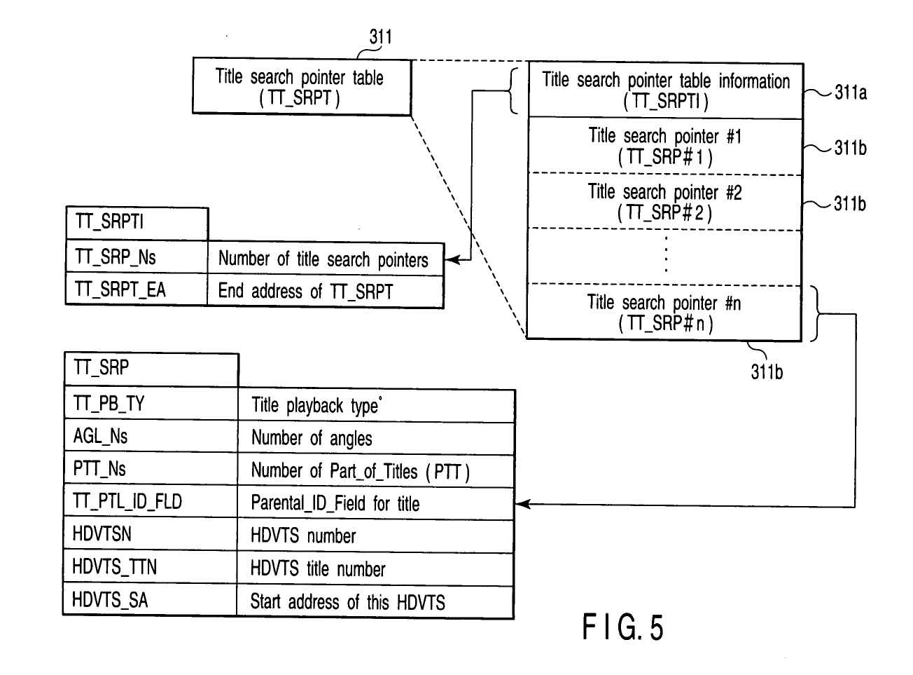

FIG. 5 shows an example of the internal structure of title search pointer table (TT_SRPT) 311 shown in FIG. 3. Title search pointer table (TT_SRPT) 311 includes title search pointer table information (TT_SRPTI) 311a, and title search pointer (TT_SRP) information 311b. One or a plurality of pieces of title search pointer (TT_SRP) information 311b in title search pointer table (TT_SRPT) 311 can be set in correspondence with the number of titles included in the HD_DVD-Video content. Title search pointer table information (TT_SRPTI) 311a records common management information of title search pointer table (TT_SRPT) 311: the number (TT_SRP_Ns) information of title search pointers included in title search pointer table (TT_SRPT) 311, and the end address (TT_SRPT_EA) information of title search pointer table (TT_SRPT) 311 in a file (HD_VMG00.HDI in FIG. 2) of the HD video manager information (HDVMGI) area.

One title search pointer (TT_SRP) information 311b records various kinds of information associated with a title pointed by this search pointer: a title playback type (TT_PB_TY), the number (AGL_Ns) of angles, the number (PTT_Ns) of Part_of_Titles (PTT), title Parental_ID_Field (TT_PTL_ID_FLD) information, an HDVTS number (HDVTSN), an HDVTS title number (HDVTS_TTN), and the start address (HDVTS_SA) of this HDVTS.

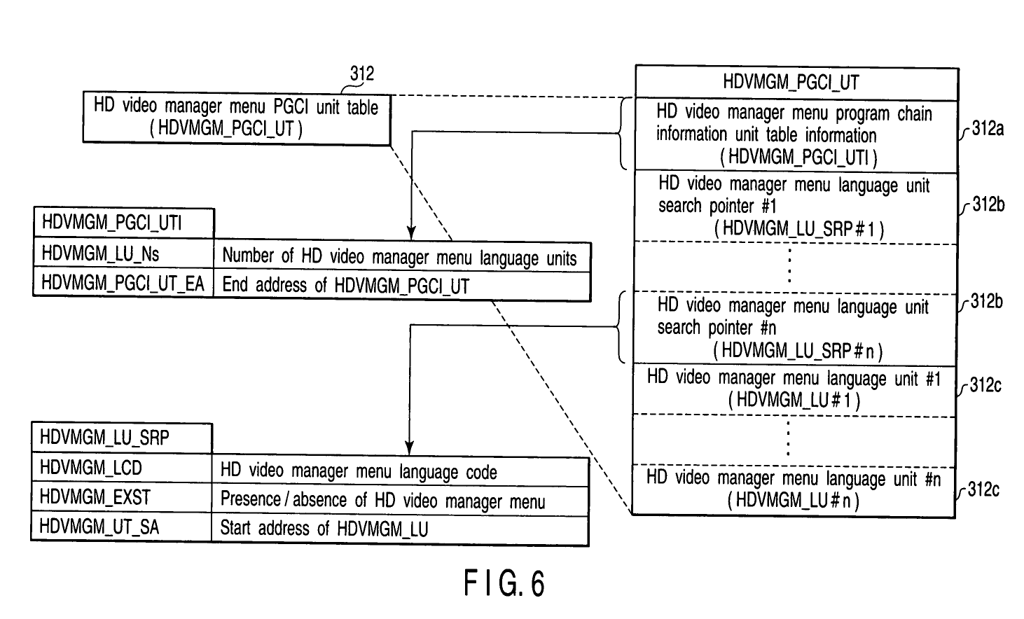

FIG. 6 shows an example of the internal structure of HD video manager menu PGCI unit table (HDVMGM_PGCI_UT) 312 shown in FIG. 3. HD video manager menu PGCI unit table (HDVMGM_PGCI_UT) 312 records HD video manager menu program chain information unit table information (HDVMGM_PGCI_UTI) 312a that records common management information in HD video manager menu PGCI unit table (HDVMGM_PGCI_UT) 312, HD video manager menu language units (HDVMGM_LU) 312c which are arranged for menu description language codes used to display a menu, and record management information associated with menu information, and the like. Table 312 has information of HD video manager menu language units (HDVMGM_LU) 312c as many as the number of menu description language codes supported by the HD_DVD-Video content. HD video manager menu PGCI unit table (HDVMGM_PGCI_UT) 312 has information of HD video manager menu language unit search pointers (HDVMGM_LU_SRP) 312b, which have the start address information of respective HD video manager menu language units (HDVMGM_LU) 312c, as many as the number of HD video manager menu language units (HDVMGM_LU) 312c, so as to facilitate access to HD video manager menu language units (HDVMGM_LU) 312c for respective menu description language codes.

HD video manager menu PGCI unit table information (HDVMGM_PGCI_UTI) 312a has information of the number (HDVMGM_LU_Ns) of HD video manager menu language units, and the end address (HDVMGM_PGCI_UT_EA) of this HD video manager menu PGCI unit table (HDVMGM_PGCI_UT) 312 in a file (HD_VMG00.HDI in FIG. 2) of the HD video manager information (HDVMGI) area.

Each HD video manager menu language unit search pointer (HDVMGM_LU_SRP) information 312b has not only differential address information (HDVMGM_UT_SA) from the start position of HD video manager menu PGCI unit table (HDVMGM_PGCI_UT) 312 in the file (HD_VMG00.HDI in FIG. 2) of the HD video manager information (HDVMGI) area to the head position of corresponding HD video manager menu language unit (HDVMGM_LU) 312c, but also information of an HD video manager menu language code (HDVMGM_LCD) indicating the menu description language code of corresponding HD video manager menu language unit (HDVMGM_LU) 312c, and information of the presence/absence (HDVMGM_EXST) of an HD video manager menu indicating if corresponding HD video manager menu language unit (HDVMGM_LU) 312c has a menu screen to be displayed for the user as a video object (VOB or EVOB).

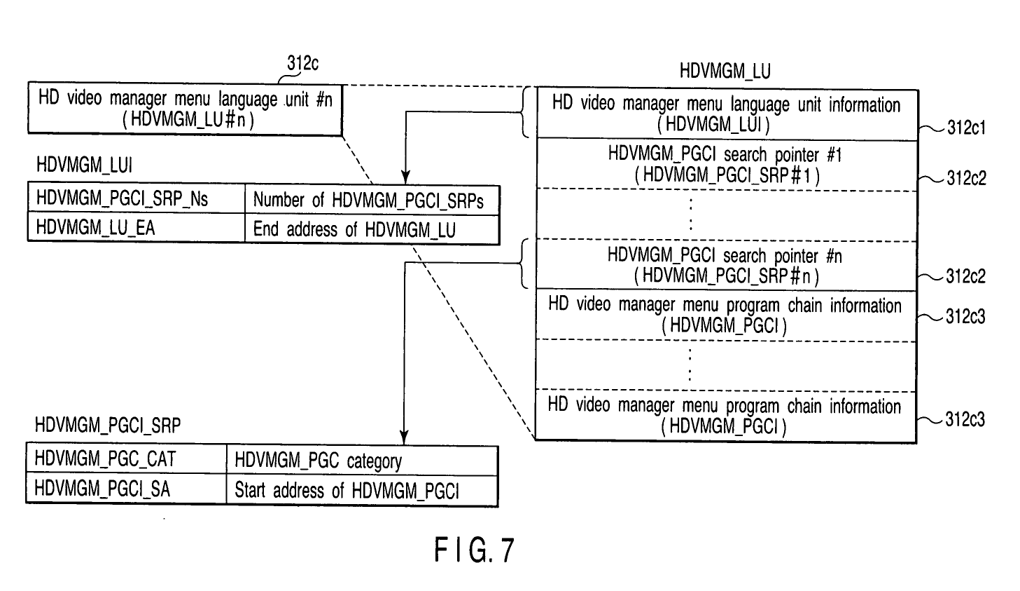

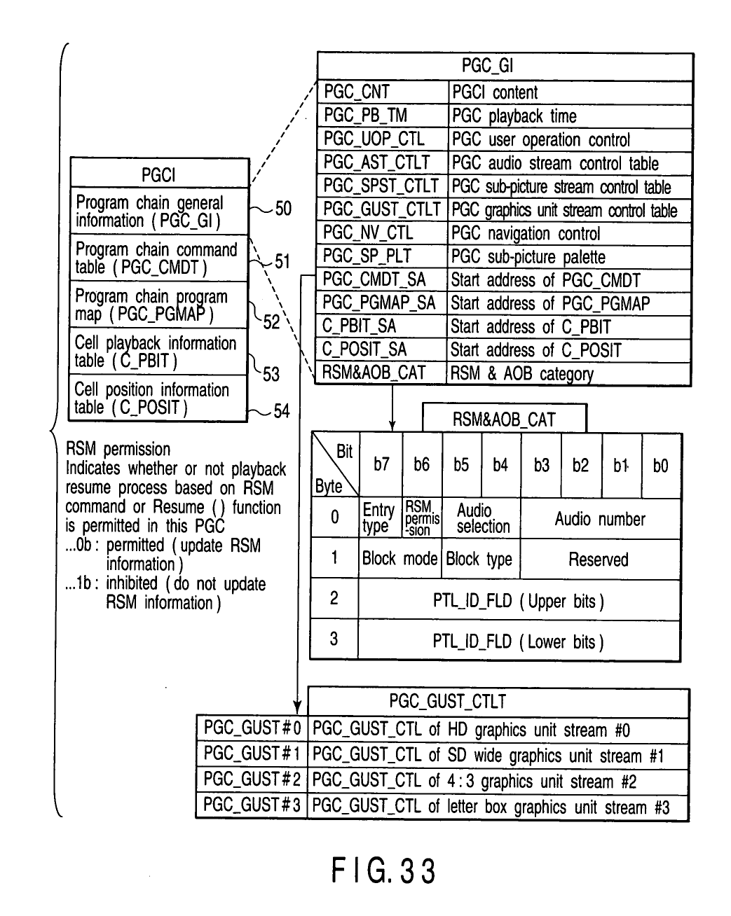

FIG. 7 shows an example of the detailed data structure in HD video manager menu language unit #n (HDVMGM_LU#n) 312c (FIG. 6) recorded in HD video manager menu PGCI unit table (HDVMGM_PGCI_UT) 312 shown in FIG. 3. HD video manager menu language unit (HDVMGM_LU) 312c has the following pieces of information: HD video manager menu language unit information (HDVMGM_LUI) 312c1 that records common management information associated with a menu in HD video manager menu language unit (HDVMGM_LU) 312c, HD video manager menu program chain information (HDVMGM_PGCI) 312c3 having a structure shown in FIG. 33, and information 312c2 of HDVMGM_PGCI search pointers (HDVMGM_PGCI_SRP#1 to HDVMGM_PGCI_SRP#n) each indicating a differential address from the head position of HD video manager menu language unit (HDVMGM_LU) 312c to that of each HD video manager menu program chain information (HDVMGM_PGCI) 312c3 in the file (HD_VMG00.HDI in FIG. 2) of the HD video manager information (HDVMGI) area.

HD video manager menu language unit information (HDVMGM_LUI) 312c1 allocated in the first field (group) in HD video manager menu language unit #n (HDVMGM_LU#n) 312c has information associated with the number (HDVMGM_PCGI_SRP_Ns) of HDVMGM_PGCI_SRP data, and the end address (HDVMGM_LU_EA) information of the HDVMGM_LU. Each information 312c of HDVMGM_PGCI search pointers (HDVMGM_PGCI_SRP#1 to HDVMGM_PGCI_SRP#n) has start address (HDVMGM_PGCI_SA) information of the HDVMGM_PGCI and HDVMGM_PGC category (HDVMGM_PGC_CAT) information.

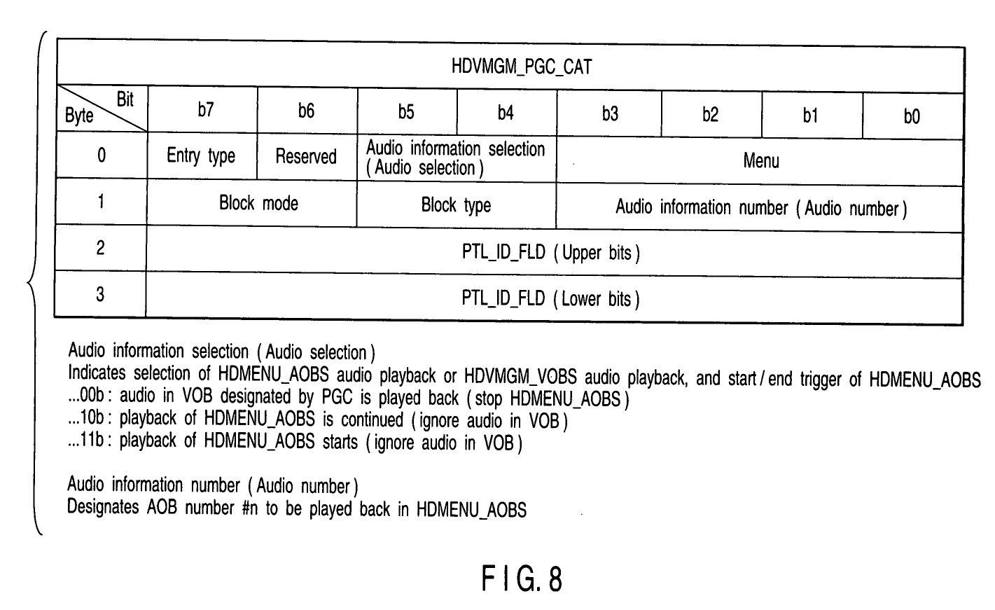

FIG. 8 shows an example of the recording content of the HDVMGM_PGC category (HDVMGM_PGC_CAT) shown in FIG. 7. HDVMGM_PGC category information (HDVMGM_PGC_CAT) in HDVMGM_PGCI search pointer #n (HDVMGM_PGCI_SRP#n) 312c2 records selection information of audio information which is to be simultaneously played back upon displaying an HD content menu in the embodiment of the invention on the screen, and an audio information selection flag (audio selection information) indicating start/end trigger information of audio information playback. As audio data which is to be simultaneously played back upon displaying the HD content menu in the embodiment of the invention on the screen, the following audio data can be selected:

<1> audio data (distributed and recorded in audio packs; not shown) recorded in menu video object area (HDVMGM_VOBS) 32 shown in FIG. 1(e), or

<2> audio data which exist in menu audio object area (HDMENU_AOBS) 33 shown in FIG. 1(e) as one or more menu AOB data (HDMENU_AOB) arranged in turn, as shown in FIG. 19.

When the audio information selection flag (Audio Selection information)=“00b” is selected, audio data <1> are played back, and audio playback is interrupted upon switching menus. When the audio information selection flag (audio selection information)=“10b” or “11b” is selected, audio data <2> of menu AOB (HDMENU_AOB) in menu audio object area (HDMENU_AOBS) 33 are played back. Upon playing back audio data <2>, if the audio information selection flag designates “11b”, the audio data begin to be played back from the beginning every time the menu screen is changed; if it designates “10b”, playback of the audio data continues irrespective of switching of menu screens.

In the embodiment of the invention, menu audio object area (HDMENU_AOBS) 33 can store a plurality of types of menu AOB (HDMENU_AOB) data, as shown in FIG. 19. An audio selection number (audio number information) shown in FIG. 8 can be used as selection information of menu AOB (HDMENU_AOB) to be simultaneously played back upon displaying the menu display PGC of interest. This audio information number can be used to “select which menu AOB from the top” of those which are allocated as menu AOB selection candidates, as shown in FIG. 19.

In addition, the HDVMGM_PGC category (HDVMGM_PGC_CAT) information in FIG. 8 can record entry type information used to check if a PGC of interest is an entry PGC, menu ID information indicating a menu identification (e.g., a title menu or the like), block mode information, block type information, PTL_ID_FLD information, and the like.

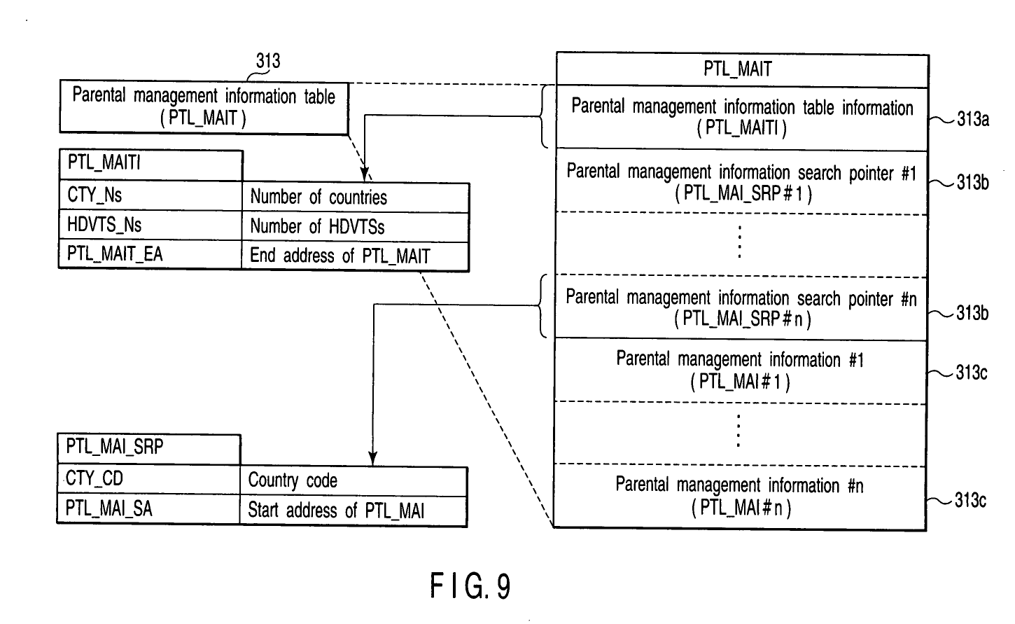

FIG. 9 shows an example of the data structure in parental management information table (PTL_MAIT) 313 shown in FIG. 3. As shown in, e.g., FIG. 9, parental management information table 313 includes parental management information table information (PTL_MAITI) 313a, one or more parental management information search pointers (PTL_MAI_SRP#1 to PTL_MAI_SRP#n) 313b, and a plurality of pieces of parental management information (PTL_MAI#1 to PTL_MAI#n) 313c as many as the number of search pointers. Note that parental management information table information (PTL_MAITI) 313a records information such as the number (CTY_Ns) of countries, the number (HDVTS_Ns) of HDVTS data, the end address (PTL_MAIT_EA) of the PTL_MAIT, and the like. Each parental management information search pointer (PTL_MAI_SRP) 313b records information such as a country code (CTY_CD), the start address (PTL_MAI_SA) of the PTL_MAI, and the like.

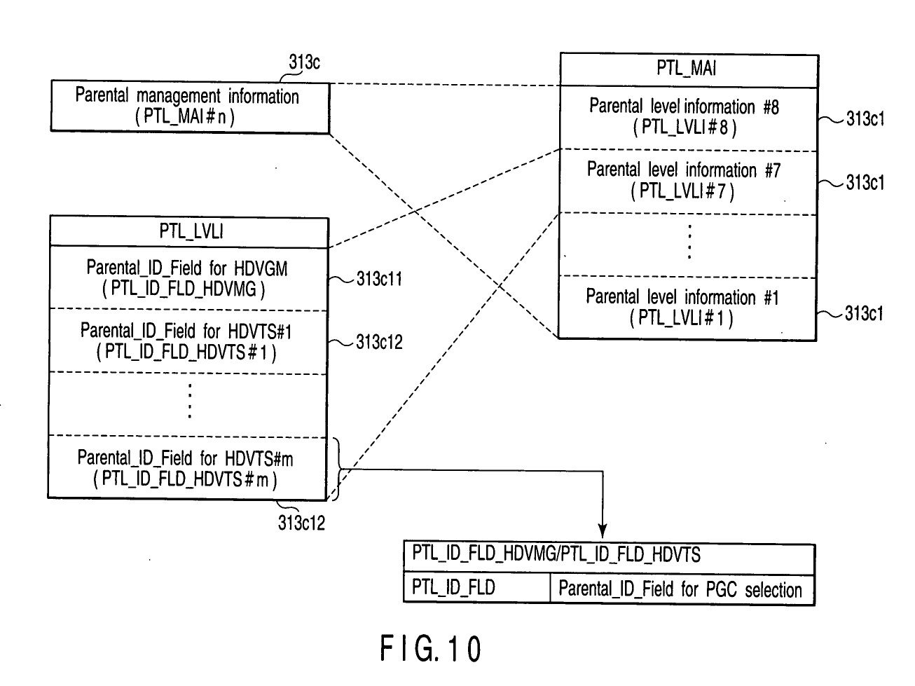

FIG. 10 shows an example of the data structure in parental management information (PTL_MAI) 313c shown in FIG. 9. This parental management information (PTL_MAI) 313c has one or more pieces of parental level information (PTL_LVLI) 313c1. Each parental level information (PTL_LVLI) 313c1 includes information of parental ID field (PTL_ID_FLD_HDVMG) 313c11 for HDVMG, and parental ID field (PTL_ID_FLD_HDVTS) 313c12 for HDVTS. Information of each parental ID field (PTL_ID_FLD_HDVTS) 313c12 for HDVTS can store parental ID field (PTL_ID_FLD) for PGC selection.

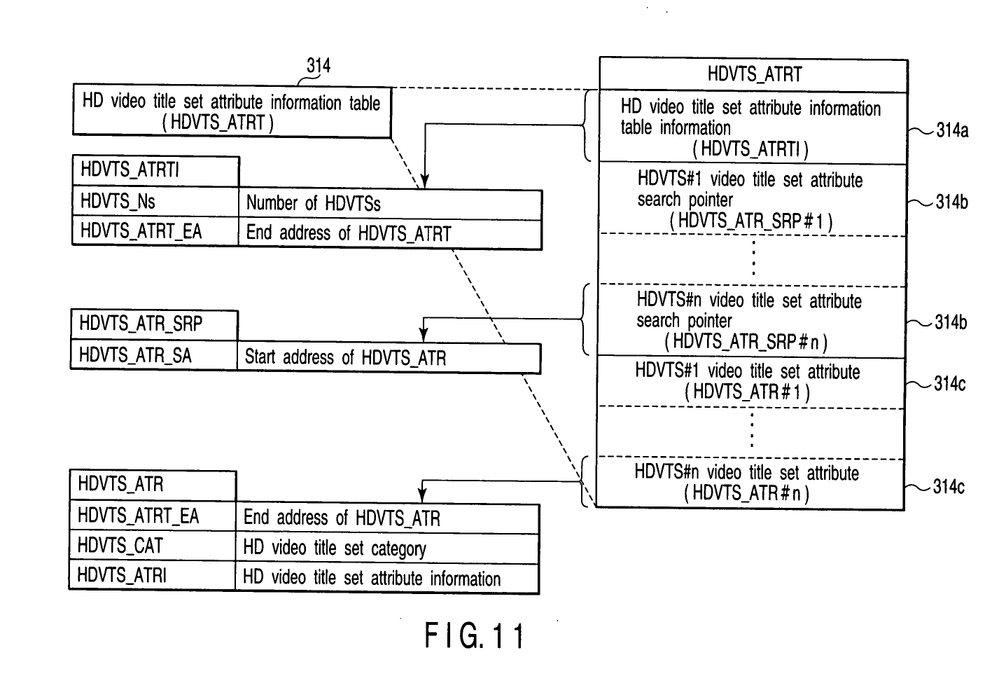

FIG. 11 shows an example of the data structure of HD video title set attribute information table (HDVTS_ATRT) 314 shown in FIG. 3. As shown in FIG. 11, this HD video title set attribute information table 314 includes: HD video title set attribute table information (HDVTS_ATRTI) 314a having information of the number (HDVTS_Ns) of HDVTS data and the end address (HDVTS_ATRT_EA) of the HDVTS_ATRT; HDVTS video title set attribute search pointers (HDVTS_ATR_SRP) 314b each of which records information of the start address (HDVTS_ATR_SA) of the HDVTS_ATR; and HDVTS video title set attributes (HDVTS_ATR) 314c each having information of the end address (HDVTS_ATRT_EA) of the HDVTS_ATR, HD video title set category (HDVTS_CAT), and HD video title set attribute information (HDVTS_ATRI).

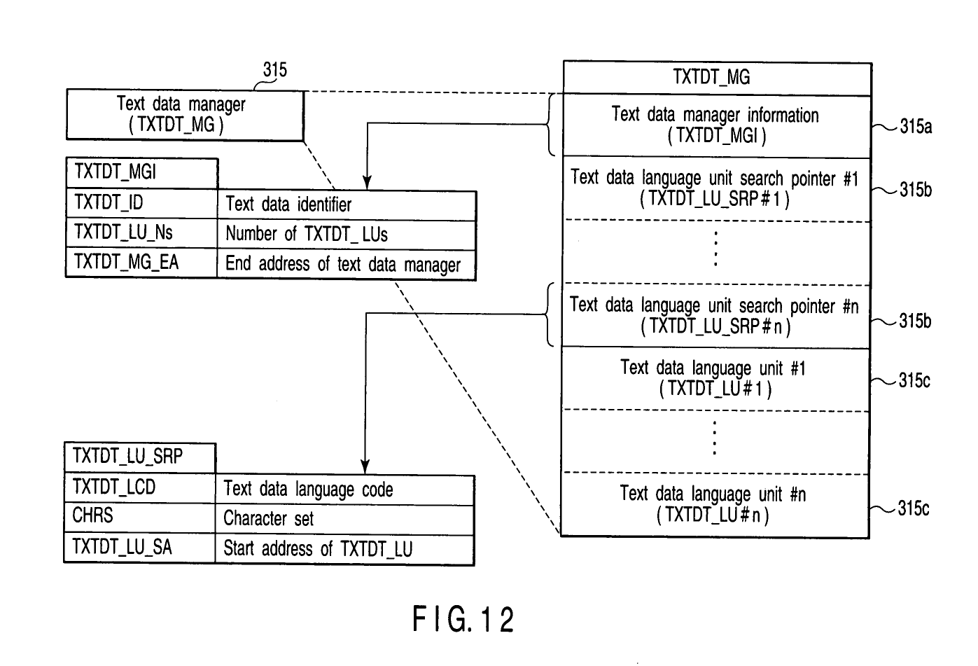

FIG. 12 shows an example of the data structure of text data manager (TXTDT_MG) 315 shown in FIG. 3. As shown in FIG. 12, this text data manager 315 includes text data manager information (TXTDT_MGI) 315a having information of a text data identifier (TXTDT_ID), the number (TXTDT_LU_Ns) of TXTDT_LU data, and the end address (TXTDT_MG_EA) of the text data manager; text data language unit search pointers (TXTDT_LU_SRP) 315b each of which records various kinds of information including a text data language code (TXTDT_LCD), a character set (CHRS), and the start address (TXTDT_LU_SA) of the TXTDT_LU; and text data language units (TXTDT_LU) 315c.

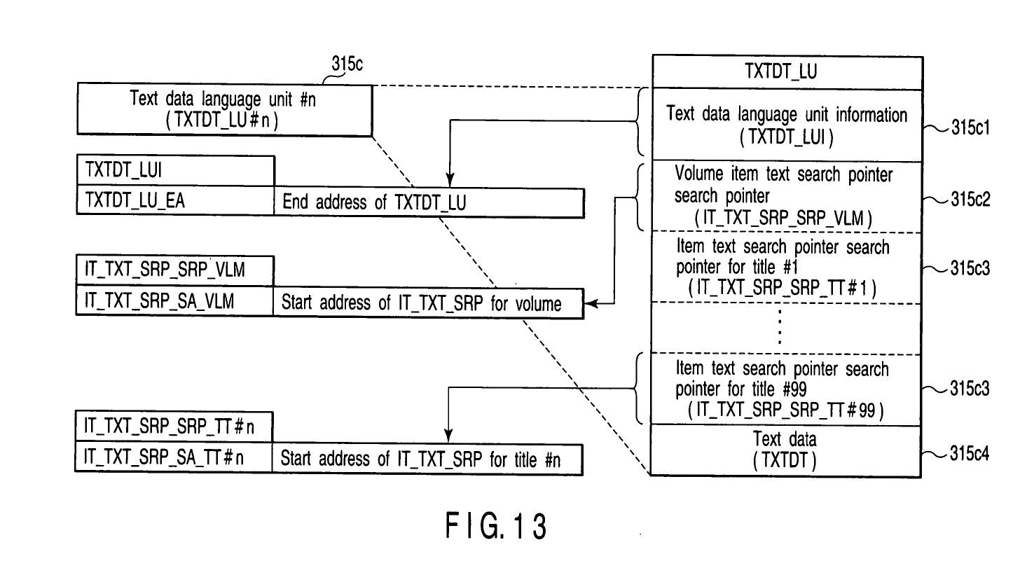

FIG. 13 shows an example of the internal data structure of text data language unit (TXTDT_LU) 315c. As shown in FIG. 13, this text data language unit 315c includes various kinds of information: text data language unit information (TXTDT_LUI) 315c1 that records the end address (TXTDT_LU_EA) information of the TXTDT_LU; item text search pointer search pointer (IT_TXT_SRP_SRP_VLM) 315c2 for volume that records the start address (IT_TXT_SRP_SA_VLM) information of the IT_TXT_SRP for volume; item text search pointer search pointers (IT_TXT_SRP_SRP_TT) 315c3 for volume each of which holds the start address (IT_TXT_SRP_SA_TT) information of the IT_TXT_SRP for title; and text data (TXTDT) 315c4.

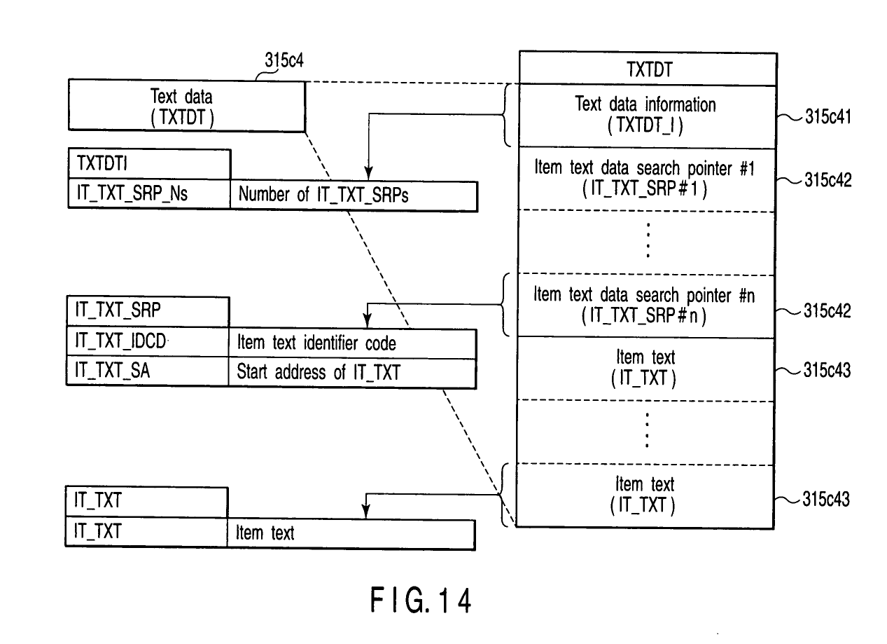

FIG. 14 shows an example of the internal data structure of text data (TXTDT) 315c4. As shown in FIG. 14, this text data 315c4 records various kinds of information: text data information (TXTDTI) 315c41 having information of the number (IT_TXT_SRP_Ns) of IT_TXT_SRP data; item text search pointers (IT_TXT_SRP) 315c42 each of which records an item text identifier code (IT_TXT_IDCD) and the start address (IT_TXT_SA) information of the IT_TXT; and item text (IT_TXT) data 315c43.

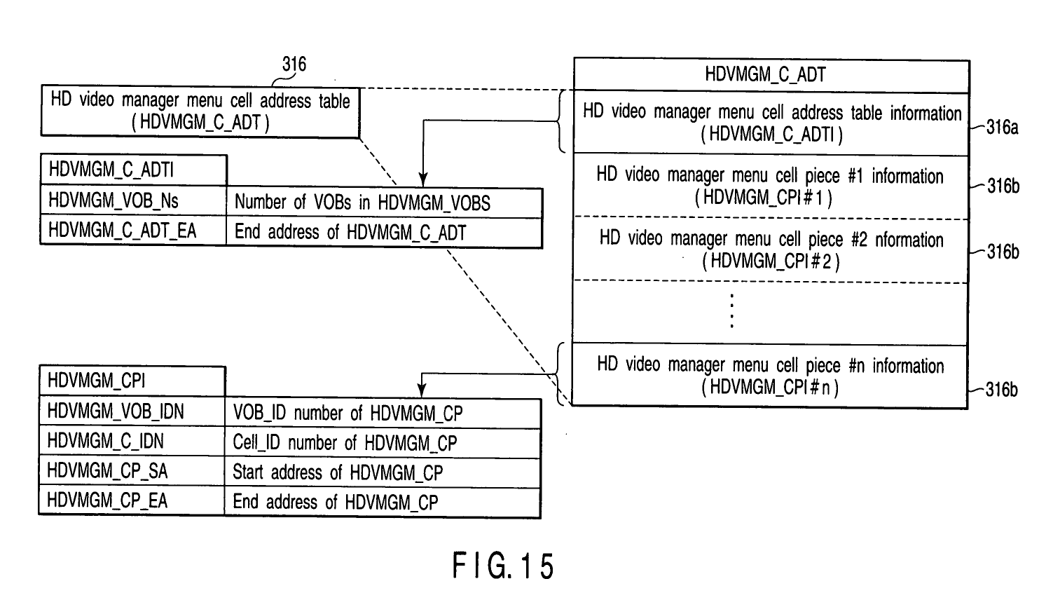

FIG. 15 shows an example of the data structure of HD video manager menu cell address table (HDVMGM_C_ADT) 316 shown in FIG. 3. As shown in FIG. 15, this HD video manager menu cell address table 316 records various kinds of information: HD video manager menu cell address table information (HDVMGM_C_ADTI) 316a having information of the number (HDVMGM_VOB_Ns) of VOB data in HDVMGM_VOBS and the end address (HDVMGM_C_ADT_EA) of the HDVMGM_C_ADT; and a plurality of pieces of HD video manager menu cell piece information (HDVMGM_CPI) 316b each of which records information of a VOB_ID number (HDVMGM_VOB_IDN) of an HDVMGM_CP, a Cell_ID number (HDVMGM_C_IDN) of the HDVMGM_CP, the start address (HDVMGM_CP_SA) of the HDVMGM_CP, and the end address (HDVMGM_CP_EA) of the HDVMGM_CP (“CP” of HDVMGM_CP indicates a cell piece).

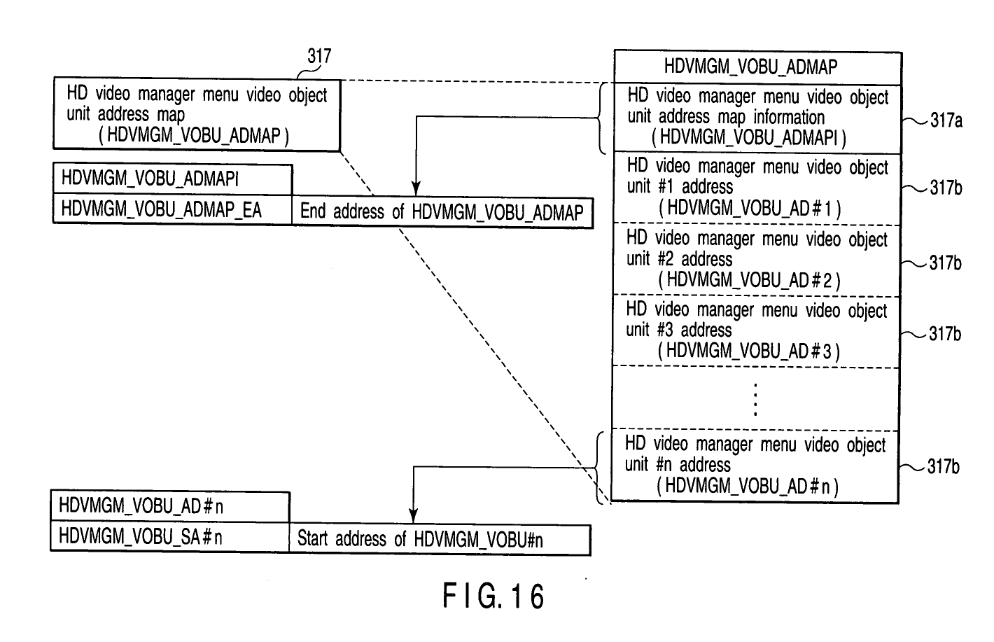

FIG. 16 shows an example of the data structure of HD video manager menu video object unit address map (HDVMGM_VOBU_ADMAP) 317 shown in FIG. 3. As shown in FIG. 16, this HD video manager menu video object unit address map 317 records various kinds of information: HD video manager menu video object unit address map information (HDVMGM_VOBU_ADMAPI) 317a having information of the end address (HDVMGM_VOBU_ADMAP_EA) of the HDVMGM_VOBU_ADMAP; and start addresses (HDVMGM_VOBU_AD#1 to HDVMGM_VOBU_AD#n) 317b of HDVMGM_VOBU data.

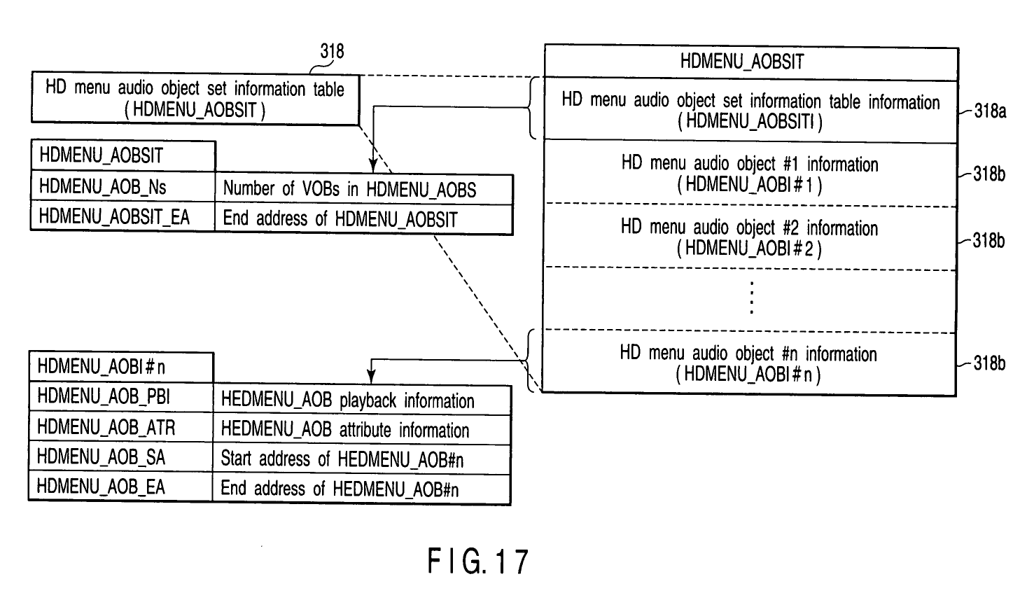

FIG. 17 shows the management information content for menu audio object (HDMENU_AOB) itself, and shows an example of the internal data structure of HD menu audio object set information table (HDMENU_AOBSIT) 318 shown in FIG. 3 stored in HD video manager information (HDVMGI) area 31 shown in FIG. 1(e). As shown in FIG. 17, HD menu audio object set information table information (HDMENU_AOBSITI) 318a allocated at the first field of HD menu audio object set information table 318 stores HDMENU_AOB_Ns as information of the number of AOB data in HDMENU_AOBS, and the end address information (HDMENU_AOBSIT_EA) of the HDMENU_AOBSIT. In the embodiment of the invention, a plurality of types of menu audio objects (audio data) can be recorded in information storage medium 1.

In HD menu audio object set information table 318 shown in FIG. 17, one or more pieces of HD menu audio object information (HDMENU_AOBI) 318b are allocated after HD menu audio object set information table information 318a. Each HD menu audio object information (HDMENU_AOBI) 318b indicates management information for each individual menu audio object (audio data), and includes playback information (HDMENU_AOB_PBI) of HDMENU_AOB, attribute information (HDMENU_AOB_ATR) of HDMENU_AOB, the start address information (HDMENU_AOB_SA) of HDMENU_AOB#n (HDMENU_AOB of interest), and the end address information (HDMENU_AOB_EA) of HDMENU_AOB#n (HDMENU_AOB of interest).

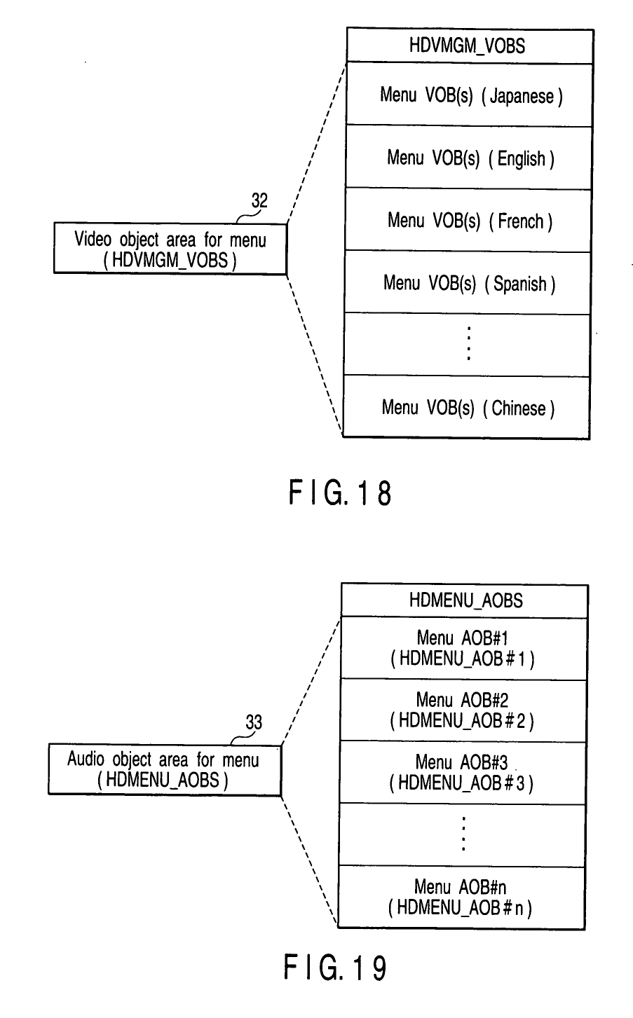

FIG. 18 shows an example of the data structure of menu video object area (HDVMGM_VOBS) 32 shown in FIG. 1(e), which is stored together in, e.g., file HD_VMG01.HDV (file HD_VMG01.HDV can be stored as a file in the menu group in FIG. 2; not shown). As shown in FIG. 18, menu screens (video objects) which record an identical menu screen using different menu description language codes are allocated in juxtaposition with this menu video object area 32. In this way, a plurality of menu screens of a plurality of languages are prepared, and a menu screen can be displayed by arbitrarily selecting one of a plurality of them. For example, when only one Japanese menu VOB is selected, a Japanese menu can be displayed; when only one English menu VOB is selected, an English menu can be displayed. Alternatively, when the display screen is configured to display multi-windows, and the Japanese menu VOB and English menu VOB are selected, the Japanese and English menus can be displayed on the multi-windows.

FIG. 19 shows an example of the data structure of menu audio object area (HDMENU_AOBS) 33 recorded in the HD video manager (HDVMG) recording area. In the embodiment of the invention, a plurality of types of menu audio objects (audio data) can be recorded in information storage medium 1. Each menu audio object (AOB) is recorded at a location in menu audio object area (HDMENU_AOBS) 33 in HD video manager recording area (HDVMG) 30, as shown in, e.g., FIG. 1. This menu audio object area (HDMENU_AOBS) 33 forms one file with, e.g., file name HD_MENU0.HDA (file HD_MENU0.HAD can be a file in the menu group in FIG. 2; not shown). Respective menu audio objects (AOB) are allocated and recorded in turn in menu audio object area (HDMENU_AOBS) 33 that forms one file with file name HD_MENU0.HAD, as shown in FIG. 19.

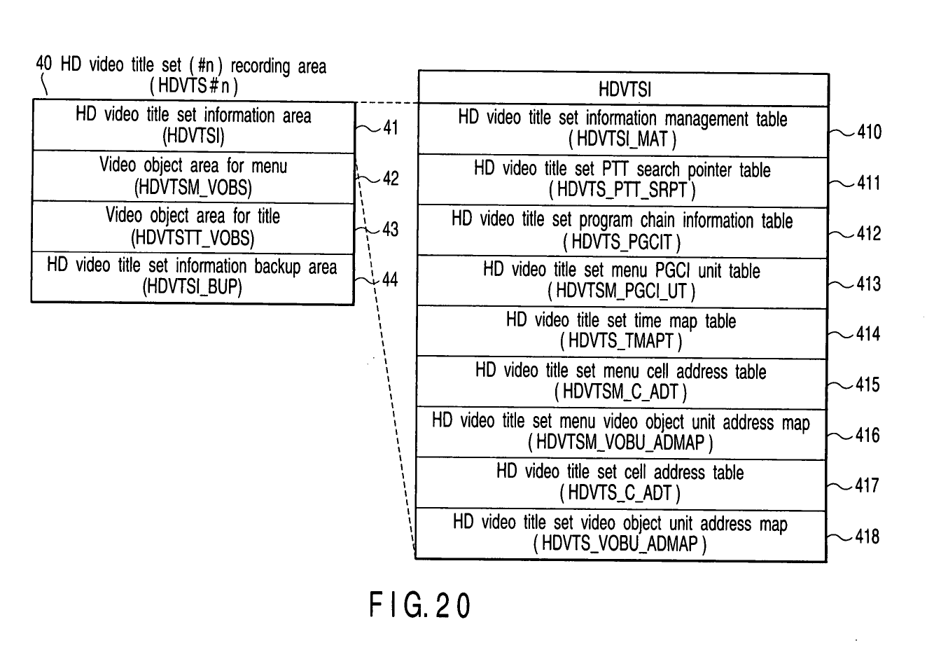

FIG. 20 shows an example of the data structure of HD video title set information (HDVTSI) 41 recorded in each HD video title set (HDVTS#n) recording area. This HD video title set information 41 is recorded together in file HVI00101.IFO and/or HVIA0001.IFO shown in, e.g., FIG. 2 (or independent file VTS00100.IFO in the DVD-Video content; not shown). As shown in FIG. 20, the interior of HD video title set information (HDVTSI) 41 shown in FIG. 1(f) is divided into respective fields (management information groups): HD video title set information management table (HDVTSI_MAT) 410, HD video title set PTT search pointer table (HDVTS_PTT_SRPT) 411, HD video title set program chain information table (HDVTS_PGCIT) 412, HD video title set menu PGCI unit able (HDVTSM_PGCI_UT) 413, HD video title set time map table (HDVTS_TMAPT) 414, HD video title set menu cell address table (HDVTSM_C_ADT) 415, HD video title set menu video object unit address map (HDVTSM_VOBU_ADMAP) 416, HD video title set cell address table (HDVTS_C_ADT) 417, and HD video title set video object unit address map (HDVTS_VOBU_ADMAP) 418.

HD video title set information management table (HDVTSI_MAT) 410 records management information common to the corresponding video title set. Since this common management information (HDVTSI_MAT) is allocated in the first field (management information group) in HD video title set information (HDVTSI) area 41, the common management information in the video title set can be immediately loaded (before the beginning of object playback). Hence, the playback control process of the information playback apparatus can be simplified, and the control processing time can be shortened.

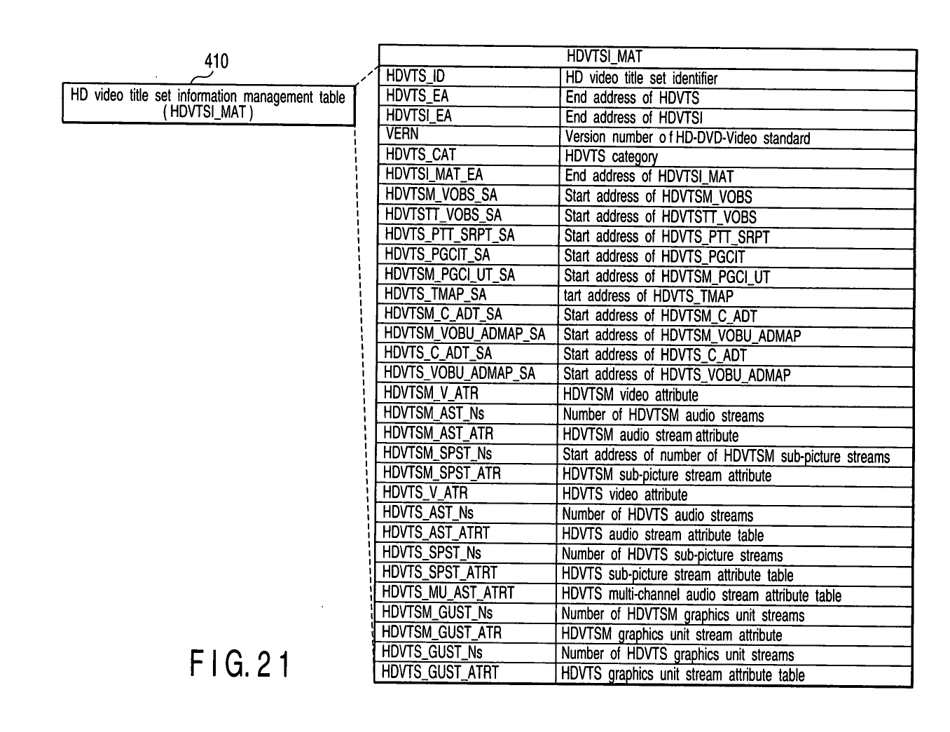

FIG. 21 shows an example of the data structure of the HD video title set information management table (HDVTSI_MAT) recorded in the HD video title set information (HDVTSI). Management information associated with graphics units included in the HDVTS (Video Title Set according to the embodiment of the invention) is recorded in HD video title set information management table (HDVTSI_MAT) 410 (see FIG. 20), which is allocated in the first field (group) in HD video title set information (HDVTSI) area 41 shown in FIG. 1(f). Detailed management information content are as shown in FIG. 21. That is, information of the number of graphics unit streams and attribute information are separately recorded for a menu screen and title (display picture) in the HDVTS as information of the number (HDVTSM_GUST_Ns) of HDVTSM graphics unit streams, HDVTSM graphics unit stream attribute information (HDVTSM_GUST_ATR), information of the number (HDVTS_GUST_Ns) of HDVTS graphics unit streams, and HDVTS graphics unit stream attribute table information (HDVTS_GUST_ATRT).

Also, as shown in FIG. 21, HD video title set information management table (HDVTSI_MAT) 410 records various kinds of information: an HD video title set identifier (HDVTS_ID), the end address (HDVTS_EA) of the HDVTS, the end address (HDVTSI_EA) of the HDVTSI, the version number (VERN) of the HD_DVD-Video standard, an HDVTS category (HDVTS_CAT), the end address (HDVTSI_MAT_EA) of the HDVTSI_MAT, the start address (HDVTSM_VOBS_SA) of the HDVTSM_VOBS, the start address (HDVTSTT_VOBS_SA) of the HDVTSTT_VOBS, the start address (HDVTS PTT SRPT SA) of the HDVTS PTT SRPT, the start address (HDVTS_PGCIT_SA) of the HDVTS_PGCIT, the start address (HDVTSM_PGCI_UT_SA) of the HDVTSM_PGCI_UT, the start address (HDVTS_TMAP SA) of the HDVTS_TMAP, the start address (HDVTSM_C_ADT_SA) of the HDVTSM_C_ADT, the start address (HDVTSM_VOBU_ADMAP_SA) of the HDVTSM_VOBU_ADMAP, the start address (HDVTS_C_ADT_SA) of the HDVTS_C_ADT, the start address (HDVTS_VOBU_ADMAP_SA) of the HDVTS_VOBU_ADMAP, an HDVTSM video attribute (HDVTSM_V_ATR), the number (HDVTSM_AST_Ns) of HDVTSM audio streams, an HDVTSM audio stream attribute (HDVTSM_AST_ATR), the start address (HDVTSM_SPST_Ns) of the number of HDVTSM sub-picture streams, an HDVTSM sub-picture stream attribute (HDVTSM_SPST_ATR), an HDVTS video attribute (HDVTS_V_ATR), the number (HDVTS_AST_Ns) of HDVTS audio streams, an HDVTS audio stream attribute table (HDVTS_AST_ATRT), the number (HDVTS_SPST_Ns) of HDVTS sub-picture streams, an HDVTS sub-picture stream attribute table (HDVTS_SPST_ATRT), and an HDVTS multi-channel audio stream attribute table (HDVTS_MU_AST_ATRT).

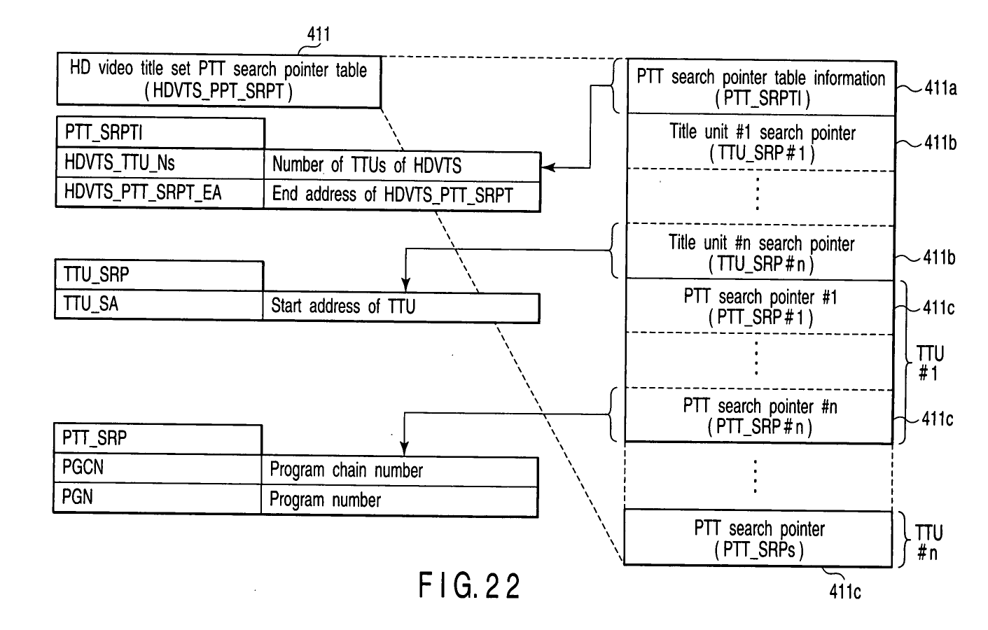

FIG. 22 shows an example of the data structure in HD video title set PTT search pointer table (HDVTS_PTT_SRPT) 411 shown in FIG. 19. This HD video title set PTT search pointer table 411 includes various kinds of information: PTT search pointer table information (PTT_SRPTI) 411a having information of the number (HDVTS_TTU_Ns) of HDVTS TTU data and the end address (HDVTS_PTT_SRPT_EA) of the HDVTS_PTT_SRPT; title unit search pointers (TTU_SRP) 411b each of which records information of the start address (TTU_SA) of the TTU; and PTT search pointers (PTT_SRP) 411c having information of a program chain number (PGCN) and program number (PGN).

<Allocation of Information that Manages Resume Information>

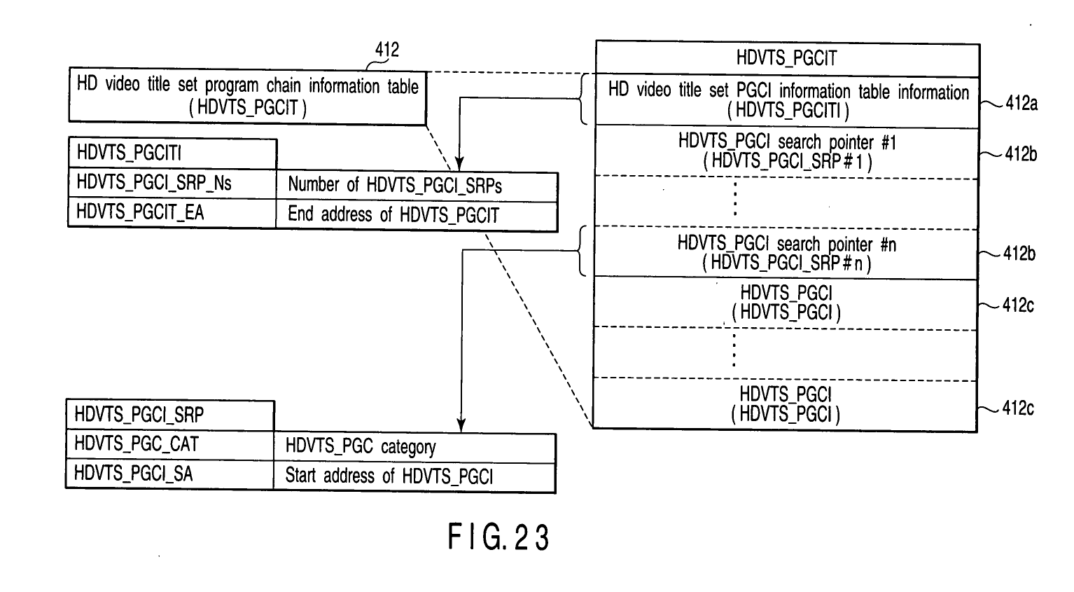

FIG. 23 shows an example of the data structure of HD video title set program chain information table (HDVTS_PGCIT) recorded in the HD video title set information (HDVTSI). In the embodiment of the invention, as shown in FIG. 23, an HDVTS_PGC category in HDVTS_PGCI search pointer 412b stores an update permission flag of resume information (RSM permission flag). Information of HDVTS_PGCI search pointer 412b is allocated in HD video title set program chain information table (HDVTS_PGCIT) 412 (FIG. 20) stored in HD video title set information (HDVTSI) area 41 shown in FIG. 1(f). In addition, as shown in FIG. 23, HD video title set program chain information table (HDVTS_PGCIT) 412 also records information of HD video title set PGCI information table (HDVTS_PGCITI) 412a including information of the number (HDVTS_PGCI_SRP_Ns) of HDVTS_PGCI_SRP data and the end address (HDVTS_PGCIT_EA) of the HDVTS_PGCIT. Also, HDVTS_PGCI search pointer (HDVTS_PGCI_SRP) 412b records information of the start address (HDVTS_PGCI_SA) of the HDVTS_PGCI together with the aforementioned HDVTS_PGC category (HDVTS_PGC_CAT).

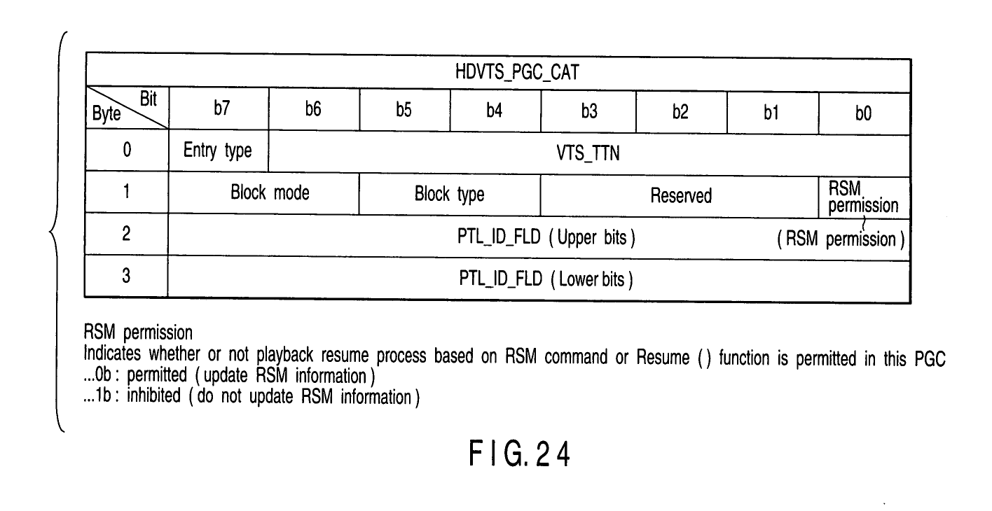

FIG. 24 shows an example of the recording content of the HDVTS_PGC category (HDVTS_PGC_CAT). The update permission flag of resume information (RSM permission Flag) shown in FIG. 24 designates whether or not the content of resume information are to be updated after playback of the HDVTS_PGC of interest starts (whether or not resume information is updated as needed in correspondence with the playback state of the PGC of interest). That is, the following process is made in correspondence with the flag:

When RSM permission flag=“0b”, resume information is updated, or

when RSM permission flag=“1b”, resume information is not updated, and playback resume information is held in the HDVTS_PGC (program chain in the video title set according to the embodiment of the invention) played back previously.

In addition, the HDVTS_PGC category (HDVTS_PGC_CAT) can record entry type information used to check if a PGC of interest is an entry PGC, title number information in a VTS (video title set) indicated by the corresponding PGC, block mode information, block type information, PTL_ID_FLD information, and the like.

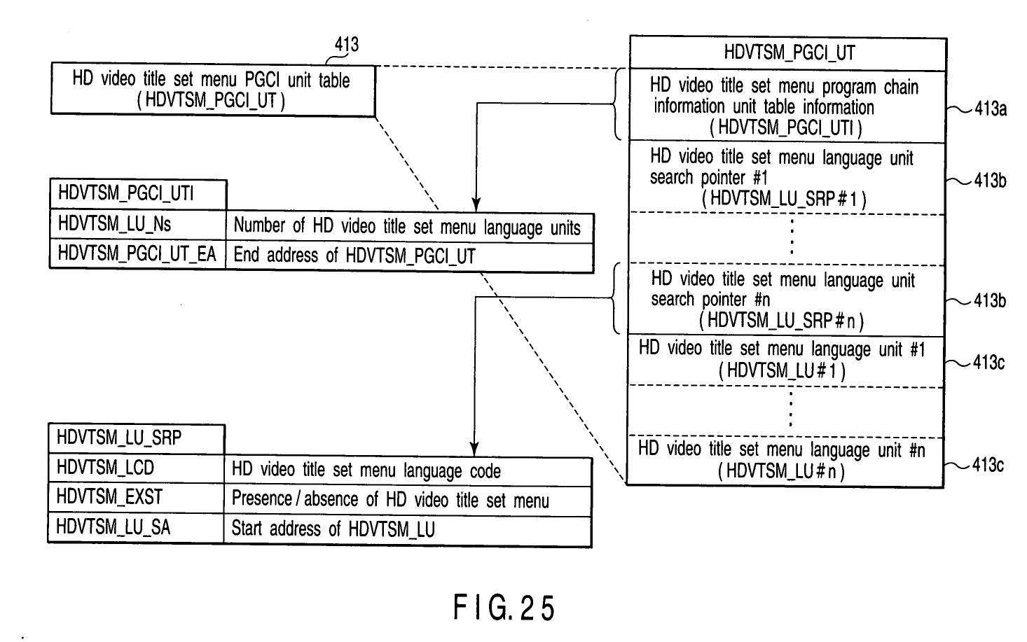

FIG. 25 shows an example of the data structure in HD video title set menu PGCI unit table (HDVTSM_PGCI_UT) 413 shown in FIG. 20. This HD video title set menu PGCI unit table 413 includes various kinds of information: HD video title set menu program chain information unit table information (HDVTSM_PGCI_UTI) 413a having information of the number (HDVTSM_LU_Ns) of HD video title set menu language units and the end address (HDVTSM_PGCI_UT_EA) of the HDVTSM_PGCI_UT; HD video title set menu language unit search pointers (HDVTSM_LU_SRP) 413b each of which records information of an HD video title set menu language code (HDVTSM_LCD), the presence/absence (HDVTSM_EXST) of a HD video title set menu, and the start address (HDVTSM_LU_SA) of the HDVTSM_LU; and HD video title set menu language units (HDVTSM_LU) 413c.

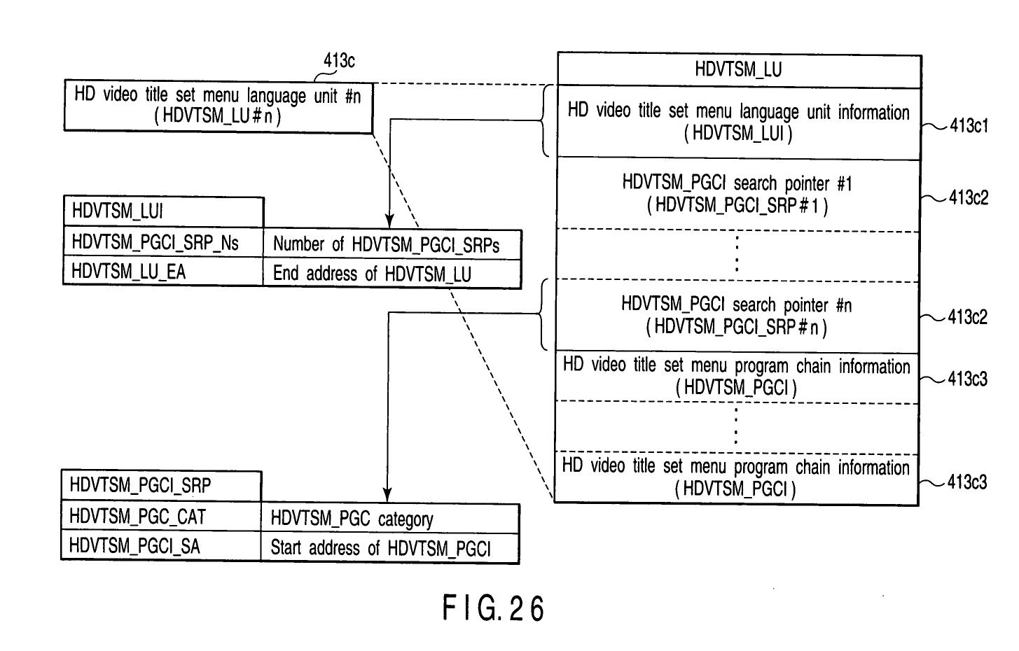

FIG. 26 shows an example of the data structure in HD video title set menu language unit (HDVTSM_LU) 413c. As shown in FIG. 26, this HD video title set menu language unit 413c includes: HD video title set menu language unit information (HDVTSM_LUI) 413c1 having information of the number (HDVTSM_PGCI_SRP_Ns) of HDVTSM_PGCI_SRP data and the end address (HDVTSM_LU_EA) of the HDVTSM_LU; a plurality of pieces of HD video title set menu program chain information (HDVTSM_PGCI) 413c3 having the same data structure as in FIG. 33; and HDVTSM_PGCI search pointers (HDVTSM_PGCI_SRP) 413c2 each of which records information of the HDVTSM_PGC category (HDVTSM_PGC_CAT) and the start address (HDVTSM_PGCI_SA) of the HDVTSM_PGCI.

As the setting location of information that refers to (designates) the menu AOB (HDMENU_AOB), in the embodiment of the invention, as for a menu for each HDVTS, that information is allocated in the HDVTSM_PGC category information (HDVTSM_PGC_CAT) in HDVTSM_PGCI search pointer #n (HDVTSM_PGCI_SRP#n) 413c2, as shown in FIG. 26.

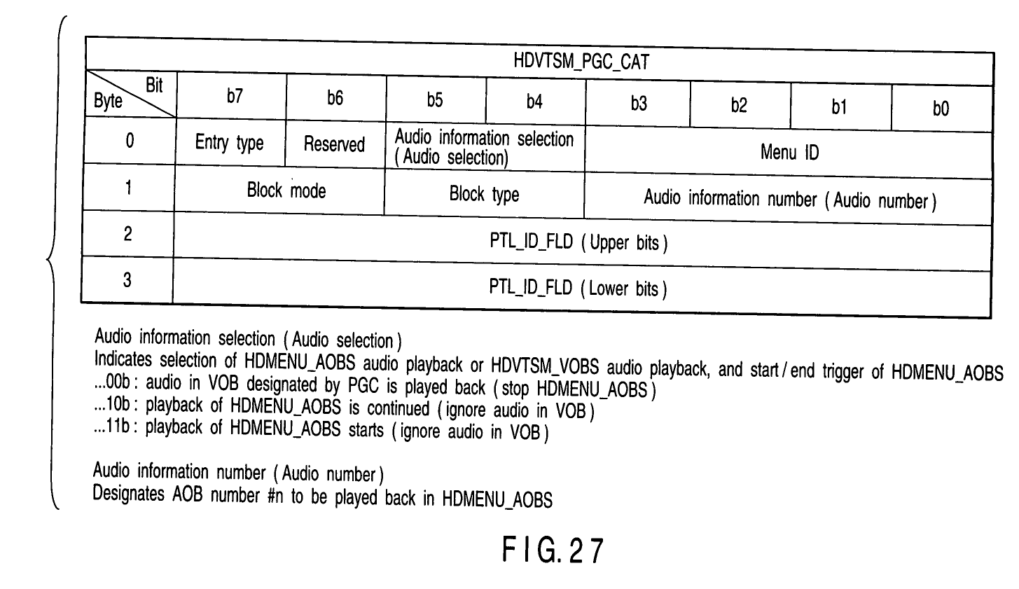

FIG. 27 shows an example of the recording content of the HDVTSM_PGC category (HDVTSM_PGC_CAT). AOB Number information in the HDVTSM_PGC category information (HDVTSM_PGC_CAT) shown in FIG. 27 means AOB number information (AOB Number) which designates AOB number #n (indicating which AOB of menu AOB (HDMENU_AOB) data which are arranged, as shown in FIG. 19 corresponds to) to be played back in HDMENU_AOBU. Also, audio selection information means selection information of audio information which is to be simultaneously played back upon displaying an HD content menu in the embodiment of the invention on the screen, and an audio information selection flag (audio selection information) indicating start/end trigger information of audio information playback.

When the audio information selection flag (Audio Selection information)=“00b” is selected, audio data recorded in respective menu video objects are played back, and audio playback is interrupted upon switching menus. When the audio information selection flag (Audio Selection information)=“10b” or “11b” is selected, audio data of menu AOB (HDMENU_AOB) data stored in menu audio object area (HDMENU_AOBS) 33 are played back. Upon playing back the menu audio data (AOB), if the audio information selection flag=“11b” is designated, the audio data begin to be played back from the beginning every time the menu screen is changed; if “10b” is designated, playback of the audio data continues irrespective of switching of menu screens. In the embodiment of the invention, menu audio object area (HDMENU_AOBS) 33 can store a plurality of types of menu AOB (HDMENU_AOB) data, as shown in FIG. 19.

Audio number information shown in FIG. 27 indicates selection information of menu AOB (HDMENU_AOB) data to be simultaneously played back upon displaying the menu display PGC of interest. This Audio Number information as the selection information of menu AOB data is used to “select which menu AOB from the top” of those which are allocated in FIG. 19 using number information. Also, the HDVTSM_PGC category (HDVTSM_PGC_CAT) records entry type information used to check if a PGC of interest is an entry PGC, menu ID information indicating a menu identification (e.g., a title menu or the like), block mode information, block type information, PTL_ID_FLD information, and the like.

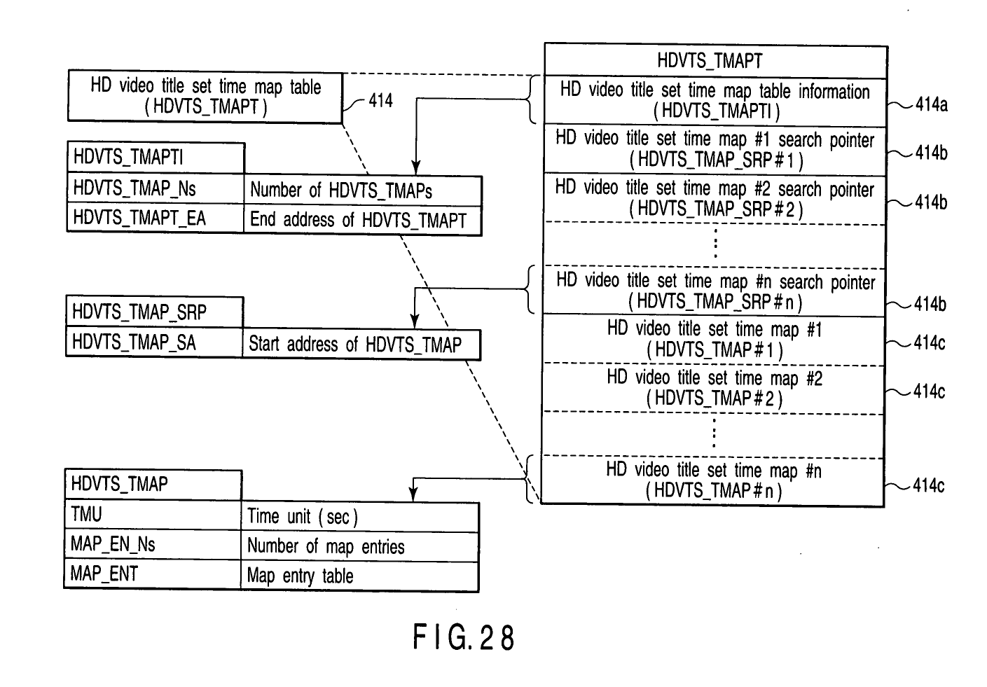

FIG. 28 shows an example of the data structure in HD video title set time map table (HDVTS_TMAPT) 414 shown in FIG. 20. This HD video title set time map table 414 includes various kinds of information: HD video title set time map table information (HDVTS_TMAPTI) 414a that describes information of the number (HDVTS_TMAP_Ns) of HDVTS_TMAP data and the end address (HDVTS_TMAPT_EA) of the HDVTS_TMAPT; HD video title set time map search pointer (HDVTS_TMAP_SRP) 414b having information of the start address (HDVTS_TMAP_SA) of the HDVTS_TMAP; and HD video title set time maps (HDVTS_TMAP) 414c each of which records information of the length (TMU) of a time unit (sec) as a reference in a map entry, the number (MAP_EN_Ns) of map entries, and a map entry table (MAP_ENT).

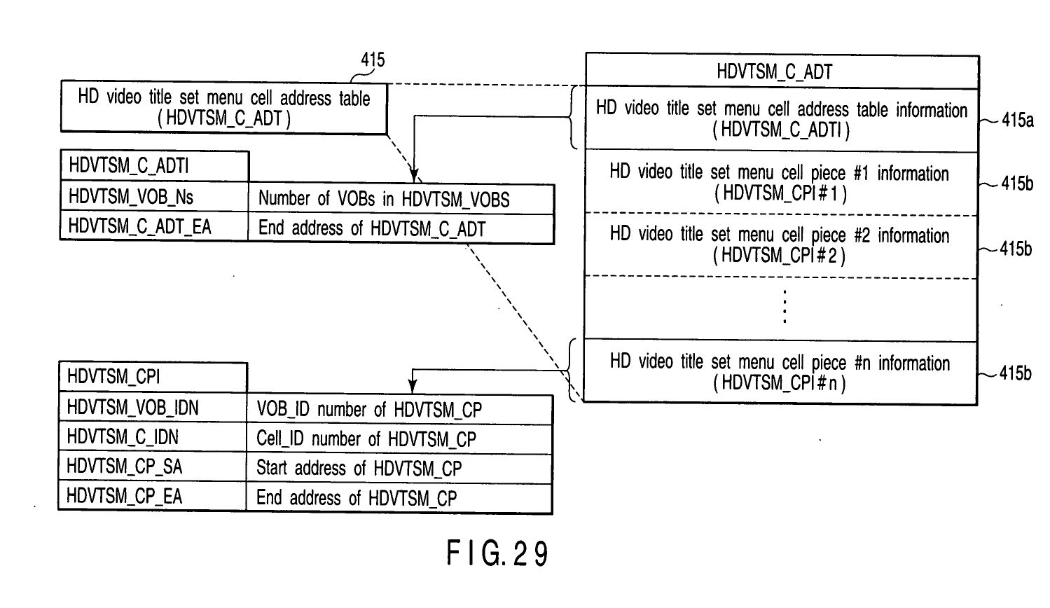

FIG. 29 shows an example of the data structure in HD video title set menu cell address table (HDVTSM_C_ADT) 415 shown in FIG. 20. As shown in FIG. 29, this HD video title set menu cell address table 415 includes various kinds of information: HD video title set menu cell address table information (HDVTSM_C_ADTI) 415a having information of the number (HDVTSM_VOB_Ns) of VOB data in an HDVTM_VOBS and the end address (HDVTSM_C_ADT_EA) of the HDVTSM_C_ADT; and a plurality of pieces of HD video title set menu cell piece information (HDVTSM_CPI) 415b each of which records information of a VOB_ID number (HDVTSM_VOB_IDN) of an HDVTSM_CP, a Cell_ID number (HDVTSM_C_IDN) of the HDVTSM_CP, the start address (HDVTSM_CP_SA) of the HDVTSM_CP, and the end address (HDVTSM_CP_EA) of the HDVTSM_CP.

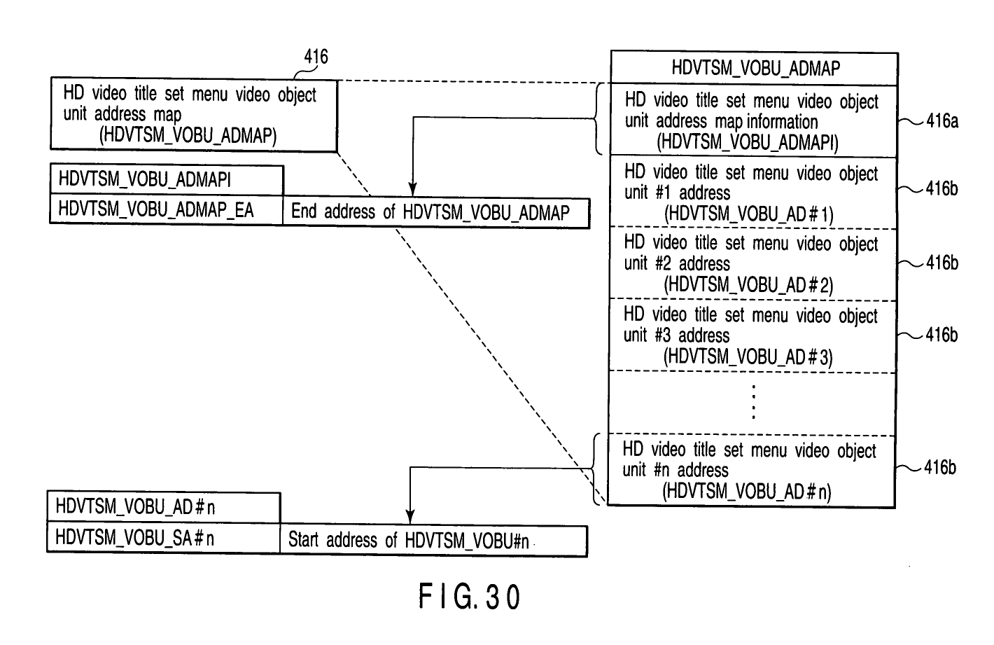

FIG. 30 shows an example of the data structure of HD video title set menu video object unit address map (HDVTSM_VOBU_ADMAP) 416 shown in FIG. 20. As shown in FIG. 30, this HD video title set menu video object unit address map 416 includes: HD video title set menu video object unit address map information (HDVTSM_VOBU_ADMAPI) 416a that describes the information of the end address (HDVTSM_VOBU_ADMAP_EA) of the HDVTSM_VOBU_ADMAP, and information of HD video title set menu video object unit addresses (HDVTSM_VOBU_AD) 416b each having information of the start address (HDVTSM_VOBU_SA) of an HDVTSM_VOBU.

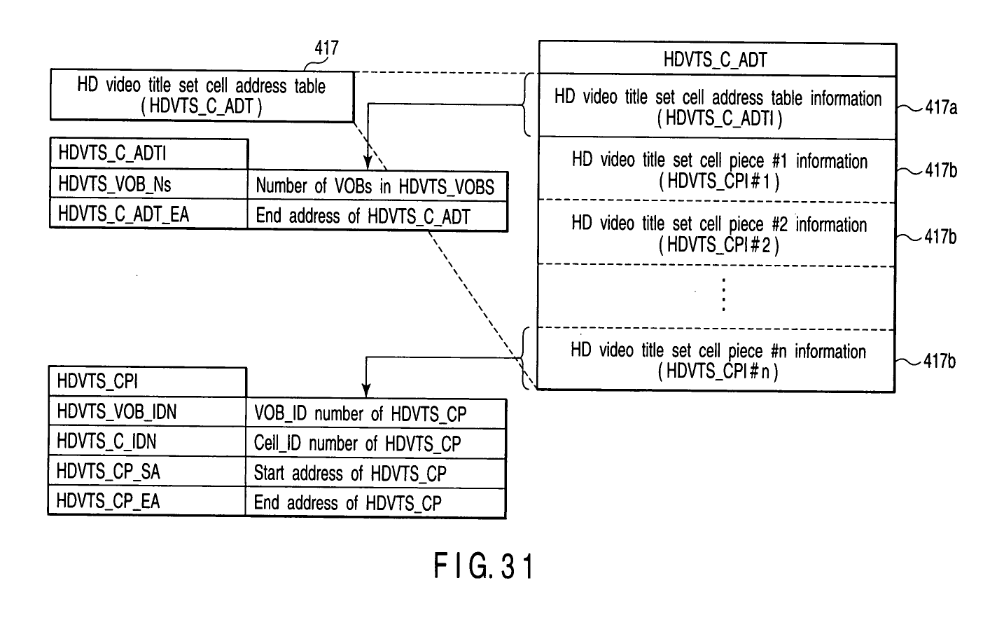

FIG. 31 shows an example of the data structure in HD video title set cell address table (HDVTS_C_ADT) 417 shown in FIG. 20. As shown in FIG. 31, this HD video title set cell address table 417 includes various kinds of information: HD video title set cell address table information (HDVTS_C_ADTI) 417a having the information of the number (HDVTS_VOB_Ns) of VOB data in an HDVTS_VOBS and the end address (HDVTS_C_ADT_EA) of the HDVTS_C_ADT; and a plurality of pieces of HD video title set cell piece information (HDVTS_CPI) 417b each including a VOB_ID number (HDVTS_VOB_IDN) of an HDVTS_CP, a Cell_ID number (HDVTS_C_IDN) of the HDVTS_CP, the start address (HDVTS_CP_SA) of the HDVTS_CP, and the end address (HDVTS_CP_EA) of the HDVTS_CP.

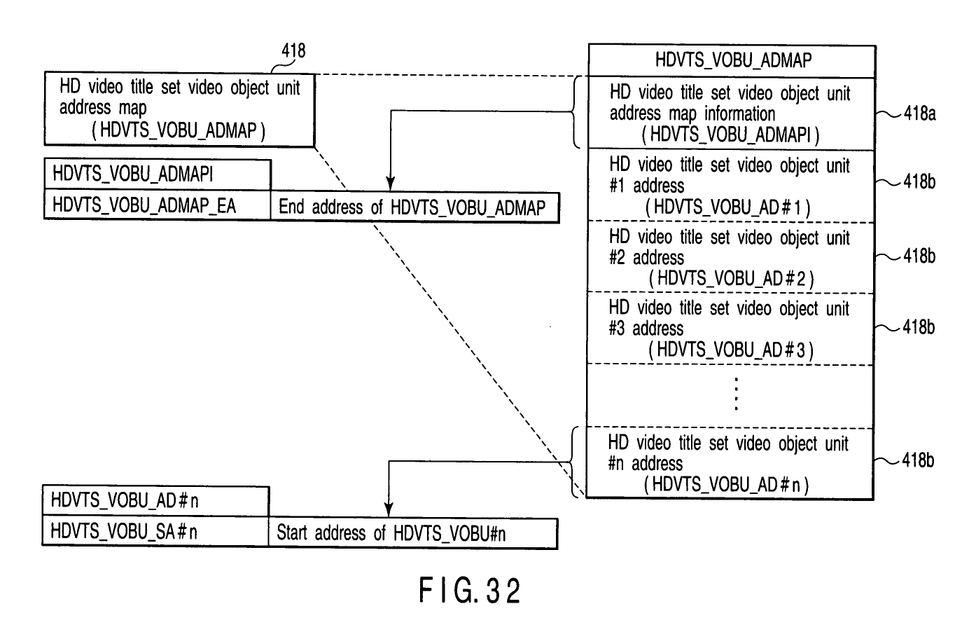

FIG. 32 shows an example of the data structure in HD video title set video object unit address map (HDVTS_VOBU_ADMAP) 418 shown in FIG. 20. As shown in FIG. 32, this HD video title set video object unit address map 418 includes various kinds of information: HD video title set video object unit address map information (HDVTS_VOBU_ADMAPI) 418a having information of the end address (HDVTS_VOBU_ADMAP_EA) of the HDVTS_VOBU_ADMAP; and HD video title set video object unit addresses (HDVTS_VOBU_AD) 418b each of which records information of the start address (HDVTS_VOBU_SA) of each HDVTS_VOBU.

FIG. 33 shows an example of the data structure of program chain general information (PGC_GI) included in program chain information (PGCI: corresponding to one of HDVTS_PGCI in, e.g., FIG. 23), and the recording content of a PGC graphics unit stream control table (PGC_GUST_CTLT) and resume/audio category (RSM&AOB_CAT) stored in this PGCI.

The information of the update permission flag of resume information (RSM permission flag) and audio information selection flag (audio selection information)/audio information number (audio number information) as some of characteristic features according to the embodiment of the invention are stored in PGCI search pointer information in the existing example (see FIGS. 26, 27, etc.). However, the invention is not limited to this. For example, the PGCI itself can store the update permission flag information of resume information and audio information selection flag/audio information number. This example is FIG. 33. The PGCI information shown in FIG. 33 corresponds to:

a] HD video manager menu program chain information (HDVMGM_PGCI) 312c3 which is shown in FIG. 7 in association with each HD video manager menu language unit (HDVMGM_LU) 312c in FIG. 6 stored in HD video manager menu PGCI unit table (HDVMGM_PGCI_UT) 312 (FIG. 3) in HD video manager information (HDVMGI) area 31 in FIG. 1(e);

b] HD video title set menu program chain information (HDVTSM_PGCI) 413c3 shown in FIG. 26 which is allocated in each HD video title set menu language unit (HDVTSM_LU) 413c in FIG. 25 in HD video title set menu PGCI unit table (HDVTSM_PGCI_UT) 413 in FIG. 20 that shows the data structure in HD video title set information (HDVTSI) area 41 in FIG. 1(f); and

c] HDVTS_PGCI 412c (FIG. 23) in HD video title set program chain information table (HDVTS_PGCIT) 412 in FIG. 20 that shows the data structure in HD video title set information (HDVTSI) area 41 in FIG. 1(f)

(the PGCI information shown in FIG. 33 can be allocated in one of the above three locations (a) to (c)).

As shown in FIG. 33, the program chain information (PGCI) includes five fields (five management information groups), i.e., program chain general information (PGC_GI) 50, program chain command table (PGC_CMDT) 51, program chain program map (PGC_PGMAP) 52, cell playback information table (C_PBIT) 53, and cell position information table (C_POSIT) 54.

As shown in FIG. 33, RSM & AOB category information (RSM&AOB_CAT) is recorded at the end of program chain general information (PGC_GI) 50 allocated in the first field (management information group) in the PGCI. The RSM & AOB category information (RSM&AOB_CAT) stores the update permission flag of resume information (RSM permission information), audio information selection flag (audio selection information) and audio information number (audio number information). This RSM permission information have the same meaning as the content described using FIG. 24. Also, the content of the audio information selection flag or audio information number match those described using FIG. 8 or 27. Furthermore, the RSM & AOB category information (RSM&AOB_CAT) records entry type information used to check if a PGC of interest is an entry PGC, block mode information, block type information, and PTL_ID_FLD information.

Information in the PGC graphics unit stream control table (PGC_GUST_CTLT) that records control information associated with graphics unit streams allocated in the PGC is independently recorded in each of a PGC_GUST_CTL (PGC_GUST#0) field of HD graphics unit stream #0, a PGC_GUST_CTL (PGC_GUST#1) field of SD wide graphics unit stream #1, a PGC_GUST_CTL (PGC_GUST#2) field of 4:3 (SD) graphics unit stream #2, and a PGC_GUST_CTL (PGC_GUST#3) field of letterbox (SD) graphics unit stream #3 as independent fields in correspondence with four different types of pictures (an HD picture at 16:0, SD picture at 16:9, SD picture at 4:3, and SD picture at letterbox), as shown in FIG. 33.

In addition to the aforementioned information, program chain general information (PGC_GI) 50 records various kinds of information including PGC content (PGC_CNT), a PGC playback time (PGC_PB_TM), PGC user operation control (PGC_UOP_CTL), a PGC audio stream control table (PGC_AST_CTLT), a PGC sub-picture stream control table (PGC_SPST_CTLT), PGC navigation control (PGC_NV_CTL), a PGC sub-picture palette (PGC_SP_PLT), the start address (PGC_CMDT_SA) of the PGC_CMDT, the start address (PGC_PGMAP_SA) of the PGC_PGMAP, the start address (C_PBIT_SA) of the C_PBIT, and the start address (C_POSIT_SA) of the C_POSIT.

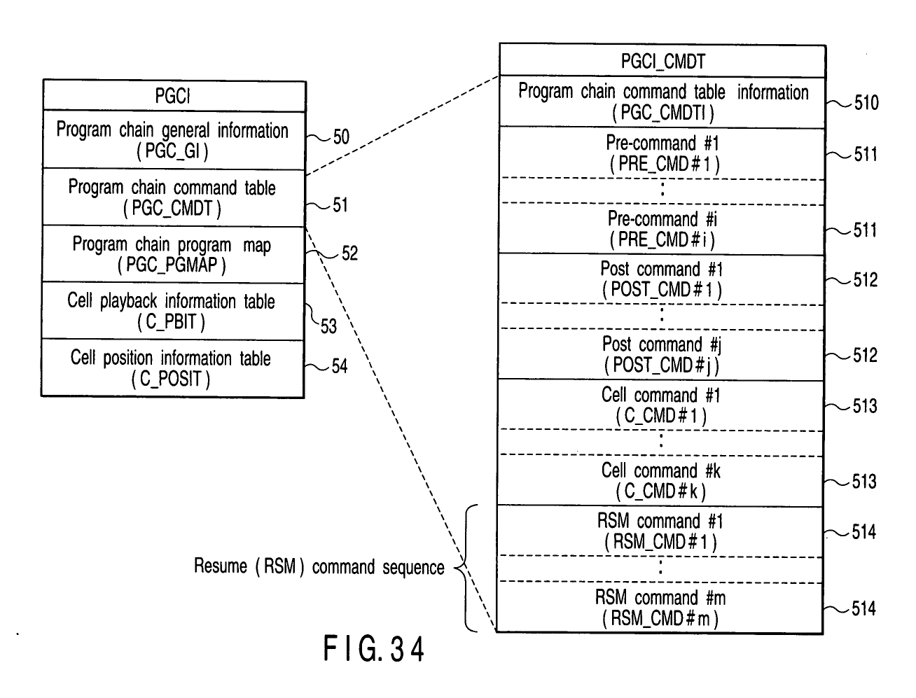

FIG. 34 shows an example of the program chain command table (PGC_CMDT) included in the program chain information (PGCI). As shown in FIG. 34, a plurality of pieces of command information to be applied to each PGC are allocated together on program chain command table (PGC_CMDT) 51. The allocation of this PGCI information can be one of the three locations (a) to (c), as described using FIG. 33. A resume (RSM) command sequence (or resume sequence) is recorded in program chain command table (PGC_CMDT) 51, as shown in FIG. 34. The information content of the resume sequence (resume command sequence) in the embodiment of the invention is described in a format in which RSM commands (RSM_CMD) 514 are allocated in juxtaposition with the field of command table 51. One RSM command (RSM_CMD) 514 described in one column in FIG. 34 means one command that can be designated in the HD_DVD-Video content in the invention, and RSM commands (RSM_CMD) 514 allocated in the resume (RSM) command sequence field are successively (sequentially) executed in turn from the top.

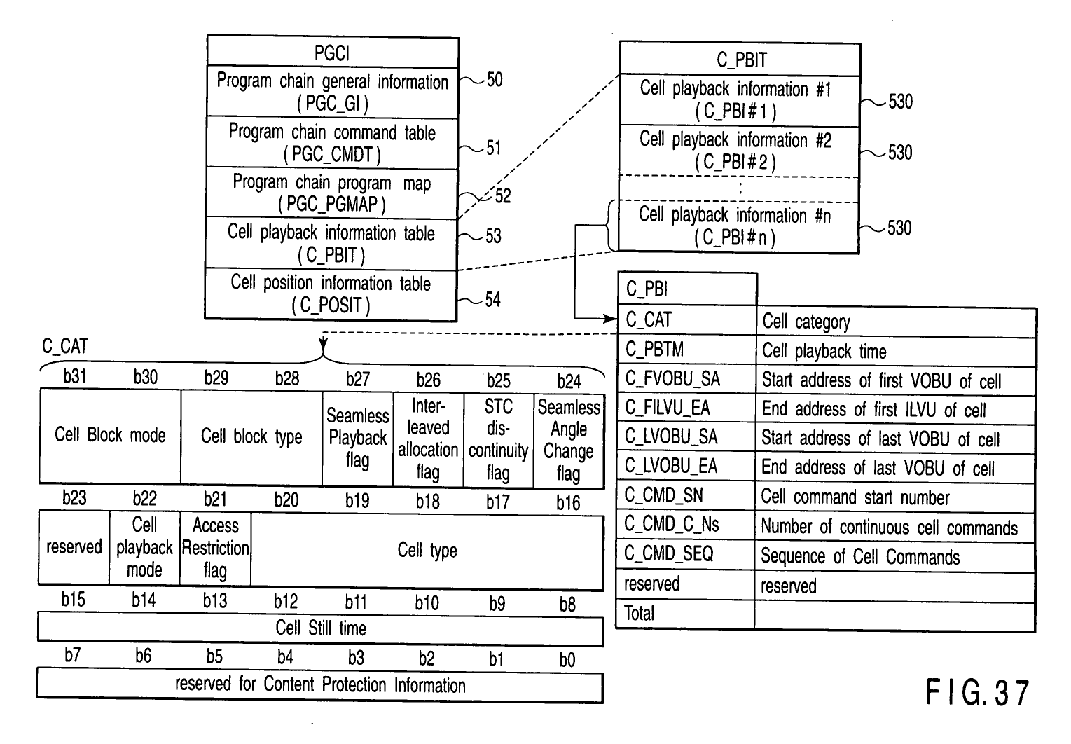

In the embodiment of the invention, a sequence of cell commands (C_CMD) 513 in FIG. 34 also means a sequential command sequence. That is, command processes are sequentially executed in turn from the top in accordance with the arrangement order of cell commands (C_CMD) 513 shown in FIG. 34. As will be additionally described with reference to FIG. 37, a structure that can designate some of cell command processing sequences for each cell (the first cell command number at which the sequential process of cell command is to start, and the execution range of the sequential process of cell commands for each cell) in a series of cell command processing sequences designated from cell command #1 (C_CMD#1) to cell command #k (C_CMD#k) is adopted.

Referring to FIG. 34, RSM command (RSM_CMD) 514 indicates a part of a command sequence which is executed “immediately before playback from the middle of a PGC” whose playback was interrupted previously after the control returns from, e.g., a menu screen to the PGC of interest. On the other hand, pre-command (PRE_CMD) 511 means a command executed “immediately before the PGC of interest is to be played back from the beginning”. Also, a command to be executed after playback of the PGC of interest is post command (POST_CMD) 512. The number of pre-commands (PRE_CMD) 511, that of post commands (POST_CMD) 512, that of cell commands (C_CMD) 513, and that of RSM commands (RSM_CMD) 514 that can be allocated in one program chain command table (PGC_CMDT) 51 in FIG. 34 can be freely set (any of the numbers of commands to be described may be “0”). In the embodiment of the invention, the upper limit of a total value obtained by adding the number of pre-commands (PRE_CMD) 511, that of post commands (POST_CMD) 512, that of cell commands (C_CMD) 513, and that of RSM commands (RSM_CMD) 514 that can be allocated in one program chain command table (PGC_CMDT) 51 is specified to be 1023. Therefore, when all of the number of pre-commands (PRE_CMD) 511, that of post commands (POST_CMD) 512, and that of RSM commands (RSM_CMD) 514 are “0”, a maximum of 1023 cell commands (C_CMD) 513 can be set.

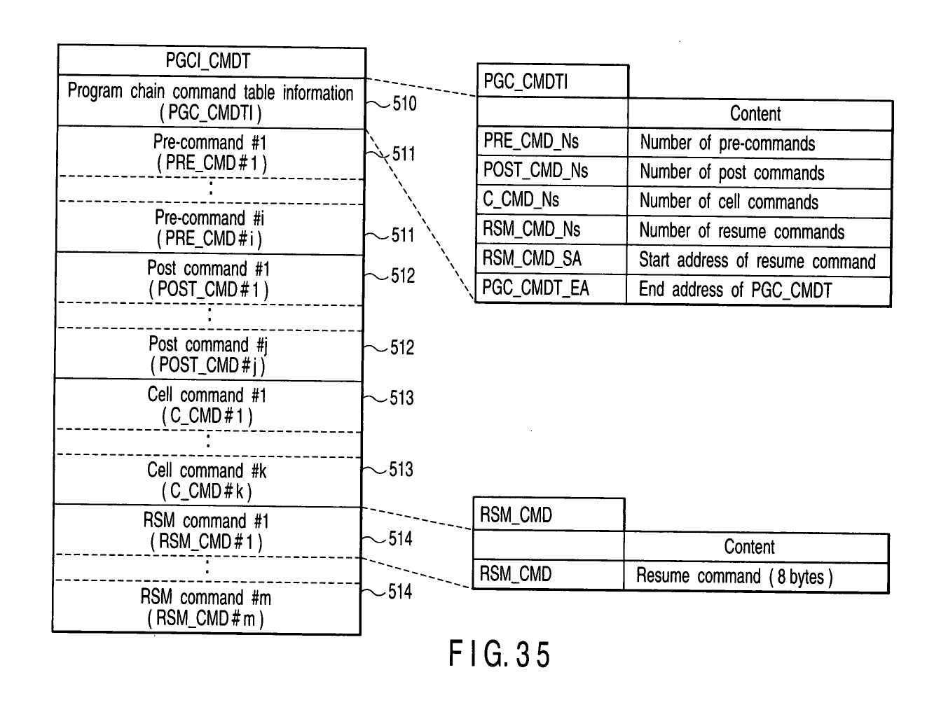

FIG. 35 shows an example of the content of program chain command table information (PGC_CMDTI) and those of each resume command (RSM_CMD) included in the program chain command table (PGC_CMDT). As shown in FIG. 35, program chain command table information (PGC_CMDTI) 510 records PRE_CMD_Ns as information indicating the number of pre-commands (PRE_CMD) 511, POST_CMD_Ns as information indicating the number of post commands (POST_CMD) 512, C_CMD_Ns as information indicating the number of cell commands (C_CMD) 513, and RSM_CMD_Ns as information indicating the number of RSM commands (RSM_CMD) 514, which can be allocated in one program chain command table (PGC_CMDT) 51.

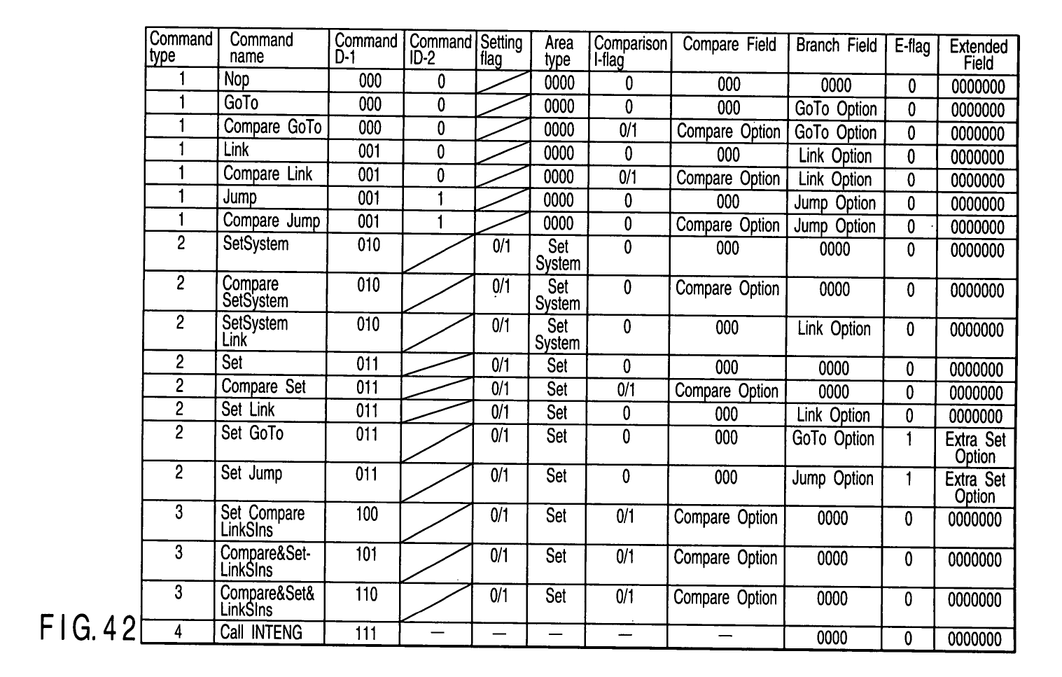

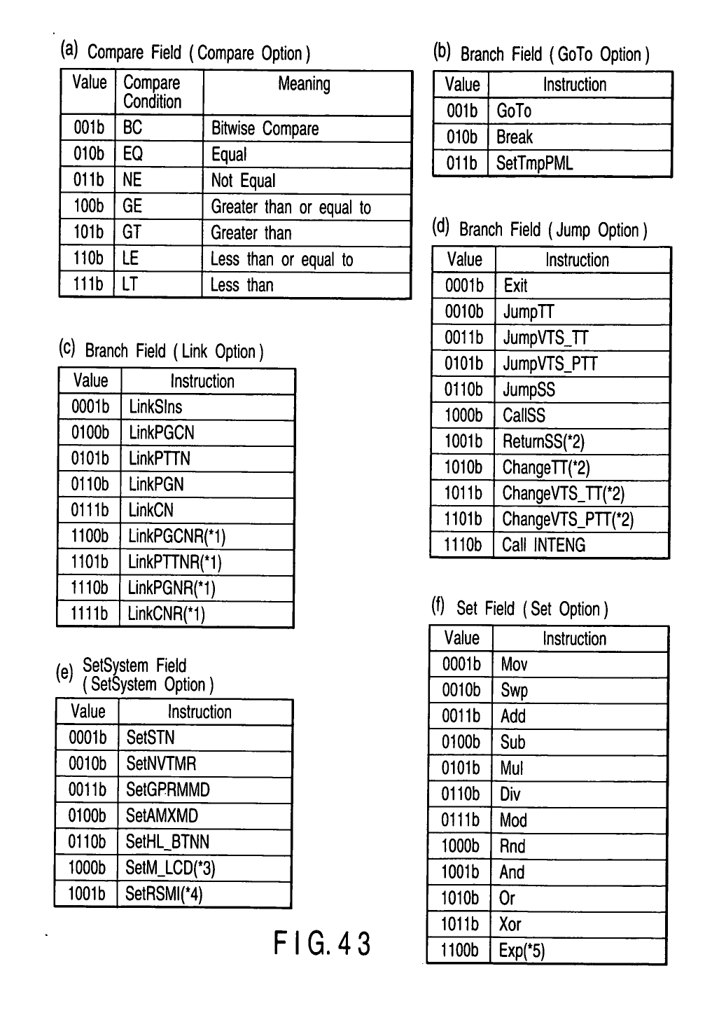

A detailed data structure in RSM command (RSM_CMD) 514 recorded in program chain command table (PGC_CMDT) 51 will be described below. The detailed data structure in RSM command (RSM_CMD) 514 will be described in this paragraph, but the data structures in pre-command (PRE_CMD) 511, post command (POST_CMD) 512, and cell command (C_CMD) 513 are the same as the detailed data structure in RSM command (RSM_CMD) 514. In the detailed data structure in RSM command (RSM_CMD) 514, an “8-byte” field is merely assigned to each command, as shown in FIG. 35. In this “8-byte” field, any of command content that will be additionally explained with reference to FIG. 43 are selected and recorded. This command stores “command ID-1” data shown in FIG. 42 in its MSB to the third bit in 8 bytes. The data content of the following bits are different depending on the value of “command type” shown in FIG. 42, but they commonly have information of “comparison I-flag”, “compare field”, and the like shown in FIG. 42 independently of the command type.

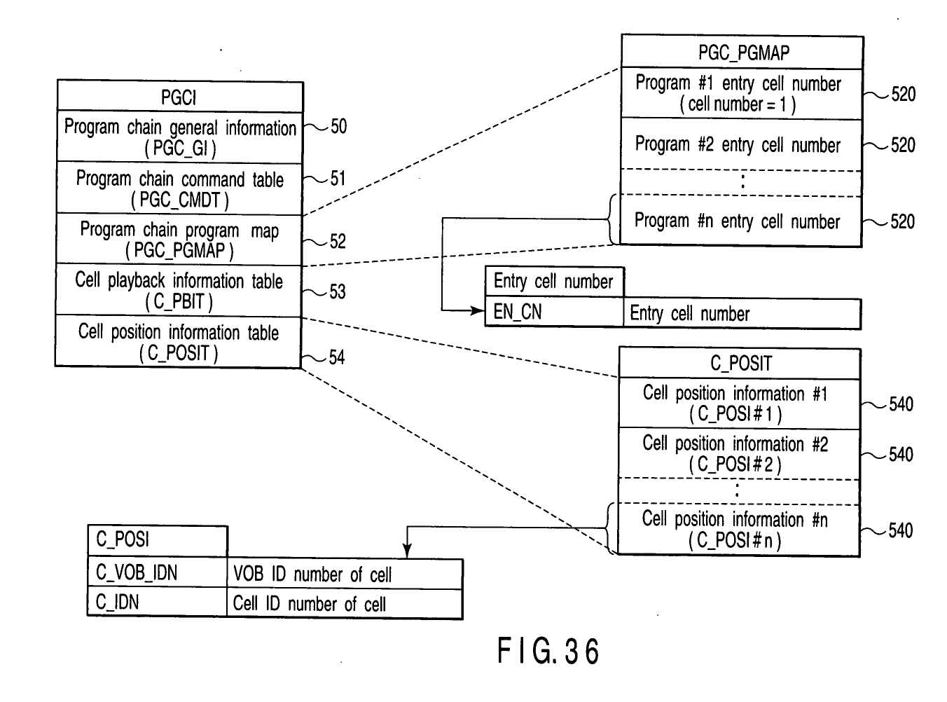

FIG. 36 shows an example of the data structures in program chain program map (PGC_PGMAP) 52 and cell position information table (C_POSIT) 54 allocated in the program chain information (PGCI). In program chain program map (PGC_PGMAP) 52, a plurality of pieces of program entry cell number 520 information that record entry cell numbers (EN_CN) indicating the cell numbers corresponding to entries are allocated in correspondence with the number of entries. Cell position information table (C_POSIT) 54 has a structure in which a plurality of pieces of cell position information (C_POSI) 540 each including a pair of a cell VOB_ID number (C_VOB_IDN) and cell ID number (C_IDN) are allocated in turn.

In the description of FIG. 34, the structure that can designate some of cell command processing sequences for each cell (the first cell command number at which the sequential process of cell command is to start, and the execution range of the sequential process of cell commands for each cell) in a series of cell command processing sequences designated from cell command #1 (C_CMD#1) to cell command #k (C_CMD#k) is adopted. FIG. 37 shows execution range information of the sequential process of cell commands which can be set for each cell. As has been explained in FIG. 33, the PGCI information can be allocated at the three locations (a) to (c). Management information associated with individual cells that form a PGC is recorded in cell playback information (C_PBI) 530 in cell playback information table (C_PBIT) 53 in the PGCI as the management information of the PGC of interest, as shown in FIG. 37.

Information associated with the first cell command number, at which the sequential process of cell command is to start, designated for each cell in a series of cell command processing sequences designated from cell command #1 (C_CMD#1) to cell command #k (C_CMD#k) is recorded in cell command start number information (C_CMD_SN) in cell playback information (C_PBI) 530, as shown in FIG. 37. At the same time, cell command continuous number information (C_CMD_C_Ns) indicating the number of commands, the command processes of which are to be continuously executed as well as cell command (C_CMD) 513 designated by the cell command start number information (C_CMD_SN) is recorded in cell playback information (C_PBI) 530. Based on these two pieces of information, the execution range of the sequential process of cell command to be executed by the cell of interest is designated. In the embodiment of the invention, after completion of playback of the cell of interest, a command sequence of the range designated by the cell command start number information (C_CMD_SN) and cell command continuous number information (C_CMD_C_Ns) in FIG. 37 can be executed.

FIG. 37 shows an example of the data structure of the cell playback information table (C_PBIT) included in the program chain information (PGCI). Referring to FIG. 37, cell playback information (C_PBI) can store the following information: a cell category (C_CAT) indicating if a cell of interest corresponds to the start or last cell of an interleaved block when the cell of interest forms an interleaved block corresponding to multi-angle playback, a part of a general continuous block, or a part of an interleaved block corresponding to multi-angle playback; a cell playback time (C_PBTM) indicating a playback time used to play back the entire cell of interest; the start address position information (C_FVOBU_SA) of the first VOBU of the cell; the end address position information (C_FILVU_EA) of the first ILVU of the cell; the start address position information (C_LVOBU_SA) of the last VOBU of the cell; the end address position information (C_LVOBU_EA) of the last VOBU of the cell, the start number (C_CMD_SN) of cell command; the number (C_CMD_C_Ns) of continuous cell commands; the sequence (C_CMD_SEQ) of cell commands; and so on. (C_CMD_SN and C_CMD_C_Ns may be omitted as the case may be.)

The cell category (C_CAT) may comprises information of a cell block mode, information of a cell block type, information of a seamless playback flag, information of an interleaved allocation flag, information of a system time clock (STC) discontinuity flag, information of a seamless angle chage flag, information of a cell playback mode, information of an access restriction flag, information of a cell type, information of a cell still time, and copy protection information. The recorded contents can be protected from illegal or unauthorized use by the copy protection information in unit of a cell (or in unit of minimum reproduction).

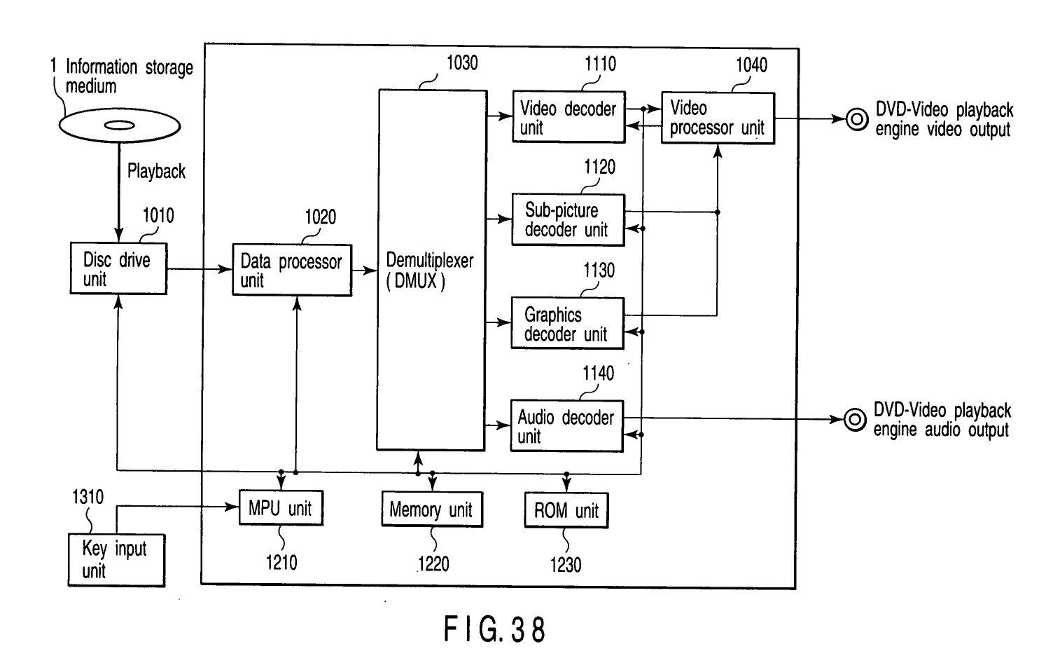

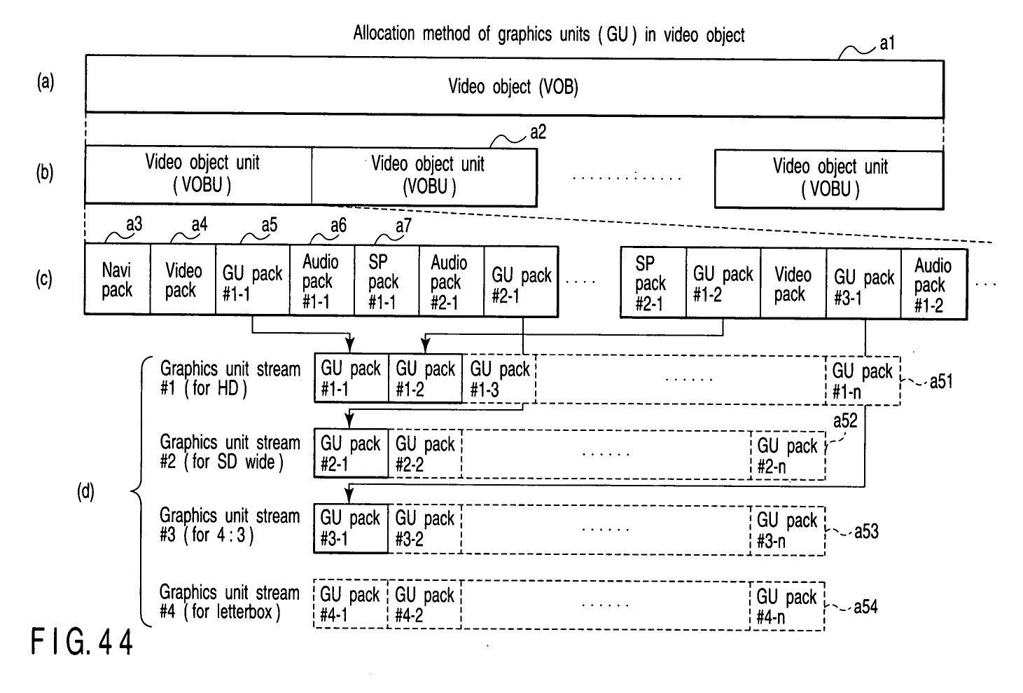

FIG. 38 is a block diagram for explaining an example of the internal structure of a playback apparatus of the disc-shaped information storage medium (optical disc, etc.) according to the embodiment of the invention. Referring to FIG. 38, information storage medium 1 records HD_DVD-Video content according to the embodiment of the invention. Disc drive unit 1010 plays back the HD_DVD-Video content from this information storage medium 1, and transfers them to data processor unit 1020. A Video Object (VOB) as picture data in the HD_DVD-Video content includes a group of Video Object Unit (VOBU) data as a basic unit shown in FIG. 44(c), and navi pack a3 is allocated at the head in each VOBU. Video data, audio data, and sub-picture data are respectively distributed and allocated in video packs a4, audio packs a6, and sub-picture (SP) packs a7, thus forming a multiplexed structure.

The embodiment of the invention may newly use graphics unit data, which is distributed and recorded in graphics unit (GU) packs a5. Demultiplexer 1030 in FIG. 38 demultiplexes a VOB formed by multiplexing these kinds of data into packets. Demultiplexer 1030 transfers video data recorded in video packs a4 to video decoder unit 1110, sub-picture data recorded in sub-picture packs a7 to sub-picture decoder unit 1120, graphics data recorded in graphics unit packs a5 to graphics decoder unit 1130, and audio data recorded in audio packs a6 to audio decoder unit 1140. Respective kinds of incoming data are decoded by decoder units 1110 to 1140, and are combined as needed in video processor unit 1040. Then, the combined data is converted into an analog signal via digital-to-analog converters 1320 and 1330, and the analog signal is output. MPU unit 1210 systematically manages a series of these processes, and temporarily stores data, which is to be temporarily saved during processing, in memory unit 1220. ROM unit 1230 records processing programs to be processed by MPU unit 1210 and permanent data set in advance. In FIG. 38, information which is input from the user to the information playback apparatus is input via key inputs at key input unit 1310. However, the invention is not limited to this, and key input unit 1310 may comprise a general remote controller.

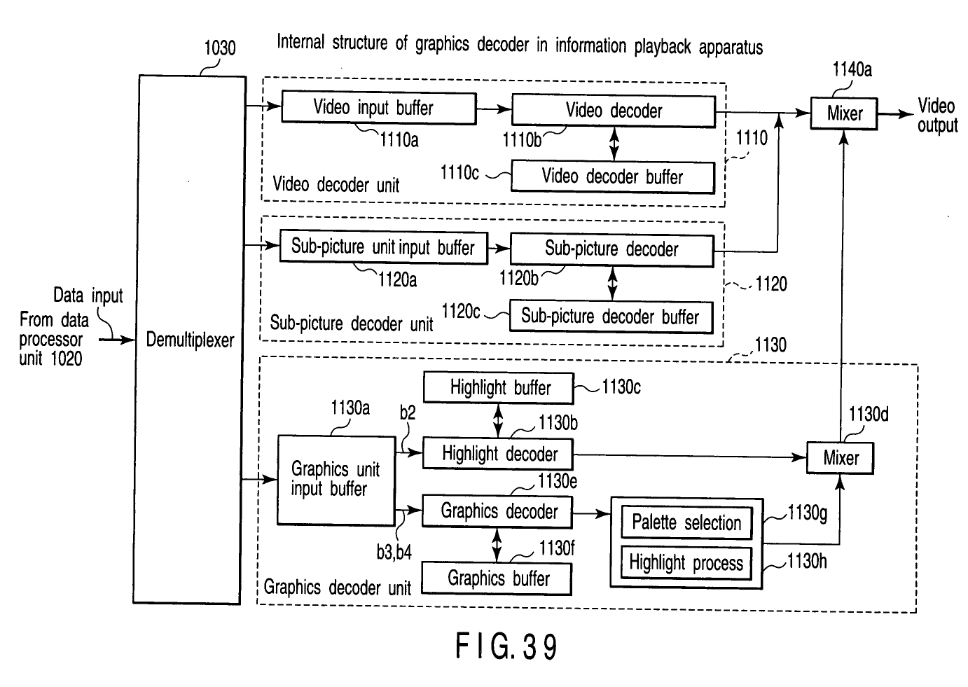

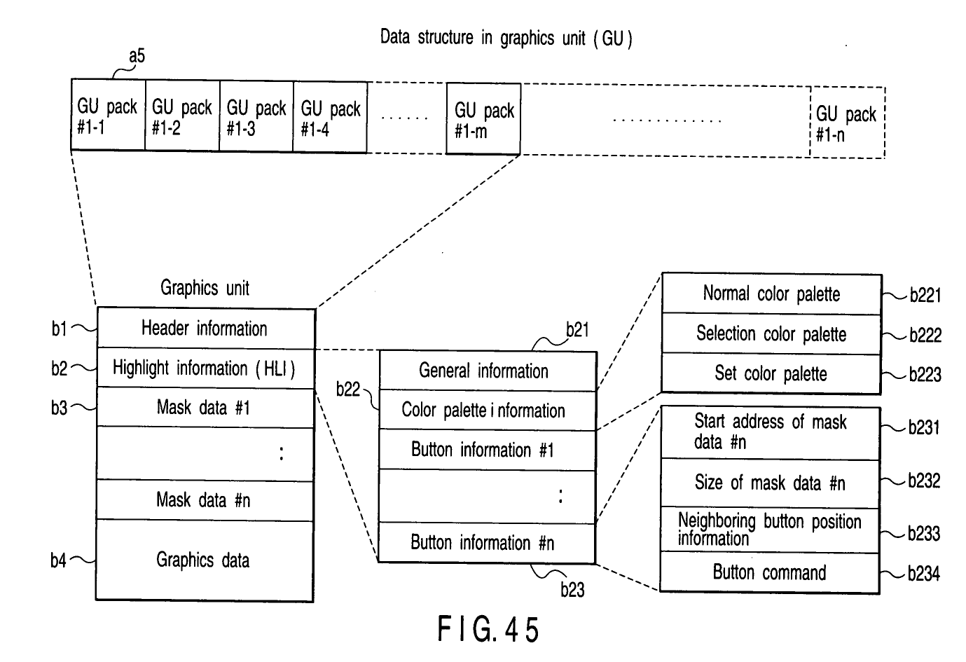

FIG. 39 is a block diagram for explaining the internal structure of graphics decoder unit 1130 shown in FIG. 38 in detail. Graphics unit data demultiplexed and extracted by demultiplexer 1030 is temporarily saved in graphics unit input buffer 1130a. The graphics unit data includes highlight information and graphics data and/or mask data, as will be described later with reference to FIG. 45. This highlight information is transferred to highlight decoder 1130b, and is decoded. The graphics data and mask data are decoded to 256-color screen information in graphics decoder 1130e.

Furthermore, after selection of color palettes and a highlight process (e.g., a process for changing a part of graphics data to be highlighted to a striking color) are applied to the decoded graphics data and/or mask data as needed, the graphics data and/or mask data are/is mixed with the decoded highlight data (e.g., picture data which has emphasized frame pixels at positions to be highlighted, and transparent pixels at other positions) by mixer 1130d, and the decoded graphics data and/or mask data modified by the highlight data as needed are/is sent to mixer 1140a. This mixer 1140a mixes the decoded graphics data and/or mask data with video data from video decoder unit 1110 and sub-picture data from sub-picture decoder unit 1120, thus forming a video output. Note that mixer 1140a in FIG. 39 is included in video processor unit 1040 in FIG. 38.

In the arrangement shown in FIG. 39, the decoded output of highlight decoder 1130b may control palette selector 1130g and/or highlight processor 1130h, so that the highlight modification may be directly applied to the decoded output of graphics decoder 1130e (in this case, mixer 1130d can be omitted).

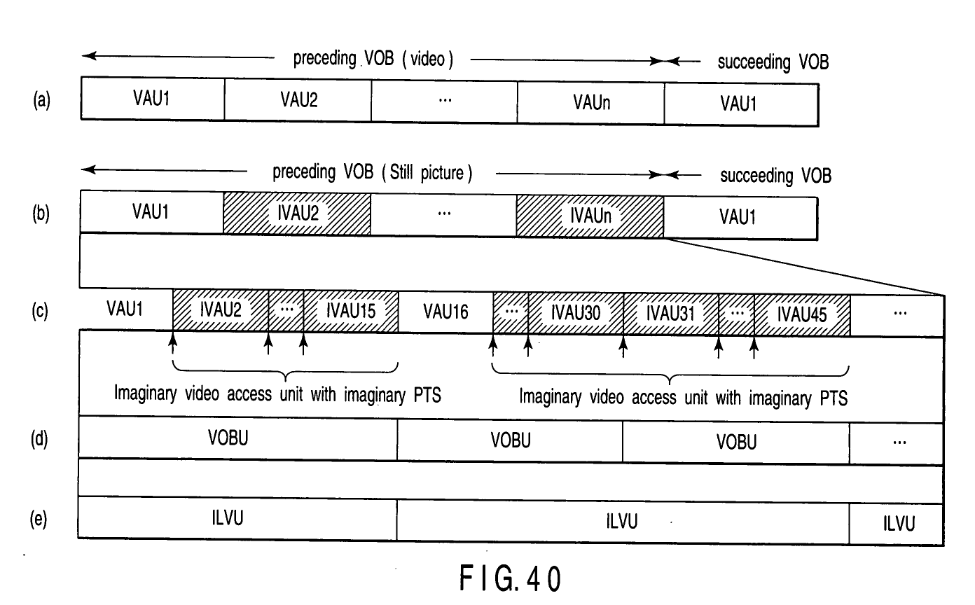

FIG. 40 is a view for explaining the concept of imaginary video access unit (IVAU). An IVAU according to the embodiment of the invention will be described below using FIG. 40. Each VOB of a movie in the conventional SD DVD-Video content is divided into Video Access Unit (VAU) data, as shown in FIG. 40(a). By matching the boundary position of neighboring VOB data with that of neighboring VAU data, seamless playback between different VOB data can be attained.

In the HD_DVD-Video according to the embodiment of the invention, as shown in FIG. 40(b), “imaginary access units” IVAU2 to IVAUn (imaginary video access units 2 to n) are set in a period between VAU1 which includes I-picture that records a still picture, and VAU1 including I-picture that records a next still picture to be displayed. This is a characteristic feature of this invention. As the setting method of access units, an interval between (VAU1 including) I-picture from which a still picture starts and (VAU1 including) the next I-picture is imaginarily finely time-divided for respective periods of access units using as a unit the video frame time or a time in an integer multiple of the video frame. A Decoding Time Stamp (DTS) indicating the input timing of a still picture to the decoder, and a Presentation Time Stamp (PTS) indicating the display timing of a still picture are set in advance for each still picture. Since one video frame period is determined in National Television System Committee (NTSC) and Phase Alternation by Line (PAL), the timing of a boundary position of the “imaginary access units” is calculated, and the calculated timing is set as an imaginary PTS, as shown in FIG. 40(c). Then, it can be (imaginarily) considered as if a still picture is repetitively played back and displayed for respective virtual access units.

In the embodiment of the invention, as shown in FIG. 40(d), one VOBU is formed of an integer number of “virtual access units”. As a result, in the embodiment of the invention, a VOBU display time of each still picture becomes an integer multiple of a video frame. In FIG. 40(c), a VAU (Video Access Unit) includes one I-picture indicating a still picture, but an IVAU does not include any I-picture. Hence, no video data is included in the IVAU. That is, each of a VOBU formed by VAU1 to IVAU15 and that formed by VAU16 to IVAU30 includes only one I-picture. By contrast, a VOBU formed by IVAU30 to IVAU45 does not include any video data (I-picture).

Note that the embodiment of the invention allows to define a VOBU having no video data. Also, the embodiment of the invention inhibits one VOBU from having a plurality of I-picture data, and limits (constrains) so that one VOBU has one or less (including zero) I-picture. As can be seen from comparison of the positions in (c) and (d) of FIG. 40, one VOBU adopts a structure in which a VAU is (imaginarily) allocated ahead of an IVAU. As shown in FIG. 40(e), the first VOBU in an Interleaved Unit (ILVU) always has video data (I-picture that records a still picture).

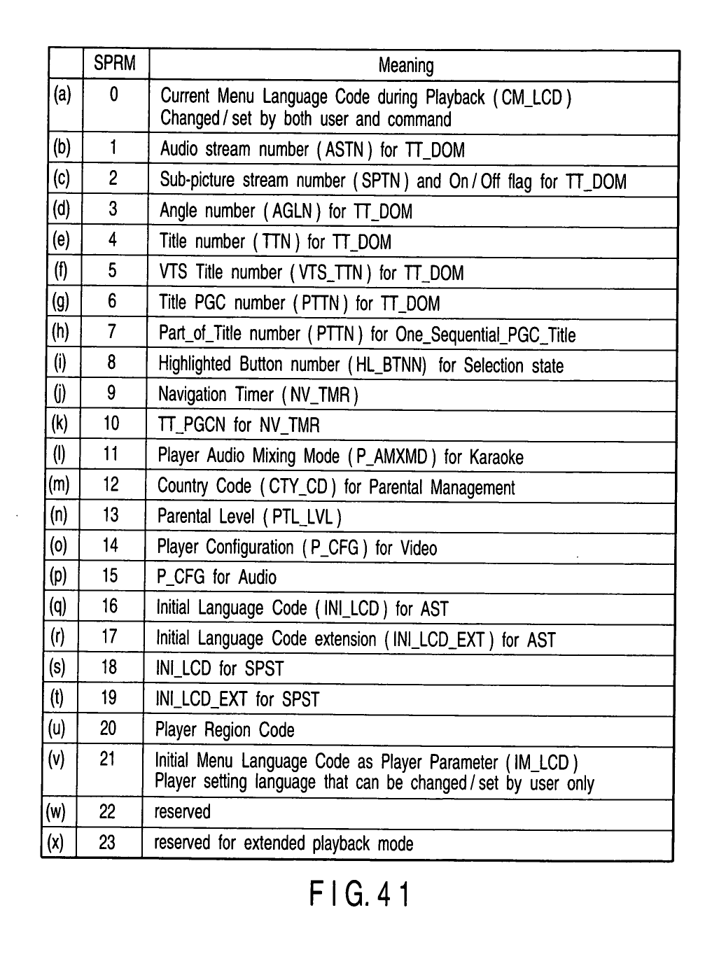

FIG. 41 is a view for explaining a practical example of system parameters used in the embodiment of the invention. In the system block diagram in the information playback apparatus shown in FIG. 38, memory unit 1220 is assigned fields for storing system parameters “0” to “23” shown in FIG. 41. Current menu language code information during playback (a language code that can be changed/set by the user and/or a command) is recorded in “SPRMO”, and initial menu language code information (a setting language code of the playback apparatus which can be changed/set by only the user) is recorded in “SPRM21”. Other kinds of information to be stored in other system parameters are: audio stream number (ASTN) for TT_DOM in SPRM(1); sub-picture stream number (SPSTN) and on/off flag for TT_DOM in SPRM(2); angle number (AGLN) for TT_DOM in SPRM(3); title number (TTN) for TT_DOM in SPRM(4); VTS title number (VTS_TTN) for TT_DOM in SPRM(5); title PGC number (TT_PGCN) for TT_DOM in SPRM(6); Part_of_Title number (PTTN) for One_Sequential_PGC_Title in SPRM(7); Highlighted Button number (HL_BTNN) for Selection state in SPRM(8); Navigation Timer (NV_TMR) in SPRM(9); TT_PGCN for NV_TMR in SPRM(10); Player Audio Mixing Mode (P_AMXMD) for Karaoke in SPRM(11); Country (or Region) Code (CTY_CD) for Parental Management in SPRM(12); Parental Level (PTL_LVL) in SPRM(13); Player Configuration (P_CFG) for Video in SPRM(14); P_CFG for Audio in SPRM(15); Initial Language Code (INI_LCD) for AST in SPRM(16); Initial Language Code extension (INI_LCD_EXT) for AST in SPRM(17); INI_LCD for SPST in SPRM(18); INI_LCD_EXT for SPST in SPRM(19); and Player Region Code in SPRM(20).

FIG. 42 shows an example of a list of commands used in the embodiment of the invention. Commands with command ID-1=“000” to “110” are the same as those used in the conventional DVD-Video, but a command “Call INTENG” with command ID-1=“111” is the one which is newly introduced in the embodiment of the invention and uses an interactive engine.

FIG. 43 shows an example of a command list used in the HD_DVD-Video content in the embodiment of the invention. “Compare Field” shown in FIG. 43(a) is used to compare a value in a navigation parameter with a specific value specified by an operand of a command. If this comparison result is true, a subsequent instruction is executed; if it is false, a subsequent instruction is skipped. This instruction is used in combination with other instruction groups. In FIG. 43(a), EQ means Equal; NE, Not Equal; GE, Greater than or equal to; GT, Greater than; LE, Less than or equal to; LT, Less than; and BC, Bitwise Compare.

“Go To Option” in “Branch Field” shown in FIG. 43(b) is used to change the execution order of navigation commands in a pre-command area or post command area, or a resume command area or cell command area. In FIG. 43(b), GoTo means transition to another navigation command, and Break means the end of execution of a navigation command in the pre-command area or post command area, or the resume command area or cell command area. Also, SetTmpPML means confirmation of a temporal change in parental level, a change in parental level, and transition to a specific navigation command if possible.

“Link Option” in “Branch Field” shown in FIG. 43(c) is used to start playback specified in one domain. In FIG. 43(c), LinkPGCN means the start of playback of a PGC of interest by directly designating a program chain number (PGCN). LinkPTTN means the start of playback of a PTT of interest (or a chapter of interest) by directly designating a part_of_title number (PTTN). LinkPGN means the start of playback of a PG of interest by directly designating a program number (PGN). LinkCN means the start of playback of a cell of interest by directly designating a cell number (CN).

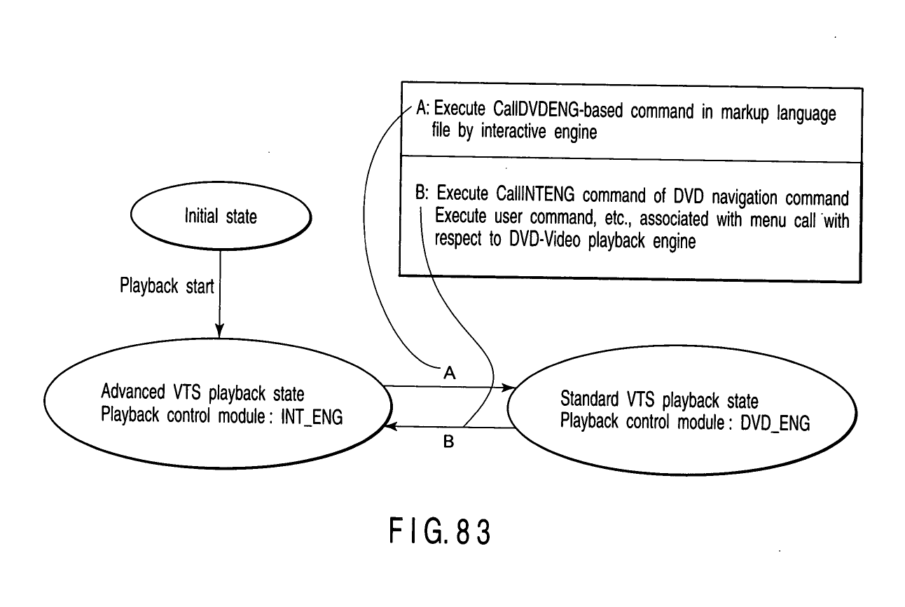

“Jump Option” in “Branch Field” shown in FIG. 43(d) is used to start specific playback after space movement. In FIG. 43(d), Exit means the end of playback. JumpTT means title playback start (when title number TTN is used). JumpVTS_TT means title playback start in a single VTS. CallSS means PGC playback start in a system space that stores resume information. JumpSS means playback start of a part_of_title included in a specific title in a single VTS. CallINTENG represents transfer of the control from a DVD-Video playback engine to an interactive engine (details are shown in FIG. 83).

“SetSystem Field” shown in FIG. 43(e) is used to set a system parameter value, and a mode and value of a general parameter. In FIG. 43(e), SetSTN means setting of a stream number (parameters to be set are SPRM(1), SPRM(2), and SPRM(3)). SetNVTMR means condition setting of the navigation timer (parameters to be set are SPRM(9) and SPRM(10)). SetHL_BTNN means setting of the highlighted button number for a selection state (a parameter to be set is SPRM(8)). SetAMXMD means setting of an audio mixing mode of the playback apparatus for Karaoke (a parameter to be set is SPRM(11)). SetGPRMMD means setting of modes and values of general parameters (parameters to be set are GPRM(0) and GPRM(15)). SetM_LCD means setting of a menu description language code (a parameter to be set is SPRM(0)). SetRSMI means updating of resume information (parameters to be set are a CN, NV_PCK address, PGC control state, VTSN (Video Title Set Number), SPRM(4), SPRM(5), SPRM(6), SPRM(7), and SPRM(8)).

“Set Field” shown in FIG. 43(f) is used to execute a calculation on the basis of a specific value specified by an operand and a general parameter. The calculation includes the following two types:

Arithmetic Operation

Bitwise Operation

The calculation result is re-stored as a general parameter. In FIG. 43(f), Exp means an exponential calculation; Div, division; and Add, addition.

FIG. 44 shows the allocation of graphics units GU in a video object. The HD_DVD-Video content used in the embodiment of the invention comply with the multiplexing rule of the MPEG system layer. That is, graphics unit data is segmented into every 2048-byte packs, and these packs are separately allocated. Upon playback, graphics unit (GU) packs which are distributed and allocated in information storage medium 1 are collected to re-form a single graphics unit stream, as shown in (c) and (d) of FIG. 44. Graphics units can support graphics data corresponding to an HD picture at 16:9, SD picture at 16:9, SD picture at 4:3, and SD picture at letter box, and independent streams are formed in correspondence with the four types of pictures (HD picture at 16:9, SD picture at 16:9, SD picture at 4:3, and SD picture at letter box), as shown in FIG. 44(d).

FIG. 45 shows an example of the data structure in a graphics unit. As shown in FIG. 45, the data structure in the graphics unit includes header information b1, highlight information b2, mask data b3, and graphics data b4. Highlight information b2 includes general information b21, color palette information b22, and button information b23.

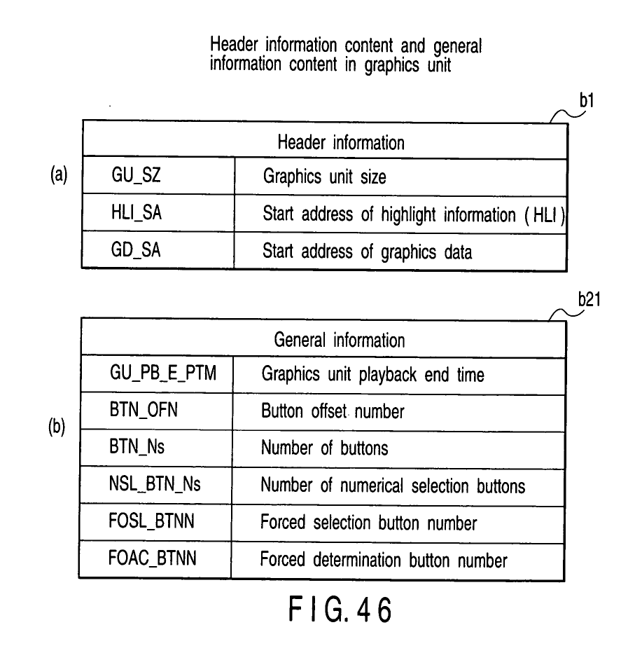

FIG. 46 shows an example of the header information content and general information content in the graphics unit. As shown in FIG. 46, the content of the header information include graphics unit size (GU_SZ) information, the start address (HLI_SA) information of the highlight information, and the start address (GD_SA) information of the graphics data. Of these content, the graphics unit size (GU_SZ) information indicates the overall size of the graphics unit shown at the lower left position in FIG. 45. The start address (HLI_SA) information of the highlight information means an address to the start position of highlight information b2 with reference to the head position (that of header information b1) of the graphics unit shown at the lower left position in FIG. 45. Also, the start address (GD_SA) information of the graphics data means an address to the head position of graphics data b4 with reference to the head position (that of header information b1) of the graphics unit shown at the lower left position in FIG. 45.

Referring to FIG. 45, general information b21 in highlight information b2 has graphics unit playback end time (GU_PB_E_PTM) information, button offset number (BTN_OFN) information, information of the number (BTN_Ns) of buttons, information of the number (NSL_BTN_Ns) of numeral selection buttons, forced selection button number (FOSL_BTNN) information, forced determination button number (FOAC_BTNN) information, and the like. The graphics unit area is distributed and allocated as graphics unit (GU) packs, as described above using FIG. 44. This graphics unit pack (strictly speaking, a packet header in a graphics unit packet included in that pack) records in advance PTS (Presentation Time Stamp) information at which playback of the graphics unit starts. Using this PTS information and the graphics unit playback end time (GU_PB_E_PTM) information, a graphics unit display time and effective time that allows execution (of a command) (both the start/end times completely match) are set. Since the start/end time information uses a PTS/PTM, the time range can be set with a very high precision.

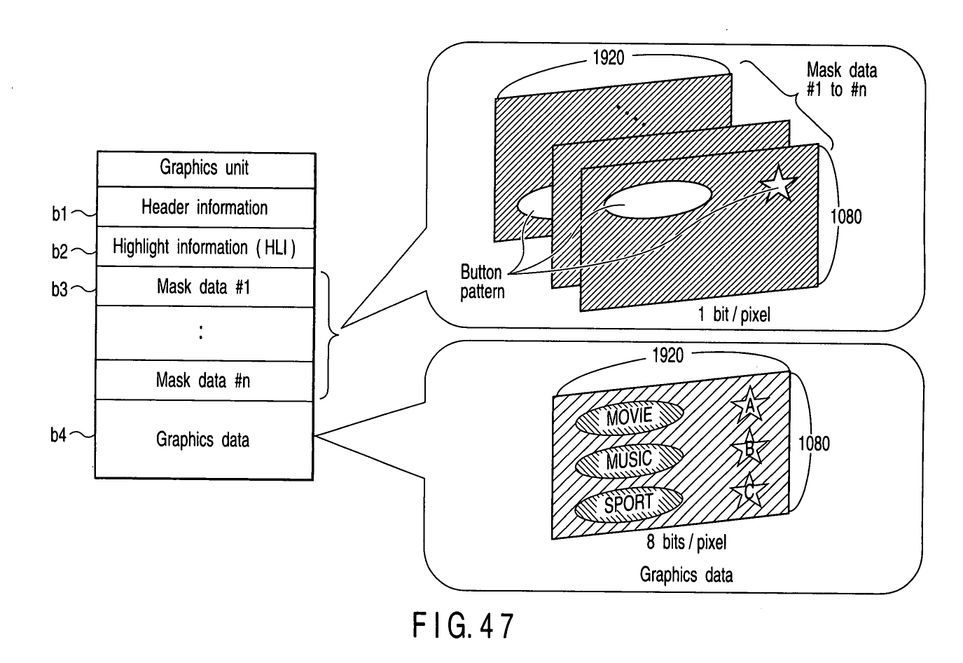

FIG. 47 is a view for explaining an image example of mask data and graphics data in the graphics unit. As the graphics data, as shown in FIG. 47, picture information (bitmap data or compressed data of that bitmap) for one screen which allows 256-color expression by assigning 8 bits per pixel is recorded. The mask data indicates a position range on the screen where the user can designate command execution, and sets only a screen region by assigning 1 bit per pixel. Since the mask data designates a region in the bitmap format using pixels, not only a plurality of regions located at positions separate from each other can be simultaneously set by masking, but also an arbitrary shaped region can be finely set as a masking screen region using pixels, as shown in FIG. 47. This is also a characteristic feature of this embodiment. A plurality of mask data can be set, and a plurality of menu choices to the user can be supplied (FIG. 47 exemplifies three user's choices).

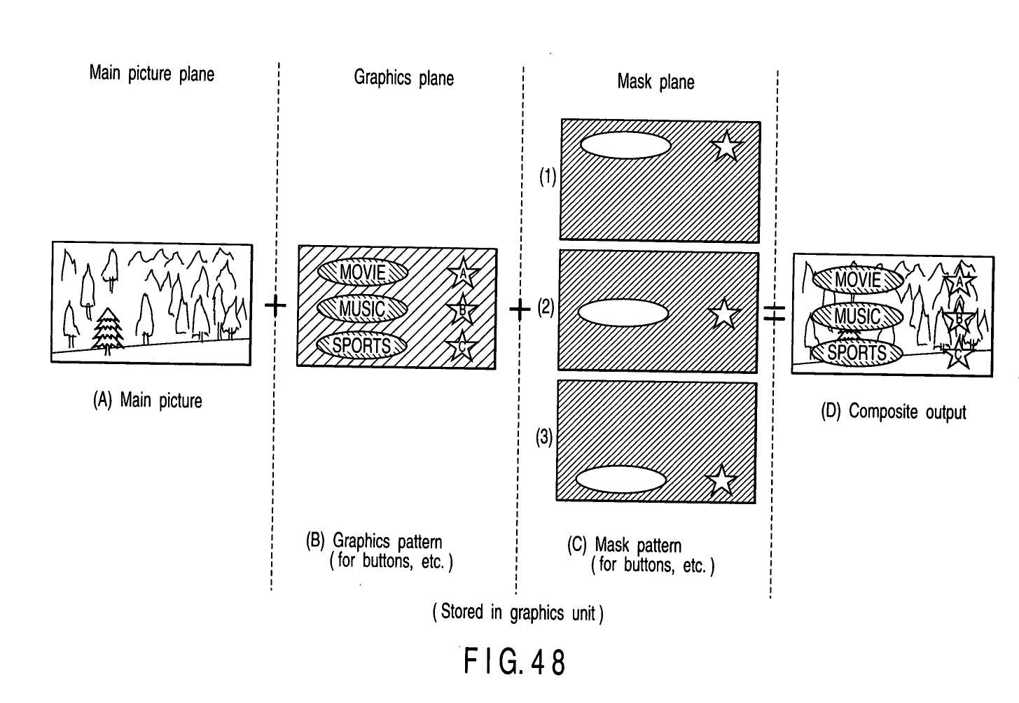

FIG. 48 shows an example of video composition including mask patterns. A screen to be presented to the user can be generated by compositing main picture (A) recorded in video packs a4 in FIG. 44(c), graphics pattern (B) recorded as the graphics data, and mask data (c) that can set a plurality of patterns, as shown in FIG. 48.

In the embodiment of the invention, as shown in FIG. 45, the number n of mask data in a single graphics unit matches the number n of pieces of button information recorded in the highlight information, and each mask data #n and button information #n have one-to-one correspondence. That is, in m that satisfies 1≦m≦n, the m-th mask data from the top corresponds to the m-th button information from the top. For example, when the user highlights (designates) a region designated by the m-th mask data on the screen by operating a cursor key or the like on a remote controller (not shown), button command b234 recorded in m-th button information b23 is executed in response to that action. In this manner, each button information #n links with each individual mask data #n. In order to further facilitate access control to mask data, button information #n records start address (address from the head position of the header information to the n-th mask data start position in the lower left view of FIG. 45) information b231 and data size information b232 of corresponding mask data #n. In addition, button information b23 records neighboring button position information b233.

The data structure in color palette information b22 in highlight information b2 in FIG. 45 will be described below. Normal color palette b221 stores color information of buttons when the menu screen is presented to the user first (before user selection). When the user selects (designates) a specific button, the display color of that button changes on the screen. Selection color palette b222 records the changed display color of the button. Furthermore, when that button is set, and button command b234 corresponding to the button is about to be executed, the display color of the button can be set to be changed to a color indicating “set”. Set color palette b223 has the set display color of the button.

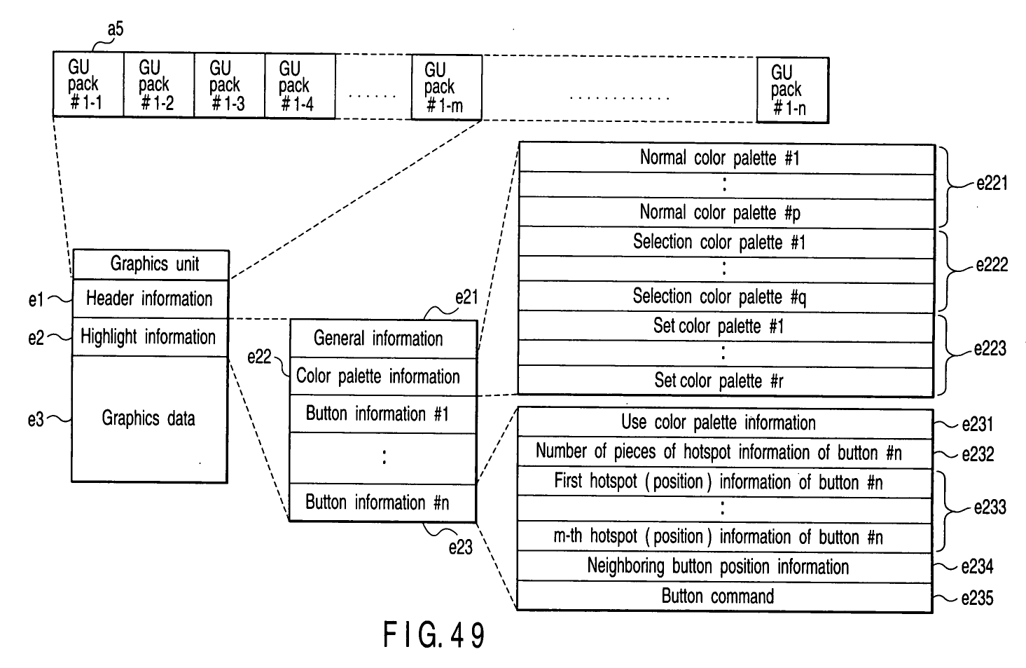

FIG. 49 shows another embodiment associated with the data structure of the graphics unit. The embodiment of FIG. 49 is characterized in that hot spot information is used in place of mask data. In correspondence with this feature, in the example of FIG. 49, a plurality of normal color palettes e221, selection color palettes e222, and set color palettes e223 can be set. As the region designation method of each button information e23 on the screen, a region on the screen can be designated by hot spot position information e233 in place of mask data. Furthermore, in the example of FIG. 49, a plurality of pieces of hot spot position information e233 can be set for one button information e23, so that a plurality of regions which are separate from each other on the screen can correspond to one button information e23.

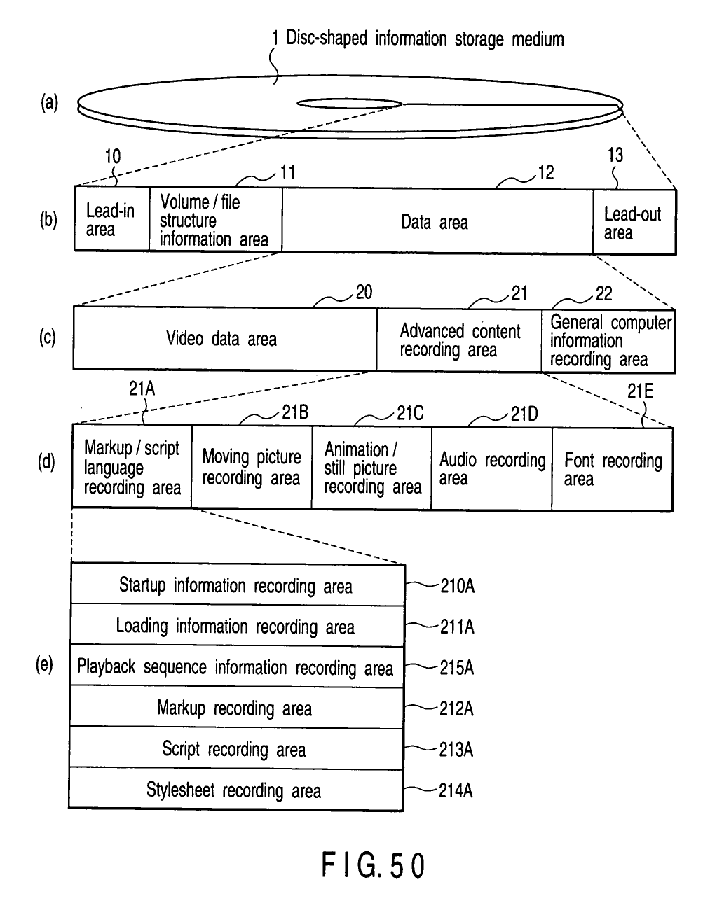

FIG. 50 is a view for explaining an example of the recording content of an advanced content recording area of the information content recorded on disc-shaped information storage medium (optical disc, etc.) 1 according to another embodiment of the invention. As shown in FIG. 50(d), advanced content recording area 21 in FIG. 50(c) is configured to include moving picture recording area 21B for recording moving picture data, animation/still picture recording area 21C for recording animation data and still picture data, audio recording area 21D for recording audio data, font recording area 21E for recording font data, and markup/script language recording area 21A for recording information for controlling playback of these data (such information is described using a markup language/script language/StyleSheet, and the like) (the area 21A is the head of the recording order of these areas as shown in FIG. 50).

The information for controlling playback (recording content in area 21A) describes a playback method (display method, playback sequence, playback switching sequence, selection of objects to be played back, etc.) of advanced content (including audio, still picture, font/text, moving picture, animation, and the like) and/or DVD-Video content using a markup language, script language, and StyleSheet. For example, markup languages such as HTML (Hyper Text markup Language)/XHTML (extensible Hyper Text markup Language), SMIL (Synchronized Multimedia Integration Language), and the like, script languages such as an ECMA (European Computer Manufacturers Association) script, Javascript (Java is the registered trade name), and the like, StyleSheets such as CSS (Cascading Style Sheet), and the like, and so forth, may be used in combination.

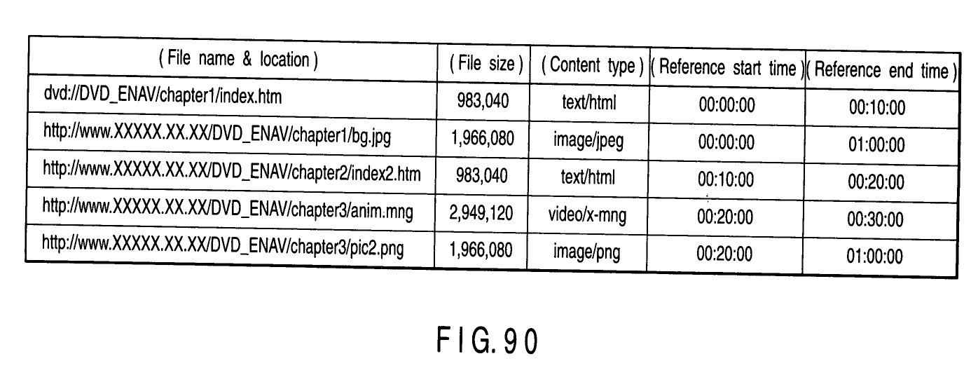

markup/script language recording area 21A includes startup recording area 210A for recording startup information, loading information recording area 211A for recording information of files to be loaded onto a buffer in a playback apparatus (see FIG. 90), playback sequence information recording area 215A for defining the playback order of video pictures for playing back the HD_DVD video pictures stored in the expansion video object sets of the advanced title sets using a markup language or script language, markup language recording area 212A for recording the aforementioned markup languages, script recording area 213A for recording the aforementioned script languages, and StyleSheet recording area 214A for recording the aforementioned StyleSheets.

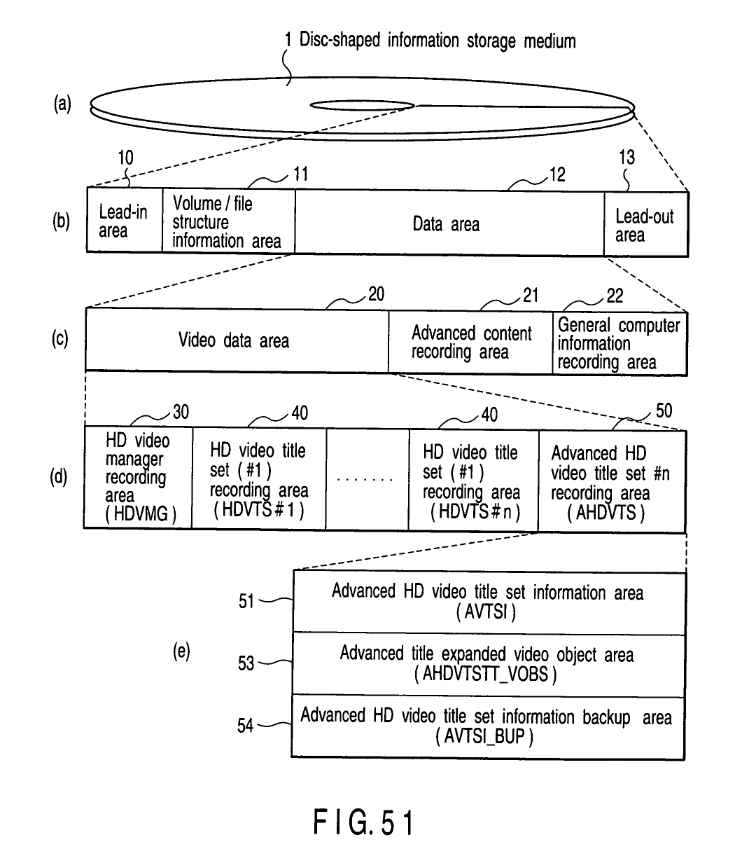

FIG. 51 is a view for explaining an example of the recording content of an advanced HD video title set recording area of the information content recorded on disc-shaped information storage medium (optical disc, etc.) 1 according to still another embodiment of the invention. An advanced HD video title set (AHDVTS: advanced VTS) shown in FIG. 51(d) is a video object which is specialized to be referred to from a markup language as one of the aforementioned advanced content.

As shown in FIG. 51(e), advanced HD video title set (AHDVTS) recording area 50 includes advanced HD video title set information (AHDVTSI) area 51 that records management information for all the content in advanced HD video title set recording area 50, advanced HD video title set information backup area (AHDVTSI_BUP) 54 that records the same information as in HD video title set information area 51 as backup data, and advanced title video object area (AHDVTSTT_VOBS) 53 that records video object (title picture information) data in an advanced HD video title set.

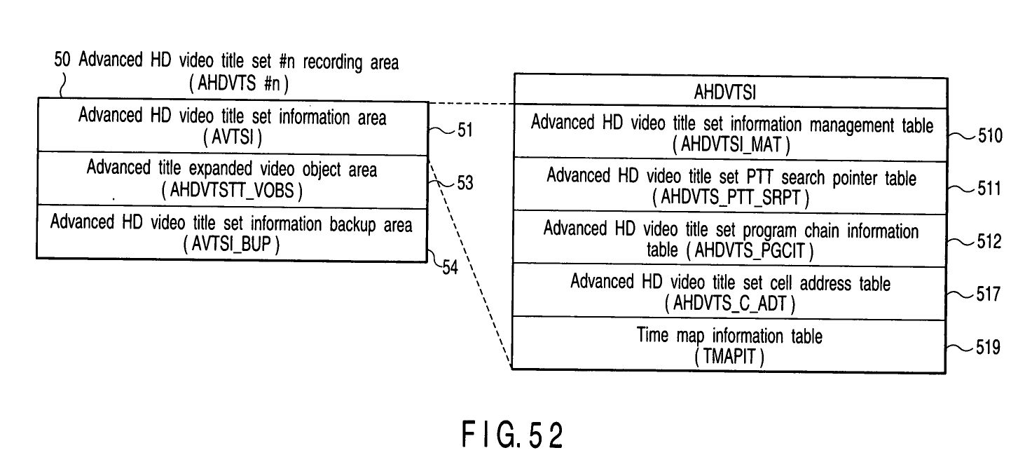

FIG. 52 shows an example of the data structure of advanced HD video title set information recorded in the advanced HD video title set recording area. This information is recorded together in file HVIA0001.IFO (or VTSA0100.IFO; not shown), and advanced HD video title set information (AHDVTSI) area 51 shown in FIG. 51(e) is divided into respective fields (management information groups): advanced HD video title set information management table (AHDVTSI_MAT) 510, advanced HD video title set PTT search pointer table (AHDVTS_PTT_SRPT) 511, advanced HD video title set program chain information table (AHDVTS_PGCIT) 512, advanced HD video title set cell address table (AHDVTS_C_ADT) 517, and time map information table (TMAPIT) 519, as shown in FIG. 52.

Note that time map information table (TMAPIT) 519 is one field of advanced HD video title set information (AHDVTSI) area 51, but it can be recorded in the same file (HVIA0001.IFO in FIG. 2) as advanced HD video title set information area 51 or in a file (e.g., HVM00000.MAP) independent from advanced HD video title set information area 51.

Advanced HD video title set information management table (AHDVTSI_MAT) 510 records management information common to the corresponding video title set. Since this common management information is allocated in the first field (management information group) in advanced HD video title set information (AHDVTSI) area 51, the common management information in the video title set can be immediately loaded. Hence, the playback control process of the information playback apparatus can be simplified, and the control processing time can be shortened.

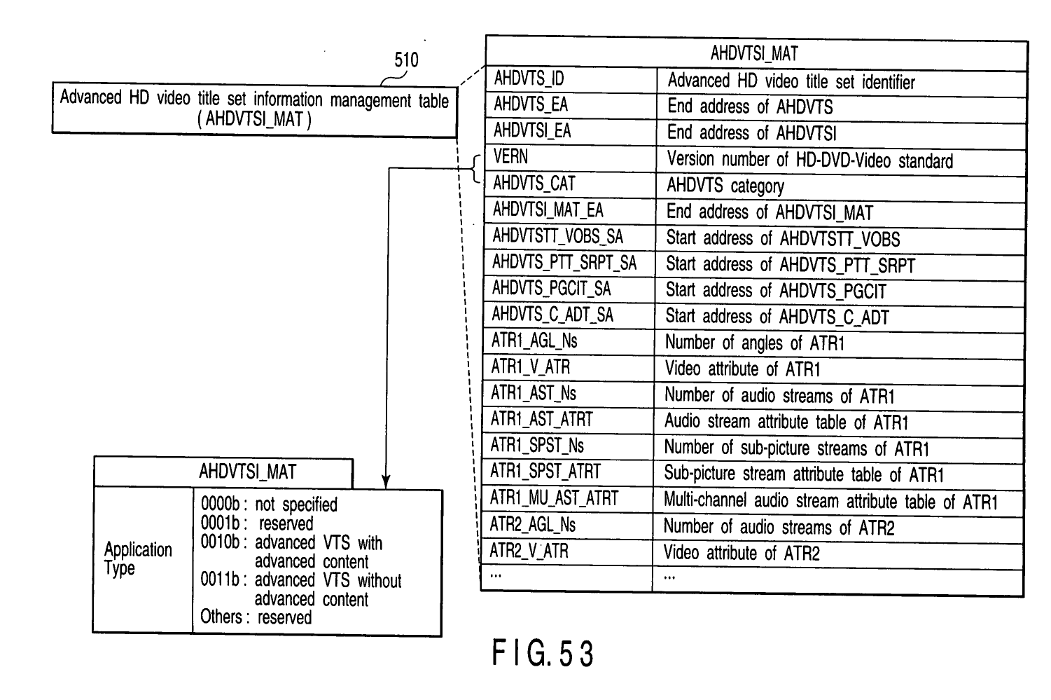

FIG. 53 shows an example of the data structure of the advanced HD video title set information management table (AHDVTSI_MAT) recorded in the advanced HD video title set information (AHDVTSI), and the recording content of category information (AHDVTS_CAT) stored in this management table. Advanced HD video title set information management table (AHDVTSI_MAT) 510 can store the following information as the common management information in the video title set. That is, as shown in FIG. 53, the advanced HD video title set information management table can store various kinds of information: an advanced HD video title set identifier (AHDVTS_ID), the end address (AHDVTS_EA) of the advanced HDVTS, the end address (AHDVTSI_EA) of the advanced HDVTSI, the version number (VERN) of the HD_DVD-Video standard, an AHDVTS category (AHDVTS_CAT), the end address (AHDVTSI_MAT_EA) of the AHDVTSI_MAT, the start address (AHDVTSTT_VOBS_SA) of the AHDVTSTT_VOBS, the start address (AHDVTS_PTT_SRPT_SA) of the AHDVTS_PTT_SRPT, the start address (AHDVTS_PGCIT_SA) of the AHDVTS_PGCIT, the start address (AHDVTS_C_ADT_SA) of the AHDVTS C ADT, the number (ATR1_AGL_Ns) of angles of a video object having attribute information 1 (ATR1), a video attribute (ATR1_V_ATR) of the video object having attribute information 1 (ATR1), the number (ATR1_AST_Ns) of audio streams of the video object having attribute information 1 (ATR1), an audio stream attribute table (ATR1_AST_ATRT) of the video object having attribute information 1 (ATR1), the number (ATR1_SPST_Ns) of sub-picture streams of the video object having attribute information 1 (ATR1), a sub-picture stream attribute table (ATR1_SPST_ATRT) of the video object having attribute information 1 (ATR1), a multi-channel audio stream attribute table (ATR1_MU_AST_ATRT) of the video object having attribute information 1 (ATR1), and the like (attribute information 2 and attribute information 3 follow).

Of the information that can be stored in the management table (AHDVTSI_MAT) in FIG. 53, the start address (HDVTSM_VOBS_SA) of an HDVTSM_VOBS included in a standard VTS need not exist since the advanced VTS does not include any HDVTSM_VOBS (or may be used as a reserved area). The start address (HDVTSM_PGCI_UT_SA) of the HDVTSM_PGCI_UT included in the standard VTS need not exist since the advanced VTS does not include any HDVTSM_VOBS (or may be used as a reserved area). The start address (HDVTSM_C_ADT_SA) of the HDVTSM_C_ADT included in the standard VTS need not exist since the advanced VTS does not include any HDVTSM (or may be used as a reserved area). The start address (HDVTSM_VOBU_ADMAP_SA) of the HDVTSM_VOBU_ADMAP included in the standard VTS need not exist since the advanced VTS does not include any HDVTSM (or may be used as a reserved area). Furthermore, the start address (HDVTS_VOBU_ADMAP_SA) of the HDVTS_VOBU_ADMAP included in the standard VTS need not exist since the advanced VTS includes the substitute time map information table (or may be used as a reserved area).

Note that the information (AHDVTS_CAT) indicating categories of the advanced VTS stored in advanced HD video title set information management table (AHDVTSI_MAT) 510 in FIG. 53 is defined as follows:

AHDVTS_CAT=0000b: no AHDVTS category is specified

AHDVTS_CAT=0001b: reserved

AHDVTS_CAT=0010b: advanced VTS with advanced content

AHDVTS_CAT=0011b: advanced VTS without advanced content

AHDVTS_CAT=other: reserved

The “advanced VTS with advanced content” whose category is indicated by “AHDVTS_CAT=0010b” basically represents an advanced VTS which is configured with the markup language. That is, in this category, the content provider assumes an “advanced VTS controlled by the markup language”, and playback is permitted only according to the control of the markup language but playback of the advanced VTS alone is not permitted. For example, when the content provider describes a markup language that permits playback of an advanced VTS in a given period only under a specific condition, and if playback of the advanced VTS alone is permitted, this period can be undesirably played back under a condition other than the specific condition. Such playback is (or may be) inhibited for the advanced VTS of the category “AHDVTS_CAT=0010b”.

The “advanced VTS without advanced content” whose category is indicated by “AHDVTS_CAT=0011b” basically represents an advanced VTS that allows playback of the advanced VTS alone without any markup language. This assumes an advanced VTS which maintains playback compatibility between other recording standards (to be referred to as a VR standard) such as DVD-VR/HDDVD-VR and the playback dedicated standard (to be referred to as a video standard) in the embodiment of the invention. The video and VR standards have different standard content due to their different use applications (the video standard places an emphasis on interactiveness, and the VR standard places an emphasis on edit functions). By commonizing a structurally simplified advanced VTS between the two standards, playback compatibility can be assured between the two standards having different purposes. For example, an information storage medium recorded in an advanced VTS mode in a recorder according to the VR standard can be played back by all playback apparatuses that can play back the video standard.

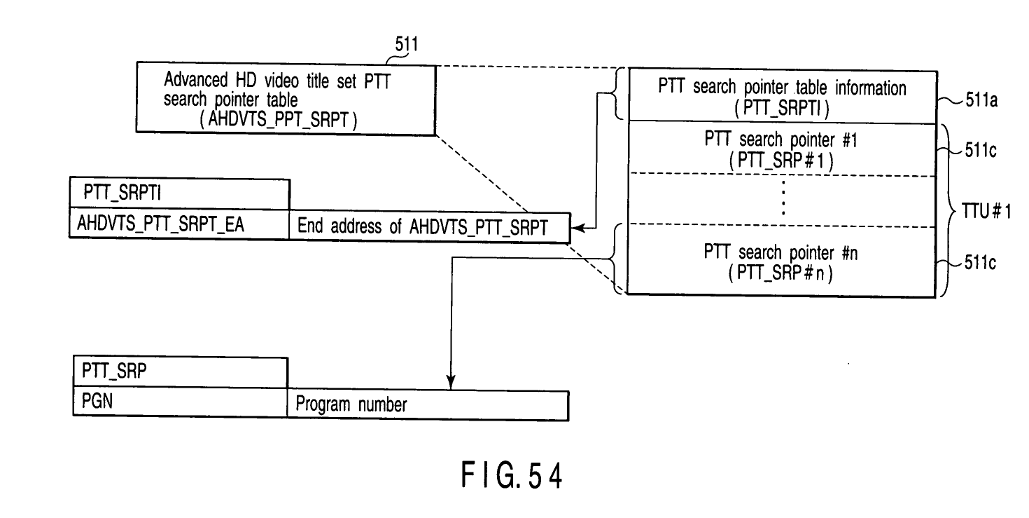

FIG. 54 shows an example of the data structure of advanced HD video title set PTT search pointer table (AHDVTS_PTT_SRPT) 511 shown in FIG. 52. Advanced HD video title set PTT search pointer table (AHDVTS_PTT_SRPT) 511 includes various kinds of information: PTT search pointer table information (PTT_SRPTI) 511a having information of the end address (AHDVTS_PTT_SRPT_EA) of the AHDVTS_PTT_SRPT; and PTT search pointers (PTT_SRP) 511c having information of a program number (PGN).

Note that HDVTS_TTU_Ns indicating the number of TTU data of an HDVTS which is included in the standard VTS need not exist since the number of TTU data in the advanced VTS is fixed, i.e., 1 (or if it exists, a fixed value is recorded). The advanced VTS can be configured to include only one title (TT). In this case, “title unit search pointers (TTU_SRP) 411b each of which records information of the start address (TTU_SA) of a TTU (see FIG. 22)” need not exist since there is only one TTU (or if it exists, a fixed value is recorded).

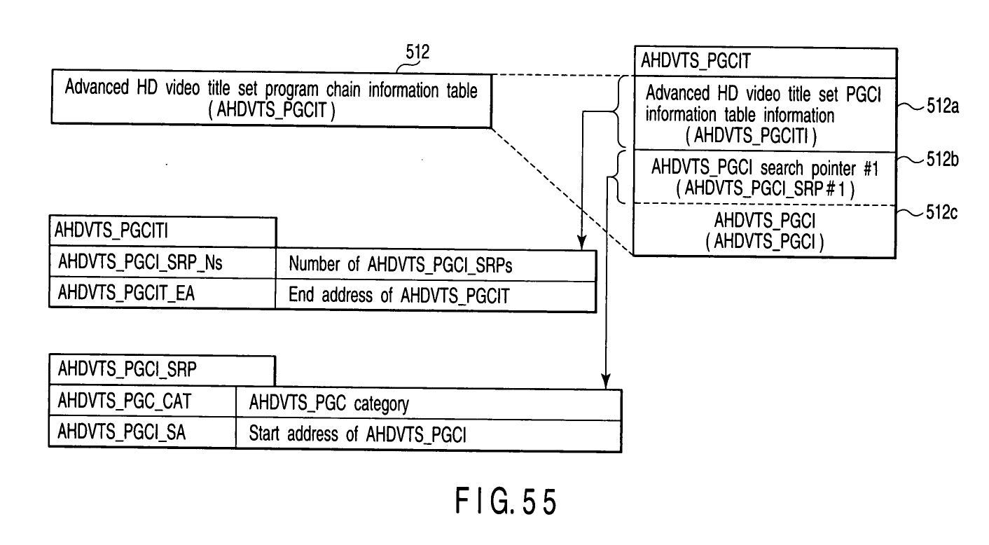

FIG. 55 shows an example of the data structure of advanced HD video title set program chain information table (AHDVTS_PGCIT) recorded in the advanced HD video title set information (AHDVTSI). As shown in FIG. 55, advanced HD video title set program chain information table (AHDVTS_PGCIT) 512 also records information of advanced HD video title set PGCI information table (AHDVTS_PGCITI) 512a including information of the number (AHDVTS_PGCI_SRP_Ns) of AHDVTS_PGCI_SRP data and the end address (AHDVTS_PGCIT_EA) of the AHDVTS_PGCIT. Also, AHDVTS_PGCI search pointer (AHDVTS_PGCI_SRP) 512b records information of the start address (AHDVTS_PGCI_SA) of the AHDVTS_PGCI together with the aforementioned AHDVTS_PGC category (AHDVTS_PGC_CAT).

Note that a plurality of PGCs can be prepared in the advanced VTS, but there is no function to control the connection relationship upon playback using navigation commands. For this reason, basically, there is only one PGC and one sequential playback of the advanced VTS is managed. In this case, the value of AHDVTS_PGCI_SRP_Ns is fixed, i.e., 1, and one each of search pointer (AHDVTS_PGCI_SRP) 512b and PGC information (AHDVTS_PGCI) 512c are present.

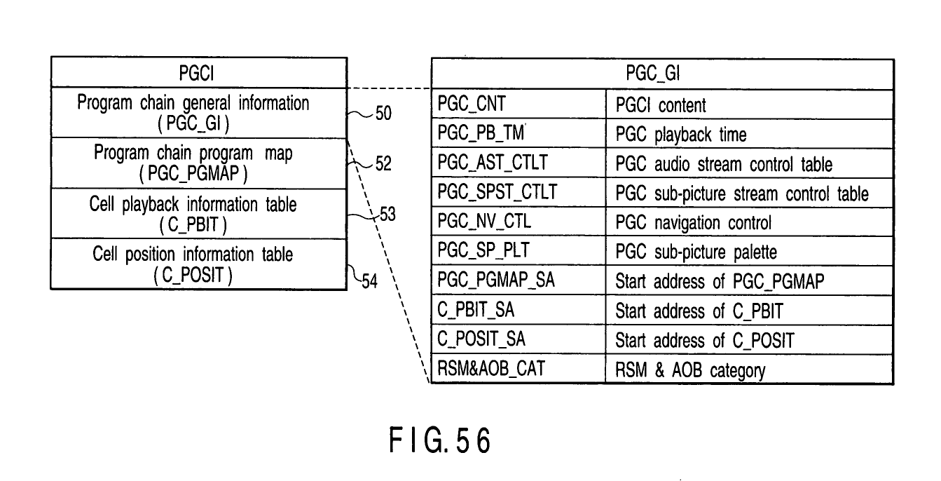

FIG. 56 shows an example of the data structure of program chain general information (PGC_GI) included in program chain information (corresponding to AHDVTS_PGCI in, e.g., FIG. 55). As shown in FIG. 56, the program chain information (PGCI) recorded in PGC information (AHDVTS_PGCI) 512c includes four fields (four management information groups), i.e., program chain general information (PGC_GI) 50, program chain program map (PGC_PGMAP) 52, cell playback information table (C_PBIT) 53, and cell position information table (C_POSIT) 54. Note that program chain command table (PGC_CMDT) 51 included in the PGCI of the standard VTS (FIG. 34) need not exist in the advanced VTS (or may be used as a reserved area).

As shown in FIG. 56, program chain general information (PGC_GI) 50 records various kinds of information including PGC content (PGC_CNT), a PGC playback time (PGC_PB_TM), a PGC audio stream control table (PGC_AST_CTLT), a PGC sub-picture stream control table (PGC_SPST_CTLT), PGC navigation control (PGC_NV_CTL), a PGC sub-picture palette (PGC_SP_PLT), the start address (PGC_PGMAP_SA) of the PGC_PGMAP, the start address (C_PBIT_SA) of the C_PBIT, and the start address (C_POSIT_SA) of the C_POSIT.

Note that the PGC user operation control (PGC_UOP_CTL) included in the standard VTS does not exist since the user operation control in the advanced VTS is made based on the markup language (or if it exists, PGC_UOP_CTL records a fixed value “00 . . . 00b”. Also, the PGC graphics unit stream control table (PGC_GUST_CTLT) included in the standard VTS does not exist since no graphics unit is used in the advanced VTS (or may be used as a reserved area). The start address (PGC_CMDT_SA) of the PGC_CMDT included in the standard VTS does not exist since no command table (PGC_CMDT) exists in the advanced VTS (or used as a reserved area).

Note that the example of the PGC_GI shown in FIG. 56 exemplifies RSM&AOB_CAT at its end. However, RSM&AOB category information (RSM&AOB_CAT) included in the standard VTS, i.e., RSM permission information, Audio selection information, and Audio Number information need not exist since the RSM information is controlled by the markup language and no Audio information is available in the advanced VTS (or may be used as a reserved area).

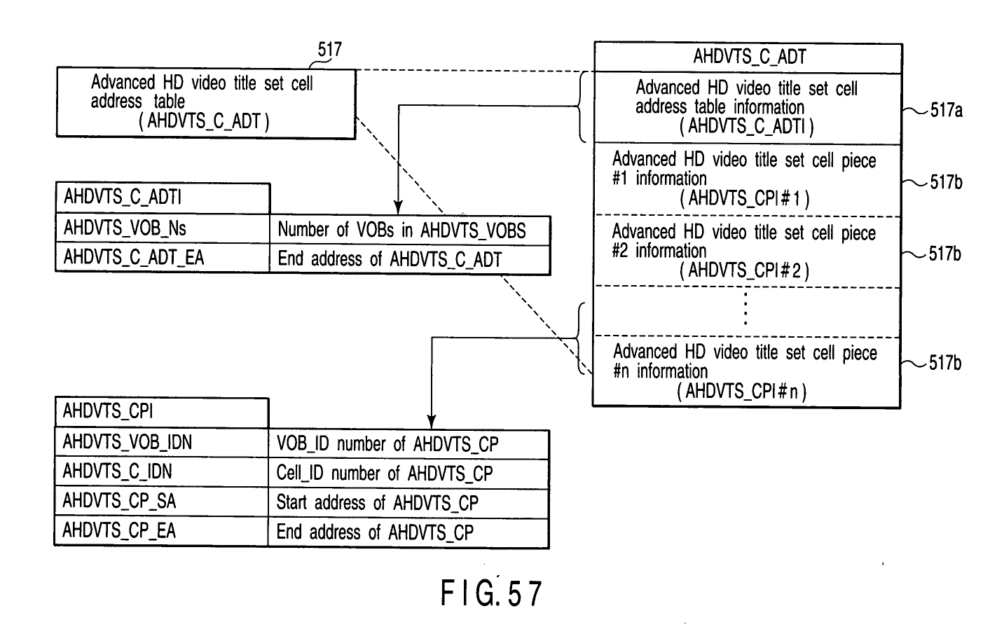

FIG. 57 shows an example of the data structure in advanced HD video title set cell address table (AHDVTS_C_ADT) 517 shown in FIG. 52. Advanced HD video title set cell address table (AHDVTS_C_ADT) 517 includes various kinds of information: advanced HD video title set cell address table information (AHDVTS_C_ADTI) 517a having the number (AHDVTS_VOB_Ns) of VOB data in an AHDVTS_VOBS and the end address (AHDVTS_C_ADT_EA) of the AHDVTS_C_ADT; and a plurality of pieces of advanced HD video title set cell piece information (AHDVTS_CPI) 517b each including a VOB_ID number (AHDVTS_VOB_IDN) of an AHDVTS_CP, a Cell_ID number (AHDVTS_C_IDN) of the AHDVTS_CP, the start address (AHDVTS_CP_SA) of the AHDVTS_CP, and the end address (AHDVTS_CP_EA) of the AHDVTS_CP.

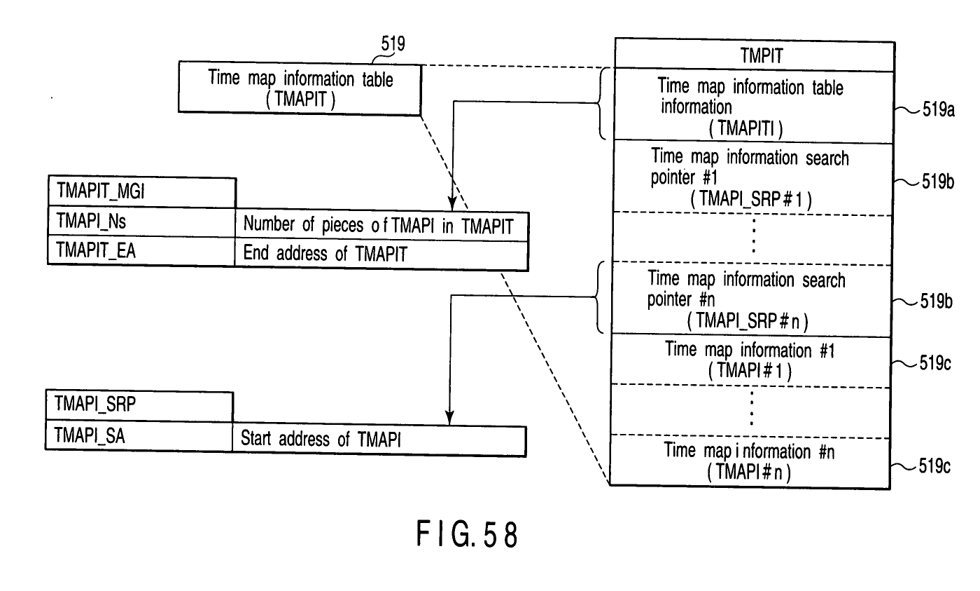

FIG. 58 shows an example of the data structure in time map information table (TMAPIT) 519 shown in FIG. 52. Time map information table (TMAPIT) 519 includes time map information table information (TMAPITI) 519a, time map information search pointers (TMAPI_SRP) 519b, and a plurality of pieces of time information (TMAPI) 519c. Time map information table information (TMAPITI) 519a includes the number of pieces of time map information (TMAPI) 519c included in this time map information table (TMAPIT) 519, and the end address information of this time map information table (TMAPIT) 519. Time map information search pointers (TMAPI_SRP) 519b exist as many as the number of pieces of time map information (TMAPI) 519c, and each pointer records the start address where corresponding time map information (TMAPI) 519c is recorded.

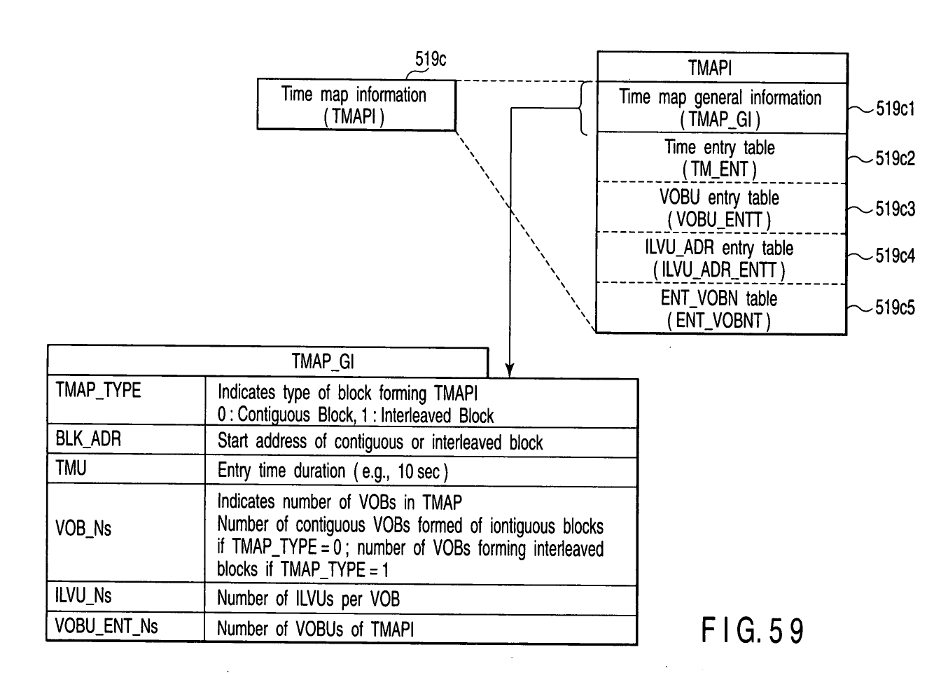

FIG. 59 shows an example of the data structure of time map information (TMAPI) 519c shown in FIG. 58. Time map information (TMAPI) 519c includes time map general information (TMAP_GI) 519c1, time entry table (TM_ENT) 519c2, VOBU entry table (VOBU_ENTT) 519c3, ILVU_ADR entry table (ILVU_ADR_ENTT) 519c4, and ENT_VOBN table (ENT_VOBNT) 519c5.

Time map general information (TMAP_GI) 519c1 includes TMAP_TYPE indicating the type of blocks which form this time map information (TMAPI) 519c, BLK_ADR indicating the start address of a contiguous or interleaved block, TMU indicating the time duration of a time entry, VOB_Ns indicating the number of VOB data to be referred to by this time map information (TMAPI) 519c, ILVU_Ns indicating the number of ILVU data per VOB to be referred to by this time map information (TMAPI) 519c, and VOBU_ENT_Ns indicating the number of all VOBU data to be referred to by this time map information (TMAPI) 519c.

In the TMAP_GI in FIG. 59, when blocks that form time map information TMAPI include a contiguous block, “0b” is recorded in TMAP_TYPE; when blocks that forms time map information TMAPI include an interleaved block, “1b” is recorded in TMAP_TYPE. The time duration of the time entry is constant in the time map information, and can be set to be a value, e.g., TMU=10 sec.

Furthermore, VOB_Ns indicating the number of VOB data to be referred to by the TMAPI indicates the number of VOB data formed by contiguous blocks when blocks that form the TMAPI are contiguous blocks (i.e., TMAP_TYPE=0b). On the other hand, VOB_Ns indicating the number of VOB data to be referred to by the TMAPI indicates the number of VOB data that form interleaved blocks when blocks that form the TMAPI are interleaved blocks (i.e., TMAP_TYPE=1b).

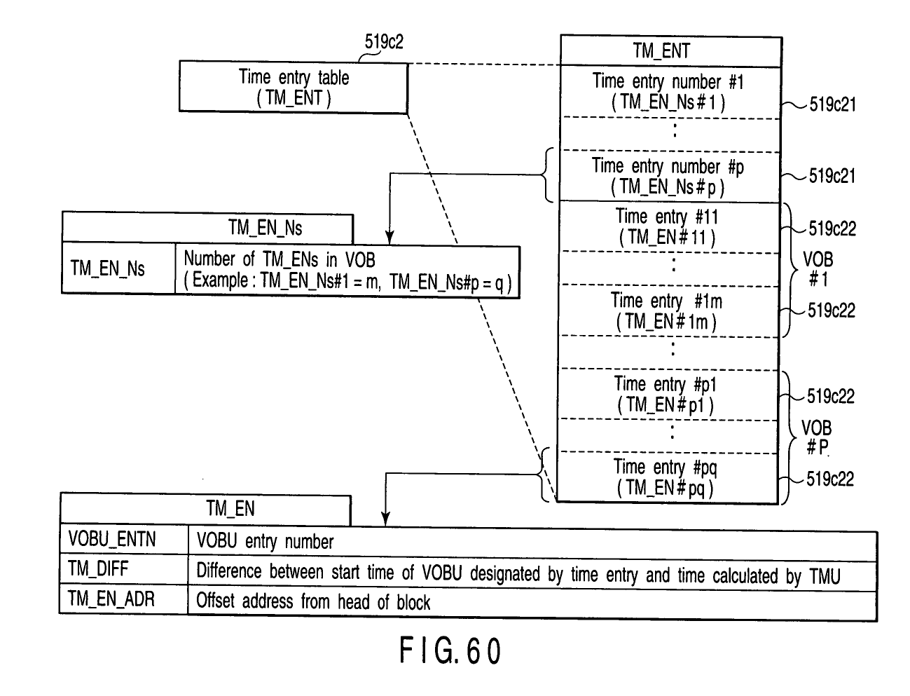

FIG. 60 shows an example of the data structure of time entry table (TM_ENT) 519c2 shown in FIG. 59. Time entry table (TM_ENT) 519c2 includes one or more time entry numbers (TM_EM_Ns) 519c21, and one or more time entries (TM_EN) 519c22. Note that the time entries are allocated for each VOB. More specifically, in the example of FIG. 60, the time entries are allocated in ascending order of VOB#p like time entry (TM_EN) 519c22 group of VOB#1, time entry (TM_EN) 519c22 group of VOB#2, . . . , time entry (TM_EN) 519c22 group of VOB#p.

Each time entry number (TM_EM_Ns) 519c21 records TM_EN_Ns indicating the number of time entries (TM_EN) 519c22. Each time entry 519c22 includes VOBU_ENTN indicating the number of VOBU entry (VOBU_ENT) 519c31 designated by the time entry, TM_DIFF indicating the time difference between the time of the time entry calculated based on TMU and the start time of the VOBU designated by the time entry, and TM_EN_ADR indicating an offset address of a Block (a VOB period with valid TMAPI) from the head position.

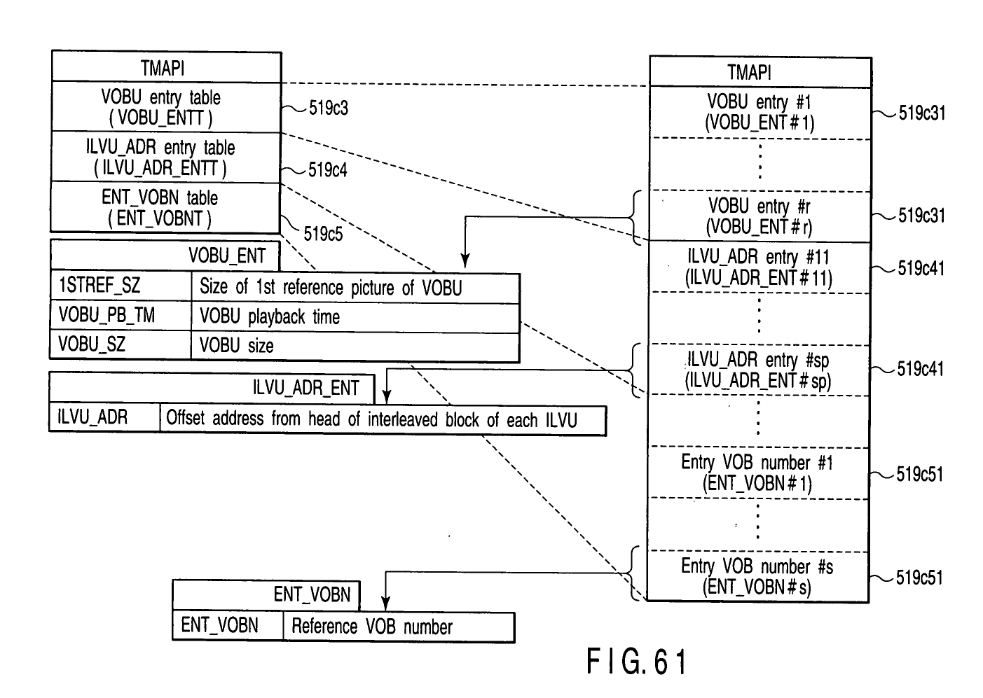

FIG. 61 shows an example of the data structures of VOBU entry table (VOBU_ENTT) 519c3, ILVU_ADR entry table (ILVU_ADR_ENTT) 519c4, and ENT_VOBN table (ENT_VOBNT) 519c5 shown in FIG. 59. As shown in FIG. 61, VOBU entry table (VOBU_ENTT) 519c3 includes VOBU entries (VOBU_ENT) 519c31. Each VOBU entry (VOBU_ENT) 519c31 includes 1STREF_SZ indicating the size (which can be indicated by the number of packs) of 1st Reference Picture data (i.e., first I-picture or equivalent data) included in a VOBU, VOBU_PB_TM indicating the VOBU playback time, and VOBU_SZ indicating the size (which can be indicated by the number of packs) of the VOBU.

ILVU_ADR entry table (ILVU_ADR_ENTT) 519c4 includes ILVU_ADR entries (ILVU_ADR_ENT) 519c41. Each ILVU_ADR entry (ILVU_ADR_ENT) 519c41 includes ILVU_ADR indicating an offset address from the head of an Interleaved block for each ILVU address.

ENT_VOBN table (ENT_VOBNT) 519c5 which indicates a list of VOB data that refer to time map information (TMAPI) 519c includes entry VOB numbers (ENT_VOBN) 519c51. Each entry VOB number (ENT_VOBN) 519c51 includes ENT_VOBN indicating a VOB number to be referred to. Note that ENT_VOBN is described in the order of VOB data that refer to time map information (TMAPI) 519c, and correspondence between the time map and VOB is indicated using the VOB number.

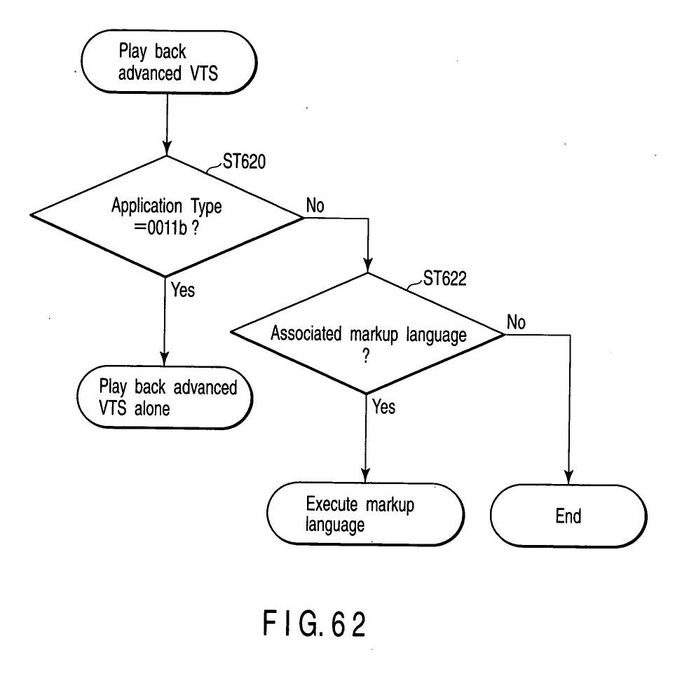

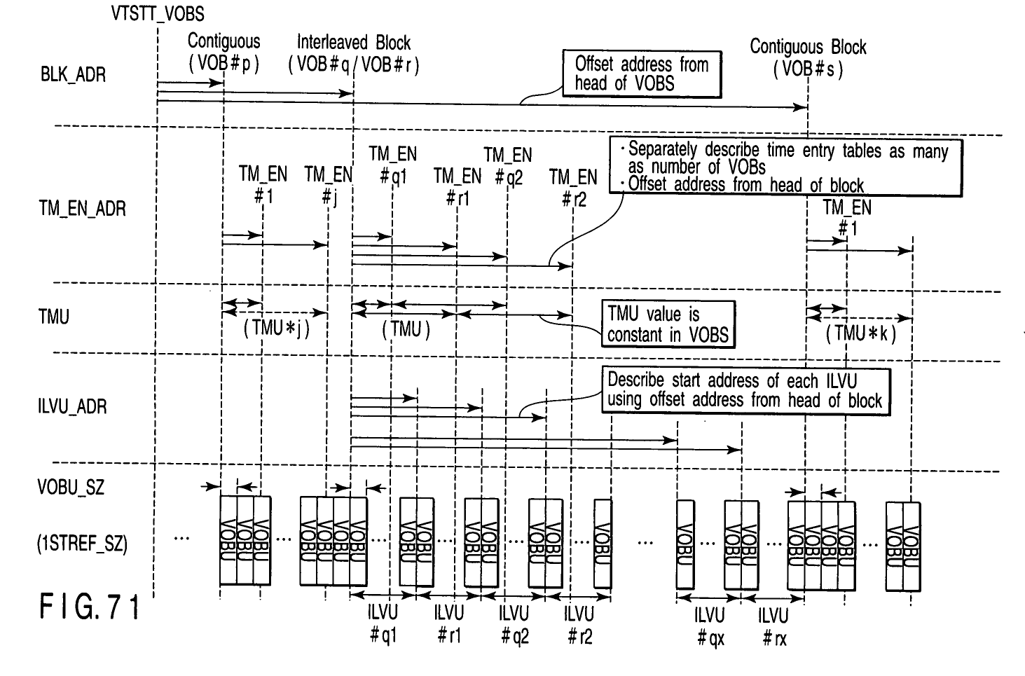

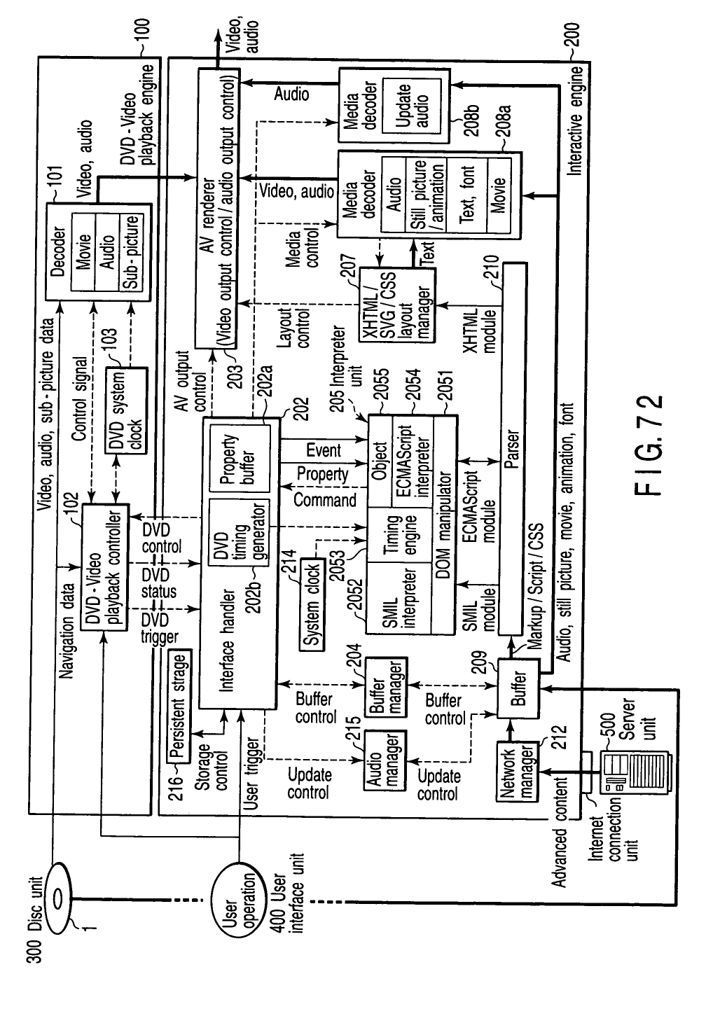

FIG. 62 is a flowchart for explaining an example of the playback sequence of an advanced VTS (AHDVTS in FIGS. 51, 74, 79, and the like) according to the content of information (Application Type) included in management information (e.g., AHDVTS_CAT in FIG. 53). When playback of an advanced VTS is designated, the playback apparatus (FIG. 72, etc.) checks the value of AHDVTS_CAT stored in AHDVTSI_MAT 510. If AHDVTS CAT=0011b (YES in block ST620), since this advanced VTS to be played back is a video object without any advanced content, i.e., playback is controlled based on only data in advanced HD video title set recording area 50 (AHDVTS) in place of the markup/script language, playback can be done based on data of this AHDVTS (a sole playback process of the advanced VTS).

If the value of AHDVTS_CAT is other than “0011b” (e.g., “0010b”) (NO in block ST620), since this advanced VTS is a video object with advanced content, playback will be done on the basis of the markup/script language used to control this video object. If not, playback of this video object becomes different from that the content provider intended. Hence, the playback apparatus (FIG. 72, etc.) searches for a markup/script language file associated with this video object. If such file is found (YES in block ST622), the video object is played back on the basis of the description of the markup/script language of that file (an execution process of the markup/script language). If no markup/script language file associated with the video object is found (NO in block ST622), since data used to control playback are not sufficiently prepared, the process ends without playback.

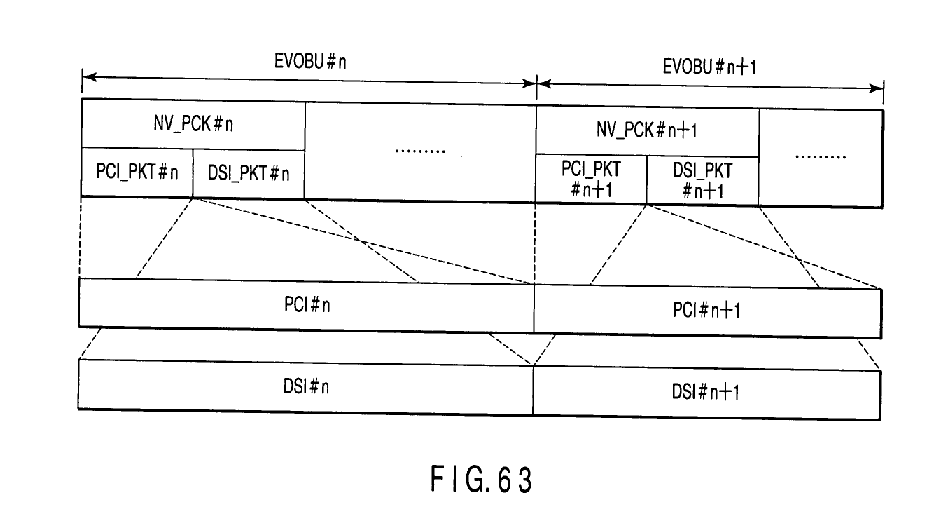

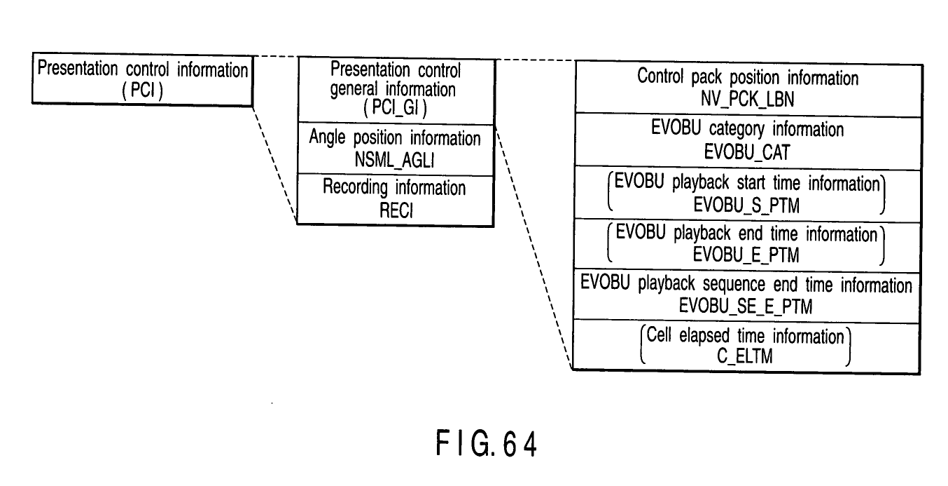

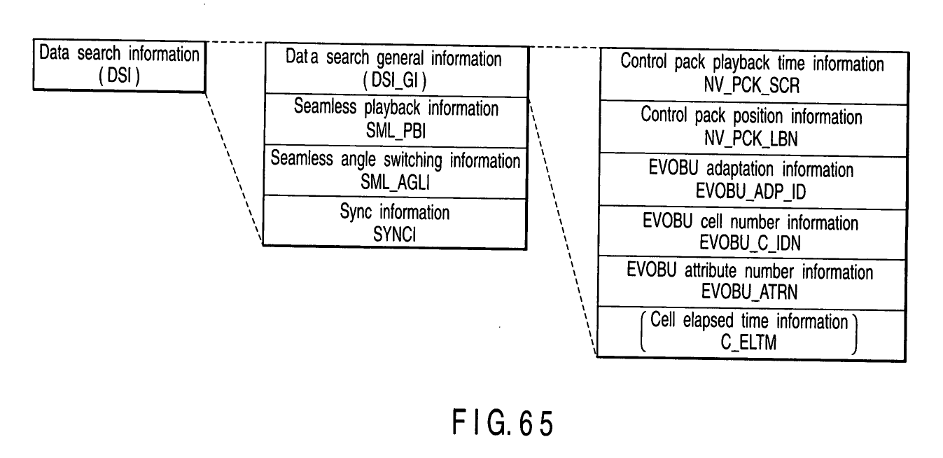

FIG. 63 shows the configuration of a navigation pack (NV_PCK) allocated at the head of each EVOBU in an enhanced video object (EVOB) which is to be referred to by an advanced VTS according to the embodiment of the invention. The navigation pack includes a presentation information packet (PCI_PKT) and data search information packet (DSI_PKT), and respective packets store information shown in FIGS. 64 and 65.

FIG. 64 shows an example of the content of the presentation control information (PCI) as playback control information. The presentation control information includes playback control general information (PCI_GI), non-seamless angle position information (NSML_AGLI) which includes the start position information of each angle and does not require any seamless playback upon angle switching, and recording information (RECI). Note that the recording information (RECI) can record specific codes such as a country code, copyright holder code, recording date, recording number, and the like in association with the content of recorded video, audio, and sub-picture data.

The playback control general information (PCI_GI) includes control pack position information (NV_PCK_LBN) indicated by a logical block number (LBN) from the head of a VOBS, EVOBU category information (EVOBU_CAT) including analog copy control information, information (EVOBU_S_PTM) indicating the playback start time and information (EVOBU_E_PTM) indicating the playback end time of an EVOBU, EVOBU playback sequence end time information (EVOBU_SE_E_PTM) indicating information of the playback end time when video playback ends in response to a sequence end code in the EVOBU, and cell elapsed time information (C_ELTM) indicating an elapsed time in a cell of the EVOBU.

Note that “EVOBU playback start time information (EVOBU_S_PTM)”, “EVOBU playback end time information (EVOBU_E_PTM)”, and “cell elapsed time information (C_ELTM)” in parentheses in the playback control general information (PCI_GI) are option information, and can be omitted depending on embodiments.

FIG. 65 shows the content of the data search information (DSI) as data search information. The data search information includes data search general information (DSI_GI), seamless playback information (SML_PBI) as information used to make seamless playback without interrupting interleaved units (ILVU) which are interleaved, seamless angle position information (SML_AGLI) that describes a jump address of an interleaved unit of each angle as information used to switch angles without interrupting playback, and sync information (SYNCI) indicating position information of audio and sub-picture packs to be played back synchronously with video data.

The data search general information (DSI_GI) includes control pack playback time information (NV_PCK_SCR) indicated by system clock reference (SCR)-based time information, control pack position information (NV_PCK_LBN) indicated by a logical block number (LBN) from the head of a VOBS, EVOBU adaptation information (EVOBU_ADP_ID) as information indicating if a disc to which the standard is applied is a read-only disc (DVD-ROM) or a writable disc (DVD-R or the like), EVOBU_EVOB number information (EVOBU_EVOB_IDN: not shown) indicating an ID number of an EVOB that includes the DSI of interest, EVOBU cell number information (EVOBU_C_IDN) indicating an ID number of a cell that includes the DSI of interest, EVOBU attribute number information (EVOBU_ATRN) indicating the number of attribute information of an EVOB to which the EVOBU of interest belongs, and cell elapsed time information (C_ELTM) indicating an elapsed time in a cell of the EVOBU.

Note that “cell elapsed time information (C_ELTM)” in parentheses in the data search general information (DSI_GI) is option information, and can be omitted depending on embodiments.

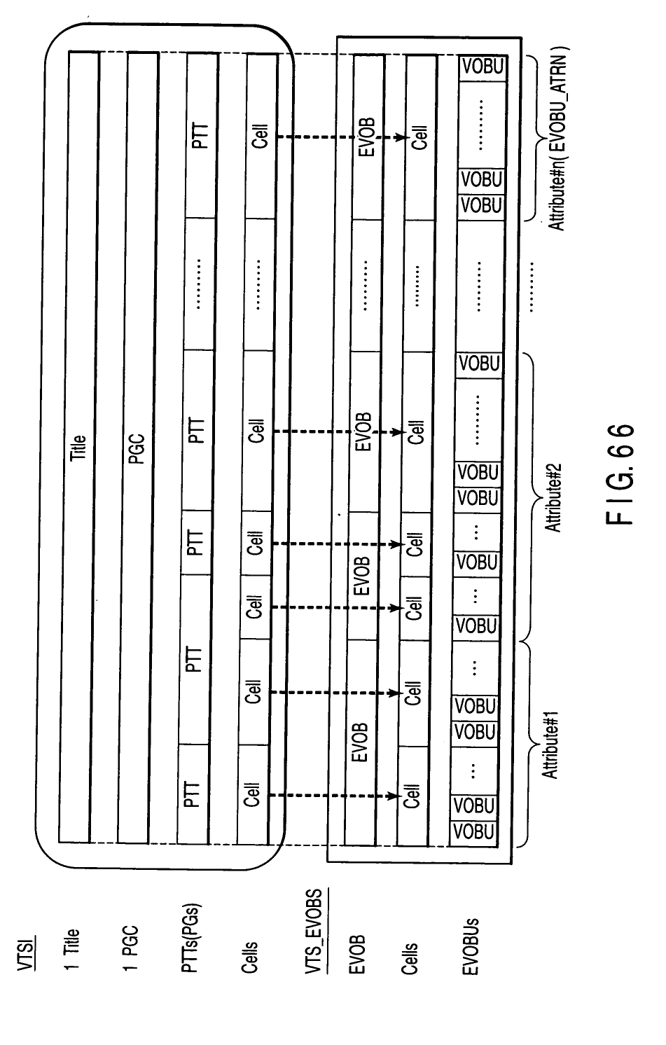

FIG. 66 is a view for explaining an example of the configuration of an advanced VTS (AHDVTS). Since the advanced VTS is basically controlled by a markup language, it uses a simple structure that allows easy control by the markup language. FIG. 66 shows an example of such structure. The advanced VTS includes only one VTS. This VTS includes only one Title. This Title includes only one PGC, which includes one or more PTT data and one or more Cells. Video object VTS_EVOBS is referred to by Cells in one-to-one correspondence.

Note that no navigation commands that can be recorded in VTS₁ and NV_PCK are available in the advanced VTS. The content production process which is complicated due to coexistence of control based on the markup language and that based on navigation commands in the advanced VTS, and the load on the manufacture of the playback apparatus can be avoided.

Furthermore, the standard VTS accesses a video object using VOBU search information included in NV_PCK. The advanced VTS does not use any VOBU search information in NV_PCK (which need not exist), and newly adds time map information. Upon accessing a video object in accordance with an instruction of the markup language, precise access can be done from an arbitrary location using the time map information.

Note that an attribute number “#n” which identifies an attribute (Attribute #n) assigned to a plurality of EVOBU data corresponding to each EVOB in FIG. 66 can be designated by the EVOBU attribute number information (EVOBU_ATRN) shown in FIG. 65.

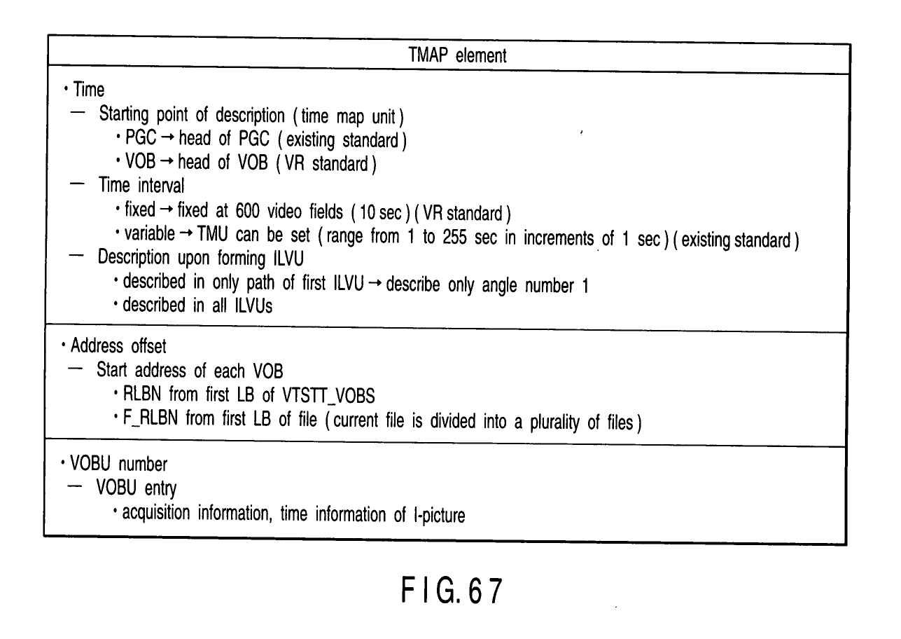

FIG. 67 shows time map elements according to the embodiment of the invention. That is, as a time element of a time map, a starting point of a description (time map unit) is available. The head of a PGC can be defined as a starting point for the PGC, and the head of a VOB can be defined as a starting point for the VOB. A time map time interval may be fixed to 600 video fields (corresponding to 10 sec) in NTSC, or the time map time interval can be set in the time unit (e.g., the range of 1 to 255 sec in increments of 1 sec). Furthermore, upon forming ILVU data, a time map may be described in only the path of the first ILVU (e.g., only the path of angle number 1 in a multi-angle block) or time maps may be described in all ILVU data.

As for an offset address of a time map, the start address of each VOB can be described. More specifically, the offset address can be described using a relative logical block number from the first logical block of a VTSTT_VOBS, or the offset address can be described using a relative logical block number from the first logical block number of the file of interest (In this case, the file at the current timing may be divided into a plurality of files as needed according to the set time maps). Furthermore, a VOBU number quoted by a time map can be associated with a VOBU entry, which can be used as acquisition information of corresponding I-picture data and/or time information of this I-picture data.

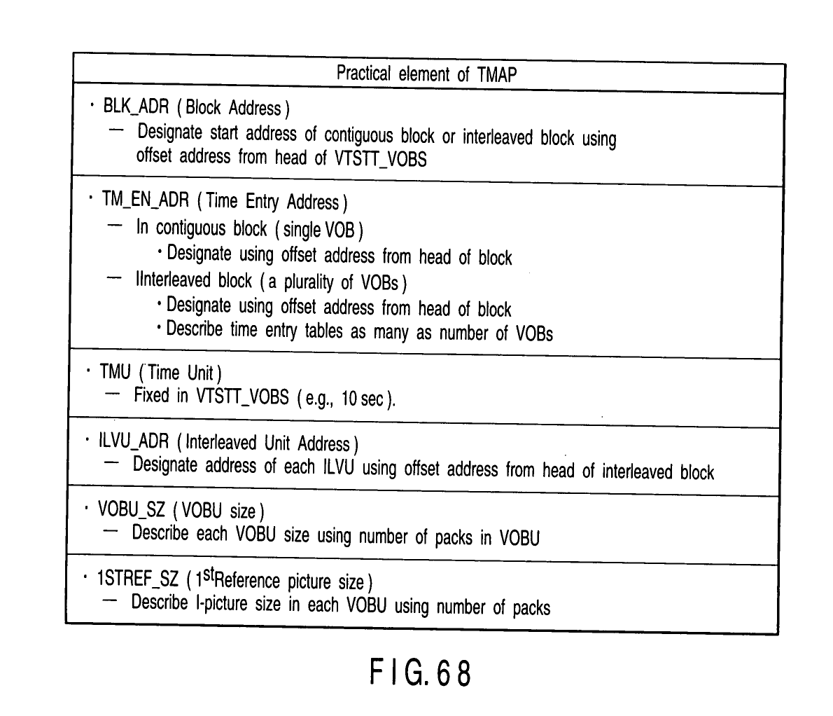

FIG. 68 shows an example of practical elements of the time map according to the embodiment of the invention. A block address (BLK_ADR) designates the start address of a contiguous or interleaved block using an offset address from the head of a VTSTT_VOBS. A time entry address (TM_EN_ADR) of a contiguous block (single VOB) can be designated using an offset address from the head of a block. Also, a time entry address of an interleaved block (a plurality of VOB data) can be designated using an offset address from the head of a block (by the same method as in a single VOB) or time entry tables can be described as many as the number of VOB data. A time unit (TMU) is fixed to a constant value (e.g., 10 sec) in a single VTSTT_VOBS.

An interleaved unit address (ILVU_ADR) can designate the address of each ILVU using an offset address from the head of an Interleaved block. Furthermore, a VOBU size (VOBU_SZ) can describe the size of each VOBU using the number of packs in that VOBU. A first reference picture size (LSTREF_SZ) can describe the size of I-picture data of each VOBU using the number of packs.

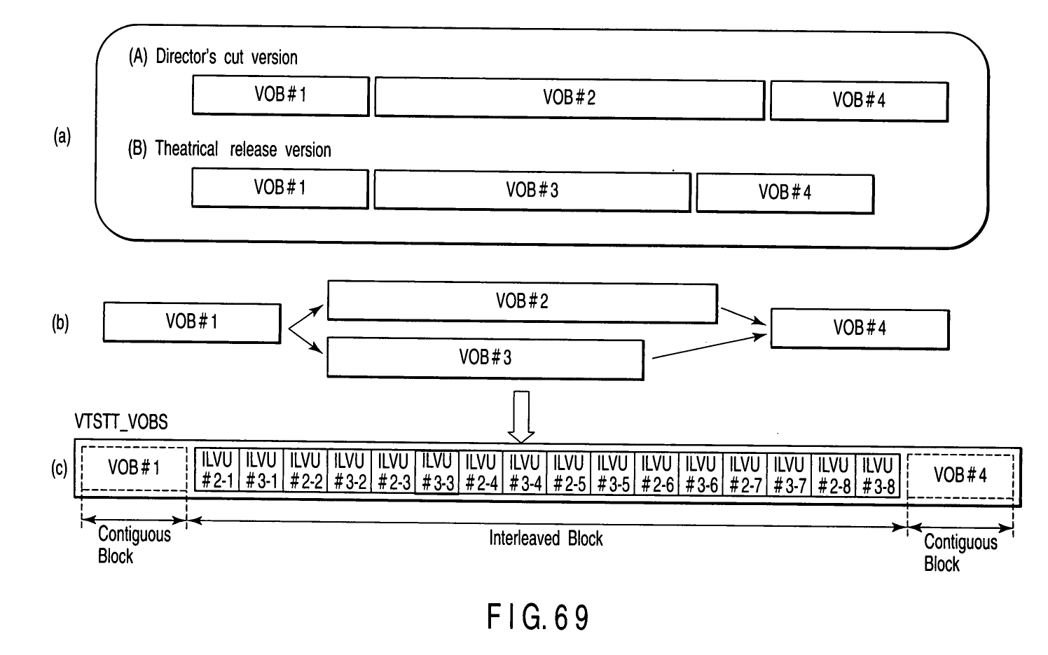

FIG. 69 shows a case having different playback paths so as to explain the time map according to the embodiment of the invention. As shown in FIG. 69, disc 1 records two different playback paths (A) and (B). (A) is, for example, the director's cut version of a movie, and (B) is, for example, the theatrical release version. In this example, (A) and (B) include the same introductory chapter (VOB#1) and ending chapter (VOB#4), but have different main chapters (VOB#2 or VOB#3). At this time, in order to improve the recording efficiency on the disc in practice, the introductory chapter (VOB#1) and ending chapter (VOB#4) are used as a common playback path, and objects (VOB#2 and VOB#3) of different playback paths are independently recorded. However, if these objects are recorded intact, one of (A) and (B) cannot be read out in time upon playback depending on the manner of recording, thus interrupting its playback. In order to solve this problem, as shown in the lowermost column in FIG. 69, respective VOB data (VOB#2 and VOB#3) are broken up into smaller units, and these units are recorded alternately (i.e., so-called interleaved recording), thus implementing seamless playback. A unit of this interleaved recording is an interleaved unit (ILVU).

Note that an interval in which playback data of VOB#1 or VOB#4 are contiguously allocated is defined as a contiguous block, and an interval in which playback data of VOB#2 and VOB#3 are alternately allocated is defined as an interleaved block.

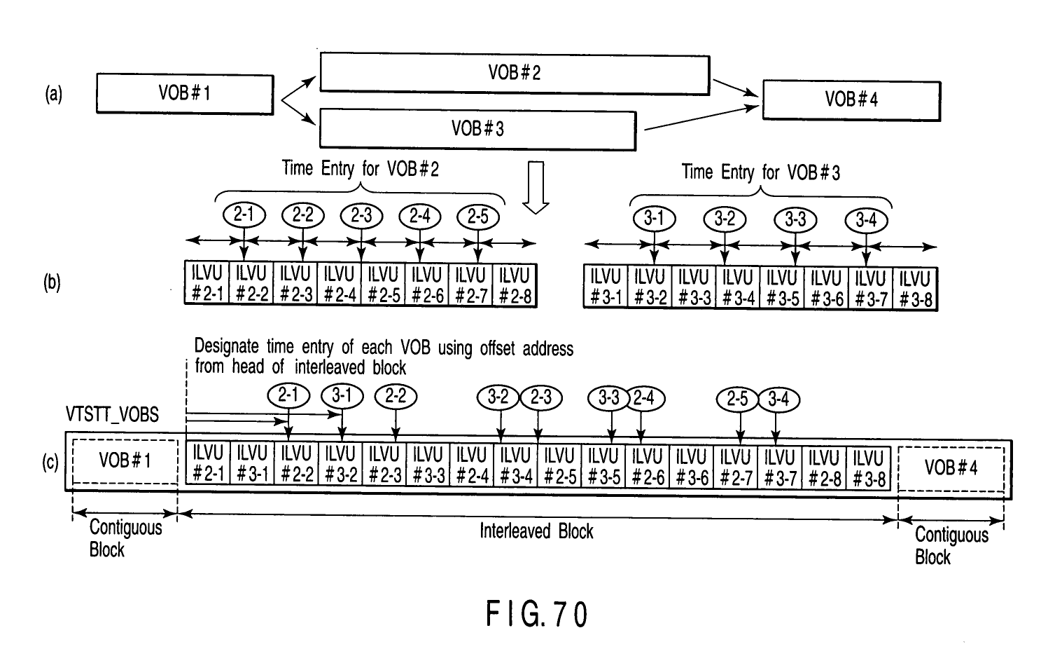

FIG. 70 is a view for explaining the time map of the ILVU interval. In order to form the time map of the interleaved-recorded ILVU interval (the interval of VOB#2 and VOB#3 in FIG. 70(a)) described using FIG. 69, time entries (2-1, 2-2, . . . of VOB#2, and 3-1, 3-2, . . . of VOB#3) are assigned to VOB#2 and VOB#3 as playback paths at predetermined time intervals (e.g., 10-sec time intervals) (FIG. 70(b)), and hold designated addresses. After interleaved allocation, the addresses of the respective time entries are re-designated as offset addresses from the head of the interleaved block (FIG. 70(c)).

FIG. 71 shows an example that generalizes the time map including the interleaved block interval that has been explained using FIG. 70. As shown in FIG. 71, a VTSTT_VOBS of a playback object includes a contiguous block of VOB#p, an interleaved block formed by VOB#q and VOB#r, and a contiguous block of VOB#s (in the example of FIGS. 70 to 72, VOB#p=VOB#1, VOB#q=VOB#2, VOB#r=VOB#3, and VOB#s=VOB#4).

This time map is configured for each block. For this purpose, the start addresses of respective blocks are designated as offset addresses (BLK_ADR) from the head of the VTSTT_VOBS. With this configuration, a time map of each block describes position information to have the head of that block as a starting point, and information that forms the time map is completed in the block.

The address of each time entry (TM_EN#) designated by a predetermined time interval (TMU) (e.g., 10 sec) is indicated by an offset address (TM_EN_ADR) from the head of each block, and is stored as a time entry table (not shown). At this time, if the block of interest is an interleaved block, time entries (TM_EN#q1, TM_EN#q2, . . . , and TM_EN#r1, TM_EN#r2, . . . in this case) as many as the number of VOB data that form the block are separately stored in respective time entry tables (not shown).

When the block that forms the time map is an interleaved block, the start addresses (ILVU_ADR) of interleaved units alternately allocated in the interleaved block are designated by offset addresses from the head of the block. With this information, the start position of each ILVU can be easily detected, and ILVU data to be contiguously played back can be seamlessly switched and played back (each ILVU size (ILVU_SZ) can be described in, e.g., TMAP_GI in FIG. 59 (not shown)).

As information of a VOBU that stores actual playback information, each time map includes the number of all VOBU data (VOBU_Ns; not shown) stored in each block, the size (VOBU_SZ) and playback time (VOBU_PB_TM; not shown) of each VOBU, the end address information (1STREF_SZ) of first reference picture (first I-picture) data, and the like. With this information, target data is accessed. The time map may have the end address information (2NDREF_SZ, 3RDREF_SZ; neither are shown) of each of second reference picture (I- or P-picture other than the first reference picture) data and third reference picture (I- or P-picture other than the first and second reference pictures) data in addition to the first reference picture.

FIG. 72 is a block diagram for explaining an example of the internal structure of a playback apparatus (advanced VTS compatible DVD-Video player) according to another embodiment of the invention. This DVD-Video player plays back and processes the recording content from information storage medium 1 shown in FIGS. 1, 50, 51, 73, 74, 79, and the like, and downloads and processes advanced content from a communication line (e.g., the Internet or the like).

The DVD-Video player shown in FIG. 72 comprises DVD-Video playback engine (DVD_ENG) 100, interactive engine (INT_ENG) 200, disc unit (disc drive) 300, user interface unit 400, and the like. DVD-Video playback engine 100 plays back and processes an MPEG2 program stream (DVD-Video content) recorded on information storage medium 1. Interactive engine (INT_ENG) 200 plays back and processes advanced content. Disc unit 300 reads out the DVD-Video content and/or advanced content recorded on information storage medium 1. User interface unit 400 supplies an input by the user of the player (user operation) to the DVD-Video player as a user trigger.

Basically, when a standard VTS is to be played back (standard VTS playback state), the user input is supplied to the DVD-Video playback engine; when an advanced VTS is to be played back (advanced VTS playback state), the user input is supplied to the interactive engine. Even when the advanced VTS is to be played back, a predetermined user input can be directly supplied to the DVD-Video playback engine.

Interactive engine (INT_ENG) 200 comprises an Internet connection unit. This Internet connection unit serves as communication means that connects server unit 500 or the like via a communication line (Internet or the like). Furthermore, interactive engine (INT_ENG) 200 is configured to include buffer unit 209, parser 210, XHTML/SVG/CSS layout manager 207, ECMAscript interpreter/DOM manipulator/SMIL interpreter/timing engine/object (interpreter unit) 205, interface handler 202, media decoders 208a/208b, AV renderer 203, buffer manager 204, audio manager 215, network manager 212, system block 214, persistent storage 216, and the like.

In the block arrangement of FIG. 72, DVD-Video playback controller 102, DVD-Video decoder 101, DVD system block 103, interface handler 202, parser 210, interpreter unit 205, XHTML/SVG/CSS layout manager 207, AV renderer 203, media decoders 208a/208b, buffer manager 204, audio manager 215, network manager 212, system clock 214, and the like can be implemented by a microcomputer (and/or hardware logic) which serves as the functions of respective blocks by an installed program (firmware; not shown). A work area used upon executing this firmware can be assured using a semiconductor memory (and a hard disc as needed; not shown) in the block arrangement.

DVD-Video playback engine (DVD_ENG) 100 is a device for playing back DVD-Video content recorded on information storage medium 1 shown in FIG. 1 and the like, and is configured to include DVD-Video decoder 101 for decoding the DVD-Video content loaded from disc unit 300, DVD-Video playback controller 102 for making playback control of the DVD-Video content, DVD system clock 103 for determining the decode and output timings in the DVD-Video decoder, and the like.

DVD-Video decoder 101 has a function of decoding main picture data, audio data, and sub-picture data read out from information storage medium 1 shown in FIG. 1 and the like, and outputting the decoded video data (obtained by mixing the main picture data and sub-picture data, etc.) and audio data. That is, the player shown in FIG. 72 can play back video data, audio data, and the like with the MPEG2 program stream structure in the same manner as a normal DVD-Video player.

In addition, DVD-Video playback controller 102 can control playback of the DVD-Video content in accordance with a “DVD control signal” output from interactive engine (INT_ENG) 200. More specifically, when a given event (e.g., menu call or title jump) has occurred in DVD-Video playback engine 100 upon DVD-Video playback, DVD-Video playback controller 102 can output a “DVD trigger” signal indicating the playback condition of the DVD-Video content to interactive engine (INT_ENG) 200. In this case (simultaneously with output of the DVD trigger signal or at an appropriate timing before and after the output), DVD-Video playback controller 102 can output a “DVD status” signal indicating property information (e.g., an audio language, sub-picture subtitle language, playback operation, playback position, various kinds of time information, disc content, and the like set in the player) of the DVD-Video player to interactive engine (INT_ENG) 200.

Interface handler 202 receives a “user trigger” corresponding to a user operation (menu call, title jump, play start, play stop, play pause, or the like) from user interface unit 400. Interface handler 202 transmits the received user trigger to interpreter unit 205 as a corresponding “event”. For example, the markup language describes the following instructions for this “event”.

1: issue a “command” corresponding to a user operation. That is, the same command as the user operation is transmitted to the DVD-Video layback engine as a DVD control signal.

2: issue a “command” different from a user operation. That is, the user action is substituted by another operation in accordance with an instruction of the markup language.

3: ignore user trigger. That is, a user event is inhibited since, for example, the user may designate a DVD-Video playback process which is not designed by the content provider.

Note that the content of the user trigger signal transmitted to interface handler 202 may be transmitted to AV renderer 203 as an “AV output control” signal. As a result, for example, when the user has changed the content or window size or has shifted its display position using a cursor key of a remote controller (not shown), a user trigger signal based on this operation is output to AV renderer 203 as a corresponding AV output control signal. In addition, when a user trigger signal which indicates switching between a video/audio output from DVD-Video playback engine 100 and that from interactive engine 200 is sent to AV renderer 203, the video/audio output can be switched in response to the user operation.

Interface handler 202 exchanges a “DVD status” signal, “DVD trigger” signal, and/or “DVD control” signal with DVD-Video playback controller 102, or exchanges a “user trigger” signal with user interface unit 400. Furthermore, interface handler 202 exchanges “event”, “property”, “command”, and “control” signals with interpreter unit 205.

That is, interface handler 202 can do the following.

Interface handler 202 transmits a “DVD trigger” signal which indicates the operation of DVD-Video playback engine 100 from DVD-Video playback engine 100, or a “user trigger” which indicates the user operation from user interface unit 400 to interpreter unit 205 as an “event”.

Interface handler 202 transmits a “DVD status” signal which indicates the playback status of DVD-Video playback engine 100 from DVD-Video playback engine 100 to interpreter unit 205 as a “property”. At this time, DVD status information is saved in property buffer 202a of interface handler 202 as needed.

Interface handler 202 outputs a “DVD control” signal to control playback of DVD-Video playback engine 100 to DVD-Video playback engine 100, an “AV output control” signal to switch video and audio data to AV renderer 203, a “buffer control” signal to load/erase the content of buffer 209 to buffer manager 204, an “update control” signal to download update audio data to audio manager 215, and a “media control” signal to instruct decoding of various media to media decoders 208a/208b, in accordance with the content of a “command” signal from Interpreter unit 205.

Interface handler 202 measures information of DVD system clock 103 in DVD-Video playback engine 100 using its DVD timing generator 202b, and transmits the measurement result to media decoders 208a/208b as a “DVD timing” signal. That is, media decoders 208a/208b can decode various media in synchronism with system clock 103 of DVD-Video playback engine 100.

As described above, interface handler 202 has a function of parsing and interpreting advanced content, and then exchanging control signals and the like between DVD-Video playback engine 100 and interactive engine 200.

Interface handler 202 is configured to exchange a first signal and also a second signal on the basis of the content which are parsed by parser 210 and are interpreted by interpreter unit 205, or a user trigger from an input device (e.g., a remote controller; not shown). In other words, interface handler 202 controls the output states of video and audio signals by AV renderer 203 on the basis of at least one of the first signal exchanged with DVD-Video playback controller 102, and the second signal exchanged with interpreter unit 205.

Note that the first signal pertains to the playback status of information storage medium 1, and corresponds to the “DVD control” signal, “DVD trigger” signal, “DVD status” signal, and the like. The second signal pertains to the content of the advanced content, and corresponds to the “event” signal, “command” signal, “property” signal, “control” signal, and the like.

Interface handler 202 is configured to execute processes corresponding to user triggers in accordance with the markup language. AV renderer 203 is configured to mix video/audio data generated by media decoders 208a/208b with that played back by DVD-Video playback engine 100 on the basis of the execution results of the processes corresponding to user triggers, and to output mixed data. Alternatively, AV renderer 203 is configured to select one of video/audio data generated by media decoders 208a/208b and that played back by DVD-Video playback engine 100 on the basis of the execution result of the “command” in interface handler 202, and to output the selected video/audio data.

Generally speaking, parser 210 parses the markup language indicating playback control information, which is included in advanced content acquired from information storage medium 1 or advanced content downloaded from the Internet or the like. The markup language is configured by a combination of markup languages such as HTML/XHTML, SMIL, and the like, script languages such as ECMAscript, Javascript, and the like, and stylesheets such as CSS and the like, as described above. Parser 210 has a function of transmitting an ECMAscript module to an ECMAscript interpreter, a SMIL module to a SMIL interpreter of interpreter unit 205, and an XHTML module to XHTML/SVG/CSS layout manager 207 in accordance with the parsing result.

The ECMAscript interpreter interprets the aforementioned ECMAscript module and follows its instructions. That is, the ECMAscript interpreter has a function of issuing a “command” signal used to control respective functions in interactive engine 200 to interface handler 202 in correspondence with an “event” signal sent from interface handler 202 or a “property” signal read from property buffer 202a of interface handler 202. At this time, the ECMAscript interpreter issues a “command” signal to DVD-Video playback engine 100 or a “media control” signal to media decoders 208a/208b at the timings designated by the markup language in accordance with the time measured by system clock 214. In this manner, the control operation of DVD-Video playback engine 100 and various media control operations (decode control of audio, still picture/animation, text/font, and movies, etc.) can be achieved.

The SMIL timing engine interprets the aforementioned SMIL module and follows its instructions. That is, the SMIL timing engine has a function of issuing a “control” signal to interface handler 202 or media decoders 208a/208b in correspondence with an “event” signal sent from interface handler 202 or a “property” signal read from property buffer 202a of interface handler 202 in accordance with system clock 214. With this function, control of the DVD-Video playback engine 100 and decoding of various media (audio, still picture/animation, text/font, movie) can be achieved at given timings. That is, the SMIL timing engine can operate based on system clock 214 in accordance with the description of the markup language, or can operate on the basis of DVD system clock 103 from DVD timing generator 202b.

XHTML/SVG/CSS layout manager 207 interprets the aforementioned XHTML module and follows its instructions. That is, XHTML/SVG/CSS layout manager 207 outputs a “layout control” signal to AV renderer 203. The “layout control” signal includes information associated with the size and position of a video screen to be output (this information often includes information associated with a display time such as display start, end, or continuation), and information associated with the level of audio data to be output (this information often includes information associated with an output time such as output start, end, or continuation). Also, text information to be displayed, which is included in the XHTML module, is sent to media decoders 208a/208b, and is decoded and displayed using given font data.

Practical methods of parsing and interpreting markup and script languages can adopt the same methods as parsing/interpretation in state-of-the-art techniques such as HTML/XHTML, SMIL, and the like or ECMAscript, Javascript, and the like (the hardware used is the microcomputer that has been mentioned at the beginning of the description of FIG. 72). Note that commands and variables described in scripts are different since objects to be controlled are different. The markup language used upon practicing the invention uses unique commands and variables associated with playback of the DVD-Video content and/or advanced content. For example, a command that switches the playback content of the DVD-Video content or advanced content in response to a given event is unique to the markup or script language used in the embodiment of the invention.

As another example of commands and variables unique to the markup or script language, those which are used to change the video size from DVD-Video playback engine 100 and/or interactive engine 200 and to change the layout of that video data are available. A change in video size is designated using a size change command and a variable that designates the size after change. A change in video layout is designated by a display position change command and a variable that designates the coordinate position or the like after change. When objects to be displayed overlap on the screen, variables that designate z-ordering and transparency upon overlaying are added.

As still another example of commands and variables unique to the markup or script language, those which are used to change the audio level from DVD-Video playback engine 100 and/or interactive engine 200 or to select an audio language to be used are available. A change in audio level is designated by an audio level change command and a variable that designates an audio level after change. An audio language to be used is selected by an audio language change command and a variable that designates the type of language after change. As yet another example, those which are used to control user triggers from user interface unit 400 are available.

On the basis of the commands/variables of the markup and script languages, as exemplified above, a “layout control” signal is sent from XHTML/SVG/CSS layout manager 207 (some functions are often implemented by the SMIL timing engine 206) to AV renderer 203. The “layout control” signal controls the layout on the screen, size, output timing, and output time of video data to be displayed on, e.g., an external monitor device or the like (not shown), and/or the tone/loudness, output timing, and output time of audio data to be played back from an external loudspeaker (not shown).

Media decoders 208a/208b decode data of the advanced content such as audio data, still picture (including a background picture)/animation, text/font data, movie data, and the like included in the advanced content. That is, each of media decoders 208a/208b includes an audio decoder, still picture/animation decoder, text/font decoder, and movie decoder in correspondence with objects to be decoded. For example, audio data in the advanced content, which is encoded by, e.g., MPEG, AC-3(, or DTS is decoded by the audio decoder and is converted into non-compressed audio data. Still picture data or background picture data, which is encoded by JPEG, GIF, or PNG, is decoded by the still picture decoder, and is converted into non-compressed picture data. Likewise, movie or animation data, which is encoded by MPEG2, MPEG4, Macromedia Flash, or Scalable Vector Graphics (SVG), is decoded by the movie or animation decoder, and is converted into non-compressed movie/animation data. Text data included in the advanced content is decoded by the text/font decoder using font data (e.g., OpenType format) included in the advanced content, and is converted into text picture data which can be superimposed on a movie or still picture. Video/audio data, which includes these decoded audio data, picture data, animation/movie data, and text picture data as needed, is sent from media decoders 208a/208b to AV renderer 203. This advanced content is decoded in accordance with an instruction of a “media control” signal from interface handler 202 and in synchronism with a “DVD timing” signal from interface handler 202 and a “timing” signal from system clock 214.

AV renderer 203 has a function of controlling a video/audio output. More specifically, AV renderer 203 controls, e.g., the video display position and size (often including the display timing and display time together), and the audio level (often including the output timing and output time together) in accordance with the “layout control” signal output from XHTML/SVG/CSS layout manager 207. Also, AV renderer 203 executes pixel conversion of video data in accordance with the type of designated monitor and/or the type of video data to be displayed. The video/audio outputs to be controlled are those from DVD-Video playback engine 100 and media decoders 208a/208b. Furthermore, AV renderer 203 has a function of controlling mixing and switching of the DVD-Video content and advanced content in accordance with an “AV output control” signal output from interface handler 202.

Note that interactive engine 200 in the DVD-Video player in FIG. 72 comprises an interface for sending the markup language in the advanced content read from information storage medium 1 to parser 210 via buffer unit 209, and an interface for sending data (audio data, still picture/animation data, text/font data, movie data, and the like) in the read advanced content to media decoders 208a/208b via buffer unit 209. These interfaces form an interface (first interface) independent from the Internet connection unit in FIG. 72.

Also, the DVD-Video player in FIG. 72 comprises an interface for receiving advanced content from a communication line such as the Internet or the like, and sending the markup language in the received advanced content to parser 210 via buffer unit 209, and an interface for sending data (audio data, still picture/animation data, text/font data, movie data, and the like) in the received advanced content to media decoders 208a/208b via buffer unit 209. These interfaces form the Internet connection unit (second interface) shown in FIG. 72.

Buffer unit 209 includes a buffer that stores the advanced content downloaded from server unit 500, and also stores the advanced content read from information storage medium 1 via disc unit 300. Buffer unit 209 reads the advanced content stored in server unit 500, and downloads them via the Internet connection unit under the control of buffer manager 204 based on the markup language/script language.

Also, buffer unit 209 loads the advanced content recorded on information storage medium 1 under the control of buffer manager 204 based on the markup language/script language. At this time, if disc unit 300 is a device that can access the disc at high speed, disc unit 300 can read out the advanced content from information storage medium 1 while playing back the DVD-Video content, i.e., reading out DVD-Video data from information storage medium 1.

If disc unit 300 is not a device that can make high-speed access, or if the playback operation of the DVD-Video content is to be perfectly guaranteed, playback of the DVD-Video content should not be interrupted. In such case, the advanced content is read out from information storage medium 1 and are stored in the buffer in advance prior to the beginning of playback. In this way, since the advanced content is read out from the buffer simultaneously when the DVD-Video content are read out from information storage medium 1, the load on disc unit 300 can be reduced. Hence, the DVD-Video content and advanced content can be simultaneously played back without interrupting playback of the DVD-Video content.

In this manner, since the advanced content downloaded from server unit 500 is stored in buffer unit 209 in the same manner as those recorded on information storage medium 1, the DVD-Video content and advanced content can be simultaneously read out and played back.

Buffer unit 209 has a limited storage capacity. That is, the data size of the advanced content that can be stored in buffer unit 209 is limited. For this reason, it is possible to erase the advanced content with low necessity and to save those with high necessity under the control of buffer manager 204 (buffer control). Buffer unit 209 can automatically execute such save and erase control.

Furthermore, buffer unit 209 has a function (preload end trigger, load end trigger) of loading content requested by buffer manager 204 from disc unit 300 or server unit 500 into buffer unit 209, and informing buffer manager 204 that the advanced content designated by buffer manager 204 have been loaded into the buffer.

Buffer manager 204 can send the following instructions as “buffer control” to buffer unit 209 in accordance with an instruction of the markup language (even during playback of DVD video content).

load all or part of a specific file from a server;

load all or part of a specific file from a disc; and

erase all or part of a specific file from a buffer.

Furthermore, buffer manager 204 instructs buffer unit 209 to load the advanced content in accordance with loading information, which is described in the markup language (or in a file designated by the markup language). Buffer manager 204 has a function (buffer control) of requesting to inform that specific advanced content described in loading information have been loaded into buffer unit 209.

Upon completion of loading of the specific advanced content into buffer unit 209, buffer unit 209 informs buffer manager 204 of it, and the buffer manager informs interface handler 202 of it (preload end trigger, load end trigger).

Audio manager 215 has a function of issuing an instruction for loading update audio data (audio commentary data) from information storage medium 1 in disc unit 300 or server unit 500 into buffer unit 209 in accordance with an instruction of the markup language (update control).

Network manager 212 controls the operation of the Internet connection unit. That is, network manager 212 switches connection/disconnection of the Internet connection unit when the markup language designates connection or disconnection to or from the network as a “command”. Also, network manager 212 has a function of checking the connection state to the network, and allows the markup language to download the advanced content in accordance with the connection state to the network.

Persistent storage 216 is an area for recording information (information set by the user and the like) associated with information storage medium 1, and comprises a nonvolatile storage medium such as a hard disc, flash memory, or the like. That is, even after the power supply of the DVD player is turned off, this information is held.

As information associated with the information storage medium to be played back, information such as the playback position of the DVD-Video content or advanced content, user information used in user authentication implemented by the advanced content, a game score of a game implemented by the advanced content, and the like are recorded in accordance with an instruction of the markup language (storage control). As a result, when the information storage medium is played back next time, playback can be continued from the previous position. When the advanced content downloaded from the server into the buffer are recorded in this persistent storage 216 upon playing back the information storage medium, the information storage medium can be played back without connecting the network from the next time.

The building components of Interactive engine 200 in FIG. 72 can also be summarized as follows. Interactive engine 200 comprises:

Parser 210

Parser 210 parses the content of the markup language.

Interpreter Unit 205, XHTML/SVG/CSS Layout Manager 207

Interpreter unit 205 which comprises the ECMAscript interpreter, SMIL timing engine, and the like, and XHTML/SVG/CSS layout manager 207 respectively interpret the parsed modules.

Interface Handler 202

Interface handler 202 handles control signals from interpreter unit 205, and those from DVD-Video playback controller 102.

Media Decoders 208a/208b

Media decoders 208a/208b generate video/audio data corresponding to audio data, still picture data, text/font data, movie data, and the like included in the advanced content in synchronism with system clock 103 of DVD playback engine 100 or system clock 214 of Interactive engine 200.

AV Renderer 203

AV renderer 203 outputs data obtained by mixing video/audio data generated by media decoders 208a/208b to that played back by DVD-Video playback engine 100 on the basis of the execution result of the “command” in interface handler 202. Or AV renderer 203 selectively outputs one of video/audio data generated by media decoders 208a/208b and that played back by DVD-Video playback engine 100 on the basis of the execution result of the “command” in interface handler 202.

Buffer Unit 209

Buffer unit 209 temporarily stores the advanced content acquired from disc unit 300 or from server unit 500 via the Internet connection unit.

Buffer Manager 204

Buffer manager 204 loads or erases advanced content data to or from buffer unit 209 in accordance with an instruction from interface handler 202 (an instruction of the markup language), or the description of loading information (FIG. 90).

Network Manager

The network manager controls connection or disconnection to or from the network and checks the connection state in accordance with an instruction of the markup language.

Persistent Storage 216

The persistent storage holds information associated with the information storage medium such as the playback position of the content, user information, and the like, and also the advanced content downloaded from server unit 500.

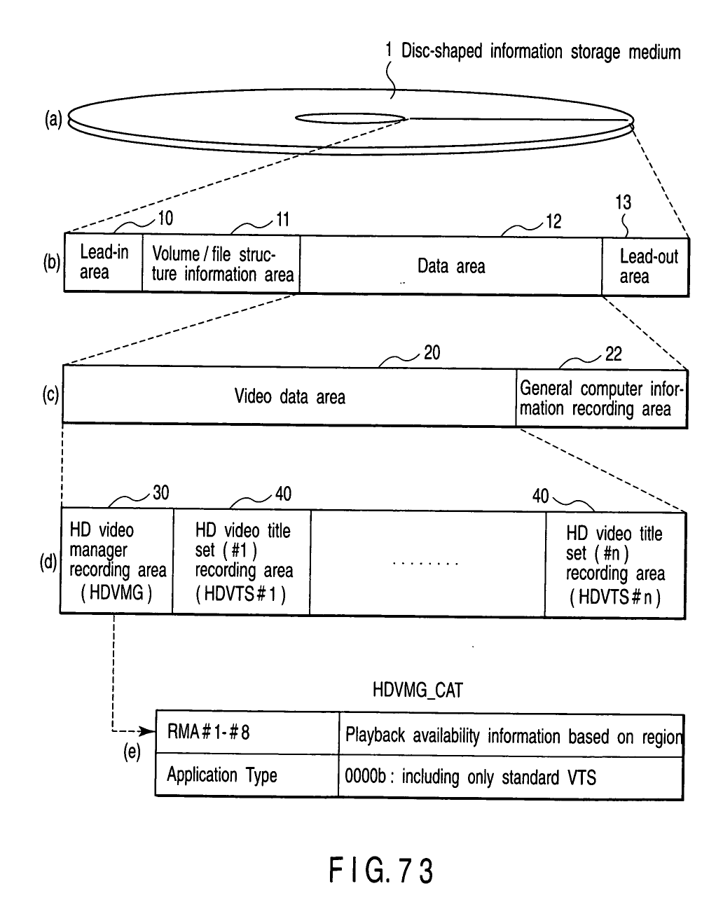

FIG. 73 shows an example of an information storage medium that records only content (standard content) which can be produced by the conventional production technique and aim at achieving high image quality of a title itself. Note that this information storage medium is called a “content type 1 disc”. The content type 1 disc includes HD video manager recording area 30 (at this time, Application Type in HDVMG_CAT in area 30 records “0000b” indicating that information storage medium 1 includes only standard VTS data), and one or more HD video title set recording areas 40, which are recorded in video data recording area 20. In addition, this information storage medium includes neither advanced HD video title set recording area 50 recorded in video data recording area 20 nor the advanced content recorded in advanced content recording area 21.

Upon playing back this information storage medium 1, FP_PGCI recorded in HD video manager information management table 310 is referred to, and playback starts in accordance with the description of the FP_PGCI. This procedure is the same as that of the conventional DVD-Video.

Also, upon playing back this information storage medium 1, in FIG. 72 that shows an example of the arrangement of the DVD player, data supplied from information storage medium 1 is processed by only DVD-Video playback engine 100, but does not undergo any processing in interactive engine 200. That is, video/audio data processed by DVD-Video playback engine 100 is output while passing through AV renderer 203.

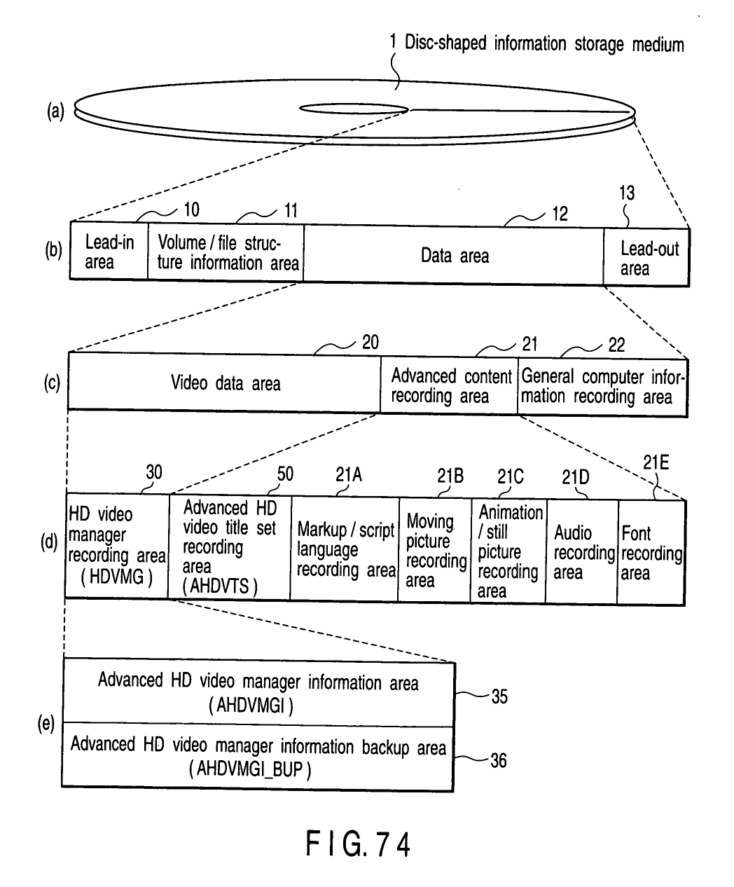

FIG. 74 shows an example of an information storage medium that records only content (advanced content) which aim at providing colorful menus, improving interactiveness, and so forth even in content of menu screens, bonus video pictures, and the like in addition to realization of high image quality of a title itself. Note that this information storage medium is called a “content type 2 disc (including only advanced VTS data)”. The content type 2 disc (including only advanced VTS data) includes one HD video manager recording area 30 and one advanced HD video title set recording area 50 recorded in video data recording area 20, and advanced content recorded in advanced content recording area 21. In addition, this information storage medium does not include any HD video title set recording area 40 recorded in video data recording area 20.

Note that since the advanced VTS does not require any menu objects, HD video manager recording area 30 of the content type 2 disc includes advanced HD video manager information recording area (AHDVMGI) 35 and advanced HD video manager information backup area (AHDVMGI_BUP) 36. At this time, Application Type in HDVMG_CAT in area 30 records “0001b” indicating that information storage medium 11 includes only advanced VTS data.

Upon playing back information storage medium 1 of this “content type 2 disc”, startup information (STARTUP.XML) recorded in the markup/script language recording area is referred to, and a “markup language file serving as a start point” described in this information is executed, thus starting playback.

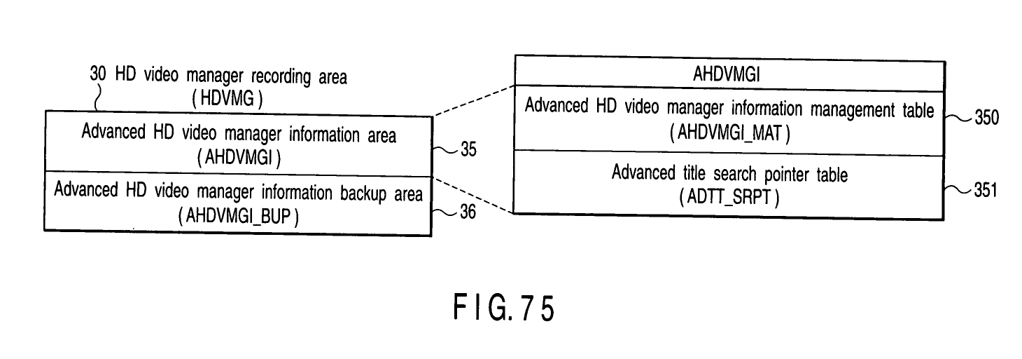

FIG. 75 shows an example of the detailed data structure in advanced HD video manager information (AHDVMGI) area 35 in information storage medium 1 in FIG. 74. Advanced HD video manager information (AHDVMGI) area 35 stores advanced HD video manager information management table (AHDVMGI_MAT) information 350 which records management information common to the entire HD_DVD-Video content recorded in video recording area 20 together, and advanced title search pointer table (ADTT_SRPT) information 351 that records information helpful to search (to detect the start positions of) titles present in the HD_DVD-Video content.

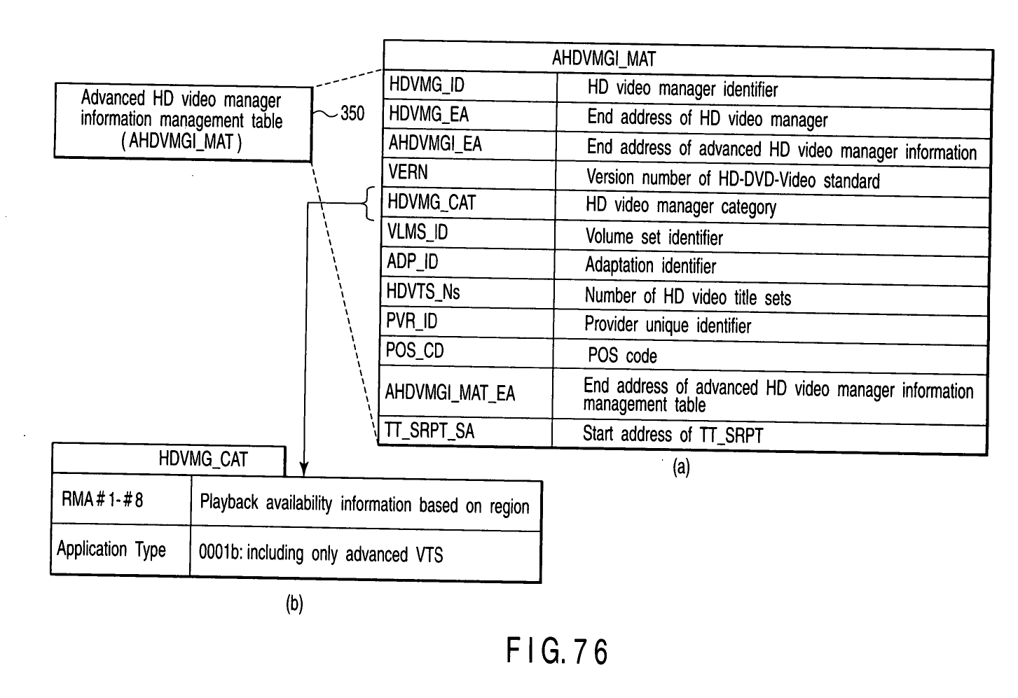

FIG. 76 shows an example of the detailed data structure in advanced HD video manager information management table (AHDVMGI_MAT) 350 in FIG. 75. Advanced HD video manager information management table (AHDVMGI_MAT) 350 records various kinds of information including an HD video manager identifier (HDVMG_ID), the end address (HDVMG_EA) of the HD video manager, the end address (HDVMGI_EA) of the HD video manager information, the version number (VERN) of the HD_DVD-Video standard, an HD video manager category (HDVMG_CAT) (in this information storage medium, Application Type in the HDVMG_CAT records “0001b”), a volume set identifier (VLMS_ID), an adaptation identifier (ADP_ID), the number (HDVTS_Ns) of HD video title sets (which records “0” since this information storage medium stores no standard VTS), a provider unique identifier (PVR_ID), a POS code (POS_CD), the end address (AHDVMGI_MAT_EA) of the advanced HD video manager information management table, and the start address (TT_SPRT_SA) of the TT_SPRT.

Note that this information storage medium does not store the start address (FP_PGCI_SA) of first play program chain information, the start address (HDVMGM_VOBS_SA) of an HDVMGM_VOBS, the start address (HDVMGM_PGCI_UT_SA) of the HDVMGM_PGCI_UT, the start address (PTL_MAIT_SA) of the PTL_MAIT, the start address (HDVTS_ATRT_SA) of the HDVTS_ATRT, the start address (TXTDT_MG_SA) of the TXTDT_MG, the start address (HDVMGM_C_ADT_SA) of the HDVMGM_C_ADT, the start address (HDVMGM_VOBU_ADMAP_SA) of the HDVMGM_VOBU_ADMAP, an HDVMGM video attribute (HDVMGM_V_ATR), the number (HDVMGM_AST_Ns) of HDVMGM audio streams, an HDVMGM audio stream attribute (HDVMGM_AST_ATR), the number (HDVMGM_SPST_Ns) of HDVMGM sub-picture streams, an HDVMGM sub-picture stream attribute (HDVMGM_SPST_ATR), first play PGCI (FP_PGCI) that records management information for language selection menus, the start address information (HDMENU_AOBS_SA) of an HDMENU_AOBS, the start address information (HDMENU_AOBSIT_SA) of the HDVMGM_AOBS information table, and information of the number (HDVMGM_GUST_Ns) of HDVMGM graphics unit streams, which are stored in the content type 1 disc (or these areas are used as reserved areas).

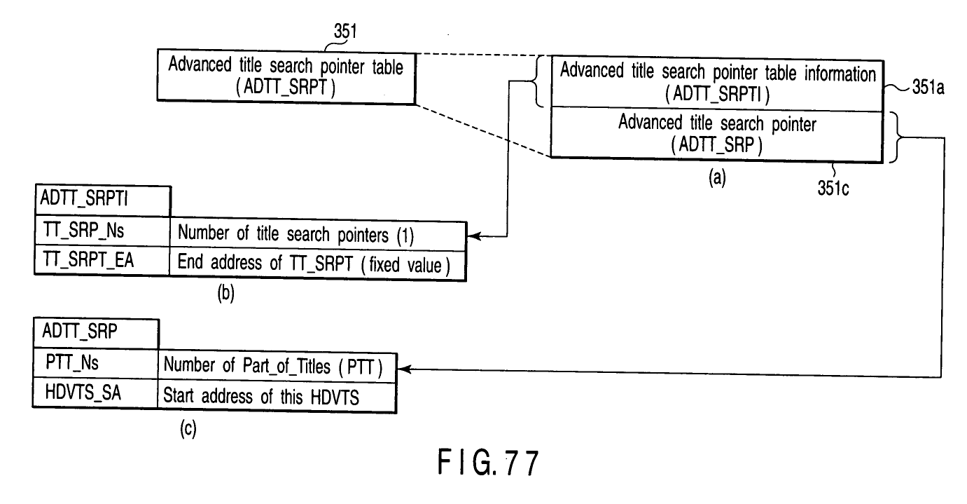

FIG. 77 shows an example of the internal structure of advanced title search pointer table (ADTT_SRPT) 351 shown in FIG. 75. Advanced title search pointer table (ADTT_SRPT) 351 includes advanced title search pointer table information (ADTT_SRPTI) 351a and advanced title search pointer table (ADTT_SRP) information 351c. Only one piece of advanced title search pointer table (ADTT_SRP) information 351c in advanced title search pointer table (ADTT_SRPT) 351 is present in an information storage medium including an advanced VTS but it does not exist in another information storage media.

Advanced title search pointer table information (ADTT_SRPTI) 351a records common management information of advanced title search pointer table (ADTT_SRPT) 351, and records information of the number (ADTT_SRP_Ns) of title search pointers included in advanced title search pointer table (ADTT_SRPT) 351 (“1” is recorded since there is only one advanced VTS in this information storage medium), and the end address (ADTT_SRPT_EA) information of this advanced title search pointer table (ADTT_SRPT) 351 (a fixed value is recorded since there is only one advanced VTS in this information storage medium) in a file of the advanced HD video manager information (AHDVMGI) area.

One advanced title search pointer (ADTT_SRP) information 351c records various kinds of information including the number (PTT_Ns) of Part_of_Titles (PTT), and the start address (HDVTS_SA) of the HDVTS of interest, in association with a title indicated by this search pointer. (This medium does not include a title playback type (TT_PB_TY), the number (AGL_Ns) of angles, title Parental_ID_Field (TT_PTL_ID_FLD) information, an HDVTS number (HDVTSN), and an HDVTS title number (HDVTS_TTN), which are stored in the content type 1 disc, or these areas are used as reserved areas.)

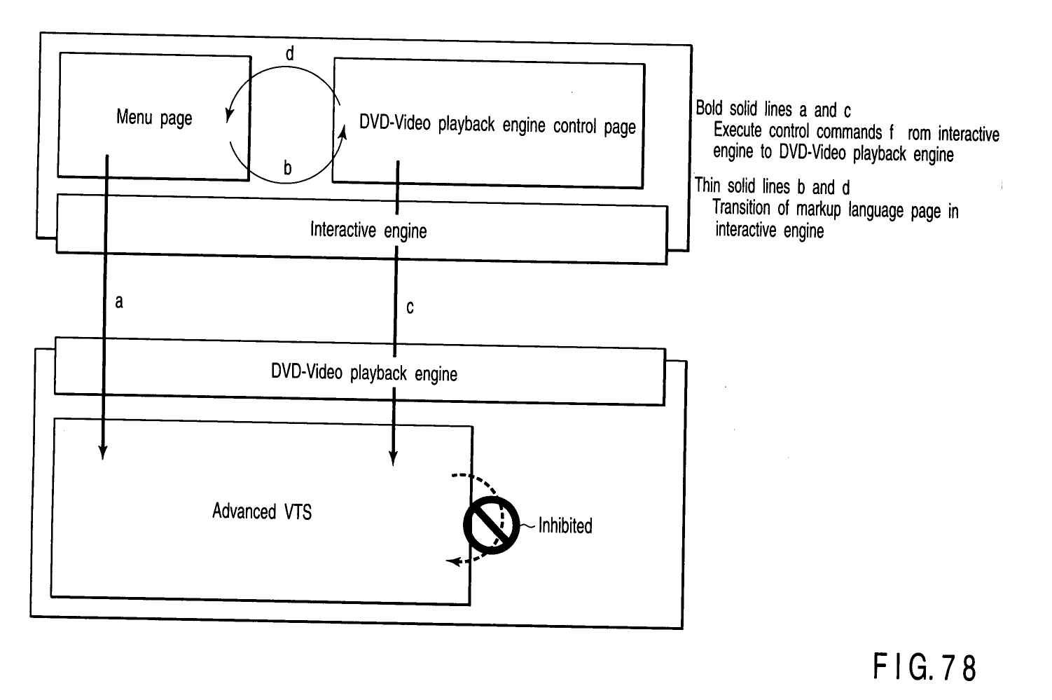

FIG. 78 is a view for explaining a playback model (example 1) of a disc that records an advanced VTS (AHDVTS). A playback example of typical content type 2 disc (including only an advanced VTS) will be described below using FIG. 78.

When playback of the content type 2 disc (including only an advanced VTS) starts, interactive engine (INT_ENG) 200 parses a menu page XML file which is stored in the advanced content recording area used to playback a menu screen described in the markup/script language.

For example, when a menu screen which prompts the user to execute a button selection process while repetitively playing back an impressive scene in movie video picture data is to be formed, the menu page XML file describes a control process for controlling DVD-Video playback engine (DVD_ENG) 100 to repetitively play back video data of the advanced VTS using the markup/script language. Interactive engine (INT_ENG) 200 issues a playback command (arrow a) to DVD-Video playback engine (DVD_ENG) 100 in accordance with the description.

At the same time, the page menu XML file stores a description for forming a menu screen using button images stored in the animation/still picture recording area and font data stored in the font recording area in advanced content recording area 21. Interactive engine (INT_ENG) 200 controls AV renderer 203 to mix the output, which forms the screen according to these descriptions, with the video output of the advanced VTS via the aforementioned DVD-Video playback engine (DVD_ENG) 100, thus implementing playback of the menu screen.

Next, the user selects a button used to execute playback of a video title itself of menu select buttons laid out on the screen using a remote controller or the like. The menu page XML file describes a script process associated with the selected button, and a jump event to a DVD playback engine control page is generated (arrow b).

The DVD playback engine control page describes a control process for playing back the starting part of the video title itself using the markup/script language. Interactive engine (INT_ENG) 200 issues a playback command to DVD-Video playback engine (DVD_ENG) 100 in accordance with the description (arrow c). The DVD playback engine control page also stores descriptions used to form a menu screen that can be displayed during playback of the video title itself (e.g., a menu is formed using a screen smaller than the video title itself, and is superimposed on the video title itself by seeing through the menu screen) and to superimpose a subtitle, using button images stored in the animation/still picture recording area and font data stored in the font recording area in the advanced content recording area 21. Interactive engine (INT_ENG) 200 controls AV renderer 203 to mix the output that forms the screen and the video output of the advanced VTS by aforementioned DVD-Video playback engine (DVD_ENG) 100 in accordance with these descriptions, thus implementing playback of the menu screen and subtitle.

Upon completion of playback of the video title itself, interactive engine (INT_ENG) 200 controls the XML file to be processed to jump to the menu page XML file so as to play back the menu screen again in accordance with the description in the DVD-Video playback engine control page XML file (arrow d). Note that a broken arrow marked with a circle with an oblique line in FIG. 78 indicates that a jump event based on a navigation command in the advanced VTS is inhibited.

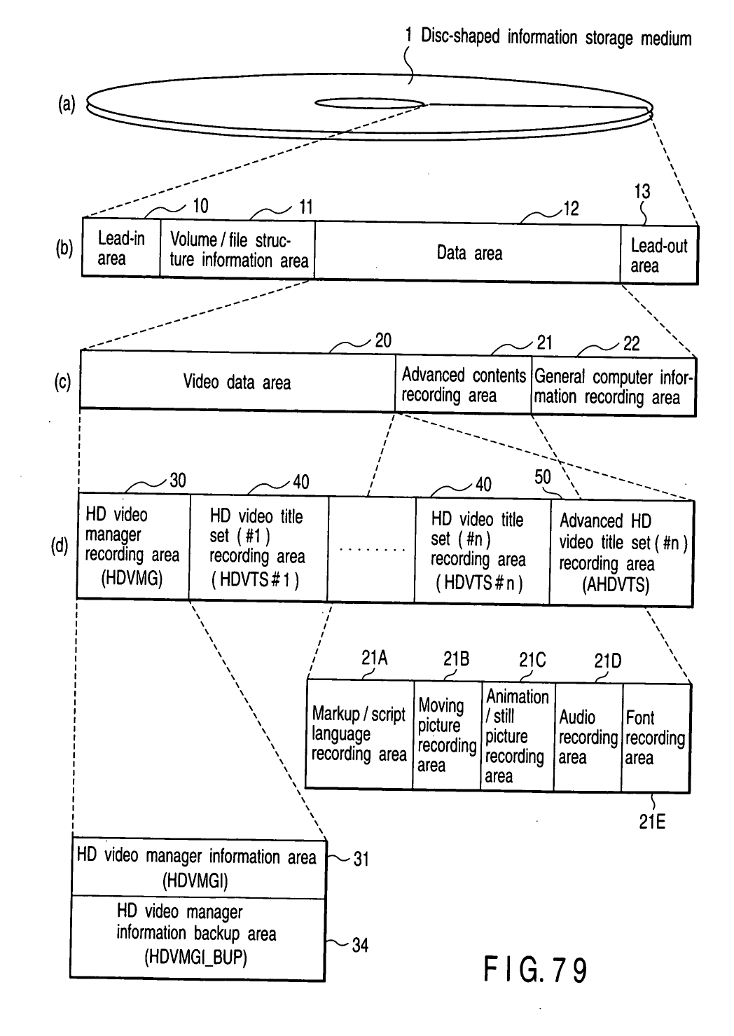

FIG. 79 shows an example of an information storage medium which records both content (standard content) which can be produced by the conventional production technique and aim at realizing high image quality of a title itself, and content (advanced content) which aim at providing colorful menus, improving interactiveness, and so forth even in content of menu screens, bonus video pictures, and the like in addition to realization of high image quality of the title itself. Note that this information storage medium is called a “content type 2 disc (including both advanced and standard VTS data)”.

The content type 2 disc including both advanced and standard VTS data includes one HD video manager recording area 30, one or more HD video title set recording areas 40, and one advanced HD video title set recording area 50, which are recorded in video data recording area 20, and advanced content (21A to 21E) recorded in advanced content recording area 21. Since the disc including the advanced VTS does not require any menu objects, this HD video manager recording area 30 includes advanced HD video manager information recording area (AHDVMGI) 35 and advanced HD video manager information backup area (AHDVMGI_BUP) 36. At this time, Application Type in the HDVMG_CAT in area 30 records “0010b” indicating that information storage medium 1 includes both standard and advanced VTS data.

Upon playing back this information storage medium (content type 2 disc) 1, startup information (STARTUP.XML) recorded in the markup/script language recording area is referred to, and a “markup language file serving as a start point” described in this information is executed, thus starting playback.

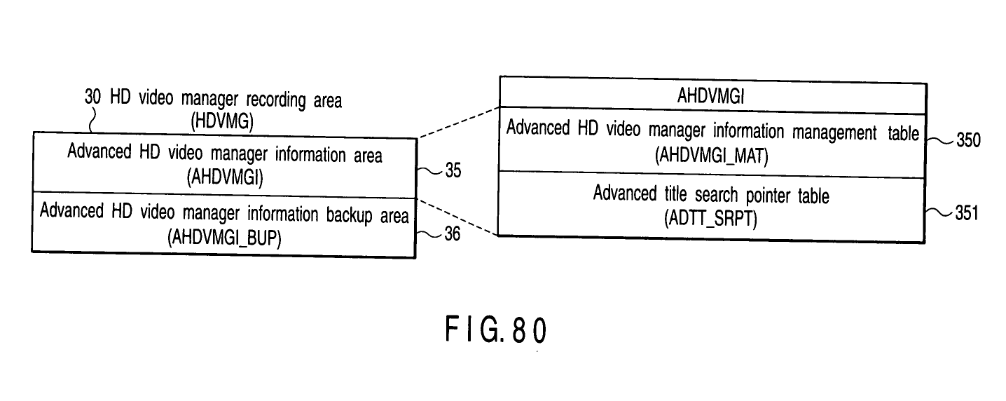

FIG. 80 shows an example of the detailed data structure in advanced HD video manager information (AHDVMGI) area 35 in the information storage medium in FIG. 79. Advanced HD video manager information (AHDVMGI) area 35 stores advanced HD video manager information management table (AHDVMGI_MAT) information 350 which records management information common to the entire HD_DVD-Video content recorded in video data recording area 20 together, and advanced title search pointer table (ADTT_SRPT) information 351 that records information helpful to search (to detect the start positions of) titles present in the HD_DVD-Video content.

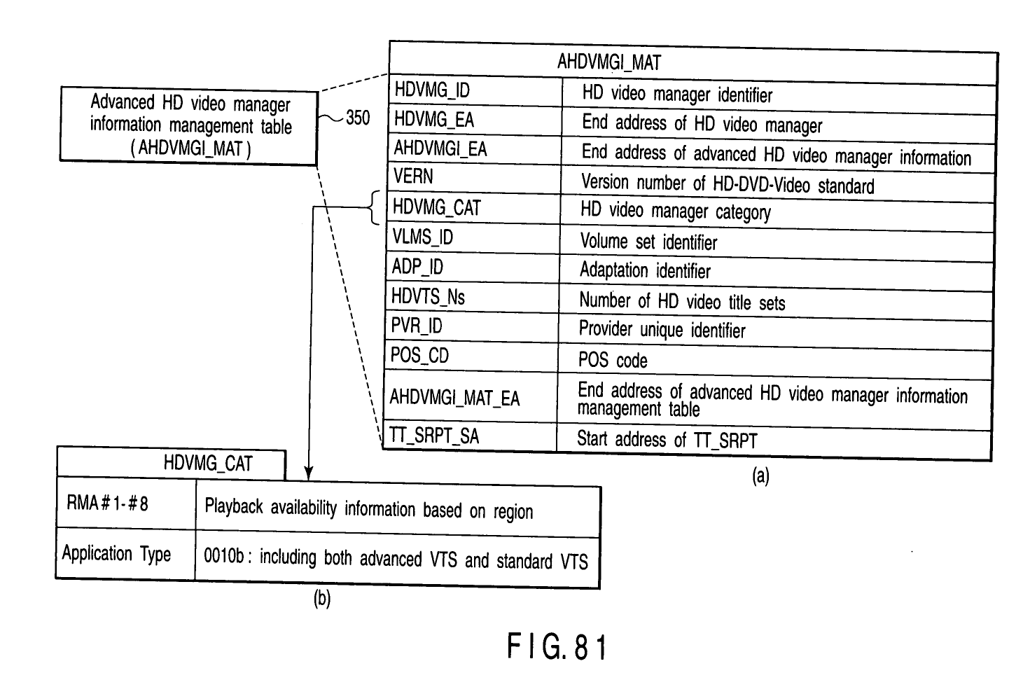

FIG. 81 shows an example of the detailed data structure in advanced HD video manager information management table (AHDVMGI_MAT) 350 in FIG. 80. Advanced HD video manager information management table (AHDVMGI_MAT) 350 records various kinds of information including an HD video manager identifier (HDVMG_ID), the end address (HDVMG_EA) of the HD video manager, the end address (AHDVMGI_EA) of the advanced HD video manager information, the version number (VERN) of the HD_DVD-Video standard, an HD video manager category (HDVMG_CAT: in this information storage medium, Application Type in the HDVMG_CAT records “0010b”), a volume set identifier (VLMS_ID), an adaptation identifier (ADP_ID), the number (HDVTS_Ns) of HD video title sets, a provider unique identifier (PVR_ID), a POS code (POS_CD), the end address (AHDVMGI_MAT_EA) of the advanced HD video manager information management table, and the start address (TT_SPRT_SA) of the TT_SPRT.

Note that this information storage medium (content type 2 disc) does not store the start address (FP_PGCI_SA) of first play program chain information, the start address (HDVMGM_VOBS_SA) of an HDVMGM_VOBS, the start address (HDVMGM_PGCI_UT_SA) of the HDVMGM_PGCI_UT, the start address (PTL_MAIT_SA) of the PTL_MAIT, the start address (HDVTS_ATRT_SA) of the HDVTS_ATRT, the start address (TXTDT_MG_SA) of the TXTDT_MG, the start address (HDVMGM_C ADT_SA) of the HDVMGM_C_ADT, the start address (HDVMGM_VOBU_ADMAP_SA) of the HDVMGM_VOBU_ADMAP, an HDVMGM video attribute (HDVMGM_V_ATR), the number (HDVMGM_AST_Ns) of HDVMGM audio streams, an HDVMGM audio stream attribute (HDVMGM_AST_ATR), the number (HDVMGM_SPST_Ns) of HDVMGM sub-picture streams, an HDVMGM sub-picture stream attribute (HDVMGM_SPST_ATR), first play PGCI (FP_PGCI) that records management information for language selection menus, the start address information (HDMENU_AOBS_SA) of an HDMENU_AOBS, the start address information (HDMENU_AOBSIT_SA) of the HDVMGM_AOBS information table, and information of the number (HDVMGM_GUST_Ns) of HDVMGM graphics unit streams, which are stored in the content type 1 disc (or these areas are used as reserved areas).

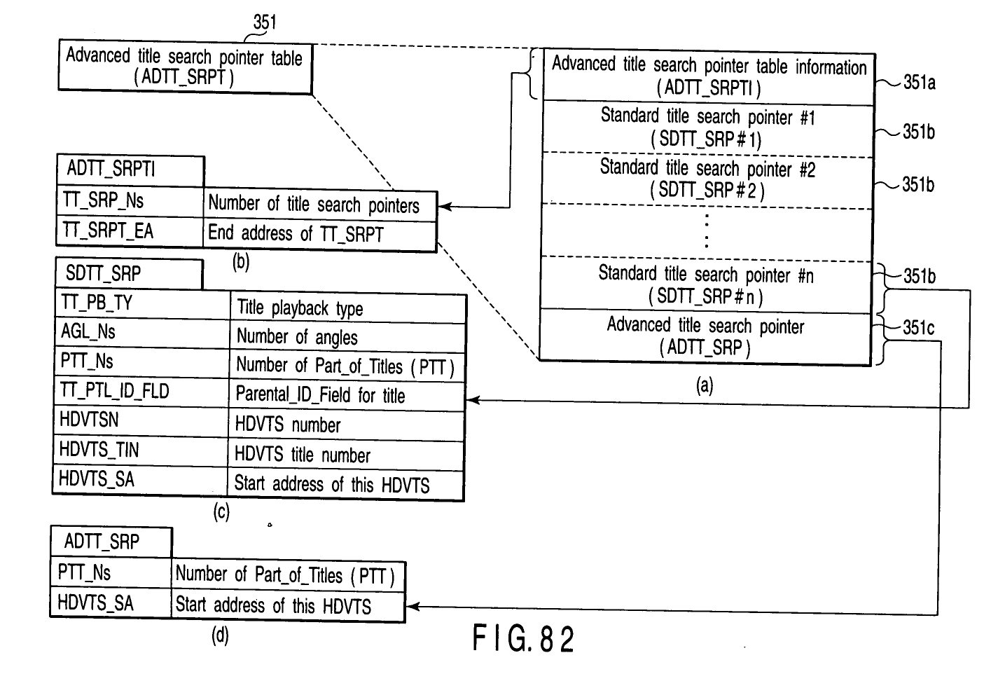

FIG. 82 shows an example of the internal structure of advanced title search pointer table (ADTT_SRPT) 351 shown in FIG. 80. Advanced title search pointer table (ADTT_SRPT) 351 includes advanced title search pointer table information (ADTT_SRPTI) 351a, standard title search pointer (SDTT_SRP) 351b, and advanced title search pointer table (ADTT_SRP) information 351c. Only one piece of advanced title search pointer table (ADTT_SRP) information 351c in advanced title search pointer table (ADTT_SRPT) 351 is present in an information storage medium including an advanced VTS but it does not exist in other information storage media. Also, standard title search pointer (SDTT_SRP) 315b is present only when an information storage medium records standard VTS data.

Advanced title search pointer table information (ADTT_SRPTI) 351a records, as common management information of advanced title search pointer table (ADTT_SRPT) 351, information of the number (ADTT_SRP_Ns) of title search pointers included in advanced title search pointer table (ADTT_SRPT) 351, and the end address (ADTT_SRPT_EA) information of this advanced title search pointer table (ADTT_SRPT) 351 in a file of the advanced HD video manager information (AHDVMGI) area.

Only one advanced title search pointer (ADTT_SRP) information 351c records various kinds of information including the number (PTT_Ns) of Part_of_Titles (PTT), the start address (HDVTS_SA) of the HDVTS of interest, and the like, in association with a title indicated by this search pointer

The information storage medium (content type 2 disc) with the structure shown in FIGS. 79 to 82 does not include a title playback type (TT_PB_TY), the number (AGL_Ns) of angles, title Parental_ID_Field (TT_PTL_ID_FLD) information, an HDVTS number (HDVTSN), and an HDVTS title number (HDVTS_TTN) (or these areas are used as reserved areas).

One standard title search pointer (SDTT_SRP) information 351b records various kinds of information including a title playback type (TT_PB_TY), the number (AGL_Ns) of angles, the number (PTT_Ns) of Part_of_Titles (PTT), title Parental_ID_Field (TT_PTL_ID_FLD) information, an HDVTS number (HDVTSN), an HDVTS title number (HDVTS_TTN), and the start address (HDVTS_SA) of the HDVTS of interest, in association with a title indicated by this search pointer.

FIG. 83 is a view for explaining the relationship between the playback states of an advanced VTS and standard VTS. FIG. 83 shows an example a state machine that indicates transition of a playback control module of the content type 2 disc. In a playback process of the content type 2 disc (of a type including both advanced and standard VTS data), playback starts from an initial state when interactive engine (INT_ENG) 200 interprets startup information (STARTUP.XML) recorded in markup/script language recording area 21A, and the control transits to an advanced VTS playback state.

In the advanced VTS playback state, interactive engine (INT_ENG) 200 generates text information, button images, and the like, which form a menu screen, and issues a video playback start instruction command to DVD-Video playback engine (DVD_ENG) 100. Interactive engine 200 controls AV renderer 203 to mix the output that forms the screen with the video output of DVD-Video playback engine (DVD_ENG) 100, thus implementing playback of the menu screen.

A markup/script language file that describes a menu page to be interpreted in the advanced VTS playback state describes a script which defines the behaviors of event handlers which are associated with events such as button clicking and the like by the user. For example, an event handler associated with a button image that indicates playback of a movie video title itself describes a command used to shift the control to a standard VTS playback state. When the user selects and executes the title playback button by a remote controller operation or the like, interactive engine (INT_ENG) 200 executes the command used to shift the control to the standard VTS playback state, and the state machine makes the video playback control transit to the standard VTS playback state executed by DVD-Video playback engine (DVD_ENG) 100.

In the standard VTS playback state, DVD-Video playback engine (DVD_ENG) 100 interprets a cell playback information table (C_PBIT), program chain command table (PGC_CMDT), and the like in a program chain (PGC) stored in a PGC and the like in the standard VTS, and executes playback control of the standard VTS in accordance with their description content. In the standard VTS playback state, interactive engine (INT_ENG) 200 halts, and never instructs DVD-Video playback engine (DVD_ENG) 100 to execute playback control.

The program chain command table (PGC_CMDT) and the like of the standard VTS can describe a shift command (“CallINTENG” or the like in FIG. 43(d)) to the advanced VTS playback state. With such command, DVD-Video playback engine (DVD_ENG) 100 can execute the shift command to the advanced VTS playback state when it executes a command interpretation process upon completion of a series of video playback processes, or DVD-Video playback engine (DVD_ENG) 100 can shift the video playback control to the advanced VTS playback state executed by interactive engine (INT_ENG) 200 upon reception of an event of a user command such as menu call or the like.

Upon shifting from the standard VTS playback state to the advanced VTS playback state, DVD-Video playback engine 100 may temporarily store information such as the video playback position of the standard VTS or the like immediately before the playback control transits to prepare for a resume playback process from interactive engine (INT_ENG) 200, so as to implement a temporary call process of a menu screen or the like.

Table A below shows a practical example of commands used to shift from the advanced VTS playback state to the standard VTS playback state in the markup/script language file to be interpreted by interactive engine (INT_ENG) 200 (commands other than those in this example may be adopted as needed).

TABLE A

| (Command Name) | (Argument) |
|---|---|
| CallDVDENG_TT | Title number |
| CallDDVENG_PTT | Title number, chapter number |
| CallDVDENG_TM | Title number, playback start |
| | time position |
| CallDVDENG_RSM | No argument |

In table A, CallDVDENG_TT is a command that designates the title number of a standard VTS upon shifting from the advanced VTS playback state to the standard VTS playback state. DVD-Video playback engine (DVD_ENG) 100 loads a standard VTS including the designated title, and starts playback from the head of the title.

CallDDVENG_PTT is a command that designates the title number and chapter number (PTT number) of a standard VTS upon shifting from the advanced VTS playback state to the standard VTS playback state. DVD-Video playback engine (DVD_ENG) 100 loads a standard VTS including the designated title, and starts playback from the head of the designated chapter number (PTT number).

CallDVDENG_TM is a command that designates the title number and an offset of the playback start time from the head of the title video of a standard VTS upon shifting from the advanced VTS playback state to the standard VTS playback state. DVD-Video playback engine (DVD_ENG) 100 loads a standard VTS including the designated title, and starts playback from the designated playback time position.

CallDVDENG_RSM is a command that designates execution of a resume process upon shifting from the advanced VTS playback state to the standard VTS playback state. Upon reception of this command, DVD-Video playback engine (DVD_ENG) 100 resumes playback in accordance with the temporarily stored playback position information when the control transits from the immediately preceding standard VTS playback state to the advanced VTS playback state.

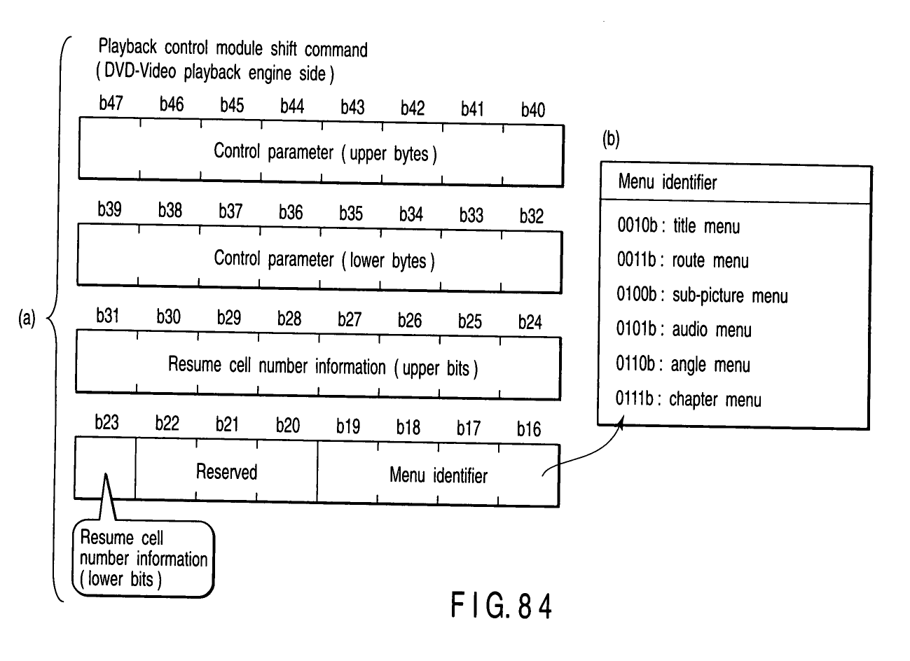

FIG. 84 shows an example of argument definition of a command (CallINTENG command) used to shift from the standard VTS playback state to the advanced VTS playback state of navigation commands to be interpreted by the DVD-Video playback engine (DVD_ENG). In the entire command bit sequence, a command code is stored in bits b63 to b48, and b15 to b0 are assigned to a reserved area for future expansion.

A 16-bit control parameter storage area is assigned to b47 to b32. At a specific playback position or in an event of a standard VTS to be interpreted by DVD-Video playback engine (DVD_ENG) 100, this area can store an arbitrary value which is used to select an arbitrary process in the description of the markup/script language file to be interpreted by interactive engine (INT_ENG) 200 after the control transits to the advanced VTS playback state. That is, this data area can be used for an arbitrary purpose upon producing video content. An area for storing the playback start cell number in the resume process is assigned to b31 to b23.

An area for storing a menu identifier is assigned to b19 to b16, and is used to designate the type of menu to be called upon calling a menu especially when the control transits from the standard VTS playback state to the advanced VTS playback state. The type of menu identifier that can be called includes:

0010b: title menu

0011b: root menu

0100b: sub-picture menu

0101b: audio menu

0110b: angle menu

0111b: chapter menu, etc.

Also, more detailed behavior differences may be expressed based on the aforementioned control parameter or by combining the control parameter and menu identifier.

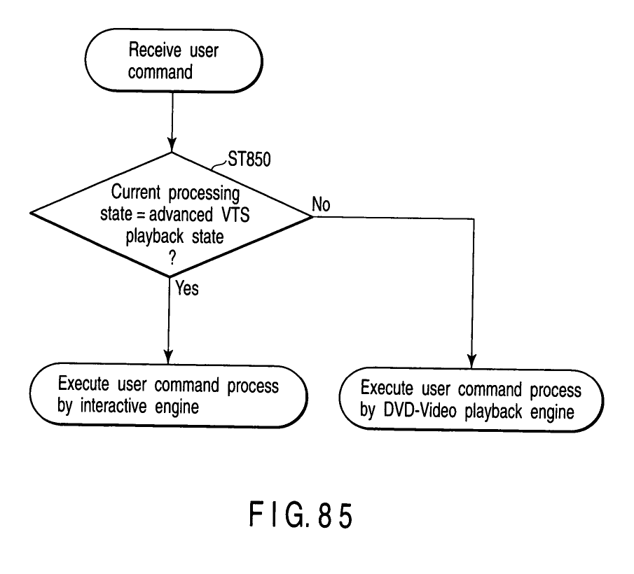

FIG. 85 is a flowchart for explaining the switching algorithm of a user command process. This flowchart exemplifies a process for switching a module that handles a process when a user command is generated. Upon playing back the content type 2 disc (of a type including both advanced and standard VTS data), when an event of a user command associated with button depression on a remote controller or front panel (not shown) is generated, a user operation module confirms the current playback state (block ST850), and switches a module which is to be notified of the user event. If the current state is the advanced VTS playback state (YES in block ST850), the user operation module notifies interactive engine (INT_ENG) 200 of the user event; if the current state is the standard VTS playback state (NO in block ST850), the user operation module notifies DVD-Video playback engine (DVD_ENG) 100 of the user event, thus executing the process of the user command.

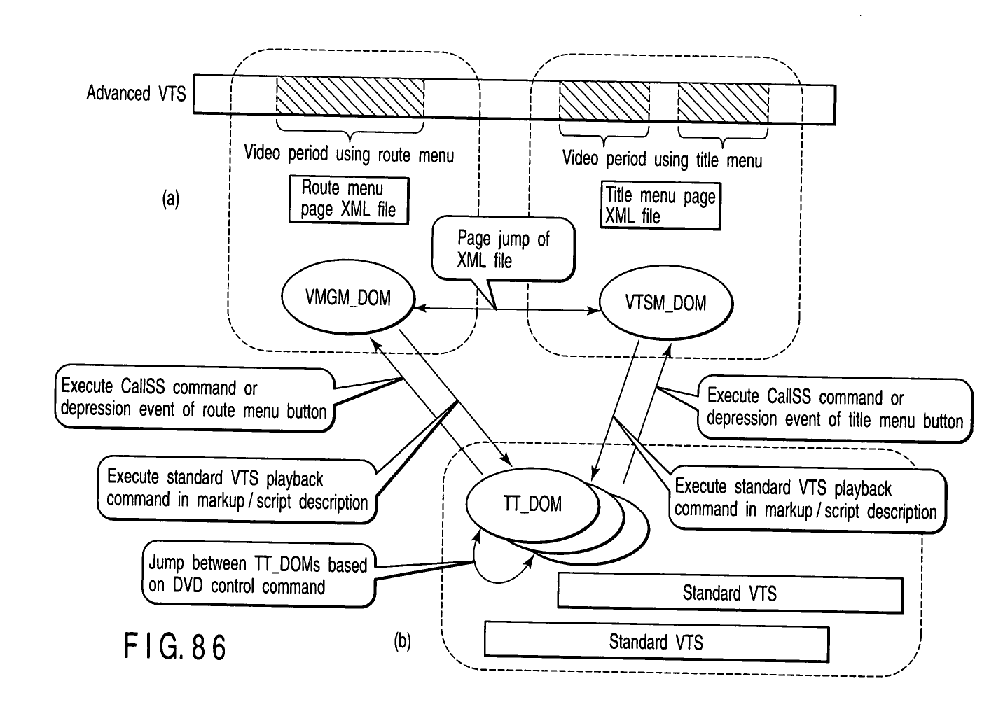

FIG. 86 shows an example of domain transition of the content type 2 disc. In a typical content type 2 disc (of a type including both advanced and standard VTS data), a VMG menu domain (VMGM_DOM) and VTS menu domain (VTSM_DOM) are formed of an advanced VTS and an XML file described in the markup/script language, and a title domain (TT_DOM) such as a video title itself is formed of a standard VTS.

Menu video picture data in the VMG menu domain and VTS menu domain is realized by playing back video picture data stored in the advanced VTS in accordance with the description of the “XML file” in addition to text information and button images rendered in accordance with the description of the “menu XML file” described in the markup/script language.

Transition between the VMG menu domain and VTS menu domain is implemented by executing a hyperlink process between menu XML files described in these menu XML files. At this time, playback of the advanced VTS may stop in correspondence with a change in page, and playback may start from a new position or may be continued from the previous position.

Transition from the VMG menu domain (VMGM_DOM), VTS menu domain (VTS_DOM), or the like to the title domain (TT_DOM) is implemented by executing a playback start command of a standard VTS (e.g., a CallDVDENG_xxx command listed in table A above) described in an XML file, and transferring the DVD playback control to DVD-Video playback engine 100.

On the other hand, transition from the title domain (TT_DOM) to the VMG menu domain (VMGM_DOM) may be implemented by defining a new command such as the aforementioned CallINTENG command and storing this new command in the program chain command table (PGC_CMDT) in the standard VTS. Alternatively, transition from the title domain (TT_DOM) to the VMG menu domain (VMGM_DOM) may take place when an argument of a CallSS command indicates VMGM_DOM. Also, an event generated upon depression of a root menu button arranged on a remote controller or the like (not shown) may be acquired, and transition from the title domain (TT_DOM) to the VMG menu domain (VMGM_DOM) may take place upon acquisition of this event.

Likewise, transition from the title domain (TT_DOM) to the VTS menu domain (VTSM_DOM) may be implemented by defining a new command such as the aforementioned CallINTENG command or the like, and storing this new command in the program chain command table (PGC_CMDT) in the standard VTS, or this domain transition may take place when an argument of a CallSS command indicates VTSM_DOM. Also, an event generated upon depression of a title menu button arranged on a remote controller or the like (not shown) may be acquired, and transition from the title domain (TT_DOM) to the VTS menu domain (VTSM_DOM) may take place upon acquisition of this event.

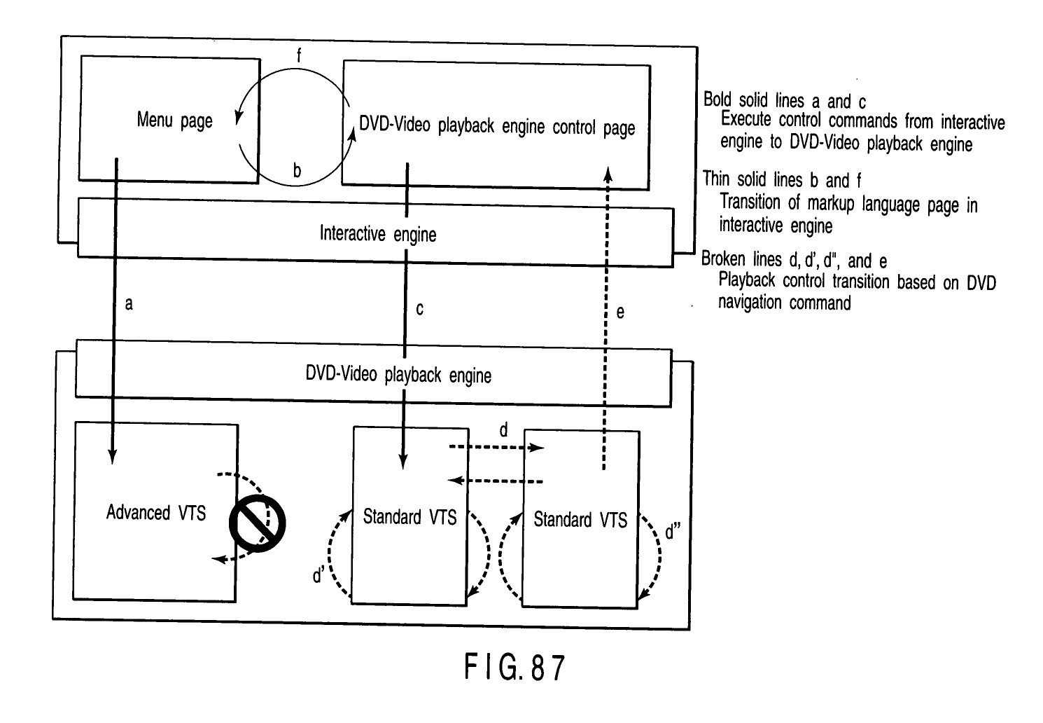

FIG. 87 is a view for explaining a playback model (example 2) of a disc that records both an advanced VTS (AHDVTS) and standard VTS (HDVTS). A playback example of a typical content type 2 disc (of a type including both advanced and standard VTS data) will be explained using FIG. 87.

When playback of the content type 2 disc (including both advanced and standard VTS data) starts, interactive engine (INT_ENG) 200 parses a menu page XML file which is stored in the advanced content recording area and is used to play back a menu screen described in the markup/script language.

For example, when a menu screen which prompts the user to execute a button selection process while repetitively playing back an impressive scene in movie video picture data is to be formed, the menu page XML file describes a control process for controlling DVD-Video playback engine (DVD_ENG) 100 to repetitively play back video data of the advanced VTS using the markup/script language. Interactive engine (INT_ENG) 200 issues a playback command (arrow a) to DVD-Video playback engine (DVD_ENG) 100 in accordance with the description.

At the same time, the menu page XML file stores a description for forming a menu screen using button images stored in the animation/still picture recording area and font data stored in the font recording area in advanced content recording area 21. Interactive engine (INT_ENG) 200 controls AV renderer 203 to mix the output, which forms the screen according to these descriptions, with the video output of the advanced VTS via the aforementioned DVD-Video playback engine (DVD_ENG) 100, thus implementing playback of the menu screen.

Next, the user selects a button used to execute playback of a video title itself of menu select buttons laid out on the screen using a remote controller or the like. The menu page XML file describes a script process associated with the selected button, and a jump event to a DVD playback engine control page is generated (arrow b).

The DVD playback engine control page describes a CallDVDENG_TT command which has the title number indicating the head of a video title itself as an argument. When interactive engine (INT_ENG) 200 executes this command, transition from the advanced VTS playback state to the standard VTS playback state takes place (arrow c).

After transition to the standard VTS playback state, DVD-Video playback engine (DVD_ENG) 100 executes playback of the standard VTS that stores the video title itself. Depending on video content, a playback position jump process to a playback position of another VTS may be taken place in accordance with the description of a playback control command stored in the VTS (arrow d). Note that a broken arrow marked with a circle with an oblique line in FIG. 87 indicates that a jump event based on a navigation command in the advanced VTS is inhibited. On the other hand, a jump event based on a navigation command is allowed in the standard VTS (arrow d′, d″, or the like).

Upon completion of playback of the video title itself, a “CallINTENG command” described in the program chain command table in the program chain (PGC) is executed, thus causing transition from the standard VTS playback state to the advanced VTS playback state (arrow e).

Interactive engine (INT_ENG) 200 controls the XML file to be processed to jump to the menu page XML file so as to play back the menu screen again in accordance with a script description described in a handler of a CallINTENG command generating event in the DVD-Video playback engine control page XML file (arrow f).

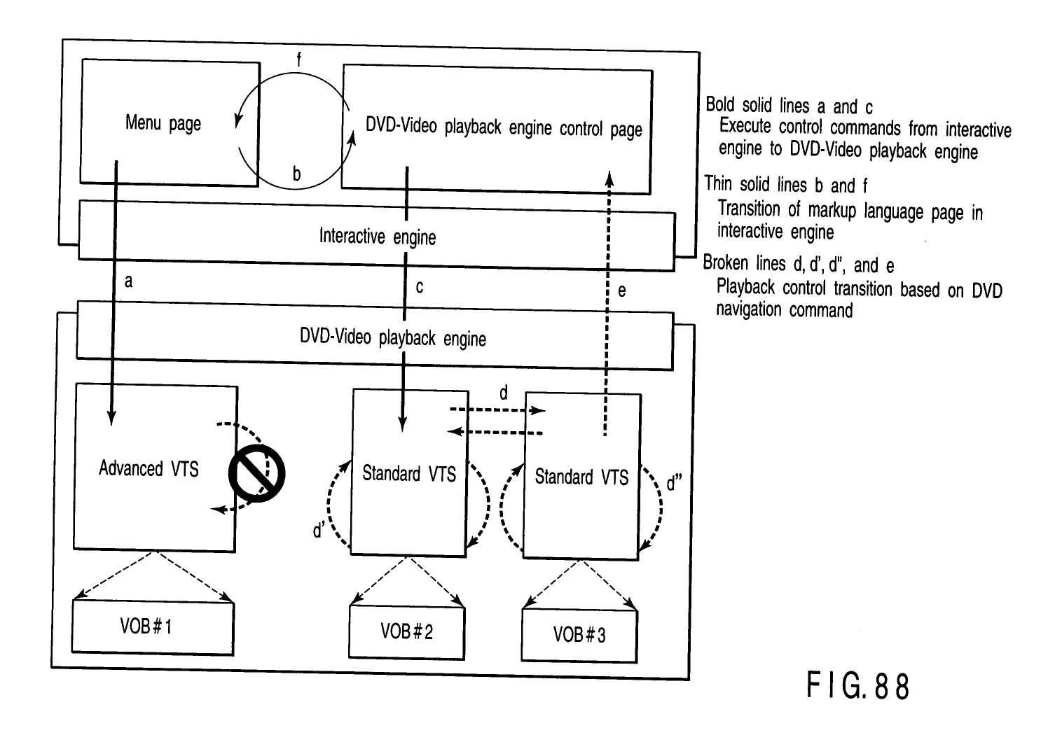

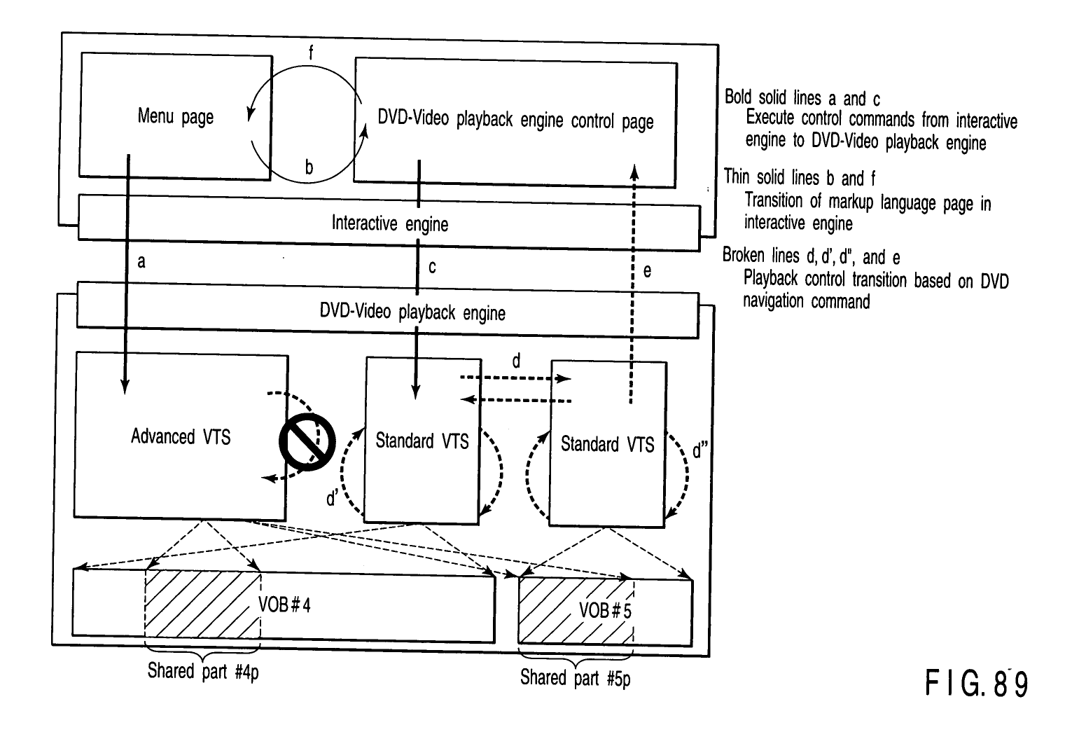

FIG. 88 shows the relationship among an advanced VTS, standard VTS, and video objects (called EVOB or VOB data) in the content type 2 disc including both advanced and standard VTS data. In FIG. 88, an advanced VTS that forms a menu and two standard VTSs which form a title (video title) are present. Respective VTSs refer to independent video objects. In this example, video picture data used to form a menu is quite different from that which forms a title. With the configuration shown in FIG. 88, when a “menu screen which prompts the user to execute a button selection process while repetitively playing back an impressive scene in movie video picture data is to be formed”, two video objects are to be prepared although the video title and menu video picture data are the same. In order to avoid such duplicate preparation of “two video objects”, a “shared reference model of objects” shown in FIG. 89 can be referred to.

FIG. 89 is a view for explaining a shared reference model of objects in a disc that records an advanced VTS (AHDVTS) and standard VTS (HDVTS) together. Since each of the advanced VTS side and standard VTS side stores a time map, the advanced VTS and standard VTS can refer to the same video objects, and an arbitrary period of a given scene in the video title can be extracted and used as a background picture of a menu screen. In this way, the content provider can reduce the number of processes for producing two video objects to one (in association with a shared object to be referred to). Also, since the two objects are reduced to one, the capacity of the information storage medium can be reduced, and improvement of the image quality of the video title itself, addition of a new bonus picture, and the like can be realized accordingly.

When a video object (VOB) to be shared by the advanced VTS and standard VTS is played back as the advanced VTS, PCI/DSI often includes information which is not required as the standard VTS, as shown in FIGS. 64 and 65. When such video object is played back as the standard VTS, playback is made using such information. However, when the video object is played back as the advanced VTS, playback is made while skipping such information, i.e., ignoring it.

FIG. 90 is a view for explaining a practical example of loading information included in advanced content. The loading information includes a file name & location field, file size field, content type field, reference start time field, reference end time field, and the like. The file name & location field describes the URL address and file name of a file when that file is present on the server unit 500, or describes the directory on a disc and file name of a file when that file is present on the disc. The file size field describes the file size of a file (unit: bytes). The content type field describes the type of content using MIME types. The reference start time field describes a reference start time of a file from the markup language or the like, and the reference end time field describes a reference end time of that file from the markup language or the like (that is, when this time has elapsed, the file loaded on the buffer may be immediately erased).

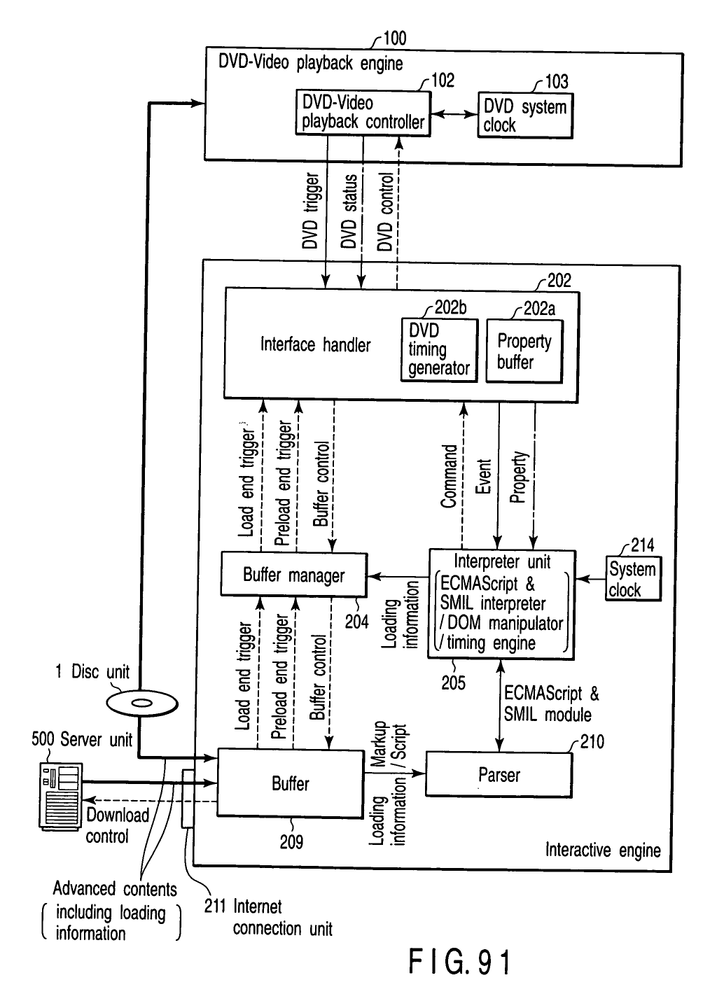

Basically, a file with the reference start time=“0” is to be loaded onto the buffer (209 in FIGS. 72 and 91 or the like) before playback starts (i.e., before the beginning of execution of the markup language) (“preload”). For other data, the playback apparatus determines the loading start times of all files using the reference start times, reference end times, and file sizes which are described in the loading information, and information associated with a communication rate acquired by the playback apparatus. In this way, the user wait time until the beginning of display of the advanced content/the beginning of playback of the DVD-Video content can be minimized.

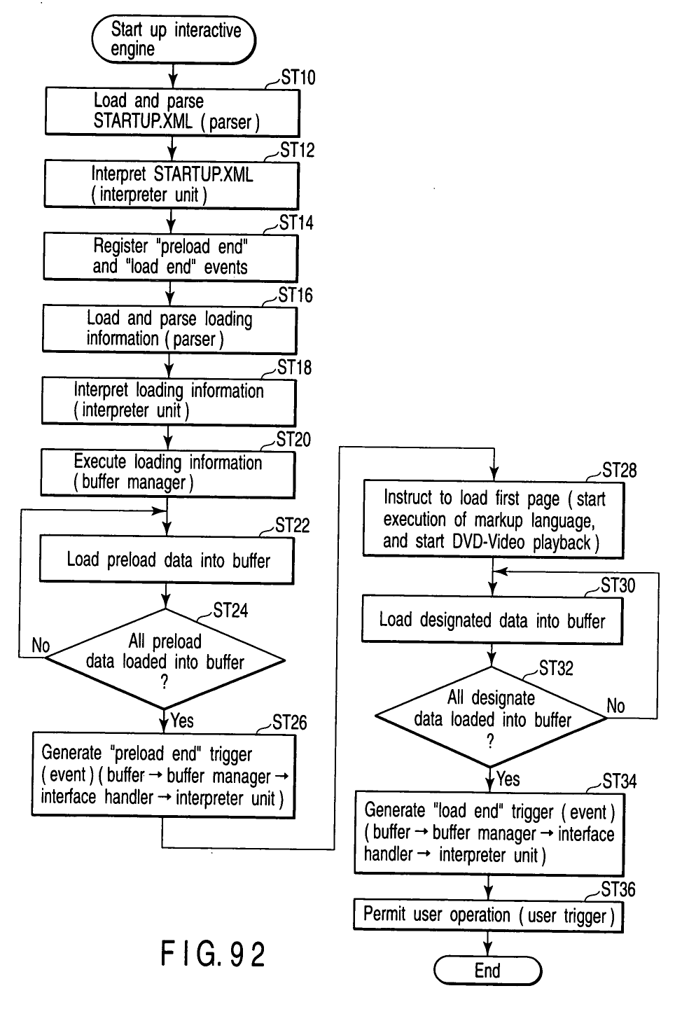

FIG. 91 shows the arrangement of buffer manager 204 and its peripheral units, and FIG. 92 shows the flow upon loading data onto V buffer 209. When interactive engine 200 is started up, a startup information file (STARTUP.XML) as one of advanced content recorded on information storage medium 1 in the disc unit is loaded (block ST10). Parser 210 parses this startup information (block ST12). Interpreter unit 205 interprets the parsed startup information. Interpreter unit 205 registers an operation upon generation of a “preload end” event (trigger) (for example, loading/execution of markup language file INDEX.XML indicating the default screen configuration starts), and an operation upon generation of a “load end” event (trigger) (for example, execution of a user operation which is inhibited so far is permitted) (block ST14).

Note that the control of “user operation” can be made by PGC user operation control (PGC_UOP_CTL) in the standard VTS, and can be made by the markup language in the advanced VTS.

Furthermore, loading information (see FIG. 90) is loaded (block ST16). This loading information may be described in the aforementioned startup file, may be recorded as one file on disc 1, or may be recorded as one file on server 500. When the loading information is recorded on disc 1 or server 500, the recording location and file name are described in the startup file. The loading information is loaded by interactive engine (INT_ENG) 200 in accordance with this description, and is parsed by parser 210 (block ST18). Interpreter unit 205 interprets the parsed loading information, and buffer manager 204 loads the advanced content onto buffer 209 (block ST20).

The loading information describes the file name and location (a place where a file exists), file size, content type or MIME type (the type of data), reference start and end times (data reference duration), and the like of each file to be downloaded.

Buffer manager 204 loads advanced content with the reference start time=“0” (i.e., files that has to be stored in the buffer before the beginning of display of the advanced content/the beginning of playback of the DVD-Video content) in accordance with this description (block ST22). At this time, files to be loaded are loaded from disc 1 or server unit 500 in accordance with the description order of the loading information. In this case, for example, the loading information designates advanced content (INDEX.XML file and its related files) that form the first page as those to be “preloaded”.

After all advanced content to be “preloaded” are loaded onto buffer 209 (YES in block ST24), buffer 209 sends a “preload end trigger” signal to buffer manager 204 (block ST26). Upon reception of the “preload end trigger” signal from buffer 209, buffer manager 204 sends a “preload end trigger” signal to interface handler 202. Upon reception of the “preload end trigger” signal from buffer manager 204, interface handler 202 sends a “preload end event” signal as an event to interpreter unit 205.

Interpreter unit 205 has registered the operation upon generation of the “preload end event”, as described above, and executes the registered operation (block ST28). For example, as the operation, execution of loading of INDEX.XML which has been loaded onto buffer 209 and forms the first page is registered. Also, INDEX.XML designates start of playback of DVD-Video content. In this manner, upon completion of preloading of the advanced content (upon generation of the “preload end event”), display of the advanced content/playback of the DVD-Video content starts.

In order to quicken this playback start time, only advanced content which form the first page may be designated as those to be “preloaded”. However, since advanced content other than the first page are not stored in buffer 209 at the beginning of playback, user operations such as fastforwarding, skip, time search, and the like are to be inhibited.

While display of the advanced content/playback of the DVD-Video content is performed, buffer manager 204 loads remaining advanced content (files to be stored in the buffer after the beginning of display of the advanced content/the beginning of playback of the DVD-Video content) in accordance with the description of the loading information (block ST30). At this time, the playback apparatus determines the loading start times and order of all advanced content using the reference start times, reference end times, and file sizes which are described in the loading information, and information associated with a communication rate acquired by the playback apparatus (e.g., using a value given by priority=reference start time−file size/communication rate).

For example, the loading information describes that a “preload end trigger” is generated upon completion of loading of advanced content that form the first page, and a “load end trigger” is generated upon completion of loading of advanced content which form the second page.

If advanced content which form the second page are loaded onto buffer 209 (YES in block ST32), buffer 209 sends a “load end trigger” signal to buffer manager 204. Upon reception of the “load end trigger” signal from buffer 209, buffer manager 204 sends a “load end trigger” signal to interface handler 202. Upon reception of the “load end trigger” signal from buffer manager 204 (block ST34), interface handler 202 sends a “load end event” signal as an event to interpreter unit 205.

Interpreter unit 205 has registered the operation upon generation of the “load end event”, as described above, and executes the registered operation (block ST36). For example, when user operations such as fastforwarding, skip, time search, and the like are inhibited, the operation for permitting the inhibited user operations is registered. That is, since all advanced content are stored in buffer 209, the user operations need not be inhibited.

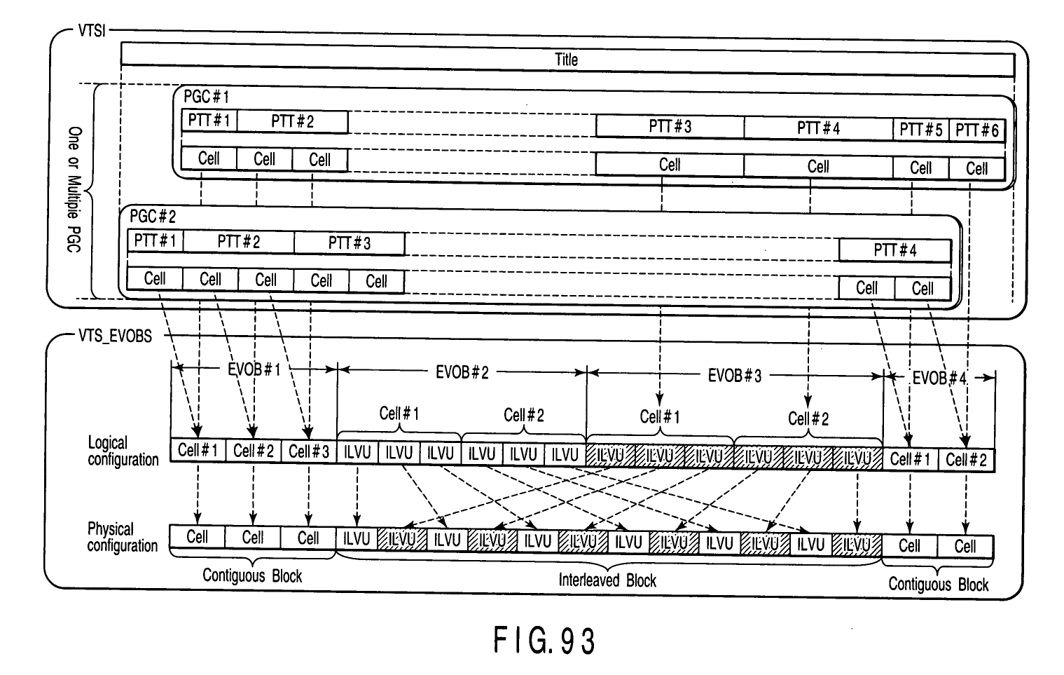

FIG. 93 is a view for explaining the configuration of an advanced VTS (AHDVTS) which exceptionally has multiple PGCs. A VTS_EVOBS of the advanced VTS in FIG. 93 includes one interleaved block. This interleaved block is used to implement playback of the director's cut version and theatrical release version, as shown in, e.g., FIG. 69. In many cases, EVOBs in the interleaved block of such VTS_EVOBS have different playback time durations. In case of such advanced VTS, VTSI may manage information associated with video playback in a plurality of PGCs.

A playback sequence is defined by the cell playback information table (C_PBIT; 53 in FIG. 56) stored in a PGC. The cell position information table (C_POSIT; 54 in FIG. 56) associates cells used in playback and actual cells using EVOB numbers (EVOB#1, etc.) and cell numbers (Cell#1 to Cell#3, etc.) in the VTS_EVOBS. Furthermore, of the cells in the VTS_EVOBS, cells that form the interleaved block are segmented for respective interleaved units (ILVUs), and are allocated at separate positions in the interleaved block on the HD_DVD disc.

In the example of FIG. 93, the cell playback information table is configured as follows. That is, for example, PGC#1 as the director's cut version plays back a contiguous block formed by EVOB#1, then plays back EVOB#3 formed by an interleaved block, and finally plays back a contiguous block formed by EVOB#4 all in the VTS_EVOBS. For example, PGC#2 as the theatrical release version plays back a contiguous block formed by EVOB#1, then plays back EVOB#2 formed by an interleaved block, and finally plays back a contiguous block formed by EVOB#4 all in the VTS_EVOBS.

In this manner, upon describing the playback sequences of the director's cut version and theatrical release version, respective cells (EVOBs) in the interleaved block period have different playback time durations. In such case, the playback sequences are defined by dividing PGCs, as in the example of FIG. 93. In this way, accesses to playback positions in time units can be easily managed.

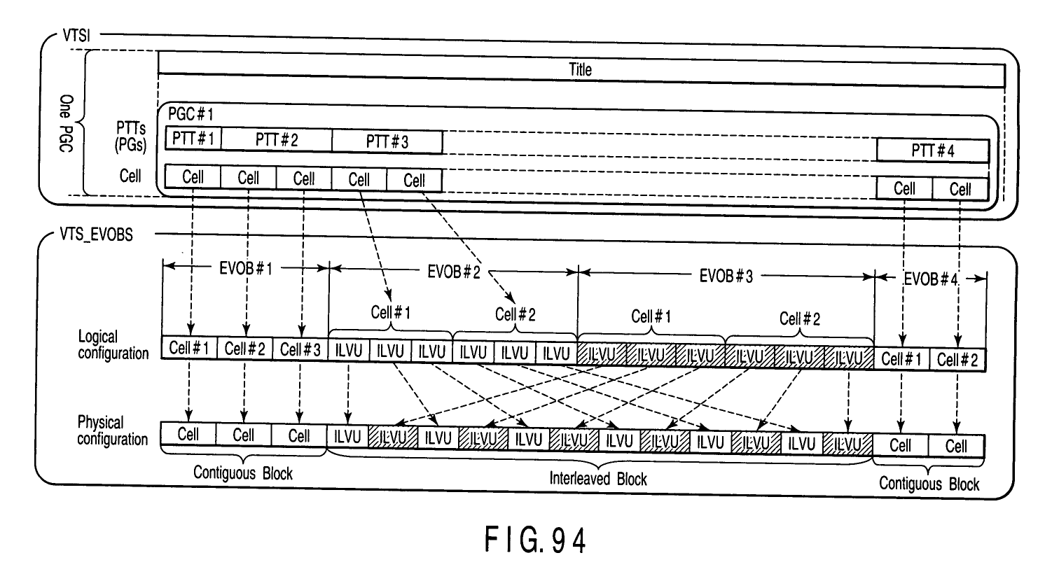

FIG. 94 is a view for explaining the configuration of an advanced VTS (AHDVTS) which includes an interleaved block but has one PGC. This example is convenient, e.g., when the interleaved block forms an angle block.

In the example of FIG. 94, the cell playback information table is configured as follows. That is, a playback sequence defined by PGC#1 plays back a contiguous block formed by EVOB#1, then plays back EVOB#2 formed by an interleaved block, and finally plays back a contiguous block formed by EVOB#4 all in the VTS_EVOBS.

In this case, it appears that no sequence for playing back EVOB#3 that forms another angle is defined. However, in practice, in the angle block, EVOBs which form respective angles, and their cells and ILVU boundaries have equal playback times, and the same multiplexed audio data is used. Hence, angles are configured to be seamlessly switched in ILVU boundary units. Therefore, a parameter that indicates the current playback angle is defined, and the angle can be switched based on the value of this parameter.

To summarize the above description, when the playback sequence of the interleaved block that forms the angle block is to be defined, the playback time is uniquely defined by the cell playback information table given by one PGC, and cells to be actually played back of a VTS_EVOBS can be specified in combination with the aforementioned parameter indicating the playback angle.

In the embodiment of the invention, using playback control information which is stored in the ADV_OBJ in FIG. 2 and is described using the markup/script language, playback of identical DVD content can be flexibly configured. That is, using the description of the aforementioned playback sequence information file (PBSEQ001.XML in FIG. 2, etc.), a function of freely configuring the playback order of a DVD video picture stored in a VTS_EVOBS in predetermined units (independently of PGC information and navigation information in navigation packs which are originally recorded on disc 1) can be implemented.

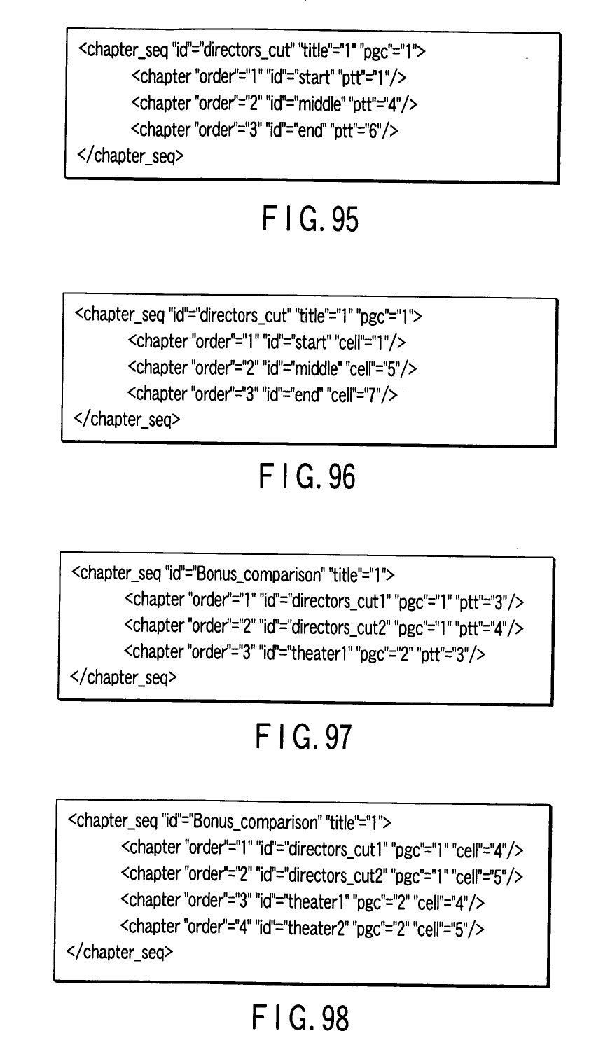

FIG. 95 shows a description example of a playback sequence in the playback sequence information file. Assume that the configuration in FIG. 93 is newly defined using the description of the above playback sequence information file (PBSEQ001.XML in FIG. 2, etc.). In the first line of the description in FIG. 95, “directors_cut” is defined as a name for uniquely defining the playback sequence, and it is defined that this playback sequence is described based on PGC information of PGC#1 and title#1.

In the second to fourth lines of the description in FIG. 95, three chapters (PTT numbers) that form the playback sequence of “directors_cut” are defined, and names that uniquely define these chapters are defined using an attribute “id”. The playback order of the chapters (PTT numbers) is defined using attribute information “order”, and associations between these chapters and those in PGC#1 in FIG. 93 are defined using an attribute “pgc” (in this example, the playback order is described in three entries, e.g., chapter “order” “1”, “2”, and “3”).

The definition of the playback sequence using the markup language description in the aforementioned playback sequence information file is convenient for a case wherein “an advanced VTS is defined as DVD video picture materials divided into respective chapters (PTTs), which are re-defined in correspondence with use purposes like a playback sequence used in a menu screen, that used in title playback, and that used in bonus content”. Since this playback sequence is defined using the markup language, it can be easily edited later. For example, such playback sequence can be applied to, e.g., a case wherein a different sequence is to be defined later using movie content (divided into a plurality of chapters) already printed on a DVD-Video disc as a material (reordering of the playback order of a plurality of chapters including repetitive playback of a specific chapter and/or playback skip of a specific chapter).

FIG. 96 shows an example in which the same playback sequence as that in FIG. 95 is described using cell units with respect to the advanced VTS shown in FIG. 71. When each of the chapters (PTT numbers) shown in FIG. 95 corresponds to one cell, the playback sequence is configured by three entries (chapter “order”=“1”, “2”, and “3”) as in FIG. 95.

FIG. 97 shows an example of the playback sequence upon expressing a playback sequence across a plurality of PGCs. For example, the playback sequence in FIG. 97 is configured to continuously play back different video parts of the director's cut version and theatrical release version, which are formed by the interleaved block. Such configuration is effective to create content that give an explanation about the difference between the director's cut version and theatrical release version in DVD bonus content or the like.

As the differences of the markup language used to describe the playback sequences, in the examples shown in FIGS. 95 and 96, the first line describes the PGC number that uniquely designates the chapters (PTT numbers) or cell numbers, while in the example of FIG. 97, the markup description that designates the chapter number includes the PGC number. With such description, one playback sequence can be configured across a plurality of PGCs (across PGC#1 and PGC#2 in this example).

FIG. 98 shows an example in which the same playback sequence as that in FIG. 97 is described using cell units with respect to the advanced VTS shown in FIG. 93. Since PTT=3 (PTT#3) of PGC number=2 (PGC#2) are configured by two cells (corresponding to cell#1 and cell#2 of EVOB#2 in the example of FIG. 93), the number of cell entries used to express the same playback sequence is increased to two (“cell”=“4” of chapter “order”=“3” and “cell”=“5” of chapter “order”=“4” in the example of FIG. 98).

Since the description method in the aforementioned playback sequence information file (PBSEQ001.XML in FIG. 2, etc.) allows flexible definitions, a more complicated, detailed playback sequence can be described using a definition different from the above example. By defining the playback sequences as exemplified above, the flow of playback of the advanced VTS stored in a DVD disc can be flexibly changed (after distribution of the disc). For example, after a given DVD disc was released, a movie company contrives a new method of enjoying the DVD video picture, and delivers a new playback sequence via the Internet. Then, users enjoy playback of the DVD video picture using the new playback sequence.

Likewise, the use method that allows the user to edit an arbitrary playback sequence by himself or herself and to enjoy video picture playback by joining his or her favorite scenes can be provided (in this case, information obtained by editing the playback sequence by the user himself or herself can be saved in, e.g., persistent storage 216 in FIG. 72 or 100).

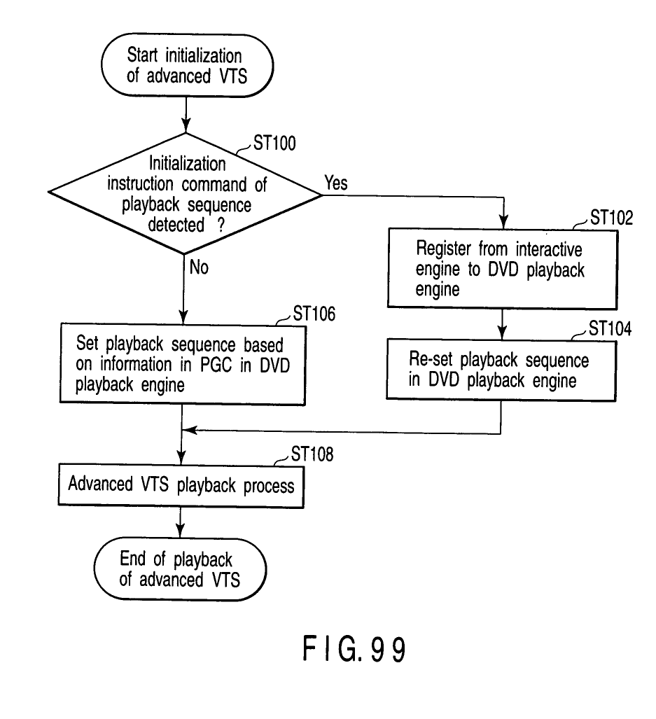

FIG. 99 is a flowchart showing an example of the processing for initializing the playback sequence of the advanced VTS (e.g., for re-setting the settings based on the default playback sequence to those of another playback sequence described in the playback sequence information file) in DVD playback engine 100 in, e.g., FIG. 72 or 100 using the playback sequence information file (PBSEQ001.XML in FIG. 2, etc.) prior to playback of the advanced VTS.

Upon starting playback of the advanced VTS, interactive engine 200 begins to initialize the DVD-Video player (definition of a playback sequence of objects to be played back) in accordance with a predetermined procedure described in, e.g., startup information recording area 210A in FIG. 50.

If it is determined in a condition determination part in block ST100 that the described initialization procedure describes a playback sequence setting command of the advanced VTS based on playback sequence information (YES in block ST100), interactive engine 200 registers playback sequence information (e.g., the description of PBSEQ001.XML in FIG. 2) in DVD playback engine 100 (block ST102). DVD playback engine 100 re-sets (block ST104) the playback sequence of the advanced VTS in accordance with the playback sequence information registered by interactive engine 200 in block ST102.

If it is determined in a condition determination part in block ST100 that no playback sequence setting command of the advanced VTS based on playback sequence information is described (NO in block ST100), DVD playback engine 100 determines a playback sequence in accordance with cell playback information (C_PBIT) in program chain information (PGCI) recorded in the advanced VTS (block ST106).

DVD playback engine 100 controls (block ST108) playback of the advanced VTS in accordance with the playback sequence set based on the cell playback information (C_PBIT) in block ST106, or controls (block ST108) playback of the advanced VTS in accordance with a playback command from interactive engine 200 on the basis of the playback sequence set based on the description of the playback sequence information file or the like in block ST104. After execution of playback using all advanced VTSs, the playback process ends.

In other words, FIG. 99 executes the following processing. That is, it is checked if a playback sequence definition based on playback sequence information (playback sequence information acquired from, e.g., the Internet if it is not stored in the playback sequence information recording area) is available (ST100). If no playback sequence definition based on playback sequence information is available (NO in block ST100), expanded video objects (EVOBs) are played back (ST108) on the basis of management information (PGCI) in the management area (ST106); if the playback sequence definition based on playback sequence information is available (YES in block ST100; initialize the playback sequence), expanded video objects are played back (ST108) on the basis of the playback sequence information (ST102 to ST104).

Alternatively, the processing in FIG. 99 is executed as follows. It is checked if a playback sequence definition based on playback sequence information is available (ST100). If the playback sequence definition based on playback sequence information is available (YES in block ST100; initialize the playback sequence), expanded video objects are played back (ST108) on the basis of at least one of a sequence of the program chain numbers, a sequence of the cell numbers, and a sequence of the chapter numbers, which are defined by the playback sequence information (ST102 to ST104).

FIG. 100 is a system block diagram for explaining an example of the internal structure of a playback apparatus (advanced VTS compatible DVD-Video player: another example of the apparatus shown in FIG. 72) according to another embodiment of the invention. This DVD-Video player plays back and processes the recording content (DVD-Video content and/or advanced content) from information storage medium 1 (which records the VTSI and VTS_EVOBS shown in, e.g., FIGS. 93, 94, and the like) shown in FIGS. 1, 50, 73, 74, 79, and the like, and downloads and processes advanced content from a communication line (e.g., the Internet/home network or the like).

In the system arrangement of the embodiment shown in FIG. 100, interactive engine 200 comprises parser 210, advanced object manager 610, data cache 620, streaming manger 710, event handler 630, system clock 214, interpreter unit 205 including a layout engine, style engine, script engine, and timing engine, media decoder unit 208 including moving picture/animation, still picture, text/font, and sound decoders, graphics superposing unit 750, secondary picture/streaming playback controller 720, video decoder 730, audio decoder 740, and the like.

On the other hand, DVD playback engine 100 comprises DVD playback controller 102, DVD decoder unit 101 including an audio decoder, main picture decoder, sub-picture decoder, and the like, and so forth.

The DVD-Video player comprises, as functional modules to be provided to interactive engine 200 and DVD playback engine 100, persistent storage 216, DVD disc 1, file system 600, network manager 212, demultiplexer 700, video mixer 760, audio mixer 770, and the like. Also, as modules which are the functions of the DVD-Video player and are mainly used by interactive engine 200 to perform information acquisition and operation control via system manager 800, the player comprises an NIC, disc drive controller, memory controller, FLASH memory controller, remote controller, keyboard, timer, cursor, and the like.

The recording locations and formats of advanced content other than DVD-Video data to be handled by interactive engine 200 may be as follows (note that a disc described as a DVD disc includes not only a normal DVD-Video disc but also a next-generation HD_DVD disc or the like).

File format data on the DVD disc;

Multiplexed divided data in an EVOB on the DVD disc;

File format data in the persistent storage of the DVD-Video player;

File format data or streaming data on a network server on the Internet/home network.

“File format data on the DVD disc” of “1.” is stored in advanced content recording area 21 in FIG. 79. Interactive engine 200 loads an advanced content file on the DVD disc via the file system.

“Multiplexed divided data in an EVOB on the DVD disc” of “2.” has a data format which is multiplexed and recorded in a VTS_EVOBS recorded in advanced HD video title set recording area (AHDVTS) 50 in FIG. 79. As the multiplexed data, data redundant to “file format data on the DVD disc” of “1.” are recorded. Such data is loaded to demultiplexer 700 in correspondence with loading of the VTS_EVOBS, and if the demultiplexed data are divided data of advanced content, they are sent to advanced object manager 610.

Advanced object manager 610 temporarily stores the divided data of the advanced content received from demultiplexer 700, and stores them as file format data of the advanced content in data cache 620 at the reception timing of data that can form one file.

As multiplexed advanced content data in an EVOB on the DVD disc, file data obtained by compressing one or a plurality of advanced content files in accordance with a predetermined method may be divisionally stored, so as to improve the efficiency of data upon multiplexing. In this case, advanced object manager 610 temporarily stores divided data until the compressed data can be decompressed, and stores decompressed advanced content data in data cache 620 at a timing at which the advanced content data can be handled as a file format.

“File format data in persistent storage 216 of the DVD-Video player” of “3.” corresponds to, e.g., introduction movie data of a new film or the like which is downloaded from the Internet and is stored at a predetermined position on persistent storage 216 while interactive engine 200 is playing back a DVD title including advanced content created by a given movie company.

For example, when a DVD title including other advanced content created by that movie company is played back, the following use method may be adopted. That is, “interactive engine 200 searches the predetermined position on persistent storage 216 in accordance with the description of the markup/script language of advanced content. If interactive engine 200 finds the saved introduction movie data of the new film there, it jumps to an XML page used to refer to/play back that data. If the playback process is selected by a user operation, interactive engine 200 plays back the introduction movie data of the new film stored in persistent storage 216.”

An example of file format data of “file format data or streaming data on a network server on the Internet/home network” of “4.” corresponds to the aforementioned introduction movie data of the new film or the like. As an example of streaming data, the following use method may be adopted. That is, “when DVD-Video data of a movie on a DVD disc includes only Japanese and English audio data, a movie company creates Chinese audio data, and a DVD-Video player connected to the Internet plays back the Chinese audio data in synchronism with video picture data on the DVD disc while sequentially downloading it.”

In the system block diagram of FIG. 100, file system 600, parser 210, interpreter unit 205, media decoder unit 208, data cache 620, network manager 212, streaming manager 710, graphics superposing unit 750, secondary picture/streaming playback controller 720, video decoder 730, audio decoder 740, demultiplexer 700, DVD playback controller 102, DVD decoder unit 101, and the like can be implemented by a microcomputer and/or hardware logic which implement/implements respective module functions by parsing built-in programs (firmware; not shown). A work area (including a temporary buffer used in a decoding process) used upon executing this firmware can be assured using a semiconductor memory (not shown) (and a hard disc device as needed) of each module. Furthermore, the system includes communication means for control signals (not shown) between respective modules so as to attain data supply and a synchronization process, and operation control between used modules can be managed. The communication means include signal lines of the hardware logic, event/data notification processes between software programs, and the like.

The behaviors for respective functions of the DVD-Video player will be described below using the system block diagram of FIG. 100. The DVD-Video player, configured to play back an advanced content, implements richly expressive menus and/or more interactive playback control, which are difficult to attain by the conventional DVD, using an XML file and/or a style sheet described using the markup/script language or the like. An example in which a menu page including a button selection that outputs an animation effect or effect sound upon selection of the user is to be configured will be examined.

The configuration and functions of the menu page are defined by a menu XML page described using the markup/script language. The menu XML page is stored in a DVD disc, and interpreter unit 205 passes the content of the menu XML page parsed by parser 210 to the layout engine, style engine, script engine, timing engine, and the like in accordance with their description content.

The timing engine receives time events from system clock 214 at predetermined intervals, and instructs processing instructions to the layout engine, style engine, and script engine on the basis of the description of the menu XML page arranged in the timing engine. These engines refer to configuration information of the menu XML page managed by them, and they issue decode process instructions to media decoder unit 208 as needed.

Media decoder unit 208 loads media data from the advanced object save area such as data cache 620 or the like as needed in accordance with instructions from interpreter unit 205, and executes decode processes.

Of data decoded by media decoder unit 208, moving picture/animation, still picture, and text/font output results associated with graphics display are sent to graphics superposing unit 750, which generates frame data of a graphics plane to be output in accordance with the descriptions of the layout and style sheet of interpreter unit 205, and outputs it to video mixer 760.

Video mixer 760 mixes the output frame of graphics superposing unit 750, an output frame of the video decoder which is output in accordance with an instruction from secondary picture/streaming playback controller 720, output frames of the main picture decoder and sub-picture decoders in DVD decoder unit 101 which are output in accordance with an instruction from DVD playback controller 102, an output frame of the cursor function of the DVD-Video player, and the like in accordance with a predetermined superposing rule while synchronizing these output frames. Video mixer 760 converts the mixed output frame data into a television output signal, and outputs it onto a video output signal line.

The behavior of the secondary picture/streaming playback controller 720 which is output in synchronism with the output frame of the graphics frame will be described below. As a main storage destination of secondary picture data, a DVD disc and streaming server on the Internet or home network are assumed.

Upon playback of secondary picture data stored on the DVD disc, IFO/VOBS (including an EVOBS) data is loaded from the DVD disc to demultiplexer 700. Demultiplexer 700 identifies various types of multiplexed data, and demultiplexes and sends data associated with main picture playback control to DVD playback controller 102, data associated with main picture, sub-picture, and audio of the DVD-Video to DVD decoder unit 101, and data associated with secondary picture playback control to secondary picture/streaming playback controller 720. If advanced object data are multiplexed and stored in this data, these data are sent to advanced object manager 610.

Secondary picture/streaming playback controller 720 executes playback control of secondary picture data on the DVD disc on the basis of a playback control signal from interpreter unit 205. For example, when interpreter unit 205 instructs not to execute playback of stored secondary picture data, all data are discarded here. When a playback instruction is issued, secondary picture/streaming playback controller 720 outputs data shaped to a format and data size suited to decode processes to video decoder 730 and audio decoder 740. Video decoder 730 and audio decoder 740 execute decode processes while synchronizing their output timings with the output from DVD decoder unit 101, in accordance with an instruction from secondary picture/streaming playback controller 720.

Control signals instructed by secondary picture/streaming playback controller 720 include instructions of the video position, the degree of scaling, that of a transparency process, a chroma color process, and the like to video decoder 730, and a volume control instruction, channel mixing instruction, and the like to audio decoder 740.

When the user designates fastforwarding, jump, or the like via a remote controller or the like, event handler 630 acquires an event from the remote controller, and notifies the script engine of interpreter unit 205 of that event. The script engine runs in accordance with the markup/script description of an XML file used to execute playback control, and confirms the presence/absence of an event handler of the remote controller process. If the XML file used to execute the playback control defines an explicit behavior, the script engine executes a process according to the description; if nothing is defined, it executes a predetermined process.

When fastforwarding is to be executed as a result of the user's remote controller process, interpreter unit 205 instructs DVD playback controller 102 and secondary picture/streaming playback controller 720 to execute fastforwarding. DVD playback controller 102 re-configures a read schedule of VOBS data to change a data read process from the DVD disc in accordance with the fastforwarding instruction from interpreter unit 205. In this way, control is made to supply data to fastforwarding playback of DVD playback controller 102 and DVD decoder unit 101 without causing any underflow. Since data to be supplied to secondary picture/streaming playback controller 720 are stored in correspondence with the main picture data allocation, secondary picture data suited to fastforwarding playback are supplied from demultiplexer 700 in synchronism with the data read process for fastforwarding executed by DVD playback controller 102.

Upon playing back stream data based on the secondary picture/streaming playback control, secondary picture/streaming playback controller 720 instructs streaming manager 710 to read streaming data on a predetermined network server and to supply the read data to itself on the basis of a playback control signal from interpreter unit 205.

Streaming manager 710 may request network manager 212 to execute a protocol control process of actual streaming data reception, and may acquire data from the network server. At this time, for example, when the bit rate of the streaming data is high, look-ahead cashing of streaming data is made using a streaming buffer area on data cache 620 which is set in advance based on startup information, thus making control for broadening, e.g., an allowance of reception bit rate variations of streaming data.

In this case, streaming manager 710 temporarily stores streaming data from the network server in the streaming buffer on data cache 620, and supplies data stored in the streaming buffer on data cache 620 in response to a streaming data read request from secondary picture/streaming playback controller 720. When no streaming buffer is assured on data cache 620, streaming manager 710 sequentially outputs streaming data acquired from the network server to secondary picture/streaming playback controller 720.

When secondary picture/streaming playback controller 720 performs playback control of streaming data on the network, it need not always perform playback in synchronism with video picture playback of DVD playback engine 100. For this reason, secondary picture/streaming playback controller 720 need not play back any streaming data even when DVD playback engine 100 does not perform any video picture playback, or it need not synchronize the playback state of streaming data with that (e.g., a special playback state such as a fastforwarding state or pause state) of DVD playback engine 100.

Upon executing the playback process of streaming data read from a streaming server on the network, data supply underflow is likely to occur. In this case, a priority process can be designated in the description of the markup/script language of advanced content to flexibly define behaviors as follows. For example, the playback process of DVD playback engine 100 is preferentially executed, and DVD-Video playback is continued even when streaming data is interrupted. Alternatively, playback of streaming data is preferentially executed, and DVD-Video playback is interrupted when streaming data is interrupted. Data to be played back by secondary picture/streaming playback controller 720 may be video data alone or audio data alone.

An example of the functions of respective modules which form the system block diagram of FIG. 100 will be explained below.

Persistent Storage 216:

It stores generated file data, file data downloaded from the Internet/home network, and the like in accordance with an instruction from interpreter unit 205. Data stored in persistent storage 216 are held even when the ON/OFF event of the power switch of the DVD-Video player occurs. Interpreter unit 205 can erase data in persistent storage 216.

DVD Disc 1:

It stores advanced content and DVD-Video data. Sector data on the DVD disc are read in accordance with read requests from the file system and demultiplexer.

File System 600:

It manages the file system for respective recording modules/devices, and provides a file access function to file data read/write requests from the advanced object manager and the like. As an example of the file system for respective recording modules/devices, when persistent storage 216 comprises a FLASH memory, a file system for the FLASH memory is used to control to average memory rewrite accesses. DVD disc 1 is accessed using a UDF or ISO9660 file system. As for files on the network, network manager 212 executes actual protocol control such as HTTP, TCP/IP, and the like, and the file system itself relays the file access function to network manager 212. The file system manages data cache 620 as, e.g., a RAM disc.

Network Manager 212:

It provides a read (write as needed) function of file data provided on an HTTP server on the network to the file system. It also executes actual protocol control in accordance with a sequential read request of stream data from streaming manager 710, acquires the requested data from the streaming server on the network, and passes the acquired data to streaming manager 710.

Demultiplexer 700:

It reads data on the DVD disc in accordance with a read instruction of sector data that store IFO/VOBS data from DVD playback controller 102 (and the secondary picture/streaming playback controller when secondary picture data alone is played back). As for multiplexed data of the read data, demultiplexer 700 supplies demultiplexed data to appropriate processing units. Demultiplexer 700 supplies IFO data to the DVD playback controller and secondary picture/streaming playback controller 720. Demultiplexer 700 outputs main picture/sub-picture/audio data associated with DVD-Video stored in a VOBS to DVD decoder unit 101, and control information (NV_PCK) to DVD playback controller 102. Demultiplexer 700 outputs control information and picture/audio data associated with secondary picture data to secondary picture/streaming playback controller 720. When advanced objects are multiplexed in a VOBS, these data are output to advanced object manager 610.

Parser 210:

It parses the markup language described in an XML file and outputs the parsed result to interpreter unit 205.

Advanced Object Manager 610:

It manages an advanced object file to be handled by interactive engine 200. Upon reception of an access request to an advanced object file from parser 210, interpreter unit 205, media decoder unit 208, and the like, advanced object manager 610 confirms the storage state of file data on data cache 620 managed by manager 610. If the requested file data is stored in data cache 620, advanced object manager 610 reads data from data cache 620, and outputs the file data to a module that issued the read request. If the requested data is not stored in data cache 620, advanced object manager 610 reads file data from the DVD disc, a network server on the Internet/home network, or the like, which stores corresponding data, onto data cache 620, and simultaneously outputs the file data to a module that issued the read request. As for data stored in persistent storage 216, advanced object manager 610 does not normally execute any cache process to data cache 620.

As another principal function of advanced object manager 610, when multiplexed advanced object data is stored in VOBS data loaded by demultiplexer 700, advanced object manager 610 temporarily stores these data output from demultiplexer 700, and stores them in data cache 620 at a timing at which they can be stored as file data. When an advanced object file is stored in VOBS data in a format that compresses one or a plurality of files together, advanced object manager 610 temporarily stores divided data to a size that allows decompression, and then decompresses and stores data in data cache 620 as file data.

Advanced object manager 610 stores advanced object data in data cache 620, and timely deletes a file, which becomes unnecessary in playback of the advanced content of interactive engine 200, from data cache 620, in accordance with an instruction from interpreter unit 205 or a predetermined rule. With this delete process, the data cache area having a limited size can be effectively used in accordance with the progress of playback of the advanced content.

Interpreter Unit 205:

This is a module for controlling the behavior of entire interactive engine 200. It initializes data cache 620 and DVD playback controller 102 in accordance with startup information, loading information, or playback sequence information parsed by parser 210. In the playback process of the advanced content, interpreter unit 205 passes layout information, style information, script information, and timing information parsed by parser 210 to respective processing modules, sends control signals to media decoder unit 208, secondary picture/streaming playback controller 720, DVD playback controller 102, and the like in accordance with their descriptions, and executes playback control among modules.

Layout Engine:

The layout engine (one of internal components of interpreter unit 205) handles information associated with objects used in graphics output of the advanced content. It manages definitions, attribute information, and layout information on the screen of moving picture/animation, still picture, text/font, sound objects, and the like, and also manages association information with style information about modifications upon rendering.

Style Engine:

The style engine (one of internal components of interpreter unit 205) manages information associated with detailed modifications upon rendering of rendering objects managed by the layout engine.

Script Engine:

The script engine (one of internal components of interpreter unit 205) manages descriptions associated with handler processes that pertain to button depression events from a user interface device (U/I device) such as a remote controller or the like and event messages from the system manager. Event handler 630 defines processing content upon occurrence of a corresponding event, and the script engine changes parameters of graphics rendering objects, and control of DVD playback controller 102, secondary picture/streaming playback controller 720, and the like in accordance with its description.

Timing Engine:

The timing engine (one of internal components of interpreter unit 205) controls scheduled processes associated with the behavior of graphics rendering objects and playback of secondary picture/streaming data. The timing engine refers to system clock 214, and when system clock 214 matches the timing of the scheduled control process, the timing engine controls respective modules to execute the playback process of the advanced content.

Media Decoder Unit 208:

It executes the decode process of advanced objects in accordance with a control signal from interpreter unit 205. Media to be handled by media decoder unit 208 include cell animation that successively plays back still images of PNG/JPEG or the like as moving picture data, vector animation that successively renders vector graphics, and the like. Media decoder unit 208 can handle JPEG, PNG, GIF, and the like as still picture data. Upon rendering text data, media decoder unit 208 mainly refers to font data such as vector font (open font) and the like and executes rendering of text data designated by interpreter unit 205. As sound data, those which have relatively short playback times such as PCM, MP3, and the like are assumed. Such sound data is mainly used a sound effect involved in an event such as button clicking or the like. Of the decode results of media decoder unit 208, the outputs associated with graphics are output to graphics superposing unit 750. Also, sound outputs are output to audio mixer 770.

Graphics Superposing Unit 750:

It superposes the outputs of graphics rendering objects output from media decoder unit 208 in accordance with the descriptions of the layout engine and style engine, and generates output image frame data. Most of rendering objects have transparency process information, and graphics superposing unit 750 also executes a transparency calculation process of these objects. The generated output image frame data is output to video mixer 760.

Data Cache 620:

It is mainly used in two use applications. In one use application, data cache 620 is used as a file cache of an advanced object file, and temporarily stores an advanced object file on the DVD disc or network. In the other use application, data cache 620 is used as a buffer of streaming data, and is managed by streaming manager 710. The allocations and sizes of the data cache used as the file cache and streaming buffer may be described in startup information or the like and may be managed for respective advanced content, or the data cache may be used to have predetermined allocations.

Streaming Manager 710:

It manages supply of streaming data between secondary picture/streaming playback controller 720 and network manager 212. When the bit rate of streaming data is relatively small and the streaming buffer need not be used, streaming manager 710 controls network manager 212 to sequentially supply streaming data acquired from a streaming server to secondary picture/streaming playback controller 720.

When the bit rate of streaming data is relatively large, streaming manager 710 can control supply of streaming data using the streaming buffer which is explicitly assured by the provider of advanced content. Streaming manager 710 stores data to be supplied to secondary picture/streaming playback controller 720 in the streaming buffer assured on data cache 620 in accordance with instructions of the streaming buffer size and read-ahead size interpreted by interpreter unit 205. When the data of the instructed read-ahead size is stored in the stream buffer, streaming manager 710 begins to supply streaming data to secondary picture/streaming playback controller 720. At the same time, as soon as a free space of a given size is assured on the streaming buffer, streaming manager 710 issues a data acquisition request to the streaming server, thus efficiently managing the streaming buffer.

Secondary Picture/Streaming Playback Controller 720:

It executes playback control of streaming data supplied from streaming manager 710 and secondary picture data supplied from demultiplexer 700 in accordance with a playback control signal from interpreter unit 205.

Video Decoder 730:

It plays back video picture data supplied from secondary picture/streaming playback controller 720 in accordance with a control signal from secondary picture/streaming playback controller 720. When video picture data is secondary picture data supplied from demultiplexer 700 or when it is instructed to synchronize streaming data with DVD video picture playback, video decoder 730 decodes data to synchronize the output timing of DVD decoder unit 101 with its output timing, and outputs decoded data to video mixer 760.

Video decoder 730 has a chroma color process function for video picture data as its characteristic function. It manages a chroma color area designated by a specific one color or a plurality of colors as a transparent area to form output frame data of video mixer 760.

Audio Decoder 740:

It plays back audio data supplied from secondary picture/streaming playback controller 720 in accordance with a control signal from secondary picture/streaming playback controller 720. When audio data is that of secondary picture data supplied from demultiplexer 700 or when it is instructed to synchronize streaming data with DVD video picture playback, audio decoder 740 decodes data to synchronize the output timing of DVD decoder unit 101 with its output timing, and outputs decoded data to audio mixer 770.

DVD Playback Controller 102:

It acquires playback control data of DVD-Video from demultiplexer 700 on the basis of a playback control signal from interpreter unit 205, and executes playback control of main picture/sub-picture/audio data of DVD decoder unit 101.

DVD Decoder Unit 101:

It comprises an audio decoder, main picture decoder, sub-picture decoder, and the like, and manages decode processes and output processes while synchronizing respective decoder outputs in accordance with a control signal from DVD playback controller 102.

Audio Decoder:

The audio decoder in DVD decoder unit 101 decodes audio data supplied from demultiplexer 700 and outputs the decoded data to audio mixer 770 in accordance with a control signal from DVD playback controller 102.

Main Picture Decoder:

The main picture decoder in DVD decoder unit 101 decodes main picture data supplied from demultiplexer 700 and outputs the decoded data to video mixer 760 in accordance with a control signal from DVD playback controller 102.

Sub-Picture Decoder:

The sub-picture decoder in DVD decoder unit 101 decodes sub-picture data supplied from demultiplexer 700 and outputs the decoded data to video mixer 760 in accordance with a control signal from DVD playback controller 102.

Video Mixer 760:

It receives output frames from graphics superposing unit 750, video decoder 730, the main picture decoder and sub-picture decoder in DVD decoder unit 101, and the cursor module, generates an output frame in accordance with a predetermined superposing rule, and outputs a video output signal. In general, each frame data has transparency information as the whole frame data or at an object or pixel level, and video mixer 760 superposes output frames from respective modules using such transparency information.

Audio Mixer 770:

It receives audio data from media decoder unit 208, audio decoder 740, and the audio decoder in DVD decoder unit 101, and generates and outputs an output audio signal in accordance with a predetermined mixing rule.

System Manager 800:

It can provide an interface for status and control of respective modules in the DVD-Video player. Interpreter unit 205 acquires the status of DVD-Video player or can change the behavior via an application interface (API) or the like provided by the system manager.

Network Connection Controller (NIC):

This is a module that implements a network connection function, and corresponds to an Ethernet controller (Ethernet is the registered trade name) or the like. The NIC provides information such as connection status of a network cable and the like via the system manager.

Disc Drive Controller:

It corresponds to a reading device of a DVD disc, and provides status information such as the presence/absence of a DVD disc on a disc tray, disc type, and the like.

Memory Controller:

It manages the system memory: it provides an area to be used as data cache 620, and executes access management of a work memory used by respective software (firmware) modules.

FLASH Memory Controller:

It provides an area used as persistent storage 216, and executes access management to the FLASH memory that stores execution codes and the like of respective software (firmware) modules.

Remote Controller:

It executes remote control of the DVD-Video player, and generates a button depression event of the user to event handler 630.

Keyboard:

It executes keyboard control of the DVD-Video player, and generates a keyboard depression event of the user to event handler 630.

Timer: It supplies system clocks, and provides a timer function used by the DVD playback tine.

Cursor:

It generates a pointer image of the remote controller or the like, and changes the position of the pointer image upon depression of direction keys and the like.

Interpreter unit 205 in FIG. 100 outputs a playback control signal to DVD playback controller 102. In this playback control signal, a new command is added to the conventional DVD playback control command, thus allowing more flexible playback control. That is, in order to define playback sequence information of an advanced VTS using the aforementioned playback sequence information (which corresponds to the PBSEQ001.XML file in FIG. 2, and is information stored in playback sequence information recording area 215A in FIG. 50, playback sequence information externally fetched via the Internet or the like, or playback sequence information which is generated by the system firmware when the user freely re-arranges chapter icons and is stored in persistent storage 216), a command for initializing using the playback sequence information is to be issued from interactive engine 200 to DVD playback engine 100.

An “InitPBSEQ( ) command” is a command which is newly defined for the aforementioned purpose, and allows interpreter unit 205 to notify DVD playback controller 102 of the playback sequence information of an advanced VTS to be played back and to initialize it. As an argument of the “InitPBSEQ command”, sequence information of the PGC number, PTT numbers, and the like as a basis of the playback sequence is given (see FIGS. 95 to 98). If the advanced VTS includes a plurality of PGCs, the PGC number specifies a PGC to be selected. The PTT numbers can define the order of chapters to be played back with reference to the PGC_PGMAP number in the PGC designated by the PGC number. Since only one advanced VTS is stored on the DVD disc, and includes only one title, they need not be designated.

Note that the playback order can be described using cell units, as described above. In this case, the argument of the “InitPBSEQ command” is sequence information of the PGC number and cell numbers. The cell numbers can define the order of cells to be played back with reference to the C_PBIT number in the PGC designated by the PGC number. If the advanced VTS includes only one PGC, the argument of the PGC number in an “InitPBSEQ function” need not be used.

To summarize, the apparatus in FIG. 100 is configured to include the following elements. That is, the apparatus is configured to comprise a video playback engine (100) which plays back expanded video objects (EVOBs) from an information storage medium (disc 1); and an interactive engine (200) which acquires advanced content as information (e.g., 21A to 21E in FIG. 50) different from the recording content of a video data recording area from the information storage medium or an external server, and outputs an AV output corresponding to at least one of the playback output of the video playback engine and the content of the advanced content in accordance with the description of a markup language. The processing that “outputs an AV output corresponding to at least one of the playback output of the video playback engine and the content of the advanced content in accordance with the description of a markup language” can correspond to ST102 to ST104+ST108 or ST106+ST108 in FIG. 99.

FIG. 101 shows an example of the data structure of an advanced HD video title set program chain information table (AHDVTS_PGCIT) recorded in advanced HD video title set information (AHDVTSI). As shown in FIG. 101, advanced HD video title set program chain information table (AHDVTS_PGCIT) 512 records information of advanced HD video title set PGCI information table (AHDVTS_PGCITI) 512a including information of the number (AHDVTS_PGCI_SRP_Ns) of AHDVTS_PGCI_SRP data and the end address (AHDVTS_PGCIT_EA) of the AHDVTS_PGCIT. In addition, the advanced HD video title set information (AHDVTSI) includes AHDVTS_PGCI search pointers (AHDVTS_PGCI_SRP) 512b and PGC information (AHDVTS_PGCI) 512c as program chain information in correspondence with the number indicated by AHDVTS_PGCI SRP_Ns. Each AHDVTS PGCI search pointer (AHDVTS_PGCI_SRP) 512b includes information of an AHDVTS_PGC category (AHDVTS_PGC_CAT) indicating the type of AHDVTS_PGC, and the start address (AHDVTS_PGCI_SA) of AHDVTS_PGCI. Note that the AHDVTS_PGC category can have the same content as in FIG. 24.

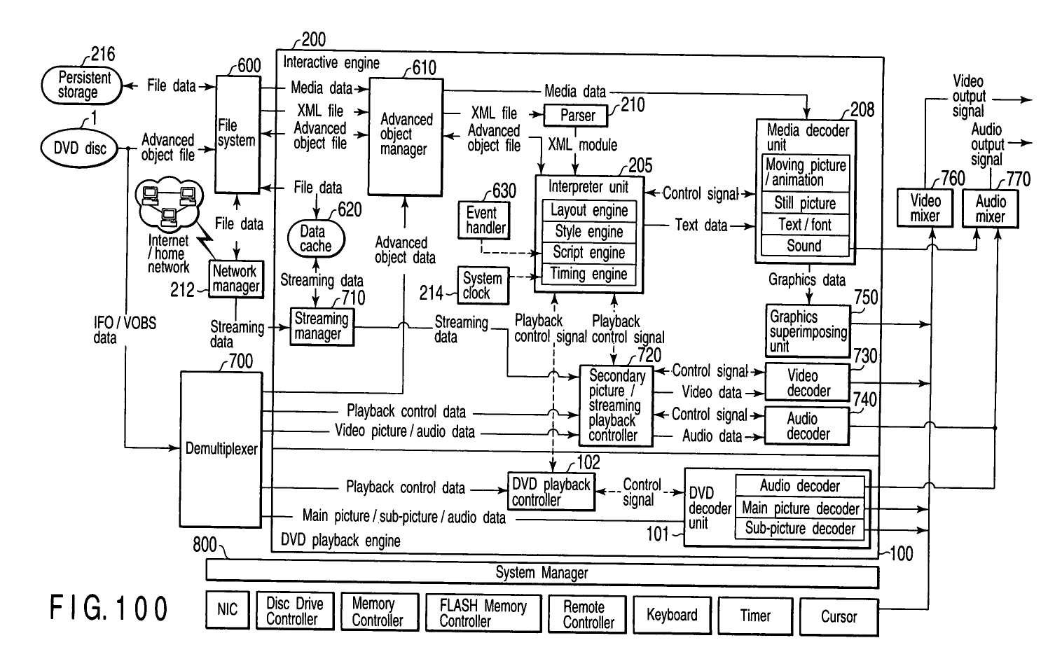

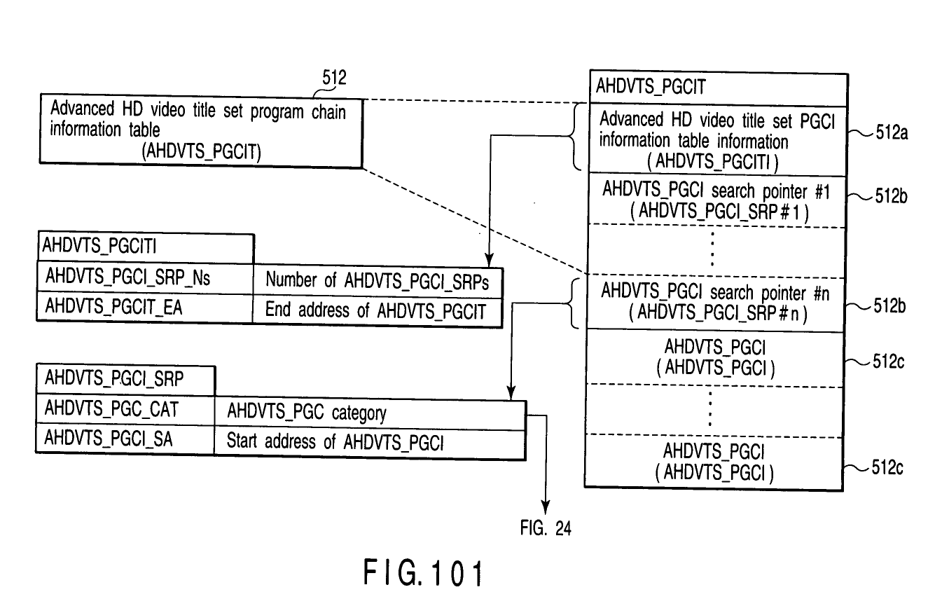

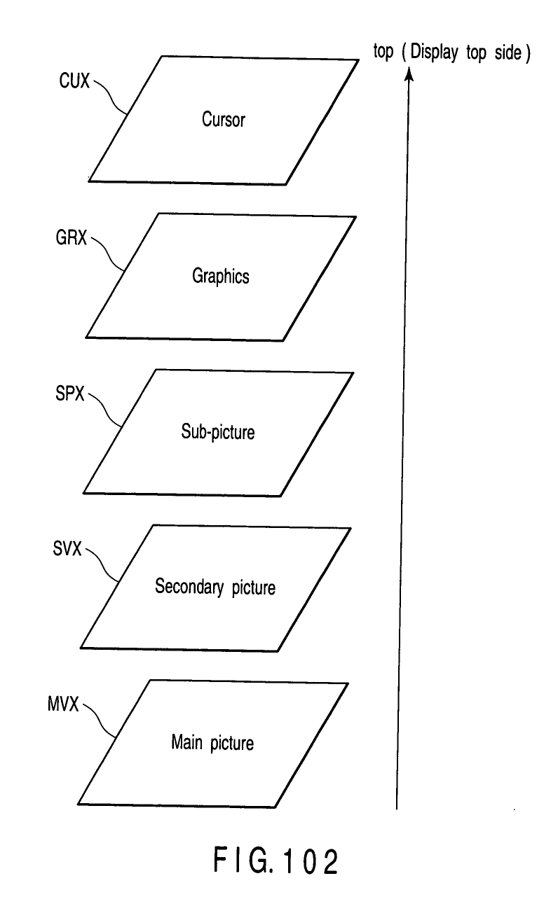

FIG. 102 shows an example of the plane configuration upon superposing the output frames of respective modules in video mixer 760 in FIG. 100. In this example, main picture plane MVX output from the main picture decode in DVD decoder unit 101 is arranged at the lowermost position of the superposed planes. Main picture plane MVX normally does not have transparency information.

Secondary picture plane SVX is arranged on main picture plane MVX. The output of this secondary picture plane SVX includes video picture data of streaming data (in this embodiment, video picture decoding processes of secondary picture and streaming data are exclusive, and these data are never decoded at the same time). Secondary picture plane SVX can have a transparency value of the entire plane as the superposing process with main picture data, and a chroma color process can be applied to a non-transparent pixel region.

This chroma color process may be executed by video decoder 730, and may be implemented in a format including transparency information as output data of video decoder 730. In this case, the transparency information of, e.g., a chroma color region is 0% (full transparency), and the remaining region has a transparency value applied to secondary picture data. The chroma color process may be executed by video mixer 760. In this case, for example, output data from video decoder 730 includes image frame data including a chroma color and chroma color information, and transparency value information for the secondary picture plane. Video mixer 760 applies a transparency process to a region designated by the chroma color to be fully transparent and the remaining region to have an input transparency value on the basis of the input image frame data.

Sub-picture plane SPX arranged on secondary picture plane SVX is the output from the sub-picture decoder in DVD decoder unit 101. On sub-picture plane SPX, a transparency value can be applied to sub-picture rendering objects (text and highlight information).

Graphics plane GRX arranged on sub-picture plane SPX is the output frame of the graphics superposing unit, and a transparency value is applied to this plane at a pixel level. A transparency value of the entire object is generally designated for an advanced object using the markup language. When a rendering object itself can describe a transparency value at a pixel level like PNG data, a transparency value obtained by multiplying that for each pixel of the object itself and that for the entire object becomes the transparency value of the object image at the pixel level. Graphics superposing unit 750 executes superposing and transparency processes of a plurality of rendering objects, and outputs the final color values and transparency values of graphics plane GRX as output data to video mixer 760.

Cursor plane CUX arranged on graphics plane GRX is a plane of a pointer image of the remote controller, mouse, or the like, and is arranged at the uppermost position of all the image planes. In general, cursor plane CUX uses a transparency value for the entire pointer image.

Video mixer 760 executes the superposing process of the output image frames of respective modules in accordance with superposing models defined as described above. Note that the above definition is an example of the superposing rule in video mixer 760, and a different superposing order of planes may be used or another transparency value process may be applied.

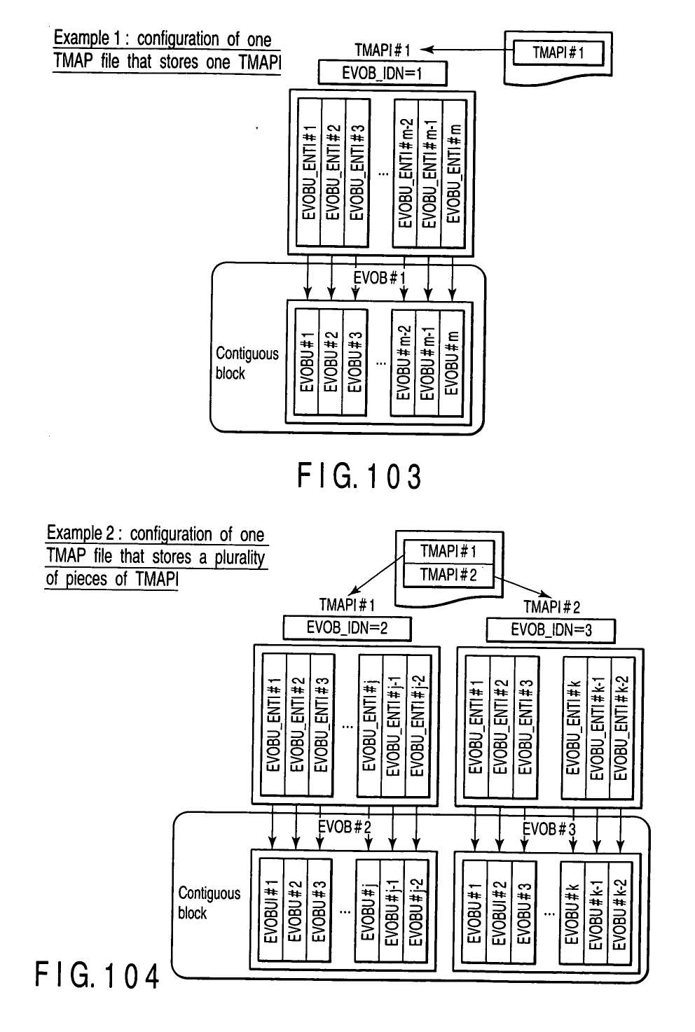

Another embodiment (an example without entry time entry) of time map information (TMAPI) shown in FIGS. 58 to 61 will be described below with reference to FIGS. 103 to 107. FIGS. 103 and 104 show an example of the time map configuration for EVOBs allocated in a contiguous block. FIG. 103 shows example 1 in which one-TMAPI is stored in one TMAP file, and FIG. 104 shows example 2 in which one or more pieces of TMAPI are stored in one TMAP file. As shown in FIGS. 103 and 104, one EVOB corresponds to one TMAPI, and a structure that allows time to each EVOB-to-address conversion using each TMAPI stored in a file is adopted. Each TMAPI includes one or more pieces of EVOBU entry information, and EVOBUs in each EVOB can be accessed using this information.

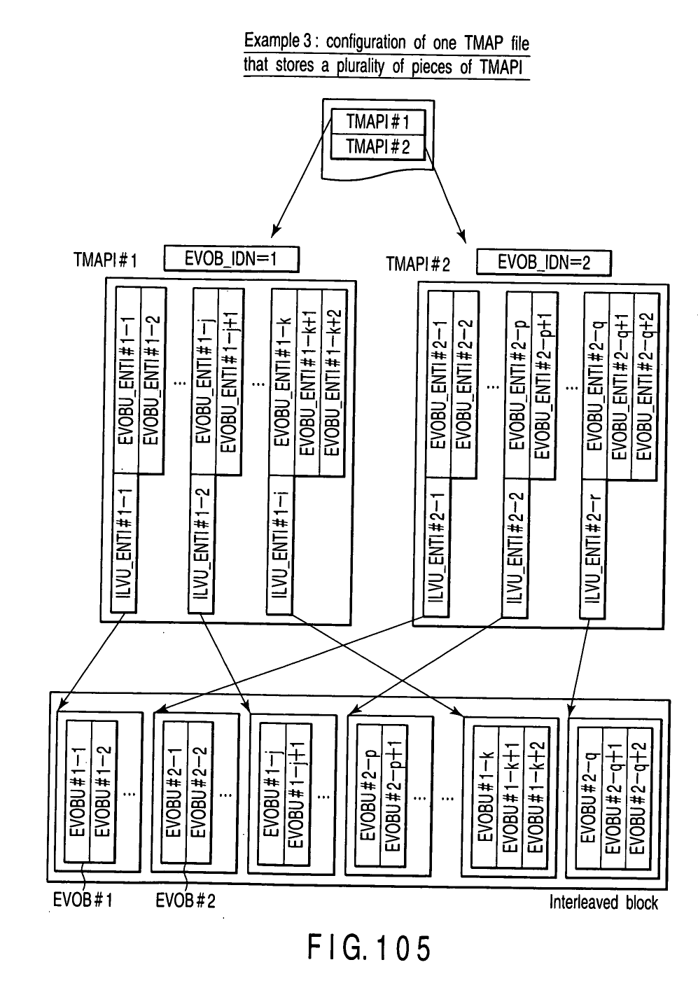

FIG. 105 shows an example of the time map configuration for EVOBs which are allocated in an interleaved block and form angles, so as to allow the user to attain seamless angle switching. As shown in FIG. 105, an EVOB for one angle corresponds to one TMAPI, and a structure that allows time to each EVOB-to-address conversion using each TMAPI stored in the file is adopted as in the EVOB time map allocated in the contiguous block. Each TMAPI includes one or more pieces of EVOBU entry information and one or more pieces of ILVU entry information, and the head of each ILVU in each EVOB and each EVOBU in that ILVU, which are allocated in the interleaved block, can be accessed.

Since each EVOB allocated in the interleaved block is stored in one file, all pieces of time map information used to play back that angle period can be acquired, and files need not be searched for each time, thus improving the processing efficiency.

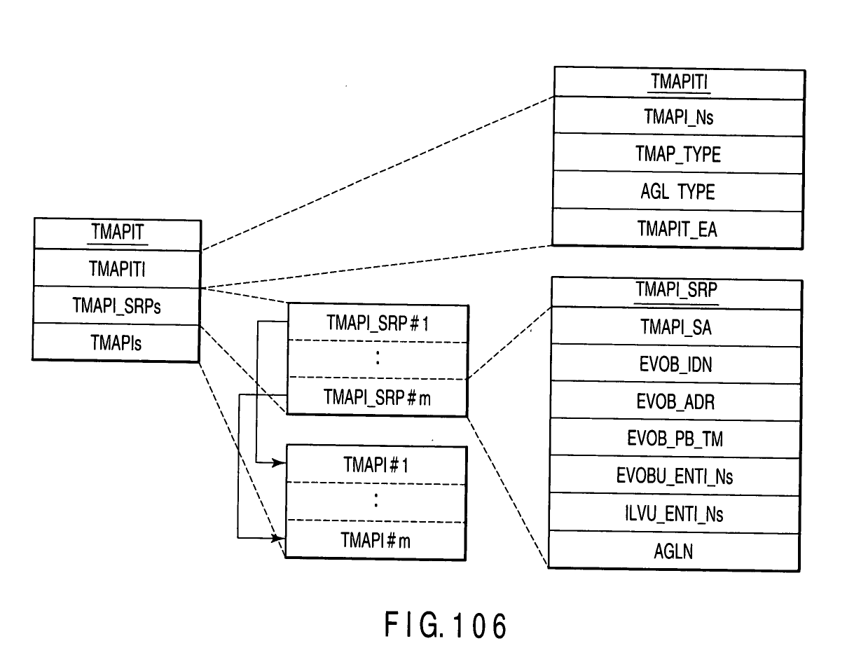

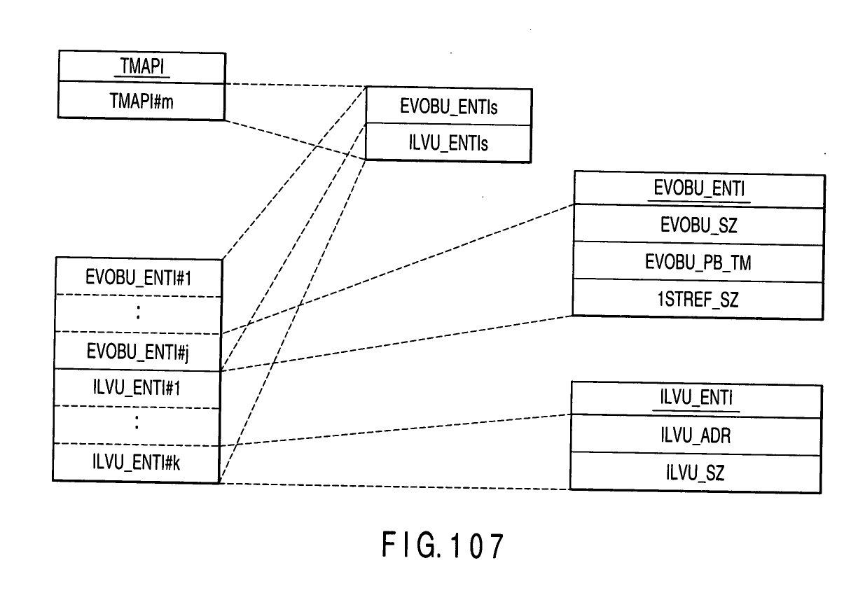

FIGS. 106 and 107 show an example of the data structure of a time map including no time entry. As shown in FIG. 106, a time map information (TMAPI) table includes TMAP information table information (TMAPITI) indicating the configuration of TMAPI stored in a file, a TMAP information search pointer group (TMAPI_SRPs) that gives a search pointer to each stored TMAPI, and a TMAP information group (TMAPIs) that stores EVOBU entry information of each TMAPI.

Time map information table information TMAPITI includes information (TMAPI_Ns) indicating the number of pieces of TMAPI stored in a TMAP file, block type information (TMAP_TYPE) indicating whether the block type of an EVOB stored in the TMAP file is a contiguous block (=0) or interleaved block (=1), angle type information (AGL_TYPE) indicating whether the angle type of an EVOB stored in the TMAP file is no angle (=0), non-seamless angle (=1), or seamless angle (=2), and information (TMAPIT_EA) indicating the end address of the table.

Each time map information search pointer

TMAPI_SRP includes information (TMAPI_SA) indicating the start address of target TMAPI, information (EVOB_IDN) indicating the identification number of an EVOB designated by the target TMAPI, information (EVOB_ADR) indicating the start address of the EVOB designated by the target TMAPI, information (EVOB_PB_TM) indicating the playback time of the EVOB designated by the target TMAPI using, e.g., the number of fields, information (EVOBU_ENTI_Ns) indicating the number of pieces of EVOBU entry information stored in the target TMAPI, information (ILVU_ENTI_Ns: if no interleaved block is formed, ILVU_ENTI_Ns=0) indicating the number of pieces of ILVU entry information stored in the target TMAPI, and information (AGLN: if no angle block is formed, AGLN=0) indicating the angle number of the EVOB of the target TMAPI.

As shown in FIG. 107, each time map information TMAPI includes an EVOBU_ENTI group and ILVU_ENTI group. The EVOBU_ENTI group includes one or more pieces of EVOBU entry information (EVOBU_ENTI). Each EVOBU_ENTI includes a size (EVOBU_SZ) of each EVOBU stored in an EVOB, which is indicated by, e.g., the number of packs, a playback time (ESOBU_PB_TM) indicated by, e.g., the number of fields, and a size (1STREF_SZ) of first reference picture data, which is indicated by, e.g., the number of packs).

The ILVU_ENTI group includes one or more ILVU entry information (ILVU_ENTI). Each ILVU_ENTI includes the start address (ILVU_ADR) of each ILVU stored in an EVOB, and a size (ILVU_SZ) of each ILVU, which is indicated by, e.g., the number of EVOBUs.

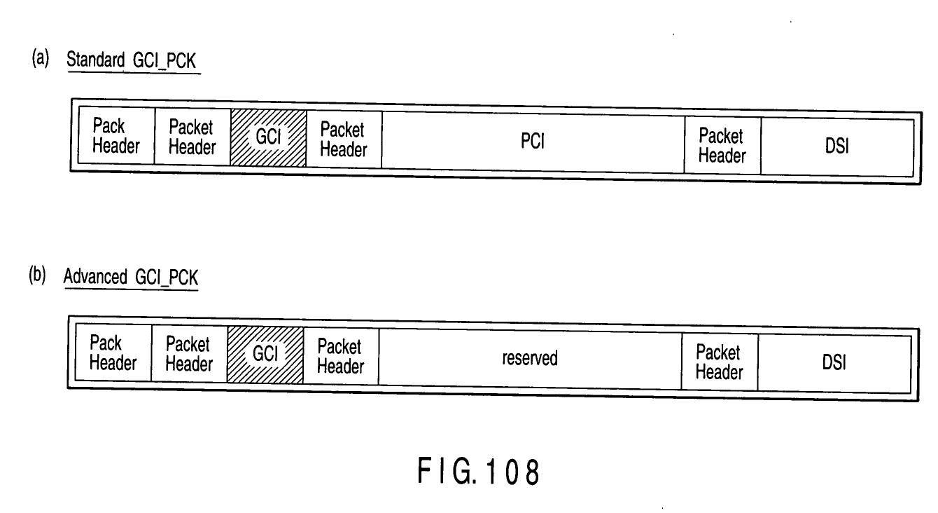

FIG. 108 shows an example of the structure which is different from that of a navigation pack (NV_PCK) shown in FIG. 63. As in NV_PCK, a general control information pack (GCI_PCK) allocated at the head of an EVOBU uses standard GCI_PCK shown in FIG. 108(a) in an EVOB in a standard VTS. This pack includes general control information (GCI) stored in a general control information packet (GCI_PKT), presentation control information (PCI) stored in a presentation control packet (PCI_PKT), and data search information (DSI) stored in a data search information packet (DSI_PKT).

Also, in an EVOB in an advanced VTS, an advanced GCI_PCK shown in FIG. 108(b) is used. This pack includes general control information (GCI) stored in a general control information packet (GCI_PKT) and data search information (DSI) stored in a data search information packet (DSI_PKT).

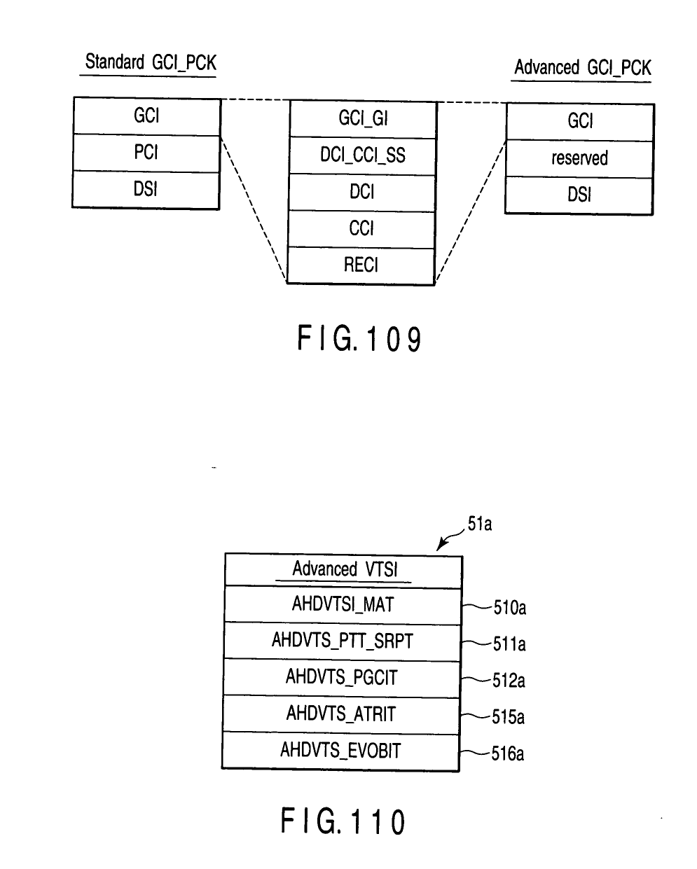

FIG. 109 shows information stored in the general control information (GCI). The general control information includes information (GCI_GI) associated with the entire EVOBU and pack in which that information is stored, information (DCI_CCI_SS) indicating the states of copy control information and display control information in the EVOBU and pack, display control information (DCI) indicating the aspect ratio and the like, copy control information (CCI) such as CGMS information, analog copy control information, and the like, recording information (RECI) that gives copyright information such as ISRC data or the like, and so forth.

FIG. 110 shows another embodiment of the data structure of advanced VTS 151a. As shown in FIG. 110, advanced HD video title set information (AHDVTSI) area 51 shown in FIG. 51(e) is divided into areas (management information groups) including advanced HD video title set information management table (AHDVTSI_MAT) 510a including no attribute information of video data, audio data, and the like, advanced HD video title set search pointer table (AHDVTS_PTT_SRPT) 511a used to search for the head of a part of title (PTT) corresponding to a chapter part of a title, advanced HD video title set program chain information table (AHDVTS_PGCIT) 512a that gives the playback sequence of a title, advanced HD video title set attribute information table (AHDVTS_ATRIT) 515a that gives attribute information of each EVOB, and advanced HD video title set expanded video object set information table (AHDVTS_EVOBIT) 516a that gives information of each EVOB.

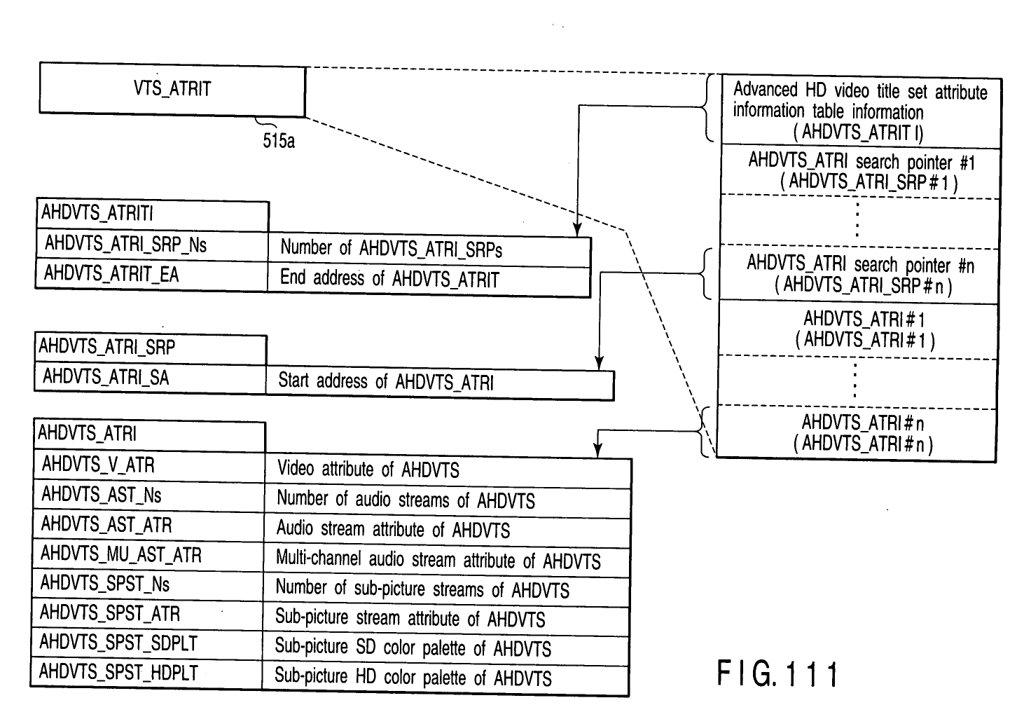

FIG. 111 shows an example of the data structure which shows the content of the advanced HD video title set attribute information table (AHDVTS_ATRIT). As shown in FIG. 111, AHDVTS_ATRIT 515a includes advanced HD video title set attribute information table information (AHDVTS_ATRITI), one or more advanced HD video title set attribute information search pointers (AHDVTS_ATRI_SRP), and one or more pieces of advanced HD video title set attribute information (AHDVTS_ATRI).

The advanced HD video title set attribute information table information (AHDVTS_ATRITI) has (AHDVTS_ATRI_SRP_Ns) indicating the number of pieces of attribute information stored in the table (the number of AHDVTS_ATRI_SRPs), and (AHDVTS_ATRIT_EA) indicating the end address of the table. The advanced HD video title set attribute information search pointer (AHDVTS_ATRI_SRP) has (AHDVTS_ATRI_SA) indicating the start address of each attribute information. The advanced HD video title set attribute information (AHDVTS_ATRI) indicates attribute information for a corresponding EVOB.

More specifically, the AHDVTS_ATRT has information (AHDVTS_V_ATR) indicating video attribute information such as MPEG-2, MPEG-4 AVC (H.264), SMPTE VC-1, and the like stored in an EVOB, information (AHDVTS_AST_Ns) indicating the number of audio streams, audio stream attribute information (AHDVTS_AST_ATR) such as DD+, DTS++, MLP, LPCM, and the like (all of DD for Dolby Digital, DTS for Digital Theater System, and MLP for Meridian Lossless Packing are the registered trade names) stored in an EVOB, multi-channel audio stream attribute information (AHDVTS_MU_AST_ATR), information (AHDVTS_SPST_Ns) indicating the number of sub-picture streams, sub-picture stream attribute information (AHDVTS_SPST_ATR) indicating the SD size (2 bits/pixel), HD size (2 bits/pixel), SD/HD size (8 bits/pixel), or the like stored in an EVOB, information (AHDVTS_SPST_SDPLT) indicating a color palette for sub-picture SD, information (AHDVTS_SPST_HDPLT) indicating a color palette for sub-picture HD, and the like.

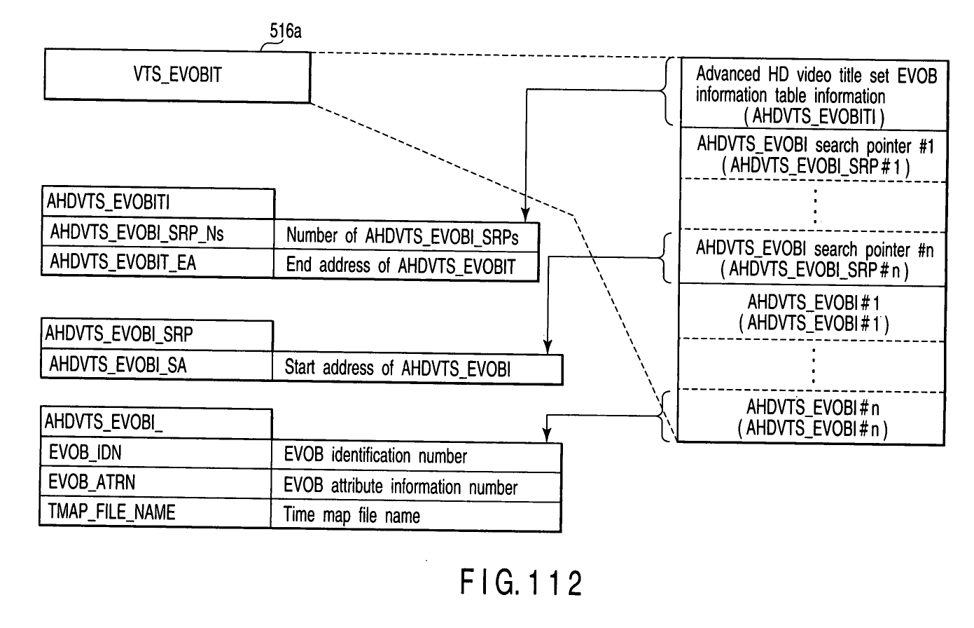

FIG. 112 shows an example of the data structure that shows the content of the advanced HD video title set EVOB information table (AHDVTS_EVOBIT). As shown in FIG. 112, AHDVTS_EVOBIT 516a includes advanced HD video title set EVOB information table information (AHDVTS_EVOBITI), one or more advanced HD video title set EVOB information search pointers (AHDVTS_EVOBI_SRP), and one ore more pieces of advanced HD video title set EVOB information (AHDVTS_EVOBI).

The advanced HD video title set EVOB information table information (AHDVTS_EVOBITI) has information (AHDVTS_EVOBI_SRP_Ns) indicating the number of pieces of EVOB information stored in the table (the number of AHDVTS_EVOBI_SRPs) and information (AHDVTS_EVOBIT_EA) indicating the end address of the table. Note that the advanced HD video title set EVOB information search pointer (AHDVTS_EVOBI_SRP) has information (AHDVTS_EVOBI_SA) indicating the start address of each EVOBI. The advanced HD video title set EVOB information (AHDVTS_EVOBI) has information (EVOB_IDN) of an EVOB identification number used to identify each EVOB, information (EVOB_ATRN) of an EVOB attribute information number indicating an attribute corresponding to each EVOB, information (TMAP_FILE_NAME) indicating the time map file name that stores time map information used to access each EVOB, and the like. Note that the number described in EVOB_ATRN is the number indicated by the advanced HD video title set attribute information search pointer (AHDVTS_ATRI_SRP#) of the advanced HD video title set attribute information table (AHDVTS_ATRIT).

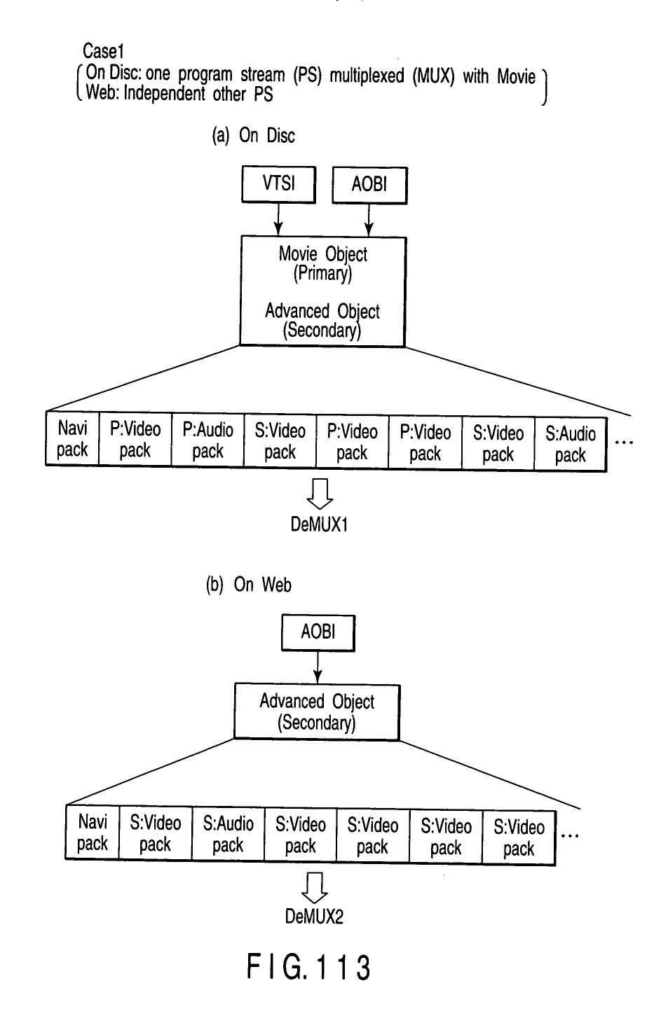

FIG. 113 is a view showing an example of a case (case 1) in which one program stream (1PS) obtained by multiplexing a Primary Object (Movie Object) and Secondary Object (Advanced Object) is recorded on a disc, and another Advanced Object (Secondary Object) exists as another independent program stream on an external communication line (Web).

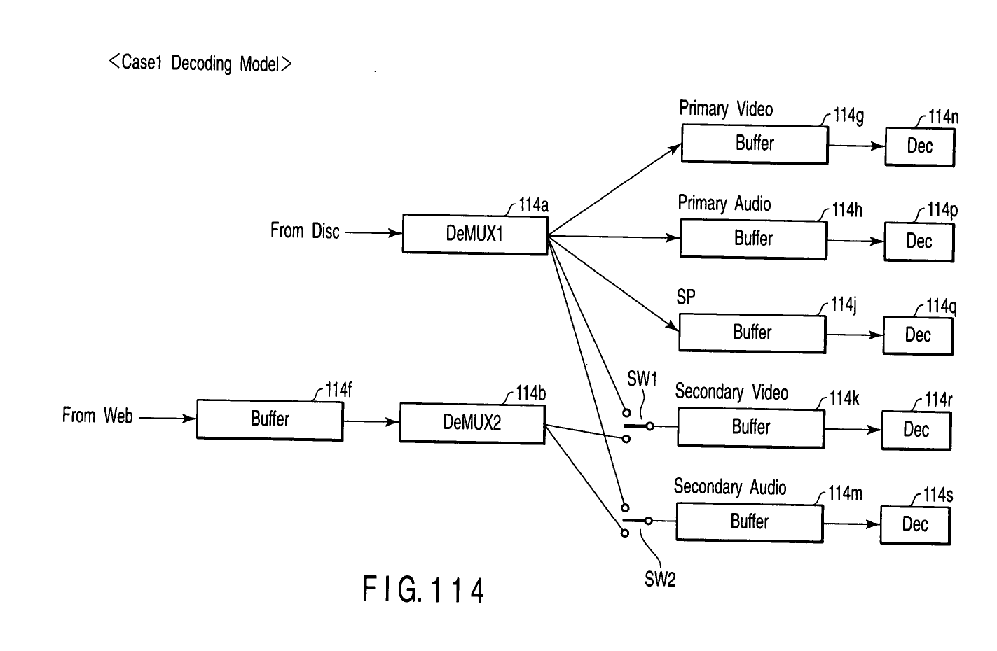

As case 1, Primary and Secondary Objects are multiplexed (MUX) onto 1PS for respective packs. At this time, as shown in FIG. 113, both Primary and Secondary Objects are managed by video title set information (VTSI: corresponding to a file in HVDVD_TS in FIG. 2, AHDVTSI in FIG. 52, etc.), and secondary information is managed by Advanced Object information (AOBI: corresponding to a file in ADV_OBJ in FIG. 2). FIG. 114 shows a Decoding model for this structure.

FIG. 114 is a diagram for explaining the decoding model of case 1. A PS sent from a Disc (corresponding to disc 1 in FIGS. 1, 50, 51, 73, 74, 79, etc.) is demultiplexed by first demultiplexer (DeMUX1) 114a and the demultiplexed packs are stored in Input Buffers 114g to 114m to be sent to Primary and Secondary Decoders 114n to 114s. Also, a Secondary Content sent from the Web is temporarily stored in Buffer 114f and is sent to Input Buffers 114k to 114m via second demultiplexer (DeMUX2) 114b and switches SW1 and SW2, so as to be played back in synchronism with the Disc. By mixing data decoded by respective Decoders 114n to 114s, Primary and Secondary Objects can be simultaneously (synchronously) displayed.

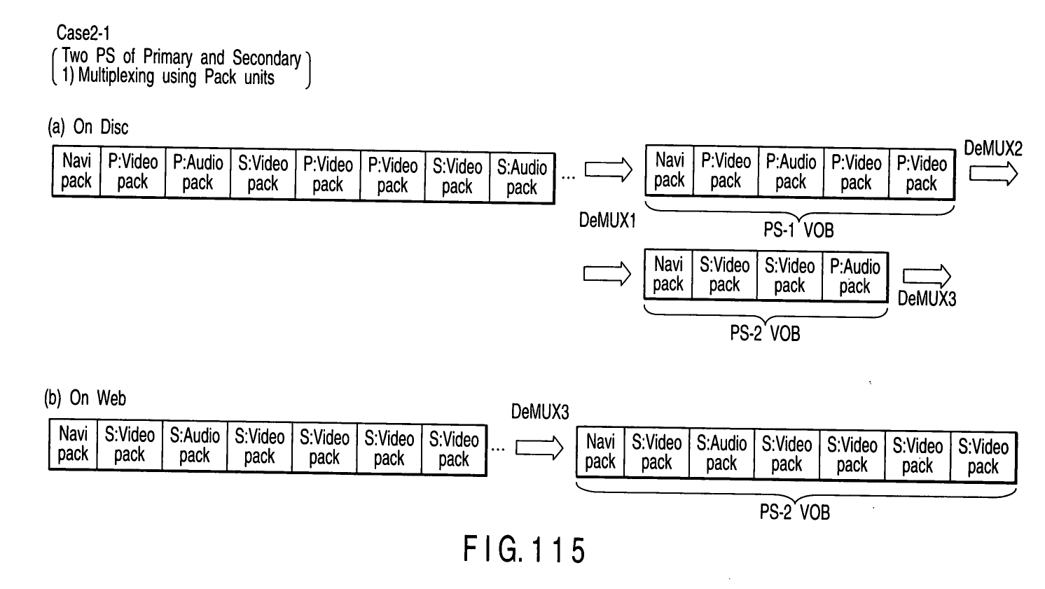

A case will be explained wherein a total of 2PSs, i.e., one program stream (1PS) of a Primary Object and 1PS of a Secondary Object are used. FIG. 115 is a view showing an example of a case (case 2-1) in which a PS of a Primary Object and that of a Secondary Object are recorded as two program streams (PS-1 VOB and PS-2 VOB) multiplexed for respective packs on a disc, and another Advanced Object (Secondary Object) exists as another independent PS on an external communication line (Web). This case 2-1 is a structural view obtained by respectively multiplexing (MUX) two objects for respective packs.

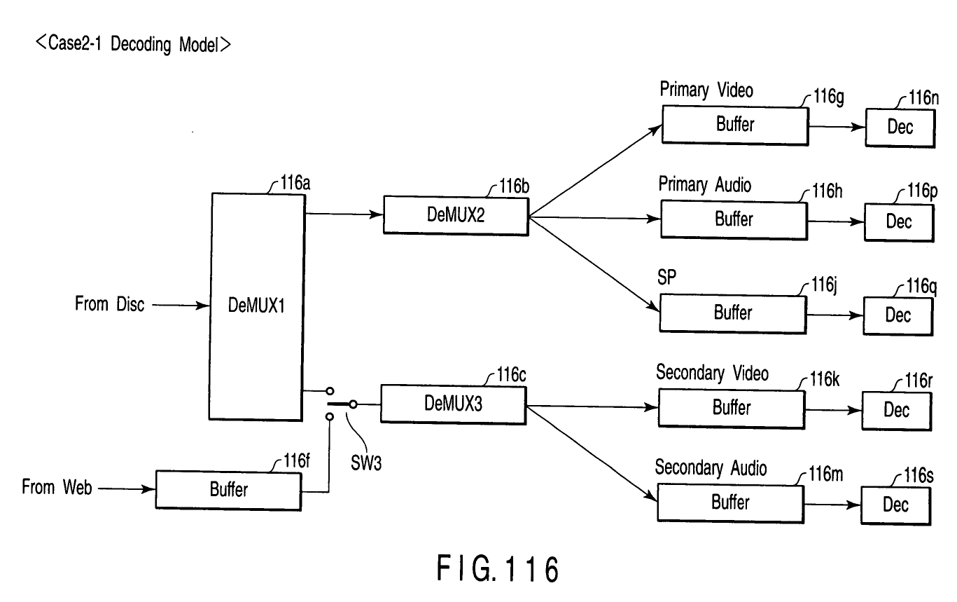

FIG. 116 is a diagram for explaining a decoding model of case 2-1. Contents on a Disc are demultiplexed by first demultiplexer (DeMUX1) 116a into Primary and Secondary streams, which are respectively sent to second demultiplexer (DeMUX2) 116b and third demultiplexer (DeMUX3) 116c so as to be sent to corresponding Decoders. Since Secondary Contents are sent from the network (Web), DeMUX3 116c receives contents by selecting the Web via switch SW3 if Web contents are available; otherwise, it receives contents by selecting the Disc.

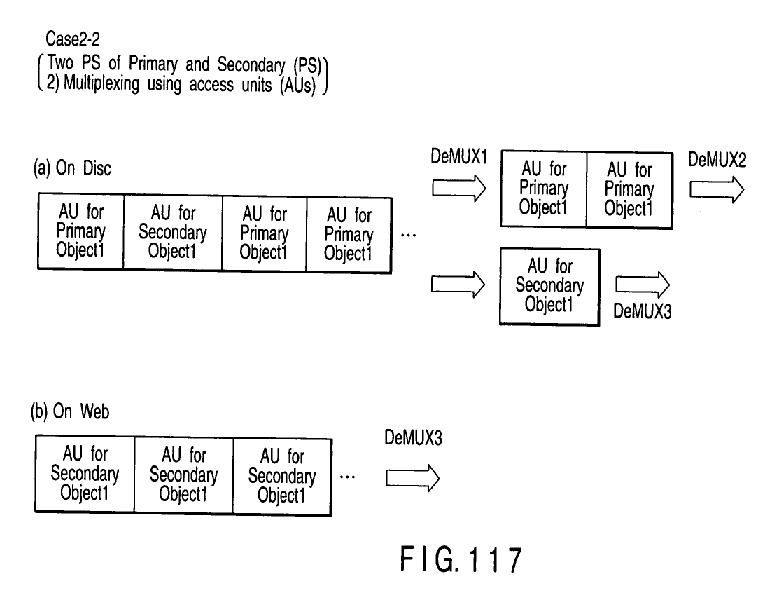

FIG. 117 is a view showing an example of a case (case 2-2) in which a PS of a Primary Object and that of a Secondary Object are recorded as two program streams multiplexed for respective access units (AUs) on a disc, and another Advanced Object (Secondary Object) exists as another independent PS on an external communication line (Web). In case 2-2, multiplexing units in 2PSs adopt AUs. In this case, by adopting the same configuration as an ILVU used in existing DVD-Video, the recording contents of Primary and Secondary Objects can be simultaneously (synchronously) displayed in the form of simultaneously displaying a plurality of angles.

In case 2-2, one access unit size is larger than that in case 2-1 (a pack size in case 2-1 is as small as 2 kB, but an access unit in case 2-2 has a relatively large size since it includes a plurality of packs). For this reason, after object data is stored in the Input Buffer (e.g., 116g in FIG. 116), and object data then begins to be supplied to the Decoder, the data loading speed of the Input Buffer cannot often catch up with the consumption speed of Buffering data (data reading speed of the Input Buffer). A measure against such problem will be described below.

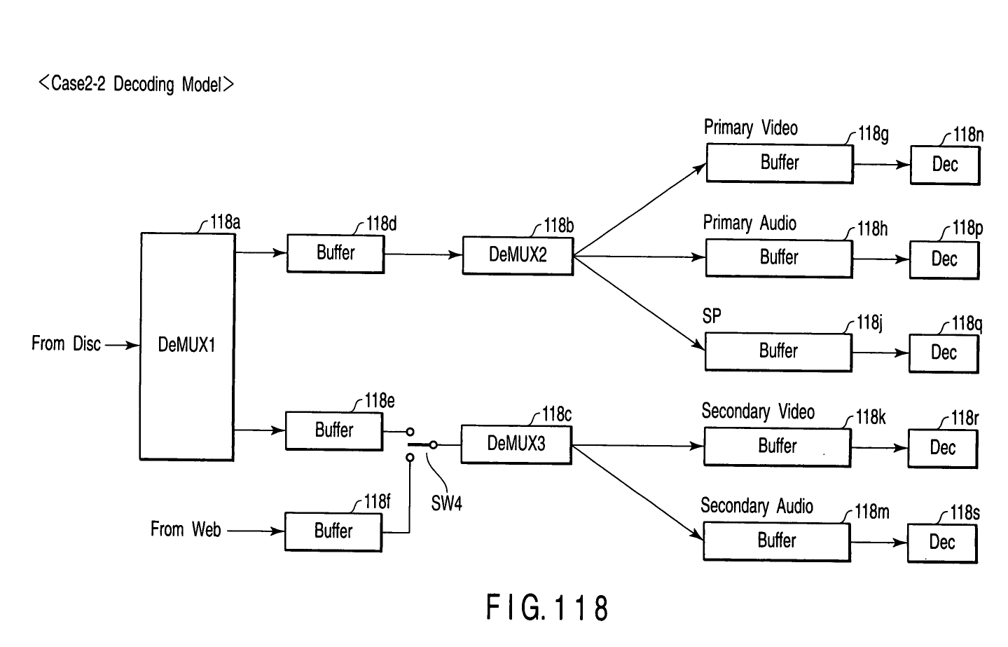

FIG. 118 is a diagram for explaining a decoding model of case 2-2. In this model, Buffers 118d to 118f used to stably supply data to second demultiplexer (DeMUX2) 118b and third demultiplexer (DeMUX3) 118c are respectively prepared after first demultiplexer (DeMUX1) 118a (the maximum data size to be Buffered on each of these Buffers, i.e., the Buffer size to be used can be determined based on a simulation result of a disc or Web which may be used in practice. Especially, Buffer 118f for the Web preferably has a relatively large size so that Buffering data is not exhausted even when data transfer from the external communication line is unstable and suffers fluctuation.).

A method of utilizing stream_id to specify a primary or Secondary Content will be described below. The respective demultiplexers (DeMUX1 to DeMUX3) demultiplex a stream using this stream_id (sub_stream_id as needed). This demultiplexing is done to send data to Input Buffers 118g to 118m that input demultiplexed data to Decoders 118n to 118s, respectively.

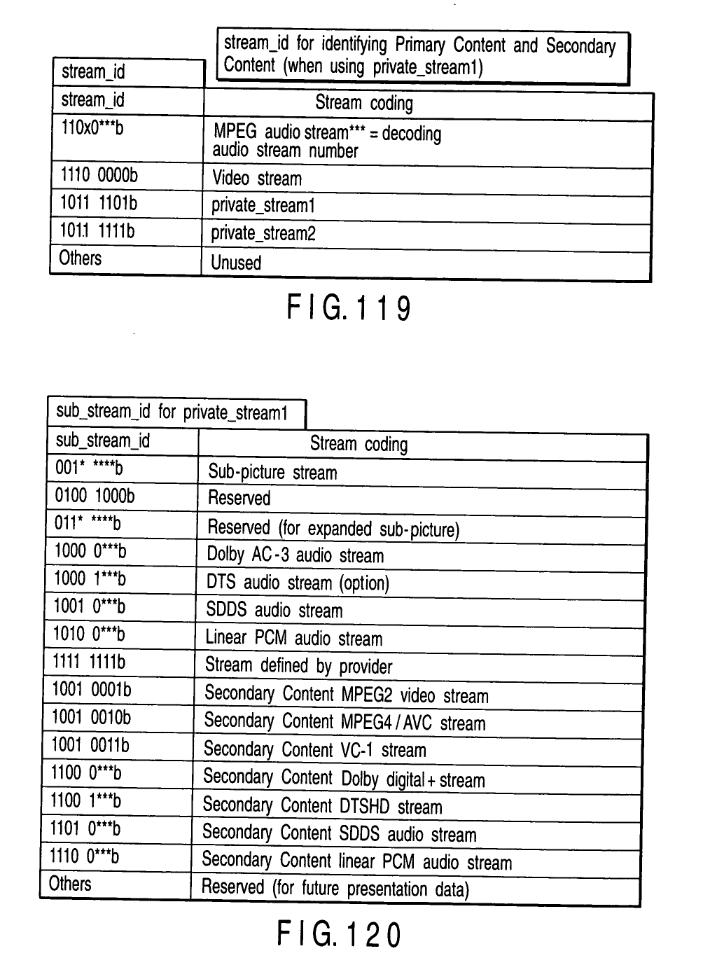

As a setting method of this stream_id and sub_stream_id, two methods, i.e., a method of defining identifiers (ids) for the Secondary Content in private_stream1 in a format according to the existing DVD-Video standard (see FIGS. 119 to 121) and a method of setting new private_stream3, and providing secondary ids to new private_stream3 (see FIGS. 122 to 125) are available.

FIG. 119 is a view for explaining an example of stream_id used to identify the contents of Primary and Secondary Objects (when private_stream1 is used to identify objects). This stream_id is configured to appropriately include “110x0***b” that specifies MPEG audio stream *** corresponding to a decoding audio stream number, “11100000b” that specifies a video stream, “10111101b” that specifies private_stream1, “10111111b” that specifies private_stream2, and others (an area which is not used currently, etc.).

FIG. 120 is a view for explaining an example of the configuration of sub_stream_id for private_stream1 in stream_id shown in FIG. 119. This sub_stream_id is configured to appropriately include “001*****b” that specifies a Sub-picture stream, “01001000b” which is reserved, “011*****b” which is reserved for an enhanced Sub-picture, “10000***b” that specifies Dolby AC-3®, “10001***b” that specifies a DTS® audio stream as an option, “10010***b” that specifies an optional SDDS® audio stream, “10100***b” that specifies a linear PCM audio stream, “11111111b” that specifies a stream defined by the contents provider, “10010001b” that specifies an MPEG2 video stream of a Secondary Content, “10010010b” that specifies an MPEG4/AVC stream of the Secondary Content, “10010011b” that specifies a VC-1 stream of the Secondary Content, “11000***b” that specifies a Dolby Digital+® stream of the Secondary Content, “11001***b” that specifies a DTSHD® stream of the Secondary Content, “11010***b” that specifies an SDDS® audio stream of the Secondary Content, “11100***b” that specifies a linear PCM audio stream of the Secondary Content, and others (for future presentation data, etc.).

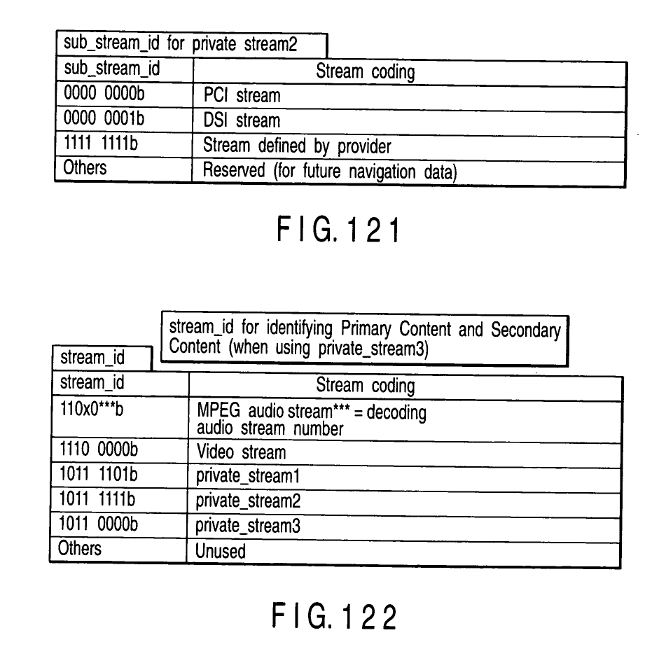

FIG. 121 is a view for explaining an example of the configuration of sub_stream_id for private_stream2 in stream_id shown in FIG. 119. This sub_stream_id is configured to appropriately include “00000000b” that specifies a presentation control information (PCI) stream, “00000001b” that specifies a data search information (DSI) stream, “llllllllb” that specifies a stream defined by the contents provider, and others (for future navigation data, etc.).

FIG. 122 is a view for explaining another example of stream_id used to identify the contents of Primary and Secondary Objects (when new private_stream3 is set to identify objects). This stream_id is configured to appropriately include “110x0***b” that specifies MPEG audio stream *** corresponding to a decoding audio stream number, “11100000b” that specifies a video stream, “10111101b” that specifies private_stream1, “10111111b” that specifies private_stream2, “10110000b” that specifies private_stream3, and others (an area which is not used currently, etc.).

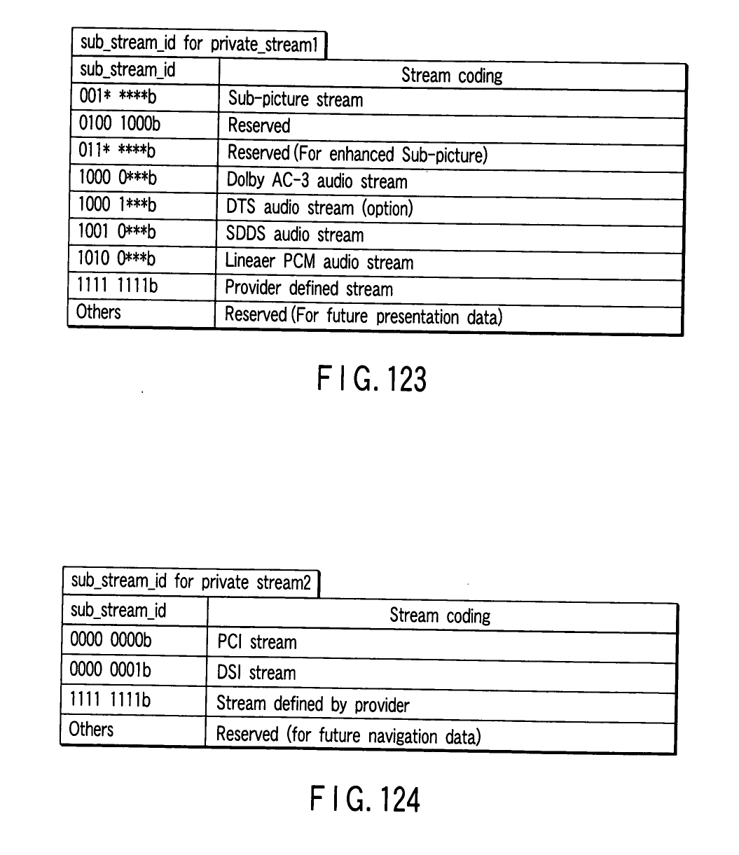

FIG. 123 is a view showing an example of the configuration of sub_stream_id for private_stream1 in stream_id in FIG. 122. This sub_stream_id is configured to appropriately include “001*****b” that specifies a Sub-picture stream, “01001000b” which is reserved, “011*****b” which is reserved for an enhanced Sub-picture, “10000***b” that specifies Dolby AC-3®, “10001***b” that specifies an optional DTS® audio stream, “10010***b” that specifies an optional SDDS® audio stream, “10100***b” that specifies a linear PCM audio stream, “11111111b” that specifies a stream defined by the contents provider, and others (for future presentation data, etc.). Note that sub_stream_id for private_stream1 in FIG. 123 has contents obtained by excluding items associated with “Secondary Content” from sub_stream_id for private_stream1 in FIG. 120.

FIG. 124 is a view showing an example of the configuration of sub_stream_id for private_stream2 in stream_id in FIG. 122. This sub_stream_id is configured to appropriately include “00000000b” that specifies a PCI stream, “00000001b” that specifies a DSI stream, “11111111b” that specifies a stream defined by the contents provider, and others (for future navigation data, etc.), as in FIG. 121.

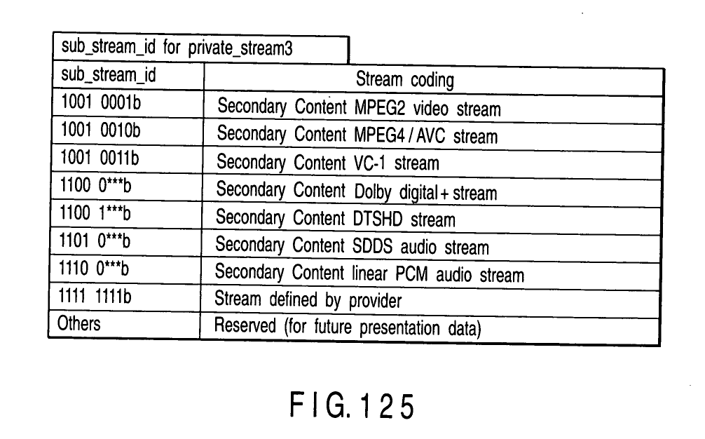

FIG. 125 is a view showing an example of the configuration of sub_stream_id for private_stream3 in stream_id in FIG. 122. This sub_stream_id is configured to appropriately include “10010001b” that specifies an MPEG2 video stream of a Secondary Content, “10010010b” that specifies an MPEG4/AVC stream of the Secondary Content, “10010011b” that specifies a VC-1 stream of the Secondary Content, “11000***b” that specifies a Dolby Digital+® stream of the Secondary Content, “11001***b” that specifies a DTSHD® stream of the Secondary Content, “11010***b” that specifies an SDDS® audio stream of the Secondary Content, “11100***b” that specifies a linear PCM audio stream of the Secondary Content, “11111111b” that specifies a stream defined by the contents provider, and others (for future presentation data, etc.). Note that sub_stream_id for private_stream3 in FIG. 125 has contents mainly including items associated with “Secondary Content” of those of sub_stream_id for private_stream1 in FIG. 120.

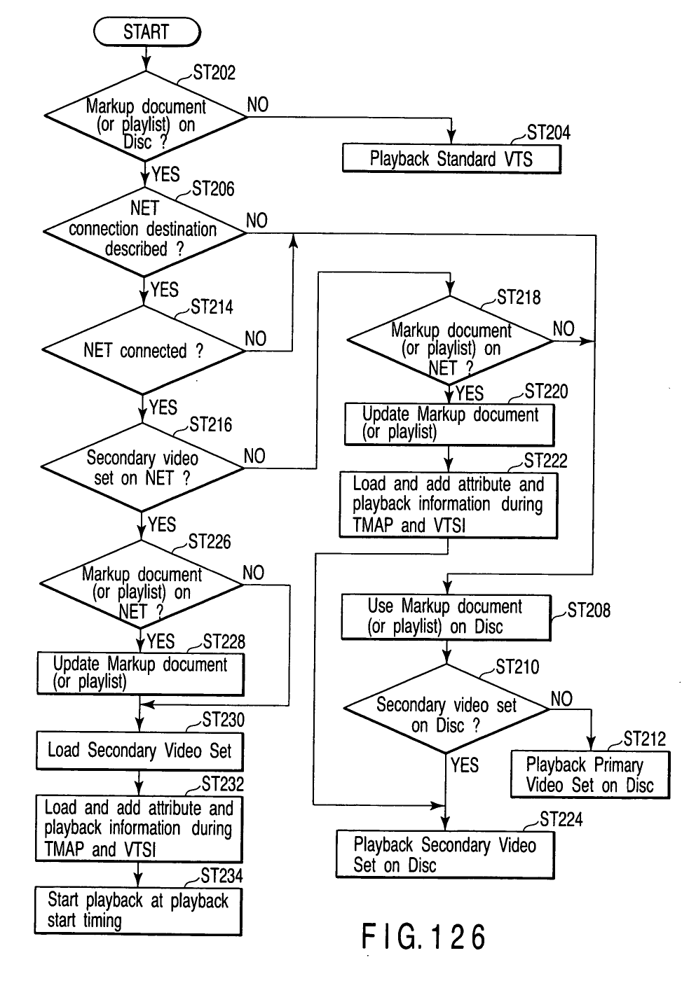

FIG. 126 is a flowchart for explaining an example of the processing sequence when a Primary Object and/or a Secondary Object is to be played back from a disc and/or an external communication line (Web). This figure exemplifies a sequence for playing back a Secondary Content (or Secondary/2ndary Video Set) using a Markup document or playlist described by XML. That is, if no Markup document (or playlist) is available on a Disc (corresponding to information storage medium 1 in FIG. 50, etc.) (NO in block ST202), a player (e.g., a playback apparatus with the arrangement shown in FIG. 100) plays back using a standard VTS (corresponding to normal DVD-Video contents or HDVTS# in FIG. 1) (block ST204).

If a Markup document (or playlist) is available on the Disc (YES in block ST202), the player checks if the Markup document (or playlist) describes a NET (Web) connection destination. If no connection destination is described (NO in block ST206), the player confirms based on the Markup document (or playlist) in the Disc (block ST208) if a Secondary Video Set is available. If no Secondary Video Set is available (NO in block ST210), the player plays back a Primary Video Set (block ST212).

If the Markup document (or playlist) describes a NET (Web) connection destination (YES in block ST206), the player confirms the connection state. If connection is not assured (NO in block ST214), the player plays back a Primary Video Set (block ST212) or a Secondary Video Set (block ST224) using the Markup document (or playlist) in the Disc (block ST208) as in the previous block (NO in block ST206).

If NET connection is assured (YES in block ST214), the player determines if a Secondary Video Set is stored on the NET. If no Secondary Video Set is stored (NO in block ST216), the player determines if a Markup document (or playlist) is stored on the NET. If neither the Secondary Video Set nor the Markup document (or playlist) are available on the NET (NO in blocks ST216 and ST218), the player plays back a Primary Video Set (block ST212) or a Secondary Video Set (block ST224) using the Markup document (or playlist) in the Disc (block ST208).

If the Secondary Video Set alone is available on the NET (YES in block ST216) but if no Markup document (or playlist) is available on the NET (NO in block ST226), the player loads that Secondary Video Set (block ST230), loads update information of TMAP information, and attribute information and playback information in VTSI (block ST232), and adds them to the current playback control information (navigation data). Then, the player starts playback of the Secondary Video Set on the NET based on the playback start timing in the Markup document (or playlist) on the Disc (block ST234).

On the other hand, if no Secondary Video Set is available on the NET (NO in block ST216) but a Markup document (or playlist) alone is available on the NET (YES in block ST218), the player updates the Markup document (or playlist) (block ST220), then loads update information of TMAP information, and attribute information and playback information in VTSI (block ST222), and adds them to the current playback control information (navigation data). Then, the player starts playback of the Secondary Video Set on the Disc based on the playback start timing in the updated Markup document (or playlist) (block ST224).

At this time, since the Secondary Video Set is not updated, TMAP information and the like need not be updated. On the other hand, if both the Markup document (or playlist) and Secondary Video Set are available (YES in blocks ST216 and ST218), the player updates the Markup document (or playlist) (block ST228) and adds to-be-used information (block ST232). The player then plays-back the Secondary Video Set on the NET.

With the processing shown in FIG. 126, the player can appropriately play back the Secondary Video Set from the Disc (block ST224) or that from the NET (Web) (block ST234). In this case, the player may have indicators (color-coded LEDs, etc.; not shown) to allow the user to immediately recognize whether the Secondary Video Set acquired from NET connection is being displayed or the Secondary Video Set is being played back based on information in the Disc, or from where the currently played-back Secondary Video Set is acquired may be on-screen displayed (OSD) on the screen of a monitor TV.

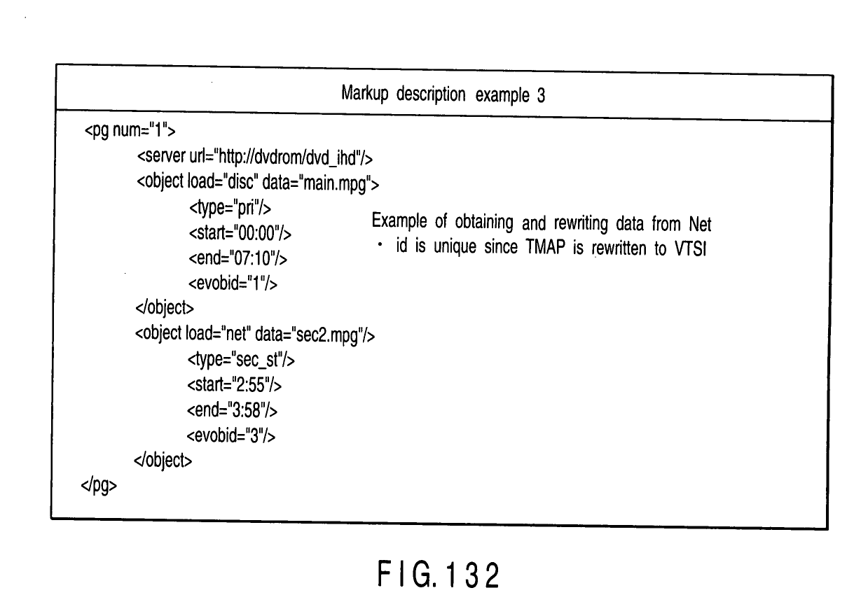

Note that whether the Secondary Video Set which is being played back is acquired from the Disc or NET can be determined based on a load attribute described in the Markup document (or playlist) (for example, see <object load=“disc” data> or <object load=“net” data> in description example 3 in FIG. 132 to be described later).

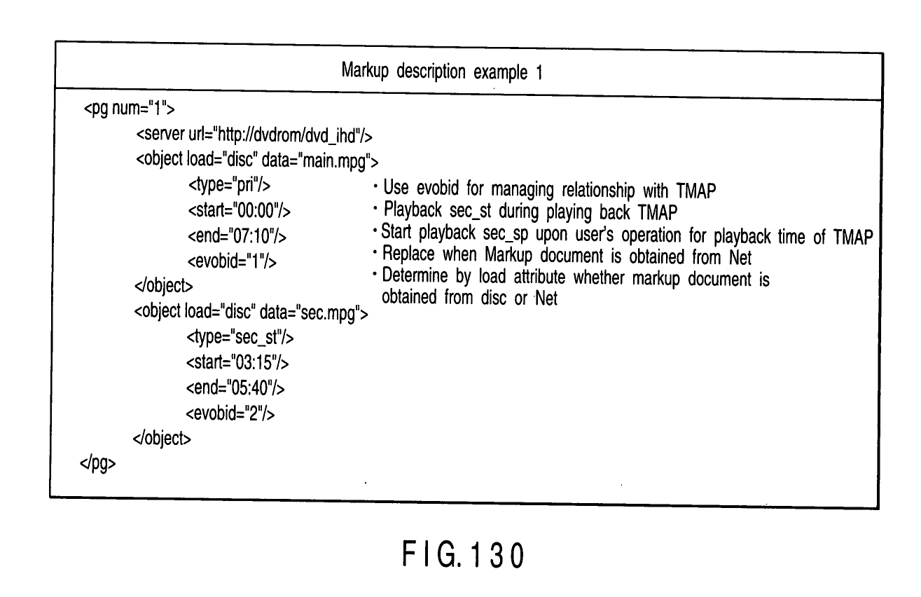

Note that the processing in FIG. 126 is closely focused on the playback processing of the Secondary Video Set. Parallel to this processing, it is possible to simultaneously play back a Primary Video Set from the Disc, as a matter of course. In this case, the playback timing of the Secondary Video Set (from the Disc or NET) with respect to the Primary Video Set which is being played back can be designated by the Markup document (or playlist) used (block ST208, ST220, or ST228). Such description examples of the Markup document (or playlist) will be described later with reference to FIGS. 130 to 132.

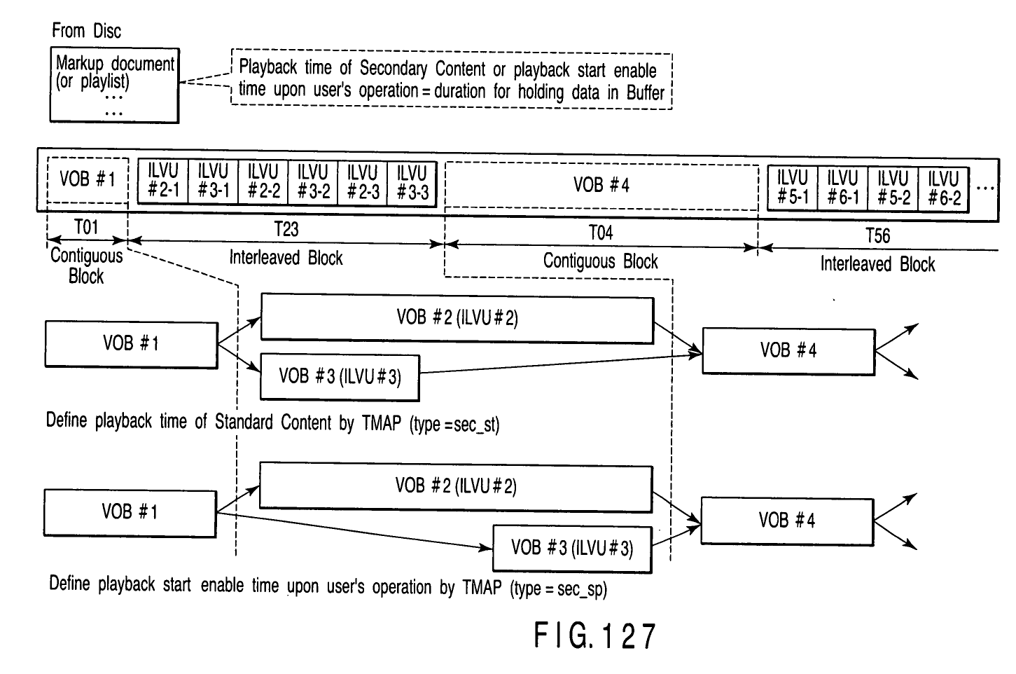

FIG. 127 is a view for explaining playback routes of a Primary Object/Primary Content (Primary Video Set) and Secondary Object/Secondary Content (Secondary Video Set) from a Disc. In this example, a Markup document (or playlist) recorded on a Disc describes a playback time of the Secondary Content or a playback startable time period by a user's operation. (This “playback startable time period by a user's operation” corresponds to a period in which the Secondary Content is held in Buffer 114f, 116f, 118f, or the like in FIG. 114, 116, or 118.)

Referring to FIG. 127, VOB#2 (Primary Content) and VOB#3 (Secondary Content) are interleaved and recorded for respective ILVUs in interleaved block section T23 after VOB#1 (Primary Content) recorded in contiguous block section T01 on the Disc, and VOB#4 (Primary Content) is recorded in subsequent contiguous block section T04. At this time, if VOB#2 corresponds to a Primary Content and VOB#3 corresponds to a Secondary Content, the playback start and end times (or playback startable period) of the Secondary Content (VOB#3) are set in the Markup document (or playlist) on the Disc. The playback start and end times literally indicate the times at which playback of VOB#3 starts and ends. The playback startable period is a period during which the Secondary Content is stored in the Buffer, and its playback can be started in response to a user's operation. For example, if section T23 in FIG. 127 is a playback startable period, VOB#3 (Secondary Content) can be played back (simultaneous or synchronous playback) together with VOB#2 (Primary Content) at a timing of a time defined by TMAP data of in VOB#3 anywhere during T23.

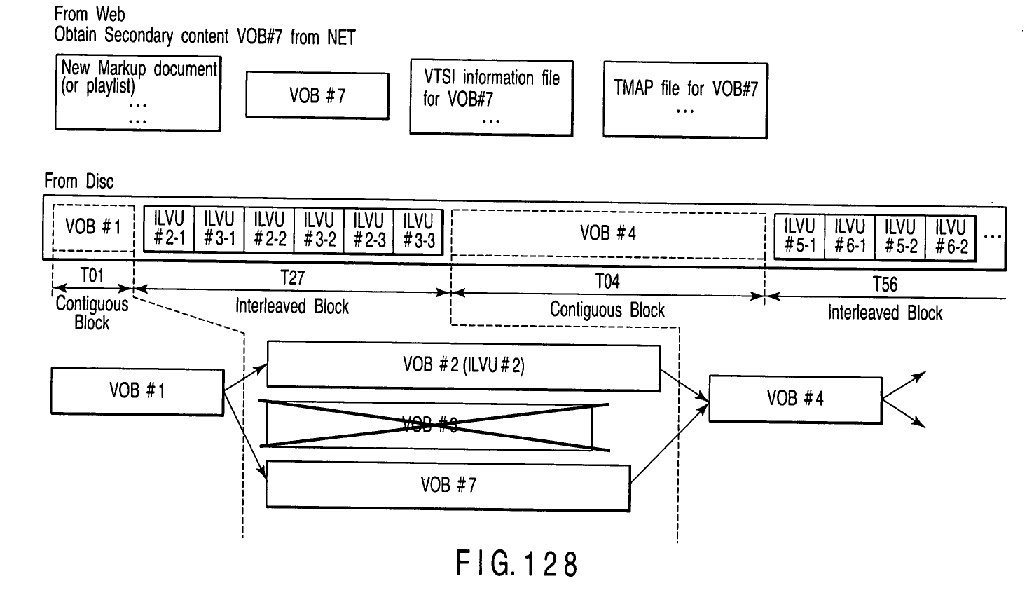

FIG. 128 is a view for explaining playback routes of a Primary Object/Primary Content (Primary Video Set) from a Disc and a Secondary Object/Secondary Content (Secondary Video Set) from an external communication line (NET/Web). In FIG. 128, VOB#2 (Primary Content) and VOB#3 (Secondary Content) are interleaved and recorded for respective ILVUs in interleaved block section T27 after VOB#1 (Primary Content) recorded in contiguous block section T01 on the Disc, and VOB#4 (Primary Content) is recorded in subsequent contiguous block section T04. However, in this example, VOB#7 (Secondary Content) from the NET/Web is played back together with VOB#2 (Primary Content) during section T27 in place of VOB#3 (Secondary Content) from the Disc.

The example of FIG. 128 corresponds to a case wherein a new Secondary Video Set of VOB#7, and a new Markup document (or playlist), VTSI file, and TMAP file are acquired from the NET. The new Markup document of this example does not include any description of VOB#3 and this VOB#3 is not displayed (even if it is recorded on the Disc). Since the Markup document and TMAP information are updated when the new Markup document is acquired from the NET, the playback period of VOB#3 defined in FIG. 127 need not match that of VOB#7 in FIG. 128. (That is, if T23 in FIG. 127=T27 in FIG. 128, the playback period of VOB#3 and that of VOB#7 can be individually and arbitrarily set within a time range corresponding to section T27).

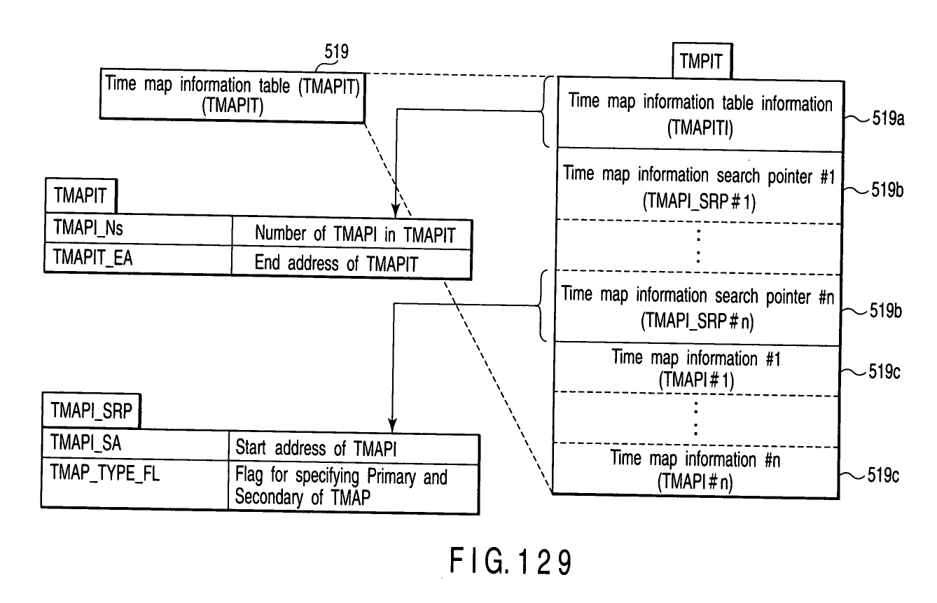

FIG. 129 is a view showing an example of the data structure of a time map information table including a type flag (TMAP_TYPE_FL) of a time map. FIG. 129 is obtained by adding a flag (TMAP_TYPE_FL) used to determine if the TMAP of interest is for a Primary or Secondary Content to time map information search pointer 519b in time map information table 519 which has been described above with reference to FIG. 58. With this table, when the player reads and maps TMAP data from the Disc, processing for replacing the current TMAP data of that player by new TMAP data can be smoothly executed.

In the example of FIG. 129, TMAP_TYPE_FL can be configured by 1 bit since it is used to simply determine if the TMAP of interest is for “a Primary or Secondary Content”. However, this flag can be expanded to a plurality of bits. For example, when TMAP_TYPE_FL is configured by 2 bits, the following specifying processing is allowed: “00b” specifies a TMAP for a Primary Object from the Disc, “01b” specifies a TMAP for a Secondary Object from the Disc, “10b” specifies a TMAP for a Secondary Object from the NET/Web, and “11b” specifies a TMAP for a Secondary Object from other locations.

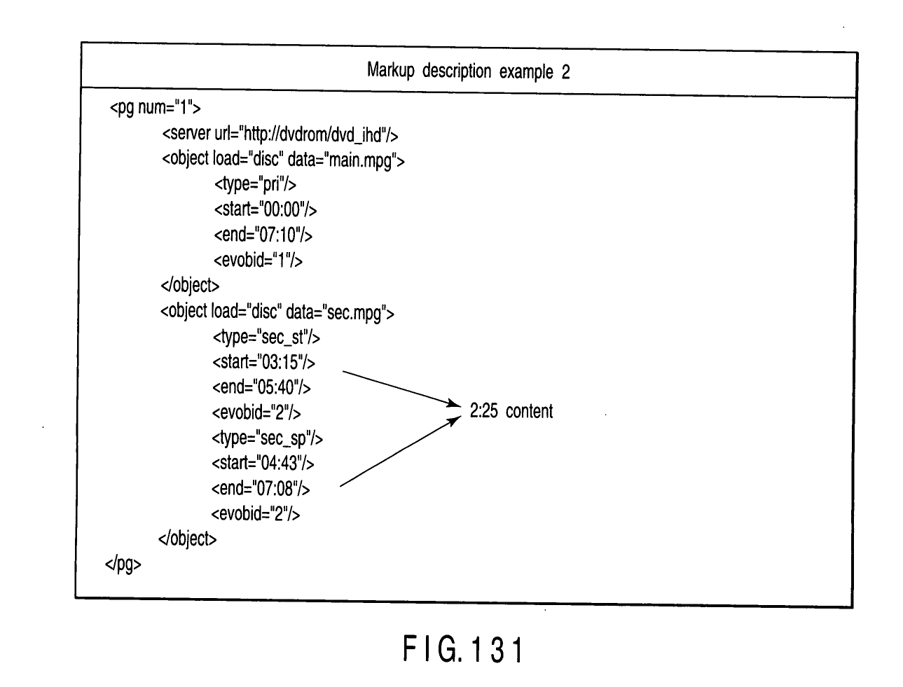

FIGS. 130 to 132 are views for explaining Markup description examples 1 to 3, respectively. In these description examples, three different object types are assumed. That is, the first type is for a Primary Content (e.g., <object load=“disc” data=“main.mpg”> in FIG. 130) and the remaining two types are for a Secondary Object. One of these two types is designed to perform play back during a playback time defined by TMAP data (e.g., <object load=“disc” data=“sec.mpg”> in FIG. 131), and the other type is designed to start playback by the timing of a user's operation during a playback time defined by TMAP data (e.g., <object load=“net” data=“sec2.mpg”> in FIG. 132). These types can be determined based on a data attribute and type tag in an object tag. Also, a server tag (e.g., <server url=“http://dvdrom/dvd_ihd”/> in FIG. 130) indicates the connection destination of the NET connection, and the operation shown in the flowchart in FIG. 126 is assumed. If a Markup document is available at the connection destination, the player uses the Markup document at the NET connection destination in playback in place of that in the Disc.

In Markup description example 1 in FIG. 130, a Secondary Object from the Disc is played back during a playback time “03:15” to “05:40” (TMAP of “evobid=“2”) of EVOB#2 as the Secondary Object.

In Markup description example 2 in FIG. 131, playback of a Secondary Object from the Disc starts during a playback time “03:15” to “05:40” (TMAP of evobid=“2”) of EVOB#2 as the Secondary Object, and playback of a Secondary Object from the Disc starts during a playback time “04:43” to “07:08” (TMAP of evobid=“2”) (contents for a total of 2 min 25 sec)). Note that the TMAP (<type=“sec_sp”/>) for the playback time “04:43” to “07:08” is an example whose playback start timing is designated by a user's operation.

In Markup description example 3 in FIG. 132, a Primary Object from the Disc is played back during a playback time “00:00” to “07:10” (TMAP of evobid=“1”) of EVOB#1 as the Primary Object, while the description of the Markup document is rewritten by that acquired from the NET (<object load=“net” data=“sec2.mpg”>) to start playback of a Secondary Object from the NET during a playback time “02:55” to “03:58” (TMAP of evobid=“3”). (In this example, since the Markup document is acquired from the NET, for example, <object load=“disc” data=“sec.mpg”> in FIG. 130 is rewritten by <object load=“net” data=“sec2.mpg”> in FIG. 132.)

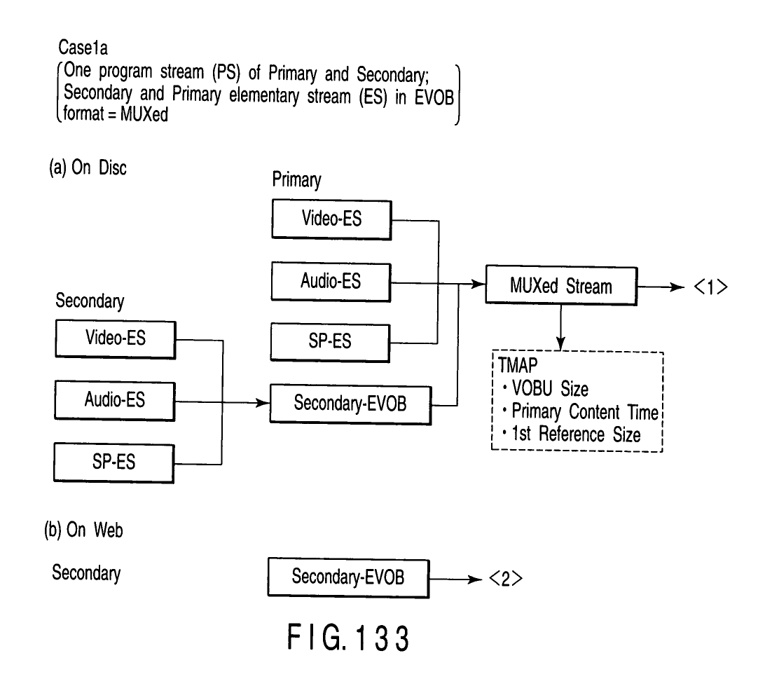

FIG. 133 is a view showing another example of a case (case 1a) in which one program stream (PS) obtained by multiplexing a Primary Object (Movie Object) and Secondary Object (Advanced Object) is recorded on a Disc, and another Advanced Object (Secondary Object) exists as another independent program stream on an external communication line (NET/Web).

The example of FIG. 133 can be considered as a model obtained by improving the 1PS model in FIG. 113 in terms that multi-stage processing for multiplexing Secondary Contents before being multiplexed on Primary Contents onto a Secondary Object (Secondary EVOB), and then the multiplexed Secondary EVOB onto Primary Contents to form 1PS is executed (the multiplexed Secondary Contents are complete at the time of multiplexing the Secondary Contents on the Primary Contents).

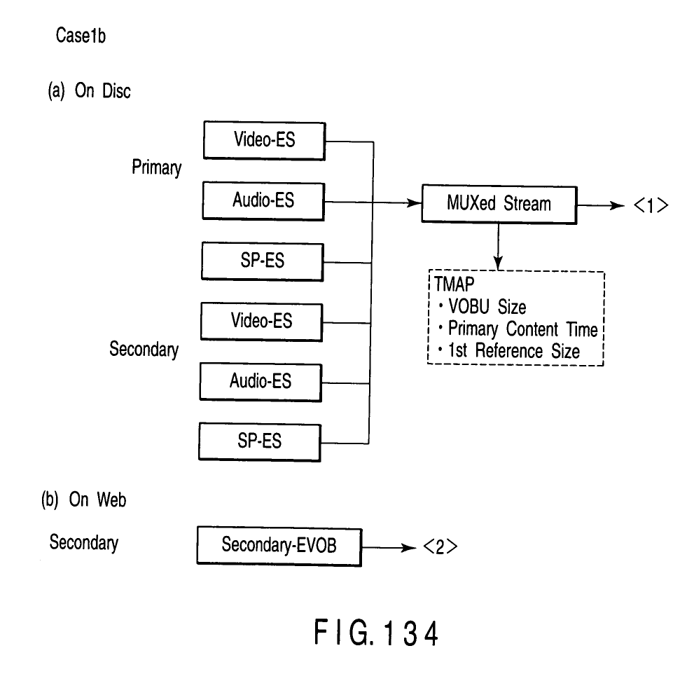

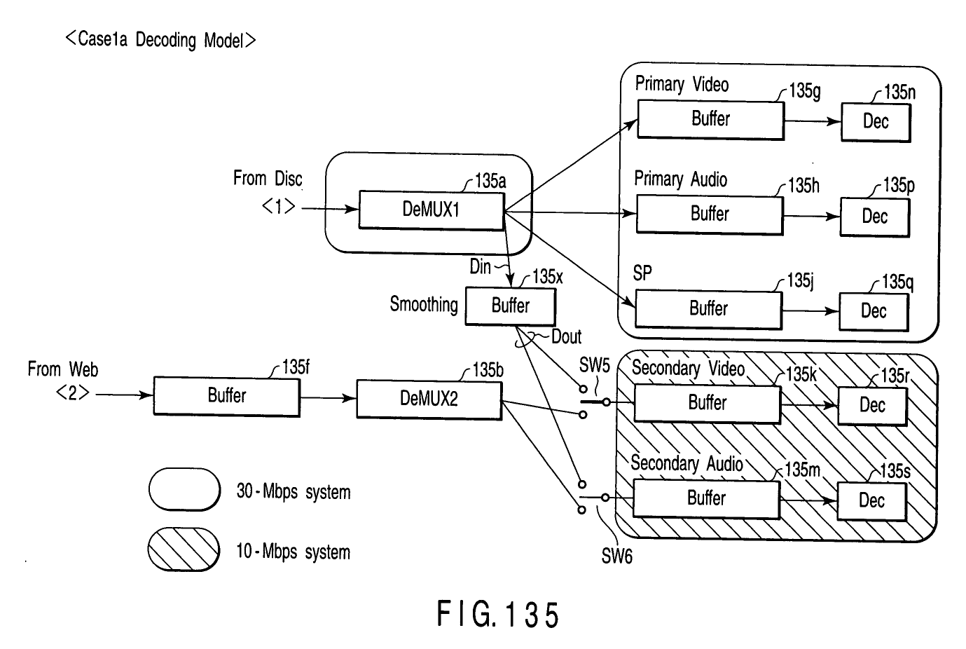

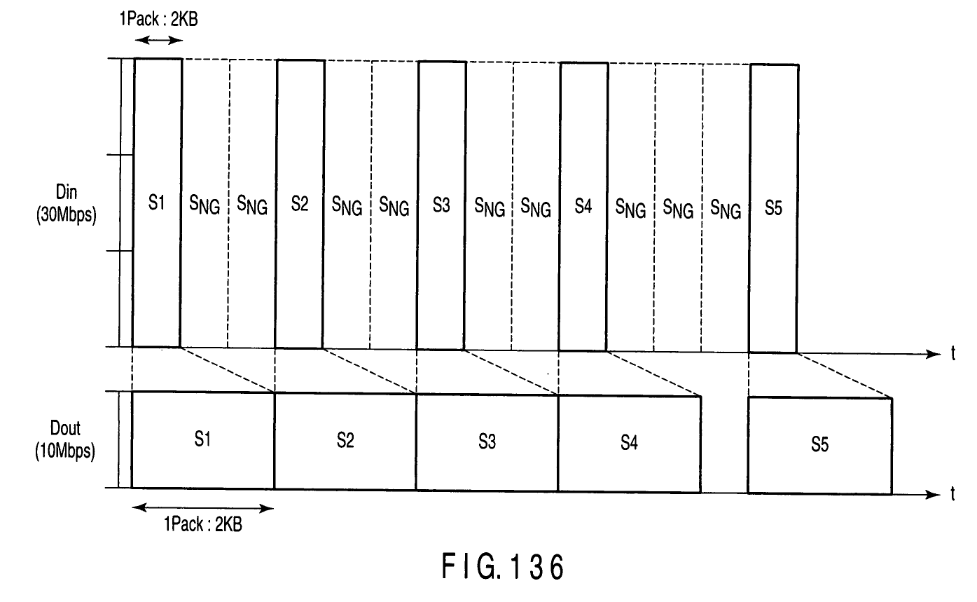

FIG. 134 is a view showing still another example of a case (case 1b) in which one program stream (PS) obtained by multiplexing a Primary Object (Movie Object) and Secondary Object (Advanced Object) is recorded on a Disc, and another Advanced Object (Secondary Object) exists as another independent program stream on an external communication line (NET/Web). FIG. 135 is a diagram for explaining a decoding model of case 1a, and FIG. 136 is a view for explaining an example of the operation of a smoothing Buffer in the decoding model of case 1a.

In case of the decoding model shown in FIG. 114, the entire system operates as a model with a single bit rate. In this case, since the bit rate of the Primary Content is higher than that of the Secondary Content, FIG. 135 shows a decoding model which assumes that the bit rate of the system is 30 Mbps, that of the Primary Content is 20 Mbps, and that of the Secondary Content is 10 Mbps. Input Buffers 114g to 114m connected before Decoders 114n to 114s in FIG. 114 may temporarily receive data at 30 Mbps even when the average bit rate of the Secondary Content is 10 Mbps. Hence, Buffers with suited sizes are to be prepared to avoid any overflow. In order to compatibly operate the decoding model in FIG. 135 under such situation, restrictions are to be placed upon multiplexing in FIG. 133 or 134. An example of the pack structure of a Secondary Video Set with such restrictions will be described below.

FIG. 136 is a view for explaining an example of the operation of a smoothing Buffer in the decoding model of case 1a. The upper side in FIG. 136 illustrates a pack structure to be input to the 30-Mbps model of DeMUX1, and the lower side in FIG. 136 illustrates a pack structure which has a rate reduced to 10 Mbps. When smoothing Buffer 135X in FIG. 135 absorbs a difference from the 10-Mbps model, a gap for at least two packs are to be assured, as shown in, e.g., FIG. 136. This is because the next pack cannot be flowed in before a stream on the lower side in FIG. 136 is output from smoothing Buffer 135X due to Buffer overflow.

The values of system clock reference SCR or presentation time stamp PTS (decoding time stamp DTS) should, for example, have a gap for (2 KB/30×10ˆ6 bps)×3 packs=1.599 [ms] if one pack is 2 KB. During this assured section, more specifically, section SNG in FIG. 136, packs of a Primary Video Set can be multiplexed (MUX). Packs of a Secondary Content may have a gap equal to or larger than three packs. As in a gap between S4 and S5 shown in FIG. 136, a gap of three packs or more may be assured, and packs of a Primary Content may be multiplexed in this gap.

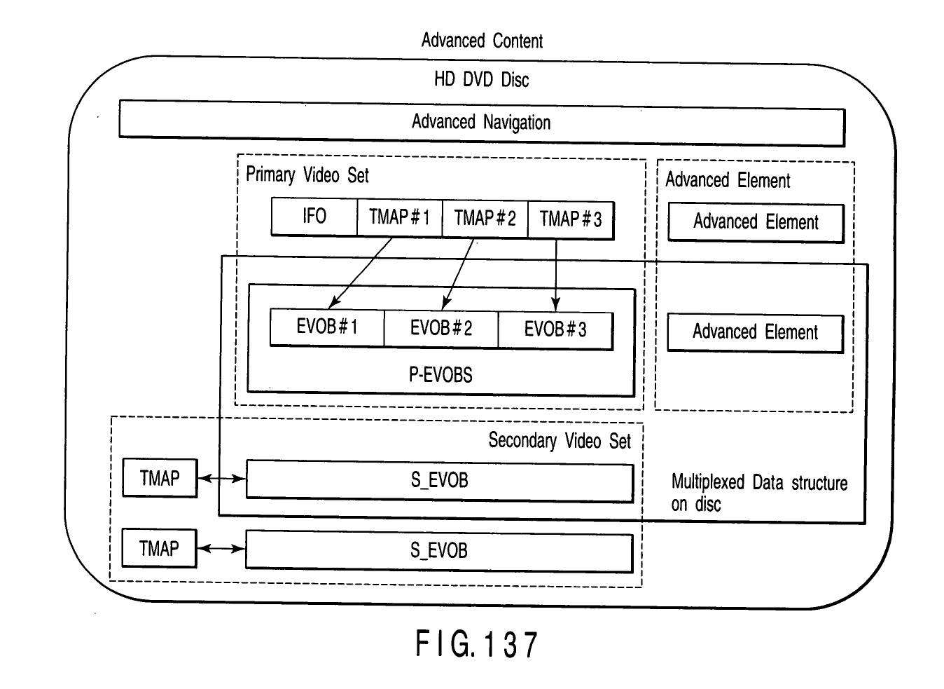

FIG. 137 illustrates an example of the types and formats of data which can be recorded on the Disc used in the embodiment of the invention. Referring to FIG. 137, “Advanced Navigation” indicates data associated with playback control to play back an advanced HD video title set and/or advanced contents shown in FIGS. 74 and 79, i.e., a data file described using a Markup or Script language or the like.

“Primary Video Set” indicates data of a main video stream of DVD represented by an advanced VTS. The “Primary Video Set” shown in FIG. 137 includes IFO data that stores management information of the main video stream, TMAP data each including a data table of a time period for each EVOB that forms the main video stream, offset information of the start positions of VOBUs each serving as one unit of playback management, and the like, an EVOB which forms one picture sequence that forms the main video stream, a P_EVOBS (Primary EVOBS) formed by a plurality of EVOBs, and the like.

“Secondary Video Set” is a video stream which is to be played back simultaneously with the main video stream, and is different from it. The difference from a Multi Angle video stream implemented by the conventional DVD is as follows. That is, the Multi Angle video stream selects and plays back one of a plurality of video streams. However, the “Secondary Video Set” can play back another video stream while playing back the main video stream. An S-EVOB (Secondary EVOB) indicates the video stream itself of the “Secondary Video Set”. In the description of this embodiment, assume that the “Secondary Video Set” does not have any of a Multi Angle function, subtitle function of the “Primary Video Set”, and the like but it includes simple video and audio data. In this case, IFO information that finely manages control of a playback sequence and the like is not always required, and TMAP information used to specify the position of the simple playback stream is prepared for each “S-EVOB”.

“Advanced Element” indicates playback data of an HDD player other than the “Primary Video Set” and “Secondary Video Set”. More specifically, the “Advanced Element” corresponds to still picture data such as JPEG, PNG, and the like, audio data used as effect tones to be played back upon clicking buttons, text data that provides text information described in a text subtitle, font data used to render the text data, and the like.

Data expressed by “Multiplexed Data structure on disc” in FIG. 137 are those which are stored in continuous sectors on the disc. In these sectors, “P-EVOBS”, “S-EVOB”, “Advanced Element”, and the like are interleaved and allocated. This is to take a measure for avoiding a problem that “P-EVOBS” data of the “Primary Video Set” cannot be supplied in time when data is read from separate sectors on the disc upon storing the “Advanced Element” in the data cache shown in FIG. 100.

In the embodiment of the invention, since the “Multiplexed Data structure” has a state in which “S-EVOB”, “Advanced Element”, and the like are interleaved in the entire sector data that form the “P-EVOBS”, the “Multiplexed Data structure” is allocated at the position of the advanced HD video title set in the video data recording area in the data structure of FIGS. 74 and 79. Also, the IFO information and TMAP data of the “Primary Video Set” are also stored at the position of the advanced HD video title set in the video data recording area.

On the other hand, TMAP data of the “Secondary Video Set”, S-EVOB data of the “Secondary Video Set” which is not interleaved in the “Multiplexed Data structure”, and “Advanced Element” data which is not interleaved in the “Multiplexed Data structure” are stored in the advanced contents recording area in FIGS. 74 and 79.

Furthermore, when these data on the disc are viewed from the viewpoint of the file system shown in FIG. 2, respective types of data interleaved in the “Multiplexed Data structure” cannot be distinguished from the file system, and are handled as a “.EVO” file of an advanced VTS. The IFO information and TMAP data of the “Primary Video Set” can be respectively accessed as a “.IFO” file and “.MAP” file of the advanced VTS.

TMAP data and S-EVOB data of the “Secondary Video Set” which are not interleaved in the “Multiplexed Data Structure”, and “Advanced Element” data which is not interleaved in the “Multiplexed Data structure” are handled as advanced contents, and can be accessed as file data in the ADV_OBJ directory.

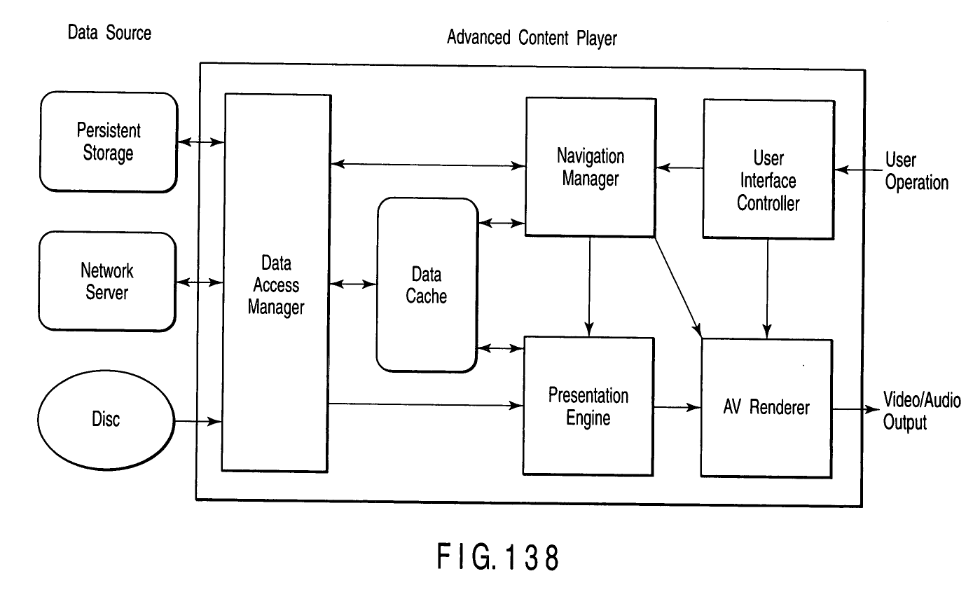

FIG. 138 is a block diagram showing the functional modules as large units for the playback system model of an HD_DVD player according to the embodiment of the invention. “Data Source” represents a data storage location accessible when this HD_DVD player executes playback. “Data Source” includes “Disc”, “Persistent Storage”, “Network Server”, and the like. “Disc” corresponds to DVD disc 1 in FIG. 100.

“Persistent Storage” corresponds to that in FIG. 100, and a NAS (Network Attached Storage) or the like present on a home network can also belong to the category of persistent storages. “Network Server” indicates a server present on the Internet. In general, a server managed by a movie picture company which provides a DVD disc can be assumed as the network server.

“Advanced Content Player” represents the whole playback system model of the HD_DVD player. The advanced content player is configured, as a large module, by “Data Access Manager”, “Data Cache”, “Navigation Manager”, “Presentation Engine”, “User Interface Controller”, and “AV Renderer”.

“Data Access Manager” manages data exchange between “Data Source” and the modules in “Advanced Content Player”. “Data Cache” is a data storage device which temporarily stores data used by “Navigation Manager” or “Presentation Engine” for playback.

“Navigation Manager” loads and interprets “Advanced Navigation”, controls “Presentation Engine”, “AV Renderer”, and the like, and manages playback control of a content type 2 or 3 disc. “Navigation Manager” loads “Startup File” from a disc and sets the HD_DVD player for playback control upon insertion of the disc.

“Presentation Engine” loads, from “Data Source” or “Data Cache”, “Primary Video Set” data, “Secondary Video Set” data, and “Advanced Element” data using “Data Access Manager” based on control commands and signals generated by “Navigation Manager” in accordance with playback control information of “Advanced Navigation”. “Presentation Engine” then plays back the loaded data and sends its output to “AV Renderer”.

“AV Renderer” performs α-blending or mixing control of video data or audio data output from “Presentation Engine” based on control commands or signals from “Navigation Manager” in accordance with playback control information from “Advanced Navigation”. “AV Renderer” finally outputs signals from the HD_DVD player to an external TV monitor or loudspeakers.

“User Interface Controller” transmits, as an event to “Navigation Manager”, a signal input from a user interface such as a front panel, remote controller, mouse, or the like. “User Interface Controller” also controls the display of a mouse cursor.

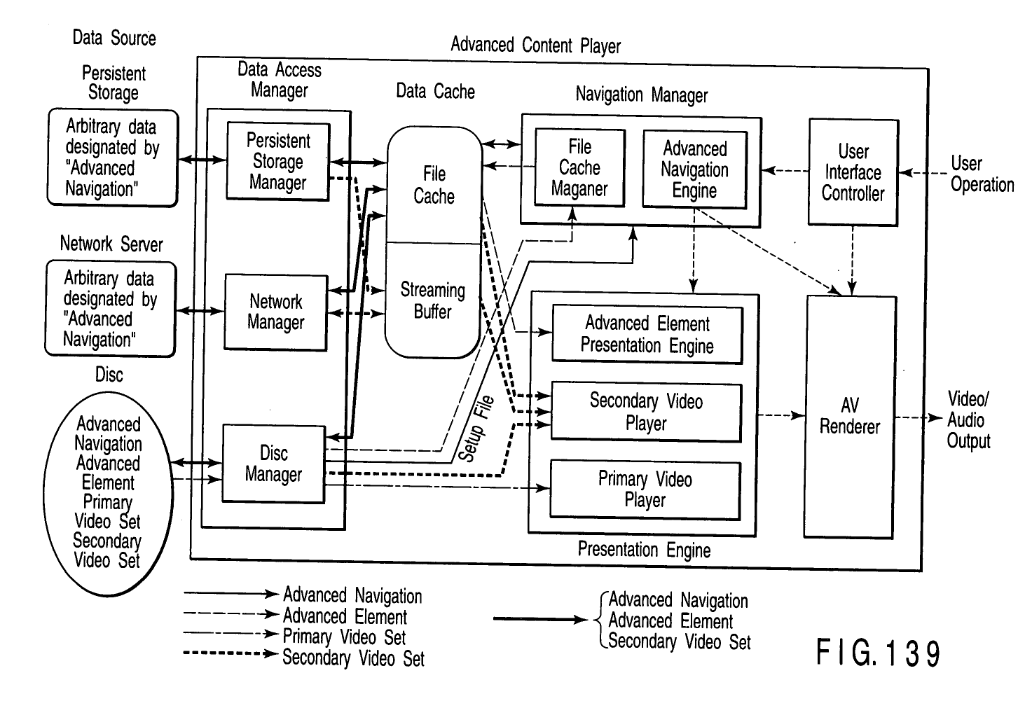

FIG. 139 is a detailed block diagram when FIG. 138 is illustrated from the viewpoint of a data flow. As a result of playback control of “Advanced Navigation”, all kinds of data can be stored in “Persistent Storage” or “Network Manager” as far as its capacity allows. The HD_DVD player can read/write-access “Persistent Storage” or “Network Manager”. Data loaded by “Advanced Content Player” and used for playback generally can include “Advanced Navigation”, “Advanced Element”, and “Secondary Video Set”. “Primary Video Set” is stored in only “Disc”, but not in “Persistent Storage” or “Network Server”.

As shown in FIG. 137, data stored in “Disc” can include “Advanced Navigation”, “Advanced Element”, “Primary Video Set”, and “Secondary Video Set”. “Disc” is a read only medium. No data is written in “Disc” by playback control of “Advanced Navigation”.

“Data Access Manager” incorporates “Persistent Storage Manager”, “Network Manager”, and “Disc Manager”, which generally manage data access from “Persistent Storage”, “Network Server”, and “Disc”, respectively. Data access to “NAS (Network Attached Storage)” included in “Persistent Storage” may be managed by “Persistent Storage Manager” using the “Network Manager” function.

A line directed from “Disc Manager” to “Navigation Manager” indicates the flow of data when “Navigation Manager” loads “Startup File” included in “Advanced Navigation” after predetermined disc type discrimination processing at the time of insertion of a disc. A line directed from “Disc Manager” to “Primary Video Player” indicates the data flow of “Primary Video Set”. A line directed from “Disc Manager” to “Secondary Video Player” indicates the data flow of “Second Video Set” interleaved in the multiplexed data structure on “Disc”.

A line directed from “Disc Manager” to “File Cache Manager” indicates the data flow of “Advanced Element” interleaved in the multiplexed data structure on “Disc”. A line directed from “Disc Manager” to “File Cache” indicates the data flow of “Advanced Navigation”, “Advanced Element”, and “Secondary Video Set” which are not included in the multiplexed data structure on “Disc”.

A line directed from “Persistent Storage” or “Network Server” to “File Cache” indicates the flow of “Advanced Navigation”, “Advanced Element”, and “Secondary Video Set” and their reverse flow. A line directed from “Persistent Storage” or “Network Server” to “Streaming Buffer” indicates the flow of “Secondary Video Set”.

A line directed from “File Cache” to “Navigation Manager” indicates the flow of mainly causing “Navigation Manager” to load “Advanced Navigation”. A line directed from “File Cache Manager” to “File Cache” indicates the flow of writing, in “File Cache” for each data file, the “Advanced Element” data sent from “Disc Manager” to “File Cache”. A line directed from “File Cache” to “Advanced Element Presentation Engine” indicates the flow of “Advanced Element”. A line directed from “File Cache” to “Secondary Video Player” indicates that the data flow when the TMAP or S-EVOB data of “Secondary Video Set” once stored as file data in “File Cache” is played back.

A line directed from “Streaming Buffer” to “Secondary Video Player” indicates the data flow in which a large “Secondary Video Set” stored in “Persistent Storage” or “Network Server” is loaded in “Streaming Buffer” little by little and is then supplied to “Secondary Video Player”. This operation is done due to the following reason. When data is supplied from “Data Source” whose data loading speed is not constant such as a general network, the data loading speed fluctuation is absorbed to minimize discontinuation of “Secondary Video Set” playback.

A dotted line directed from “Advanced Navigation Engine” to “Presentation Engine” or “AV Renderer” indicates a control signal. A line directed to “Presentation Engine” often indicates that text subtitle data stored in the “Advanced Navigation” data configured by Markup/Script data is supplied.

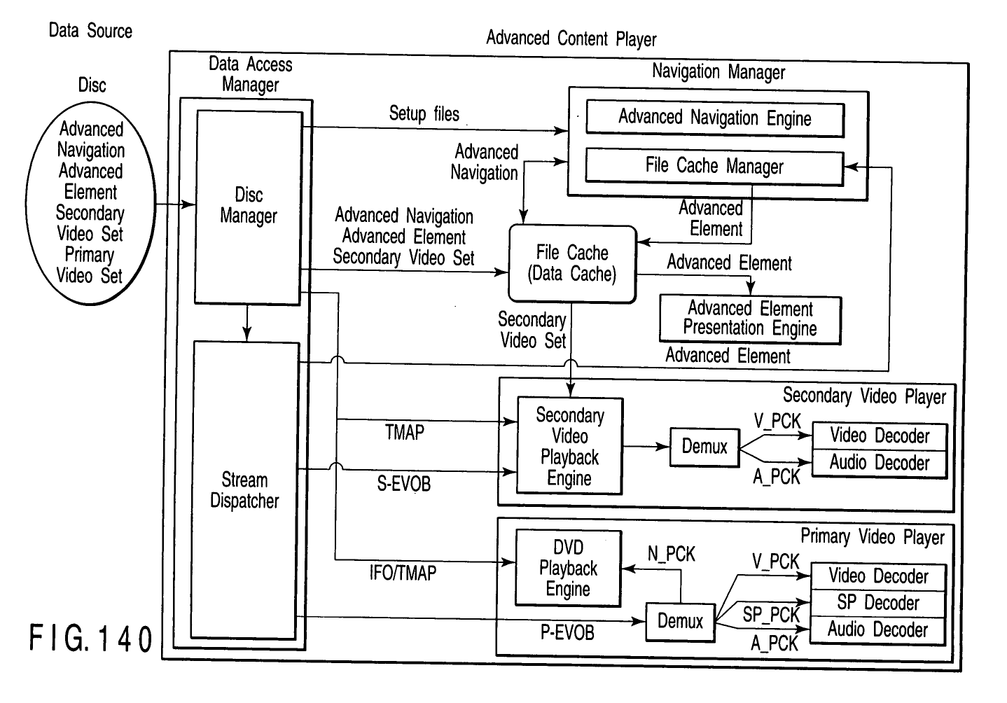

FIG. 140 is a more detailed block diagram when FIG. 139 is illustrated from the viewpoint of a data supply from “Disc”. In FIG. 139, only “Disc Manager” in “Data Access Manager” handles the data from “Disc”. However, in FIG. 140, “Stream Dispatcher” can also handle the data from “Disc”.

“Stream Dispatcher” serves to receive the multiplexed data structure shown in FIG. 137 from “Disc Manager”, and respectively supply P-EVOBS data, S-EVOB data, and “Advanced Element” data interleaved in the multiplexed data structure to a “Demux” device in “Primary Video Player”, “Secondary Video Playback Engine” in “Secondary Video Player”, and “File Cache Manager” in “Navigation Manager”.

Upon inserting “Disc” to the player according to the embodiment of the invention, “Disc Manager” supplies “Startup File” recorded on “Disc” to “Navigation Manager”. The “Advanced Navigation” file, “Advanced Element” file, and “Secondary Video Set” file which are managed in a file system on “Disc” are loaded in “File Cache” based on a result obtained when “Advanced Navigation Engine” in “Navigation Manager” interprets “Startup File” and “Advanced Navigation”.

When “Primary Video Player” is to play back “Primary Video Set”, the IFO data and TMAP data of “Primary Video Set” are loaded from “Disc Manager” onto “DVD Playback Engine”, prior to playback of “Primary Video Set”. “Primary Video Player” provides an upper-level control API (Application Interface) for playing back “Primary Video Set” to “Navigation Manager”. The upper-level control API is a level API such as “Play”, “FF”, “STOP”, or “PAUSE”. The detailed playback control processing of “Primary Video Set” is controlled by “DVD Playback Engine”.

“DVD Playback Engine” performs playback control of “Primary Video Set” in accordance with the upper-level control API from “Advanced Navigation Engine” according to the description of “Advanced Navigation”.

“Demux” demultiplexes P-EVOB data to supply a control pack (N_PCK) to “DVD Playback Engine” and supply a video pack (V_PCK), Sub-picture pack (SP_PCK), and audio pack (A_PCK) to “Video Decoder”, “SP Decoder”, and “Audio Decoder”, respectively. These Decoders decode the acquired PCK data in appropriate units.

When “Secondary Video Player” is to play back “Secondary Video Set” in which the S-EVOB is interleaved in the multiplexed data structure on “Disc”, the TMAP data of “Secondary Video Set” is loaded from “Disc Manager” onto “Secondary Video Playback Engine”, prior to playback of “Secondary Video Set”. “Secondary Video Set” managed on the file system can also be stored in “File Cache” temporarily, and then loaded and played back by “Secondary Video Playback Engine”.

“Secondary Video Player” provides an upper-level control API for playing back “Secondary Video Set” as well as “Primary Video Player”.

“Secondary Video Playback Engine” performs playback control of “Secondary Video Set” in accordance with the upper-level control API from “Advanced Navigation Engine” according to the description of “Advanced Navigation”.

“Demux” in “Secondary Video Player” demultiplexes the S-EVOB data to supply a video pack (V_PCK) and audio pack (A_PCK) to “Video Decoder” and “Audio Decoder”, respectively.

In the model of this embodiment, “Second Video Set” includes only the video pack and audio pack. However, “Secondary Video Set” may have a structure which also includes a Sub-picture pack and control pack.

“File Cache Manager” acquires “Advanced Element” data packs output from “Stream Dispatcher” and writes the packs in “File Cache” as one file belonging to “Advanced Element” after the pack data are acquired by an amount which allows to handle the data as one file data.

For example, when large file data such as font data is to be written in “File Cache”, the file data may be started to be written in “File Cache” before all the font file data are collected in “File Cache Manager”, and the file data may be successively written in “File Cache” to form a final font file in “File Cache”.

“Advanced Element” stored in the multiplexed data structure can also be compressed and then interleaved. In this case, “File Cache Manager” loads the compressed “Advanced Element” data by a decompressable size to perform decompression processing. “File Cache Manager” then writes the “Advanced Element” file generated as a result of the decompression processing in “File Cache”. The “Advanced Element” data may be compressed for each file. Alternatively, an archive including the plurality of “Advanced Element” files may be compressed.

“Advanced Element Presentation Engine” loads the “Advanced Element” data from “File Cache”, and executes decoding processing and the like of “Advanced Element” based on control commands/signals from “Advanced Navigation Engine” in accordance with the description of “Advanced Navigation”.

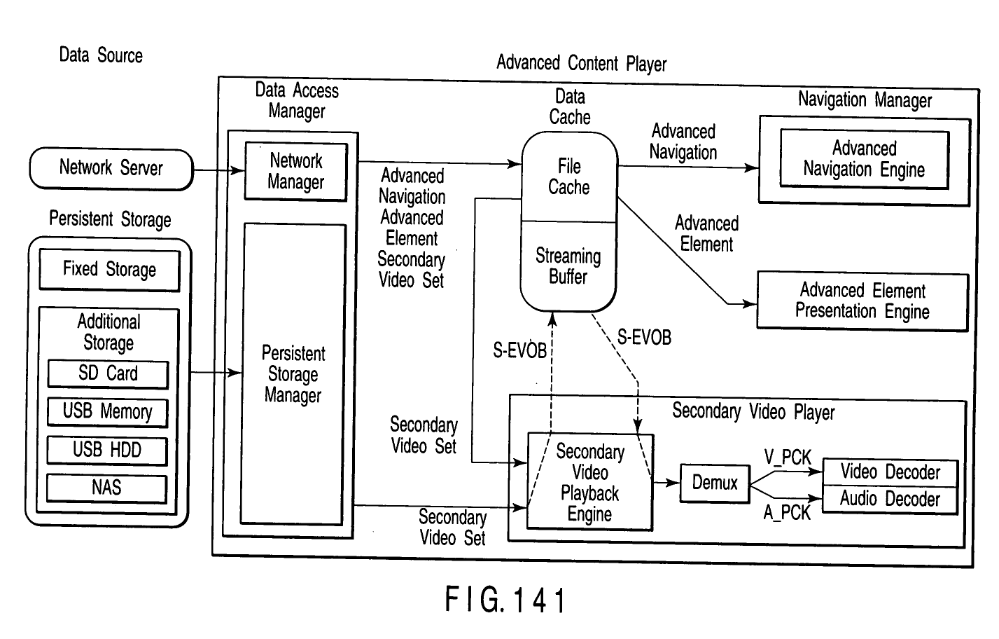

FIG. 141 is a more detailed block diagram when FIG. 139 is illustrated from the viewpoint of a data supply from “Network Server” and “Persistent Storage”. A device serving as “Persistent Storage” can be divided into “Fixed Storage” and “Additional Storage”. “Fixed Storage” is a recording medium permanently connected to the HD_DVD player, and generally corresponds to a FLASH memory.

“Additional Storage” is a recording medium which is detachable from the HD_DVD player. “Additional Storage” can include a memory card represented by an SD card, a memory device and HDD device which are connected via a connection interface such as a USB, a NAS (Network Attached Storage) connected on the network, and the like.

As in the supply model from “Disc” shown in FIG. 140, “File Cache” is supplied with data such as “Advanced Navigation”, “Advanced Element”, and “Secondary Video Set” via “Network Manager” and “Persistent Storage Manager”.

When “Secondary Video Set” having the S-EVOB data whose capacity is larger than that of “File Cache” is to be played back, the data is directly supplied to “Secondary Video Playback Engine” sequentially, to play back “Secondary Video Set”. At this time, in accordance with control described in “Advanced Navigation”, “Secondary Video Playback Engine” can play back “Secondary Video Set” while temporarily storing it in “Streaming Buffer”. This operation is done due to the following reason. When data supply speed is not constant such as a network, discontinuation of “Secondary Video Set” playback is minimized. Generally, “Streaming Buffer” need not be used in order to play back “Secondary Video Set” loaded in “File Cache”.

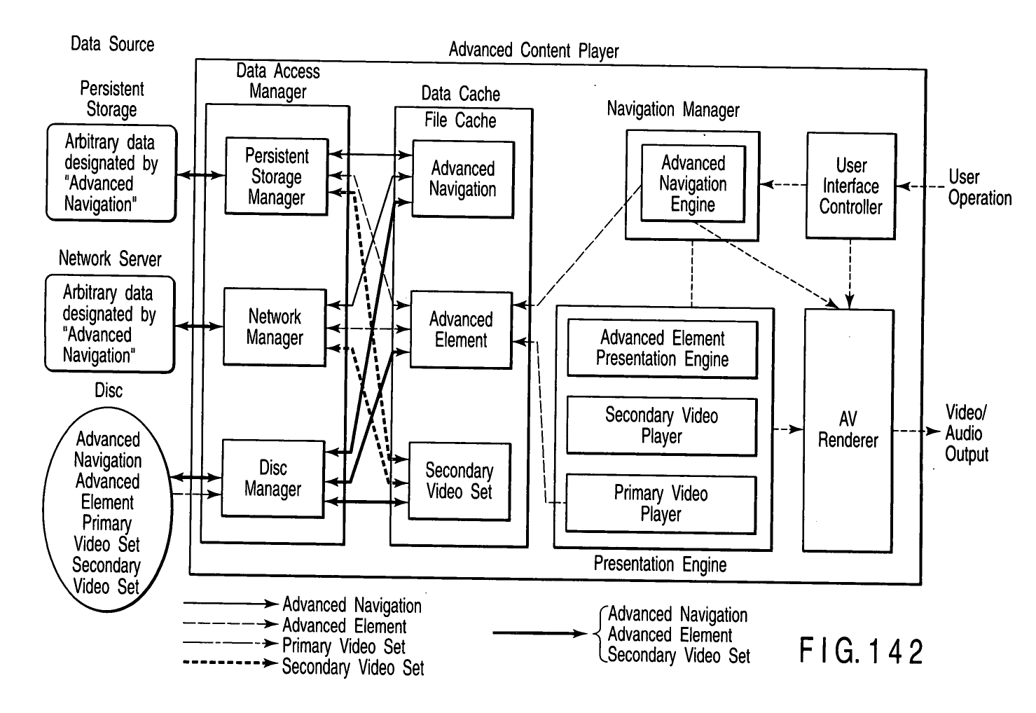

FIG. 142 is a detailed block diagram when FIG. 139 is illustrated from the viewpoint of the data storage flow to “Persistent Storage” and “Network Server”. A line directed from “Advanced Navigation Engine” to “Advanced Element” indicates the flow of causing “Advanced Navigation Engine” to write, in “File Cache”, “Advanced Element” such as the data file generated using the Script language or the like. “Advanced Navigation Engine” generates a file for recording the number of times of viewing the video on “Disc” by using the description in, e.g., the Script language and stores the generated file in “Persistent Storage”. Whenever the user has finished viewing the video picture data on “Disc”, “Advanced Navigation Engine” updates the data in the file. “Advanced Navigation Engine” may display the number of times of viewing the video on a screen, or it may send the score data of a game created using the Script language to “Network Server” to compete in the game to earn a high score. Such data generated by “Advanced Navigation Engine” is temporarily stored in “File Cache”, and then copied or moved to appropriate storage destinations.

A line directed from “Primary Video Player” to “Advanced Element” indicates the flow of pausing the video picture data whose playback is underway in “Primary Video Set” in accordance with the description of “Advanced Navigation Engine” or interpretation of a user operation, and writing, in “File Cache”, “Advanced Element” such as an image file obtained by capturing a frame or the like. The generated captured frames may be collected to make an original chapter collection with appropriate comments. The data may be stored in “Persistent Storage” and the like to view the video picture data by selecting a scene based on the original chapter frames from the next time. Frame capturing sources may include the “Secondary Video Set” frame output from “Secondary Video Player”, a graphic frame output from “Advanced Element Presentation Engine”, or an output picture from “AV Renderer” obtained by mixing these frames.

The data generated by “Navigation Manager”, “Presentation Engine”, and the like are temporarily stored in “File Cache”, and then stored on an appropriate Data Source medium in accordance with the description of “Advanced Navigation”. Similarly, when the contents in “Persistent Storage”, “Network Server”, and “Disc” are to be stored in or uploaded to “Persistent Storage” or “Network Server”, the data is temporarily loaded in “File Cache”, and then stored on an appropriate Data Source medium, in accordance with the description of “Advanced Navigation”.

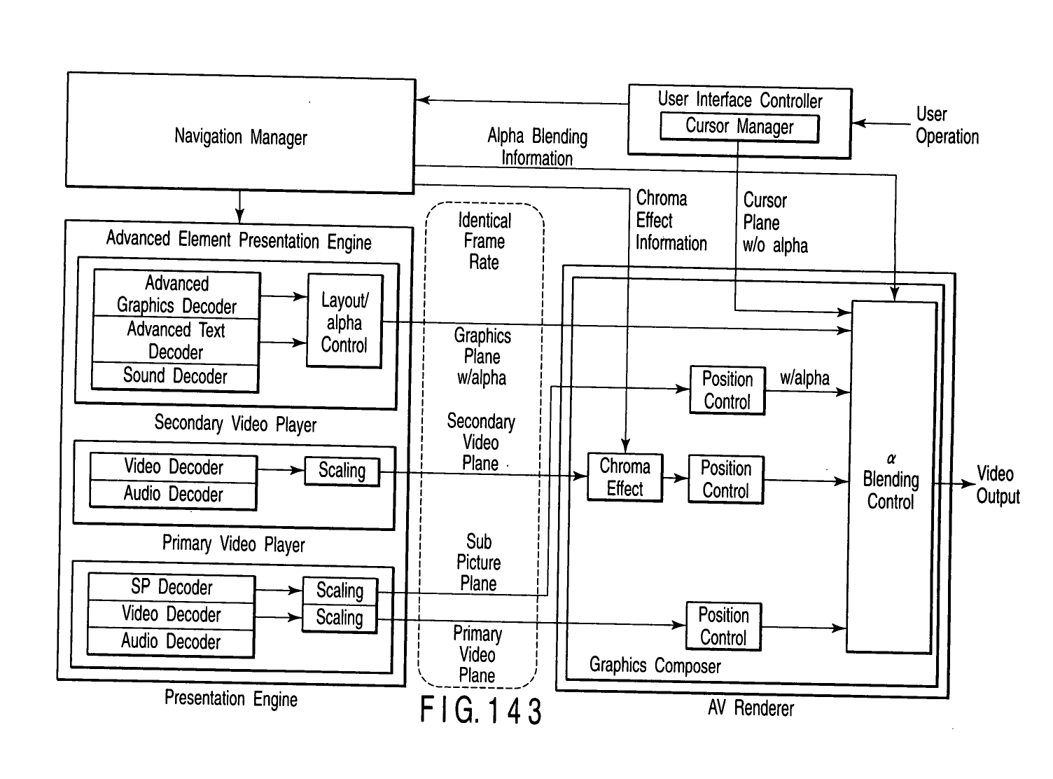

FIG. 143 is a detailed block diagram of a blending model of picture outputs. FIG. 143 assumes outputs of five picture planes. The five picture planes include “Primary Video Plane”, “Secondary Video Plane”, “Sub-picture Plane”, “Graphics Plane”, and “Cursor Plane” when they are described in turn from planes of lower layers.

“Primary Video Plane” is a video output plane of “Primary Video Set”. In this model, “Primary Video Plane” is supplied to “AV Renderer” via a “Scaling” device. This model does not assume that any α value (a value that determines a contrast ratio) is applied to “Primary Video Plane”. However, when, for example, a background plane or the like is prepared as an underlying layer of “Primary Video Plane”, application of the a value to “Primary Video Plane” is effective to enhance the powers of expression.

“Secondary Video Plane” is a video output plane of “Secondary Video Set”. In this model, “Secondary Video Plane” is supplied to “AV Renderer” via a “Scaling” device. This model incorporates a “Chroma Effect” function to implement a function of extracting the shape of an object in a video and superimposing it on the output of “Primary Video”. This function can be implemented by painting a portion other than the object to be extracted in a specific color, and handling the portion in that color as a transparent portion.

“Sub-picture Plane” is a Sub-picture output plane of “Primary Video Set”. In this model, “Sub-picture Plane” is supplied to “AV Renderer” via a “Scaling” device. For example, when Sub-picture data of the SD size is prepared in advance, or when Sub-picture data for Pan Scan output or that for Letter Box output of the SD size is prepared in advance, the “Scaling” device outputs Sub-picture data suited to the output size from “SP Decoder” without any processing, thus blending it to the entire picture.

“Graphics Plane” is a picture output plane of “Advanced Element Presentation Engine”. This model assumes that “Advanced Graphic Decoder” processes picture data such as picture data of JPEG, PNG, and the like, and those such as cell animation, vector animation, and the like, and “Advanced Text Decoder” processes to output a text picture using font data. These decoding result outputs for respective objects are sent to “Layout/Alpha Control”, and undergo layout control and α-blending control in accordance with control information of “Navigation Manager” obtained by interpreting “Advanced Navigation”. Layout processing includes scaling of objects and the like.

“Cursor Plane” is managed and output by “Cursor Manager” in “User Interface Controller”. In this model, an a value is set for a Cursor object, and is blended to other planes.

The above five picture data are output from respective Decoders in formats corresponding to the output frame rate of final video data of the HD_DVD player. When these outputs are supplied to “AV Renderer”, all plane data are supplied in the same frame rate/format.

“Graphic Composer” is a module which manages blending of the aforementioned five picture outputs, and includes “a Blending Control”, “Position Control”, “Chroma Effect”, and the like.

As described above, “Chroma Effect” is a function module which processes a color designated by “Navigation Manager” as a transparent color so as to extract the shape of a predetermined object from the video output of “Secondary Video Player”. In practice, since the “Secondary Video” output often suffers a change in color value of a pixel as a “Chroma Key” due to the use of Lossy codec such as MPEG2 or the like, it is effective to incorporate a function of extracting the shape of an object more precisely by designating the “Chroma Key” to have a certain range in place of using one color or by applying image processing.

“Position Control” supplies a picture obtained by controlling the layout position of input video data with respect to the entire picture output size to “a Blending Control”.

“a Blending Control” blends the aforementioned video data in accordance with an instruction of “Advanced Navigation” interpreted by “Navigation Manager”, and generates a final video output picture.

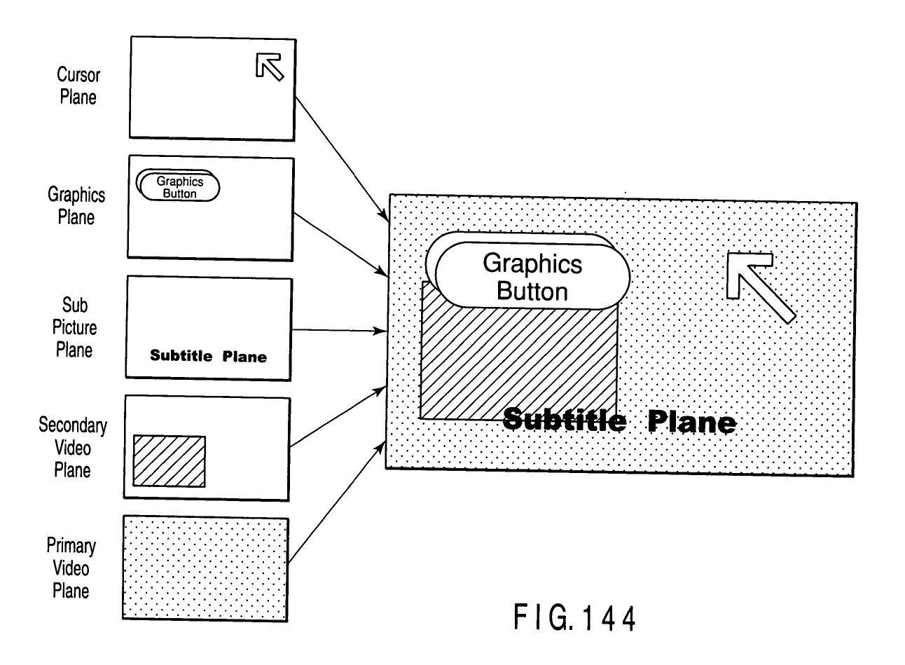

FIG. 144 is a view showing an example of an actual picture output of the blending model of picture outputs in FIG. 143. A video output of “Primary Video Set” of “Primary Video Plane” is generally main video moving picture data of DVD, and is displayed on the entire screen. A video output of “Secondary Video Set” of “Secondary Video Plane” is normally laid out in “Primary Video Plane” in a format of “Picture In Picture”, and is α-blended to the “Primary Video” picture in accordance with the description of “Advanced Navigation”. Also, as described above, an object shape can be extracted, and can be blended to “Primary Video Plane”.

An output of “Sub-picture Plane” is Sub-picture data stored in “Primary Video Set”, which is given a values on the pixel level, and is blended to the blended picture of “Primary Video Plane” or “Secondary Video Plane” as a background.

values of an output of “Graphics Plane” are controlled on the pixel level, and the a value of the entire plane is never controlled by “Navigation Manager”. “Navigation Manager” controls a values for respective objects such as a button picture, text, and the like to be laid out on “Graphics Plane”. Upon controlling a values on the pixel level, a picture object itself has to use a format that can describe a values on the pixel level. As such format, PNG, JPEG2000, and the like can be used. As for text, when a character picture which is output once undergoes scaling, a character is crushed and becomes very illegible in some cases. Hence, picture data to be supplied to “Layout/a Control” is decoded in advance in correspondence with the size of a final output picture, thus effectively avoiding deterioration of image quality due to scaling.

“Cursor Plane” corresponds to a pointer picture which moves on the screen in response to an event of a mouse or arrow keys of a remote controller or the like. This pointer picture can be replaced by an “Advanced Element” picture based on the description of “Advanced Navigation”. To “Cursor Plane”, an α value can be applied on the object (plane) level.

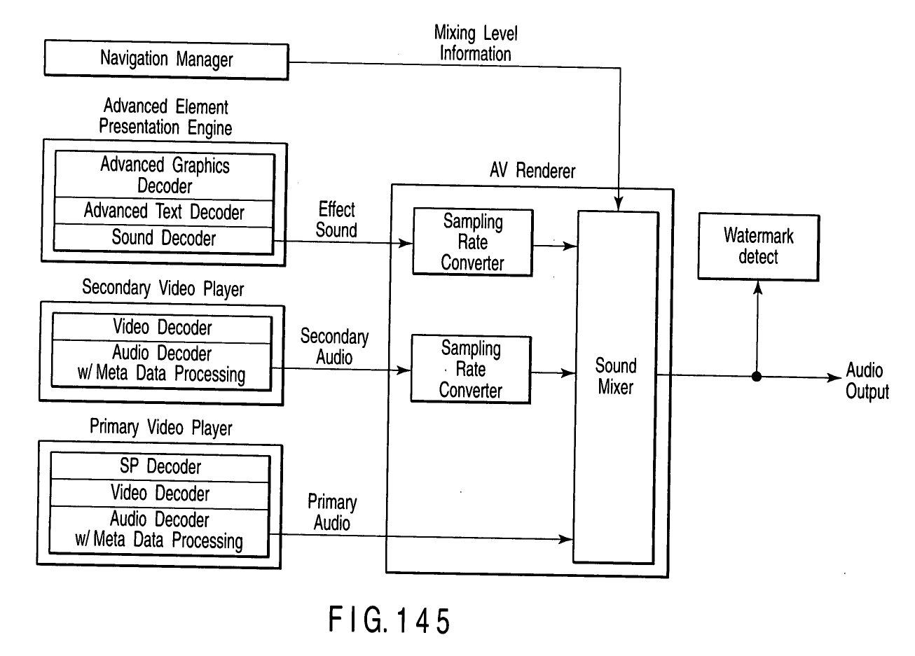

FIG. 145 is a diagram showing a mixing model of audio outputs. In this model, three audio outputs are mixed. That is, “Primary Audio” is an audio output of “Primary Video Set”. “Secondary Audio” is an audio output of “Secondary Video Set”. Note that “Secondary Video Set” need not always include any video output, and “Secondary Video Set” including an audio alone may be present.

“Audio Decoder” in “Primary Video Player” and that in “Secondary Video Player” can control to change the mixing level on the frame level by interpreting meta data in respective audio elementary streams. In the example of this model, the meta data processing is completed in respective Decoders. Alternatively, meta data information may be sent to “Sound Mixer” and may be processed in “Sound Mixer”.

“Sound Decoder” in “Advanced Element Presentation Engine” outputs effect sounds and the like produced when buttons are clicked. The mixing processing of audio outputs is implemented by “Sampling Rate Converters” and “Sound Mixer” in “AV Renderer”.

Since this model adjusts the sampling rates of “Secondary Audio and “Effect Sound” to that of “Primary “Audio” under the assumption that the audio output of “Primary Audio” is supplied with the best sound quality, the output of “Primary Audio” does not comprise any “Sampling Rate Converter”. Upon implementing a function of dropping the quality of the audio outputs so as to realize an inexpensive HD_DVD player, it is effective to insert a “Sampling Rate Converter” in the output of “Primary Audio”.

Respective audio signals are supplied to “Sound Mixer” while their sampling rates are standardized by “Sampling Rate Converters”. “Sound Mixer” mixes and outputs these three audio signals in accordance with a mixing level designated by “Navigation Manager” in accordance with the description of “Advanced Navigation”. When the HD_DVD player comprises an analog audio output, the mixed audio signal is supplied to a D/A converter; when it comprises a digital output, the mixed audio signal is supplied to an appropriate encode processor.

“Watermark Detect” is a module for checking the output audio signal from “Sound Mixer” and detecting the presence/absence of copyright control information.

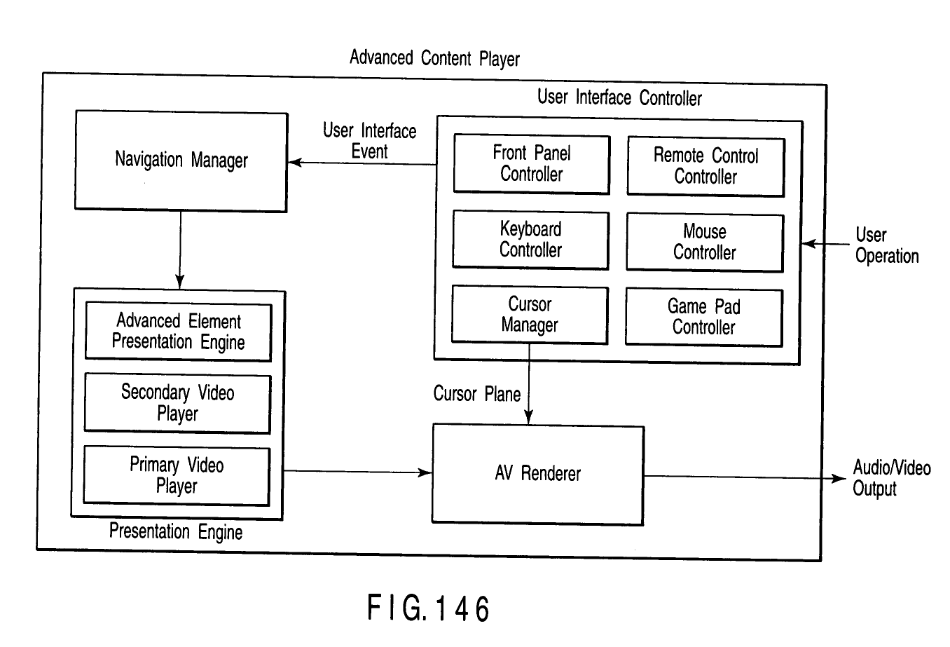

FIG. 146 is a diagram showing user interface processing managed by “User Interface Controller”. In this model, a front panel, remote controller, keyboard, mouse, and game pad are exemplified as user input devices. “Cursor Manager” controls the display position of the cursor object on the screen in accordance with the arrow keys or a move event of the remote controller or mouse, as described above. “Navigation Manager” is informed of a button depression event on the remote controller or keyboard as “User Interface Event”.

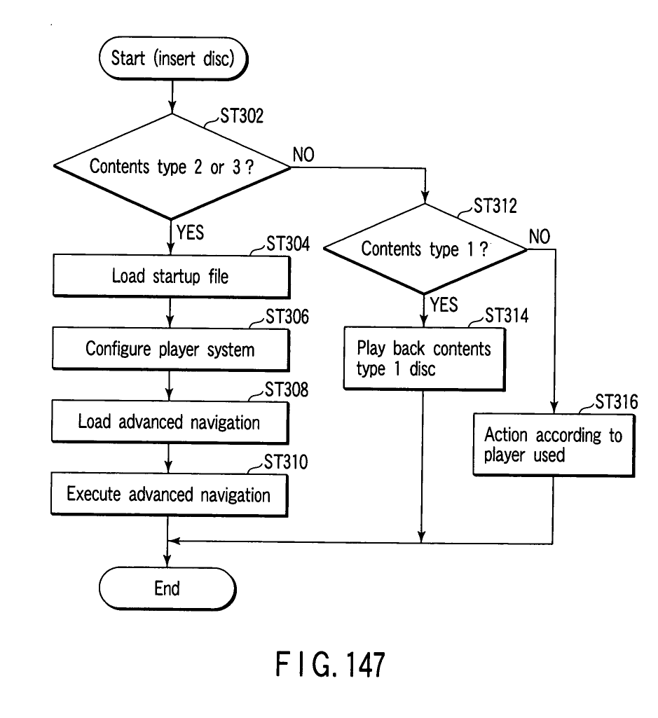

FIG. 147 is a flowchart showing the flow of startup processing after disc insertion. When a disc is inserted into the HD_DVD player, the contents type is detected first. The contents type detection can be implemented using the presence/absence of an advanced VTS, that of a specific Markup file, and the like as the conditions. If the disc is a contents type 2 or 3 disc (YES in block ST302), a startup file is loaded from the disc (block ST304). As the data structure of contents type 2 or 3, a disc including an advanced VTS alone, as shown in FIG. 74, and a disc including both an advanced VTS and standard VTS, as shown in FIG. 79 are available.

After the startup file is interpreted, player configurations are changed according to its description (block ST306: configure player system). Information to be changed includes the distribution of the file cache of the data cache, the configuration of network connection, and the like. After that an advanced navigation file for an initial operation, which describes the startup file, is loaded from the disc, network server, persistent storage, or the like (block ST308), and advanced navigation processing described in the startup file is started (block ST310).

On the other hand, if the disc is a contents type 1 disc (NO in block ST302, YES in block ST312), playback processing of a standard VTS is executed according to the conventional DVD (block ST314). The contents type 1 disc includes a standard VTS alone, as shown in FIG. 73. If the disc is other than those described above (NO in block ST302, NO in block ST312), each playback processing is executed according to a media type supported by an individual HD_DVD player that plays back the disc of interest (block ST316).

<Summary>

An information storage medium (high-definition video disc or the like) according to the embodiment of the invention has a data area (12) storing a video data recording area (20) that includes a management area (30) which records management information and an object area (40, 50) which records objects to be managed by this management information, and an advanced contents recording area (21) which includes information (21A to 21E) different from the recording contents (30 to 50) of the video data recording area (20), and a file information area (11) that stores file information corresponding to the recording contents of the data area (12). In this information storage medium, the object area (40, 50) is configured to store enhanced video objects (objects in an HDVTS; and abbreviated as EVOBS or VOBS as needed) whose playback is managed using a logical unit called a program chain, and Advanced Objects (objects in an AHDVTS) recorded independently of the enhanced video objects. Each Advanced Object is configured to store playback sequence information (playback control information implemented by a Markup language or the like shown in FIGS. 95 to 98) that describes the playback order of enhanced video objects, playback control information that gives the playback conditions (playback timings, picture output positions, display sizes, etc.) of other Advanced Objects, and the like.

The provider (or producer) of contents recorded on the information storage medium can describe the aforementioned playback conditions (or playback control information, playback sequence information, or the like) using a predetermined language (markup language or the like). When the provider supplies the markup language that gives the playback conditions to the playback apparatus using a network (Internet or the like), management information which is recorded on the information storage medium and is uniquely determined so far can be updated.

Furthermore, for example, by distributing the playback control information that controls playback of video objects via the Internet or the like after the disc is prepared, or by adding the aforementioned playback control information to the video disc which is prepared once, a new disc can be manufactured without re-manufacturing the whole disc. More specifically, video objects which cannot be played back upon shipping of a DVD-Video disc can be played back under a specific condition using playback control information delivered via the Internet, or bugs remaining upon shipping the DVD-Video disc can be controlled using the playback control information, thus correcting problems.

Put differently, according to the embodiment of the invention, a scheme that allows the user to freely change and enjoy the playback sequence of Advanced Objects and/or enhanced video objects using playback control information implemented by a Markup language or the like upon production of an information storage medium (ROM-based disc) or after its sales can be provided.

The data area (12) is configured to store a Primary Object set (P-EVOBS) which is a set of one or more Primary Objects (EVOB#1, EVOB#2, etc.) whose relationship between the playback times (TM_DIFF, etc.) and recording positions (TM_EN_ADR, etc.) is managed by one or more time maps (TMAP#1, TMAP#2, etc.; corresponding to TMAPIT), and form a main video stream, and a Secondary Object (S-EVOB) which is an object whose relationship between the playback times (TM_DIFF) and recording positions (TM_EN_ADR) is managed by individual time maps (TMAP) and forms another video stream which can be simultaneously played back with the main video stream.

Note that playback of the one or more Primary Objects (EVOB#1, EVOB#2, etc.) can be managed using the playback times based on the one or more time maps (TMAP#1, TMAP#2, etc.; corresponding to TMAPIT), and that of the Secondary Object (S-EVOB) which can be played by simultaneously with (or in synchronism with) an arbitrary one of these Primary Objects (EVOB#1, EVOB#2, etc.) can be managed using the playback time based on the individual time map (TMAP). In this case, the playback timing and/or playback period with the Secondary Object which is played back simultaneously with (in synchronism with) a given Primary Object can be freely set using the predetermined language (Markup language or the like).

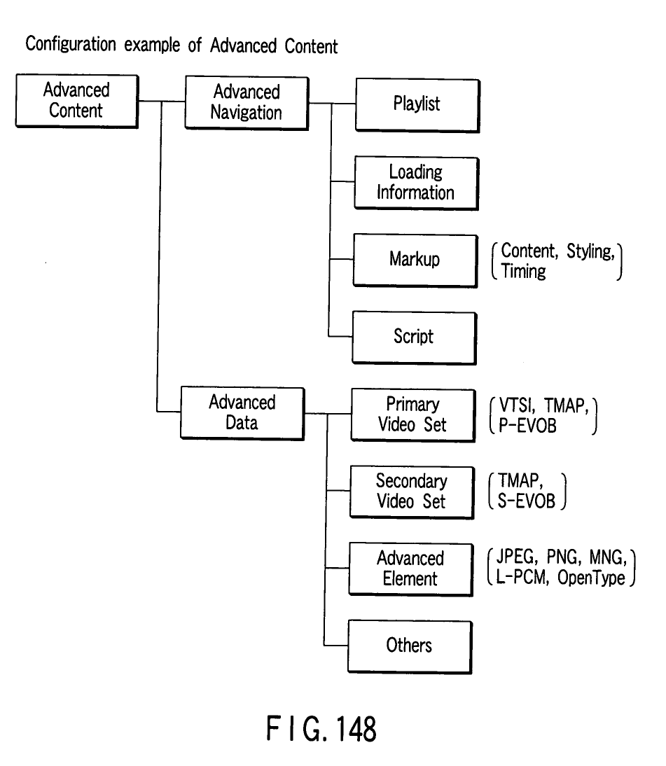

FIG. 148 is a view for explaining a configuration example of an Advanced Content. The Advanced Content is configured to include Advanced Navigation that manages Primary/Secondary Video Set output, text/graphic rendering, and audio output, and Advanced Data including these data managed by the Advanced Navigation. The Advanced Navigation includes Playlist files, Loading Information files, Markup files (for content, styling, timing information), and Script files. Also, the Advanced Data includes a Primary Video Set (VTSI, TMAP, and P-EVOB), Secondary Video Set (TMAP and S-EVOB), Advanced Element (JPEG, PNG, MNG, L-PCM, OpenType font, etc.), and the like.

Note that a Playlist file which is described in XML (markup language) is allocated on the disc. A playback apparatus (player) of this disc is configured to play back this Playlist file first (prior to playback of the Advanced content) when that disc has the Advanced content.

This Playlist file can include the following pieces of information (see FIG. 236 to be described later):

*Object Mapping Information (information which is included in each title and is used for playback objects mapped on the timeline of this title);

*Playback Sequence (playback information for each title which is described based on the timeline of the title); and

*Configuration Information (information for system configurations such as data buffer alignment, etc.)

Note that a Primary Video Set is configured to include Video Title Set Information (VTSI), an Enhanced Video Object Set for Video Title Set (VTS_EVOBS), a Backup of Video Title Set Information (VTSI_BUP), and Video Title Set Time Map Information (VTS_TMAP).

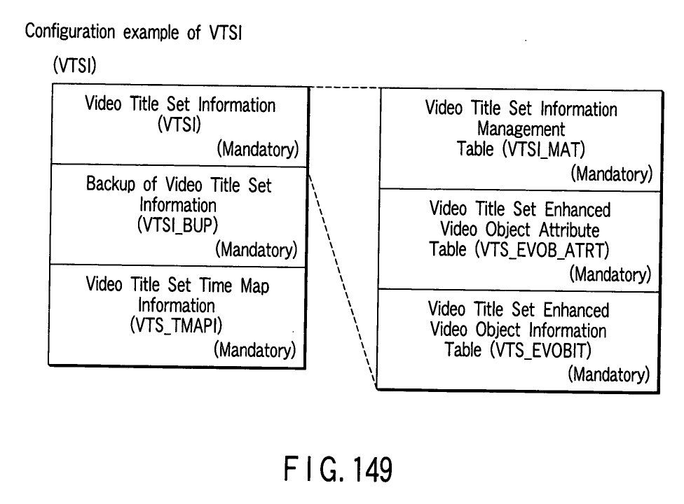

FIG. 149 is a view for explaining a configuration example of video title set information (VTSI). The VTSI describes information of one video title. This information makes it possible to describe attribute information of each EVOB. This VTSI starts from a Video Title Set Information Management Table (VTSI_MAT), and a Video Title Set Enhanced Video Object Attribute Information Table (VTS_EVOB_ATRT) and Video Title Set Enhanced Video Object Information Table (VTS_EVOBIT) follow that table. Note that each table is aligned to the boundary of neighboring logical blocks. Due to this boundary align, each table can follow up to 2047 bytes (that can include 00h).

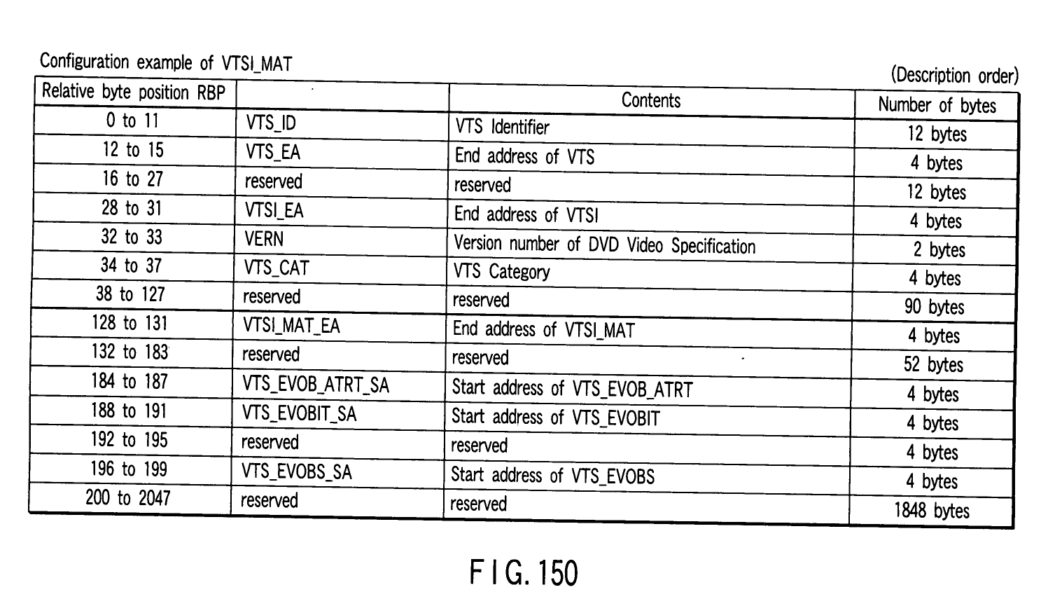

FIG. 150 is a view for explaining a configuration example of the video title set information management table (VTSI_MAT). In this table, a VTS_ID which is allocated first as a relative byte position (RBP) describes “ADVANCED-VTS” used to identify a VTSI file using character set codes of ISO646 (a-characters). The next VTS_EA describes the end address of a VTS of interest using a relative block number from the first logical block of that VTS. The next VTSI_EA describes the end address of VTSI of interest using a relative block number from the first logical block of that VTSI. The next VERN describes a version number of the DVD-Video specification of interest.

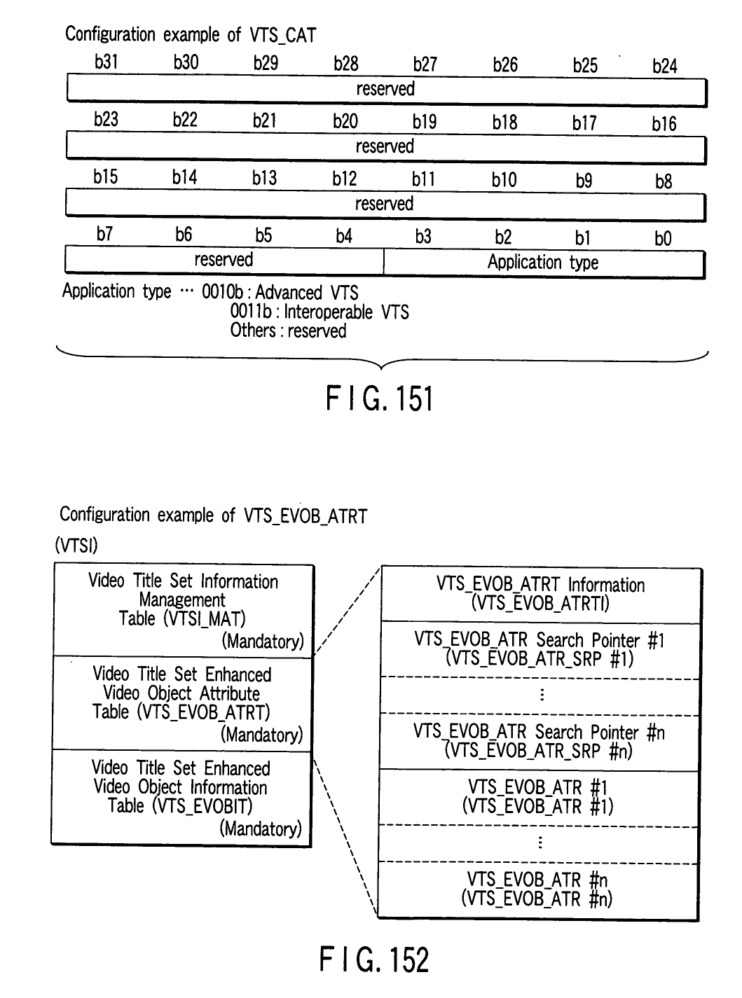

FIG. 151 is a view for explaining a configuration example of a video title set category (VTS_CAT). This VTS_CAT is allocated after the VERN in FIG. 150, and includes information bits of an Application type. With this Application type, an Advanced VTS (=0010b), Interoperable VTS (=0011b), or others can be discriminated. After the VTS_CAT in FIG. 150, the end address of the VTSI_MAT (VTSI_MAT_EA), the start address of the VTS_EVOB_ATRT (VTS_EVOB_ATRT_SA), the start address of the VTS_EVOBIT (VTS_EVOBIT_SA), the start address of the VTS_EVOBS (VTS_EVOBS_SA), and others (Reserved) are allocated.

FIG. 152 is a view for explaining a configuration example of the video title set enhanced video object attribute table (VTS_EVOB_ATRT). This table describes attribute information of defined in each EVOB in the Primary Video Set. This table starts from VTS_EVOB_ATRT information (VTS_EVOB_ATRTI), and one or more VTS_EVOB_ATR search pointers (VTS_EVOB_ATR_SRPs) and one or more VTS_EVOB attributes (VTS_EVOB_ATRs) follow that information. One VTS_EVOB attribute (VTS_EVOB_ATR) corresponds to attributes of one or more arbitrary EVOBs in the Primary Video Set.

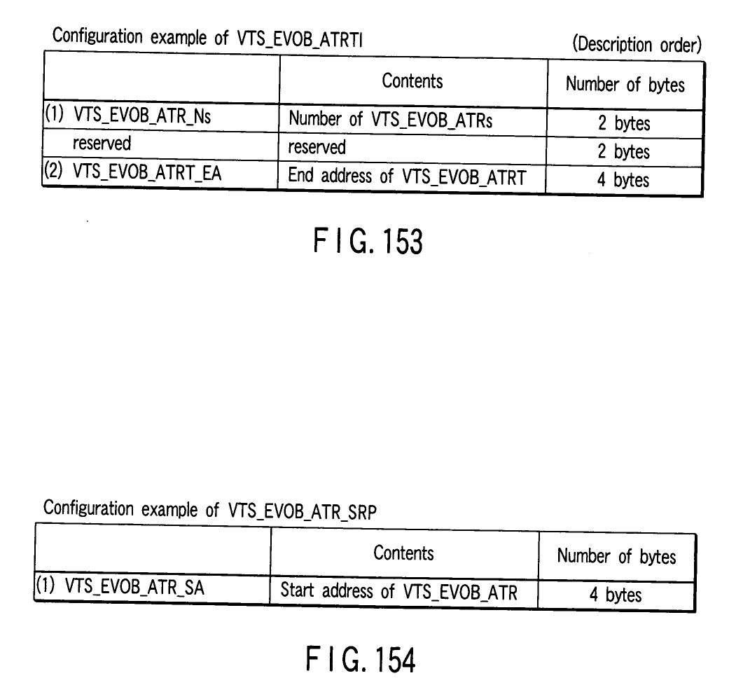

FIG. 153 is a view for explaining a configuration example of the video title set enhanced video object attribute table information (VTS_EVOB_ATRTI). This attribute table information (VTS_EVOB_ATRTI) includes information indicating the number of VTS_EVOB ATRs (VTS_EVOB_ATR_Ns) and the end address of the VTS_EVOB_ATRT (VTS_EVOB_ATRT_EA).

FIG. 154 is a view for explaining a configuration example of the video title set enhanced video object attribute search pointer (VTS_EVOB_ATR_SRP). This attribute search pointer (VTS_EVOB_ATR_SRP) includes the start address of the VTS_EVOB_ATR (VTS_EVOB_ATR_SA).)

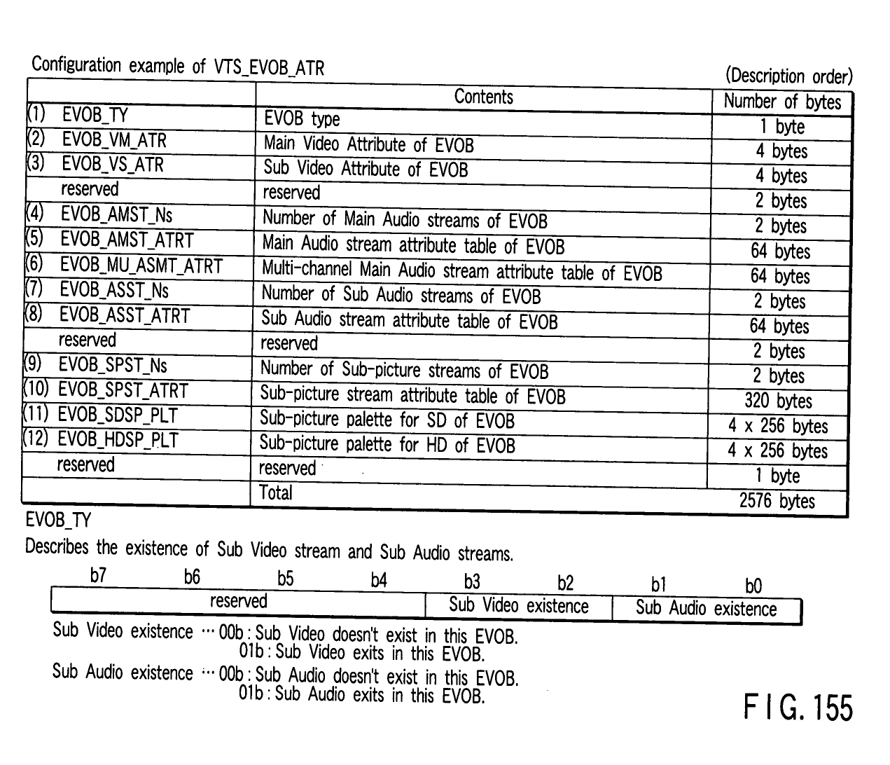

FIG. 155 is a view for explaining a configuration example of the video title set enhanced video object attribute (VTS_EVOB_ATR). One VTS_EVOB attribute (VTS_EVOB_ATR) is configured to include an EVOB type (EVOB_TY), a main video attribute of an EVOB (EVOB_VM_ATR), a sub video attribute of the EVOB (EVOB_VS_ATR), the number of main audio streams of the EVOB (EVOB_AMST_Ns), a main audio stream attribute table of the EVOB (EVOB_AMST_ATRT), a multichannel main audio stream attribute table of the EVOB (EVOB_MU_AMST_ATRT), the number of sub audio streams of the EVOB (EVOB_ASST_Ns), a sub audio stream attribute table of the EVOB (EVOB_ASST_ATRT), the number of Sub-picture streams of the EVOB (EVOB_SPST_Ns), a Sub-picture stream attribute table of the EVOB (EVOB_SPST_ATRT), a Sub-picture palette for SD of the EVOB (EVOB_SDSP_PLT), a Sub-picture palette for HD of the EVOB (EVOB_HDSP_PLT), and the like.

Note that the EVOB_TY is configured to include Sub Video existence and Sub Audio existence. The Sub Video existence is information indicating whether or not a Sub Video exists in the EVOB of interest (00b, not exist; 01b, exist), and the Sub Audio existence is information indicating whether or not a Sub Audio exists in the EVOB of interest (00b, not exist; 01b, exist).

Note that a plurality of EVOBs can share the same VTS_EVOB_ATR (one attribute can be commonly used by a plurality of EVOBs). When a plurality of multiplexed EVOBs belong to one Interleaved Block for seamless angle switching, the same attribute (VTS_EVOB_ATR) is applied to these EVOBs.

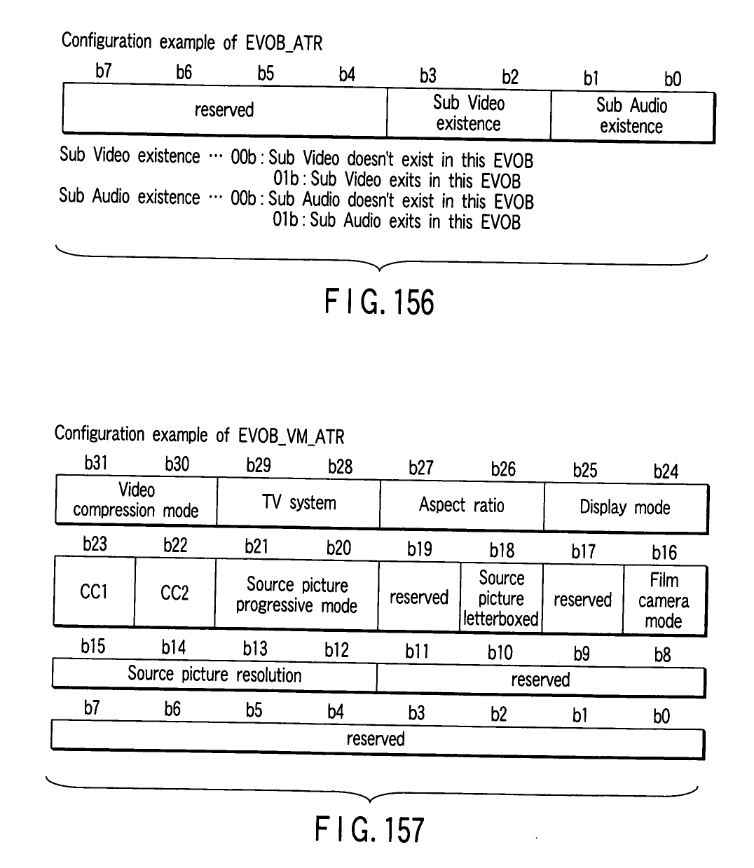

FIG. 156 is a view for explaining a configuration example of the enhanced video object attribute (EVOB_ATR). This attribute (EVOB_ATR) can separately describe whether or not a Sub Video stream and Sub Audio streams exist. FIG. 156 corresponds to another example of FIG. 155, and such configuration is also available.

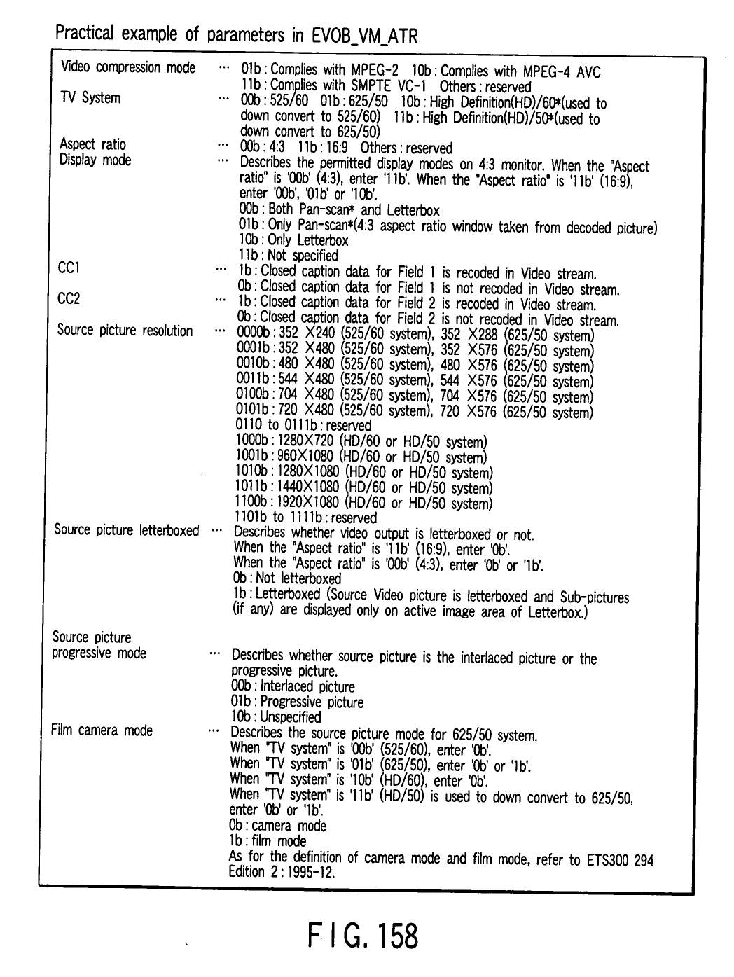

FIG. 157 is a view for explaining a configuration example of the main video attribute of an enhanced video object (EVOB_VM_ATR). The respective fields of this attribute (EVOB_VM_ATR) have values (a practical example of these values is shown in FIG. 158) which match (coincide with) information in a main video stream of that EVOB.

FIG. 158 is a view for explaining a practical example of parameters of the main video attribute of the enhanced video object (EVOB_VM_ATR). In a Video compression mode field of the EVOB_VM_ATR, 01b specifies a mode that complies with MPEG-2; 10b, a mode that complies with MPEG-4 AVC; and 11b, a mode that complies with SMPTE VC-1. Other bit values of this field are reserved for other compression modes.

In a TV system field, 00b specifies a system that complies with 525/60 (NTSC); 01b, a mode that complies with 625/50 (PAL); 10b, a system that complies with High Definition (HD)/60* (used to down convert to 525/60); and 11b, a mode that complies with High Definition (HD)/50* (used to down convert to 625/50).

In an Aspect ratio field, 00b specifies an aspect ratio 4:3; and 11b, 16:9. Other bit values of this field are reserved for other aspect ratios.

A Display mode field describes a display mode permitted on a monitor having an aspect ratio 4:3. In this field, if “Aspect ratio”=‘00b’ (4:3), ‘11b’ is entered; and if “Aspect ratio”=‘11b’ (16:9), ‘00b’, ‘01b’ or ‘10b’ is entered. In the Display mode field, 00b specifies both Pan-scan* and Letterbox; 01b, only Pan-scan*; 10b, only Letterbox; and 11b, not specified. (*: Pan-scan is to extract a window of an aspect ratio 4:3 from a decoded picture).

In a CC1 field, 1b specifies that Closed caption data for field 1 is recorded in a video stream, and 0b specifies that Closed caption data for field 1 is not recorded in a video stream.

In a CC2 field, 1b specifies that Closed caption data for field 2 is recorded in a video stream, and 0b specifies that Closed caption data for field 2 is not recorded in a video stream.

In a Source picture resolution field,

0000b specifies 352×240 (525/60 system) or 352×288 (625/50 system);

0001b, 352×480 (525/60 system) or 352×576 (625/50 system);

0010b, 480×480 (525/60 system) or 480×576 (625/50 system);

0011b, 544×480 (525/60 system) or 544×576 (625/50 system);

0100b, 704×480 (525/60 system) or 704×576 (625/50 system);

0101b, 720×480 (525/60 system) or 720×576 (625/50 system); and

0110b to 0111b, reserved.

Also,

1000b specifies 1280×720 (HD/60 or HD/50 system);

1001b, 960×1080 (HD/60 or HD/50 system);

1010b, 1280×1080 (HD/60 or HD/50 system);

1011b, 1440×1080 (HD/60 or HD/50 system);

1100b, 1920×1080 (HD/60 or HD/50 system); and

1101b to 1111b, reserved.

A Source picture letterboxed field describes a value as to whether or not a video output is letterboxed. In this field, if “Aspect ratio”=‘11b’ (16:9), ‘0b’ is entered; and if “Aspect ratio”=‘00b’ (4:3), ‘0b’ or ‘1b’ is entered. In the Source picture letterboxed field, 0b specifies that a video output is not letterboxed, and 1b specifies that a video output is letterboxed. (When a Source Video picture is letterboxed, a Sub-picture can be configured to be displayed only on an actual picture display area of letterbox.)

A Source picture progressive mode field describes whether a source picture is an interlaced picture or progressive picture. In this field, 00b is entered for an Interlaced picture; 01b is entered for a progressive picture; and 10b is entered for unspecified pictures.

A Film camera mode field describes a source picture mode for the 625/50 system. In this field, if “TV system=‘00b’ (525/60), ‘0b ’ is entered; if “TV system=‘01b’ (625/50), ‘0b ’ or ‘1b’ is entered; if “TV system=‘10b’ (HD/60), ‘0b ’ is entered; and if “TV system=‘11b’ (HD/50) and is used to down convert to 625/50, ‘0b ’ or ‘1b’ is entered. In the Film camera mode field, 0b specifies a camera mode, and 1b specifies a film mode. Note that the camera mode and film mode have been defined in ETS300 294 Edition 2: 1995-12.

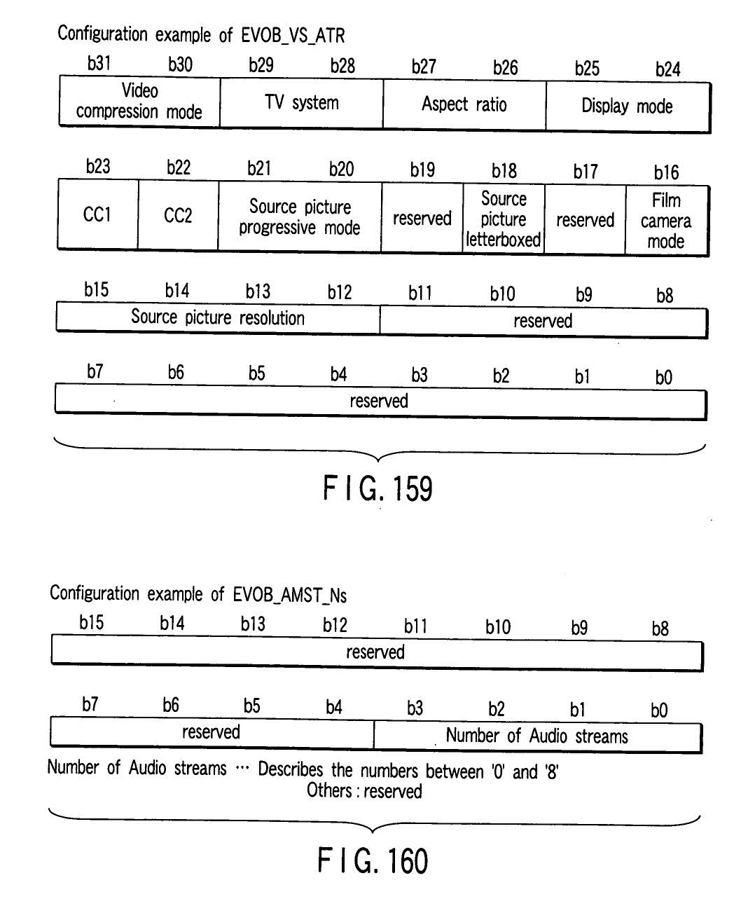

FIG. 159 is a view for explaining a configuration example of the sub video attribute of the enhanced video object (EVOB_VS_ATR). Respective fields of this attribute (EVOB_VS_ATR) have values which match (coincide with) information in a sub video stream of that EVOB (the data structure is the same as FIG. 157).

FIG. 160 is a view for explaining a configuration example of the number of main audio streams in an enhanced video object (EVOB_AMST_Ns). The number of main audio streams in an EVOB described by EVOB_AMST_Ns can be arbitrarily designated within a range between 0 and 8. The numbers of audio streams other than 0 to 8 are reserved.

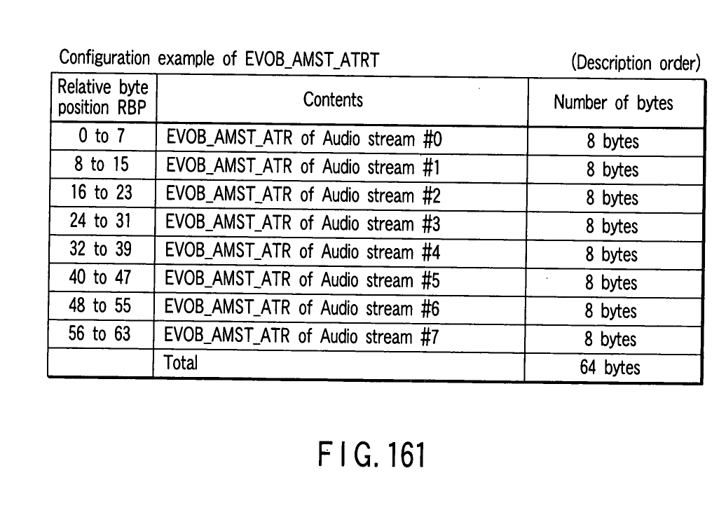

FIG. 161 is a view for explaining a configuration example of the main audio stream attribute table of the EVOB (EVOB_AMST_ATRT). The respective fields of this EVOB_AMST_ATRT have values that match (coincide with) information in a main audio stream of that EVOB. One EVOB_AMST_ATR is described for each Main Audio stream. This EVOB_AMST_ATRT has areas for eight main audio stream attributes EVOB_AMST_ATRs. Note that stream numbers are assigned in turn from 0 in accordance with a description order of EVOB_AMST_ATRs (in the example of FIG. 161, stream numbers of #0 to #7 are assigned). When the number of main audio streams of the EVOB of interest is less than 8, the respective bits of an EVOB_AMST_ATR for an unspecified stream are padded with ‘0b ’.

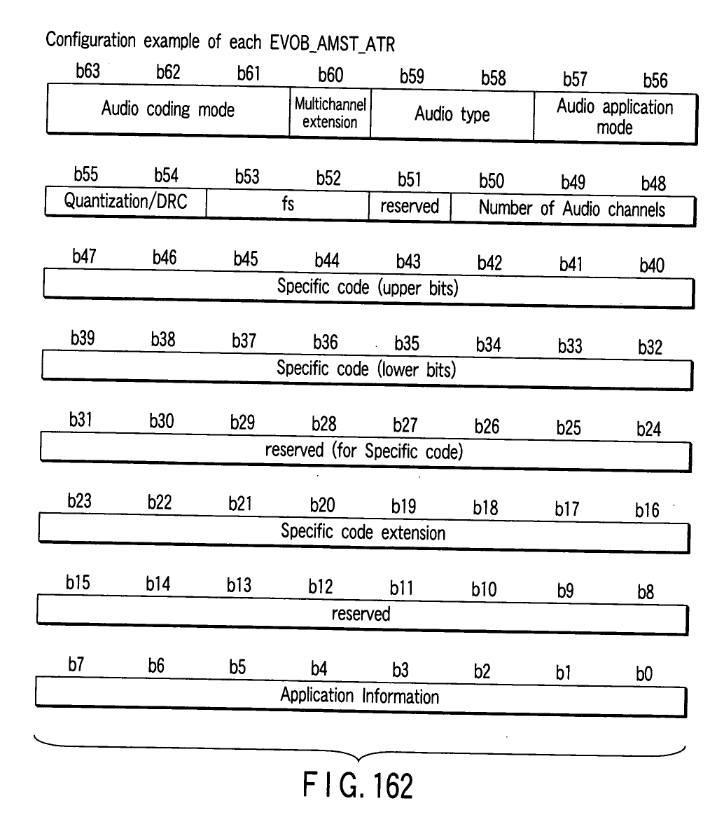

FIG. 162 is a view for explaining a configuration example of each main audio stream attribute of the enhanced video object (EVOB_AMST_ATR). Each EVOB_AMST_ATR is configured to include Audio coding mode, Multichannel extension, Audio type, Audio application mode, Quantization/DRC, fs, reserved, Number of Audio channels, Specific code (upper bits), Specific code (lower bits), reserved (for Specific code), Specific code extension, reserved, and Application Information fields.

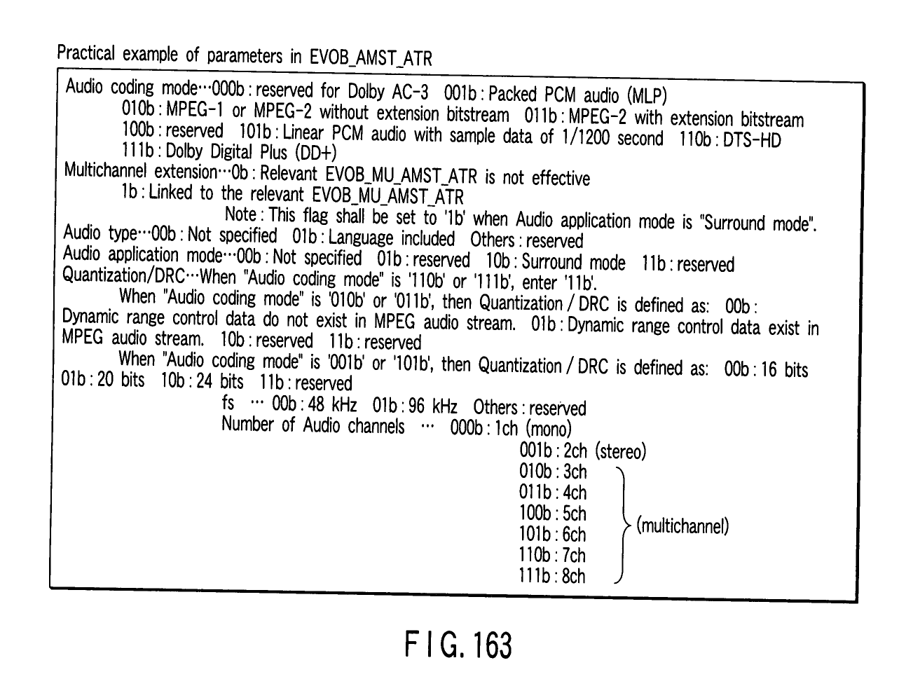

FIG. 163 is a view for explaining a practical example of parameters in the main audio stream attribute of the enhanced video object (EVOB_AMST_ATR). In the Audio coding mode field, 000b is reserved for Dolby AC-3; 001b specifies Packed PCM audio (MLP); 010b, MPEG-1 or MPEG-2 without any extension bitstream; 011b, MPEG-2 with an extension bitstream; 100b, reserved; 101b, Linear PCM audio with sample data of 1/1200 seconds; 110b, DTS-HD; and 111b, Dolby Digital Plus (DD+).

In the Multichannel extension field, 0b specifies that a relevant EVOB_MU_AMST_ATR is not effective, and 1b specifies that a relevant EVOB_MU_AMST_ATR is linked. Note that if the Audio application mode is “Surround mode”, this Multichannel extension flag is set to ‘1b’. Also, in the Audio type field, 00b specifies “Not specified”, 01b specifies that a Language is included, and Others specify “reserved”.

In the Audio application mode field, 00b specifies “Not specified”; 01b, “reserved”; 10b, “Surround mode”; and 11b, “reserved”. In the Quantization/DRC field, when “Audio coding mode” is ‘110b’ or ‘111b’, ‘11b’ is entered. On the other hand, when “Audio coding mode” is ‘010b’ or ‘011b’, bits indicating the following contents are entered in the Quantization/DRC field. More specifically, 00b specifies that Dynamic range control data do not exist in an MPEG audio stream, 01b specifies that Dynamic range control data exist in an MPEG audio stream, 10b and 11b specify “reserved”. When “Audio coding mode” is ‘001b’ or ‘101b’, bits indicating the following contents are entered in the Quantization/DRC field. That is, 00b specifies 16 bits (number of quantization bits); 01b, 20 bits; 10b, 24 bits; and 11b, “reserved”.

The fs field describes a sampling frequency. 00b specifies 48 kHz; 01b, 96 kHz; and others, “reserved”. In the Number of Audio channels field, 000b specifies 1ch (mono); 001b, 2ch (stereo); 010b, 3ch; 011b, 4ch; 100b, 5ch; 101b, 6ch; 110b, 7ch; and 111b, 8ch (3ch to 8ch correspond to multichannel). Note that “0.1ch” in multichannel is handled as one channel. Therefore, in case of, e.g., 5.1ch, it is handled as 6ch, and ‘101b’ is entered in the Number of Audio channels field.

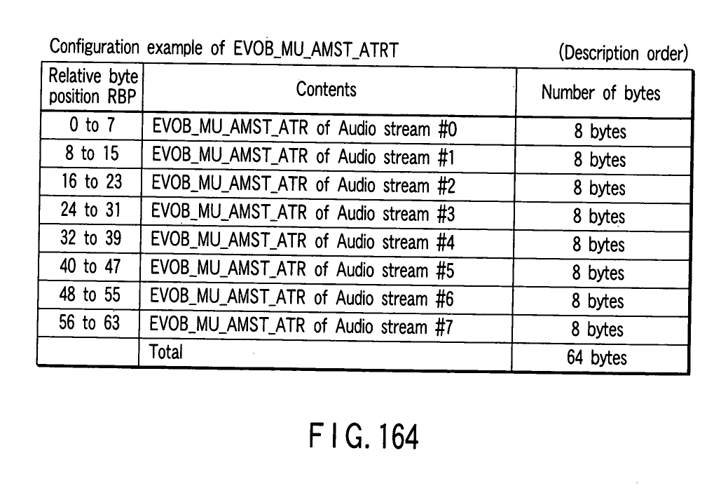

FIG. 164 is a view for explaining a configuration example of the multichannel main audio stream attribute table of the enhanced video object (EVOB_MU_AMST_ATRT). This EVOB_MU_AMST_ATRT describes Main Audio attributes for multichannel. This attribute table includes a maximum of eight audio attributes EVOB_MU_AMST_ATRs each for one type (their stream numbers start from 0 and ends at 7). In an area of an Audio stream in which “Multichannel extension” in an EVOB_AMST_ATR is ‘0b ’, ‘0b ’ is entered in the respective bits.

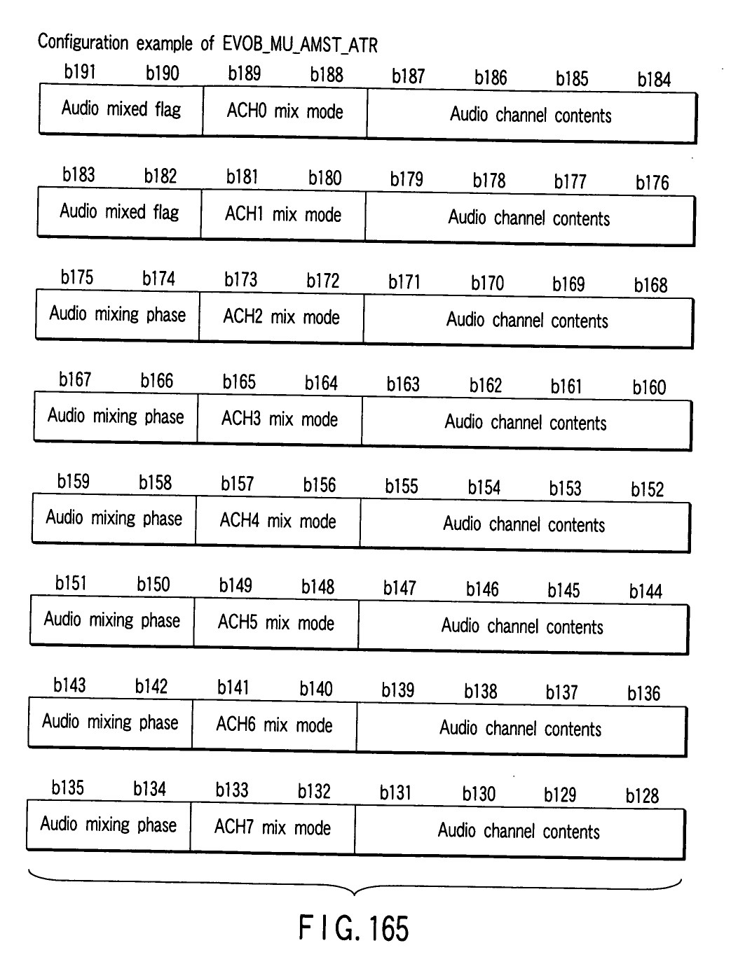

FIG. 165 is a view for explaining a configuration example of each multichannel main audio stream attribute of the enhanced video object (EVOB_MU_AMST_ATR). This EVOB_MU_AMST_ATR is configured to include Audio mixed flag, ACH0 mix mode, Audio channel contents, Audio mixed flag, ACH1 mix mode, Audio channel contents, Audio mixing phase, ACH2 mix mode, Audio channel contents, Audio mixing phase, ACH3 mix mode, Audio channel contents, Audio mixing phase, ACH4 mix mode, Audio channel contents, Audio mixing phase, ACH5 mix mode, Audio channel contents, Audio mixing phase, ACH6 mix mode, Audio channel contents, Audio mixing phase, ACH7 mix mode, and Audio channel contents fields.

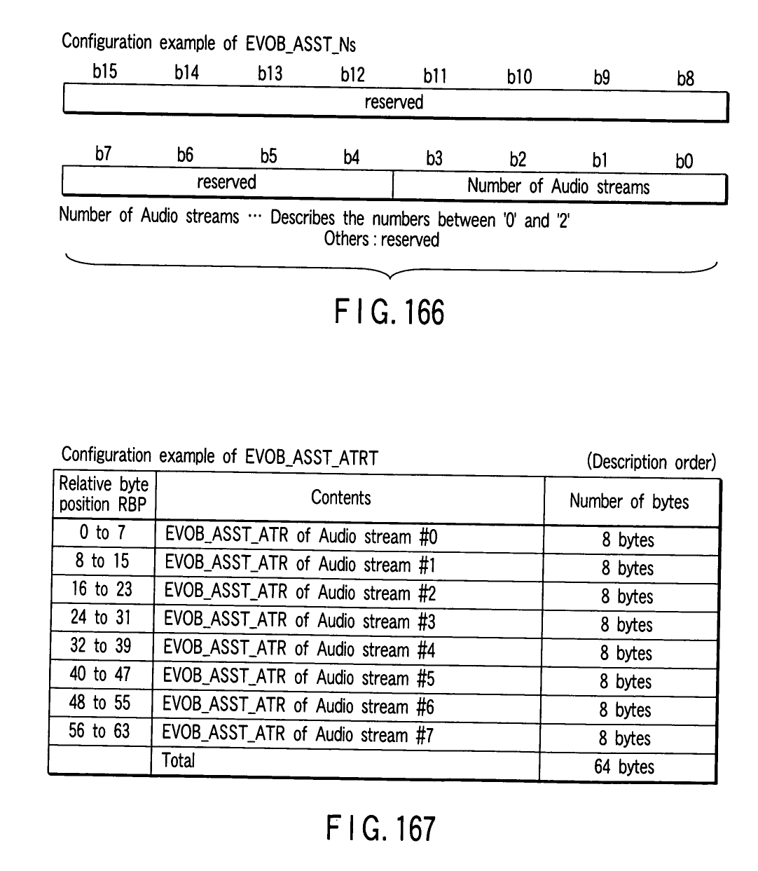

FIG. 166 is a view for explaining a configuration example of the number of sub audio streams in an enhanced video object (EVOB_ASST_Ns). A Number of Audio streams field in this EVOB_ASST_Ns describes a value ranging from 0 to 2, and other values are reserved.

FIG. 167 is a view for explaining a configuration example of the sub audio stream attribute table of the enhanced video object (EVOB_ASST_ATRT). The respective fields of this EVOB_ASST_ATRT have values that match (coincide with) information in a sub audio stream of the EVOB of interest. One EVOB_ASST_ATR is described for each Sub Audio stream. This EVOB_ASST_ATRT has areas for eight sub audio stream attributes EVOB_ASST_ATRs. Note that stream numbers are assigned in turn from 0 in accordance with a description order of EVOB_ASST_ATRs (in the example of FIG. 167, stream numbers of #0 to #7 are assigned). When the number of main audio streams of the EVOB of interest is less than 8, the respective bits of an EVOB_ASST_ATR for an unspecified stream are padded with ‘0b ’.

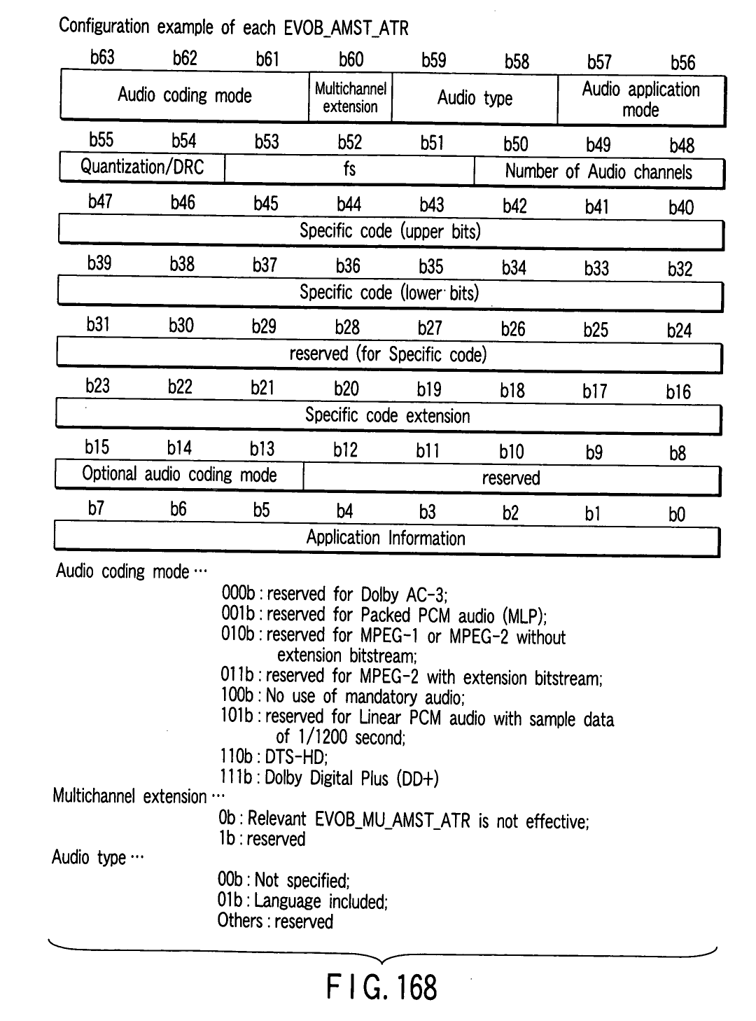

FIG. 168 is a view for explaining a configuration example of each sub audio stream attribute of the enhanced video object (EVOB_ASST_ATR). Each EVOB_ASST_ATR is configured to include Audio coding mode, Multichannel extension, Audio type, Audio application mode, Quantization/DRC, fs, reserved, Number of Audio channels, Specific code (upper bits), Specific code (lower bits), reserved (for Specific code), Specific code extension, Optional audio coding mode, reserved, and Application Information fields.

Note that Audio coding mode=000b is reserved for Dolby AC-3, =001b is reserved for Packed PCM Audio (MLP: lossless compressed PCM audio), =010b is reserved for MPEG-1 or MPEG-2 without any extension bitstream, and =011b is reserved for MPEG-2 with an extension bitstream. Furthermore, Optional audio coding mode=100b is reserved for use purposes other than mandatory audio, =101b is reserved for Linear PCM audio having sample data of 1/1200 seconds, =110b specifies DTS-HD, and =111b specifies Dolby Digital Plus (DD+). (The respective bits of Optional audio coding mode are reserved.)

Also, Multichannel extension=0b specifies that a relevant EVOBU_MU_AMST_ATR is not effective (=1b is reserved), and Audio type=01b specifies that a language is included (=00b specifies “not specified”, and =other bits is reserved).

When the Audio coding mode field is 110b (DTS-HD) or 111b (DD+), the Quantization/DRC field indicating the number of quantization bits and dynamic range control is set to 11b. The fs field (3 bits) specifies one of 48 kHz, 8 kHz, 12 kHz, 16 kHz, 24 kHz, and other sampling frequencies. Furthermore, the Number of Audio channels field (3 bits) specifies one of 1ch (mono), 2ch (stereo), and the like.

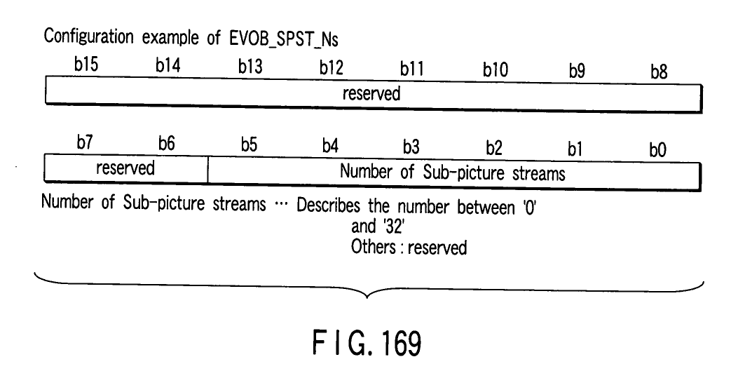

FIG. 169 is a view for explaining a configuration example of the number of Sub-picture streams in the enhanced video object (EVOB_SPST_Ns). A Number of Sub-picture streams field in this EVOB_SPST_Ns describes a value ranging from 0 to 32, and other values are reserved.

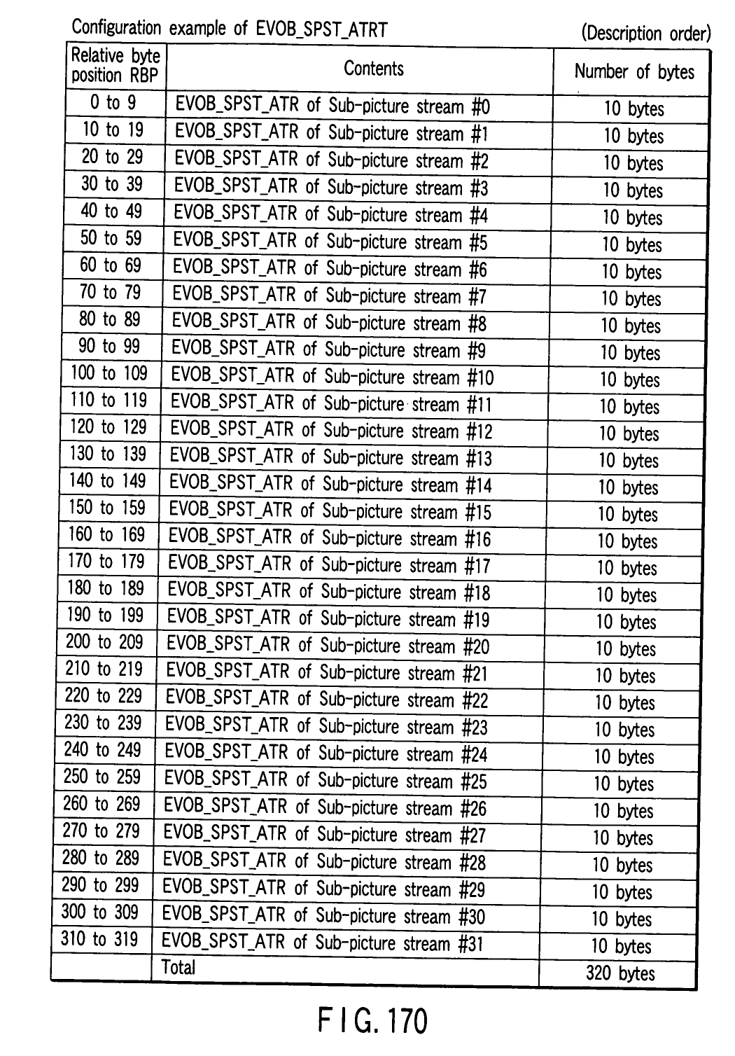

FIG. 170 is a view for explaining a configuration example of the Sub-picture stream attribute table of the enhanced video object (EVOB_SPST_ATRT). This EVOB_SPST_ATRT describes Sub-picture stream attributes (EVOB_SPST_ATRs) for the EVOB. One EVOB_SPST_ATR is described for each existing Sub-picture stream. Stream numbers are assigned in turn from 0 up to the number of EVOB_SPST_ATRs described in this table. If the number of Sub-picture streams is less than 32, the respective bits of an EVOB_SPST_ATR for an unspecified stream are padded with ‘0b ’.

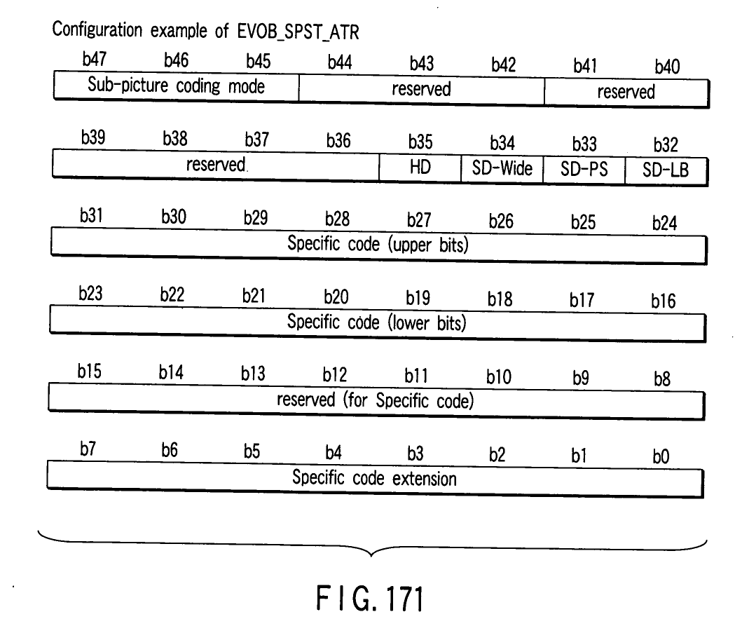

FIG. 171 is a view for explaining a configuration example of the each Sub-picture stream attribute of the enhanced video object (EVOB_SPST_ATR). Each VTSM_SPST_ATR is configured to include Sub-picture coding mode, reserved, HD (High Definition), SD-Wide (Standard Definition Wide), SD-PS (Standard Definition Pan Scan), SD-LB (Standard Definition Letter Box), Specific code (upper bits), Specific code (lower bits), reserved (for specific code), and Specific code extension fields.

In the example of FIG. 171, HD, SD-Wide, SD-PS, and SD-LB bits are allocated at bits b39 to b32, but another allocation method is available. For example, a HD/4:3 (HD or aspect ratio 4:3) is allocated at b37, and a Decoding Sub-picture stream number for HD/4:3 is allocated at bits b36 to b32 (bits b39 and b38 are reserved). Also, SD-Wide is allocated at b29, and a Decoding Sub-picture stream number for SD-Wide is allocated at bits b28 to b24 (bits b31 and b30 are reserved). SD-LB is allocated at b21, and a Decoding Sub-picture stream number for SD-LB is allocated at bits b20 to b16 (bits b23 and b22 are reserved). Furthermore, SD-PS is allocated at b13, and a Decoding Sub-picture stream number for SD-PS is allocated at bits b12 to b8 (bits b15 and b14 are reserved).

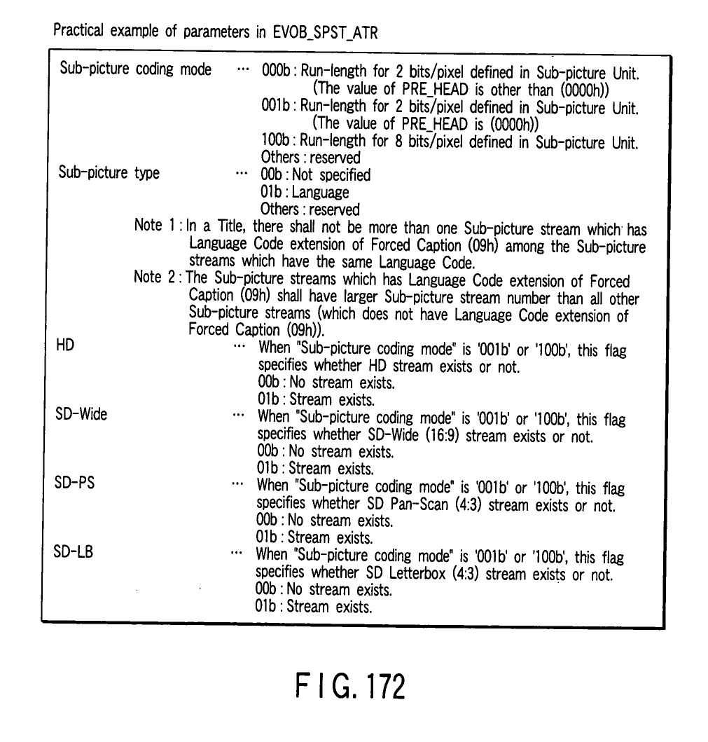

FIG. 172 is a view for explaining a practical example of parameters in the main audio stream attribute of the enhanced video object (EVOB_AMST_ATR). Sub-picture coding mode=000b specifies a Run-length compression rule for 2 bits/pixel (a PRE_HEAD value is other than (0000h)), =001b specifies a Run-length compression rule for 2 bits/pixel (a PRE_HEAD value is other than (0000h)), =100b specifies a Run-length compression rule for 8 bits/pixel, and other bits in this field are reserved.

Sub-picture type=00b specifies “Not specified”, =01b specifies a Language, and other bits in this field are reserved. Note that a title includes not more than one Sub-picture stream having the Language code extension of Forced Caption (09h) among Sub-picture streams having the same Language Code. The Sub-picture stream having the Language code extension of Forced Caption (09h) has a larger Sub-picture stream number than all other Sub-picture streams which do not have any Language code extension of Forced Caption (09h).

In the HD field, when “Sub-picture coding mode” is ‘001b’ or ‘100b’, a bit indicating whether or not an HD stream or 4:3 stream exists is entered (if HD=0b, no stream exists; and if HD=1b, an HD stream or 4:3 stream exists).

In the SD-Wide field, when “Sub-picture coding mode” is ‘001b’ or ‘100b’, a bit indicating whether or not an SD-Wide stream (an SD stream with an aspect ratio 16:9) exists is entered (if SD-Wide=0b, no SD-Wide stream exists; and if SD-Wide=1b, an SD-Wide stream exists).

In the SD-PS field, when “Sub-picture coding mode” is ‘001b’ or ‘100b’, a bit indicating whether or not an SD Pan-scan stream (a Pan-scan SD stream with an aspect ratio 4:3) exists is entered (if SD-PS=0b, no SD Pan-scan stream exists; and if SD-PS=1b, an SD Pan-scan stream exists).

In the SD-LB field, when “Sub-picture coding mode” is ‘001b’ or ‘100b’, a bit indicating whether or not an SD Letterbox stream (a Letterbox SD stream with an aspect ratio 4:3) exists is entered (if SD-LB=0b, no SD Letterbox stream exists; and if SD-LB=1b, an SD Letterbox stream exists).

If “Aspect ratio” in an EVOB_VM_ATR is 00b (=4:3), “TV system” is 00b (=525/60) or 01b (=625/50), and “HD/4:3” is 1b (=stream exists), the aforementioned “Decoding Sub-picture stream number for HD/4:3” is configured to describe least significant 5 bits of sub_stream_id of a corresponding Sub-picture stream for 4:3. On the other hand, if “Aspect ratio” in an EVOB_VM_ATR is 11b (=16:9), “TV system” is 10b (=HD/60) or 11b (=HD/50), and “HD/4:3” is 1b (=stream exists), the aforementioned “Decoding Sub-picture stream number for HD/4:3” is configured to describe least significant 5 bits of sub_stream_id of a corresponding Sub-picture stream for HD.

If “Aspect ratio” in an EVOB_VM_ATR is 11b, and “SD-Wide” is 1b, the aforementioned “Decoding Sub-picture stream number for SD-Wide” is configured to describe least significant 5 bits of sub_stream_id of a corresponding Sub-picture stream for SD-Wide. Otherwise, the “Decoding Sub-picture stream number for SD-Wide” describes 00000b, which does not mean the “Decoding Sub-picture stream number”=0.

If “Aspect ratio” in an EVOB_VM_ATR is 11b (=16:9), “Display mode” is 00b (=both Pan-scan and Letterbox) or 10b (=only Letterbox), and “SD-LB” is 1b (=stream exists), the aforementioned “Decoding Sub-picture stream number for SD-LB” is configured to describe least significant 5 bits of sub_stream_id of a corresponding Sub-picture stream for letterbox.

Furthermore, if “Aspect ratio” in an EVOB_VM_ATR is 11b (=16:9), “Display mode” is 00b (=both Pan-scan and Letterbox) or 01b (=only Pan-scan), and “SD-PS” is 1b (=stream exists), the aforementioned “Decoding Sub-picture stream number for SD-PS” is configured to describe least significant 5 bits of sub_stream_id of a corresponding Sub-picture stream for pan-scan.

Even when “Aspect ratio” is 00b (=4:3), if “Source picture resolution” is 1011b (=1440×1080), it can be considered that “Aspect ratio” is 11b (=16:9). The same Sub-picture bitstream coding conditions used in respective stream numbers can be used in an EVOB. The same number as the Decoding Sub-picture stream number for HD can be used in the Decoding Sub-picture stream number for SD-Wide, SD-LB and/or SD-PS.

Moreover, if “Aspect ratio” in an EVOB_VM_ATR is 11b (=16:9), “TV system” is 10b (=HD/60) or 11b (=HD/50), and “HD/4:3” is 0b (=stream does not exist), “SD-Wide”, “SD-LB”, and “SD-PS” are set to 0b (=stream does not exist). Also, if “Aspect ratio” in an EVOB_VM_ATR is 11b (=16:9), and “TV system” is 00b (=525/60) or 01b (=625/50), “HD/4:3” is set to 0b (=stream does not exist), and no Decoding Sub-picture stream number for HD is described.

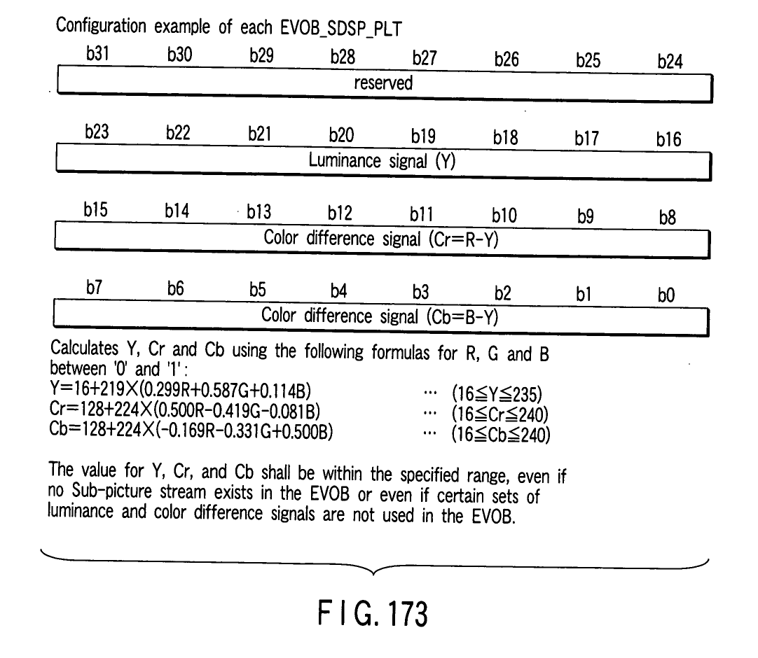

FIG. 173 is a view for explaining a configuration example of the palette (EVOB_SDSP_PLT) that describes luminance/color difference signals (256 sets) shared by all SD Sub-picture streams in each enhanced video object. In this EVOB_SDSP_PLT, color codes from 0 to 255 are assigned in a description order. Each EVOB_SDSP_PLT is configured to include reserved, Luminance signal (Y), Color difference signal (Cr=R−Y), and Color difference signal (Cb=B−Y) fields. Note that Y, Cr, and Cb can be calculated using R, G, and B that assume values ranging from 0 to 1 by:
Y=16+219×(0.299R+0.587G+0.114B) (16≦Y≦235)
Cr=128+224×(0.500R−0.419G−0.081B) (16≦Cr≦240)
Cb=128+224×(−0.169R−0.331G+0.500B) (16≦Cb≦240)

Even if no Sub-picture stream exists in the EVOB of interest, or even if sets of luminance and color difference signals are not used in the EVOB of interest, Y, Cr, and Cb values are configured to fall within a predetermined range.

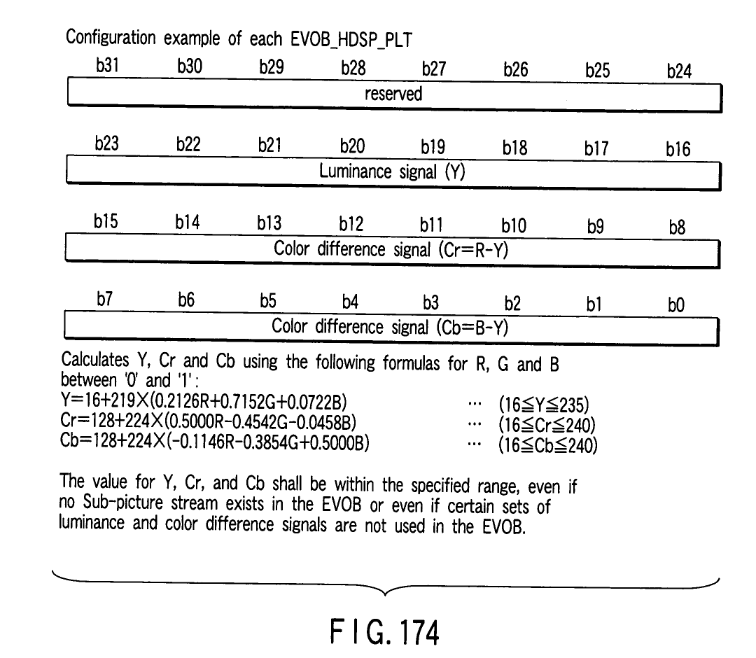

FIG. 174 is a view for explaining a configuration example of the palette (EVOB_HDSP_PLT) that describes luminance/color difference signals (256 sets) shared by all HD Sub-picture streams in each enhanced video object. In this EVOB_HDSP_PLT, color codes from 0 to 255 are assigned in a description order. Each EVOB_HDSP_PLT is configured to include reserved, Luminance signal (Y), Color difference signal (Cr=R−Y), and Color difference signal (Cb=B−Y) fields. Note that Y, Cr, and Cb can be calculated using R, G, and B that assume values ranging from 0 to 1 by:
Y=16+219×(0.2126R+0.7152G+0.0722B) (16≦Y≦235)
Cr=128+224×(0.5000R−0.4542G−0.0458B) (16≦Cr≦240)
Cb=128+224×(−0.1146R−0.3854G−0.5000B) (16≦Cb≦240)

Even if no Sub-picture stream exists in the EVOB of interest, or even if sets of luminance and color difference signals are not used in the EVOB of interest, Y, Cr, and Cb values are configured to fall within a predetermined range.

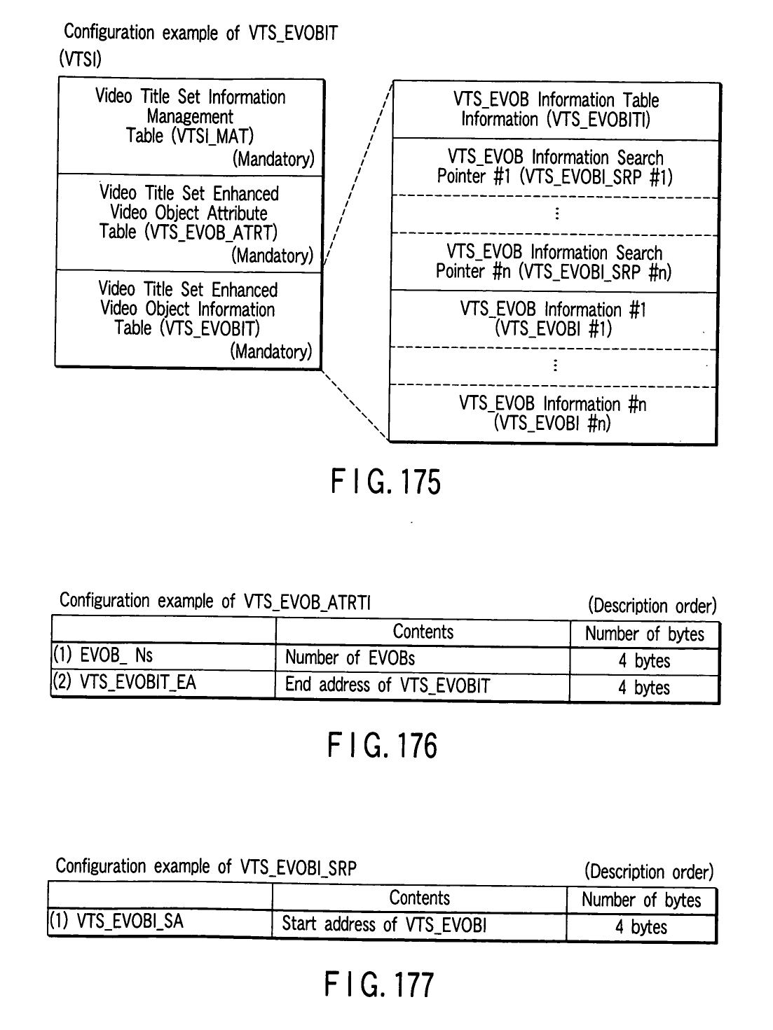

FIG. 175 is a view for explaining a configuration example of the video title set enhanced video object information table (VTS_EVOBIT). This VTS_EVOBIT describes information for respective EVOBs in the Primary Video Set. This table starts from VTS_EVOBIT Information (VTS_EVOBITI), and is configured to include one or more VTS_EVOBI Search Pointers (VTS_EVOBI_SRPs) and one or more pieces of VTS_EVOB Information (VTS_EVOBIs).

FIG. 176 is a view for explaining a configuration example of the video title set enhanced video object information table information (VTS_EVOBITI). This VTS_EVOBITI is configured to include EVOB_Ns that describes the number of EVOBs, and VTS_EVOBIT_EA that describes the end address of the VTS_EVOBIT, which is expressed by the number of relative blocks from the first byte of the VTS_EVOBIT.

FIG. 177 is a view for explaining a configuration example of the video title set enhanced video object information search pointer (VTS_EVOBI_SRP). This VTS_EVOBI_SRP is configured to include VTS_EVOBI_SA that describes the start address of the VTS_EVOBI (corresponding to the EVOB of interest), which is expressed by the number of relative blocks from the first byte of the VTS_EVOBIT.

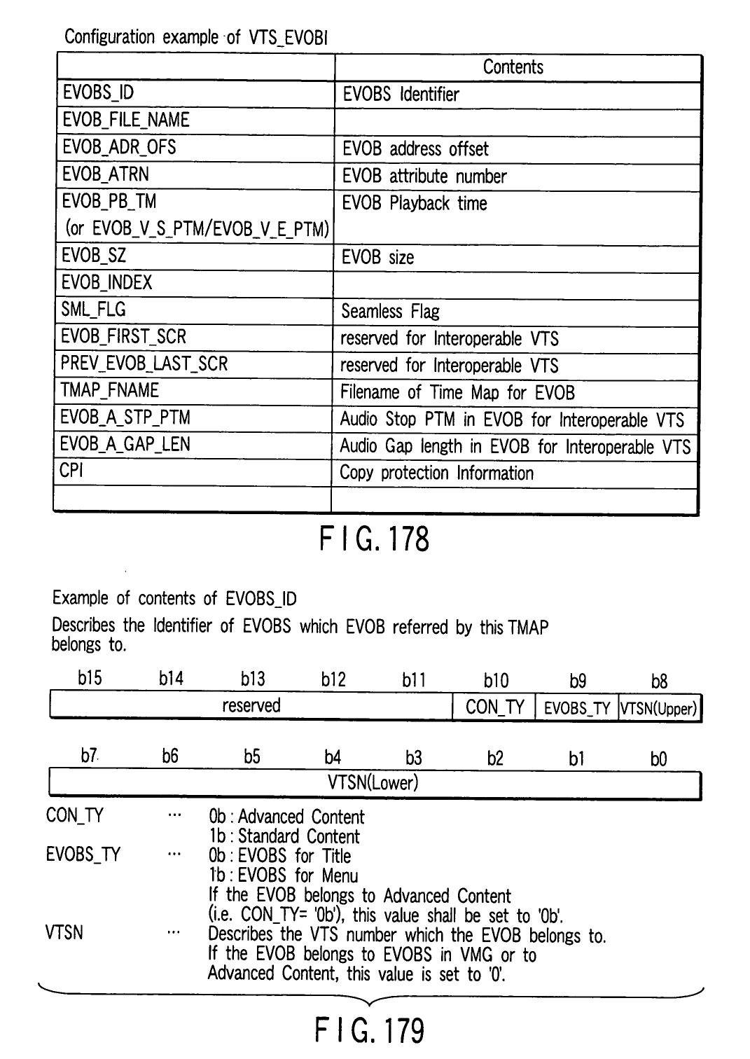

FIG. 178 is a view for explaining a configuration example of the video title set enhanced video object information (VTS_EVOBI). This VTS_EVOBI is configured to include EVOBS_ID that describes an EVOBS ID, EVOB_ADR_OFS that describes an EVOB address offset, EVOB_ATRN that describes an EVOB attribute number, EVOB_PB_TM (or EVOB_V_S_PTM & EVOB_V_E_PTM) that describes an EVOB playback time (EVOB_V_S_PTM describes a start presentation time of the EVOB, and EVOB_V_E_PTM describes an end presentation time of the EVOB), EVOB_SZ that describes an EVOB size, SML_FLG that describes a Seamless Flag, EVOB_FIRST_SCR reserved for an Interoperable VTS, PREV_EVOB_LAST_SCR reserved for an Interoperable VTS, TMAP_FNAME that describes a Filename of a Time Map for an EVOB, and the like.

This VTS_EVOBI is configured to further include EVOB_FILE_NAME that describes an EVOB filename, EVOB_INDEX that describes an EVOB index number, EVOB_A_STP_PTM that describes a audio-stop playback time in an EVOB for an Interoperable VTS, EVOB_A_GAP_LEN that describes an audio gap length in an EVOB for an Interoperable VTS, and CPI that describes copyright protection information (copy control information). The recorded contents (of VTS) can be protected from illegal or unauthorized use by this copy protection information in unit of a title or a video object.

FIG. 179 is a view for explaining an example of the contents of the EVOBS_ID in the video title set enhanced video object information (VTS_EVOBI). This EVOBS_ID is configured to include CON_TY indicating whether or not the EVOBS of interest belongs to an Advanced Content (0b=Advanced Content, and 1b=Standard Content), EVOBS_TY indicating whether the EVOBS of interest is for title or menu (0b=EVOBS for Title, and 1b=EVOBS for Menu), VTSN that describes a VTS number to which the EVOB of interest belongs, and the like. When an EVOB belongs to an Advanced Content (i.e., CON_TY=0b), the EVOBS_TY is set to 0b. When an EVOB belongs to an EVOBS in the VMG or an Advanced Content, VTSN is set to 0b.

FIG. 180 is a view for explaining an example of parameters in the video title set enhanced video object information (VTS_EVOBI). The SML_FLG in each VTS_EVOBI indicates whether or not the EVOB of interest satisfies the seamless playback condition. SML_FLG=0b specifies that the EVOB of interest does not satisfy the seamless playback condition of the previous EVOB, and SML_FLG=1b specifies that the EVOB of interest satisfies the seamless playback condition of the previous EVOB.

The EVOB_FIRST_SCR field is reserved for an Interoperable VTS. In an Advanced VTS, the value of this field is padded with ‘1b or FFh’ or the like. The PREV_EVOB_LAST_SCR field is reserved for an Interoperable VTS. In an Advanced VTS, the value of this field is padded with ‘1b or FFh’ or the like. The EVOB_TMAP_FNAME field describes the filename of a Time Map which is referred to by the EVOB of interest.

FIG. 181 is a view for explaining a configuration example of a time map (TMAP) which includes as an element time map information (TMAPI) used to convert the playback time in a primary enhanced video object (P-EVOB) into the address of an enhanced video object unit (EVOBU). This TMAP starts from TMAP General Information (TMAP_GI). A TMAPI Search pointer (TMAPI_SRP) and TMAP information (TMAPI) follow the TMAP_GI, and ILVU Information (ILVUI) is allocated at the end.

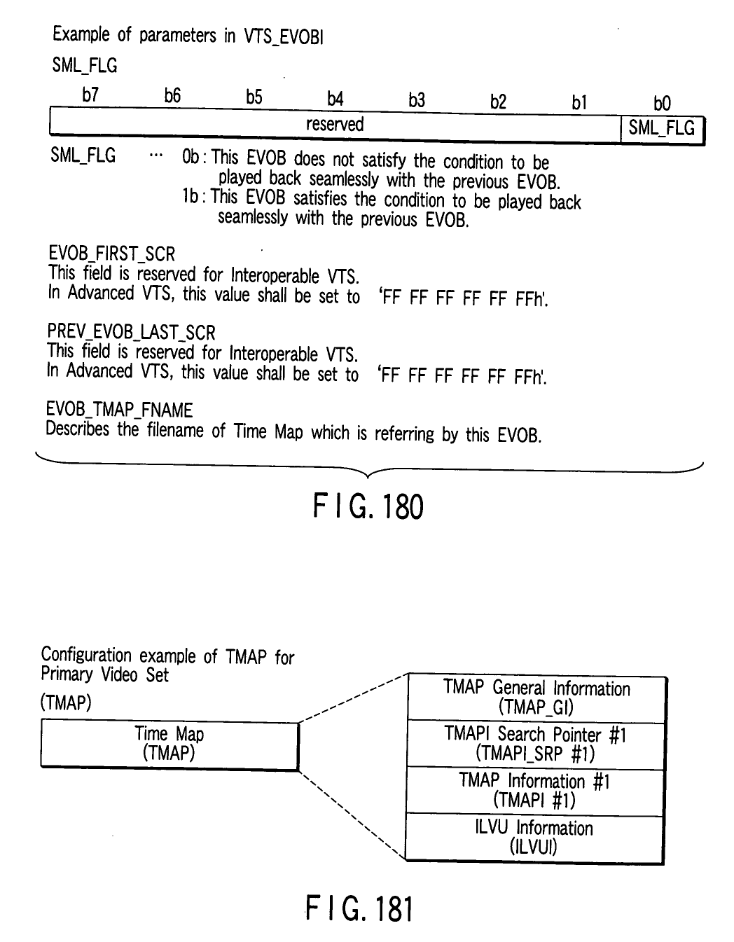

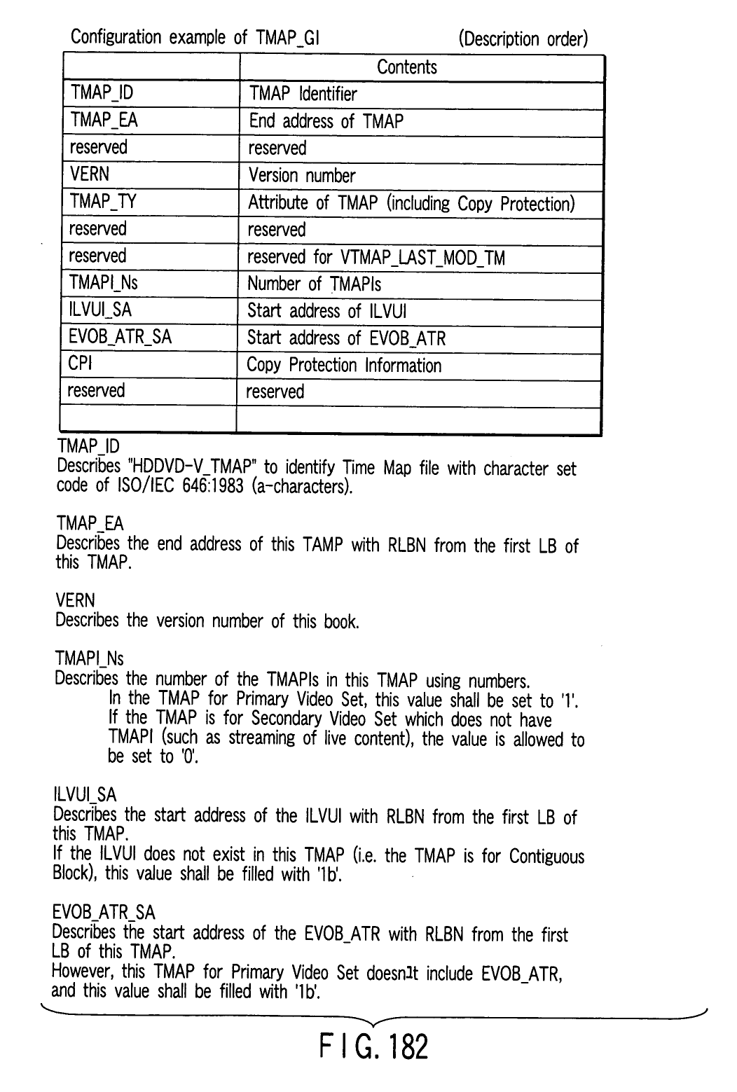

FIG. 182 is a view for explaining a configuration example of the time map general information (TMAP_GI). This TMAP_GI is configured to include TMAP_ID that describes “HDDVD-V_TMAP” which identifies a Time Map file by character set codes or the like of ISO/IEC 646:1983 (a-characters), TMAP_EA that describes the end address of the TMAP of interest with a relative logical block number from the first logical block of the TMAP of interest, VERN that describes the version number of the book of interest, TMAPI_Ns that describes the number of pieces of TMAPI in the TMAP of interest using numbers, ILVUI_SA that describes the start address of the ILVUI with a relative logical block number from the first logical block of the TMAP of interest, EVOB_ATR_SA that describes the start address of the EVOB_ATR of interest with a relative logical block number from the first logical block of the TMAP of interest, copy protection information (CPI), and the like. The recorded contents can be protected from illegal or unauthorized use by the copy protection information, in a time map (TMAP) basis. Here, the TMAP may be used to convert from a given presentation time inside an EVOB to the address of an EVOBU or to the address of a time unit TU (TU represents an access unit for an EVOB including no video packet).

In the TMAP for a Primary Video Set, the

TMAPI_Ns is set to ‘1’. In the TMAP for a Secondary Video Set, which does not have any TMAPI (e.g., streaming of a live content), the TMAPI_Ns is set to ‘0’. If no ILVUI exists in the TMAP (that for a contiguous block), the ILVUI_SA is padded with ‘1b or FFh’ or the like. Furthermore, when the TMAP for a Primary Video Set does not include any EVOB_ATR, the EVOB_ATR is padded with ‘1b’ or the like.

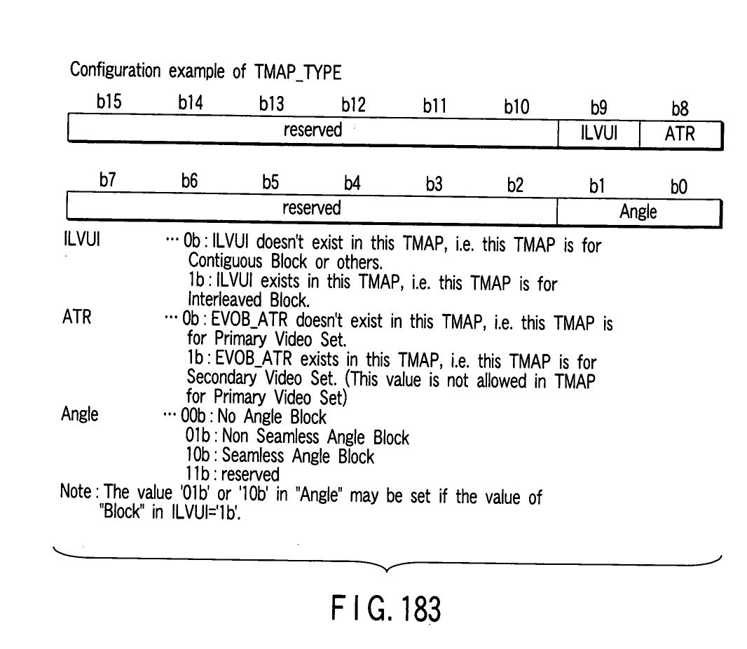

FIG. 183 is a view for explaining a configuration example of the time map type (TMAP_TY). This TMAP_TY is configured to include information bits of ILVUI, ATR, and Angle. If the ILVUI bit in the TMAP_TY is 0b, this indicates that no ILVUI exists in the TMAP of interest, i.e., the TMAP of interest is that for a contiguous block or others. If the ILVUI bit in the TMAP_TY is 1b, this indicates that an ILVUI exists in the TMAP of interest, i.e., the TMAP of interest is that for an interleaved block.

If the ATR bit in the TMAP_TY is 0b, it specifies that no EVOB_ATR exists in the TMAP of interest, and the TMAP of interest is a time map for a Primary Video Set. If the ATR bit in the TMAP_TY is 1b, it specifies that an EVOB_ATR exists in the TMAP of interest, and the TMAP of interest is a time map for a Secondary Video Set.

If the Angle bits in the TMAP_TY are 00b, they specify no angle block; if these bits are 01b, they specify a non-seamless angle block; and if these bits are 10b, they specify a seamless angle block. The Angle bits=11b in the TMAP_TY are reserved for other purposes. Note that the value 01b or 10b in the Angle bits can be set when the ILVUI bit is 1b.

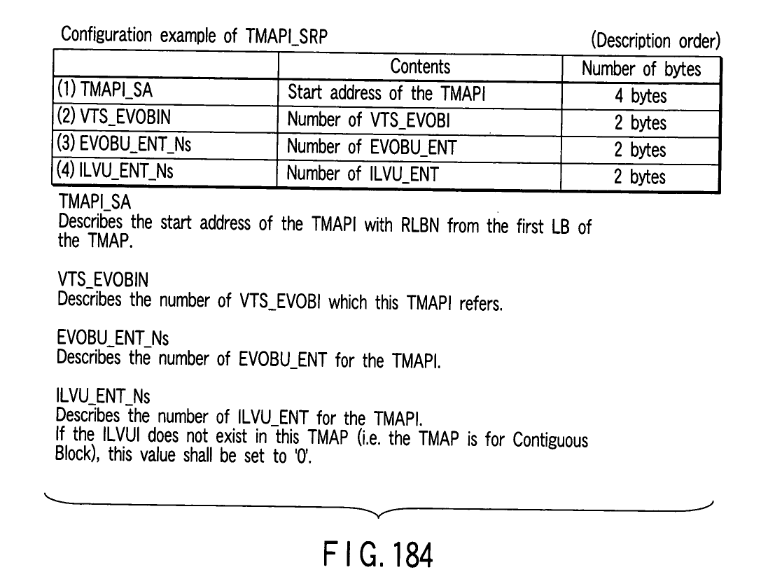

FIG. 184 is a view for explaining a configuration example of the time map information search pointer (TMAPI_SRP). This TMAPI_SRP is configured to include TMAPI_SA that describes the start address of the TMAPI with a relative logical block number from the first logical block of the TMAP of interest, VTS_EVOBIN that describes the number of VTS_EVOBI which is referred to by the TMAPI of interest, EVOBU_ENT_Ns that describes the number of pieces of EVOBU_ENTI for the TMAPI of interest, and ILVU_ENT_Ns that describes the number of ILVU_ENTs for the TMAPI of interest (If no ILVUI exists in the TMAP of interest (i.e., if the TMAP is for a contiguous block), the value of ILVU_ENT_Ns is ‘0’).

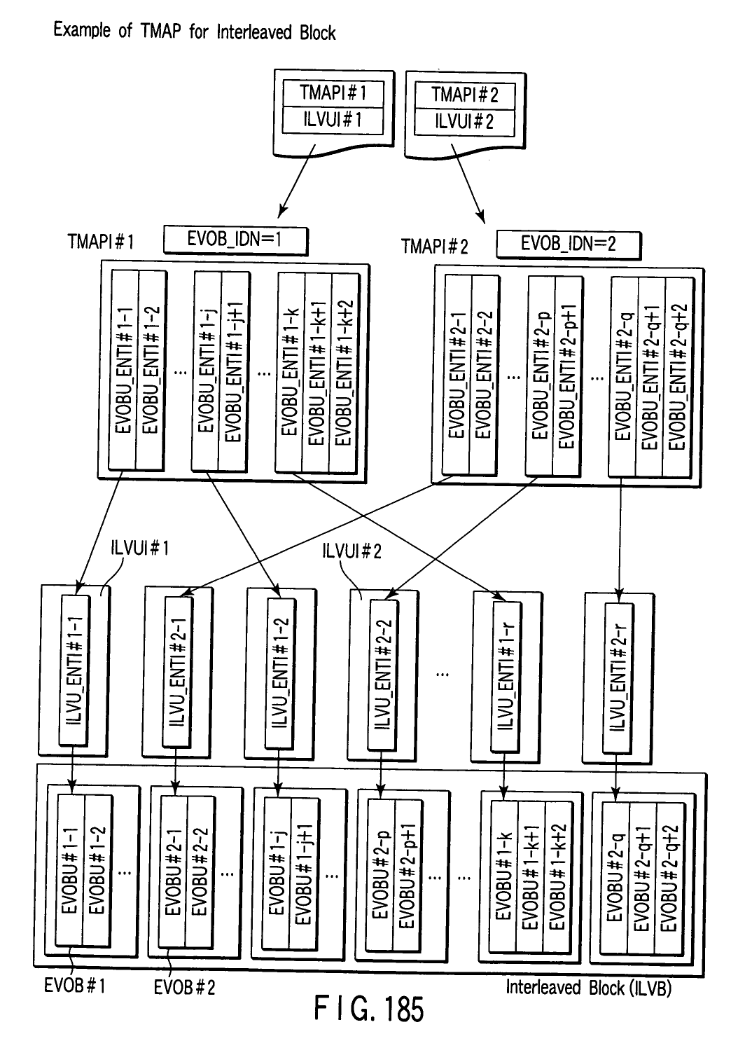

FIG. 185 is a view showing an example of a TMAP for an interleaved block. FIG. 185 shows a modification of FIG. 105, and each of a plurality of TMAP files individually has TMAPI and ILVUI.

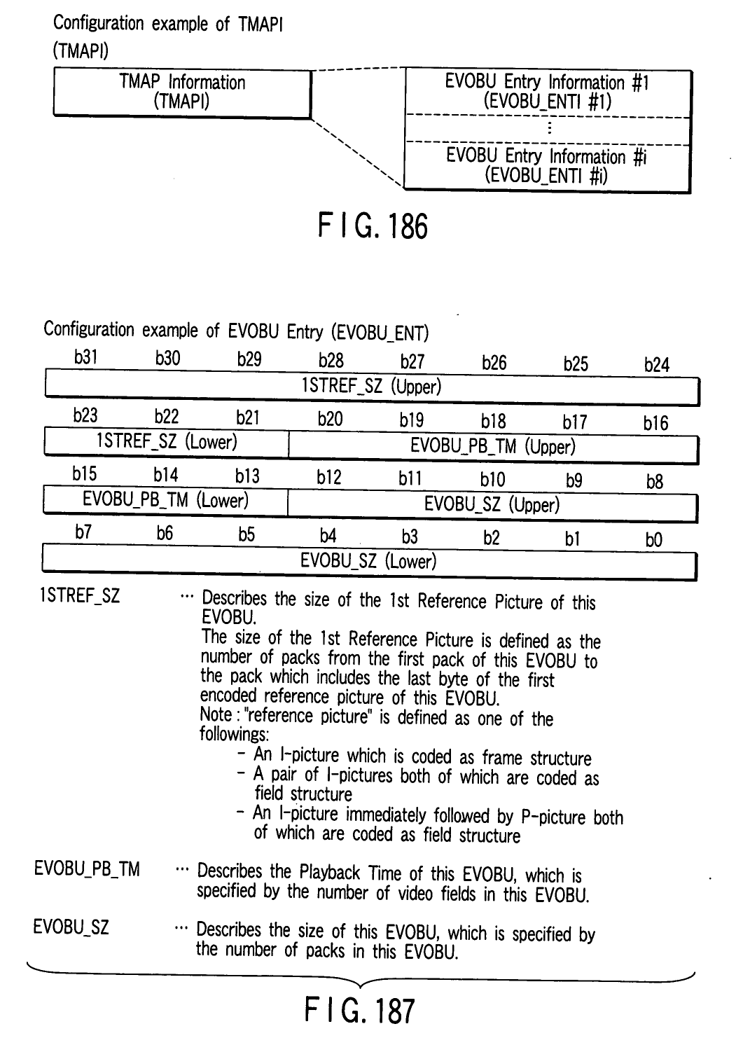

FIG. 186 is a view for explaining a configuration example of time map information (TMAPI of a Primary Video Set) which starts from entry information (EVOBU_ENT#1 to EVOBU_ENT#i) of one or more enhanced video object units. The TMAP information (TMAPI) as an element of a Time Map (TMAP) is used to convert the playback time in an EVOB into the address of an EVOBU. This TMAPI includes one or more EVOBU Entries. One TMAPI for a contiguous block is stored in one file, which is called TMAP. Note that one or more TMAPIs that belong to an identical interleaved block are stored in a single file. This TMAPI is configured to start from one or more EVOBU Entries (EVOBU_ENTs).

FIG. 187 is a view for explaining a configuration example of enhanced video object unit entry information (EVOBU_ENTI). This EVOBU_ENTI is configured to include 1STREF_SZ (Upper), 1STREF_SZ (Lower), EVOBU_PB_TM (Upper), EVOBU_PB_TM (Lower), EVOBU_SZ (Upper), and EVOBU_SZ (Lower).

The 1STREF_SZ describes the size of a 1st Reference Picture of the EVOBU of interest. The size of the 1st Reference Picture can be defined as the number of packs from the first pack of the EVOBU of interest to the pack which includes the last byte of the first encoded reference picture of the EVOBU of interest. Note that “reference picture” can be defined as one of the followings:

an I-picture which is coded as a frame structure;

a pair of I-pictures which are coded as a field structure; and

an I-picture immediately followed by a P-picture, both of which are coded as a field structure.

The EVOBU_PB_TM describes the playback time of the EVOBU of interest, which can be specified by the number of video fields in the EVOBU of interest. Furthermore, the EVOBU_SZ describes the size of the EVOBU of interest, which can be specified by the number of packs in the EVOBU of interest.

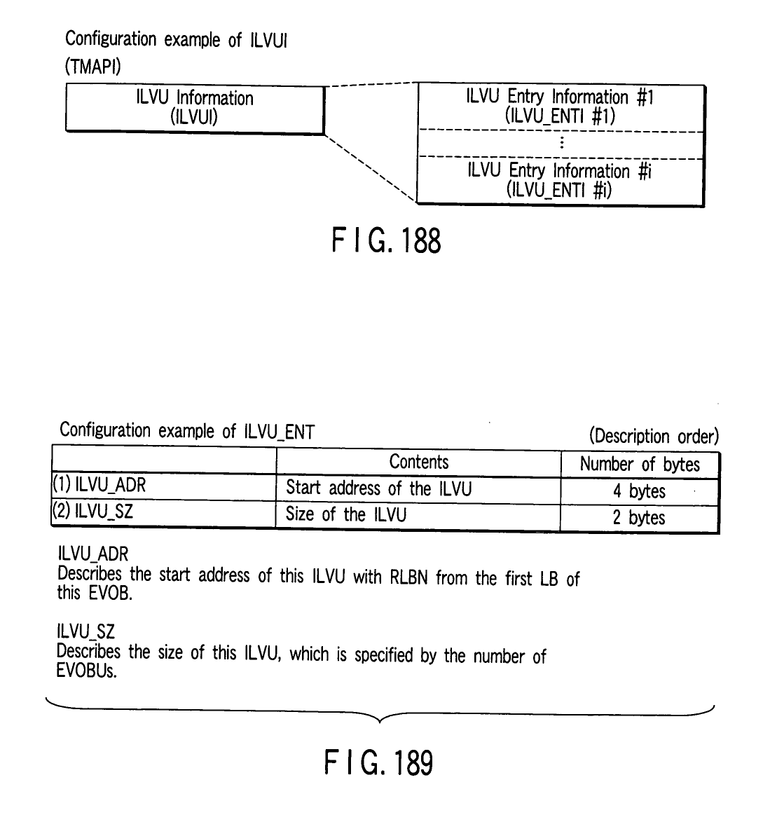

FIG. 188 is a view for explaining a configuration example of the interleaved unit information (ILVUI for a Primary Video Set) which exists when time map information is for an interleaved block. This ILVUI includes one or more ILVU Entries (ILVU_ENTs). This information (ILVUI) exists when the TMAPI is for an Interleaved Block.

FIG. 189 is a view for explaining a configuration example of interleaved unit entry information (ILVU_ENTI). This ILVU_ENTI is configured to include ILVU_ADR that describes the start address of the ILVU of interest with a relative logical block number from the first logical block of the EVOB of interest, and ILVU_SZ that describes the size of the ILVU of interest. This size can be specified by the number of EVOBUs.

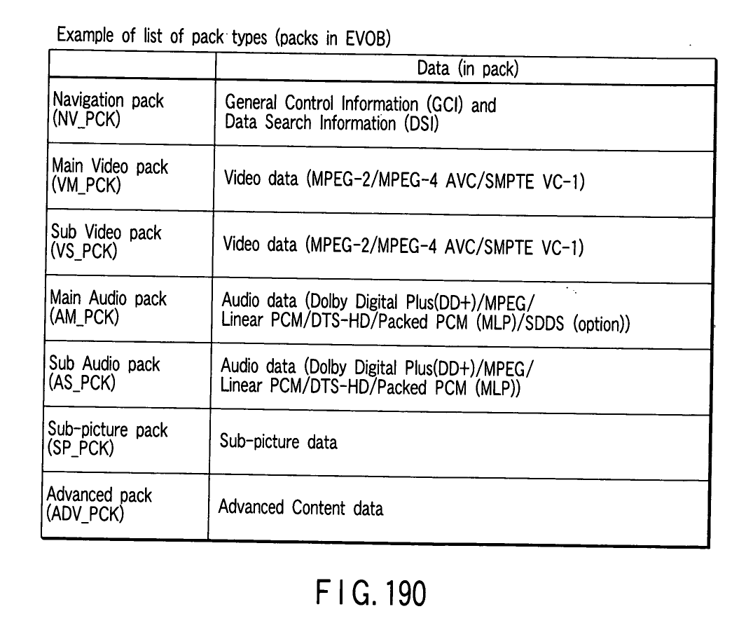

FIG. 190 is a view for explaining a list of pack types in an enhanced video object. This list of pack types has a Navigation pack (NV_PCK) configured to include General Control Information (GCI) and Data Search information (DSI), a Main Video pack (VM_PCK) configured to include Video data (MPEG-2/MPEG-4 AVC/SMPTE VC-1, etc.), a Sub Video pack (VS_PCK) configured to include Video data (MPEG-2/MPEG-4 AVC/SMPTE VC-1, etc.), a Main Audio Pack (AM_PCK) configured to include Audio data (Dolby Digital Plus (DD+)/MPEG/Linear PCM/DTS-HD/Packed PCM (MLP)/SDDS (option), etc.), a Sub Audio pack (AS_PCK) configured to include Audio data (Dolby Digital Plus (DD+)/MPEG/Linear PCM/DTS-HD/Packed PCM (MLP), etc.), a Sub-picture pack (SP_PCK) configured to include Sub-picture data, and an Advanced pack (ADV_PCK) configured to include Advanced Content data.

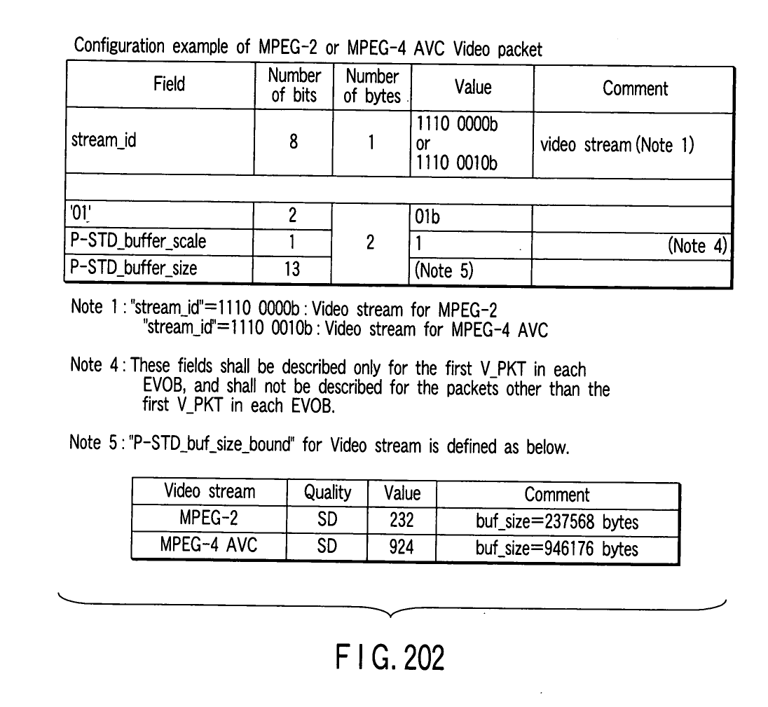

Note that the Main Video pack (VM_PCK) in the Primary Video Set follows the definition of a V_PCK in the Standard Content. The Sub Video pack in the Primary Video Set follows the definition of the V_PCK in the Standard Content, except for stream_id and P-STD_buffer_size (see FIG. 202).

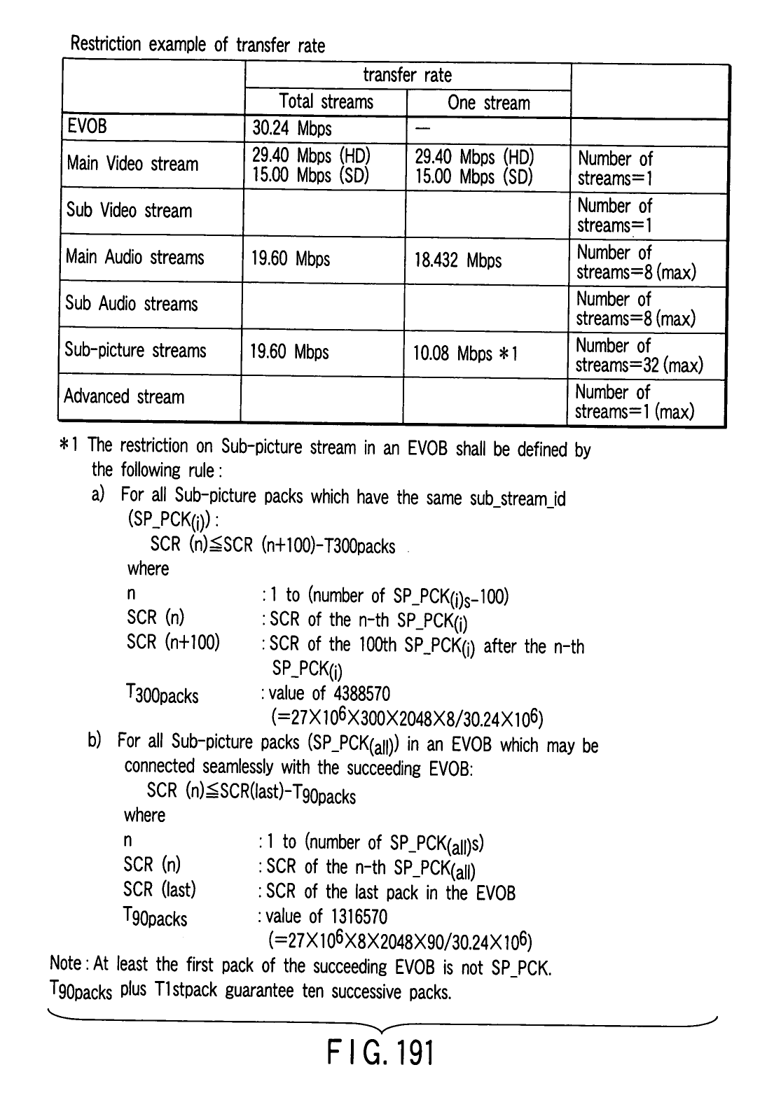

FIG. 191 is a view for explaining a restriction example of transfer rates on streams of an enhanced video object. In this restriction example of transfer rates, an EVOB is set with a restriction of 30.24 Mbps on Total streams. A Main Video stream is set with a restriction of 29.40 Mbps (HD) or 15.00 Mbps (SD) on Total streams, and a restriction of 29.40 Mbps (HD) or 15.00 Mbps (SD) on One stream. Main Audio streams are set with a restriction of 19.60 Mbps on Total streams, and a restriction of 18.432 Mbps on One stream. Sub-picture streams are set with a restriction of 19.60 Mbps on Total streams, and a restriction of 10.08 Mbps on One stream.

Note that the following rules can be applied to the restrictions on the Sub-picture stream in an EVOB:

For all Sub-picture packs (SP_PCK(i)) which have the same sub_stream_ID:
SCR (n)≦SCR (n+100)−T300packs

where

n: 1 to (number of SP_PCK(i)s−100)

SCR (n): SCR of n-th SP_PCK(i)

SCR (n+100): SCR of 100th SP_PCK(i) after n-th SP_PCK(i)

T300packs: value of 4388570 (=27×10⁶×300×2048×8/30.24×10⁶)

For all Sub-picture packs (SP_PCK(all)) in an EVOB which may be seamlessly connected with the succeeding EVOB:
SCR (n)≦SCR (last)−T90packs

where

n: 1 to (number of SP_PCK(all)s)

SCR (n): SCR of n-th SP_PCK(all)

SCR (last): SCR of last pack in EVOB

T90packs: value of 1316570 (=27×10⁶×8×2048×90/30.24×10⁶)

Note that at least the first pack of the succeeding EVOB is not an SP_PCK. T90packs+T1stpack guarantee ten successive packs.

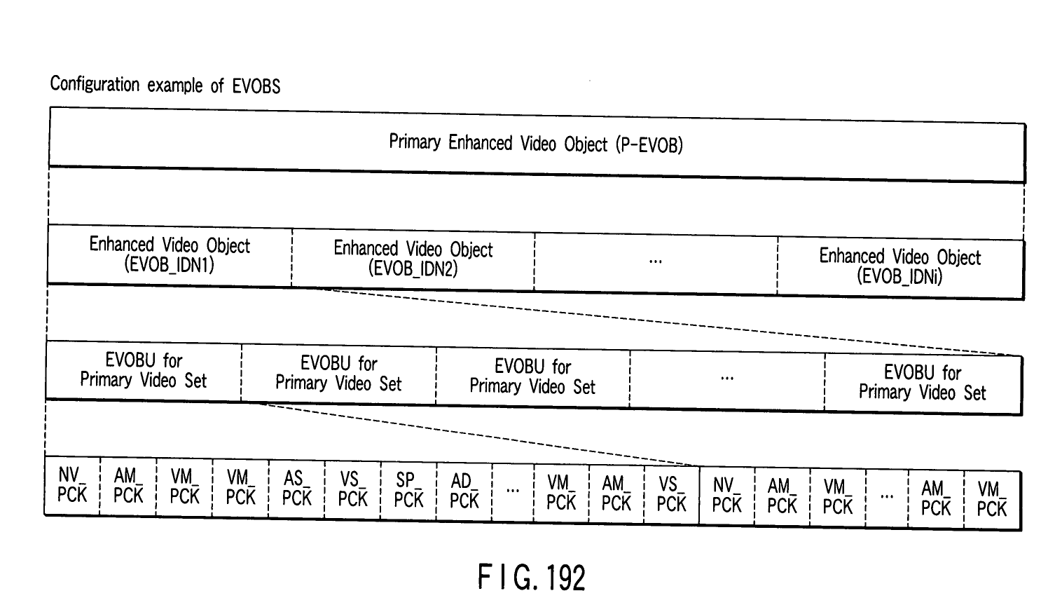

FIG. 192 is a view for explaining a configuration example of a primary enhanced video object (P-EVOB). An EVOB (this means a Primary EVOB, i.e., “P-EVOB”) includes some of Presentation Data and Navigation Data. As the Navigation Data included in the EVOB, General Control Information (GCI), Data Search Information (DSI), and the like are included. As the Presentation Data, Main/Sub video data, Main/Sub audio data, Sub-picture data, Advanced Content data, and the like are included.

An Enhanced Video Object Set (EVOBS) corresponds to a set of EVOBs, as shown in FIG. 192. The EVOB can be broken up into one or more (an integer number of) EVOBUs. Each EVOBU includes a series of packs (various kinds of packs exemplified in FIG. 192) which are arranged in the recording order. Each EVOBU starts from one NV_PCK, and is terminated at an arbitrary pack which is allocated immediately before the next NV_PCK in the identical EVOB (or the last pack of the EVOB). Except for the last EVOBU, each EVOBU corresponds to a playback time of 0.4 sec to 1.0 sec. Also, the last EVOBU corresponds to a playback time of 0.4 sec to 1.2 sec.

Furthermore, the following rules are applied to the EVOBU:

The playback time of the EVOBU is an integer multiple of video field/frame periods (even if the EVOBU does not include any video data);

The playback start and end times of the EVOBU is specified in 90-kHz units. The playback start time of the current EVOBU is set to be equal to the playback end time of the preceding EVOBU (except for the first EVOBU);

When the EVOBU includes video data, the playback start time of the EVOBU is set to be equal to the playback start time of the first video field/frame. The playback period of the EVOBU is set to be equal to or longer than that of the video data;

When the EVOBU includes video data, that video data indicates one or more PAUs (Picture Access Units);

When an EVOBU which does not include any video data follows an EVOBU which includes video data (in an identical EVOB), a sequence end code (SEQ_END_CODE) is appended after the last coded picture;

When the playback period of the EVOBU is longer than that of video data included in the EVOBU, a sequence end code (SEQ_END_CODE) is appended after the last coded picture;

Video data in the EVOBU does not have a plurality of sequence end codes (SEQ_END_CODE); and

When the EVOB includes one or more sequence end codes (SEQ_END_CODE), they are used in an ILVU. At this time, the playback period of the EVOBU is an integer multiple of video field/frame periods. Also, video data in the EVOBU has one I-picture data for a still picture, or no video data is included. The EVOBU which has one I-picture data for a still picture has one sequence end code (SEQ_END_CODE). The first EVOBU in the ILVU has video data.

Assume that the playback period of video data included in the EVOBU is the sum of the following A and B:

a difference between presentation time stamp PTS of the last video access unit (in the display order) in the EVOBU and presentation time stamp PTS of the first video access unit (in the display order); and

a presentation duration of the last video access unit (in the display order).

Each elementary stream is identified by stream_ID defined in a Program stream. Audio Presentation Data which are not defined by MPEG are stored in PES packets with stream_ID of private_stream_1. Navigation Data (GCI and DSI) are stored in PES packets with stream_ID of private_stream_2. The first bytes of data areas of packets of private_stream_1 and private_stream_2 are used to define sub_stream_ID. If stream_id is private_stream_1 or private_stream_2, the first byte of a data area of each packet can be assigned as sub_stream_id.

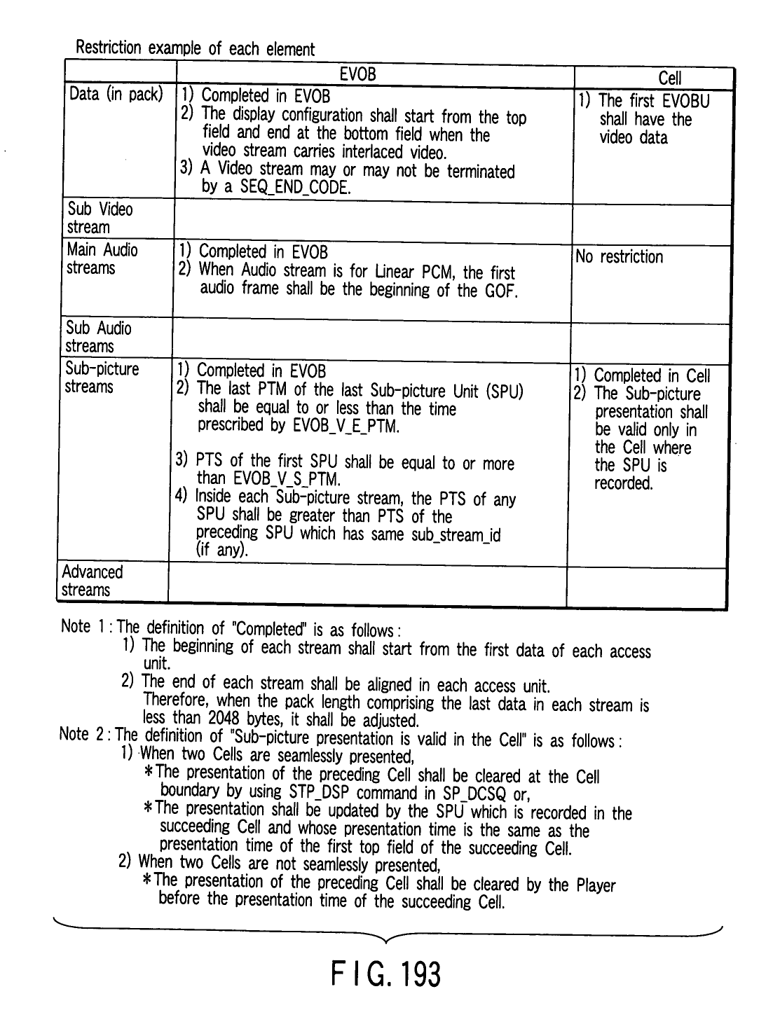

FIG. 193 is a view for explaining a restriction example of elements on a primary enhanced video object stream. In this element restriction example,

as for a Main Video stream,

the Main Video stream is completed within an EVOB;

if a video stream carries interlaced video, the display configuration starts from a top field and ends at a bottom field; and

a Video stream may or may not be terminated by a sequence end code (SEQ_END_CODE).

Furthermore, as for the Main Video stream,

the first EVOBU has video data.

As for a Main Audio stream,

the Main Audio stream is completed within an EVOB; and

when an Audio stream is for Linear PCM, the first audio frame is the beginning of the GOF.

As for a Sub-picture stream,

the Sub-picture stream is completed within the EVOB;

the last playback time (PTM) of the last Sub-picture unit (SPU) is equal to or less than the time prescribed by EVOB_V_E_PTM (video end time);

the PTS of the first SPU is equal to or more than EVOB_V_S_PTM (video start time); and

in each Sub-picture stream, the PTS of any SPU is larger than that of the preceding SPU having the same sub_stream_id (if any).

Furthermore, as for the Sub-picture stream,

the Sub-picture stream is completed within a cell; and

the Sub-picture presentation is valid within the cell where the SPU is recorded.

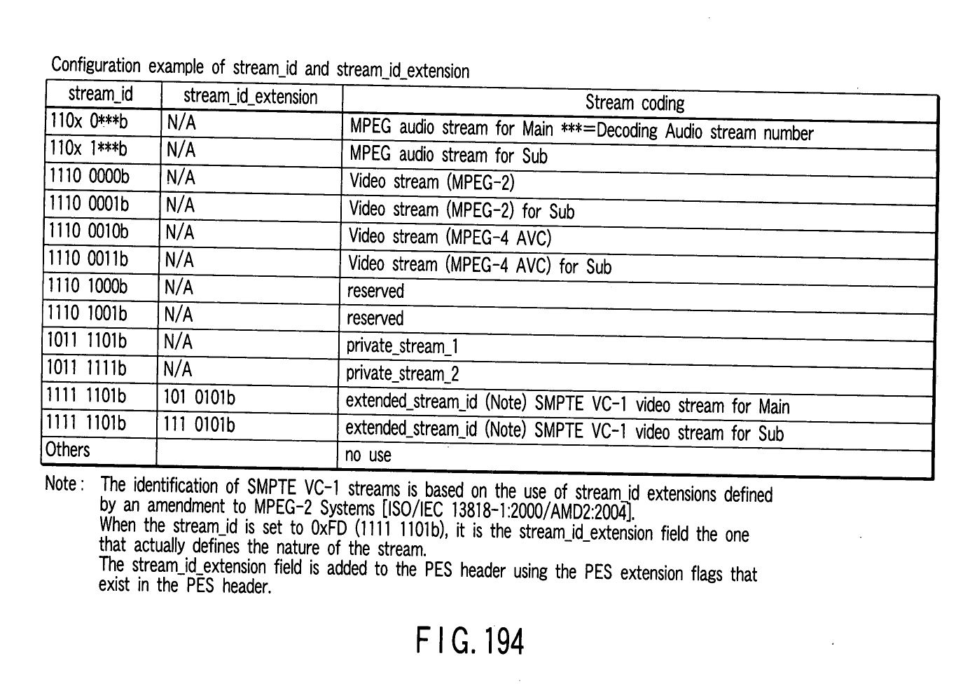

FIG. 194 is a view for explaining a configuration example of a stream id and stream id extension. In this stream_id and stream_id_extension,

stream_id=110x 0***b specifies stream_id_extension=N/A, and Stream coding=MPEG audio stream for Main ***=Decoding Audio stream number;

stream_id=110x 1***b specifies stream_id_extension=N/A, and Stream coding=MPEG audio stream for Sub;

stream_id=1110 0000b specifies stream_id_extension=N/A, and Stream coding=Video stream (MPEG-2);

stream_id=1110 0001b specifies stream_id_extension=N/A, and Stream coding=Video stream (MPEG-2) for Sub;

stream_id=1110 0010b specifies stream_id_extension=N/A, and Stream coding=Video stream (MPEG-4 AVC);

stream_id=1110 0011b specifies stream_id_extension=N/A, and Stream coding=Video stream (MPEG-4 AVC) for Sub;

stream_id=1110 1000b specifies stream_id_extension=N/A, and Stream coding=reserved;

stream_id=1110 1001b specifies stream_id_extension=N/A, and Stream coding=reserved;

stream_id=1011 1101b specifies stream_id_extension=N/A, and Stream coding=private_stream_1;

stream_id=1011 1111b specifies stream_id_extension=N/A, and Stream coding=private_stream_2;

stream_id=1111 1101b specifies stream_id_extension=101 0101b, and Stream coding=extended_stream_id (note) SMPTE VC-1 video stream for Main;

stream_id=1111 1101b specifies stream_id_extension=111 0101b, and Stream coding=extended_stream_id (note) SMPTE VC-1 video stream for Sub; and

stream_id=Others specifies stream coding=no use.

Note: The identification of SMPTE VC-1 streams is based on the use of stream_id extensions defined by an amendment to MPEG-2 Systems [ISO/IEC 13818-1:2000/AMD2:2004]. When the stream_ID is set to be 0xFD (1111 1101b), the stream_id_extension field is used to actually define the nature of the stream. The stream_id_extension field is added to the PES header using the PES extension flags which exist in the PES header.

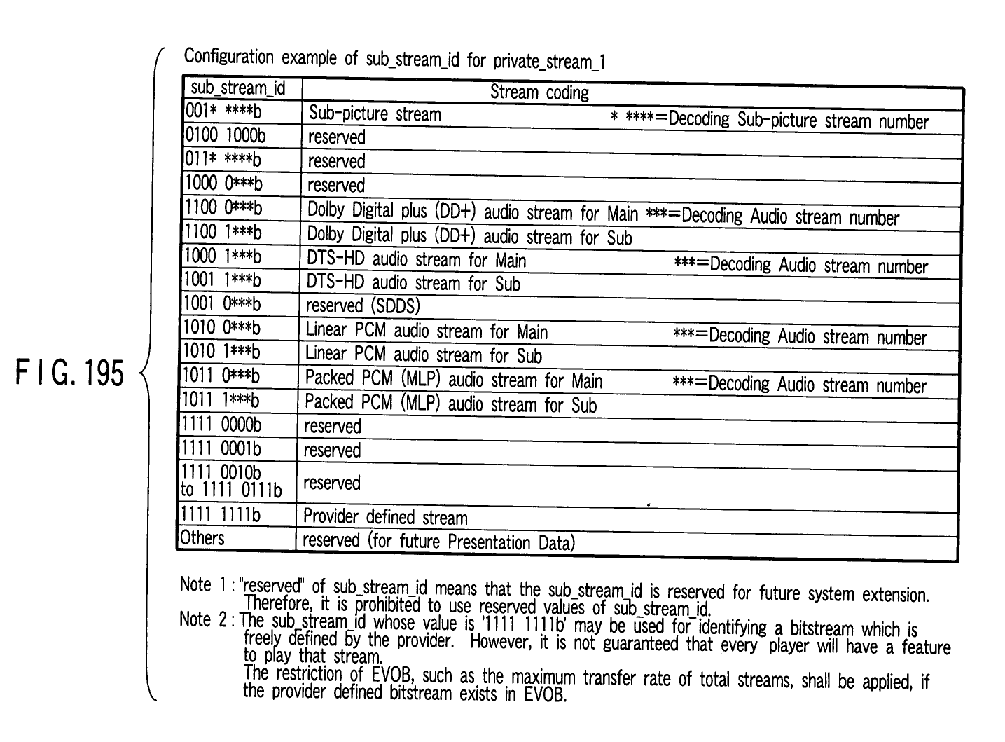

FIG. 195 is a view for explaining a configuration example of a substream id for private stream 1. In this sub_stream_id for private_stream_1,

sub_stream_id=001* ****b specifies Stream coding=Sub-picture stream* ****=Decoding Sub-picture stream number;

sub_stream_id=0100 1000b specifies Stream coding=reserved;

sub_stream_id=011* ****b specifies Stream coding=reserved;

sub_stream_id=1000 0***b specifies Stream coding=reserved;

sub_stream_id=1100 0***b specifies Stream coding=Dolby Digital plus (DD+) audio stream for Main ***=Decoding Audio stream number;

sub_stream_id=1100 1***b specifies Stream coding=Dolby Digital plus (DD+) audio stream for Sub;

sub_stream_id=1000 1***b specifies Stream coding=DTS-HD audio stream for Main ***=Decoding Audio stream number;

sub_stream_id=1001 1***b specifies Stream coding=DTS-HD audio stream for Sub;

sub_stream_id=1001 0***b specifies Stream coding=reserved (SDDS);

sub_stream_id=1010 0***b specifies Stream coding=Linear PCM audio stream for Main ***=Decoding Audio stream number;

sub_stream_id=1010 1***b specifies Stream coding=Linear PCM audio stream for Sub;

sub_stream_id=1011 0***b specifies Stream coding=Packed PCM (MLP) audio stream for Main ***=Decoding Audio stream number;

sub_stream_id=1011 1***b specifies Stream coding=Packed PCM (MLP) audio stream for Sub;

sub_stream_id=1111 0000b specifies Stream coding=reserved;

sub_stream_id=1111 0001b specifies Stream coding=reserved;

sub_stream_id=1111 0010b to 1111 0111b specifies Stream coding=reserved;

sub_stream_id=1111 1111b specifies Stream coding=Provider defined stream; and

sub_stream_id=Others specifies Stream coding=reserved (for future Presentation data).

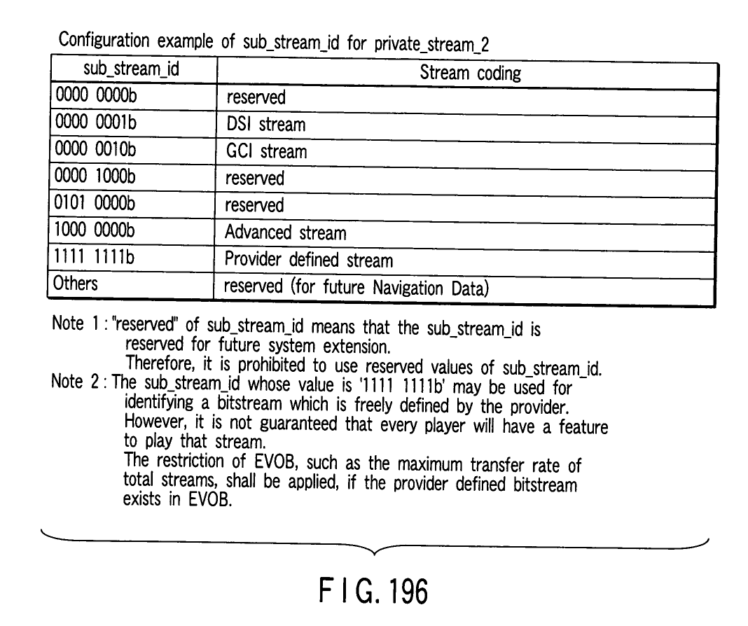

FIG. 196 is a view for explaining a configuration example of a substream id for private stream 2. In this sub_stream_id for private_stream_2,

sub_stream_id=0000 0000b specifies Stream coding=reserved;

sub_stream_id=0000 0001b specifies Stream ceding=DSI stream;

sub_stream_id=0000 0010b specifies Stream coding=GCI stream;

sub_stream_id=0000 1000b specifies Stream coding=reserved;

sub_stream_id=0101 0000b specifies Stream coding=reserved;

sub_stream_id=1000 0000b specifies Stream coding=Advanced stream;

sub_stream_id=1111 1111b specifies Stream coding=Provider defined stream; and

sub_stream_id=Others specifies Stream coding=reserved (for future Navigation data).

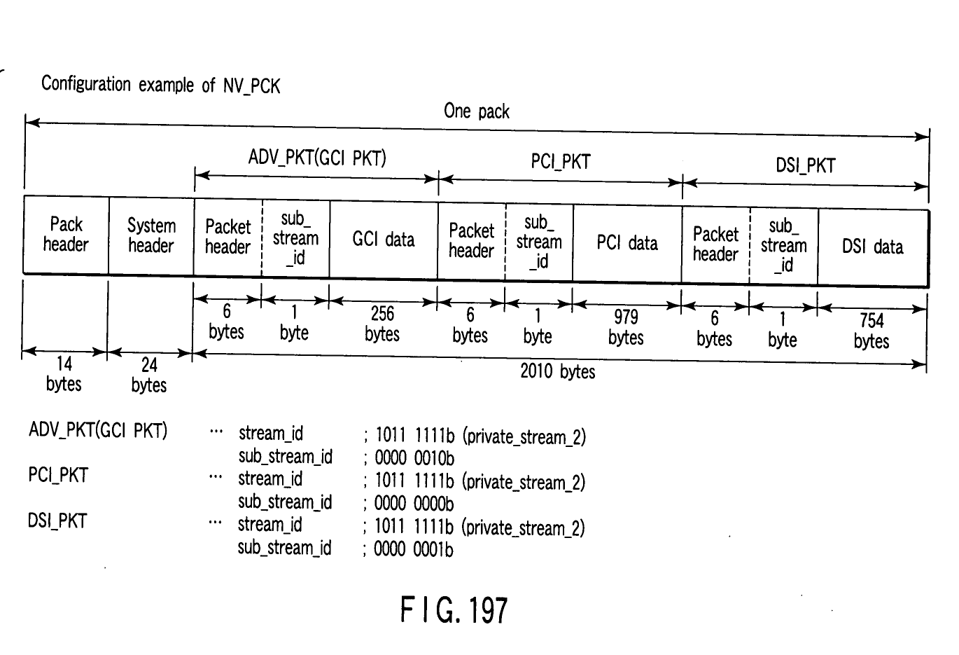

FIG. 197 is a view for explaining a configuration example of a navigation pack (NV_PCK) aligned at the head of an enhanced video object unit (EVOBU). The structures of a pack and packet comply with “The system part of the MPEG-2 standard (ISO/IEC 13818-1:2000, ISO/IEC 13818-1:2000/COR1:2002, ISO/IEC 13818-1:2000/COR2:2002, ISO/IEC 13818-1:2000/AMD1:2003, ISO/IEC 13818-1:2000/AMD2:2004, and ISO/IEC 13818-1:2000/AMD3:2005)”.

As exemplified in FIG. 197, a Navigation pack (NV_PCK) is configured to include a pack header, system header, Advanced packet or General Control information packet (ADV_PKT or GCI_PKT), Presentation Control Information packet (PCI_PKT), and Data Search Information Packet (DSI_PKT). In this example, the ADV_PKT or GCI_PKT is specified by stream_id=1011 1111b (private_stream_2) and sub_stream_id=0000 0010b, and the DSI_PKT is specified by stream_id=1011 1111b (private_stream_2) and sub_stream_id=0000 0001b.

Note that the storage location of the PCI_PKT of FIG. 197 may be a reserved area, and this pack can be configured to ignore a PCI_PKT even if it is included in this area.

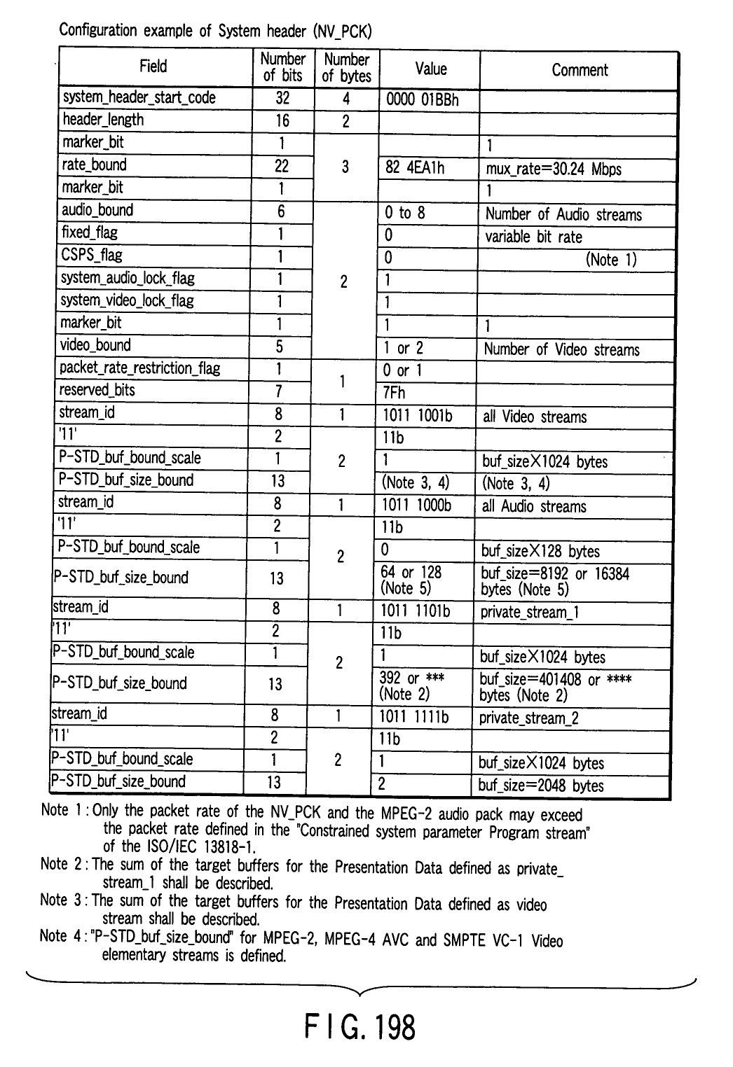

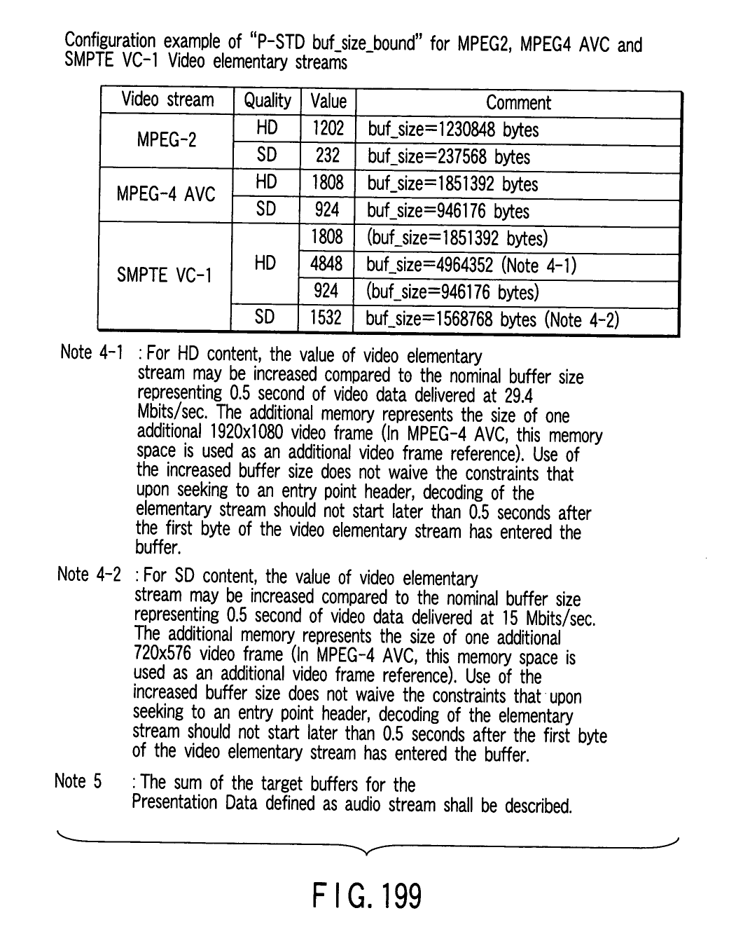

FIG. 198 is a view for explaining a configuration example of the system header of the NV_PCK in FIG. 197, and FIG. 199 is a view for explaining a configuration example of a buffer size boundary (P-STD_buf_size_bound) for MPEG-2/MPEG-4 AVC/SMPTE VC-1 video elementary streams in the system header in FIG. 198.

A Quality field includes HD as a high resolution, and SD as a standard resolution. In Video stream=MPEG-2, Quality=HD is specified by Value=1202 (buf_size=1230848 bytes), and Quality=SD is specified by Value=232 (buf_size=237568 bytes). In Video stream=MPEG-4 AVC, Quality=HD is specified by Value=1808 (buf_size=1851392 bytes), and Quality=SD is specified by Value=924 (buf_size=946176 bytes). Furthermore, in Video stream=SMPTE VC-1, Quality=HD is specified by Value=1808 (buf_size=1851392 bytes) or Value=4848 (buf_size=4964352 bytes), and Quality=SD is specified by Value=924 (buf_size=946176 bytes) or Value=1532 (buf_size=1568768 bytes)

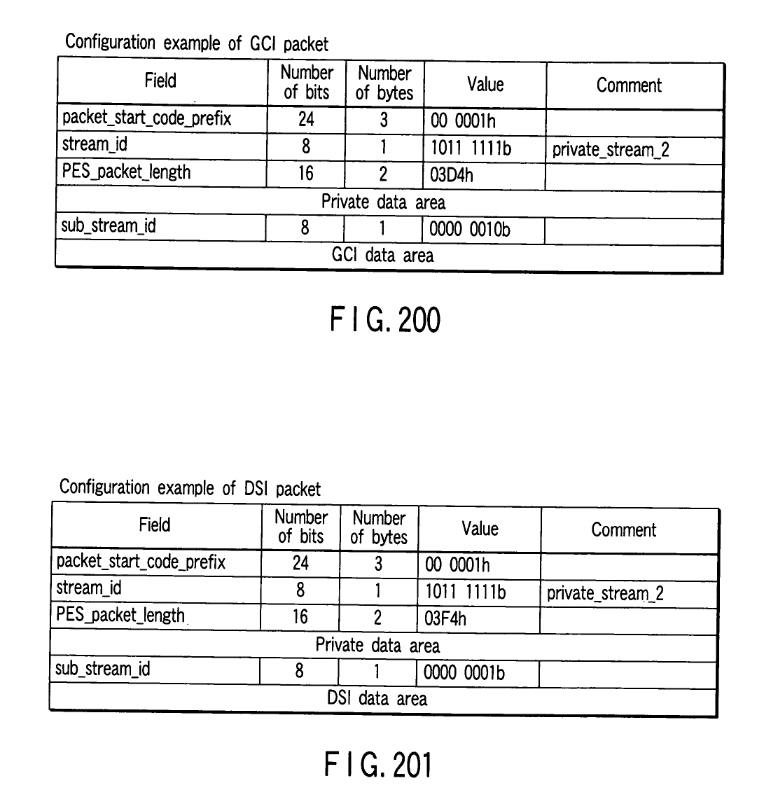

FIG. 200 is a view for explaining a configuration example of a general control information (GCI) packet. This GCI packet is configured to include packet_start_code_prefix, stream_ID, PES_packet_length (03D4h), a Private data area, sub_stream_ID (0000 0010b), and a GCI data area.

FIG. 201 is a view for explaining a configuration example of a data search information (DSI) packet. This DSI packet is configured to include packet_start_code_prefix, stream_ID, PES_packet_length (03FAh), a Private data area, sub_stream_ID (0000 0001b), and a DSI data area.

FIG. 202 is a view for explaining a configuration example of a video packet for MPEG-2 or MPEG-4 AVC. A Video packet for MPEG-2 or MPEG-4 AVC is configured to include stream_ID, P-STD_buffer_scale, and P-STD_buffer_size. A Video stream for MPEG-2 is specified by stream_id=1110 0000b, and a Video stream for MPEG-4 AVC is specified by stream_id=1110 0010b. Note that “P-STD_buf_size_bound” for a Video stream is defined as follows. That is, in Video stream=MPEG-2, Quality=SD is specified by Value=232 (buf_size=237568 bytes). In Video stream=MPEG-4 AVC, Quality=SD is specified by Value=924 (buf_size=946176 bytes).

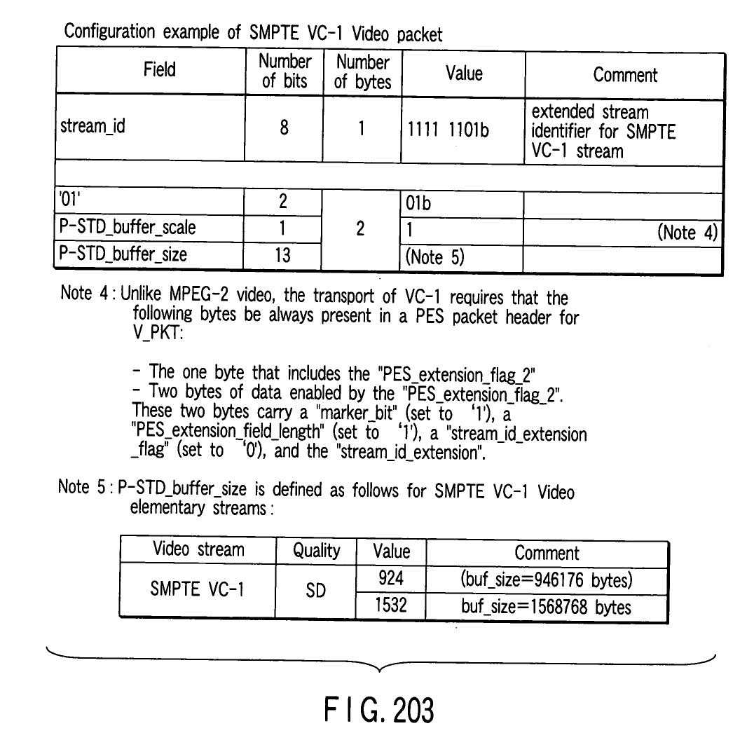

FIG. 203 is a view for explaining a configuration example of a video packet for SMPTE VC-1. In a Video packet for SMPTE VC-1, a stream_id field=1111 1101b specifies an extended stream identifier for an SMPTE VC-1 stream, and fields ‘01’=01b, P-STD_buffer_scale=1, and P-STD_buffer_size=Note 5 specify the contents of Note 4.

Note 4: Unlike MPEG-2 video, the transport of VC-1 requires that the following bytes always be present in a PES packet header for a V_PKT:

one byte including “PES_extension_flag_2”; and

two-byte data enabled by “PES_extension_flag_2”. These two bytes carry:

a “marker_bit” (set to ‘1’),

“PES_extension_field_length” (set to ‘1’),

“stream_id extension_flag” (set to ‘0’), and

“stream_id_extension”.

Note 5: P-STD_buffer_size is defined as follows for SMPTE VC-1 Video elementary streams:

in case of Video stream=SMPTE VC-1 and Quality=SD, buffer size buf_size=946176 bytes is defined for Value=924, and buffer size buf_size=1568768 bytes is defined for Value=1532.

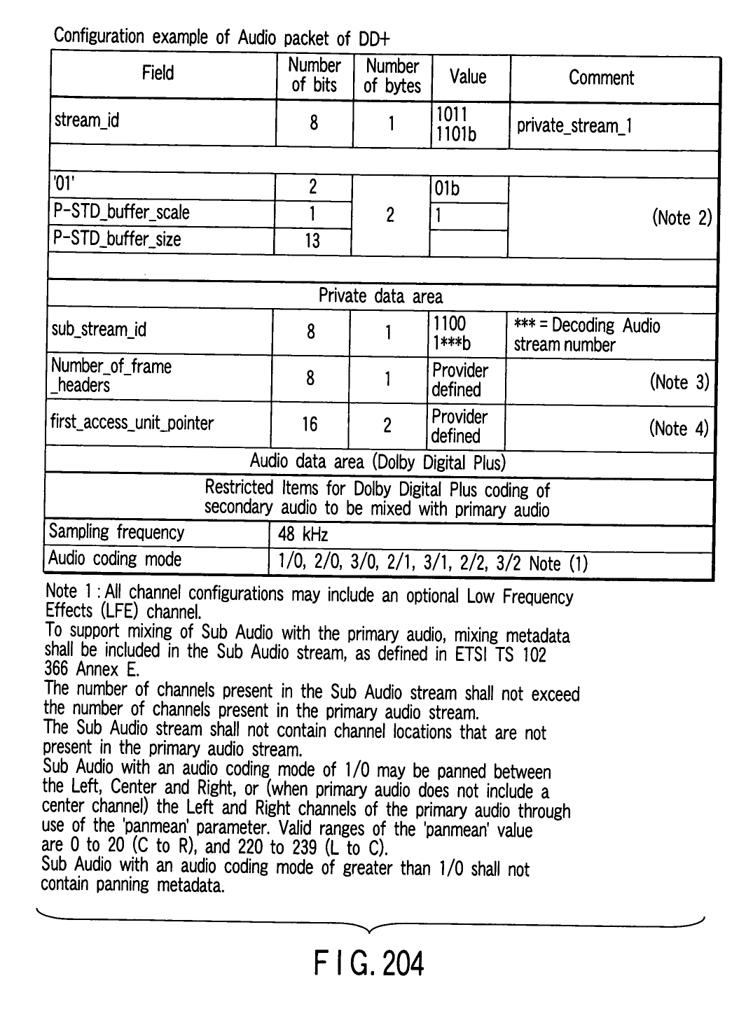

FIG. 204 is a view for explaining a configuration example of an audio packet for DD+. In this example, the sampling frequency is fixed at 48 kHz, and a plurality of audio coding modes are available. All audio channel configuration can include an optional Low Frequency Effects (LFE) channel. In order to support an environment that can mix sub audio with primary audio, mixing meta data is included in a sub audio stream. The number of channels in the sub audio stream does not exceed that in a primary audio stream. The sub audio stream does not include any channel location which does not exist in the primary audio stream. Sub audio with an audio coding mode of “1/0” may be panned between the left, center, and right channels. Alternatively, when primary audio does not include a center channel, the sub audio may be panned between the left and right channels of the primary audio through the use of a “panmean” parameter. Note that the “panmean” value has a valid range e.g., from 0 to 20 from the center to the right, and that from 220 to 239 from the center to the left. Sub audio of an audio coding mode of greater than “1/0” does not include any panning parameter.

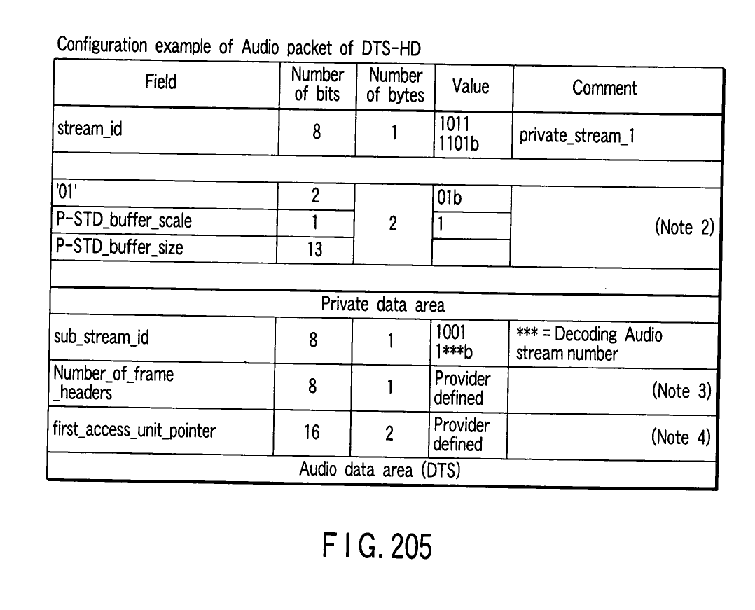

FIG. 205 is a view for explaining a configuration example of an audio packet for DTS-HD. Note that an audio packet for linear PCM can have the following configuration (although not shown). That is, in an Audio packet for Linear PCM, a stream_id field=1011 1101b specifies private_stream_1, and fields ‘01’=01b, P-STD_buffer_scale=1, and P-STD_buffer_size=392 specify the contents of Note 2.

A Private data area is configured to include fields of sub_stream_id=1010 0***b (***=Decoding Audio stream number), number_of_frame_headers (Note 3), first_access_unit_pointer (Note 4), audio_emphasis flag (Note 5), audio_mute_flag (Note 6), reserved, audio_frame_number (Note 7), quantization_word_length (Note 8), audio_sampling_frequency (Note 9), reserved, number_of_audio_channels (Note 10), and dynamic_range_control (Note 11).

Note 2: In each EVOB, these fields appear in the first packet, and are inhibited in subsequent packets in respective sequences of private_stream_1 packets identified by the same sub_stream_id (from appearance of the fields of Note 2). A total of target buffers for Presentation Data defined as private_stream_1 is described for a P-STD buffer size.

Note 3: The field “number_of_frame_headers” describes the number of audio frames whose first bytes are included in the A_PKT of interest.

Note 4: The access unit in this case is an audio frame. The first access unit is the first audio frame which has the first byte of the audio frame, and is specified by the PTS of the A_PCK of interest. The field “first_access_unit_pointer” describes the first byte address of the first access unit with relative block number RBN from the last byte of the information of interest. If no first byte of this first access unit exists, (0000h) is described in “first_access_unit_pointer”.

Note 5: The field “audio_emphasis_flag” describes state of emphasis (0b=emphasis off; 1b=emphasis on). For example, if “audio_sampling_frequency” is 96 kHz, “emphasis off” is described using this field. This emphasis is applied to all audio samples decoded from the first access unit.

Note 6: The field “audio_mute_flag” describes a state of mute (0b=mute off; 1b=mute on) while all data in an audio frame become zero. This mute is applied to all audio samples decoded from the first access unit.

Note 7: The field “audio_frame_number” describes a frame number (a number ranging from 0 to 19) of the first access unit in a Group of audio frames (GOF). If no first byte is included in the access unit, ‘1111b’ is described in “audio_frame_number”.

Note 8: The field “quantization_word_length” describes one of the following word-lengths used to quantize audio samples:

00b=16 bits

01b=20 bits

10b=24 bits

11b=reserved

Note 9: The field “audio_sampling_frequency” describes the sampling frequency of audio samples:

00b=48 kHz

01b=96 kHz

Others=reserved

Note 10: The field “number_of_audio_channels” describes the number of Audio channels”

000b=1ch (mono)

001b=2ch (stereo)

010b=3ch

011b=4ch

100b=5ch

101b=6ch

110b=7ch

111b=8ch

Note 11: The field “dynamic_range_control” describes a dynamic range control word used to compress the dynamic range from the first access unit. For example, if an 8-bit “dynamic_range_control” word [b7 b6 b5 b4 b3 b2 b1 b0] is used, upper 3 bits [b7 b6 b5] are defined as unsigned integer X, and lower 5 bits [b4 b3 b2 b1 b0] are defined as unsigned integer Y, the following gain control value can be obtained:

As linear indication,
G=2^{4-(X+Y/30)}

(0≦X≦7, 0≦Y≦29)

As dB indication,
G=24.082−6.0206X−0.2007Y

(0≦X≦7, 0≦Y≦29)

Note that when no dynamic range control is applied, the value of “dynamic_range_control” is fixed to ‘1000 0000b’.

Dynamic range control value G above is preferably applied (uniformly) to all audio samples to be decoded from the first access unit.

Also, an audio packet for MPEG audio can have the following configuration (although not shown). In an Audio packet for MPEG audio, a stream_id field=1100 0***b or 1101 0***b specifies an MPEG audio stream (***=Decoding Audio stream number (Note 1)), and that also has fields of ‘01’, P-STD_buffer_scale, and P-STD_buffer_size.

Note 1: In case of “stream_id”=1100 0***b, packets include one of the following streams:

an MPEG-1 audio stream,

an MPEG-2 audio stream if no MPEG-2 extension audio stream exists, and

an MPEG-2 main audio stream if an MPEG-2 extension audio stream exists.

In case of “stream_id”=1101 0***b, packets include an MPEG-2 extension audio stream.

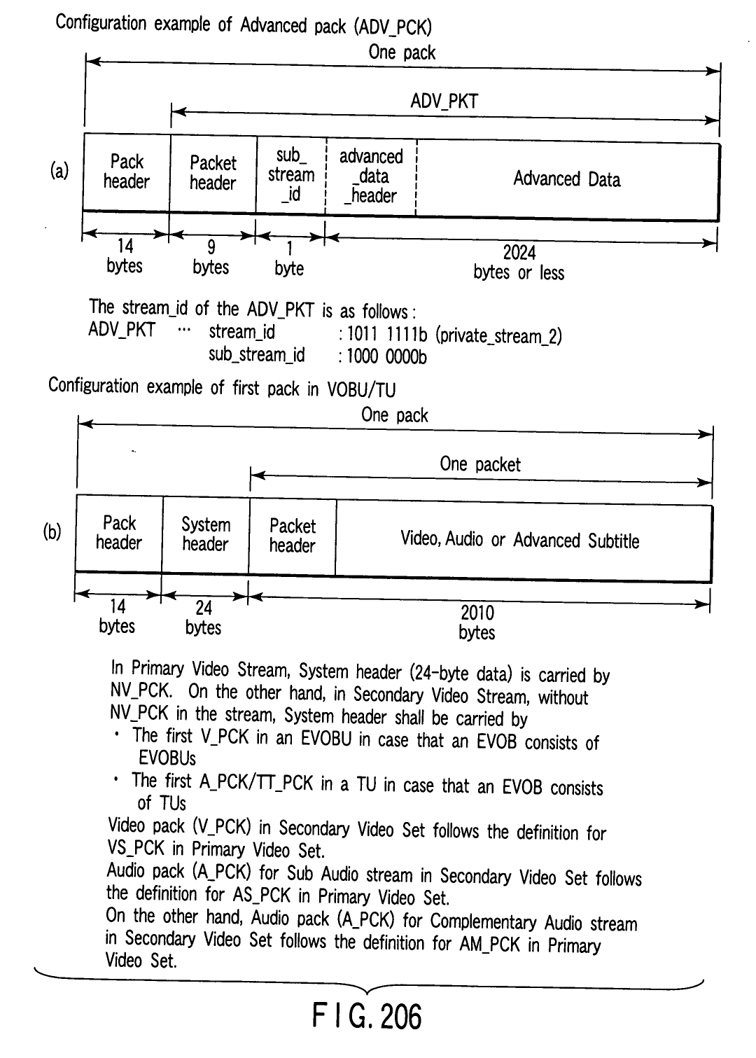

FIG. 206 is a view for explaining a configuration example of an advanced pack (ADV_PCK) and the first pack of a_video object unit/time unit (VOBU/TU). An ADV_PCK in FIG. 206(a) comprises a pack header and Advanced packet (ADV_PKT). Advanced data (Advanced stream) is aligned to a boundary of logical blocks. Only in case of the last pack of Advanced data (Advanced stream), the ADV_PCK can have a padding packet or stuffing bytes. In this way, when the ADV_PCK length including the last data of the Advanced stream is smaller than 2048 bytes, that pack length can be adjusted to have 2048 bytes. The stream_id of this ADV_PCK is, e.g., 1011 1111b (private_stream_2), and its sub_stream_id is, e.g., 1000 0000b.

A VOBU/TU in FIG. 206(b) comprises a pack header, System header, and VOBU/TU packet. In a Primary Video Stream, the System header (24-byte data) is carried by an NV_PCK. On the other hand, in a Secondary Video Stream, the stream does not include any NV_PCK, and the System header is carried by:

the first V_PCK in an EVOBU when an EVOB includes EVOBUs; or

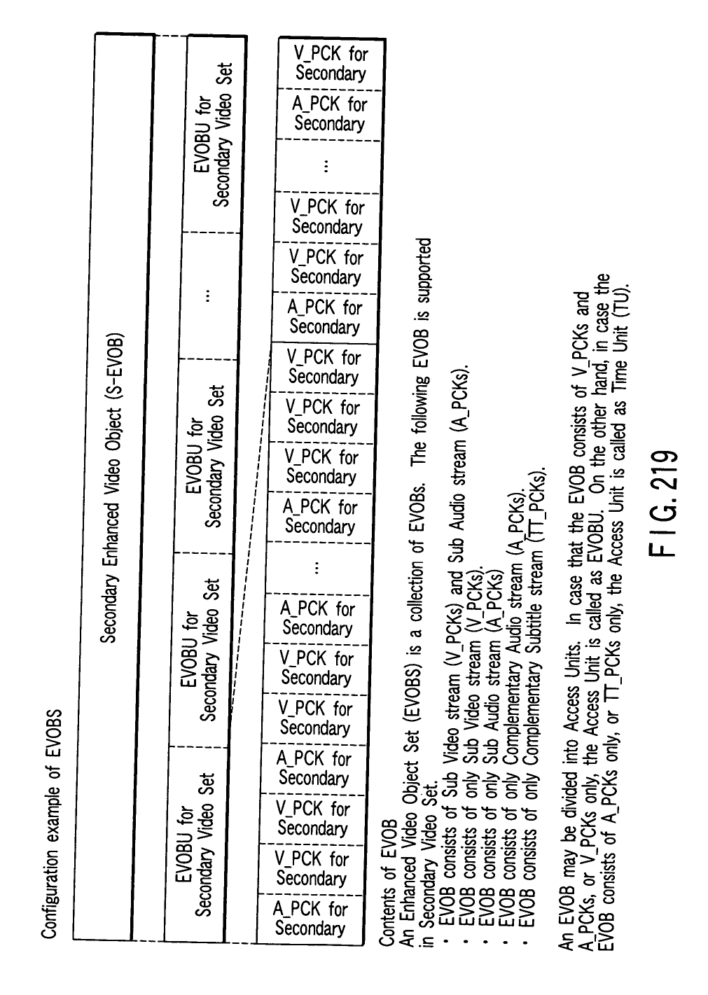

the first A_PCK or first TT_PCK when an EVOB includes TUs. (TU=Time Unit will be described later using FIG. 219.)

A video pack (V_PCK) in a Secondary Video Set follows the definitions of a VS_PCK in a Primary Video Set. An audio pack (A_PCK) for a Sub Audio Stream in the Secondary Video Set follows the definition for an AS_PCK in the Primary Video Set. On the other hand, an audio pack (A_PCK) for a Complementary Audio stream in the Secondary Video Set follows the definition for an AM_PCK in the Primary Video Set.

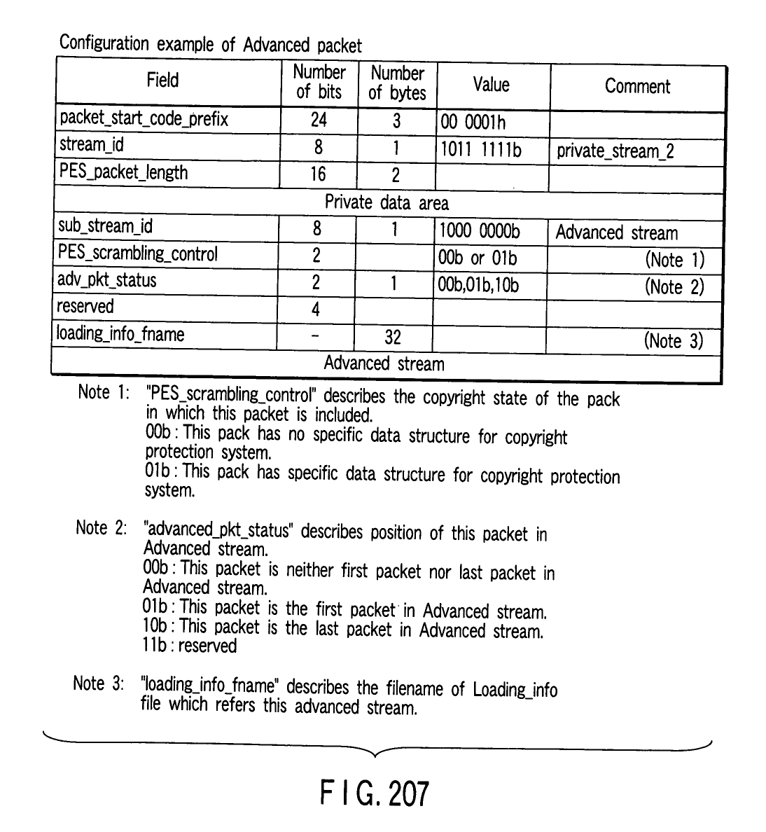

FIG. 207 is a view for explaining a configuration example of an advanced packet. In this Advanced packet, a packet_start_code_prefix field has a value “00 0001h”, a stream_id field=1011 1111b specifies private_stream_2, and a PES_packet_length field is included. The Advanced packet has a Private data area, in which a sub_stream_id field=1000 0000b specifies an Advanced stream, a PES_scrambling_control field assumes a value “00b” or “01b” (Note 1), and an adv_pkt_status field assumes a value “00b”, “01b”, or “10b” (Note 2). Also, the Private data area includes a loading_info_fname field (Note 3) which describes the filename of a loading information file which refers to the advanced stream of interest.

Note 1: The “PES_scrambling_control” field describes the copyright state of the pack that includes this advanced packet: 00b specifies that the pack of interest does not have any specific data structure of a copyright protection system, and 01b specifies that the pack of interest has a specific data structure of a copyright protection system.

Note 2: The adv_pkt_status field describes the position of the packet of interest (advanced packet) in the Advanced stream: 00b specifies that the packet of interest is neither the first packet nor the last packet in the Advanced stream, 01b specifies that the packet of interest is the first packet in the Advanced stream, and 10b specifies that the packet of interest is the last packet in the Advanced stream. 11b is reserved.

Note 3: The loading_info_fname field describes the filename of loading information file that refers to the advanced stream of interest.

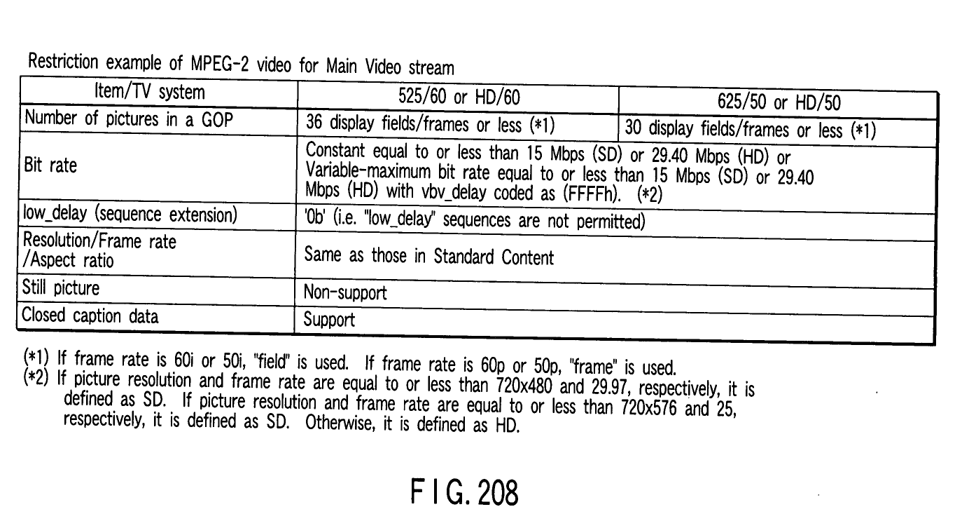

FIG. 208 is a view for explaining a restriction example of MPEG-2 video for a main video stream. In MPEG-2 video for a Main Video stream in a Primary Video Set, the number of pictures in a GOP is 36 display fields/frames or less in case of 525/60 (NTSC) or HD/60 (in this case, if the frame rate is 60 interlaced (i) or 50i, “field” is used; and if the frame rate is 60 progressive (p) or 50p, “frame” is used). On the other hand, the number of pictures in the GOP is 30 display fields/frames in case of 625/50 (PAL, etc.) or HD/50 (in this case as well, if the frame rate is 60i or 50i, “field” is used; and if the frame rate is 60p or 50p, “frame” is used).

The Bit rate in MPEG-2 video for the Main Video stream in the Primary Video Set assumes a constant value equal to or less than 15 Mbps (SD) or 29.40 Mbps (HD) in both the case of 525/60 or HD/60 and the case of 625/50 or HD/50. Alternatively, in case of a variable bit rate, a Variable-maximum bit rate is equal to or less than 15 Mbps (SD) or 29.40 Mbps (HD). In this case, dvd_delay is coded as (FFFFh). (If the picture resolution and frame rate are equal to or less than 720×480 and 29.97, respectively, SD is defined. Likewise, if the picture resolution and frame rate are equal to or less than 720×576 and 25, respectively, SD is defined. Otherwise, HD is defined.)

In MPEG-2 video for the Main Video stream in the Primary Video Set, low_delay (sequence extension) is set to ‘0b ’ (i.e., “low_delay sequence” is not permitted).

In MPEG-2 video for the Main Video stream in the Primary Video Set, the Resolution (=Horizontal_size/vertical_size)/Frame rate (=frame_rate_value)/Aspect ratio are the same as those in a Standard Content. More specifically, the following variations are available if they are described in the order of Horizontal_size/vertical_size/frame_rate_value/aspect_ratio_information/aspect ratio: 1920/1080/29.97/‘0011b’ or ‘0010b’/16:9;

1440/1080/29.97/‘0011b’ or ‘0010b’/16:9;

1440/1080/29.97/‘0011b’/4:3;

1280/1080/29.97/‘0011b’ or ‘0010b’/16:9;

1280/720/59.94/‘0011b’ or ‘0010b’/16:9;

960/1080/29.97/‘0011b’ or ‘0010b’/16:9;

720/480/59.94/‘0011b’ or ‘0010b’/16:9;

720/480/29.97/‘0011b’ or ‘0010b’/16:9;

720/480/29.97/‘0010b’/4:3;

704/480/59.94/‘0011b’ or ‘0010b’/16:9;

704/480/29.97/‘0011b’ or ‘0010b’/16:9;

704/480/29.97/‘0010b’/4:3;

544/480/29.97/‘0011b’ or ‘0010b’/16:9;

544/480/29.97/‘0010b’/4:3;

480/480/29.97/‘0011b’ or ‘0010b’/16:9;

480/480/29.97/‘0010b’/4:3;

352/480/29.97/‘0011b’ or ‘0010b’/16:9;

352/480/29.97/‘0010b’/4:3;

352/240 (note*1, note*2)/29.97/‘0010b’/4:3;

1920/1080/25/‘0011b’ or ‘0010b’/16:9;

1440/1080/25/‘0011b’ or ‘0010b’/16:9;

1440/1080/25/‘0011b’/4:3;

1280/1080/25/‘0011b’ or ‘0010b’/16:9;

1280/720/50/‘0011b’ or ‘0010b’/16:9;

960/1080/25/‘0011b’/16:9;

720/576/50/‘0011b’ or ‘0010b’/16:9;

720/576/25/‘0011b’ or ‘0010b’/16:9;

720/576/25/‘0010b’/4:3;

704/576/50/‘0011b’ or ‘0010b’/16:9;

704/576/25/‘0011b’ or ‘0010b’/16:9;

704/576/25/‘0010b’/4:3;

544/576/25/‘0011b’ or ‘0010b’/16:9;

544/576/25/‘0010b’/4:3;

480/576/25/‘0011b’ or ‘0010b’/16:9;

480/576/25/‘0010b’/4:3;

352/576/25/‘0011b’ or ‘0010b’/16:9;

352/576/25/‘0010b’/4:3;

352/288 (note *1)/25/‘0010b’/4:3.

Note *1: The Interlaced SIF format (352×240/288) is not adopted.

Note *2: When “vertical_size” is ‘240’, “progressive_sequence” is ‘1’. In this case, the meanings of “top_field_first” and “repeat_first_field” are different from those when “progressive_sequence” is ‘0’.

When the aspect ratio is 4:3, horizontal_size/display_horizontal_size/aspect_ratio_information are as follows (DAR=Display Aspect Ratio):

720 or 704/720/‘0010b’ (DAR=4:3);

544/540/‘0010b’ (DAR=4:3);

480/480/‘0010b’ (DAR=4:3);

352/352/‘0010b’ (DAR=4:3).

When the aspect ratio is 16:9, horizontal_size/display_horizontal_size/aspect_ratio_information/Display mode in FP_PGCM_V_ATR/VMGM_V_ATR; VTSM_V_ATR; VTS_V_ATR are as follows (DAR=Display Aspect Ratio): 1920/1920/‘0011b’ (DAR=16:9)/Only Letterbox; 1920/1440/‘0010b’ (DAR=4:3)/Only Pan-scan, or Both Letterbox and Pan-scan;

1440/1440/‘0011b’ (DAR=16:9)/Only Letterbox;

1440/1080/‘0010b’ (DAR=4:3)/Only Pan-scan, or Both Letterbox and Pan-scan;

1280/1280/‘0011b’ (DAR=16:9)/Only Letterbox;

1280/960/‘0010b’ (DAR=4:3)/Only Pan-scan, or Both Letterbox and Pan-scan;

960/960/‘0011b’ (DAR=16:9)/Only Letterbox;

960/720/‘0010b’ (DAR=4:3)/Only Pan-scan, or Both Letterbox and Pan-scan;

720 or 704/720/‘0011b’ (DAR=16:9)/Only Letterbox;

720 or 704/540/‘0010b’ (DAR=4:3)/Only Pan-scan, or Both Letterbox and Pan-scan;

544/540/‘0011b’ (DAR=16:9)/Only Letterbox;

544/405/‘0010b’ (DAR=4:3)/Only Pan-scan, or Both Letterbox and Pan-scan;

480/480/‘0011b’ (DAR=16:9)/Only Letterbox;

480/360/‘0010b’ (DAR=4:3)/Only Pan-scan, or Both Letterbox and Pan-scan;

352/352/‘0011b’ (DAR=16:9)/Only Letterbox;

352/270/‘0010b’ (DAR=4:3)/Only Pan-scan, or Both Letterbox and Pan-scan.

In FIG. 208, still picture data in MPEG-2 video for the Main Video stream in the Primary Video Set is not supported. However, Closed caption data in MPEG-2 video for the Main Video stream in the Primary Video Set is supported.

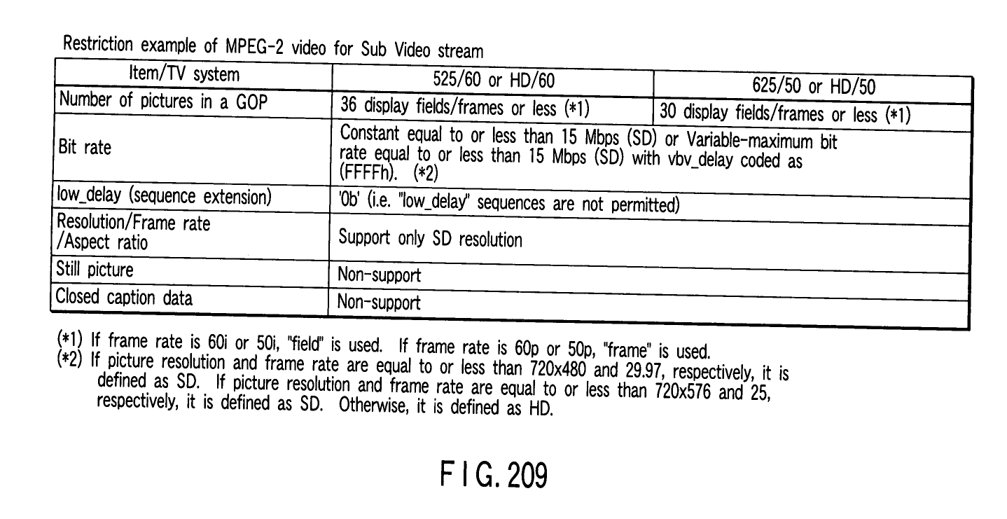

FIG. 209 is a view for explaining a restriction example of MPEG-2 video for a Sub Video stream. In MPEG-2 video for a Sub Video stream in the Primary Video Set, the number of pictures in the GOP can be the same as that in FIG. 208.

The Bit rate in MPEG-2 video for the Sub Video stream in the Primary Video Set assumes a constant value equal to or less than 15 Mbps (SD). Alternatively, in case of a variable bit rate, a Variable-maximum bit rate is equal to or less than 15 Mbps (SD). In this case, dvd_delay is coded as (FFFFh).

In MPEG-2 video for the Sub Video stream in the Primary Video Set, low_delay (sequence extension) is set to ‘0b ’. In MPEG-2 video for the Sub Video stream in the Primary Video Set, the Resolution/Frame rate/Aspect ratio support only, e.g., the SD resolution. Note that neither Still picture data nor Closed caption data in MPEG-2 video for the Sub Video stream in the Primary Video Set are supported.

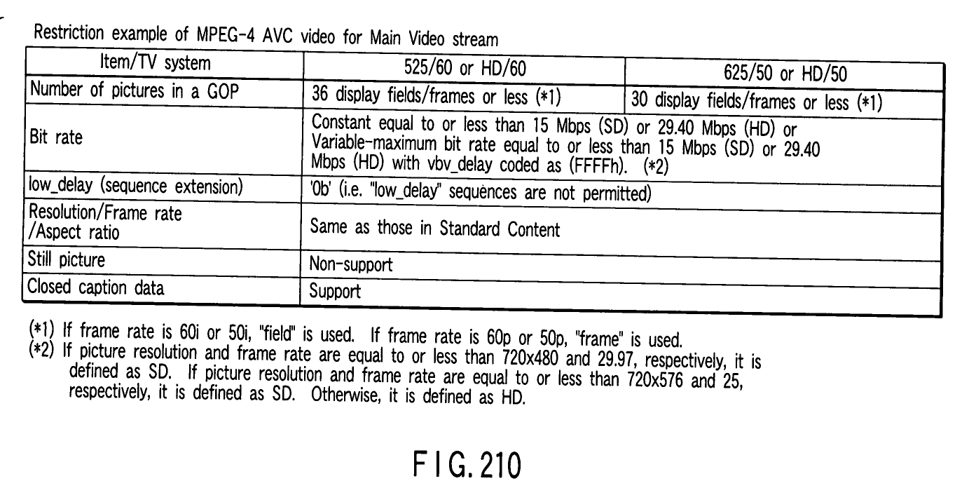

FIG. 210 is a view for explaining a restriction example of MPEG-4 AVC video for a main video stream. In MPEG-4 AVC video for a Main Video stream in the Primary Video Set, the number of pictures in a GOP is 36 display fields/frames or less in case of 525/60 (NTSC) or HD/60. On the other hand, the number of pictures in the GOP is 30 display fields/frames or less in case of 625/50 (PAL, etc.) or HD/50.

The Bit rate in MPEG-4 AVC video for the Main Video stream in the Primary Video Set assumes a constant value equal to or less than 15 Mbps (SD) or 29.40 Mbps (HD) in both the case of 525/60 or HD/60 and the case of 625/50 or HD/50. Alternatively, in case of a variable bit rate, a Variable-maximum bit rate is equal to or less than 15 Mbps (SD) or 29.40 Mbps (HD). In this case, dvd_delay is coded as (FFFFh).

In MPEG-4 AVC video for the Main Video stream in the Primary Video Set, low_delay (sequence extension) is set to ‘0b ’.

In MPEG-4 AVC video for the Main Video stream in the Primary Video Set, the Resolution/Frame rate/Aspect ratio are the same as those in a Standard Content (as in FIG. 208). Note that Still picture data in MPEG-4 AVC video for the Main Video stream in the Primary Video Set is not supported. However, Closed caption data in MPEG-4 AVC video for the Main Video stream in the Primary Video Set is supported.

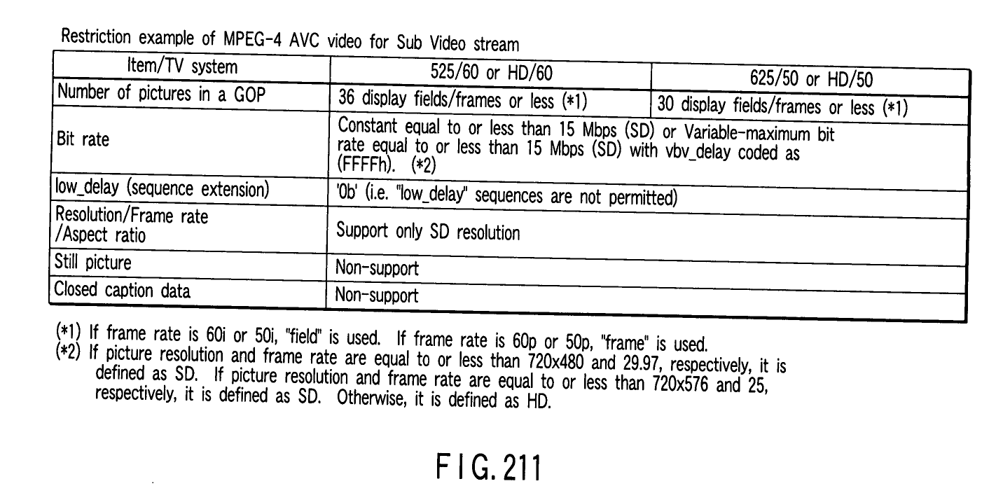

FIG. 211 is a view for explaining a restriction example of MPEG-4 AVC video for a Sub Video stream. In MPEG-4 AVC video for a Sub Video stream in the Primary Video Set, the number of pictures in the GOP can be the same as that in FIG. 210. The Bit rate in MPEG-4 AVC video for the Sub Video stream in the Primary Video Set assumes a constant value equal to or less than 15 Mbps (SD). Alternatively, in case of a variable bit rate, a Variable-maximum bit rate is equal to or less than 15 Mbps (SD). In this case, dvd_delay is coded as (FFFFh).

In MPEG-4 AVC video for the Sub Video stream in the Primary Video Set, low_delay (sequence extension) is set to ‘0b ’. In MPEG-4 AVC video for the Sub Video stream in the Primary Video Set, the Resolution/Frame rate/Aspect ratio support only, e.g., the SD resolution. Note that neither Still picture data nor Closed caption data in MPEG-4 AVC video for the Sub Video stream in the Primary Video Set are supported.

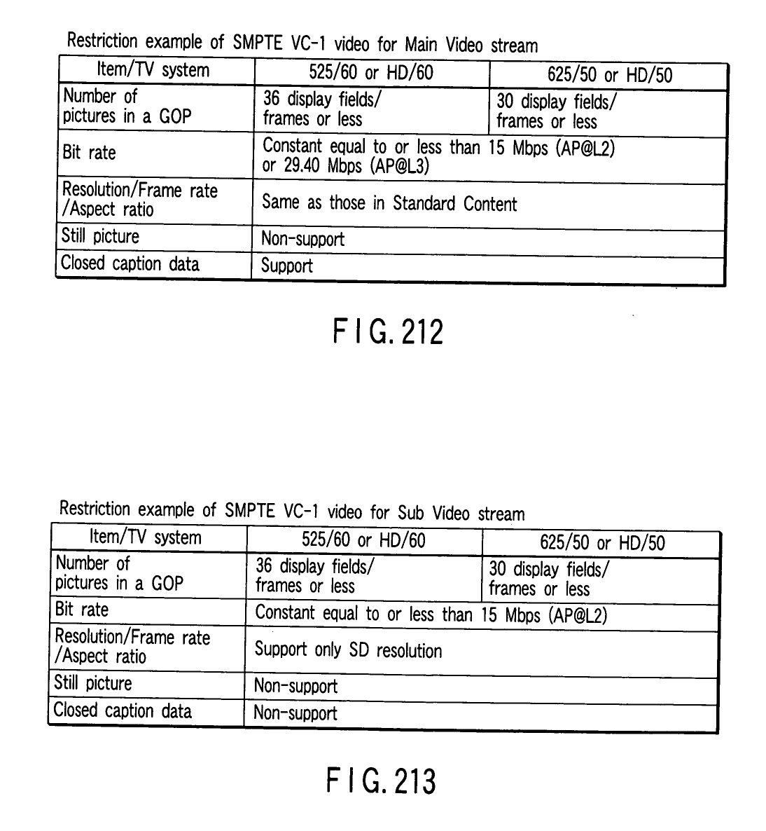

FIG. 212 is a view for explaining a restriction example of SMPTE VC-1 video for a Main Video stream. In SMPTE VC-1 video for a Main Video stream in the Primary Video Set, the number of pictures in a GOP is 36 display fields/frames or less in case of 525/60 (NTSC) or HD/60. On the other hand, the number of pictures in the GOP is 30 display fields/frames or less in case of 625/50 (PAL, etc.) or HD/50. The Bit rate in SMPTE VC-1 video for the Main Video stream in the Primary Video Set assumes a constant value equal to or less than 15 Mbps (AP@L2) or 29.40 Mbps (AP@L3) in both the case of 525/60 or HD/60 and the case of 625/50 or HD/50.

In SMPTE VC-1 video for the Main Video stream in the Primary Video Set, the Resolution/Frame rate/Aspect ratio are the same as those in a Standard Content (as in FIG. 208). Note that Still picture data in SMPTE VC-1 video for the Main Video stream in the Primary Video Set is not supported. However, Closed caption data in SMPTE VC-1 video for the Main Video stream in the Primary Video Set is supported.

FIG. 213 is a view for explaining a restriction example of SMPTE VC-1 video for a sub video stream. In SMPTE VC-1 video for a Sub Video stream in the Primary Video Set, the number of pictures in the GOP can be the same as that in FIG. 212. The Bit rate in SMPTE VC-1 video for the Sub Video stream in the Primary Video Set assumes a constant value equal to or less than 15 Mbps (AP@L2). In SMPTE VC-1 video for the Sub Video stream in the Primary Video Set, the Resolution/Frame rate/Aspect ratio support only, e.g., the SD resolution. Note that neither Still picture data nor Closed caption data in SMPTE VC-1 video for the Sub Video stream in the Primary Video Set are supported.

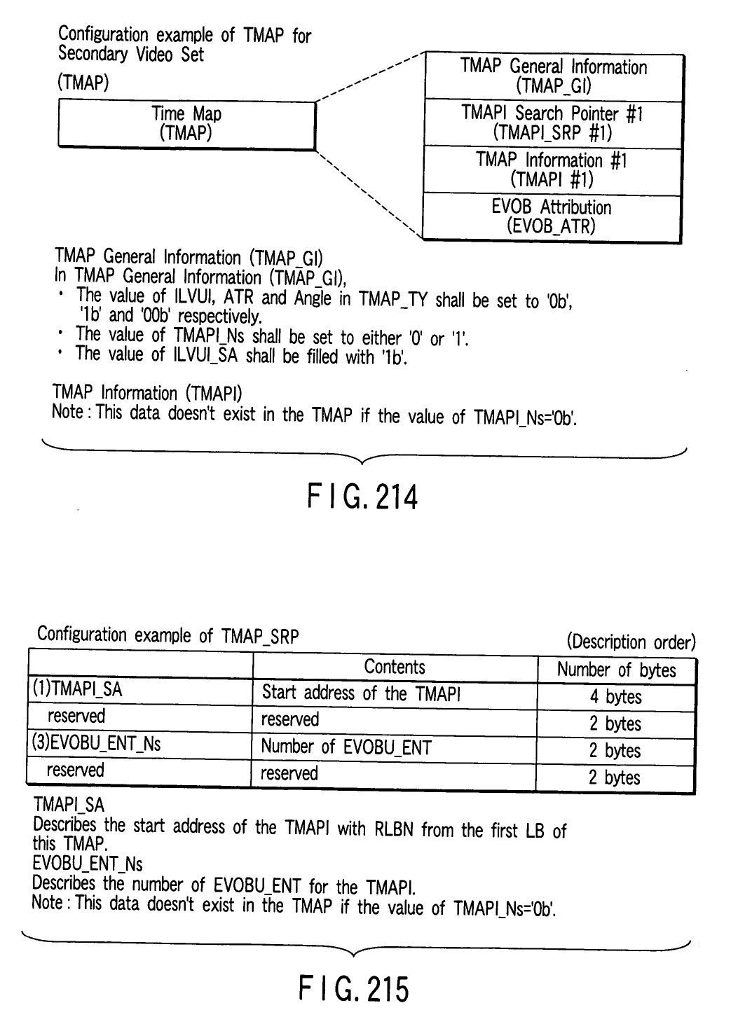

FIG. 214 is a view for explaining a configuration example of a time map (TMAP) for a Secondary Video Set. This TMAP has a configuration partially different from that for a Primary Video Set shown in FIG. 181. More specifically, the TMAP for the Secondary Video Set has TMAP general information (TMAP_GI) at its head position, which is followed by a time map information search pointer (TMAPI_SRP#1) and corresponding time map information (TMAPI#1), and has an EVOB attribute (EVOB_ATR) at the end.

The TMAP_GI for the Secondary Video Set can have the same configuration as in FIG. 182. However, in this TMAP_GI, the ILVUI, ATR, and Angle values in the TMAP_TY (FIG. 183) respectively assume ‘0b ’, ‘1b’, and ‘00b’. Also, the TMAPI_Ns value assumes ‘0’ or ‘1’. Furthermore, the ILVUI_SA value is padded with ‘1b’.

FIG. 215 is a view for explaining a configuration example of the TMAPI_SRP. The TMAPI_SRP for the Secondary Video Set is configured to include TMAPI_SA that describes the start address of the TMAPI with a relative block number from the first logical block of the TMAP, EVOBU_ENT_Ns that describes the EVOBU entry number for this TMAPI, and a reserved area. If the TMAPI_Ns in the TMAP_GI (FIG. 182) is ‘0b ’, no TMAPI_SRP data (FIG. 215) exists in the TMAP (FIG. 214).

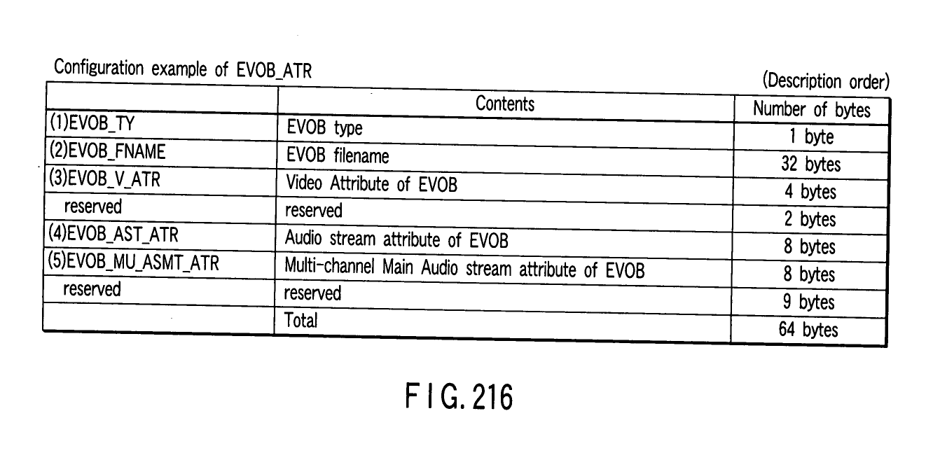

FIG. 216 is a view for explaining a configuration example of the EVOB_ATR. The EVOB_ATR included in the TMAP (FIG. 214) for the Secondary Video Set is configured to include EVOB_TY that specifies an EVOB type, EVOB_FNAME that specifies an EVOB filename, EVOB_V_ATR that specifies an EVOB video attribute, EVOB_AST_ATR that specifies an EVOB audio stream attribute, EVOB_MU_ASMT_ATR that specifies an EVOB multi-channel main audio stream attribute, and a reserved area.

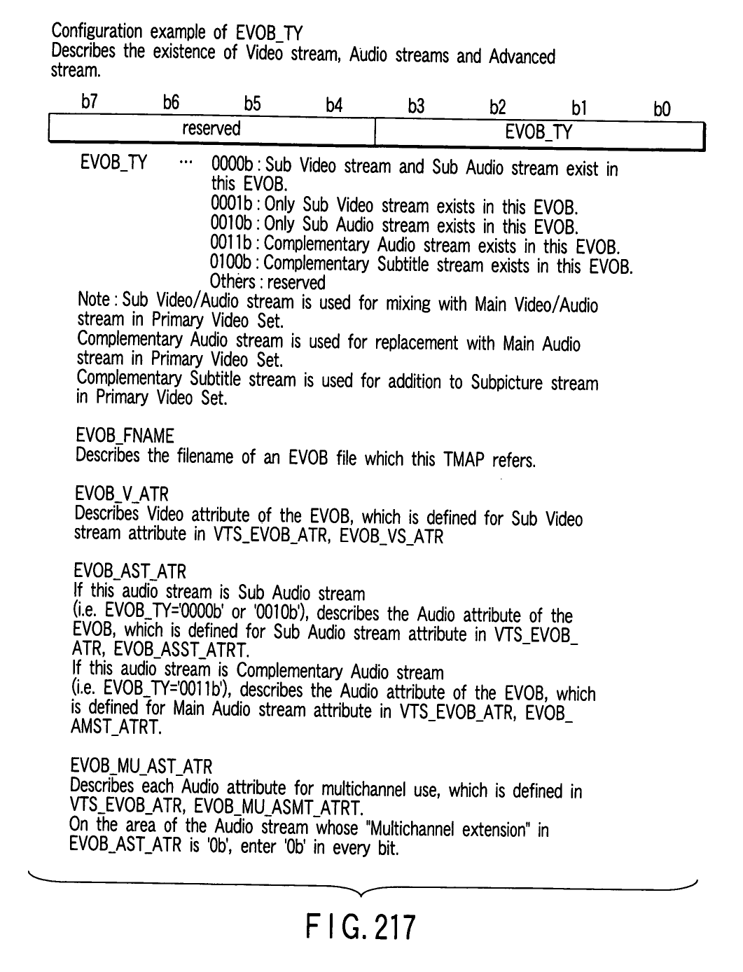

FIG. 217 is a view for explaining elements in the EVOB_ATR in FIG. 216. The EVOB_TY included in the EVOB_ATR in FIG. 216 describes existence of a Video stream, Audio streams, and Advanced stream. That is, EVOB_TY=‘0000b’ specifies that a Sub Video stream and Sub Audio stream exist in the EVOB of interest. EVOB_TY=‘0001b’ specifies that only a Sub Video stream exists in the EVOB of interest. EVOB_TY=‘0010b’ specifies that only a Sub Audio stream exists in the EVOB of interest. EVOB_TY=‘0011b’ specifies that a Complementary Audio stream exists in the EVOB of interest. EVOB_TY=‘0100b’ specifies that a Complementary Subtitle stream exists in the EVOB of interest. When the EVOB_TY assumes values other than those described above, it is reserved for other use purposes.

Note that the Sub Video/Audio stream can be used for mixing with a Main Video/Audio stream in the Primary Video Set. The Complementary Audio stream can be used for replacement with a Main Audio stream in the Primary Video Set. The Complementary Subtitle stream can be used for addition to a Sub-picture stream in the Primary Video Set.

Referring to FIG. 217, EVOB_FNAME is used to describe the filename of an EVOB file to which the TMAP of interest refers. The EVOB_V_ATR describes an EVOB video attribute used to define a Sub Video stream attribute in the VTS_EVOB_ATR and EVOB_VS_ATR. If the audio stream of interest is a Sub Audio stream (i.e., EVOB_TY=‘0000b’ or ‘0010b’), the EVOB AST_ATR describes an EVOB audio attribute which is defined for the Sub Audio stream in the VTS_EVOB_ATR and EVOB_ASST_ATRT. If the audio stream of interest is a Complementary Audio stream (i.e., EVOB_TY=‘0011b’), the EVOB_AST_ATR describes an EVOB audio attribute which is defined for a Main Audio stream in the VTS_EVOB_ATR and EVOB_AMST_ATRT. The EVOB_MU_AST_ATR describes respective audio attributes for multichannel use, which are defined in the VTS_EVOB_ATR and EVOB_MU_AMST_ATRT. On the area of the Audio stream whose “Multichannel extension” in the EVOB_AST_ATR is ‘0b ’, ‘0b ’ is entered in every bit.

A Secondary EVOB (S-EVOB) will be summarized below. The S-EVOB includes Presentation Data configured by Video data, Audio data, Advanced Subtitle data, and the like. The Video data in the S-EVOB is mainly used to mix with that in the Primary Video Set, and can be defined according to Sub Video data in the Primary Video Set. The Audio data in the S-EVOB includes two types, i.e., Sub Audio data and Complementary Audio data. The Sub Audio data is mainly used to mix with Audio data in the Primary Video Set, and can be defined according to Sub Audio data in the Primary Video Set. On the other hand, the Complementary Audio data is mainly used to be replaced by Audio data in the Primary Video Set, and can be defined according to Main Audio data in the Primary Video Set.

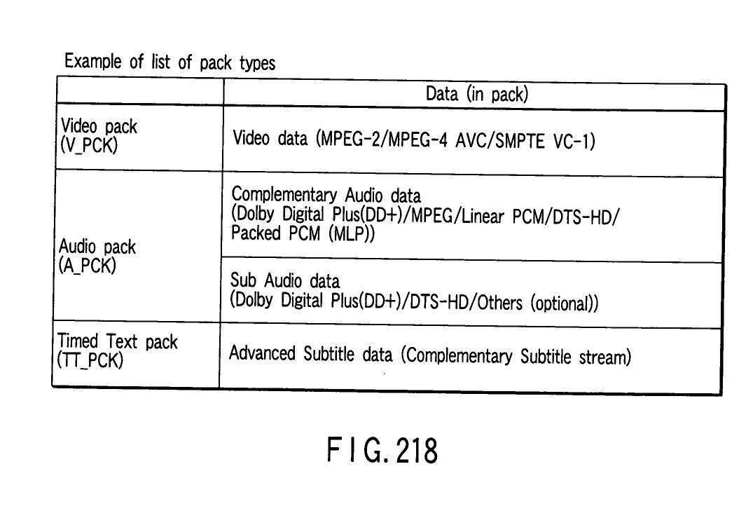

FIG. 218 is a view for explaining a list of pack types in a secondary enhanced video object. In the Secondary Video Set, Video pack (V_PCK), Audio pack (A_PCK), and Timed Text pack (TT_PCK) are used. The V_PCK stores video data of MPEG-2, MPEG-4 AVC, SMPTE VC-1, or the like. The A_PCK stores Complementary Audio data of Dolby Digital Plus (DD+), MPEG, Linear PCM, DTS-HD, Packed PCM (MLP), or the like. The TT_PCK stores Advanced Subtitle data (Complementary Subtitle data).

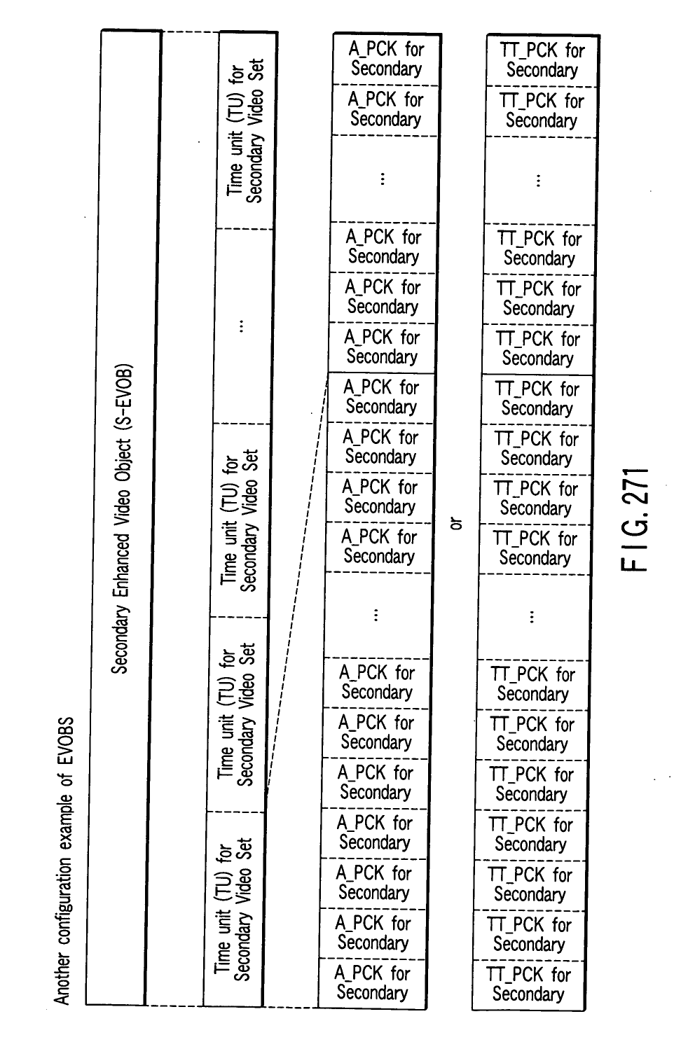

FIG. 219 is a view for explaining a configuration example of a secondary enhanced video object (S-EVOB). Unlike the configuration of the P-EVOB (FIG. 192), in the S-EVOB (FIG. 219 or FIG. 271 to be described later), each EVOBU does not include any Navigation pack (NV_PCK) at its head position.

An EVOBS (Enhanced Video Set) is a collection of EVOBs, and the following EVOBs are supported by the Secondary Video Set:

an EVOB which includes a Sub Video stream (V_PCKs) and Sub Audio stream (A_PCKs);

an EVOB which includes only a Sub Video stream (V_PCKs);

an EVOB which includes only a Sub Audio stream (A_PCKs);

an EVOB which includes only a Complementary Audio stream (A_PCKs); and

an EVOB which includes only a Complementary Subtitle stream (TT_PCKs).

Note that an EVOB can be divided into one or more Access Units (AUs). When the EVOB includes V_PCKs and A_PCKs, or when the EVOB includes only V_PCKs, each Access Unit is called an “EVOBU”. On the other hand, when the EVOB includes only A_PCKs or when the EVOB includes only TT_PCKs, each Access Unit is called a “Time Unit (TU)”.

An EVOBU (Enhanced Video Object Unit) includes a series of packs which are arranged in a recording order, starts from a V_PCK including a System header, and includes all subsequent packs (if any). The EVOBU is terminated at a position immediately before the next V_PCK that includes a System header in the identical EVOB or at the end of that EVOB.

Except for the last EVOBU, each EVOBU of the EVOB corresponds to a playback period of 0.4 sec to 1.0 sec. Also, the last EVOBU of the EVOB corresponds to a playback period of 0.4 sec to 1.2 sec. The EVOB includes an integer number of EVOBUs.

Each elementary stream is identified by the stream_ID defined in a Program stream. Audio Presentation data which are not defined by MPEG can be stored in PES packets with the stream_id of private_stream_1.

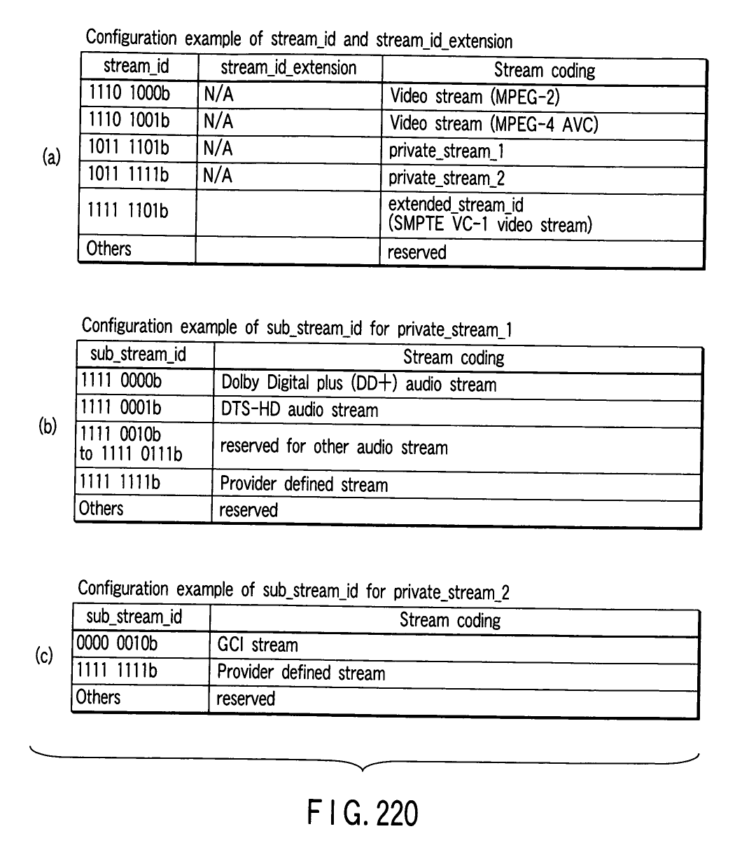

Advanced Subtitle data can be stored in PES packets with the stream_id of private_stream_2. The first bytes of data areas of packets of private_stream_1 and private_stream_2 can be used to define the sub_stream_id. FIG. 220 shows a practical example of them.

FIG. 220 is a view for explaining a configuration example of the stream_id and stream_id_extension, that of the substream_id for private_stream_1, and that of the substream_id for private_stream_2.

The stream_id and stream_id_extension can have a configuration, as shown in, e.g., FIG. 220(a) (in this example, the stream_id_extension is not applied or is optional). More specifically, stream_id=‘1110 1000b’ specifies Stream coding=‘Video stream (MPEG-2)’; stream_id=‘1110 1001b’, Stream coding=‘Video stream (MPEG-4 AVC)’; stream_id=‘1011 1101b’, Stream coding=‘private_stream_1’; stream_id=‘1011 1111b’, Stream coding=‘private_stream_2’; stream_id=‘1111 1101b’, Stream coding=‘extended_stream_id (SMPTE VC-1 video stream)’; and stream_id=others, Stream coding=reserved for other use purposes.

The sub_stream_id for private_stream_1 can have a configuration, as shown in, e.g., FIG. 220(b). More specifically, sub_stream_id=‘1111 0000b’ specifies Stream coding=‘Dolby Digital plus (DD+) audio stream’; sub_stream_id=‘1111 0001b’, Stream coding=‘DTS-HD audio stream’; sub_stream_id=‘1111 0010b’ to ‘1111 0111b’, Stream coding=reserved for other audio streams; and sub_stream_id=others, Stream coding=reserved for other use purposes.

The sub_stream_id for private_stream_2 can have a configuration, as shown in, e.g., FIG. 220(c). More specifically, sub_stream_id=‘0000 0010b’ specifies Stream coding=GCI stream; sub_stream_id=‘1111 1111b’, Stream coding=Provider defined stream; and sub_stream_id=others, Stream coding=reserved for other purposes.

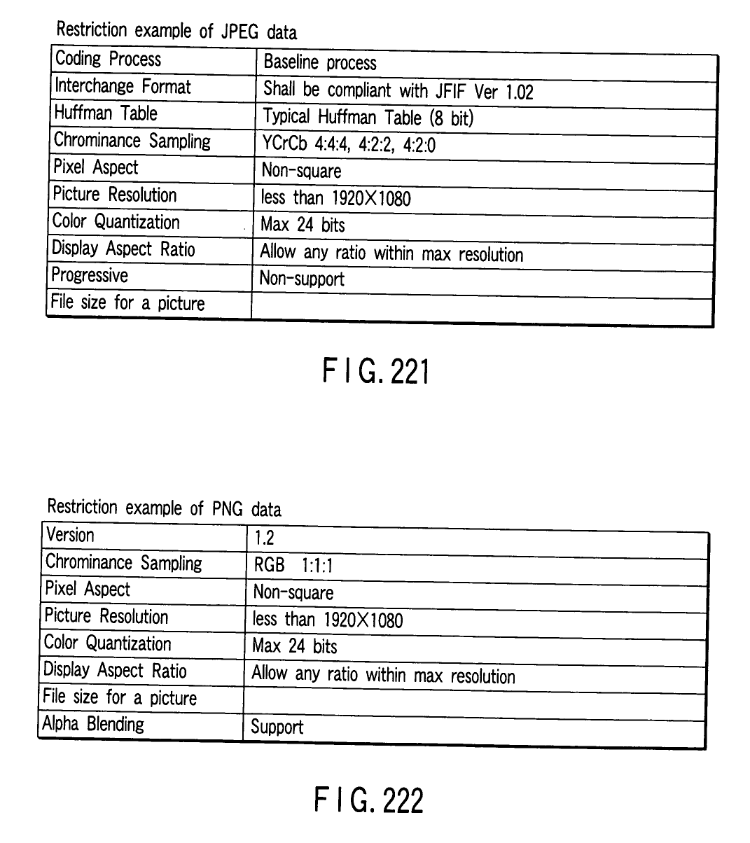

FIG. 221 is a view for explaining a restriction example of JPEG (Joint Photograph Expert Group) data. When “Coding process”=“Interchange Format”, “Baseline process” is compliant with JFIF version 1.02. When “Coding process”=“Huffman Table”, “Baseline process” is compliant with a typical Huffman table (8 bits). When “Coding process”=“Chrominance Sampling”, “Baseline process” is compliant with YCrCb=‘4:4:4’, ‘4:2:2’, or ‘4:2:0’. When “Coding process”=“Pixel Aspect”, “Baseline process” is compliant with Non-square. When “Coding process”=“Picture Resolution”, “Baseline process” is compliant with 1920×1080. When “Coding process”=“Color Quantization”, “Baseline process” is compliant with a maximum of 24 bits. When “Coding process”=“Display Aspect Ratio”, “Baseline process” allows any ratio within the range of the maximum resolution. “Coding process” “Progressive” is not supported.

Although not shown, the following JPEG marker formats are available. That is, Marker=SOI specifies Start of Image; Marker=APP0 (attribute=APP0), an Application information start marker, Marker=APP0 (attribute=length), the length of a structure including the field of interest; Marker=APP0 (attribute=identifier), an APP0 marker unique identifier (value=‘JFIF/0’); Marker=APP0 (attribute=version), the currently released version; Marker=APP0 (attribute=units), X and Y density units; Marker=APP0 (attribute=X density), the horizontal pixel density; Marker=APP0 (attribute=Y density), the vertical pixel density; Marker=APP0 (attribute=X thumbnail), the number of horizontal pixels of a thumbnail; and Marker=APP0 (attribute=Y thumbnail), the number of vertical pixels of a thumbnail. Furthermore, Marker=DQT specifies a Quantization Table start marker; Marker=DHT, a Huffman Table marker; Marker=SOF0, Start of frame-Baseline DCT; Marker=SOS, Start of scan marker; and Marker=EOI, End of Image.

FIG. 222 is a view for explaining a restriction example of PNG data. PNG (Portable Network Graphics) still picture data is compliant with PNG version 1.2, and is applied with restrictions shown in FIG. 222. That is, “Chrominance Sampling” is restricted to RGB ‘1:1:1’; “Pixel Aspect”, Non-square; “Picture Resolution”, less than 1920×1080; “Color Quantization”, a maximum of 24 bits; and “Display Aspect Ratio”, an arbitrary ratio within the range of the maximum resolution. Note that PNG data supports a blending.

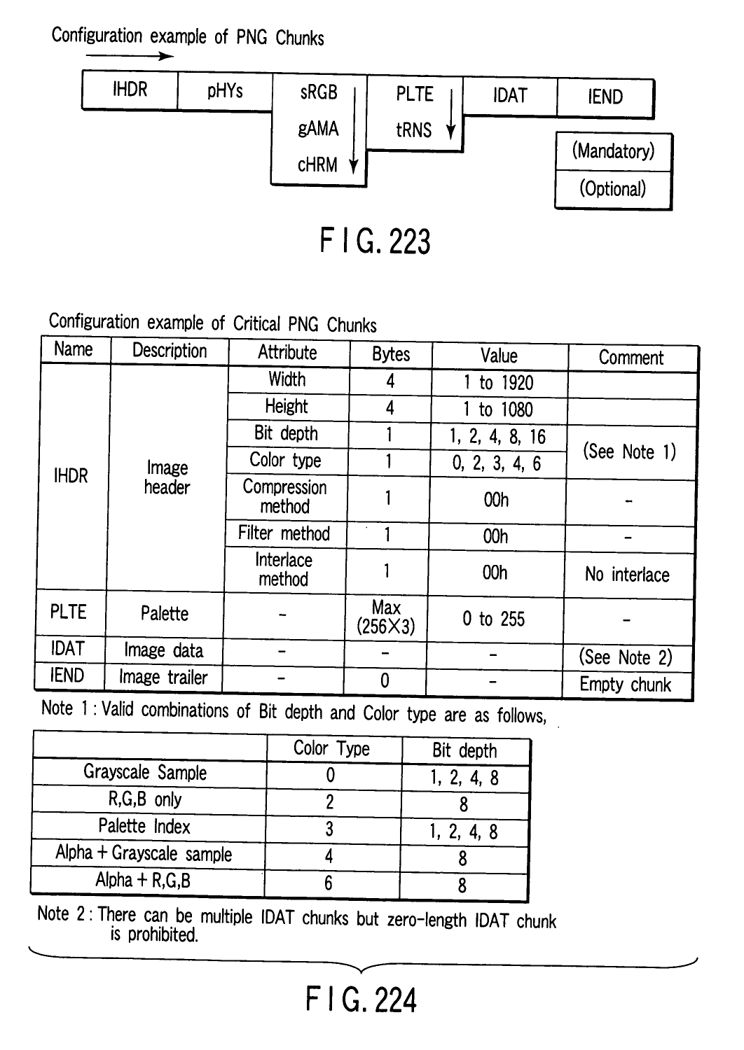

FIG. 223 is a view for explaining a configuration example of PNG chunks. In this example, chunks that can display a top level of a PNG image will be explained. As shown in FIG. 223, a PNG image of PNG chunks starts from an IHDR (Image header) chunk and ends at an IEND (Image trailer) chunk. An IDAT (Image data) chuck includes actual image data, and is allocated before the IEND chunk. Other optional chunks (pHYs, sRGB, gAMA, cHRM, PLTE, tRNS, etc.) can be allocated between the IHDR and IDAT chunks.

FIG. 224 is a view for explaining a configuration example of Critical PNG Chunks. IHDR, IDAT, and IEND chunks are used, but a PLTE (palette) chunk can be omitted depending on color type information of the IHDR chunk specified by PNG version 1.2.

In FIG. 224, IHDR indicates an Image header, and can have attributes Width, Height, Bit depth, Color type, Compression method, Filter method, and Interlace method. Also, PLTE indicates a palette from 0 to 255 (a maximum of 256×3 bytes); IDAT, image data; and IEND, an Image trailer (an Empty chunk at the end).

Valid combinations of “Bit depth” and “Color Type” are as follows. More specifically, Color Type=‘0’ and Bit depth=‘1, 2, 4, 8’ are set for “Grayscale Sample”; Color Type=‘2’ and Bit depth=‘8’ are set for “RGB only”; Color Type=‘3’ and Bit depth=‘1, 2, 4, 8’ are set for “Palette Index”; Color Type=‘4’ and Bit depth=‘8’ are set for “Alpha+Grayscale Sample”; and Color Type=‘6’ and Bit depth=‘8’ are set for “Alpha+RGB”. Note that multiple IDAT chunks are permitted, but a zero-length IDAT chunk is prohibited.

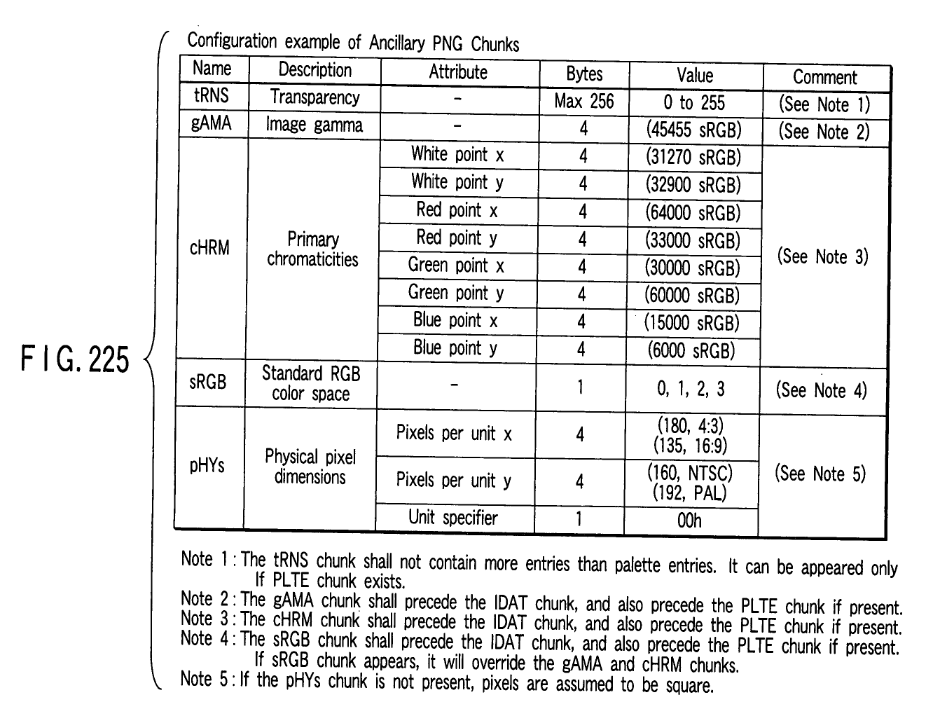

FIG. 225 is a view for explaining a configuration example of Ancillary PNG Chunks. Ancillary PNG Chunks are optional, but it is strongly demanded to adopt them. A tRNS chunk describes transparency, and has a value ranging from 0 to 255 (a maximum of 245 bytes). A gAMA chunk describes Image gamma. A cHRM chunk describes Primary chromaticities. This cHRM chunk has, as its attributes, White point X, White point Y, Red point X, Red point Y, Green point X, Green point Y, Blue point X, and Blue point Y. An sRGB chunk describes a Standard RGB color space. A pHYs chunk describes Physical pixel dimensions, and has, as its attributes, Pixel per unit x, Pixel per unit y, and Unit specifier.

Note that the tRNS chunk does not have more entries than palette entries, and can be configured to appear only when the PLTE chunk exists. The gAMA chunk precedes the IDAT chunk and also precedes the PLTE chunk if present. The cHRM chunk precedes the IDAT chunk and also precedes the PLTE chunk if present. Also, the sRGB chunk precedes the IDAT chunk and also precedes the PLTE chunk if present. If the pHYs chunk does not exist, pixels are assumed to be square.

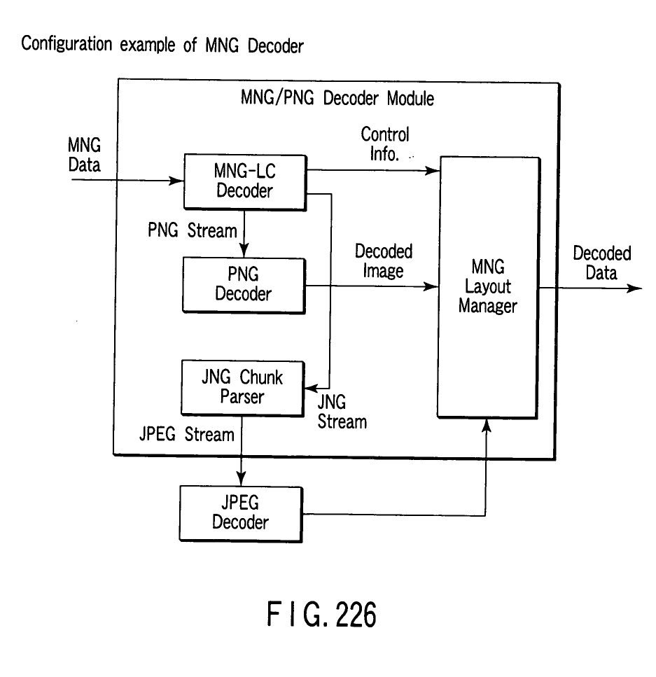

FIG. 226 is a block diagram for explaining an example of the arrangement of an MNG decoder. An MNG file will be explained first. The MNG file complies with MNG-LC with JNG as a subset of MNG Format Version 1.0. An MNG-LC datastream describes a sequence of zero or more single frames (each of which is composed of zero or more embedded images). The embedded images can be the PNG or JNG datastreams. FIG. 226 shows an example of a decoder that decodes such MNG datastream.

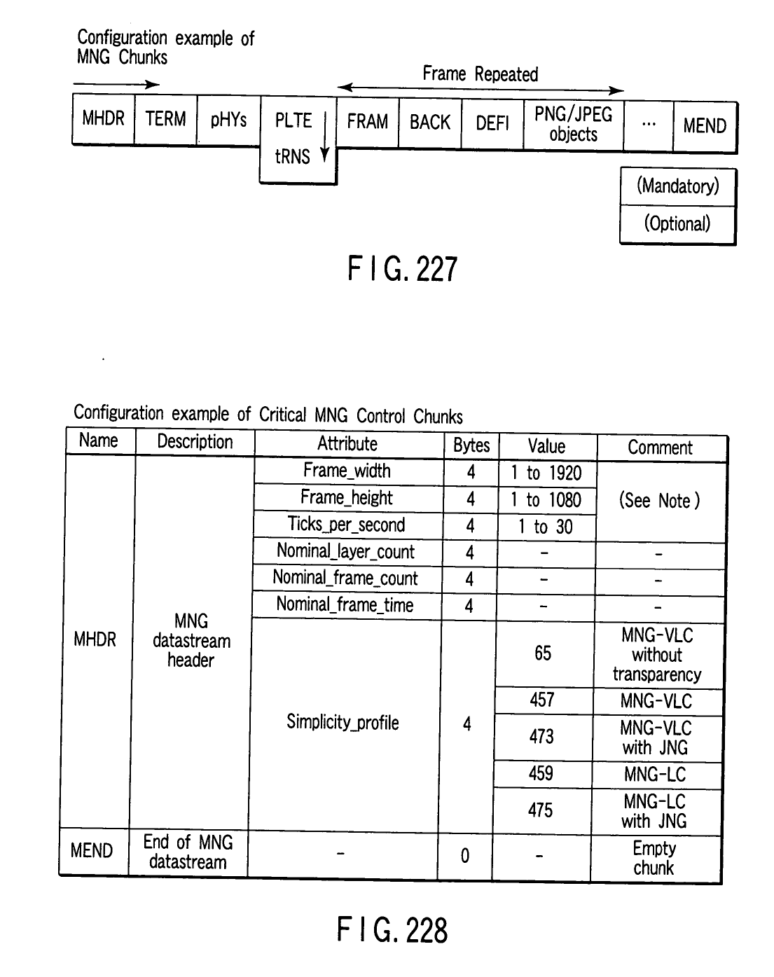

FIG. 227 is a view for explaining a configuration example of MNG Chunks. An MNG chunk describe chunks which can be played back at the top level of the MNG datastream. MNG data starts from an MHDR chunk and ends at an MEND chunk. TERM, PLTE, and tRNS chunks are allocated in turn immediately after the MHDR chunk. FRAME, BACK, and DEFI chunks are allocated before PNG or JNG objects.

FIG. 228 is a view for explaining a configuration example of Critical MNG Control Chunks. An HMDR chunk in the Critical MNG Control Chunks describes an MNG datastream header, and includes various attributes (Frame_width, Frame_height, Ticks_per_second, Nominal_layer_count, Nominal_frame_count, Nominal_frame_time, and Simplicity_profile). Note that Simplicity_profile attribute includes MNG-VLC without transparency, MNG-VLC, MNG-VLC with JNG, MNG-LC, and MNG-LC with JNG. An MEND chunk in the Critical MNG Control Chunks indicates the end of the MNG datastream, and can be an Empty chunk.

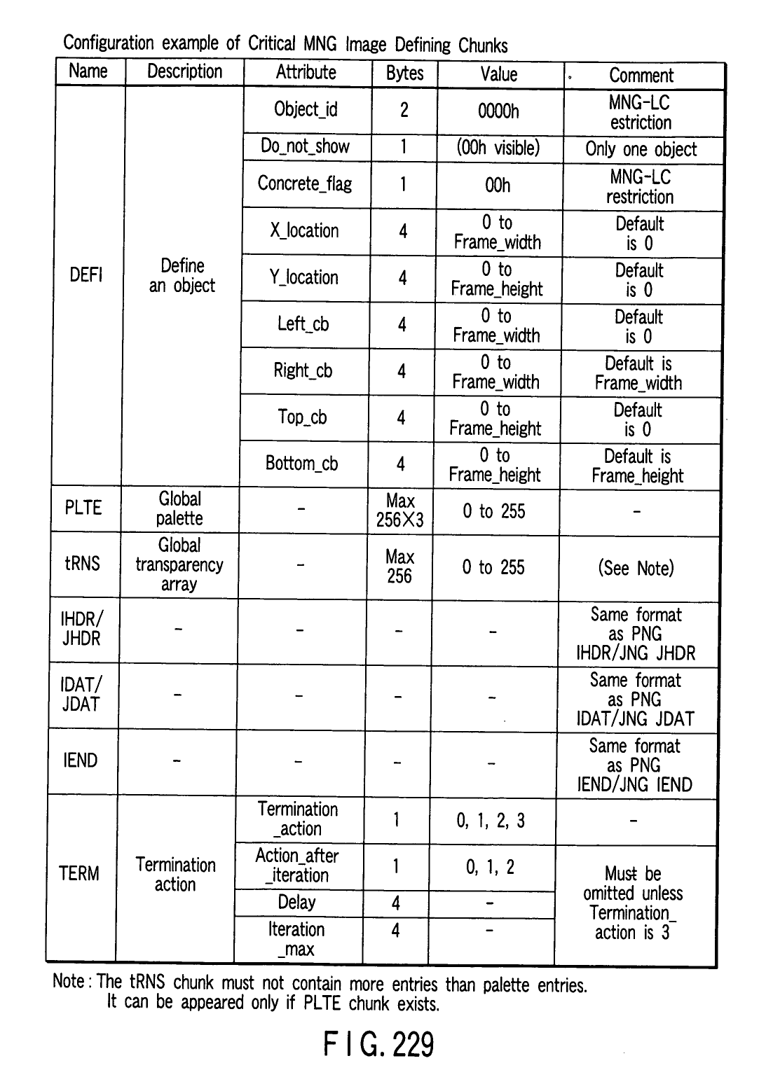

FIG. 229 is a view for explaining a configuration example of Critical MNG Image Defining Chunks. A DEFI chunk in the Critical MNG Image Defining Chunks describes an object, and has various attributes (Object_id, Do_not_show, Concrete_flag, X_location, Y_location, Left_cb, Right_cb, Top_cb, Bottom_Cb, etc.). A PLTE chunk describes a Global palette, and has a value ranging from 0 to 255 (a maximum of 256×3 bytes). A tRNS chunks describes a Global transparency array, and has a value ranging from 0 to 255 (a maximum of 256 bytes). An IHDR/JHDR chunk has the same format as that of a PNG IHDR/JNG JHDR chunk. An IDAT/JDAT chunk has the same format as that of a PNG IDAT/JNG JDAT chunk. An IEND chunk has the same format as a PNG IEND/JNG IEND chunk. A TERM chunk describes a Termination action, and has various attributes (Termination_action, Action_after_iteration, Delay, Iteration_max, etc.).

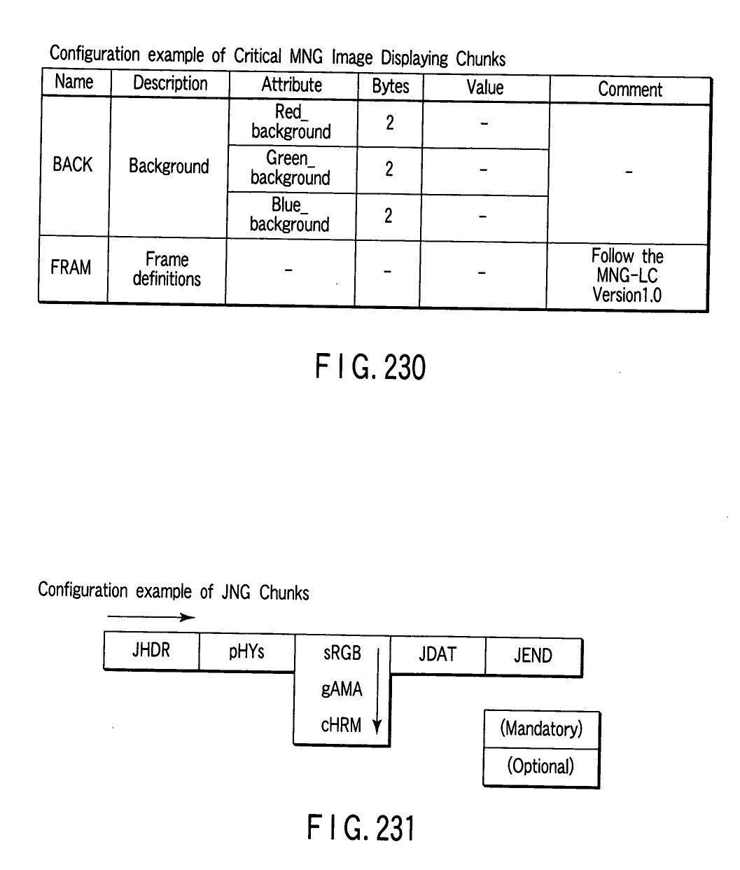

FIG. 230 is a view for explaining a configuration example of Critical MNG Image Displaying Chunks. A BACK chunk in the Critical MNG Image Displaying Chunks describes a Background, and has various attributes (Red_background, Green_background, Blue_background, etc.). Also, an FRAM chunk defines a frame, and is compliant with MNG-LC Version 1.0.

FIG. 231 is a view for explaining a configuration example of JNG chunks. A JNG chunk can be used to generate a JNG datastream when it is added to a JPEG image set. A JNG datastream is configured to start from a JHDR chunk and to end at a JEND chunk. A JDAT chunk includes actual image data and is allocated before the JEND chunk. Respective optional chunks such as pHYs, sRGB, gAMA, and cHRM chunks can be allocated between the JHDR and JDAT chunks.

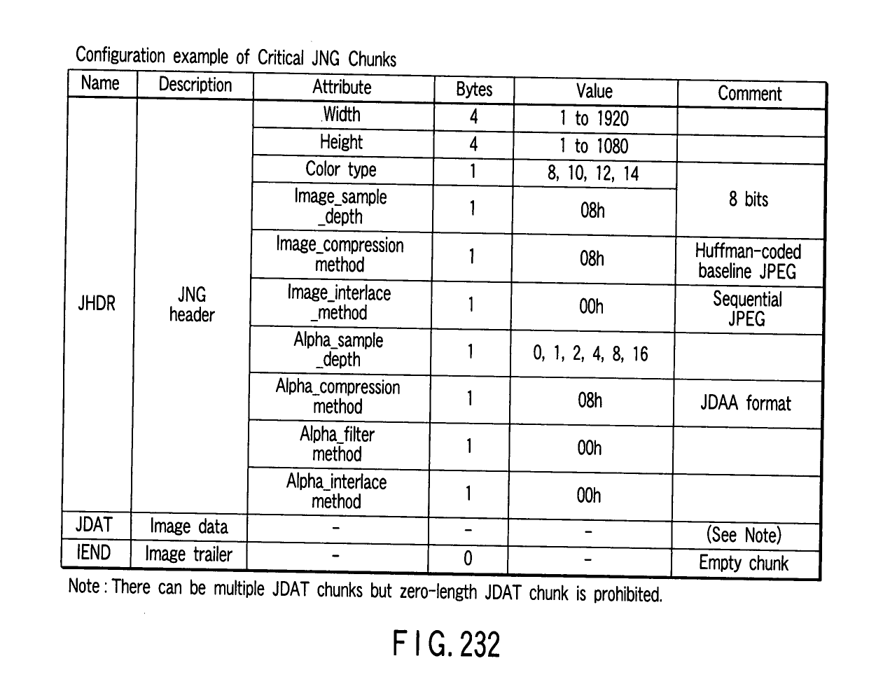

FIG. 232 is a view for explaining a configuration example of Critical JNG Chunks. A JHDR chunk in the Critical JNG Chunks describes a JNG header, and has various attributes (Width, Height, Color type, Image_sample_depth, Image_compression_method, Image_interlace_method, Alpha_sample_depth, Alpha_compression_method, Alpha_filter_method, and Alpha_interlace_method). A JDAT chunk describes Image data, and an JEND chunk describes an Image trailer (Empty chunk). Note that multiple JDAT chunks are permitted but a zero-length JDAT chunk is prohibited.

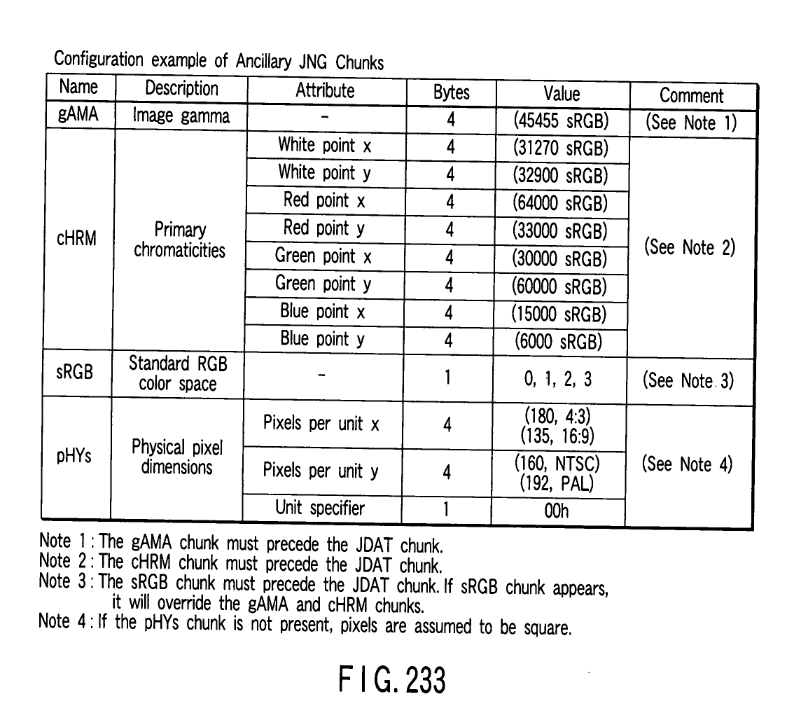

FIG. 233 is a view for explaining a configuration example of Ancillary JNG Chunks. Ancillary JNG Chunks are optional, but it is strongly demanded to adopt them. A gAMA chunk describes Image gamma. A cHRM chunk describes Primary chromaticities. This cHRM chunk has, as its attributes, White point X, White point Y, Red point X, Red point Y, Green point X, Green point Y, Blue point X, and Blue point Y. An sRGB chunk describes a Standard RGB color space. A pHYs chunk describes Physical pixel dimensions, and has, as its attributes, Pixel per unit x, Pixel per unit y, and Unit specifier. The gAMA chunk precedes the JDAT chunk, the cHRM chunk precedes the JDAT chunk, and the sRGB chunk precedes the JDAT chunk. If the sRGB chunk appears, it will overwrite the gAMA and cHRM chunks. If the pHYs chunk does not exist, pixels are assumed to be square.

Note that Linear PCM data wrapped by the WAV file format (RIFF waveform Audio Format) can be used as an effect sound or the like, and can be mixed with the Primary Video Set and/or Secondary Video Set. Note that the WAV file can have an RIFF chunk descriptor as its file identifier, an fmt sub-chunk for audio attribute information, and a data sub-chunk including Linear PCM data.

The Advanced content can include text which is received, processed, rendered, and composed uniformly by the player so as to be displayed in various TV display formats. Minimum guidelines for character encoding, a general font system for rendering characters, including a specific font technology supported, and composing or laying out of display text will be described below.

In order to maintain consistent appearance, an Advanced content player is configured to use a single font file format for font data defined by the Open Type Standard. That font file can be stored in a disc or a Web site on the network.

In order to strengthen the consistent appearance, rules for identifying (text) boundaries according to Unicode Standard 4.0.1 and its Annexes (for line breaking and text boundaries) may be set. In order to promote appropriate language-based formatting, the provider or author desirably uses Open Type fonts together with embedded layout tables.

Hence, the Advanced Content Player is configured to accept and display UTF-8 and UTF-16 (held sets encoded by other methods may be supported as needed).

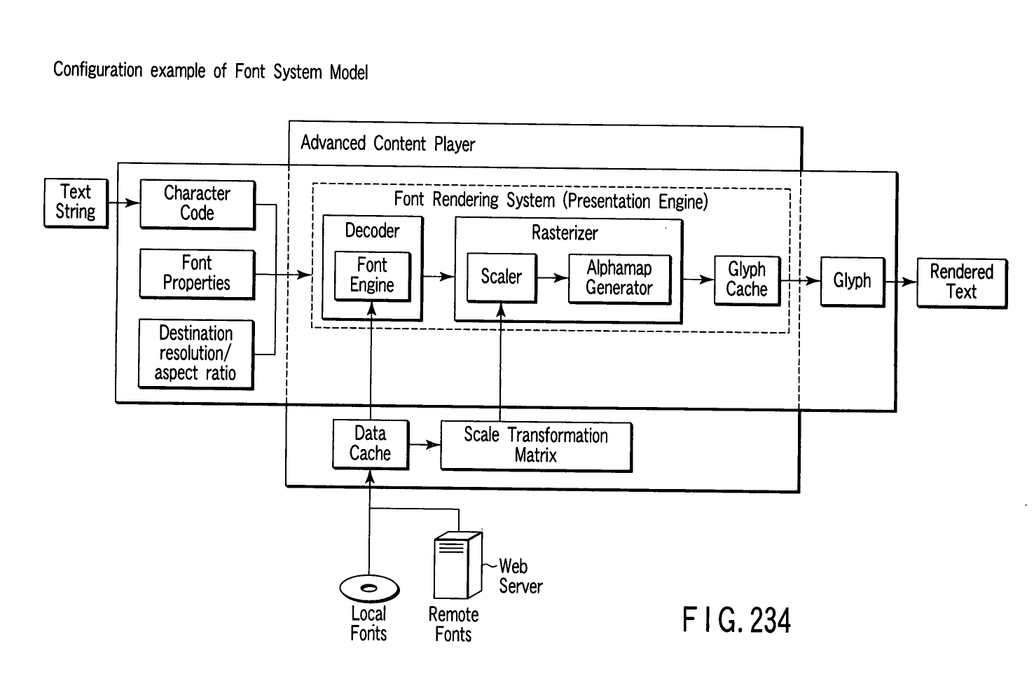

FIG. 234 is a view for explaining a configuration example of a font system model. This font system accepts a character code, given font properties, destination aspect ratio, and the like as inputs. After processing, this system generates a glyph indicating an input character.

Details of various fonts can be specified according to CSS level 2 font properties. This CSS supports use of a font property described in CSS2, section 15.2-5 as a shorthand for setting specific properties.

Text is rendered in accordance with author-specified font properties used to render a particular element, available fonts, and availability of requested glyphs of these fonts. The Advanced Content Player is configured to use intelligent font matching when an appropriate font is selected to meet an author's request. In order to assist the player to perform optimal matching, the author may use the CSS2@font-face rule (CSS2, section 15.3-1). In order to manage a system font database that includes a descriptor used to specify a URI for locating font data, the @font-face rule can include a large number of descriptors used by the Advanced Content Player.

Fonts are loaded from the disc or Web onto a data cache. In this case, the @font-face src descriptor is used to identify the locations of fonts.

The Advanced Content Player can support the Open Type specification for font data under the following restrictions:

a font engine requests only True Type outlines; and

an output device to be supported is only a TV display.

A font data file can be allocated on the disc and/or server. This font data is loaded according to a predetermined font loading rule.

In a font rendering system, a font decoder accesses a font file from a font buffer, and sends font data to a font engine. The result is sent to a font rasterizer to generate glyph information.

The implementations of the Advanced Content Player can use the font engine that supports predetermined to-be-used items. Upon reception of glyph information from the font decoder, the font rasterizer performs scaling and Aspect Ratio Transformations. In the Aspect Ratio Transformations, whether or not it is proper for the rasterizer to execute the Aspect Ratio Transformations of the rendered glyph is determined. This is done to allow the rendered graphic to be normally seen within the final display aspect ratio depending on which of an individual graphic element or final graphic frame buffer is transformed.

The Open Type font specification supports typography via embedded layout tables. It is desirable for the author to use this mechanism so as to promote appropriate language-based formatting.

The text layout rules are specified by the Unicode Standard Version 4.0.1, Sections 5.8, 5.13, and 5.14, and Unicode Standard Annex #9 The Bidirectional Algorithm, Annex #14 Line Breaking Properties, and Annex #29 Text Boundaries.

Note that the Advanced Subtitle can be used for a subtitle synchronized with video in addition to Sub-pictures. That data can be described as a Markup subset.

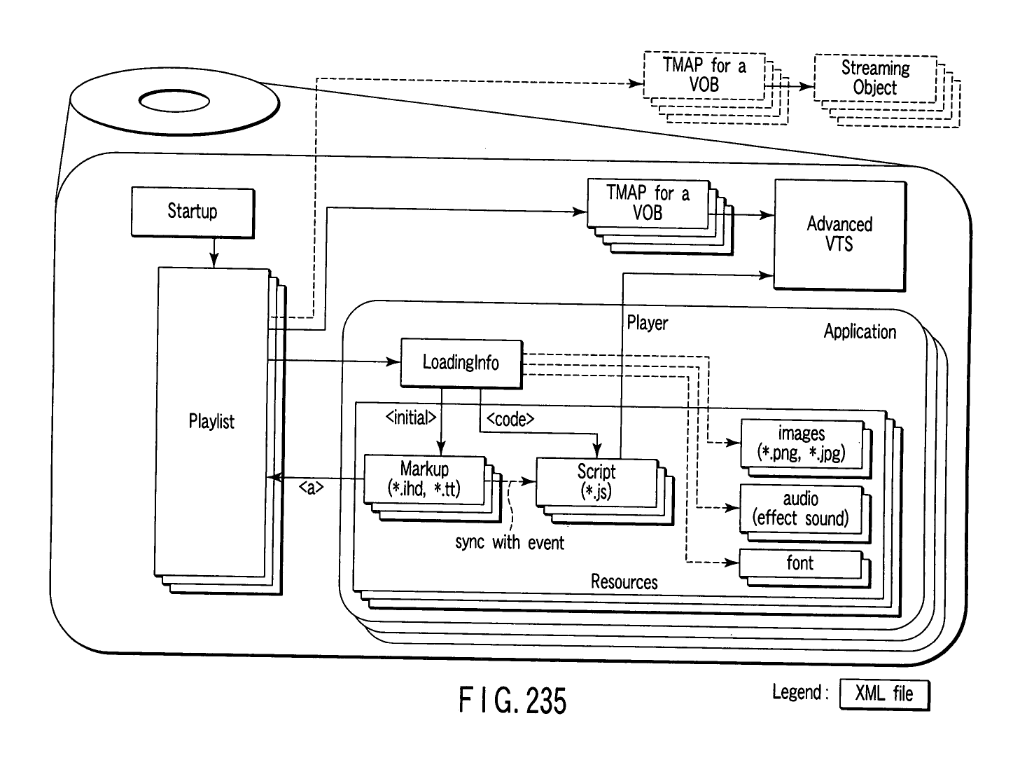

FIG. 235 is a view for explaining the relationship between pieces of information associated with a playlist, and exemplifying the relationship between the Advanced Contents on the disc. One Startup file in an Advanced Content recording area on the disc determines one or more Playlists. The determined Playlist includes descriptions of designation of an Application (Object Mapping), reference to a TMAP file of an EVOB on the disc or network (Object Mapping), a setting range of Chapters and Titles on the Timeline (Playback Sequence), and determination of the Player configurations (Configuration Information).

The Startup File Designates Only One

Playlist. When the designated Playlist is changed in the Markup language in the Application or the like, it is to be completely replaced. Each Application designated by the Playlist includes one XML file called Loading Information which designates Resources used in the Application.

FIG. 236 is a view for explaining a configuration example of the playlist. Object Mapping information, a Playback Sequence, and Configuration information are respectively described in three areas designated under a root element.

This playlist file can include the following information:

*Object Mapping Information (playback object information which exists in each title, and is mapped on the time line of this title);

*Playback Sequence (title playback information described on the time line of the title); and

*Configuration Information (system configuration information such as data buffer alignment).

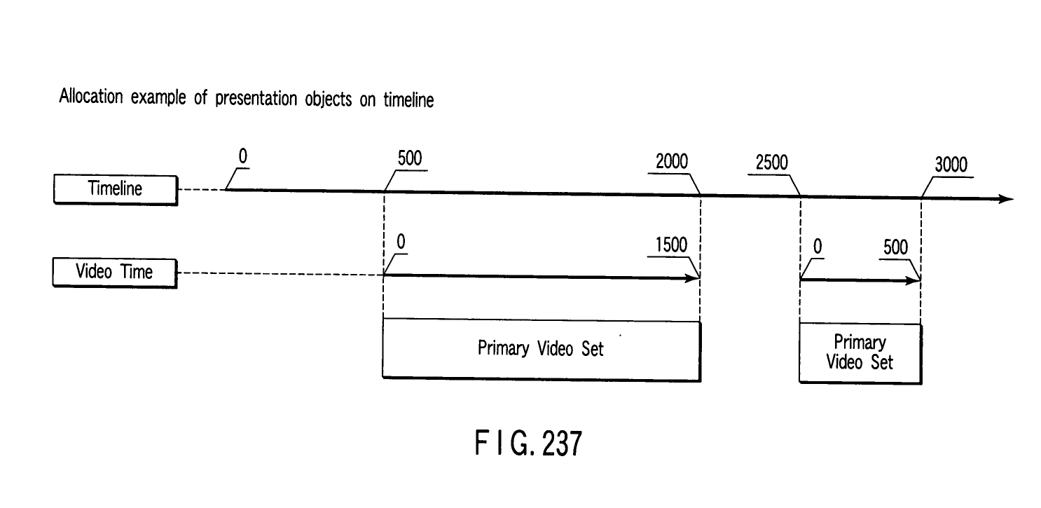

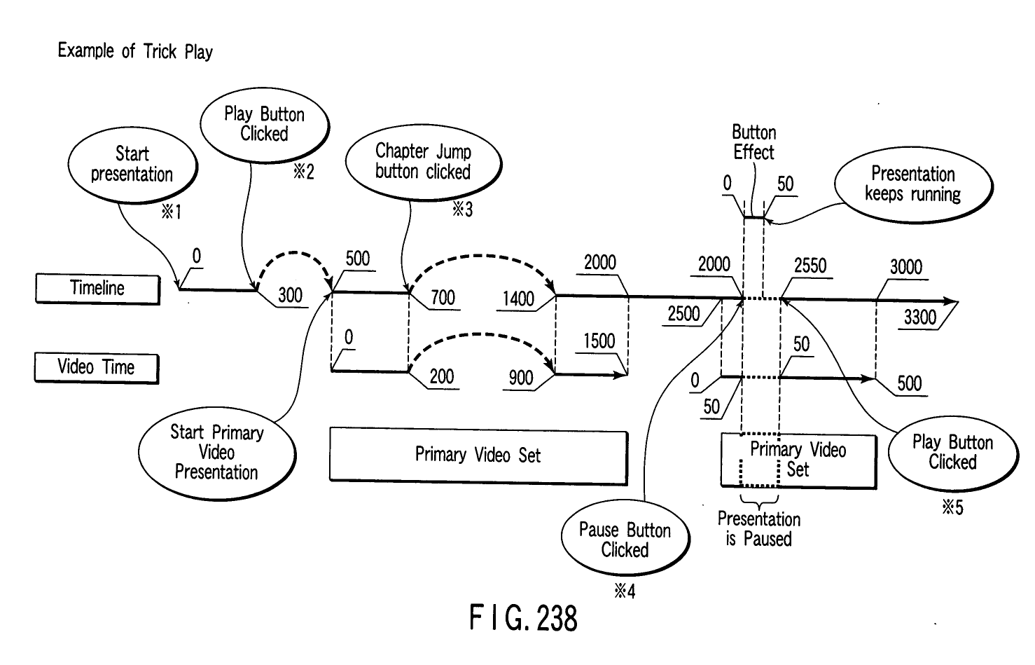

FIGS. 237 and 238 are views for explaining the Timeline used in the Playlist. FIG. 237 is a view for explaining an example of the Allocation of Presentation Objects on the timeline. Note that the timeline unit can use a video frame unit, second (millisecond) unit, 90-kHz/27-MHz-based clock unit, unit specified by SMPTE, and the like. In the example of FIG. 237, two Primary Video Sets having durations “1500” and “500” are prepared, and are allocated on a range from 500 to 1500 and that from 2500 to 3000 on the Timeline. By allocating the Objects having different durations on the Timeline as one timeline, these Objects can be played back compatibly. Note that the timeline is configured to be reset to zero for each playlist to be used.

FIG. 238 is a view for explaining an example when trick play (chapter jump or the like) of a presentation object is made on the timeline. FIG. 238 shows an example of the way the time gains on the Timeline upon execution of an actual presentation operation. That is, when presentation starts, the time on the Timeline begins to gain (*1). Upon depression of a Play button at time 300 on the Timeline (*2), the time on the Timeline jumps to 500, and presentation of the Primary Video Set starts. After that, upon depression of a Chapter Jump button at time 700 (*3), the time jumps to the start position of the corresponding Chapter (time 1400 on the Timeline), and presentation starts from there. After that, upon clicking a Pause button (by the user of the player) at time 2550 (*4), presentation pauses after the button effect is validated. Upon clicking the Play button at time 2550 (*5), presentation restarts.

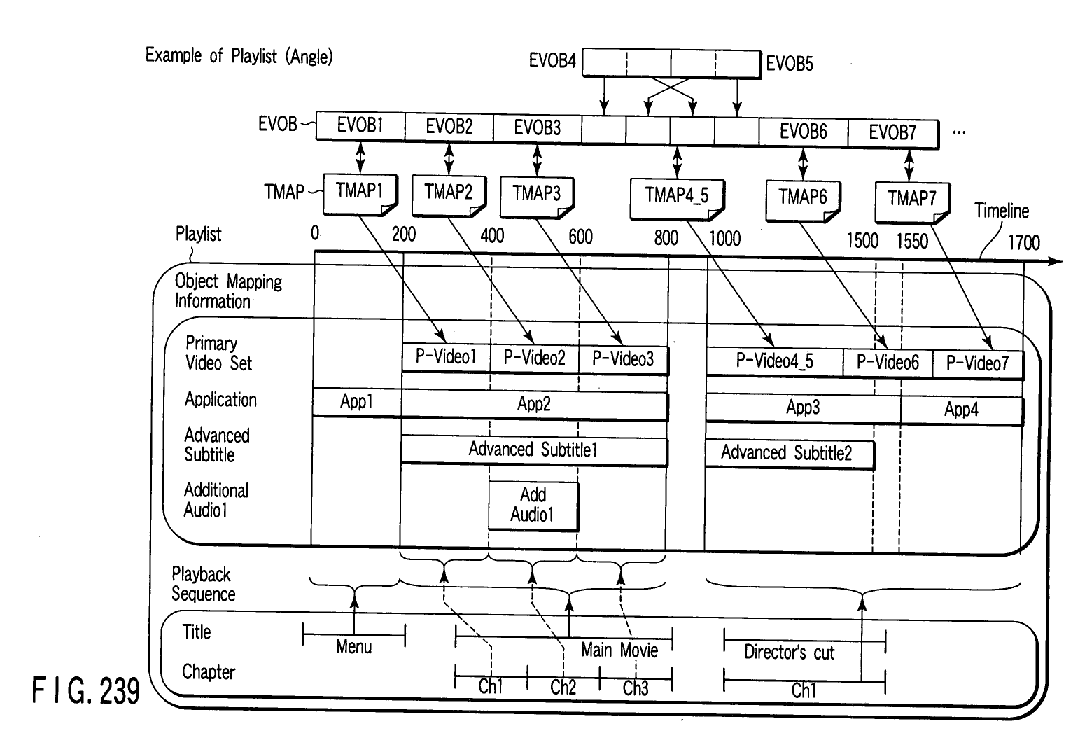

FIG. 239 is a view for explaining a configuration example of a Playlist when EVOBs have interleaved angle blocks. Each EVOB has a corresponding TMAP file. However, information of EVOB4 and EVOB5 as interleaved angle blocks is written in a single TMAP file. By designating individual TMAP files by Object Mapping Information, the Primary Video Set is mapped on the Timeline. Also, Applications, Advanced subtitles, Additional Audio, and the like are mapped on the Timeline based on the description of the Object Mapping Information in the Playlist.

In FIG. 239, a Title (a Menu or the like as its use purpose) having no Video or the like is defined as App1 between times 0 and 200 on the Timeline. Also, during a period of times 200 to 800, App2, P-Video1 (Primary Video 1) to P-Video3, Advanced Subtitle1, and Add Audio1 are set. During a period of times 1000 to 1700, P-Video4_{—}5 including EVOB4 and EVOB5, P-Video6, P-Video7, App3 and App4, and Advanced Subtitle2, which form the angle block, are set.

The Playback Sequence defines that App1 configures a Menu as one title, App2 configures a Main Movie, and App3 and App4 configure a Director's cut. Furthermore, the Playback Sequence defines three Chapters in the Main Movie, and one Chapter in the Director's cut.

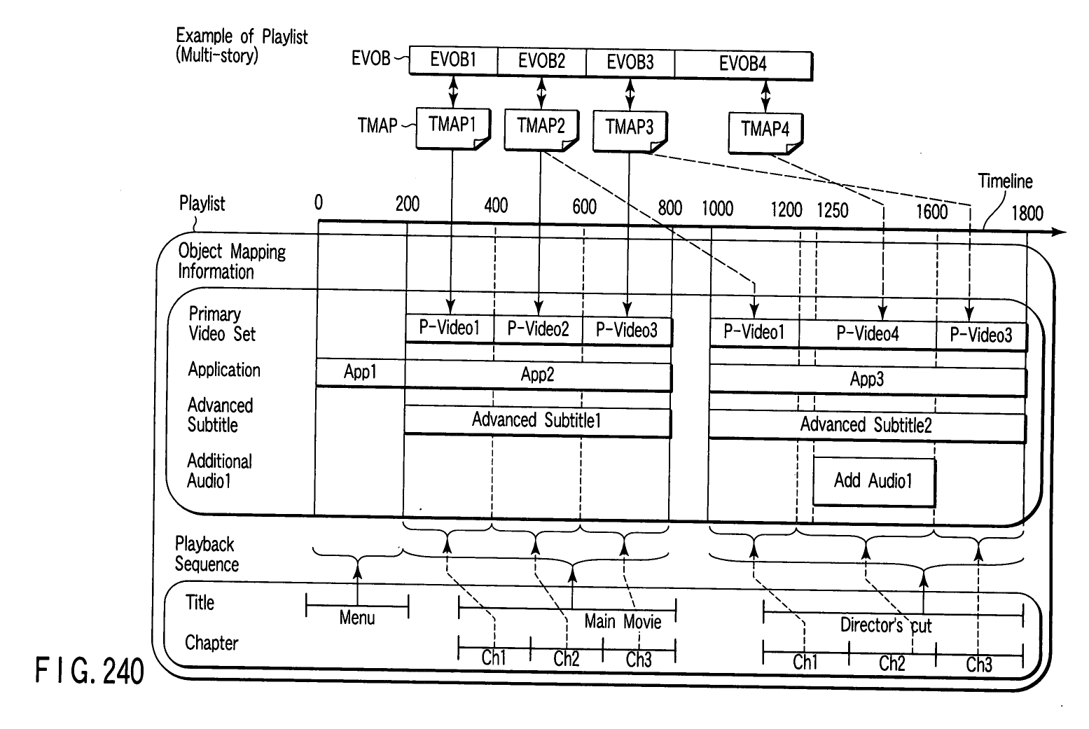

FIG. 240 is a view for explaining a configuration example of a playlist when an object includes multi-story. FIG. 240 shows an image of the Playlist upon setting Multi-story. By designating TMAPs in Object Mapping Information, these two titles are mapped on the Timeline. In this example, Multi-story is implemented by using EVOB1 and EVOB3 in both the titles, and replacing EVOB2 and EVOB4.

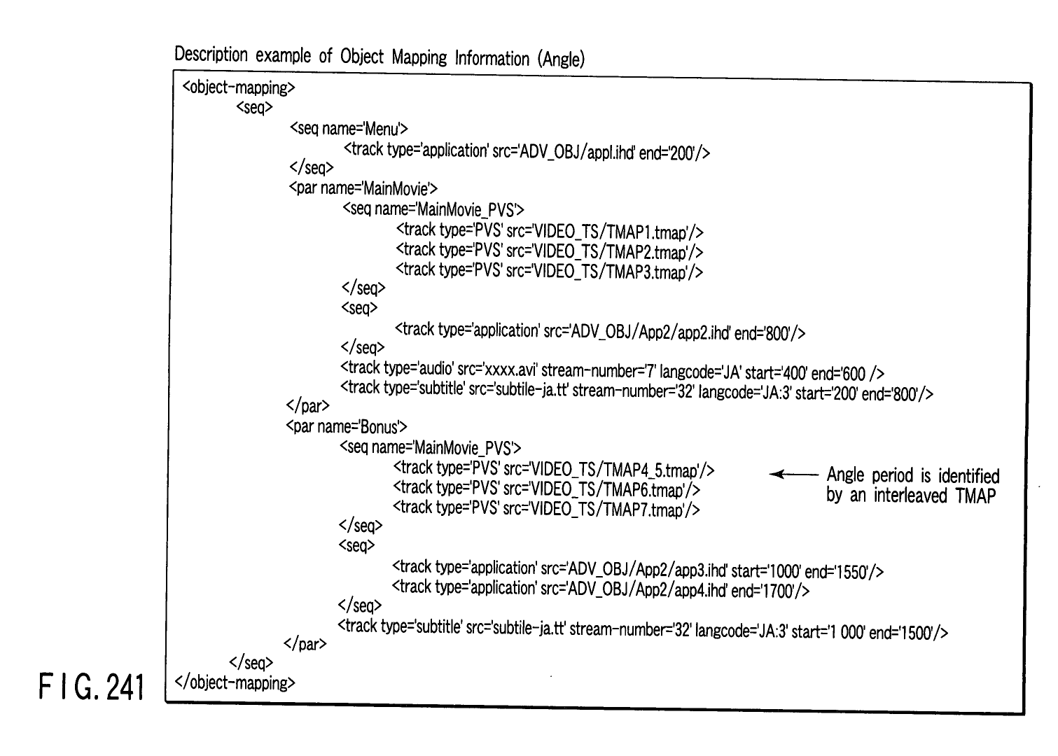

FIG. 241 is a view for explaining a description example (when an object includes angle information) of object mapping information in the playlist. FIG. 241 shows a practical description example of the Object Mapping Information in FIG. 239.

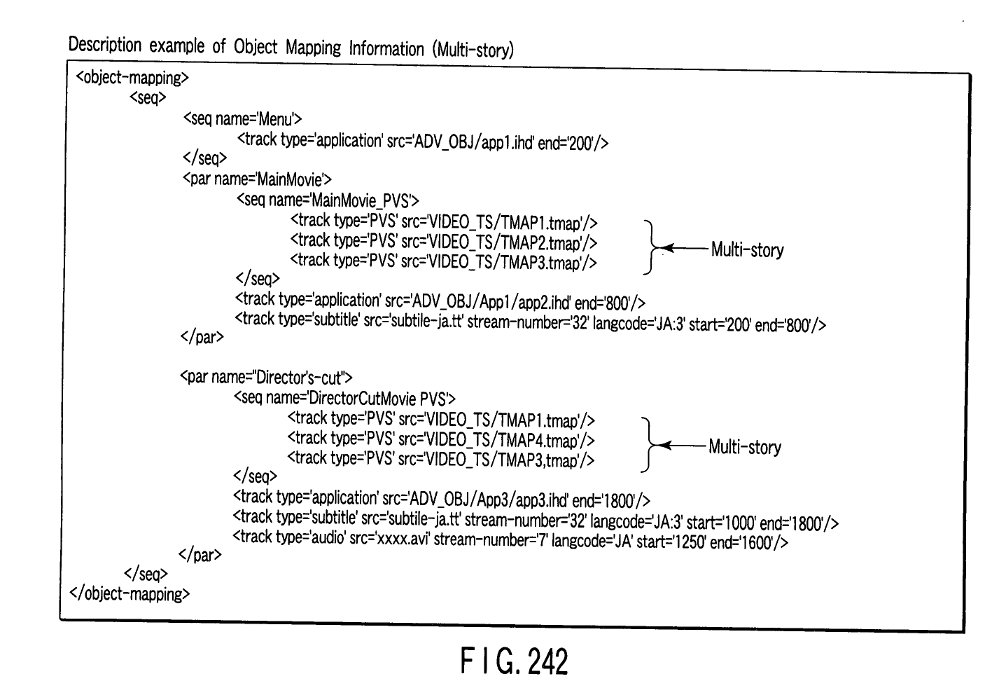

FIG. 242 is a view for explaining a description example (when an object includes multi-story) of object mapping information in the playlist. FIG. 242 shows a description example of Object Mapping Information upon setting Multi-Story in FIG. 240. Note that a seq element means its child elements are sequentially mapped on the Timeline, and a par element means that its child elements are simultaneously mapped on the Timeline. Also, a track element is used to designate each individual Object, and the times on the Timeline are expressed also using start and end attributes.

At this time, when objects are successively mapped on the Timeline like App1 and App2 in FIG. 239, an end attribute can be omitted. Also, when objects are mapped to have a gap like App2 and App3, their times are expressed using the end attribute. Furthermore, using a name attribute set in the seq and par elements, the state during current presentation can be displayed on (a display panel of) the player or an external monitor screen. Note that Audio and Subtitle can be identified using Stream numbers.

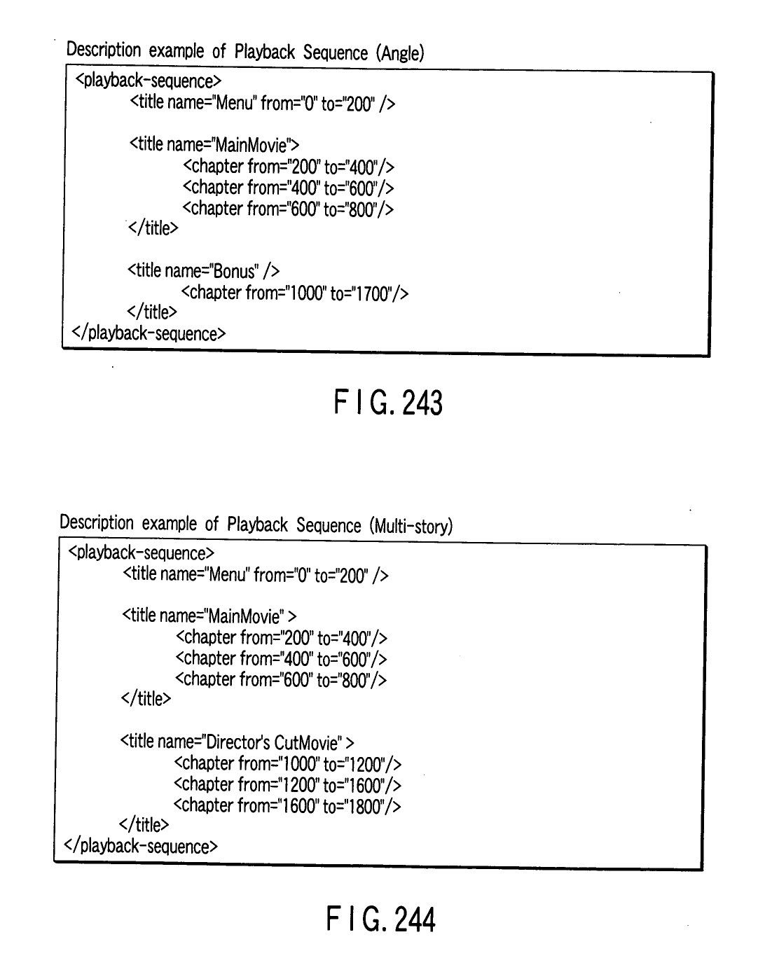

FIG. 243 is a view for explaining a description example (when an object includes angle information) of a playback sequence in the playlist. FIG. 244 is a view for explaining a description example (when an object includes multi-story) of a playback sequence in the playlist. FIGS. 243 and 244 respectively show examples of Playback Sequences for the cases of Angle and Multi-Story in FIGS. 239 and 240. In these examples, “title” is set as a child element of a playback-sequence element, and “chapter” is set as its child element. Respective periods are defined using from and to attributes.

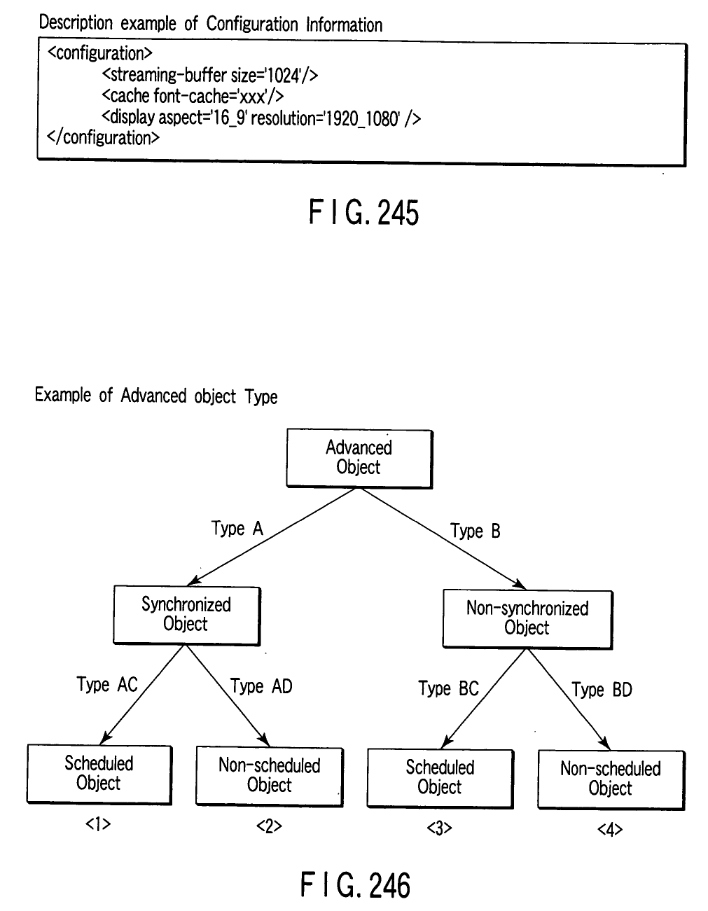

FIG. 245 is a view for explaining a description example of configuration information in the playlist. In this case, a streaming-buffer attribute is set in the Configuration information, so that the size of a Streaming buffer prepared by the player (individual playback apparatus) can be set for each Playlist, and its attribute size defines the size of the buffer. Of course, after the size of the Streaming buffer is determined, the size of a data cache is also determined. As other setting items, font-cache, display resolution and aspect, and the like are available. These attributes in the display element represent that contents (or content) to be referred to by the Playlist are displayed after the resolution and aspect ratio are converted into values set by these attributes when the contents have another resolution and aspect ratio. To this Configuration information, items to be changed for each playlist in association with the Player configurations can be added.

FIG. 246 is a view for explaining examples (four examples in this case) of an advanced object type. Advanced objects can be classified into four Types, as shown in FIG. 246. Initially, objects are classified into two types depending on whether an object is played back in synchronism with the Timeline or an object is asynchronously played back based on its own playback time. Then, the objects of each of these two types are classified into an object whose playback start time on the Timeline is recorded in the Playlist, and which begins to be played back at that time (scheduled object), and an object which has an arbitrary playback start time by, e.g., a user's operation (non-scheduled object).

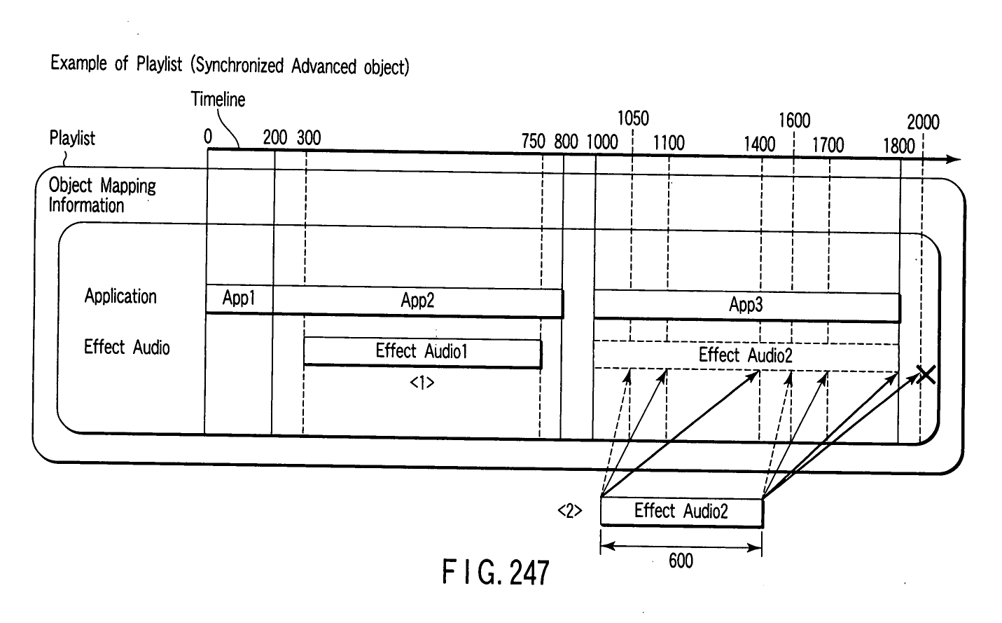

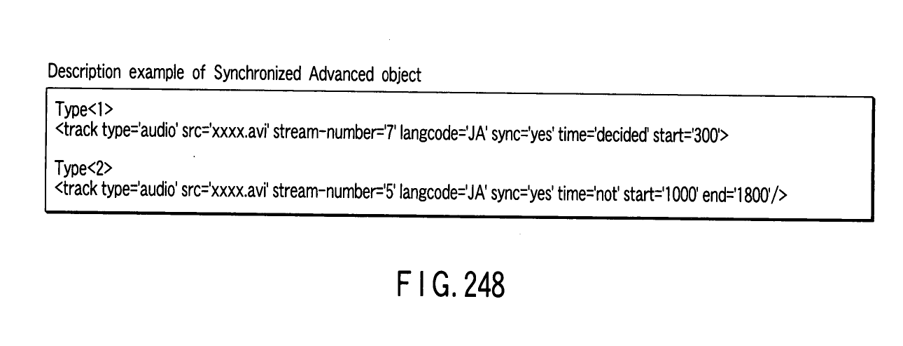

FIG. 247 is a view for explaining a description example of a playlist in case of a synchronized advanced object. FIG. 247 exemplifies cases <1> and <2> which are to be played back in synchronism with the Timeline of the aforementioned four types. In FIG. 247, an explanation is given using Effect Audio. Effect Audio1 corresponds to <1>, and Effect Audio2 corresponds to <2> in FIG. 248. Effect Audio1 is a model whose start and end times are defined. Effect Audio2 has its own playback duration “600”, and its playable time period has an arbitrary start time by a user's operation during a period from 1000 to 1800.

When App3 starts from time 1000 and presentation of Effect Audio2 starts at time 1050, they are played back until time 1650 on the Timeline in synchronism with it. When the presentation of Effect Audio2 starts from time 1100, it is similarly synchronously played back until time 1700. However, presentation beyond the Application produces conflict if another Object exists. Hence, a restriction for inhibiting such presentation is set. For this reason, when presentation of Effect Audio2 starts from time 1600, it will last until time 2000 based on its own playback time, but it ends at time 1800 as the end time of the Application in practice.

FIG. 248 is a view for explaining a description example of a playlist in case of a synchronized advanced object. FIG. 248 shows a description example of track elements for Effect Audio1 and Effect Audio2 used in FIG. 247 when Objects are classified into types. Selection as to whether or not to be synchronized with the Timeline can be defined using a sync attribute. Whether the playback period is determined on the Timeline or it can be selected within a playable time by, e.g., a user's operation can be defined using a time attribute.

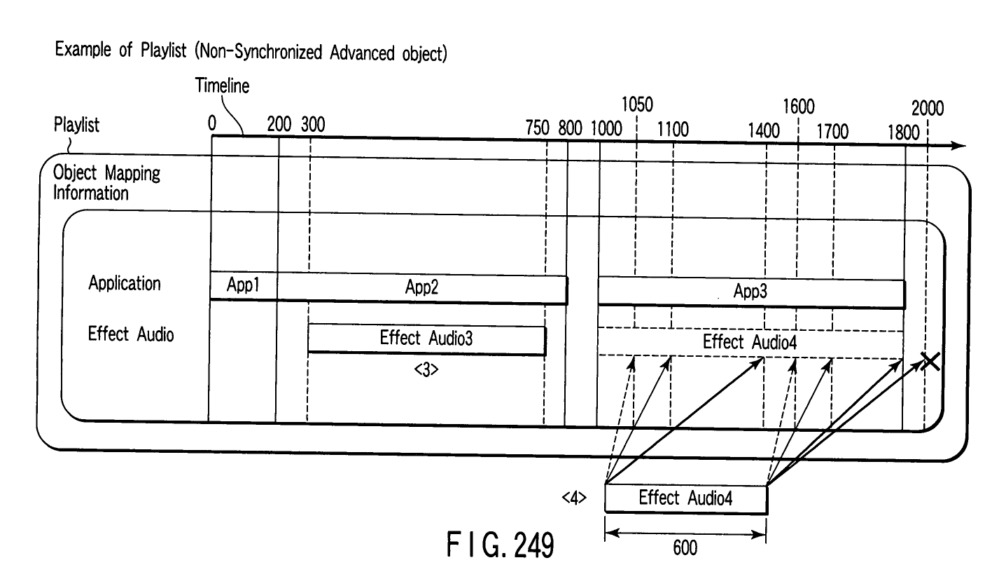

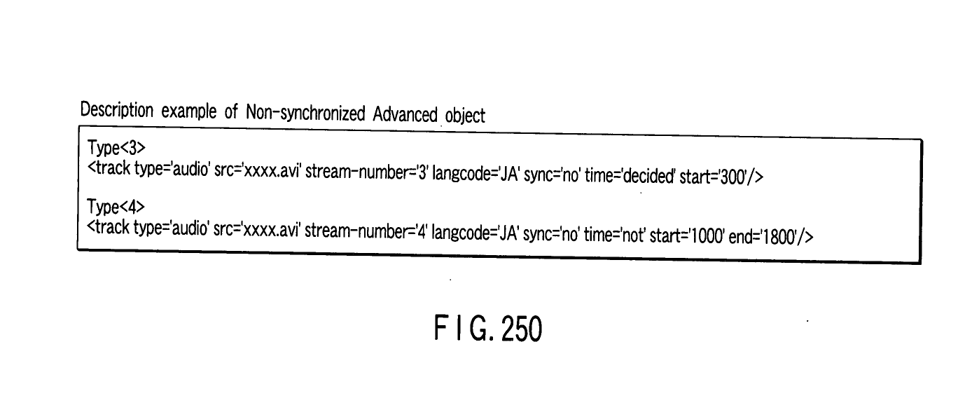

FIG. 249 is a view for explaining an example of a playlist in case of a non-synchronized advanced object, and FIG. 250 is a view for explaining a description example of a playlist in case of the non-synchronized advanced object.

FIG. 249 shows an example of an object which is not synchronized with the Timeline, i.e., is played back based on its own time axis. Effect Audio3 belongs to Type <3> in FIGS. 246 and 250, and its playback start time is determined on the Timeline. Effect Audio4 is an example of an Object which belongs to Type <4> in FIGS. 246 and 250, and has a playable time period written in the Playlist. In this case, as in Effect Audio2 in FIG. 247, when the playback start time is 1050 or 1100, Effect Audio4 is normally played back until time 1650 or 1700. However, when the start time is time 1400, Effect Audio4 ends at time 1800 as the end time of the Application. Since this Object is not synchronized with the Timeline, if the Timeline reaches time 1800 by, e.g., fastforwarding, its presentation ends.

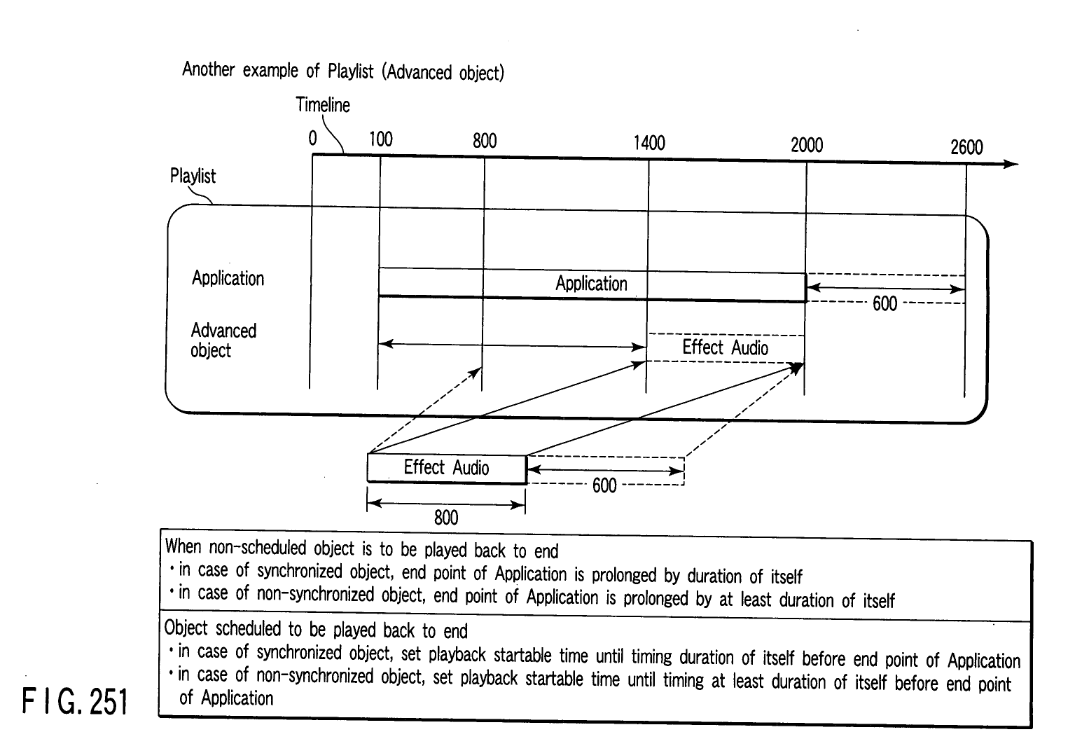

FIG. 251 is a view for explaining a playlist for various playback processes of an advanced object. FIG. 251 is a view for explaining solutions when objects in cases <1>, <2>, <3>, and <4> in FIG. 246 are to be respectively played back to the end. Cases <1> and <2> which are synchronized with the Timeline will be respectively described below.

When an Object of Type <1> is to be played back to its end, a time the same duration as its own playback duration before the end of the Application (time 1400 in FIG. 251) is set as a playback start time. In case of Type <2> as well, when a playback startable time is set at a time its own playback duration before the end of the Application (time 1400 in FIG. 251), that object can be played back to the end. Also, by prolonging the playback duration of the Application by their own durations (to time 2600 in FIG. 251), these objects can be played back to the end.

Next, cases <3> and <4> which are not synchronized with the Timeline will be described below.

Cases <3> and <4> can also be coped with by setting the setting time forward, or by prolonging the duration of the Application. However, since these objects are not synchronized with the Timeline, a time which considers and guarantees a case wherein the Timeline is advanced due to processing such as fastforwarding or the like is to be set.

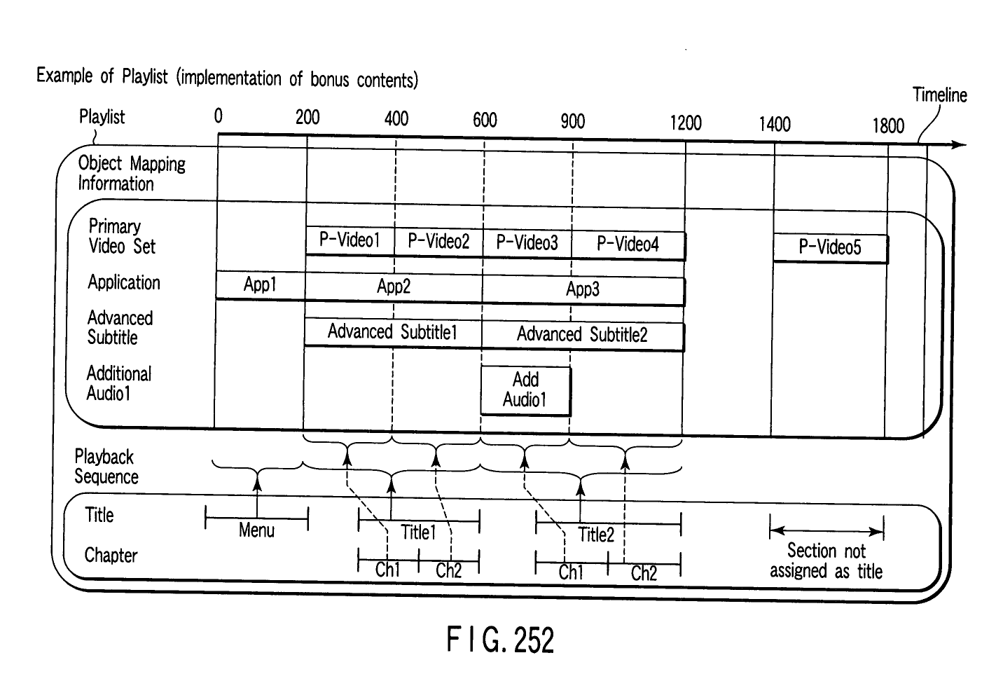

FIG. 252 is a view for explaining an example of a playlist upon playing back an object including bonus contents. FIG. 252 is a view upon setting a section which is not assigned as a title on the timeline. By setting assignment on the timeline independently of that of titles, the section which is not set as a title can be played back. For example, when a bonus track is to be expressed, a section to which no title is assigned is expressed (P-Video5). In this way, contents that do not allow the user to directly jump to and play back only the bonus contents can be created.

In this example, the contents have a scheme for setting flags upon completion of Title playback. In the contents, App3 checks these flags, and if all flags are set, it allows to jump to time 1400 on the Timeline. In this way, the contents which allow only the user who has viewed all playback points to play back the bonus contents can be implemented.

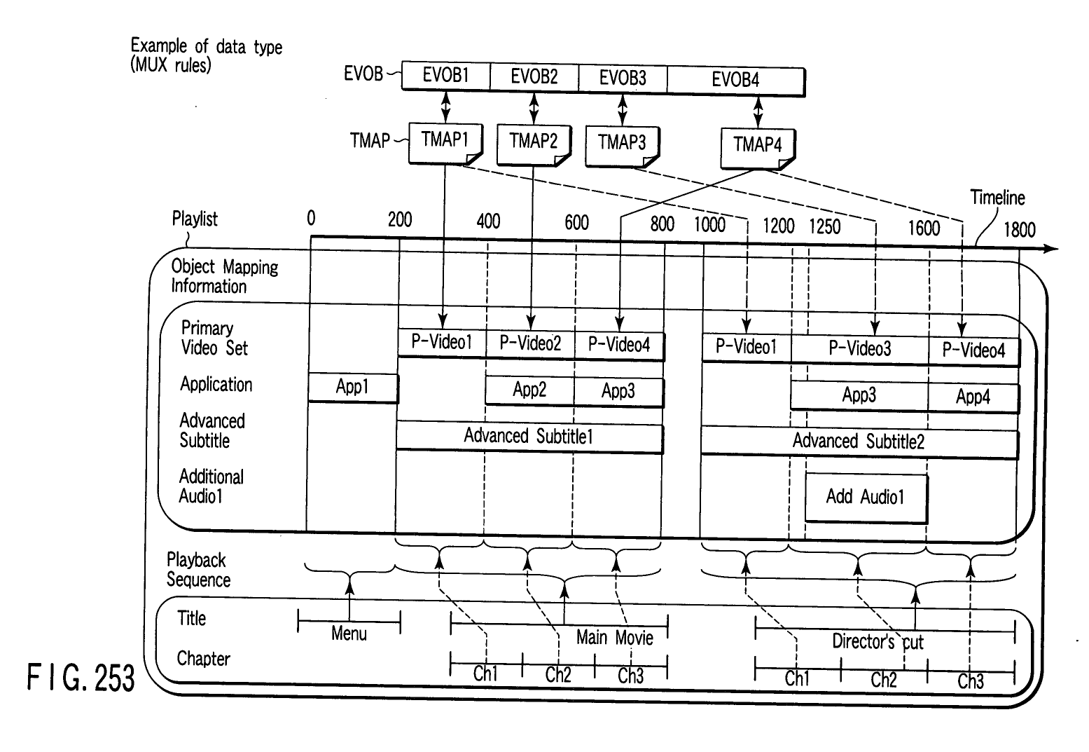

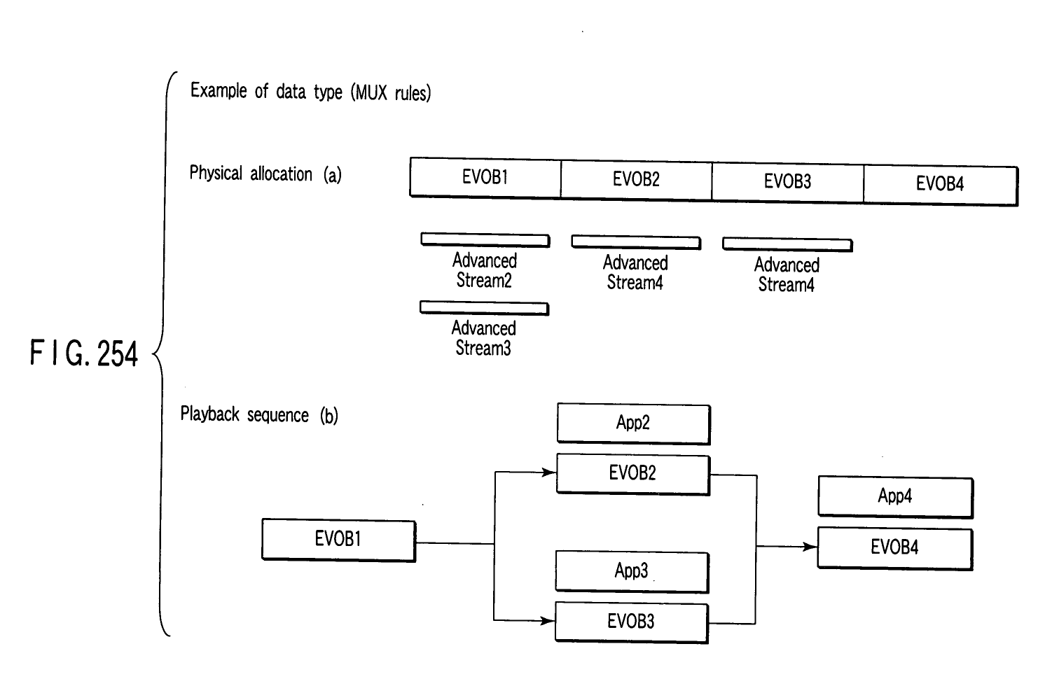

FIG. 253 is a view for explaining points to remember (multiplexing rules) when an application to be used in the next enhanced video object to be played back is multiplexed on the current enhanced video object whose playback is in progress in order to attain seamless playback. FIG. 254 is a view for explaining an example of the physical allocation and playback sequence of enhanced video objects when an application used in the next enhanced video object to be played back is multiplexed on the current enhanced video object whose playback is in progress.

FIGS. 253 and 254 exemplify a case wherein an Application to be used in the next EVOB is to be MUXed (multiplexed) on the EVOB whose playback is in progress to perform seamless playback. Assume that FIG. 253 includes two titles, i.e., a Main Movie (P-Video1→P-Video2→P-Video4) and a Director's Cut (P-Video1→P-Video3→P-Video4). These titles are expressed by the playback sequence shown in the lower chart (b) in FIG. 254.

There are two transition paths from EVOB1 to the next EVOB, i.e., EVOB2 and EVOB3. Such playback sequence is described and controlled using a Playlist. In this case, in consideration of the physical allocation on the disc, both App2 for EVOB2 and App3 for EVOB3 are to be MUXed on EVOB1. After that, when both the paths transit to EVOB4, both EVOB2 and EVOB3 have to multiplex (MUX) App4 for EVOB4.

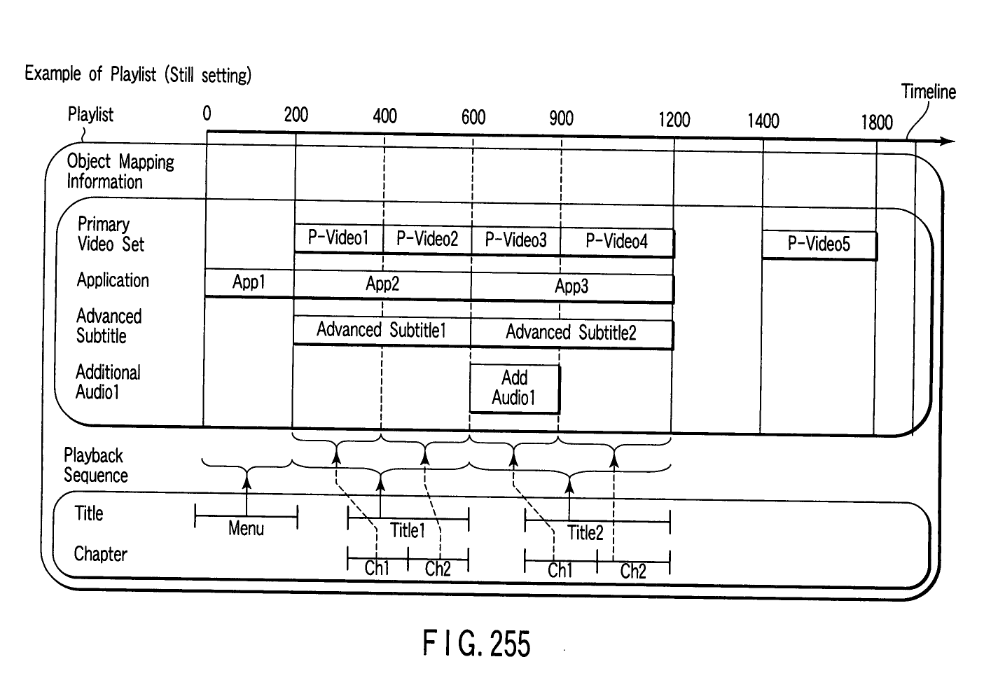

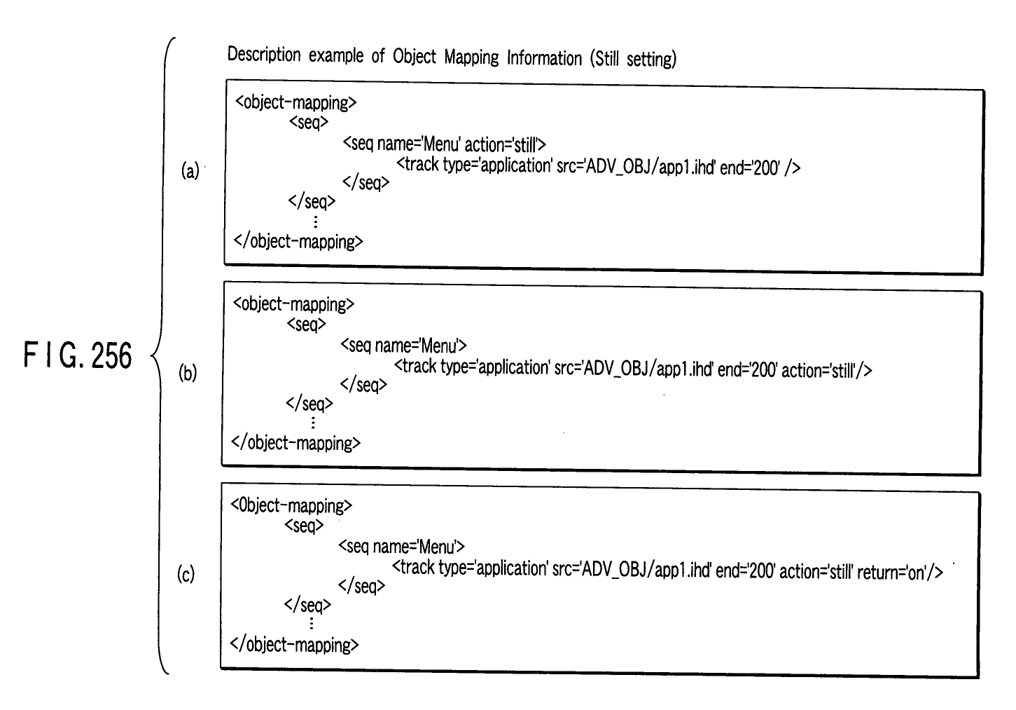

FIG. 255 is a view for explaining an example when processing for interrupting (or repeating) the progress of the timeline is executed in a playlist (still setting). FIG. 256 is a view for explaining a description example of object mapping information in a playlist upon executing the processing for interrupting (or repeating) the progress of the timeline (still setting).

FIG. 255 exemplifies a case wherein the Playlist is to execute the processing for interrupting or repeating the progress of the Timeline. Title1 in FIG. 255 forms a Menu. At this time, when an Application used by the Menu is executed in response to a user's operation, much time is taken in interpretation of script processing, and the next Title may be played back since the Timeline progress even during execution of that processing. In such case, as shown in FIG. 256, by setting an action attribute or a return attribute used to perform repetitive playback for each object or each par or seq element, processing for interrupting the Timeline during the script processing or object playback (Effect Audio, etc.) upon occurrence of a user's operation, or processing for returning to the beginning if no action occurs to the end of the Timeline can be executed.

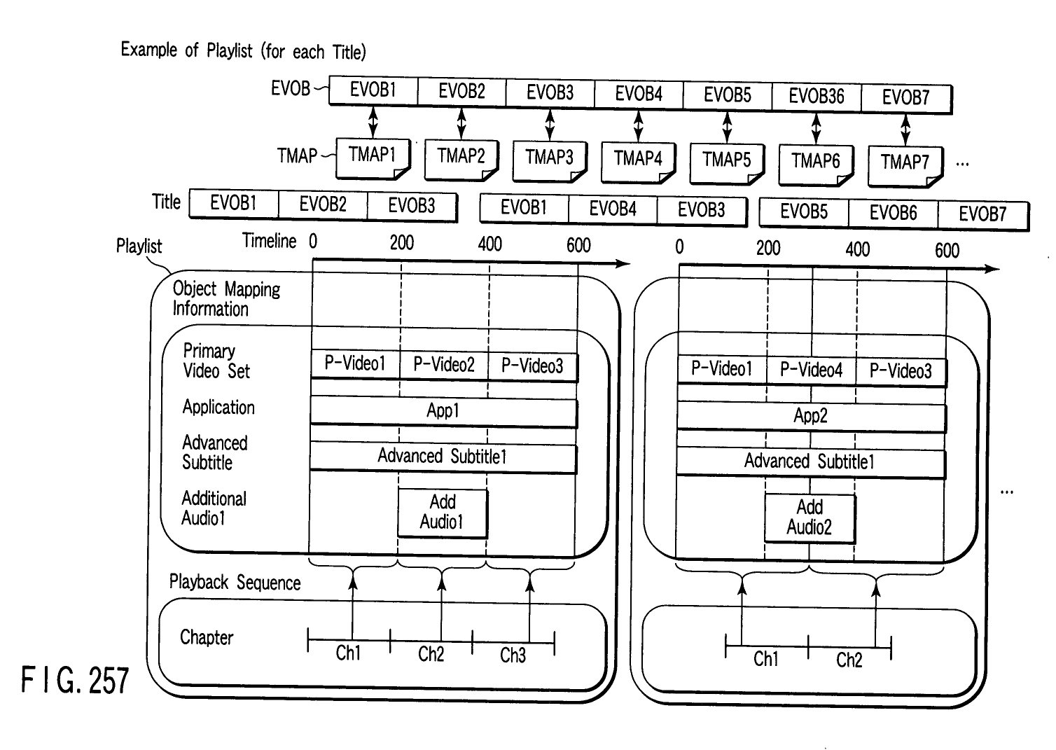

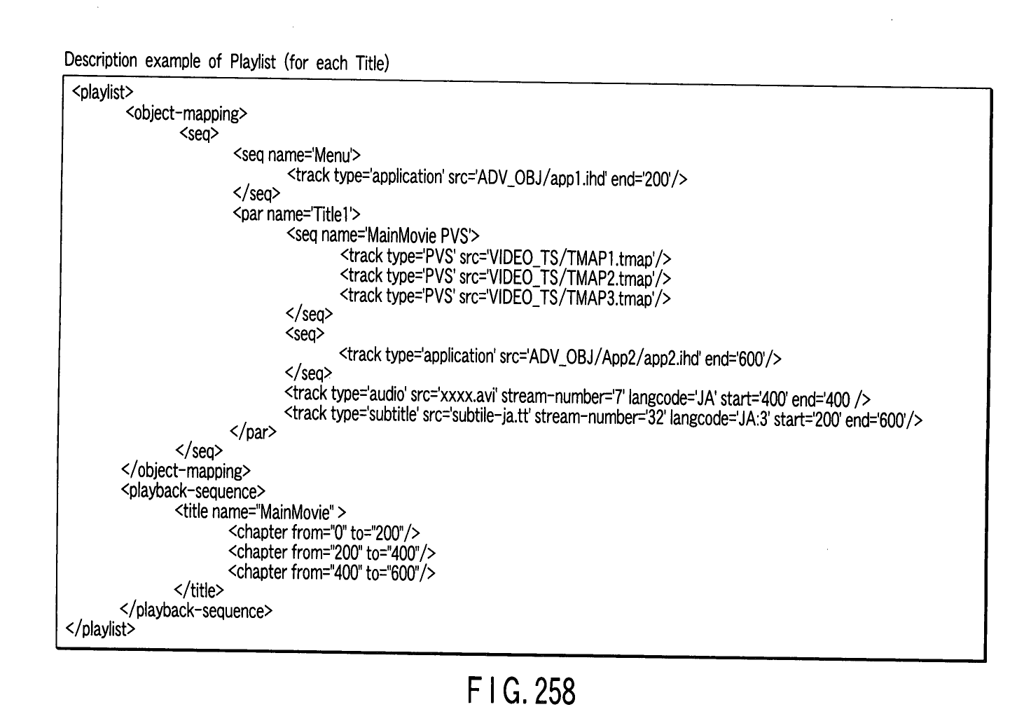

FIG. 257 is a view for explaining a description example of playlists independently prepared for respective titles. FIG. 258 is a view for explaining a description example of the playlists independently prepared for respective titles. FIGS. 257 and 258 exemplify a case wherein different Playlists are created for respective titles. Objects are allocated on the Timeline for respective titles, and Playlists have different descriptions. FIG. 258 shows a description of the Playlist. Since settings are made for respective titles, the Playback Sequence does not include any Title elements but includes only Chapter elements.

A new API (Application Interface) used to determine as to whether or not functions are to be supported by the Player is defined. Using such API, the Player status is diagnosed, and one of a plurality of Playlists can be automatically selected based on a return value from the API.

Furthermore, a function of displaying the playback time is available as that of the Player. However, when the time on the Timeline is displayed intact, the time cannot often be continuously increased depending on the playback paths. For this reason, a continuous increase in time is implemented and its display is made depending on the playback paths of the Playback Sequence. Since a Title that implements a Menu often executes processing for returning the Timeline to the beginning of the Title after the Title is played back to the end (see FIG. 256(c)), the playback time is determined by adding up times in place of returning the time.

An authoring system can create contents having the aforementioned playlists.

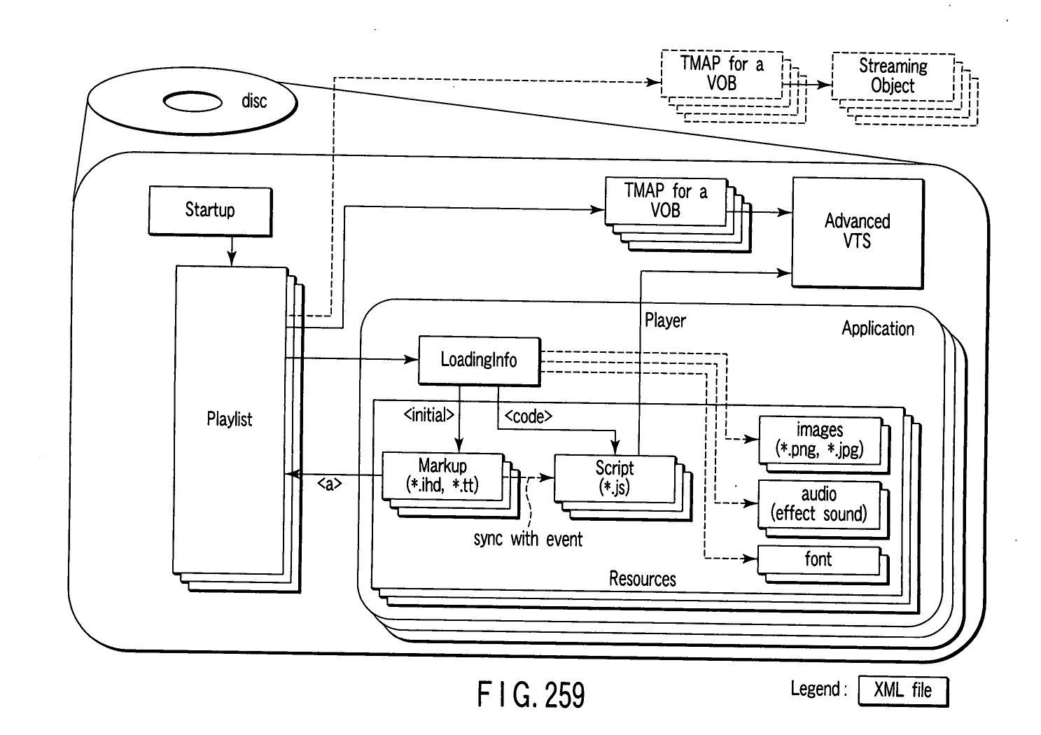

FIG. 259 is a view for explaining the relationship between pieces of information when a playlist is provided. FIG. 259 shows the relationship of the Advanced Content allocated on the disc. One Startup file recorded in the Advanced Content recording area on the disc determines one of one or more Playlists. The Determined Playlist includes three descriptions, i.e., designation of an Application (Object Mapping), reference to TMAP files of EVOBs on the disc or network (Playback Sequence), and determination of the Player configurations (Configuration Information). Only one Playlist is designated by the Startup file, and when the Playlist is to be changed by a Markup description or the like in the Application, it is completely replaced. The Application designated by the Playlist includes an XML file which is called Loading Information for each Application, and designates Resources used in the Application.

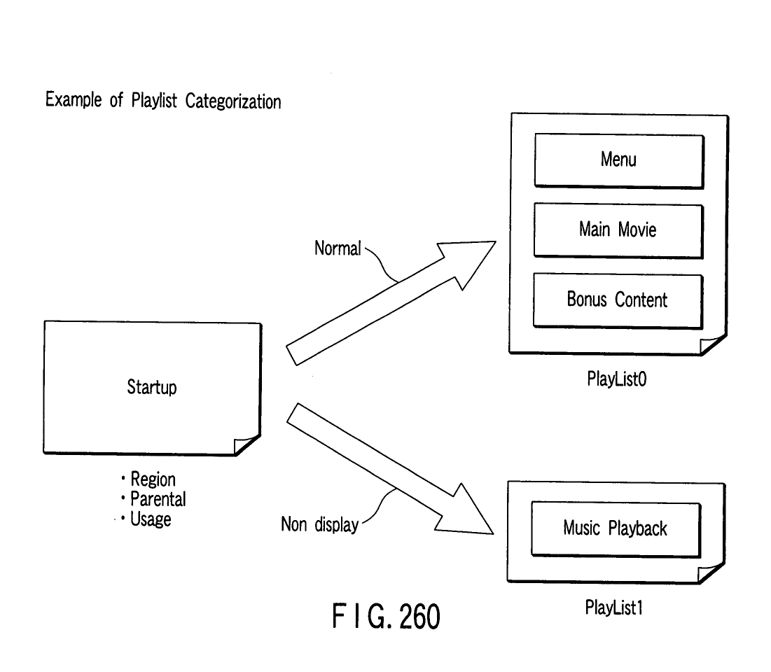

FIG. 260 is a view for explaining an example of playlist categorization based on startup. FIG. 260 exemplifies normal playback using Playlist0, and music playback using Playlist1 when no display is available. In addition, categorization based on a region, and those based on the parental level, the presence/absence of a Display, the resolution and aspect ratio, and the like may be used.

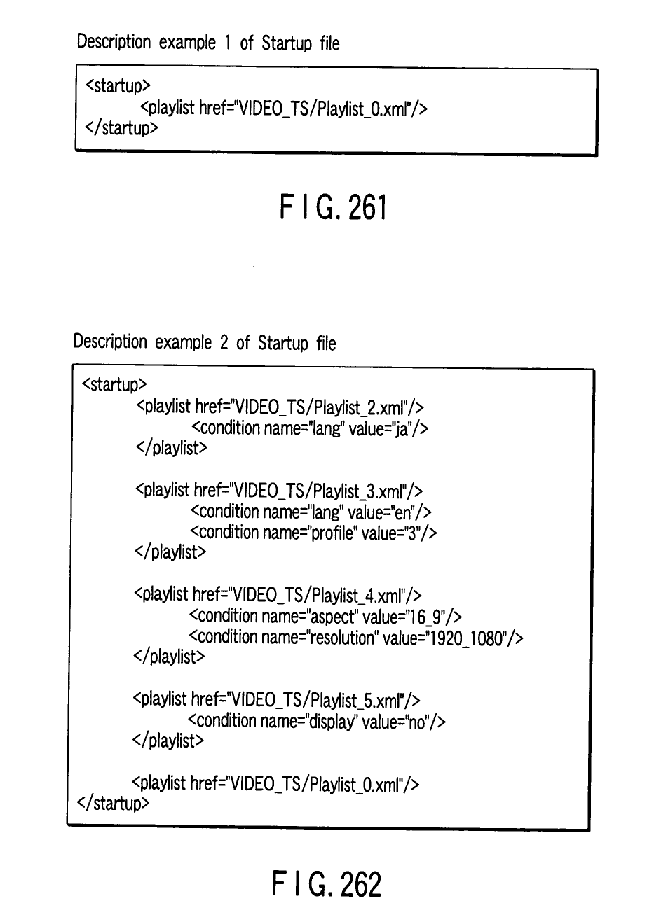

FIG. 261 is a view for explaining description example 1 (only one piece of playlist information) of a startup file. FIG. 262 is a view for explaining description example 2 (a plurality of pieces of playlist information) of a startup file. FIG. 261 shows a description when only one playlist is set. Reference is described using a URL in an attribute. In FIG. 262, Playlists for respective states are set based on categorization. Using condition elements, when lang=ja, Playlist_{—}2.xml is selected. When lang=en and profile=3, Playlist_{—}3.xml is selected. Otherwise, Playlist_{—}0.xml is selected. The condition elements which describe the categorization conditions may include attributes “aspect”, “resolution”, “display”, and the like used to make categorization based on the aspect ratio, the resolution of a display, the presence/absence of a display, and the like.

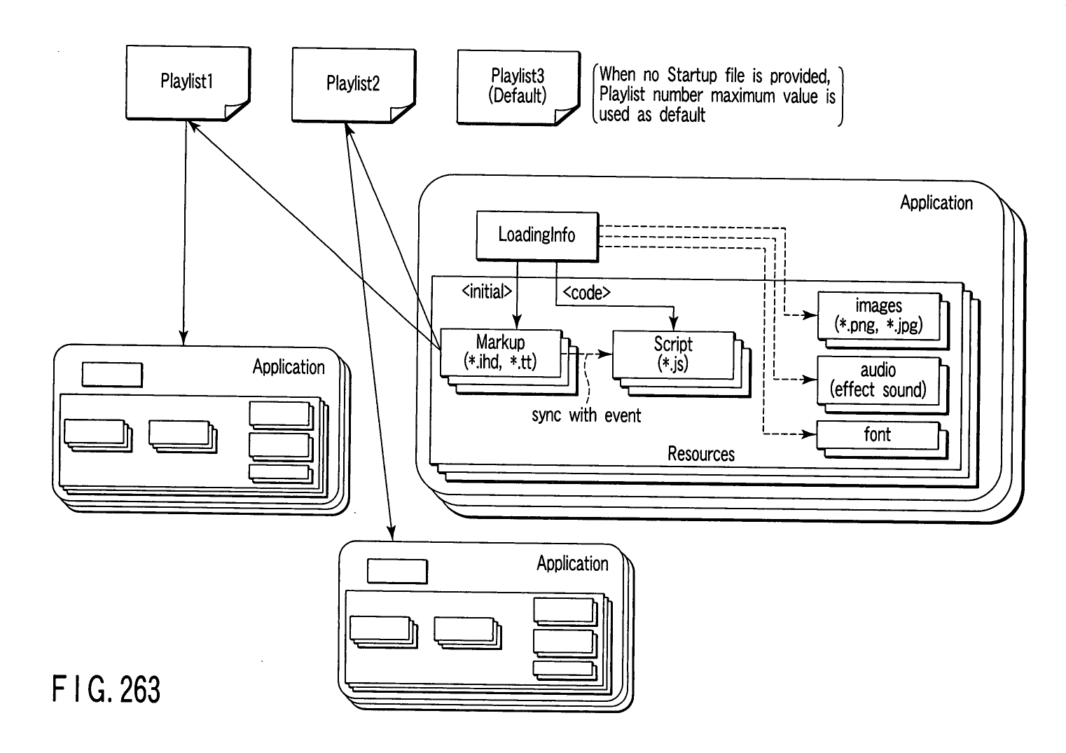

FIG. 263 is a view for explaining the relationship between pieces of information when no playlist is provided. A default Playlist necessarily has a large Playlist number. The default Playlist determines Resources used in Loadinginfo. When another Playlist is to be used, a Markup document is used to change the Playlist.

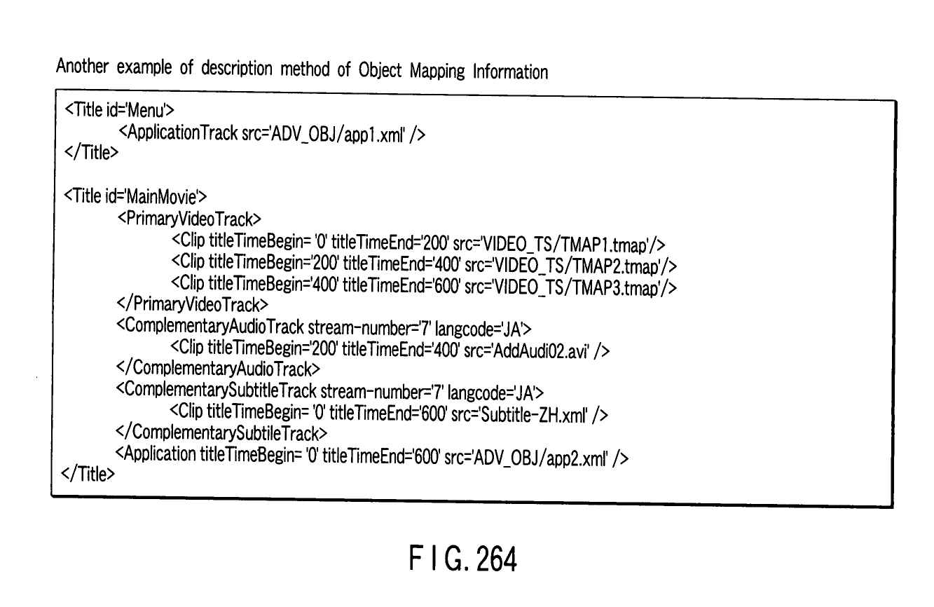

FIG. 264 is a view for explaining another example of object mapping information (when presentation objects are allocated using time periods defined on the timeline) in a playlist. FIG. 264 shows an example of a description that allocates Presentation Objects using the time periods defined on the Timeline in place of SMIL tag rules as the time expression in the Playlist. In this example, a PrimaryVideoTrack tag, ComplementaryAudioTrack tag, and the like are prepared in a Title tag and its child elements, so as to define Object Mapping for respective types of objects.

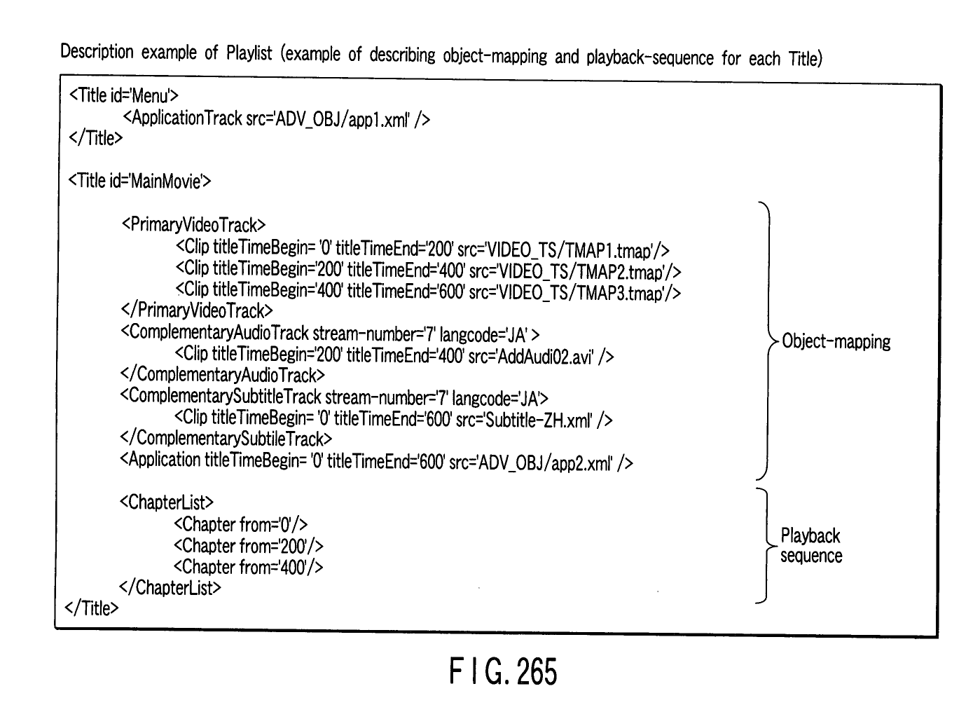

FIG. 265 is a view for explaining a description example of a playlist (when object mapping information and a playback sequence are described for each title). FIG. 265 shows an example in which Object Mapping information and Playback-Sequence are described for each title, and management for respective titles can be easily done by describing the Playback-Sequence in the child element of each Title.

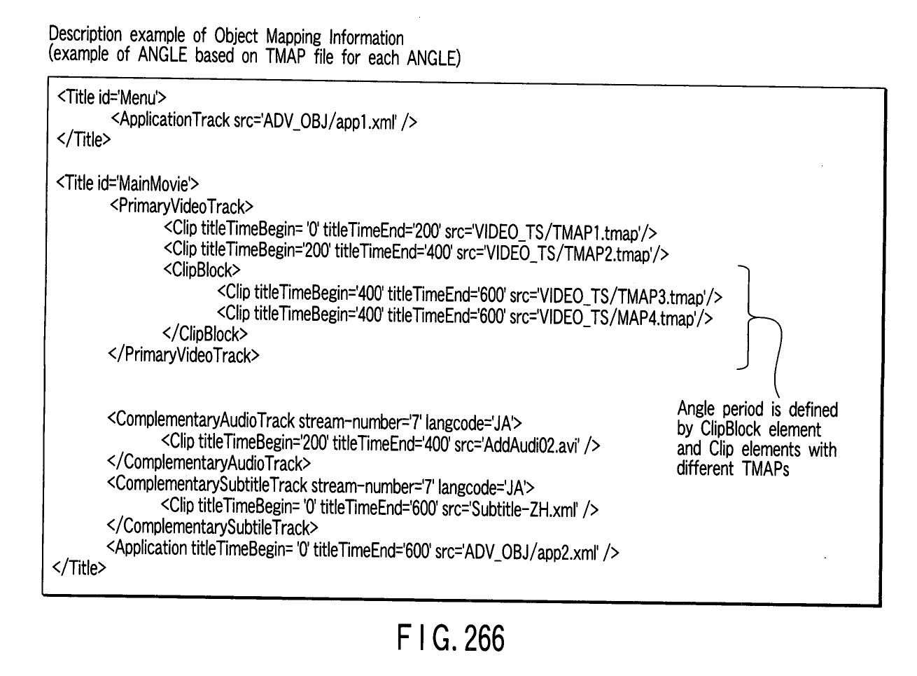

FIG. 266 is a view for explaining a description example of object mapping information (when angles are implemented by individual TMAP files). FIG. 266 shows an example in which ANGLE periods are implemented by individual TMAP files. EVOBs that implement an Angle period have each individual TMAP file for respective interleaved EVOBs. In the description on the Playlist, EVOBs that form an angle period are grouped via a ClipBlock tag. The ClipBlock tag has a Clip tag as a child element, and an src attribute refers to each individual TMAP file to form an angle block.

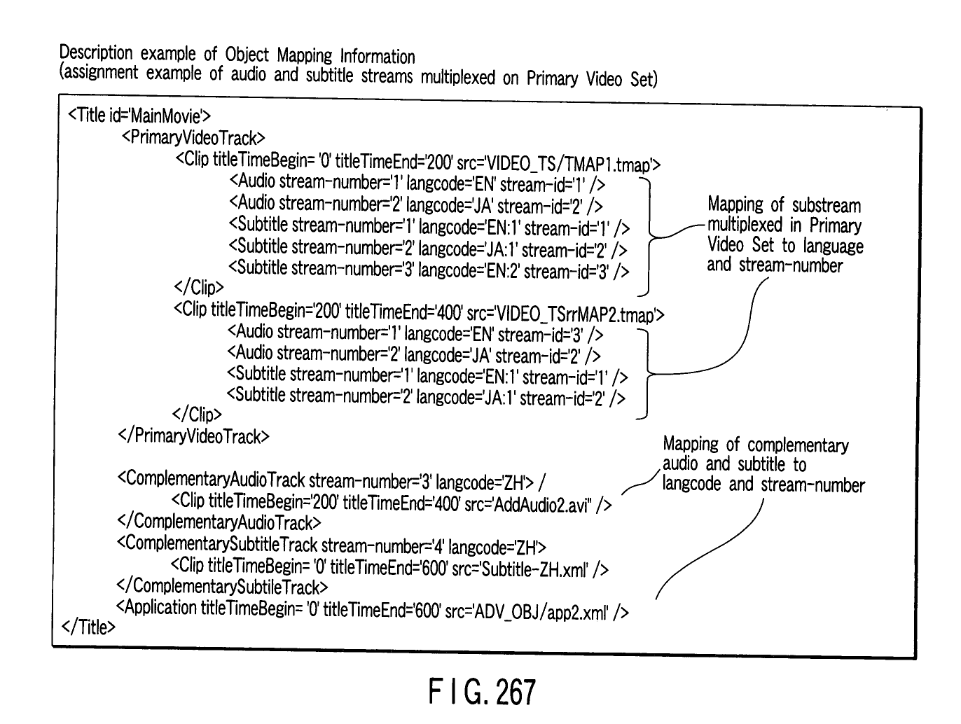

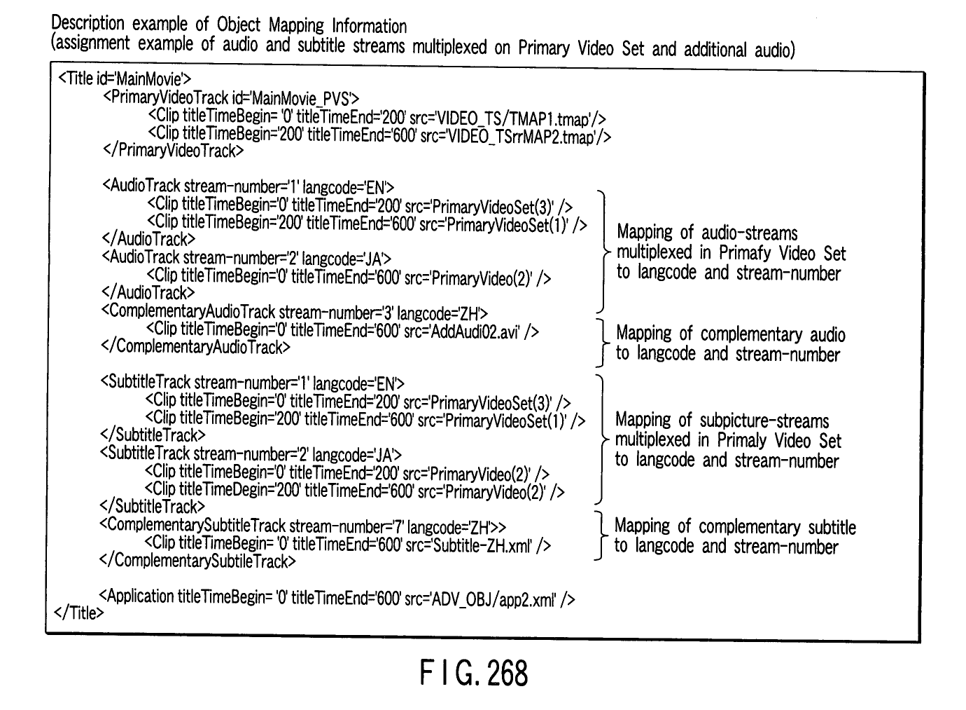

FIG. 267 is a view for explaining a description example of object mapping information (when audio and subtitle streams multiplexed on a primary video set are recombined or when non-multiplexed additional audio and subtitle streams are allowed to be selected). FIG. 268 is a view for explaining another description example of object mapping information. FIGS. 267 and 268 show an example in which audio and subtitle streams MUXed on the Primary Video Set are allowed to be recombined, and non-MUXed additional audio and subtitle streams are allowed to be selected using a stream number or language. This is attained by reassigning the MUXed Audio and SP streams to other stream numbers. The PGC_AST_CTL can use only the MUXed streams. However, in this embodiment, the MUXed audio stream and Complementary audio stream can be transparently switched.

The point of this example is that since the MUXed audio stream and the like cannot be reallocated on the Timeline, which stream of the Primary Video Set is to be used is simply designated using src. (Another Clip has its start time as that of a medium, and an audio stream at the corresponding time of the MUXed Primary Video Set is selected.)

In FIG. 267, “PrimaryVideoTrack” defines two EVOBs (0 to 200, and 200 to 400). During a time period from times 0 to 200 where EVOB1, i.e., TMAP1 is designated, Stream-Number ‘1’ is assigned to a stream with stream_id=‘1’ of MUXed Audio streams. Likewise, Stream-number ‘2’ is assigned to a stream with stream_id=‘2’. The same definition applies to Subtitle streams. Also, during a time period from 200 to 400 where EVOB2, i.e., TMAP2 is designated, “ComplementaryAudioTrack” defines AddAudio2.avi with Stream-number ‘3’.

In case of FIG. 268, when stream-number is ‘1’, “AudioTrack” uses an audio stream of Audio3 MUXed in an EVOB (i.e., EVOB1→PrimaryVideoSet1) of the Primary Video Set during a time period from 0 to 200, and uses an audio stream of Audio3 MUXed in an EVOB of PrimaryVideoSet2, i.e., EVOB2 during a time period from 200 to 600. When stream-number=‘2’, “AudioTrack” uses Audio2 of EVOB1 and EVOB2 during a time period from 0 to 600. “ComplementaryAudio” defines AddAudio2.avi with Stream-number ‘3’. The same definitions apply to Subtitle streams. A description that a child element with AudioTrack stream-number=‘2’ uses Audio2 during a period from 0 to 600 on the Timeline means that both EVOB1 and EVOB2 use Audio2 and has the same meaning as that of a description:

<Clip titleTimeBegin=‘0’ titleTimeEnd=‘200’ src=‘PrimaryVideoSet(2)’/>

<Clip titleTimeBegin=‘200’ titleTimeEnd=‘600’ src=‘PrimaryVideoSet(2)’/>

in SubtitleTrack stream-number=‘2’.

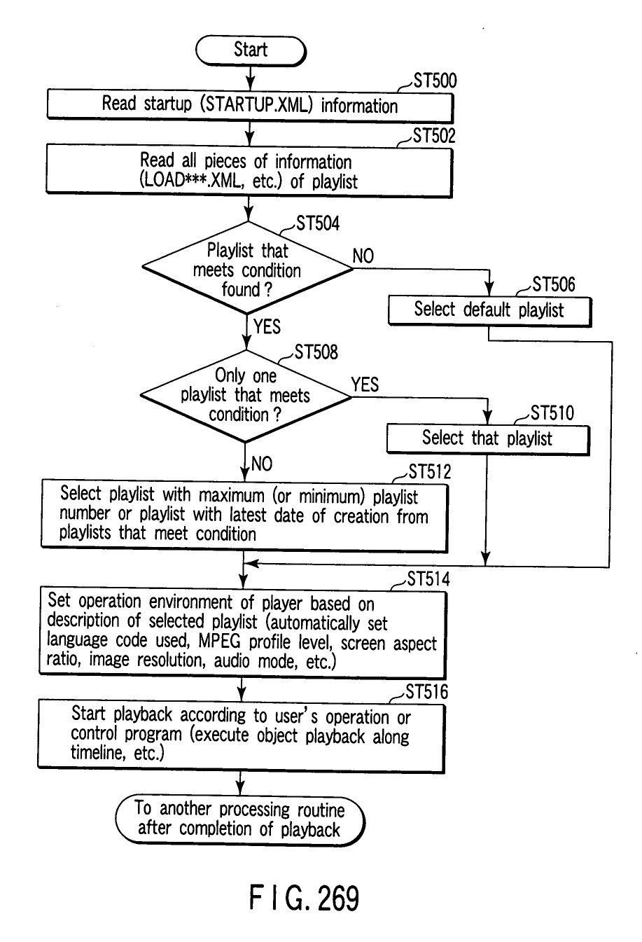

FIG. 269 is a flowchart for explaining an example of a sequence when a predetermined one of one or more playlists is selected, and playback is made based on the selected playlist. For example, when a disc of FIG. 259 is loaded into the player of FIG. 38, FIG. 72, FIG. 100, or FIGS. 139 to 146, and a disc drive (e.g., disc drive 1010 in FIG. 38) of this player starts a reading operation, startup file information (FIG. 261, FIG. 262, etc.) is read (block ST500), and all pieces of information (“LOAD001.XML” and the like in the ADV_OBJ directory in FIG. 2, or FIGS. 241 to 245, FIG. 256, FIG. 258, FIGS. 264 to 268, etc.) of playlists (FIG. 236) are read (block ST502).

Based on the read information, the conditions which can be played back by the player (for example, whether or not the player supports a language code, MPEG profile level, display aspect ratio, display resolution, audio mode, and the like described in the read information of the playlists) is checked.

If no playlist which meets the conditions that can be played back by the player is found (NO in block ST504), a default playlist which has description contents that can be played back independently of players (e.g., “<playlist href=“VIDEO_TS/playlist_{—}0.xml”/>” in FIG. 261) is selected, and the operation environment of the player (a language code used, MPEG program file level, screen aspect ratio, image resolution, audio mode, etc.) is automatically set based on the description of the selected playlist (block ST514).

After that, in accordance with a user's operation (a push event of a play button on a remote controller, or the like) or a control program (automatic playback reservation using a timer, or the like), playback processing (object playback along with the timeline) is executed (block ST516).

If only one playlist that meets the conditions which can be played back by that player is found based on the information read in blocks ST500 and ST502 (YES in block ST504, YES in block ST508), that one playlist is selected. The operation environment of the player is automatically set based on the description of the selected playlist (block ST514), and the playback processing is executed in accordance with a user's operation or control program (block ST516).

On the other hand, if a plurality of playlists that meet the conditions which can be played back by that player are found based on the information read in blocks ST500 and ST502 (YES in block ST504, NO in block ST508), a predetermined one of the plurality of playlists that meets the conditions is selected.

More specifically, in the example of FIG. 261, if “<playlist href=“VIDEO_TS/playlist_{—}2.xml”/>” to “<playlist href=“VIDEO_TS/playlist_{—}5.xml”/>” and “<playlist href=“VIDEO_TS/playlist_{—}0.xml”/>” meet the conditions, a playlist with a maximum playlist number (”<playlist href=“VIDEO_TS/playlist_{—}5.xml”/>”) or the latest playlist (normally, a playlist with the latest date of creation) (when each playlist information includes a time stamp or is linked with some time information) is selected (block ST512).

After that, the operation environment of the player is automatically set based on the description of the selected playlist (block S514), and the playback processing is executed in accordance with a user's operation or control program (block ST516).

When a playlist with a small playlist number is meant to be preferentially selected (on the provider or player design side), a playlist (e.g., “<playlist href=“VIDEO_TS/playlist_{—}2.xml”/>”) with a smallest playlist number of those which meets the conditions (except for a default playlist) may be selected in block ST512.

The contents of “Advanced Navigation” mentioned in the description of FIG. 148 will be described in more detail below. The Advanced Navigation information includes a Playlist file, Loading Information file, Markup file (for content, styling, and timing information), and Script file. These files (Playlist file, Loading Information file, Markup file, and Script file) are encoded as an XML document. The resources of the XML document for Advanced Navigation are reflected by an Advanced Navigation Engine (FIGS. 139 to 142) if they are not described in correct formats.

The XML document is validated according to the definition of the document type used as a reference, but the Advanced Navigation Engine (on the player side) does not necessarily have a function of checking validity of the content (the validity of the content can be guaranteed by the provider). If the resources of the XML document are not described in correct formats, the normal operation of the Advanced Navigation Engine is not guaranteed.

The following rules are applied to XML declarations:

The encoding declaration includes “UTF-8” or “ISO-8859-1”. An XML file is encoded by one of these encoding schemes.

A value of a standard document declaration in the XML declarations is “no” if this standard document declaration exists. If no standard document declaration exists, this value is assumed to be “no”.

All recourses available on the disc or network have addresses encoded by the Uniform Resource Identifier defined by [URI, RFC2396].

Protocols and paths supported for a DVD disc are, for example, as follows:

file://dvdrom:/dvd_advnav/file.xml

[About Playlist File]

A Playlist File can describe initial system configurations of an HD DVD player, and information of advanced content titles. This Playlist File describes sets of Object Mapping Information and Playback Sequences for respective titles in correspondence with respective titles, as shown in, e.g., FIG. 236. This Playlist File is encoded in the XML format. The syntax of the Playlist file can be defined by the XML Syntax Representation.

<Elements and Attributes>

A Playlist element is a root element of that playlist. The XML Syntax Representation of the Playlist element is, for example, as follows:

<Playlist>
Configuration TitleSet
</Playlist>

The Playlist element includes a set of information of Titles and a TitleSet element for a configuration element for System Configuration Information.

Note that the Configuration element can be composed of sets of System Configurations for the Advanced Content. Also, the System Configuration Information can be composed of a Data Cache configuration that designates a streaming buffer size, or the like.

The TitleSet element describes information of a set of Titles for Advanced Contents in the playlist. The XML Syntax Representation of the TitleSet element is, e.g., as follows:

<TitleSet>
Title *
</TitleSet>

The TitleSet element is composed of a list of Title elements. Title numbers for Advanced Navigation are assigned in series from “1” in accordance with the document order of Title elements. Each Title element describes information of each title.

That is, the Title element describes information of a Title for Advanced Contents including Object Mapping information and a Playback Sequence in that title. The XML Syntax Representation of the Title element is, e.g., as follows:

```
<Title
  id = ID
  hidden = (true | false)
  onExit = positiveInteger>
    PrimaryVideoTrack?
    SecondaryVideoTrack ?
    ComplementaryAudioTrack ?
    ComplementarySubtitleTrack ?
    ApplicationTrack *
    ChapterList ?
</Title>
```

The content of the Title element includes an element fragment for tracks and ChapterList elements. The element fragment for tracks includes a list of elements of PrimaryVideoTrack, SecondaryVideoTrack, ComplementaryAudioTrack, ComplementarySubtitleTrack, and ApplicationTrack.

Object Mapping Information for a Title is described by the element fragment for tracks. Mapping of a Presentation Object on the Title Timeline is described by the corresponding element. Note that a Primary Video Set corresponds to PrimaryVideoTrack, a Secondary Video Set corresponds to SecondaryVideoTrack, a Complementary Audio corresponds to ComplementaryAudioTrack, a Complementary Subtitle corresponds to ComplementarySubtitleTrack, and an ADV_APP corresponds to ApplicationTrack.

Note that the Title Timeline is assigned to each Title. Information of a Playback Sequence for a Title including chapter points is described by the ChapterList element.

Note that (a) a hidden attribute can describe whether or not the title can be navigated by user's operations. If its value is “true, that title cannot be navigated by user's operation. This value can be omitted, and a default value in this case is “false”.

Also, (b) an on Exit attribute can describe a title to be played back after the current title playback. If the current title playback is allocated before the end of that title, the Player is configured to inhibit jump (of playback).

The PrimaryVideoTrack element describes Object Mapping Information of the Primary Video Set. The XML Syntax Representation of the PrimaryVideoTrack element is, e.g., as follows:

```
<PrimaryVideoTrack
  id = ID>
    (Clip | ClipBlock) +
</PrimaryVideoTrack>
```

The PrimaryVideoTrack content is composed of a list of Clip elements and ClipBlock elements, each of which refers to a P-EVOB in Primary Video as a Presentation Object. The Player pre-assigns P-EVOB(s) onto the Title Timeline using start and end times according to the description of the Clip elements. Note that the P-EVOB(s) assigned onto the Title Timeline does (do) not overlap each other.

The SecondaryVideoTrack element describes Object Mapping Information of the Secondary Video Set in the title. The XML Syntax Representation of the SecondaryVideoTrack element is, e.g., as follows:

```
<SecondaryVideoTrack
  id = ID
  sync = (true | false)>
    Clip +
</SecondaryVideoTrack>
```

The SecondaryVideoTrack content is composed of a list of Clip elements, each of which refers to an S-EVOB in the Secondary Video Set as a Presentation Object. The Player pre-assigns S-EVOB(s) onto the Title Timeline using start and end times according to the description of the Clip elements.

The Player maps the Clip and ClipBlock on the Title Timeline as the start and end positions of the Clip on the Title Timeline using titleBeginTime and titleEndTime attributes of the Clip element. Note that the S-EVOB(s) assigned onto the Title Timeline does (do) not overlap each other.

If a sync attribute is ‘true’, the Secondary Video Set is synchronized with the time on the Title Timeline. On the other hand, if the sync attribute is ‘false’, the Secondary Video Set runs based on its own time (in other words, if the sync attribute is ‘false’, presentation progresses based on the time assigned to the Secondary Video Set itself in place of the timeline time).

Furthermore, if the sync attribute value is ‘true’ or it is omitted, a Presentation Object in “SecondaryVideoTrack” becomes a Synchronized Object. On the other hand, if the sync attribute value is ‘false’, a Presentation Object in “SecondaryVideoTrack” becomes a Non-synchronized Object.

The ComplementaryAudioTrack element describes Object Mapping Information of a Complementary Audio Track in the title and assignment to an Audio Stream Number. The XML Syntax Representation of the ComplementaryAudioTrack element is, e.g., as follows:

```
<ComplementaryAudioTrack
  id = ID
  streamNumber = Number
      languageCode = token
      >
    Clip +
</ComplementaryAudioTrack>
```

The content of the ComplementaryAudioTrack element is composed of a list of Clip elements, each of which refers to a Complementary Audio as a Presentation Element. The Player pre-assigns Complementary Audio(s) onto the Title Timeline according to the description of the Clip elements. Note that the Complementary Audio(s) assigned onto the Title Timeline does (do) not overlap each other.

A specified Audio Stream Number is assigned to the Complementary Audio. If an Audio_stream_Change API selects the specified stream number of the Complementary Audio, the Player is configured to select the Complementary Audio in place of an audio stream in the Primary Video Set.

A streamNumber attribute describes this Audio Stream Number for the Complementary Audio.

A languageCode attribute describes a specific code and specific code extension for the Complementary Audio.

A language code attribute value follows the following scheme (BNF scheme). That is, specificCode and specificCodeExt respectively describe the specific code and specific code extension, e.g., as follows:

languageCode:=specificCode ‘:’specificCodeExtension

specificCode:=[A-Za-z][A-Za-z0-9]

specificCodeExt:=[0-9A-F][0-9A-F]

The ComplementarySubtitleTrack element describes Object Mapping Information of the Complementary Subtitle in the title and assignment to a Sub-picture Stream Number. The XML Syntax Representation of the ComplementarySubtitleTrack element is, for example, as follows:

```
<ComplementarySubtitleTrack
  id = ID
  streamNumber = Number
      languageCode = token
      >
    Clip +
</ComplementarySubtitleTrack>
```

The content of the ComplementarySubtitleTrack element is composed of a list of Clip elements, each of which refers to a Complementary Subtitle as a Presentation Element. The Player pre-assigns Complementary Subtitle(s) onto the Title Timeline according to the description of the Clip elements. Note that the Complementary Subtitle(s) assigned onto the Title Timeline does (do) not overlap each other.

A specified Sub-picture Stream Number is assigned to the Complementary Subtitle. If a Sub-picture_stream_Change API selects the stream number of the Complementary Subtitle, the Player is configured to select the Complementary Subtitle in place of a Sub-picture stream in the Primary Video Set.

A streamNumber attribute describes this

Sub-picture Stream Number for the Complementary Subtitle.

A languageCode attribute describes a specific code and specific code extension for the Complementary Subtitle.

A language code attribute value follows the following scheme (BNF scheme). That is, specificCode and specificCodeExt respectively describe the specific code and specific code extension, e.g., as follows:

languageCode:=specificCode ‘:’specificCodeExtension

specificCode:=[A-Za-z][A-Za-z0-9]

specificCodeExt:=[0-9A-F][0-9A-F]

The ApplicationTrack element describes Object Mapping information of an ADV_APP in the title. The XML Syntax Representation of the ApplicationTrack element is, for example, as follows:

```
<ApplicationTrack
  id = ID
  loading_info = anyURI
  sync = (true | false)
  language = string />
```

Note that the ADV_APP is scheduled on the entire Title Timeline. When the player starts title playback, it launches the ADV_APP according to a loading information file (e.g., Loading Information in FIG. 2 or FIG. 148) represented by the loading information attribute. If the Player exits title playback, the ADV_APP in the title is also terminated.

If a sync attribute is ‘true’, the ADV_APP is synchronized with the time on the Title Timeline. On the other hand, if the sync attribute is ‘false’, the ADV_APP runs based on its own time.

A loading information attribute describes a URI of a loading information file that describes initialization information of the application.

If the sync attribute value is ‘true’, it indicates that the ADV_APP in the ApplicationTrack is a Synchronized Object. On the other hand, if the sync attribute value is ‘false’, it indicates that the ADV_APP in the ApplicationTrack is a Non-synchronized Object.

The Clip element describes information of a period (a life period or from the start time to the end time) of a Presentation Object on the Title Timeline. The XML Syntax Representation of the Clip element is, for example, as follows:

```
  <Clip
    id = ID
    titleTimeBegin = timeExpression
    clipTimeBegin = timeExpression
    titleTimeEnd = timeExpression
    src = anyURI
    preload = timeExpression
    xml:base = anyURI >
      (UnavailableAudioStream |
UnavailableSubpictureStream )*
  </Clip>
```

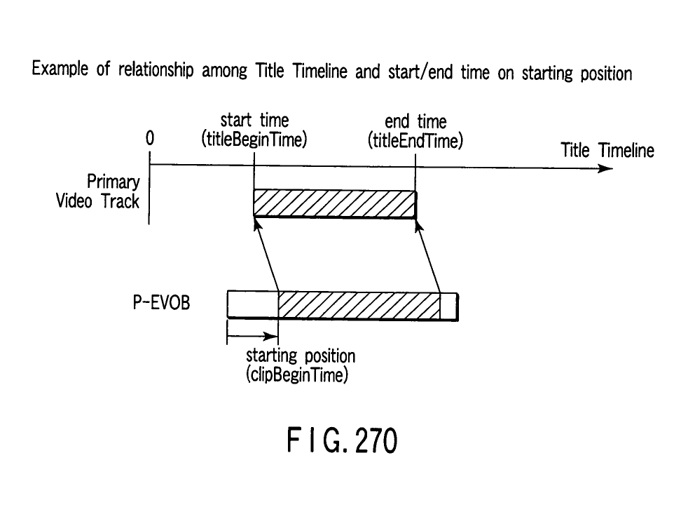

The life period of the Presentation Object on the Title Timeline is determined by the start time and end time on the Title Timeline. The start time and end time on the Title Timeline can be respectively described using a titleTimeBegin attribute and titleTimeEnd attribute. The starting position of the Presentation Object is described using a clipTimeBegin attribute. At the start time on the Title Timeline, the Presentation Object exists at the starting position described by clipTimeBegin. FIG. 270 illustrates this. FIG. 270 shows an example of the relationship among the timeline, the starting position of a P-EVOB, and the start and end times of the P-EVOB.

The Presentation Object is referred to by the URI of an index information file. A P-EVOB TMAP file is referred to for the Primary Video Set. An S-EVOB TMAP file is referred to for the Secondary Video Set. An S-EVOB TMAP file of the Secondary Video Set including an object is referred to for the Complementary Audio and Complementary Subtitle.

For example, the Attribute values of titleBeginTime, titleEndTime, clipBeginTime, and the duration time of the Presentation Object satisfy:

```
  titleBeginTime < titleEndTime, and
  clipBegintTime + titleEndTime − titleBeginTime
    ≦ duration time of Presentation
Object
```

UnavailableAudioStream and UnavailableSubpictureStream elements exist only for the Clip element in the PrimaryVideoTrack element.

The titleTimeBegin attribute describes the start time of continuous fragments of the Presentation Object on the Title Timeline.

The titleTimeEnd attribute describes the end time of continuous fragments of the Presentation Object on the Title Timeline.

The clipTimeBegin attribute describes the starting position in the Presentation Object, and its value can be described in a timeExpression value. Note that clipTimeBegin can be omitted. If no clipTimeBegin attribute exists, the starting position is assumed to, e.g., ‘0’.

An src attribute describes the URI of the index information file of the Presentation Object to be referred to.

A preload attribute can describe the time on the Title Timeline upon starting playback of a Presentation Object pre-fetched by the Player.

The ClipBlock element describes a group of Clips in a P-EVOBS, which is called a Clip Block. One Clip is selected for playback. The XML Syntax Representation of the ClipBlock element is, for example, as follows:

<ClipBlock>
Clip+
</ClipBlock>

All Clips in the ClipBlock are configured to have the same start and end times. For this reason, the ClipBlock can be scheduled on the Title Timeline using the start and end times of the first child Clip. Note that the ClipBlock can be used in only the PrimaryVideoTrack.

The ClipBlock can express an Angle Block. Angle numbers for Advanced Navigation are assigned in series from ‘1’ in accordance with the document order of Clip elements.

The Player selects the first Clip as the one to be played back as a default. If an Angle_Change API selects a specified Angle number, the Player selects the corresponding Clip as the one to be played back.

The UnavailableAudioStream element in the Clip element which describes a Decoding Audio Stream in a P-EVOBS is inhibited from being used during the playback period of the Clip of interest. The XML Syntax Representation of the UnavailableAudioStream element is, for example, as follows:

```
<UnavailableAudioStream
    number = integer
    />
```

The UnavailableAudioStream element can be used in only the Clip element for a P-EVOB, which is present in the PrimaryVideoTrack element. Otherwise, no UnavailableAudioStream exists. The player disables a Decoding Audio Stream designated by a number attribute.

The UnavailableSubpictureStream element in the Clip element that describes a Decoding Sub-picture Stream in a P-EVOBS is inhibited from being used during the playback period of the Clip of interest. The XML Syntax Representation of the UnavailableSubpictureStream element is, for example, as follows:

```
<UnavailableSubpictureStream
    number = integer
    />
```

The UnavailableSubpictureStream element can be used in only the Clip element for a P-EVOB, which is present in the PrimaryVideoTrack element. Otherwise, no UnavailableSubpictureStream exists. The player disables a Decoding Sub-picture Stream designated by a number attribute.

The ChapterList element in the Title element describes Playback Sequence Information for the title of interest. The Playback sequence defines the chapter start position using a time value on the Title Timeline. The XML Syntax Representation of the ChapterList element is, for example, as follows:

<ChapterList>
Chapter+
</ChapterList>

The ChapterList element is composed of a list of Chapter elements. Each Chapter element describes the chapter start position on the Title Timeline. Chapter numbers for Advanced Navigation are assigned in series from ‘1’ in accordance with the document order of Chapter elements in the ChapterList. More specifically, the chapter start position in the Title Timeline is monotonically increased according to the Chapter numbers.

The Chapter element describes the chapter start position on the Title Timeline in the Playback Sequence. The XML Syntax Representation of the Chapter element is, for example, as follows:

```
<Chapter
    id = ID
    titleBeginTime = timeExpression />
```

The Chapter element may have a titleBeginTime attribute. The timeExpression value of this titleBeginTime attribute describes the chapter start position on the Title Timeline.

The titleBeginTime attribute describes the chapter start position on the Title Timeline in the Playback Sequence, and its value is described in the timeExpression value.

<Datatypes>

The timeExpression value describes a timecode using, e.g., a positive integer of a 90-kHz unit.

[About Loading Information File]

The Loading Information File is initialization information of an ADV_APP for a title, and the Player is configured to launch the ADV_APP in accordance with information in the Loading Information File. This ADV_APP may have a configuration including presentation of a Markup file and extension of a Script (or execution of a Script).

The initialization information described in the Loading Information file includes:

*Files to be stored first in the File Cache before execution of an initial markup file;

*the Initial markup file to be executed; and

*a Script file to be executed.

The Loading Information File should be encoded in a correct XML format, and Rules for an XML Document File are applied.

<Element and Attributes>

The syntax of the Loading Information file is specified by the XML Syntax Representation.

An Application element is a root element of the Loading Information file, and includes, for example, the following elements and attributes:

XML Syntax Representation of the Application element:

```
    <Application
        Id = ID
        >
            Resource* Script ? Markup ?
Boundary ?
    </Application>
```

A Resource element describes files to be stored in the File Cache before execution of the initial Markup file, and the XML Syntax Representation of the Resource element is, for example, as follows:

```
<Resource
    id = ID
    src = anyURI
    />
```

Note that an src attribute describes the URI of a file to be stored in the File Cache.

A Script element describes an initial Script file for the ADV_APP, and the XML Syntax Representation of the Script element is, for example, as follows:

```
<Script
    id = ID
    src = anyURI
    />
```

Upon starting up the application, a Script Engine loads a script file referred to by the URI in the src attribute, and executes the loaded file as a global code [ECMA 10.2.10]. Note that the src attribute describes the URI for the initial script file.

A Markup element describes an initial Markup file for the ADV_APP, and the XML Syntax Representation of the Markup element is, for example, as follows:

```
<Markup
    id = ID
    src = anyURI
    />
```

Upon starting up the application, the Advanced Navigation is configured to load the Markup file with reference to the URI in the src attribute before execution of the initial Script file if present. Note that the src attribute describes the URI for the initial Markup file.

A Boundary element can describe a valid URL that can be referred to by the application.

[About Markup File]

The Markup file is information of a Presentation Object on the Graphics Plane. The number of Markup files that can simultaneously exist in the application is limited to one. The Markup file is composed of a content model, styling, and timing.

[About Script File]

The Script file describes a Script global code. The Script Engine executes the Script file upon starting up the ADV_APP, and waits for an event in an event handler defined by the executed Script global code.

Note that the Script is configured to control the Playback Sequence and the Graphics on the Graphics Plane using events such as a User Input Event, Player playback event, and the like.

FIG. 271 is a view showing another example of a secondary enhanced video object (S-EVOB) (another example FIG. 219). In the example of FIG. 219, an S_EVOB is composed of one or more EVOBUs. However, in the example of FIG. 271, an S_EVOB is composed of one or more Time Units (TUs). Each TU may include an audio pack group for an S-EVOB (A_PCK for Secondary) or a Timed Text pack group for an S-EVOB (TT_PCK for Secondary) (for TT_PCK, refer to FIG. 218).

In each of the aforementioned embodiments described above with reference to the accompanying drawings, information elements (310 to 318, etc. in the example of FIG. 3) which form the data structure are arranged in the illustrated order. This arrangement corresponds to the order indicating which information element is to be loaded first by the player upon playback of disc 1.

The invention is not limited to the aforementioned specific embodiments, but can be embodied by variously modifying constituent elements without departing from the scope of the invention based on all possible available arts when it is practiced at present or in the future. For example, the invention can be applied not only to DVD-ROM Video that has currently spread worldwide but also to recordable/reproducible DVD-VR (video recorder) whose demand is rapidly increasing in recent years. Furthermore, the invention can be applied to a reproduction system or a recording/reproduction system of next-generation HD-DVD which will be spread in the near future.

Furthermore, various inventions can be formed by appropriately combining a plurality of constituent elements disclosed in the respective embodiments. For example, some used constituent elements may be omitted from all constituent elements disclosed in the respective embodiments. Furthermore, constituent elements across different embodiments may be appropriately combined.

According to an embodiment of the invention, an information storage medium and its playback apparatus/method which can realize colorful expressions and can create attractive contents can be provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium comprising:
a data area configured to contain a video data recording area including a management area configured to record management information and an object area configured to record objects to be managed by the management information and an advanced content recording area configured to record advanced content information different from recording contents of the video data recording area, said advanced content recording area including a data area configured to record playlist information to be reproduced or played back first when the information storage medium stores the advanced content information, and
a file information area configured to store file information corresponding to or relating to recording contents of the data area.

2. A medium according to claim 1, wherein the playlist information is configured to include:
object mapping information which is included in each of titles for the object to be played back, and is mapped on a timeline of the title;
a playback sequence for each title, which is described based on the timeline; and
configuration information indicating a system configuration of a playback system.

3. A recording or storing method configured to use the information storage medium of claim 1, comprising:
recording or storing the playlist information in the advanced content recording area.

4. A playback or reproduction method configured to use the information storage medium of claim 1, comprising:
playing back or reproducing a file including the playlist information from the data area; and
playing back or reproducing the object from the data area.

5. A playback or reproduction apparatus configured to use the information storage medium of claim 1, comprising:
a device configured to play back a file including the playlist information; and
a device configured to play back the object.

6. An information storage medium comprising:
a data area configured to contain a video data recording area including a management area configured to record management information and an object area configured to record objects to be managed by the management information, and an advanced content recording area configured to record advanced content information different from recording contents of the video data recording area, said advanced content recording area including a data area configured to store startup information that includes at least one piece of playlist information to be reproduced or played back first when the information storage medium stores the advanced content information, and information used to determine which one of said at least one piece of the playlist information is to be adopted, and
a file information area configured to store file information corresponding to or relating to recording contents of the data area.

7. A medium according to claim 6, wherein said one playlist information is configured to include:
object mapping information which is included in each of titles for the object to be played back, and is mapped on a timeline of the title;
a playback sequence for each title, which is described based on the timeline; and
configuration information indicating a system configuration of a playback system.

8. A recording or storing method configured to use the information storage medium of claim 6, comprising:
recording or storing the playlist information and the startup information in the advanced content recording area.

9. A playback or reproduction method configured to use the information storage medium of claim 6, comprising:
playing back or reproducing a file including said at least one piece of playlist information and the startup information from the data area; and
playing back or reproducing the object from the data area.

10. A playback or reproduction apparatus configured to use the information storage medium of claim 6, comprising:
a device configured to play back a file including the playlist information and the startup information; and
a device configured to play back the object.

11. A playback apparatus using an information storage medium which comprises a data area storing a video data recording area that includes a management area which records management information and an object area which records objects to be managed by the management information, and an advanced content recording area which includes information different from the recording contents of the video data recording area, and a file information area that stores file information corresponding to or relating to recording contents of the data area, and in which the data area is configured to store startup information including at least one piece of playlist information to be played back first when the information storage medium stores the advanced content and/or information used to determine which one of said at least one piece of playlist information is to be adopted, said apparatus comprising:
a device configured to play back a file including the playlist information and/or the startup information; and
a device configured to play back the object.

12. An apparatus according to claim 11, wherein said at least one piece of playlist information is configured to include:
object mapping information which is included in each of titles for the object to be played back, and is mapped on a timeline of the title;
a playback sequence for each title, which is described based on the timeline; and
configuration information indicating a system configuration of a playback system.

13. A recording or storing method configured to use the information storage medium of claim 2, comprising:
recording or storing the playlist information in the advanced content recording area.

14. A playback or reproduction method configured to use the information storage medium of claim 2, comprising:
playing back or reproducing a file including the playlist information from the data area; and
playing back or reproducing the object from the data area.

15. A playback or reproduction apparatus configured to use the information storage medium of claim 2, comprising:
a device configured to play back a file including the playlist information; and
a device configured to play back the object.

16. A recording or storing method configured to use the information storage medium of claim 7, comprising:
recording or storing the playlist information and the startup information in the advanced content recording area.

17. A playback or reproduction method configured to use the information storage medium of claim 7, comprising:
playing back or reproducing a file including said at least one piece of playlist information and the startup information from the data area; and
playing back or reproducing the object from the data area.

18. A playback or reproduction apparatus configured to use the information storage medium of claim 7, comprising:
a device configured to play back a file including the playlist information and the startup information; and
a device configured to play back the object.
